(19) United States
(12) Patent Application Publication
(10) Pub. No.: US 2026/0361575 A1
(43) Pub. Date: Nov. 12, 2026

(54) FIRST AND SECOND COMMUNICATION DEVICES AND METHODS

(71) Applicant: Sony Group Corporation, Tokyo (JP)

(72) Inventors: Ephraim FUCHS, Stuttgart (DE); Thomas HANDTE, Stuttgart (DE); Dana CIOCHINA-KAR, Stuttgart (DE)

(73) Assignee: Sony Group Corporation, Tokyo (JP)

(21) Appl. No.: 19/488,077

(22) PCT Filed: Jun. 19, 2024
(86) PCT No.: PCT/EP2024/067138

§ 371 Date: Nov. 26, 2025

(30) Foreign Application Priority Data
Jun. 29, 2023 (EP) 23 182 337.8

(51) Int. Cl. H04L 25/02; H04L 5/14

(52) U.S. Cl. CPC H04L 25/0242; H04L 5/1461; H04L 25/0226

(57) ABSTRACT

A first communication device, e.g. a transmitter, that is configured to communicate with a second communication device, e.g. a receiver, comprises circuitry configured to transmit a first training field comprising a channel estimation sequence for use by the second communication device to estimate the channel between the first communication device and the second communication device; transmit a second training field comprising a nonlinearity estimation sequence for use by the second communication device to estimate nonlinearities between the first and second communication devices, the second training field having a higher peak-to-average-power ratio and/or a different average power than the first training field; receive nonlinearity feedback from the second communication device with respect to the estimated nonlinearities; and use the received nonlinearity feedback to configure a subsequent transmission.

### BACKGROUND

### Field of the Disclosure

The present disclosure relates to first and second communication devices that are configured to communicate with each other. The present disclosure relates further to corresponding communication methods.

### Description of Related Art

Nonlinearity in wireless transmitters is an inevitable effect that negatively affects the performance of communication systems. For instance, nonlinearly distorted signals suffer from increased detection errors. Moreover, nonlinear distortions invoke intermodulation products that lead to out-of-band emissions. Further, in full duplex communication scenarios, where transmission and reception happen at the same time within the same device, nonlinearity contributes significantly to self-interference. Hence, nonlinearity also poses a problem for wireless LAN systems which may support full duplex operation in the future.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly nor impliedly admitted as prior art against the present disclosure.

### SUMMARY

It is an object to enable an improved compensation for the effect of nonlinearity. It is a further object to provide communication devices and methods as well as a corresponding computer program and a non-transitory computer-readable recording medium for implementing the communication methods.

According to an aspect there is provided a first communication device configured to communicate with a second communication device, the first communication device comprising circuitry configured to:
transmit a first training field comprising a channel estimation sequence for use by the second communication device to estimate the channel between the first communication device and the second communication device;
transmit a second training field comprising a nonlinearity estimation sequence for use by the second communication device to estimate nonlinearities between the first and second communication devices, the second training field having a higher peak-to-average-power ratio and/or a different average power than the first training field;
receive nonlinearity feedback from the second communication device with respect to the estimated nonlinearities; and
use the received nonlinearity feedback to configure a subsequent.

According to a further aspect there is provided a second communication device configured to communicate with a first communication device, the second communication device comprising circuitry configured to:
receive a first training field comprising a channel estimation sequence and a second training field comprising a nonlinearity estimation sequence, the second training field having a higher peak-to-average-power ratio and/or a different average power than the first training field;
estimate nonlinearities between the first and second communication devices based on the received second training field; and
transmit nonlinearity feedback with respect to the estimated nonlinearities to the first communication device.

According to still further aspects a computer program comprising program means for causing a computer to carry out the steps of the methods disclosed herein, when said computer program is carried out on a computer, as well as a non-transitory computer-readable recording medium that stores therein a computer program product, which, when executed by a processor, causes the methods disclosed herein to be performed are provided.

Embodiments are defined in the dependent claims. It shall be understood that the disclosed communication methods, the disclosed computer program and the disclosed computer-readable recording medium have similar and/or identical further embodiments as the claimed communication devices and as defined in the dependent claims and/or disclosed herein.

The effect of nonlinearity can generally be compensated by means of predistortion at the transmitter (herein also called “first communication device”) or interference cancellation (or self-interference cancellation) at the receiver (herein also called “second communication device”). Such compensation methods require an accurate estimation of the nonlinear characteristic of the transmitter. This disclosure enables an accurate nonlinearity estimation of nonlinearities between the first and second communication devices, which may include nonlinearities of the first communication device, nonlinearities of the second communication device and/or nonlinearities of the channel in between them. Based on feedback regarding the nonlinearities, a subsequent transmission is configured, which may include predistortion or a change of settings for the transmission of a subsequent data unit.

According to embodiments of the present disclosure, nonlinearity estimation sequences for optimized nonlinearity estimation that comply with various sequence formats described in different standards of the IEEE 802.11 family are presented.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWING

A more complete appreciation of the disclosure and many of the attendant advantages thereof will be readily obtained as the same becomes better understood by reference to the following detailed description when considered in connection with the accompanying drawings, wherein:

FIG. 1A shows a schematic diagram of a first embodiment of a general system model for nonlinearity estimation.

FIG. 1B shows a schematic diagram of a second embodiment of a general system model for nonlinearity estimation.

FIG. 1C shows a schematic diagram of a third embodiment of a general system model for nonlinearity estimation.

FIG. 2A shows a schematic diagram illustrating TDD (time-division duplex) operation mode.

FIG. 2B shows a schematic diagram illustrating IBFD (in-band full duplex) operation mode.

FIG. 2C shows a schematic diagram illustrating FDD (frequency-division duplex) operation mode.

FIG. 3 shows a flowchart of an embodiment of a first communication method of a transmitter according to the present disclosure.

FIG. 4 shows a flowchart of an embodiment of a second communication method of a receiver according to the present disclosure.

FIG. 5 schematically illustrates an embodiment of a method for nonlinearity estimation according to the present disclosure.

FIG. 6A shows a first embodiment of a first data unit according to the present disclosure.

FIG. 6B shows a second embodiment of a first data unit according to the present disclosure.

FIG. 6C shows a third embodiment of a first data unit according to the present disclosure.

FIG. 6D shows a fourth embodiment of a first data unit according to the present disclosure.

FIG. 7A shows a schematic diagram of an embodiment of the communication scheme according to the present disclosure using a wired feedback link.

FIG. 7B shows a schematic diagram of an embodiment of the communication scheme according to the present disclosure using a wireless feedback link.

FIG. 8 shows an embodiment of a second data unit onto which predistortion is applied.

FIG. 9 shows a schematic diagram of an embodiment of a transmitter including predistortion means.

FIG. 10 shows another embodiment of a second data unit including another second training field.

FIG. 11A shows a diagram of a first embodiment of a communication scheme according to the present disclosure.

FIG. 11B shows a diagram of a second embodiment of a communication scheme according to the present disclosure.

FIG. 12 shows a diagram of a communication scheme for use with FDD operation, wherein TX and RX are arranged in the same STA.

FIG. 13A shows a diagram of a first embodiment of a communication scheme for use with FDD operation, wherein TX and RX are arranged in different STAs.

FIG. 13B shows a diagram of a second embodiment of a communication scheme for use with FDD operation, wherein TX and RX are the same STA.

FIG. 14 shows another embodiment of a communication scheme using an internal link for self-interference cancellation.

### DETAILED DESCRIPTION OF THE EMBODIMENTS

Compensation for the effects of nonlinearity is adopted in communication systems. One known option is predistortion. Predistortion systems typically estimate the nonlinearity device-internally with an additional receive path that is only used for predistortion adaption. This solution is costly, bulky and energy-intensive. Another option of nonlinearity compensation is self-interference cancellation. Self-interference caused by spectral regrowth from nonlinear distortions in full duplex systems is typically mitigated or cancelled by means of passive, analog and digital methods. Passive methods include using hardware components, such as circulators or duplexers. These components are both costly and bulky and thus not suitable for the mass market of low-cost consumer devices. Analog methods use additional electronic circuitry to perform phase and amplitude alignment, inversion, and superposition of the distorted signal onto the received signal. This comes with the same drawbacks as the passive methods. Digital self-interference cancellation methods use algorithms to estimate the nonlinear self-interference components and subtract them digitally from the received signal.

For both compensation methods, an accurate estimate of the nonlinearity is needed. Nonlinearity estimation can be performed by means of transmitting, receiving and evaluating a nonlinearity estimation sequence. There exist no sequences that are particularly suitable for nonlinearity estimation while being compliant to IEEE 802.11 standards, e.g., in terms of sequence format. Filling this gap is one of the intentions of this disclosure. Thus, according to the present disclosure, for improved performance of compensation methods like predistortion and self-interference cancellation, nonlinearity estimation over-the-air with an already existing receiver with compensation of wireless channel frequency selectivity is considered in an embodiment.

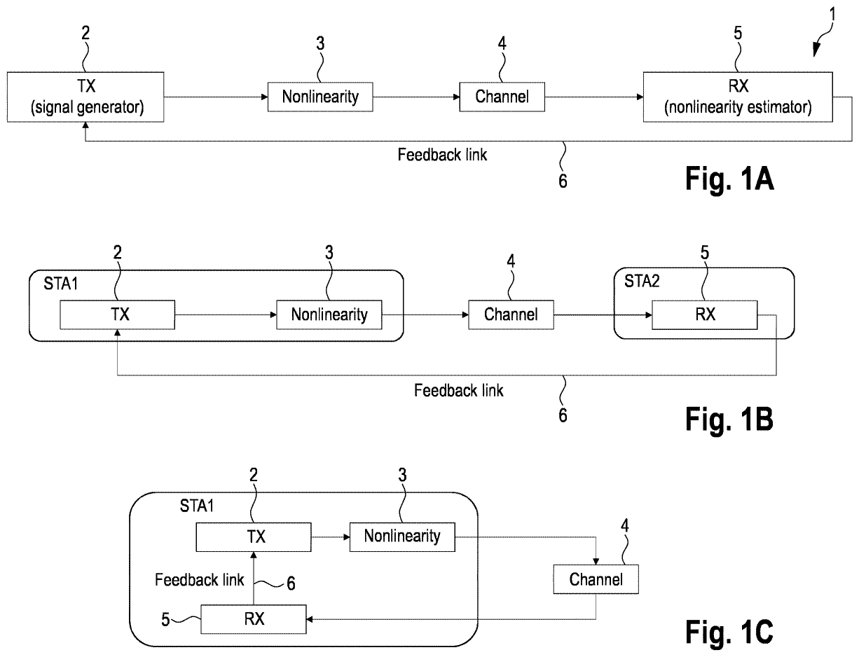

The general system model 1 for nonlinearity estimation is schematically depicted in FIG. 1A. The signal transmitted by a transmitter (TX) 2 (herein also called “first communication device”) is distorted by a nonlinearity 3 and propagates through a channel 4. A receiver (RX) 5 (herein also called “second communication device”) receives this signal and provides feedback to the TX 1 via a feedback link 6. The signal generated by the TX 2 may be a Physical Protocol Data Unit (PPDU) (herein also called “data unit”) containing a nonlinearity estimation training field. The RX 5 may contain a nonlinearity estimator. TX 2 and RX 5 may be arranged in separate stations (STA) as schematically depicted in FIG. 1B or may be arranged within the same station as schematically depicted in FIG. 1C. The nonlinearity may be part of the STA that contains TX 2 as depicted in FIG. 1B and FIG. 1C.

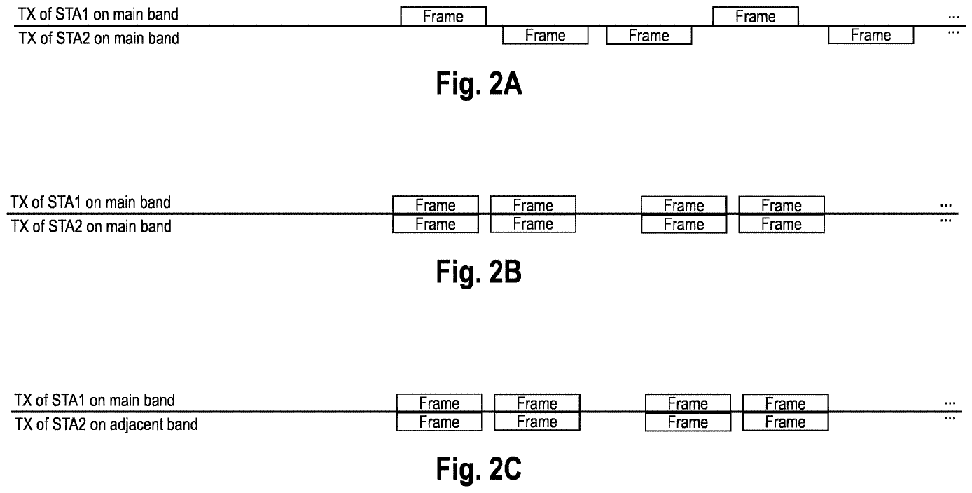

The duplexing operation of two stations can be described as follows. Two STAs STA1 and STA2, each comprising a TX and an RX, generally communicate bidirectionally with each other. In a time-division duplex (TDD) operation mode, TX and RX of both STAs are tuned to the same band and transmission is done alternately. This is schematically depicted in FIG. 2A. In an inband full duplex (IBFD) operation mode, TX and RX of both STAs are tuned to the same band, but transmission is done concurrently. This is schematically depicted in FIG. 2B. In a frequency-division duplex (FDD) operation mode, TX and RX of a STA are tuned to different bands and transmission is done concurrently. The TX of one STA is tuned to the RX band of the other STA and vice versa. This is schematically depicted in FIG. 2C. In this disclosure, the band used by the TX is referred to as main band and the band that is adjacent to the main band with respect to frequency is referred to as adjacent band.

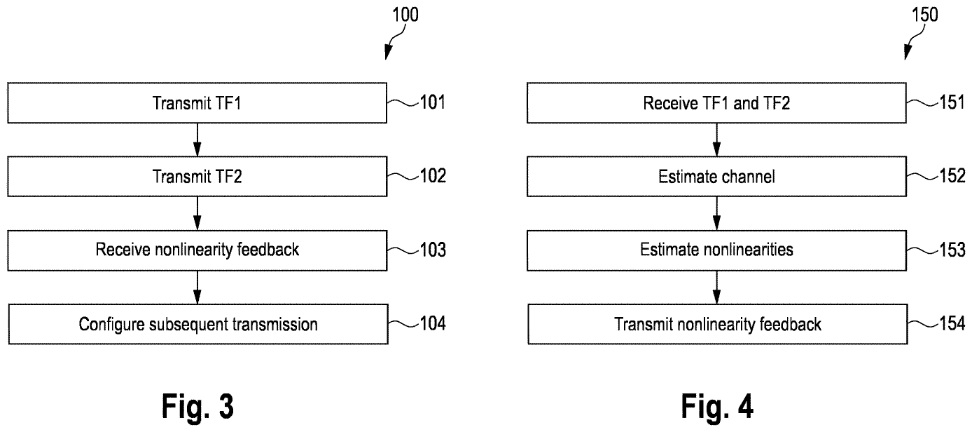

FIG. 3 shows a flowchart of a first communication method 100 carried out by a first communication device (e.g. TX 2) according to the present disclosure. In a first step 101 a first training field comprising a channel estimation sequence for use by RX 5 to estimate the channel between the TX 2 and RX 5 is transmitted to RX 5. In a second step 102 a second training field comprising a nonlinearity estimation sequence for use by RX 5 to estimate nonlinearities between TX 2 and RX 5 is transmitted. The second training field has a higher peak-to-average-power ratio and/or a different average power than the first training field. In a third step 103 nonlinearity feedback is received from RX 5 with respect to the estimated nonlinearities. In a fourth step 104 the received nonlinearity feedback is used to configure a subsequent transmission (e.g. to RX 5 and/or to one or more different devices).

FIG. 4 shows a flowchart of a second communication method 150 carried out by a second communication device (e.g. RX 5) according to the present disclosure. In a first step 151 a first training field comprising a channel estimation sequence and a second training field comprising a nonlinearity estimation sequence. In a second (optional) step 152 the channel between TX 2 and RX 5 is estimated based on the received first training field, which is only performed if channel estimation of the channel is performed. In a third step 153 nonlinearities between TX 2 and RX 5 are estimated based on the received second training field. In a fourth step 154 nonlinearity feedback with respect to the estimated nonlinearities to the first communication device is transmitted to TX 2.

According to an embodiment of the present disclosure, the nonlinearity of a communication device, e.g. a wireless transmitter, may be estimated by means of a polynomial. The estimation order P is the number of coefficients of the polynomial that represents the nonlinearity. The coefficients depend on the specific hardware implementation (chip, internal wiring . . . ) of transmitter components and on temperature fluctuations, supply voltage instabilities, etc. The estimated coefficients may represent the coefficients ap of a polynomial of the form:

$${\hat{f}}_{p a} ( x ) = {{\sum }^{P - 1}}_{p = 0} {\hat{a}}_{p} {ψ}_{p} ( x ) \qquad ( 1 )$$

More specifically, it may be constructed with one of the following basis functions

$${ψ}_{p}^{} ( x ) :$$

### Complex Baseband Monomials:

$${ψ}_{p}^{B B} ( x ) = x {\vert x \vert}^{2 p} ; \qquad ( 2 )$$

### Laguerre Basis Functions:

$${ψ}_{p}^{L A} ( x ) = {\sum }_{l = 0}^{p} \frac{{( - 1 )}^{l + p}}{l ! \sqrt{p + 1}} ( \begin{matrix}p + 1 \\ l + 1\end{matrix} ) {ψ}_{l}^{B B} ( x ) ; \qquad ( 3 )$$

### Hermite Basis Functions:

$${ψ}_{p}^{I H} ( x ) = {{\sum }_{l = 0}}^{p} {( - 1 )}^{l} l ! p ( \begin{matrix}p + 1 \\ l\end{matrix} ) ( \begin{matrix}p \\ l\end{matrix} ) {ψ}_{p - l}^{B B} ( x ) ; \qquad ( 4 )$$

### Legendre Basis Functions:

$${ψ}_{p}^{O P} ( x ) = {{\sum }_{l = 0}}^{p} {( - 1 )}^{l + p} \frac{( p + l + 2 ) !}{l ! ( l + 2 ) ! ( p - l ) !} x {\vert x \vert}^{l} . \qquad ( 5 )$$

Training fields (TFs) are defined for transmission by the wireless transmitter. The optimal estimation order P has an influence on the accuracy of the nonlinearity estimate, i.e., too few coefficients result in poor modeling accuracy and too many coefficients may not be estimated accurately due to higher impact of noise. The estimation order can be determined iteratively as described below in more detail. Using an accuracy indicator, the estimation order P may be increased until the accuracy is high enough. Alternatively, the optimal estimation order P may be derived from the signal-to-noise ratio of the signal received by the RX.

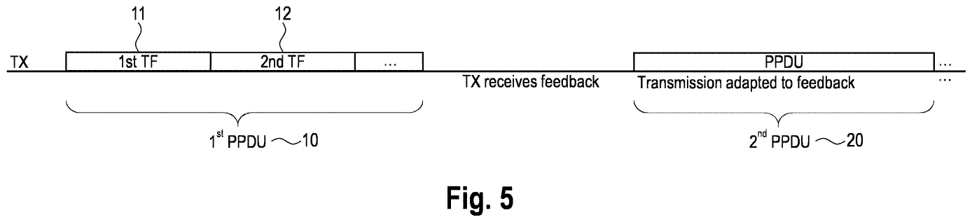

FIG. 5 schematically illustrates an embodiment of the method for estimation of nonlinearities (of TX 2, RX 5 and/or the channel 4) according to the present disclosure. According to this embodiment the TX 2 transmits a first data unit 10 (in this case a PPDU) holding a first TF 11 and a second TF 12. The two TFs 11, 12 have different peak-to-average-power ratio (PAPR) or different average power. Subsequently, the TX 2 receives feedback 4 of the estimated nonlinearity from the RX. The TX then applies the feedback information for configuring (or generating) the transmission of subsequent data unit 20 (in this case a second PPDU).

The first TF 11 is intended for estimation of the channel frequency response or channel impulse response and may be a training field from WLAN standard IEEE 802.11, such as legacy long training field (L-LTF), very high throughput long training field (VHT-LTF), high efficiency long training field (HE-LTF), or extremely high throughput training field (EHT-LTF). These channel estimation sequences are usually designed with a low PAPR. A low PAPR design is desired to avoid the amplifier of the TX operating in its nonlinear region and/or to get a robust estimate of the channel frequency response or channel impulse response.

The second TF 12 (hereinafter also called N-TF) is intended for nonlinearity estimation and usually has a high PAPR to cover most of the power amplifier's dynamic range. The design criterion is different since the estimation of the nonlinearity requires the amplifier of the TX to operate in its nonlinear region. If the second TF 12 were used to estimate the channel frequency response, such estimates would be noisier than those obtained by the first TF. However, this may be compensated by transmitting several copies of the second TF 12. In contrast, if the first TF 11 were used to estimate the nonlinearity, those estimates would be noisier than those obtained by use of the second TF 12.

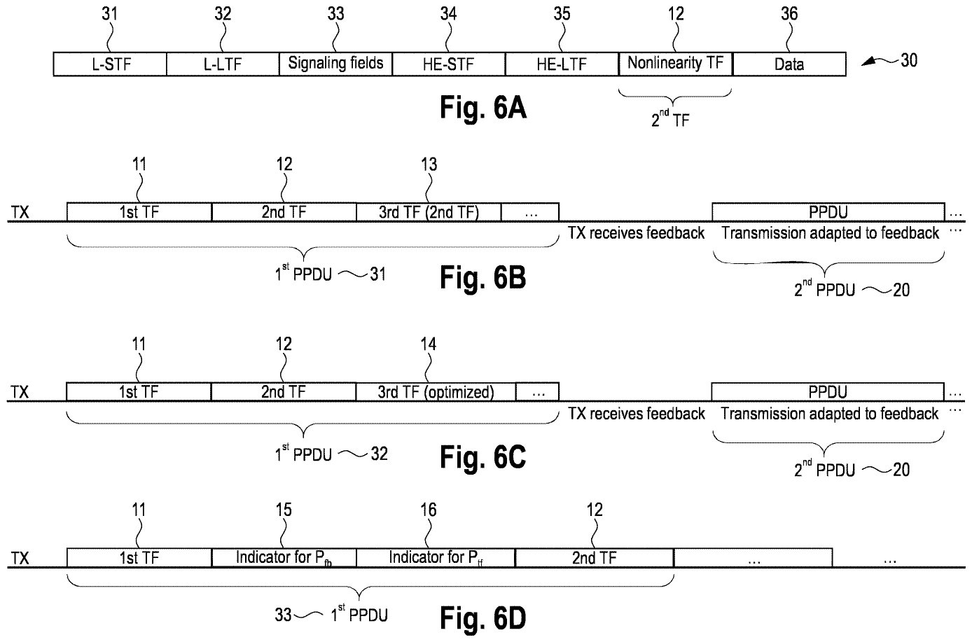

In the PPDU format defined in the standards IEEE 802.11, there may be multiple training fields for channel frequency response estimation, e.g., a L-LTF and a HE-LTF along with short training fields (STF) for, e.g., synchronization. Herein, however, the second TF 12 generally refers to the nonlinearity estimation training field and not to channel estimation fields such as STF or LTF. FIG. 6A shows a diagram of an exemplary first PPDU 30 containing multiple channel frequency response estimation training fields 31-35, a second TF 12 and a data field 36.

The second TF 12 may be parameterized with the total number of tones, the number of nonzero tones and the estimation order P it is optimized for. The estimation order P is a property of the second TF 12 that has been used as design criterion during optimization, i.e., for the optimized estimation order P, the second TF 12 achieves best estimation performance. However, it can be evaluated for any estimation order P at reduced performance. It may be defined in the frequency domain as one of the sequences given below in any one of multiple lists referred to as List1 to List24 provided at the end of the description.

In more general, the second TF 12 may be one of the sequences given in List1 to List24 or it may be obtained by performing one or more of the following operations on the sequences given in List1 to List24:
Shifting the phase of the whole sequence by the same angle, i.e., this phase shift should be applied on all tones contained in the sequence so that the phase shift is same for all tones.
Flip left and right in frequency domain, i.e., mirror the frequency axis and flip the tones of the sequence.
Transformation into time domain.
Transformation into time domain and flip left and right in time domain, i.e., mirror the time axis.
Transformation into time domain and rearrange/permute samples in time domain.
Transformation into time domain and concatenation of a copy or a part of the sequence to the sequence, which includes adding a cyclic prefix.
Transformation into time domain and concatenation of another sequence contained in List1 to List24 that was transformed into time domain.

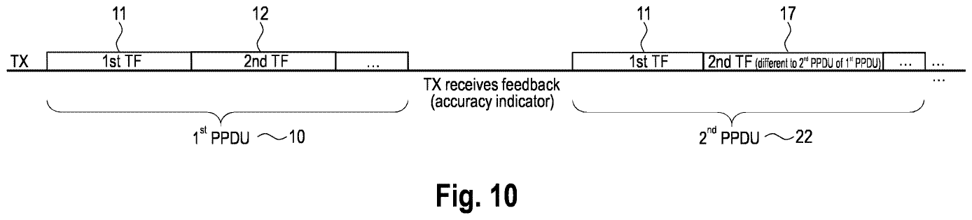

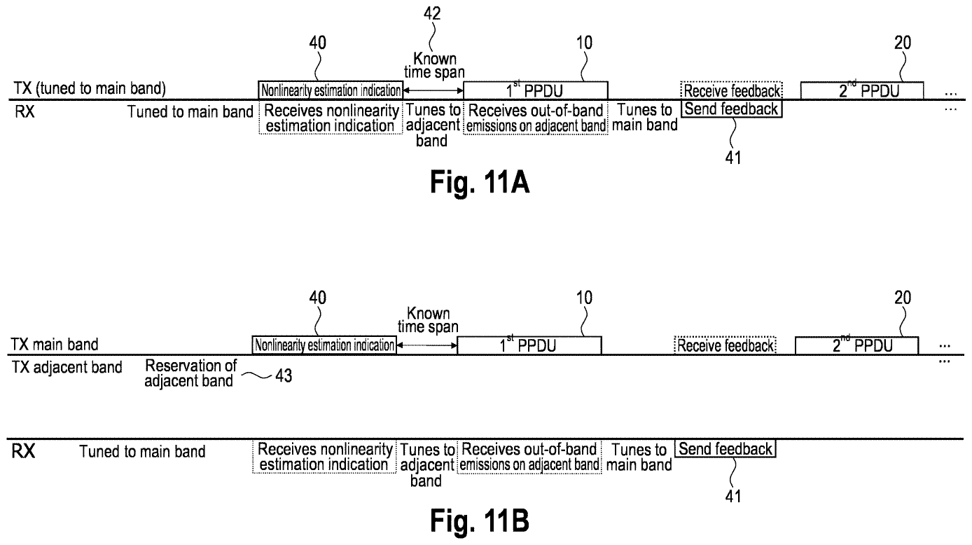

The second TF 12 may be chosen by the TX based on one or more of the following criteria:
The total number of tones of the second TF 12 directly depends on the bandwidth of the transmission and the communication standard defining the subcarrier spacing. The second TF 12 may have a bandwidth that is equal to or smaller than the bandwidth of the first TF 11. This is preferred because channel equalization may be used for those tones on which nonlinearity estimation is performed. Channel equalization may use the channel estimate on the second TF 12 meaning that the channel estimate may be used to remove the linear effects of the channel on the second TF 12.
The number of nonzero tones of the second TF 12 is chosen based on the format of the first TF 11 or on the requirement for the second TF 12 to be repetitive. Repetitive sequences have the benefit that noise smoothing is possible or that the TF may be shortened but provide less distinct sampling points of the nonlinear characteristic.
The estimation order P, that the second TF 12 is specified for, may be chosen arbitrarily if no prior knowledge is present, or it may be determined from the SNR of a PPDU received previously from the RX or it may be determined from previous feedback of RX on the optimal P. If P is chosen arbitrarily, it may not be the optimal P, but the optimal P may be determined with an iterative procedure (e.g. as described below with reference to an embodiment of a second PPDU shown in FIG. 10).

The TX may add a third TF to the first data unit (e.g. the first PPDU). FIG. 6B shows an embodiment of a first PPDU 31 comprising a third TF 13, which in this case is the same as the second TF 12. This may increase estimation quality because more samples can be used for estimation. FIG. 6C shows an embodiment of a first PPDU 32 comprising a third TF 14, which in this case is optimized for a different estimation order P than the second TF 12. Estimation of nonlinearity with a third TF 14 that is specifically designed for a particular estimation order may give more accurate estimation results.

The third TF 13, 14 can be used by the RX to estimate nonlinearity for a different estimation order than with the second TF 12 or to determine the accuracy of the already determined polynomial coefficients. The accuracy evaluation of polynomial coefficients based on the third TF 13, 14 may have the benefit that the third TF 13, 14 covers a high dynamic range. Thus, accuracy is also determined for high amplitudes.

Further, according to an embodiment the TX may add to the first PPDU a first indicator 15 (herein also called feedback estimation order indicator) for the estimation order P_{fb} that determines how may coefficients should be contained in the feedback. This information may also reside in a separate frame that is sent before the PPDU or at least before the second TF 12. Additionally, the TX may add to the first PPDU a second indicator 16 (herein also called transmission estimation order indicator) for the estimation order P_{tf} that determines for which estimation order the second TF 12 of the first PPDU is specified. FIG. 6D shows an embodiment of a first PPDU 33 comprising a feedback estimation order indicator 15 and a transmission estimation order indicator 16.

If a third TF 13, 14 is present in the first PPDU, the TX may add to the first PPDU a third indicator (herein also called another transmission estimation order indicator) for the estimation orders P_{tf2} and P_{tf3} that determine for which estimation order the second TF 12 and third TF 13, 14 of the first PPDU are specified.

The nonlinearity feedback may include one or more of the following:
Coefficients of the polynomial representing the nonlinearity. These coefficients may be P real or complex numbers. The number P of coefficients (also called “estimation order”) may be indicated from the TX using a feedback estimation order indicator 15 in the first PPDU or it is determined from the received second TF that is specified for a given P. The coefficients may be used by the TX for, e.g., predistortion. In addition to the coefficients, the nonlinearity feedback may include the choice of a basis function set of the basis function ψ(x) used for estimation.
The optimal estimation order P determined by the RX based on the signal-to-noise ratio (SNR).
An accuracy indicator that gives the accuracy of the nonlinearity estimation that was performed by the RX with the received first PPDU.

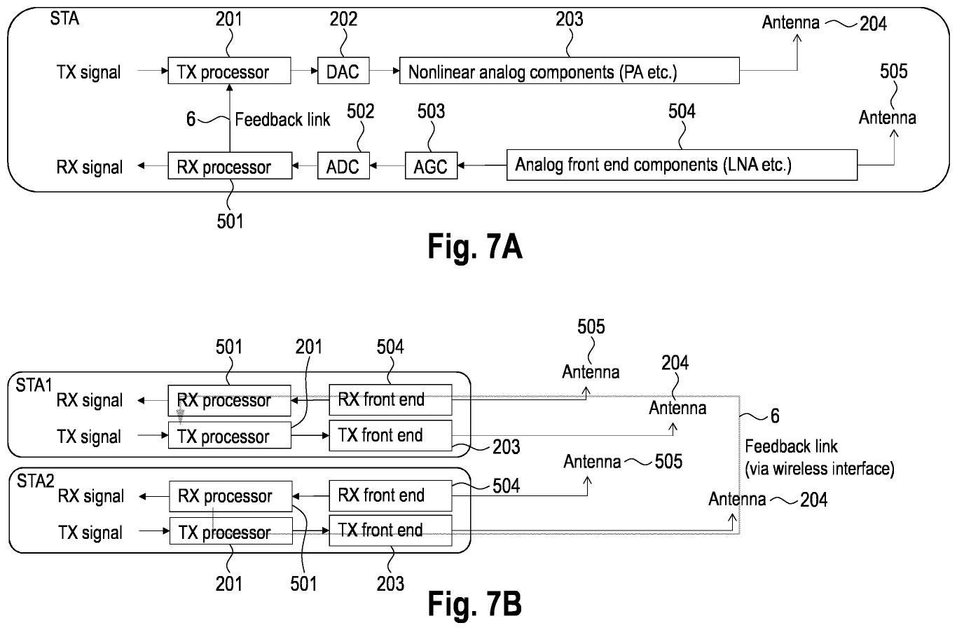

The signaling of the nonlinearity feedback may be performed wirelessly as shown in FIG. 7B or via a wired interface as shown in FIG. 7A. According to the embodiment of the communication scheme shown in FIG. 7A the TX and the RX are included in a common STA. The TX of this embodiment comprises a TX processor 201, a digital-to-analog (DAC) converter 202, a TX front end 203 (comprising one or more nonlinear analog components such as a power amplifier (PA)), and an antenna 204. The RX of this embodiment comprises an RX processor 501, an analog-to-digital (ADC) converter 502, an automatic gain control (AGC) unit 503, an RX front end 504 (comprising one or more analog components such as a low noise amplifier (LNA)), and an antenna 505. A wired feedback link 6 connects the RX processor 501 and the TX processor 201 and enables the transfer of nonlinearity feedback from the RX to the TX.

According to the embodiment of the communication scheme shown in FIG. 7B, each of two STAs STA1 and STA2 comprises a TX and an RX, both shown in a simplified diagram. The TX in both STAs comprises a TX processor 201, a TX front end 203 and a TX antenna 204. The RX in both STAs comprises an RX processor 501, an RX front end 504 and an RX antenna 505. A wireless feedback link 6 connects the RX processor 501 of STA2 and the TX processor 201 of STA1 and enables the transfer of nonlinearity feedback from STA2 to STA1.

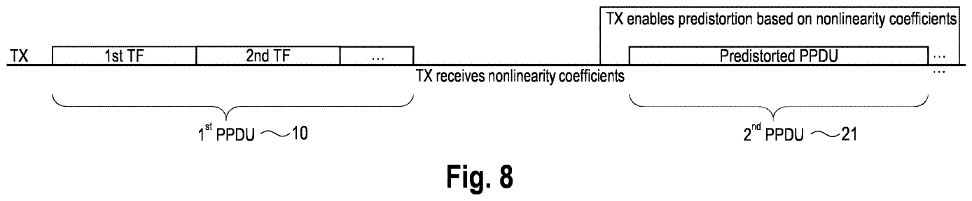

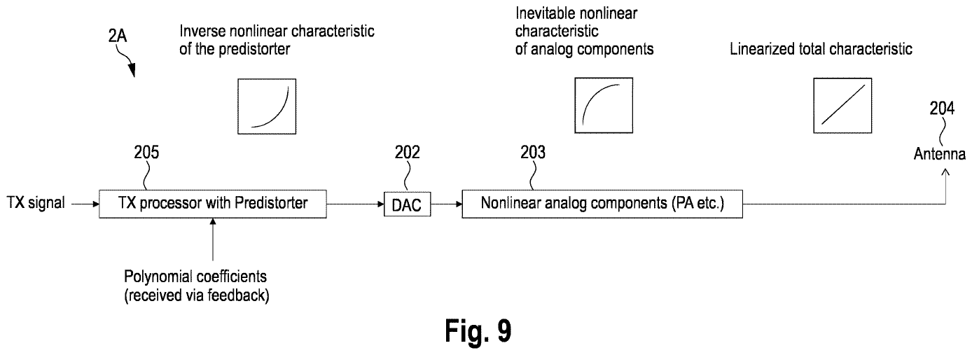

There are different options to apply the feedback information, i.e. the nonlinearity feedback, to configure a transmission of one or more subsequent PPDUs. According to a first option predistortion is applied on the one or more subsequent PPDUs based on an inverse nonlinear characteristic obtained by the polynomial coefficients. This is illustrated in FIG. 8 which shows a second PPDU 21 onto which predistortion is applied. FIG. 9 shows a schematic diagram of another embodiment of a TX 2A having a TX processor 205 including predistortion means (e.g. a predistorter) for adapting the transmit signal (i.e. the one or more subsequent PPDUs) using the provided coefficients such that the overall transmit characteristic of the transmit signal is linearized. The predistorter may also be provided as separate element. FIG. 9 further shows the inverse nonlinear characteristic of the predistorter, the nonlinear characteristic of the analog components 203 and the linearized total characteristic.

According to a second option a different second TF is transmitted in a subsequent PPDU than in the first PPDU. FIG. 10 shows a second PPDU 22 including a first TF 11 and another second TF 17. This TF 17 may be a TF that is specified for a different estimation order P. With this second TF 17, the RX may estimate polynomial coefficients for a different (usually higher) estimation order to get a more accurate nonlinearity model. This may be done if the accuracy indicator obtained by the feedback is lower than a certain threshold or shows a higher accuracy than the accuracy of a previous feedback signaling, if known. In both cases, nonlinearity modeling accuracy may increase by nonlinearity estimation using a different (usually higher) estimation order. The described behavior helps to iteratively determine the optimal estimation order P.

According to a third option, a subsequent conventional PPDU may be transmitted, i.e., the nonlinearity estimation procedure is finished. This may be done if the accuracy indicator exceeds a certain threshold or shows lower accuracy than the accuracy of a previous feedback signaling, if known.

Generally, nonlinearity estimation can be performed using the received signal in the main band or using out-of-band emissions leaking into another band, in particular an adjacent band. However, if nonlinearity estimation is performed solely on another band (e.g. the adjacent band), it may be possible that the coefficient of the linear (x¹) component can inherently not be estimated since this component does not produce out-of-band emissions. Thus, predistortion is not feasible as an inverse nonlinear characteristic may not be determined. Consequently, feedback signaling of polynomial coefficients may not be useful in this case.

Nonlinearity estimation solely based on the out-of-band emissions that affect the other bands, e.g. adjacent bands, instead of based on the main-band signal is possible with the following procedure, for instance for TDD and IBFD operation modes. This is illustrated with reference to FIGS. 11A and 11B showing two different embodiments of a communication scheme making use of a main band and an adjacent band in TDD and IBFD operation modes.

According to a first embodiment shown in FIG. 11A, the TX may indicate via a nonlinearity estimation indicator 40 (herein also called “nonlinearity estimation indication” or “nonlinearity announcement”) to the RX to tune to a band that is adjacent to the main band used by the TX during transmission of the first PPDU 10 and then tune back to the main band for transmitting the nonlinearity feedback 41. Preferably, there should be a known or predetermined time span 42 between the end of nonlinearity estimation indicator 40 and the start of the first PPDU 10 which allows the RX to synchronize to the first PPDU 10 because synchronization to the first PPDU 10 solely based on the out-of-band emissions may not be feasible. According to a second embodiment shown in FIG. 11B, the TX may make a reservation 43 of the adjacent band (e.g., by RTS (ready-to-send) and/or CTS (clear-to-send) frames) to avoid interference from other users during nonlinearity estimation on the adjacent band.

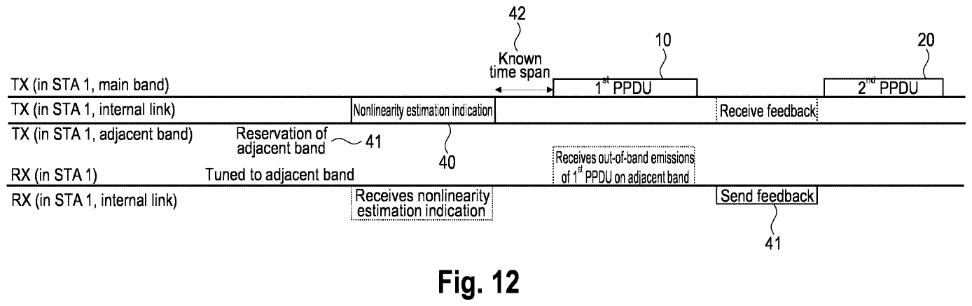

FIG. 12 shows a diagram of a communication scheme for use with FDD operation, wherein TX and RX are arranged in the same STA. In FDD operation, the nonlinearity can be estimated by the RX of the same STA. In this setup, it can be assumed that there exists an internal link between TX and RX (as e.g. shown in FIG. 7A). The TX may make a reservation 43 of the adjacent band to avoid interference from other users during nonlinearity estimation on the adjacent band. The internal link can be used to send a nonlinearity estimation indicator 40 from TX to RX. After a known time span 42 after the end of the indicator 40, the first PPDU 10 is transmitted (on the main band). This fixed time span 42 enables the RX to synchronize to the first PPDU 10, which may be infeasible based on solely the out-of-band emissions of the first PPDU 10.

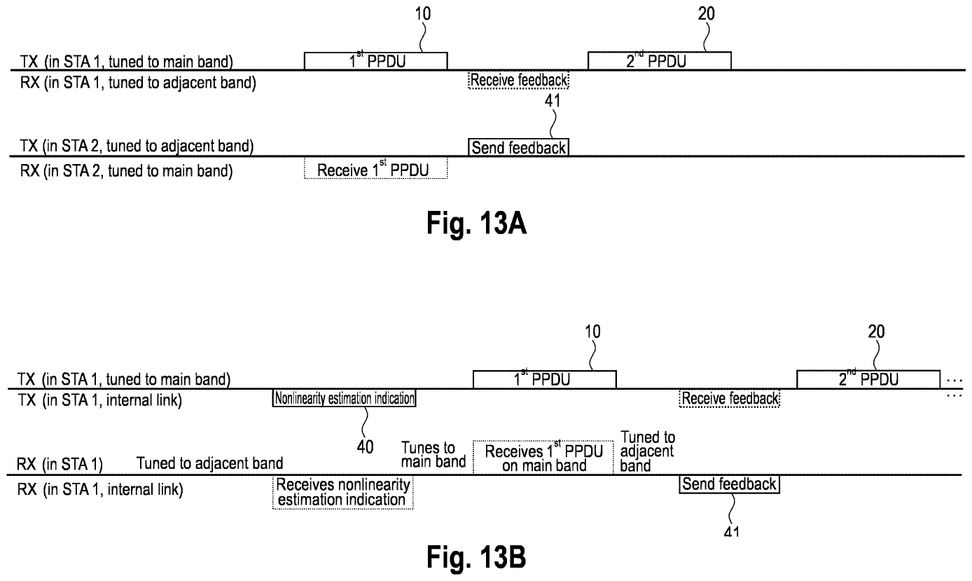

In FDD operation, nonlinearity estimation can also be done in the main band. This is illustrated with reference to FIGS. 13A and 13B showing two different embodiments of a communication scheme in FDD operation mode. According to a first embodiment shown in FIG. 13A, TX and RX are arranged in different STAs STA1 and STA2. The nonlinearity estimation is done in the main band, but feedback 41 is given wirelessly in the adjacent band. According to a second embodiment shown in FIG. 13B, TX and RX are arranged in the same STA. The RX of a STA is tuned to another band, e.g. the adjacent band, of this STA's own TX. However, nonlinearity estimation can also be performed in main band. A nonlinearity estimation indicator 40 is hence transmitted, e.g. on an internal link, that elicits tuning of the RX to the main band. Once the first PPDU 10 is transmitted and received by the RX on the main band, the RX may tune back to the adjacent band and may transmit the nonlinearity feedback 41, e.g. on the internal link.

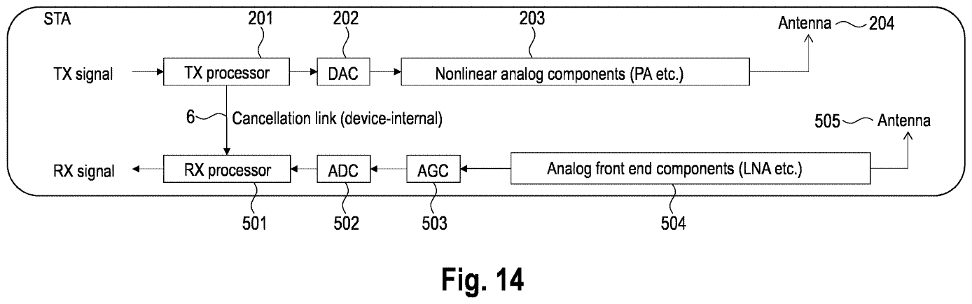

If TX and RX are located within the same device, e.g., in a full duplex FDD or IBFD system setup, the TX may provide its transmit signal to the RX via an internal link 6 (which may be a cancellation link) to enable self-interference cancellation at the RX. This is illustrated in FIG. 14 showing another embodiment of a communication scheme using an internal link for self-interference cancellation.

As explained already above, e.g. with reference to FIG. 4, the operation of the RX for estimation of nonlinearity may be summarized as follows. The RX receives a first PPDU holding a first TF and a second TF. The RX evaluates first TF of first PPDU to estimate the channel frequency response and then performs channel equalization using this channel estimate on the second TF. This can be done by means of conventional methods, e.g., zero-forcing (ZF) or minimum-mean-squared-error (MMSE) equalization. Further, the RX performs nonlinearity estimation on the equalized second TF and then provides nonlinearity feedback to the TX, which may include polynomial coefficients and choice of a basis function set, an optimal estimation order P and an accuracy indicator.

The coefficient estimation may be performed as follows. For the mathematical description of the coefficient estimation, the received equalized time-domain signal is denoted with y and the estimation matrix Ψ(xₑ) is constructed in the following form:

Ψ(xₑ)=[ψ₀(xₑ), . . . ,ψ_{P-1}(xₑ)]∈ [symbol] ^{N×P} (6)

The variable xₑ denotes the time-domain representation of the estimation sequence, i.e., the second TF of the first PPDU. The matrix Ψ(xₑ) is a complex-valued matrix of dimensionN× P, where N is the number of samples of the estimation sequence and P is the estimation order. In the matrix Ψ(xₑ), each column represents the p-th basis function ψₚ(xₑ) applied on the estimation sequence. The basis functions ψₚ(x) may be one of the function sets given above in one of the equations (2) to (5) (e.g. complex baseband monomials, Laguerre basis functions, Hermite basis functions, Legendre basis functions).

The polynomial coefficients â that represent the estimated nonlinear characteristic may be estimated using least squares estimation of the form:

â=Ψ(xₑ)⁺y=(Ψ(xₑ)^{H}Ψ(xₑ))⁻¹Ψ(xₑ)^{H}y. (7)

The plus symbol and the capital H letter written in superscript denote Moore-Penrose pseudo inverse or Hermitian transpose, respectively.

Alternatively, coefficient estimation may be performed in frequency domain. For this, the estimation matrix Ψ(xₑ) is constructed of the form:

Ψ(xₑ)=[ [symbol] (ψ₀(xₑ)), . . . , [symbol] (ψ_{P-1}(xₑ)]∈ [symbol] ^{N×P}. (8)

The matrix consists of columns being constructed of the Fourier transformed basis functions ψₚ(x). In equation (8) [symbol] (⋅) denotes Fourier transform.

The polynomial coefficients a can be estimated using least squares estimation from the received equalized signal in frequency domain y using the equation:

â=Ψ(xₑ)⁺y=(Ψ(xₑ)^{H}Ψ(xₑ))⁻¹Ψ(xₑ)^{H}y. (9)

The number P of estimated coefficients (“estimation order”) is indicated from the transmitter using an indicator in the first PPDU or it is determined from the received second TF that is specified for a given P.

The optimal estimation order may be determined by the RX based on the SNR of the received first PPDU. This may be done by means of a pre-defined look-up table that maps SNR values to values for optimal estimation order.

The accuracy included in the feedback may be calculated by the RX using one of the following fields:
A correctly received data field within the first PPDU (after first TF and potentially after second TF). This data field may have a high PAPR.
The received third TF of the first PPDU, if present.
The received second TF of the first PPDU, if polynomial coefficients are already known (e.g., due to previous nonlinearity estimations) and the accuracy of those coefficients shall be determined.

The accuracy, denoted by s, may be calculated as follows:

$$ε = \frac{1}{N} {( Ψ ( {x}_{t} ) \hat{a} - {y}_{e q} )}^{H} ( Ψ ( {x}_{t} ) \hat{a} - {y}_{e q} ) . \qquad ( 10 )$$

It may equal the mean squared error between the equalized received signal y_{eq}, which denotes the equalized version of the field mentioned above (in the previous paragraph), and a reconstructed distorted version of the signal xₜ, which denotes the undistorted, original version of the field mentioned above.

If a third TF13, 14 is present (as shown in FIGS. 6B and 6C) within the first PPDU 31, 32 and it is optimized for a different estimation order P, the RX may perform channel equalization on the third TF 13, 14 using the channel estimate obtained by the first TF 11. Further, the RX may perform nonlinearity estimation on an equalized third TF 13, 14 and/or additionally provide the polynomial coefficients obtained by nonlinearity estimation on the third TF 13, 14 within the nonlinearity feedback to the TX. Alternatively, the RX may average the polynomial coefficients obtained by nonlinearity estimation on the third TF 13, 14 with polynomial coefficients obtained by nonlinearity estimation on the second TF 12, and these average polynomial coefficients may be provided as nonlinearity feedback to the TX.

The RX may send the nonlinearity feedback to the TX via a wired interface or wirelessly. In FDD operation, the RX may send the feedback wirelessly on the adjacent band. If the RX receives a second PPDU 22 containing a further second TF 17 (as shown in FIG. 10) that is different to the second TF 12 of the first PPDU 10, the RX may process the second PPDU 22 as described above (in the previous paragraph) but may estimate a number P of coefficients that the second TF 17 of the second PPDU 22 is specified for. Hence, the number of coefficients may be different to the number of coefficients estimated with the second TF 12 of the first PPDU 10.

In TDD and IBFD operation, if the RX receives a nonlinearity estimation indicator (as shown in FIGS. 11A and 11B) it may tune to the adjacent band and receive the out-of-band emissions of the first PPDU after a known time span. In FDD operation, if the RX receives a nonlinearity estimation indicator (as shown in FIG. 12), it may receive the out-of-band emissions of the first PPDU after a known time span. In FDD operation, if the RX receives a nonlinearity estimation indicator (as shown in FIG. 13B), it may tune to the main band, receive the first PPDU and tune back to adjacent band. If the RX receives a nonlinearity estimation indicator, the automatic gain control (AGC) may be adjusted for a lower gain during receiving of the second TF of the first PPDU than during receiving the first TF of the first PPDU to prevent RX-sided nonlinear distortions.

If TX and RX are located within the same device, e.g., in a full duplex FDD or IBFD system setup, the RX may perform self-interference cancellation using the estimated polynomial coefficients and the transmit signal provided by the TX (as shown in FIG. 14). This may be done with the following steps. Initially, a signal y affected with self-interference is received. The TX signal xₜ is fetched device-internally, the self-interference estimate ŷₛᵢ=Ψ(xₜ)â is computed with matrix Ψ defined according to equation (6) and the polynomial coefficients â. Only for an FDD system operation, the matrix Y is calculated with an oversampled version of xₜ and the adjacent channel signal part of the result of Ψ(xₜ) â is extracted, e.g. via Fourier transform, subcarrier selection and subsequent inverse Fourier transform. Subsequently, self-interference cancellation is performed on the received signal y via subtraction of the self-interference estimate y_{sic}=y−ŷₛᵢ Finally, y_{sic} is processed further as in conventional receivers, e.g. by frame parsing, decoding, etc.

The frequency-domain representation of the second TF (N-TF) for nonlinearity estimation is given in the following. Each sequence is one orthogonal frequency division multiplexing (OFDM) symbol long. The number of total tones and the number of non-zero tones as well as the nonzero tone positions of all N-TFs are adapted to TFs defined in IEEE 802.11 standards. The number of total tones and the number of non-zero tones are given in the second and third column of Table 1. The formats of the N-TFs are given in the fourth column of Table 1 using TF identifiers that refer to TFs of current IEEE 802.11 standards and define the non-zero tone positions based on TFs of IEEE 802.11. The suffix numbers (20, 40, 80, 160) in the TF identifiers denote the bandwidth in MHz. The fifth column of Table 1 gives a reference to the TFs in the standard from which the format is taken to construct the N-TFs. For each format, an N-TF is given that is optimized for each estimation order from P=3 to P=10. The sequences are optimized for estimation with Laguerre basis functions but perform well with other basis functions. They are obtained by minimizing the Cramer-Rao bound of the nonlinearity estimator.

The sequences are normalized to unit power. Further, the sequences have a PAPR lower than or equal to 13.053 dB. Having unit variance, this corresponds to a maximum magnitude of 4.4942 in time domain, which is the optimal maximum amplitude with respect to the tradeoff between clipping and quantization errors for Gaussian distributed signals considering a 10-bit DAC.

TABLE 1
List of all N-TFs for nonlinearity estimation

| | Total | Number of | | |
|---|---|---|---|---|
| List | number | non-zero | | |
| number | of tones | tones | TF identifier | Reference to standard document |
| List1 | 64 | 12 | LSTF20/ | IEEE Std 802.11-2020, Eq. (19-8)/IEEE |
| | | | VHTSTF20 | Std 802.11ac-2013, Eq. (22-29) |
| List2 | 64 | 52 | LLTF20 | IEEE Std 802.11-2020, Eq. (19-11) |
| List3 | 64 | 56 | VHTLTF20 | IEEE Std 802.11ac-2013, Eq. (22-36) |
| List4 | 128 | 24 | LSTF40/ | IEEE Std 802.11-2020, Eq. (19-9)/IEEE |
| | | | VHTSTF40 | Std 802.11ac-2013, Eq. (22-30) |
| List5 | 128 | 104 | LLTF40 | IEEE Std 802.11-2020, Eq. (19-12) |
| List6 | 128 | 114 | VHTLTF40 | IEEE Std 802.11ac-2013, Eq. (22-37) |
| List7 | 256 | 14 | HESTF20 | IEEE Std 802.11ax-2021, Eq. (27-23) |
| List8 | 256 | 48 | LSTF80/ | IEEE Std 802.11-2020, Eq. (21-18)/ |
| | | | VHTSTF80 | IEEE Std 802.11ac-2013, Eq. (22-31) |
| List9 | 256 | 60 | 1xHELTF20 | IEEE Std 802.11ax-2021, Eq. (27-41) |
| List10 | 256 | 122 | 2xHELTF20 | IEEE Std 802.11ax-2021, Eq. (27-42) |
| List11 | 256 | 208 | LLTF80 | IEEE Std 802.11-2020, Eq. (21-21) |
| List12 | 256 | 242 | 4xHELTF20/ | IEEE Std 802.11ax-2021, Eq. (27-43)/ |
| | | | VHTLTF80 | IEEE Std 802.11ac-2013, Eq. (22-38) |
| List13 | 512 | 30 | HESTF40 | IEEE Std 802.11ax-2021, Eq. (27-24) |
| List14 | 512 | 122 | 1xHELTF40 | IEEE Std 802.11ax-2021, Eq. (27-44) |
| List15 | 512 | 242 | 2xHELTF40 | IEEE Std 802.11ax-2021, Eq. (27-45) |
| List16 | 512 | 484 | 4xHELTF40 | IEEE Std 802.11ax-2021, Eq. (27-46) |
| List17 | 1024 | 62 | HESTF80 | IEEE Std 802.11ax-2021, Eq. (27-25) |
| List18 | 1024 | 250 | 1xHELTF80 | IEEE Std 802.11ax-2021, Eq. (27-47) |
| List19 | 1024 | 498 | 2xHELTF80 | IEEE Std 802.11ax-2021, Eq. (27-48) |
| List20 | 1024 | 996 | 4xHELTF80 | IEEE Std 802.11ax-2021, Eq. (27-49) |
| List21 | 2048 | 124 | HESTF160 | IEEE Std 802.11ax-2021, Eq. (27-26) |
| List22 | 2048 | 500 | 1xHELTF160 | IEEE Std 802.11ax-2021, Eq. (27-50) |
| List23 | 2048 | 996 | 2xHELTF160 | IEEE Std 802.11ax-2021, Eq. (27-51) |
| List24 | 2048 | 1992 | 4xHELTF160 | IEEE Std 802.11ax-2021, Eq. (27-52) |

In the following the N-TFs for List1 to List 24 are given.

### List1

For 20 MHz transmission, the N-TF sequence with the format of an LSTF20, optimized for estimation order P=3, is given by:

N-TF(LSTF20,P=3)=sqrt(64/12)·{0,0,0,0,0,0,0,0,−1,0,0,0,−1,0,0,0,−1,0,0,0,−1,0,0,0,−1,0,0,0,1,0,0,0,0,0,0,0,−1,0,0,0,−1,0,0,0,1,0,0,0,−1,0,0,0,−1,0,0,0,1,0,0,0,0,0,0,0}

For 20 MHz transmission, the N-TF sequence with the format of an LSTF20, optimized for estimation order P=4, is given by:

N-TF(LSTF20,P=4)=sqrt(64/12)·{0,0,0,0,0,0,0,0,−1,0,0,0,−1,0,0,0,1,0,0,0,−1,0,0,0,−1,0,0,0,−1,0,0,0,0,0,0,0,−1,0,0,0,−1,0,0,0,1,0,0,0,1,0,0,0,−1,0,0,0,−1,0,0,0,0,0,0,0}

For 20 MHz transmission, the N-TF sequence with the format of an LSTF20, optimized for estimation order P=5, is given by:

N-TF(LSTF20,P=5)=sqrt(64/12)·{0,0,0,0,0,0,0,0,−1,0,0,0,−1,0,0,0,−1,0,0,0,−1,0,0,0,−1,0,0,0,1,0,0,0,0,0,0,0,1,0,0,0,−1,0,0,0,1,0,0,0,−1,0,0,0,−1,0,0,0,−1,0,0,0,0,0,0,0}

For 20 MHz transmission, the N-TF sequence with the format of an LSTF20, optimized for estimation order P=6, is given by:

N-TF(LSTF20,P=6)=sqrt(64/12)·{0,0,0,0,0,0,0,0,1,0,0,0,−1,0,0,0,−1,0,0,0,−1,0,0,0,1,0,0,0,−1,0,0,0,0,0,0,0,−1,0,0,0,1,0,0,0,1,0,0,0,−1,0,0,0,−1,0,0,0,1,0,0,0,0,0,0,0}

For 20 MHz transmission, the N-TF sequence with the format of an LSTF20, optimized for estimation order P=7, is given by:

N-TF(LSTF20,P=7)=sqrt(64/12)·{0,0,0,0,0,0,0,0,−1,0,0,0,−1,0,0,0,−1,0,0,0,−1,0,0,0,−1,0,0,0,−1,0,0,0,0,0,0,0,1,0,0,0,1,0,0,0,1,0,0,0,−1,0,0,0,−1,0,0,0,1,0,0,0,0,0,0,0}

For 20 MHz transmission, the N-TF sequence with the format of an LSTF20, optimized for estimation order P=8, is given by:

N-TF(LSTF20,P=8)=sqrt(64/12)·{0,0,0,0,0,0,0,0,−1,0,0,0,−1,0,0,0,−1,0,0,0,1,0,0,0,1,0,0,0,1,0,0,0,0,0,0,0,−1,0,0,0,−1,0,0,0,1,0,0,0,−1,0,0,0,1,0,0,0,1,0,0,0,0,0,0,0}

For 20 MHz transmission, the N-TF sequence with the format of an LSTF20, optimized for estimation order P=9, is given by:

N-TF(LSTF20,P=9)=sqrt(64/12)·{0,0,0,0,0,0,0,0,1,0,0,0,−1,0,0,0,1,0,0,0,−1,0,0,0,1,0,0,0,−1,0,0,0,0,0,0,0,1,0,0,0,1,0,0,0,−1,0,0,0,1,0,0,0,1,0,0,0,1,0,0,0,0,0,0,0}

For 20 MHz transmission, the N-TF sequence with the format of an LSTF20, optimized for estimation order P=10, is given by:

N-TF(LSTF20,P=10)=sqrt(64/12)·{0,0,0,0,0,0,0,0,−1,0,0,0,−1,0,0,0,−1,0,0,0,1,0,0,0,1,0,0,0,1,0,0,0,0,0,0,0,−1,0,0,0,−1,0,0,0,1,0,0,0,1,0,0,0,−1,0,0,0,−1,0,0,0,0,0,0,0}

### List2

For 20 MHz transmission, the N-TF sequence with the format of an LLTF20, optimized for estimation order P=3, is given by:

N-TF(LLTF20,P=3)=sqrt(64/52)·{0,0,0,0,0,0,−1,−1,1,1,−1,1,−1,1,−1,1,−1,1,−1,1,−1,1,1,1,−1,1,−1,1,−1,1,−1,−1,0,−1,1,1,1,1,1,1,1,−1,1,1,1,1,−1,1,−1,1,−1,1,−1,1,−1,1,−1,1,−1,0,0,0,0,0}

For 20 MHz transmission, the N-TF sequence with the format of an LLTF20, optimized for estimation order P=4, is given by:

N-TF(LLTF20,P=4)=sqrt(64/52)·{0,0,0,0,0,0,1,−1,−1,1,−1,−1,−1,−1,−1,−1,−1,1,−1,−1,−1,1,−1,1,−1,1,−1,−1,−1,1,−1,−1,0,1,−1,−1,−1,−1,−1,−1,1,−1,−1,−1,−1,−1,−1,1,−1,−1,−1,1,−1,1,−1,1,−1,1,1,0,0,0,0,0}

For 20 MHz transmission, the N-TF sequence with the format of an LLTF20, optimized for estimation order P=5, is given by:

N-TF(LLTF20,P=5)=sqrt(64/52)·{0,0,0,0,0,0,−1,−1,1,1,1,1,1,1,1,1,−1,1,−1,1,−1,1,−1,1,−1,1,−1,1,1,1,1,1,0,1,1,1,1,1,1,1,−1,1,−1,1,1,1,−1,1,1,1,−1,1,1,1,1,1,1,1,1,0,0,0,0,0}

For 20 MHz transmission, the N-TF sequence with the format of an LLTF20, optimized for estimation order P=6, is given by:

N-TF(LLTF20,P=6)=sqrt(64/52)·{0,0,0,0,0,0,1,1,1,1,1,1,1,1,1,1,1,1,−1,1,−1,1,−1,1,−1,1,−1,1,−1,1,−1,1,0,1,−1,−1,−1,1,1,1,1,1,1,1,1,1,1,1,1,1,1,1,−1,1,−1,1,−1,1,−1,0,0,0,0,0}

For 20 MHz transmission, the N-TF sequence with the format of an LLTF20, optimized for estimation order P=7, is given by:

N-TF(LLTF20,P=7)=sqrt(64/52)·{0,0,0,0,0,0,−1,1,−1,1,−1,1,−1,1,−1,1,1,1,1,1,1,1,1,1,1,1,1,1,1,1,1,1,0,1,1,1,−1,1,−1,1,−1,1,−1,1,−1,1,1,1,−1,1,−1,1,−1,1,1,1,1,1,1,0,0,0,0,0}

For 20 MHz transmission, the N-TF sequence with the format of an LLTF20, optimized for estimation order P=8, is given by:

N-TF(LLTF20,P=8)=sqrt(64/52) {0,0,0,0,0,0,−1,−1,−1,−1,−1,−1,−1,−1,−1,−1,−1,−1,−1,−1,−1,−1,−1,−1,−1,−1,−1,1,−1,1,−1,1,0,1,−1,1,−1,1,1,1,−1,1,−1,1,−1,1,−1,1,−1,1,−1,−1,−1,−1,−1,−1,−1,−1,−1,0,0,0,0,0}

For 20 MHz transmission, the N-TF sequence with the format of an LLTF20, optimized for estimation order P=9, is given by:

N-TF(LLTF20,P=9)=sqrt(64/52)·{0,0,0,0,0,0,−1,1,−1,1,−1,1,1,−1,−1,1,1,−1,1,1,−1,1,−1,1,−1,1,1,−1,1,1,−1,1,0,1,−1,1,−1,1,−1,−1,1,−1,1,1,−1,−1,−1,1,−1,−1,−1,1,−1,−1,1,−1,−1,1,−1,0,0,0,0,0}

For 20 MHz transmission, the N-TF sequence with the format of an LLTF20, optimized for estimation order P=10, is given by:

N-TF(LLTF20,P=10)=sqrt(64/52)·{0,0,0,0,0,0,−1,−1,−1,−1,−1,−1,−1,−1,−1,−1,1,−1,−1,−1,−1,1,−1,−1,1,−1,−1,−1,−1,1,−1,−1,0,−1,−1,−1,1,−1,1,1,1,−1,1,−1,−1,1,−1,−1,−1,−1,−1,1,1,−1,−1,1,−1,−1,−1,0,0,0,0,0}

### List3

For 20 MHz transmission, the N-TF sequence with the format of an VHTLTF20, optimized for estimation order P=3, is given by:

N-TF(VHTLTF20,P=3)=sqrt(64/56)·{0,0,0,0,−1,−1,−1,−1,1,−1,−1,−1,−1,−1,1,−1,1,−1,−1,−1,1,−1,1,−1,1,−1,−1,−1,−1,−1,−1,−1,0,−1,1,−1,1,−1,−1,1,−1,−1,−1,−1,−1,1,−1,−1,−1,1,−1,1,−1,−1,−1,1,−1,−1,−1,1,−1,0,0,0}

For 20 MHz transmission, the N-TF sequence with the format of an VHTLTF20, optimized for estimation order P=4, is given by:

N-TF(VHTLTF20,P=4)=sqrt(64/56)·{0,0,0,0,1,1,−1,−1,1,−1,1,−1,1,−1,1,−1,1,−1,−1,−1,1,−1,−1,−1,1,−1,−1,−1,−1,−1,−1,−1,0,−1,−1,−1,−1,−1,1,−1,1,−1,1,−1,−1,−1,1,−1,−1,−1,1,−1,−1,−1,−1,−1,−1,−1,1,1,−1,0,0,0}

For 20 MHz transmission, the N-TF sequence with the format of an VHTLTF20, optimized for estimation order P=5, is given by:

N-TF(VHTLTF20,P=5)=sqrt(64/56)·{0,0,0,0,−1,−1,1,−1,−1,−1,1,−1,−1,−1,−1,−1,−1,−1,−1,−1,1,−1,1,−1,1,−1,−1,−1,1,1,1,−1,0,1,1,−1,−1,−1,1,1,1,−1,1,−1,−1,−1,−1,−1,1,−1,−1,−1,1,−1,−1,−1,1,−1,−1,−1,1,0,0,0}

For 20 MHz transmission, the N-TF sequence with the format of an VHTLTF20, optimized for estimation order P=6, is given by:

N-TF(VHTLTF20,P=6)=sqrt(64/56)·{0,0,0,0,−1,−1,1,−1,−1,−1,−1,−1,1,−1,−1,−1,−1,−1,1,−1,−1,−1,1,−1,−1,−1,−1,−1,1,−1,−1,−1,0,−1,1,−1,−1,−1,1,1,1,−1,1,−1,1,−1,−1,1,1,−1,1,−1,−1,−1,1,−1,1,−1,−1,−1,1,0,0,0}

For 20 MHz transmission, the N-TF sequence with the format of an VHTLTF20, optimized for estimation order P=7, is given by:

N-TF(VHTLTF20,P=7)=sqrt(64/56)·{0,0,0,0,−1,1,−1,1,−1,−1,−1,1,−1,−1,−1,−1,−1,1,−1,−1,−1,1,−1,1,−1,−1,−1,1,−1,−1,−1,−1,0,1,−1,−1,−1,1,−1,1,1,−1,−1,1,−1,−1,−1,−1,−1,1,−1,−1,−1,1,−1,1,−1,−1,−1,1,1,0,0,0}

For 20 MHz transmission, the N-TF sequence with the format of an VHTLTF20, optimized for estimation order P=8, is given by:

N-TF(VHTLTF20,P=8)=sqrt(64/56)·{0,0,0,0,1,−1,−1,−1,−1,−1,1,−1,−1,−1,1,−1,1,−1,−1,−1,1,−1,−1,−1,−1,−1,1,−1,−1,−1,1,1,0,−1,−1,−1,1,−1,−1,1,−1,−1,1,−1,−1,−1,1,−1,1,−1,−1,−1,1,−1,−1,−1,−1,−1,−1,−1,−1,0,0,0}

For 20 MHz transmission, the N-TF sequence with the format of an VHTLTF20, optimized for estimation order P=9, is given by:

N-TF(VHTLTF20,P=9)=sqrt(64/56)·{0,0,0,0,1,1,1,1,−1,−1,1,1,−1,1,1,1,−1,1,1,1,−1,1,1,1,−1,1,−1,1,−1,1,−1,1,0,1,−1,1,−1,1,−1,1,1,1,1,1,1,1,−1,1,1,1,−1,1,1,−1,−1,1,1,1,1,1,1,0,0,0}

For 20 MHz transmission, the N-TF sequence with the format of an VHTLTF20, optimized for estimation order P=10, is given by:

N-TF(VHTLTF20,P=10)=sqrt(64/56)·{0,0,0,0,−1,−1,1,−1,−1,1,−1,−1,1,−1,−1,−1,−1,1,−1,1,−1,1,−1,−1,−1,−1,−1,−1,−1,1,1,−1,0,−1,−1,−1,−1,−1,−1,1,−1,−1,−1,−1,−1,1,−1,−1,−1,−1,1,−1,1,−1,1,−1,−1,−1,−1,−1,−1,0,0,0}

### List4

For 40 MHz transmission, the N-TF sequence with the format of an LSTF40, optimized for estimation order P=3, is given by:

N-TF(LSTF40,P=3)=sqrt(128/24)·{0,0,0,0,0,0,0,0,1,0,0,0,−1,0,0,0,−1,0,0,0,−1,0,0,0,−1,0,0,0,−1,0,0,0,0,0,0,0,−1,0,0,0,1,0,0,0,1,0,0,0,−1,0,0,0,−1,0,0,0,−1,0,0,0,0,0,0,0,0,0,0,0,0,0,0,0,1,0,0,0,−1,0,0,0,−1,0,0,0,1,0,0,0,−1,0,0,0,1,0,0,0,0,0,0,0,−1,0,0,0,1,0,0,0,−1,0,0,0,−1,0,0,0,−1,0,0,0,−1,0,0,0,0,0,0,0}

For 40 MHz transmission, the N-TF sequence with the format of an LSTF40, optimized for estimation order P=4, is given by:

N-TF(LSTF40,P=4)=sqrt(128/24)·{0,0,0,0,0,0,0,0,−1,0,0,0,−1,0,0,0,1,0,0,0,1,0,0,0,1,0,0,0,−1,0,0,0,0,0,0,0,1,0,0,0,1,0,0,0,1,0,0,0,1,0,0,0,−1,0,0,0,1,0,0,0,0,0,0,0,0,0,0,0,0,0,0,0,1,0,0,0,−1,0,0,0,1,0,0,0,1,0,0,0,1,0,0,0,−1,0,0,0,0,0,0,0,−1,0,0,0,1,0,0,0,1,0,0,0,1,0,0,0,1,0,0,0,1,0,0,0,0,0,0,0}

For 40 MHz transmission, the N-TF sequence with the format of an LSTF40, optimized for estimation order P=5, is given by:

N-TF(LSTF40,P=5)=sqrt(128/24)·{0,0,0,0,0,0,0,0,−1,0,0,0,1,0,0,0,−1,0,0,0,1,0,0,0,−1,0,0,0,−1,0,0,0,0,0,0,0,1,0,0,0,−1,0,0,0,1,0,0,0,1,0,0,0,1,0,0,0,1,0,0,0,0,0,0,0,0,0,0,0,0,0,0,0,−1,0,0,0,1,0,0,0,−1,0,0,0,1,0,0,0,−1,0,0,0,1,0,0,0,0,0,0,0,1,0,0,0,−1,0,0,0,1,0,0,0,−1,0,0,0,1,0,0,0,1,0,0,0,0,0,0,0}

For 40 MHz transmission, the N-TF sequence with the format of an LSTF40, optimized for estimation order P=6, is given by:

N-TF(LSTF40,P=6)=sqrt(128/24)·{0,0,0,0,0,0,0,0,1,0,0,0,−1,0,0,0,−1,0,0,0,−1,0,0,0,1,0,0,0,−1,0,0,0,0,0,0,0,1,0,0,0,1,0,0,0,1,0,0,0,1,0,0,0,−1,0,0,0,1,0,0,0,0,0,0,0,0,0,0,0,0,0,0,0,−1,0,0,0,−1,0,0,0,1,0,0,0,1,0,0,0,−1,0,0,0,−1,0,0,0,0,0,0,0,1,0,0,0,1,0,0,0,−1,0,0,0,1,0,0,0,1,0,0,0,1,0,0,0,0,0,0,0}

For 40 MHz transmission, the N-TF sequence with the format of an LSTF40, optimized for estimation order P=7, is given by:

N-TF(LSTF40,P=7)=sqrt(128/24)·{0,0,0,0,0,0,0,0,−1,0,0,0,−1,0,0,0,1,0,0,0,−1,0,0,0,−1,0,0,0,−1,0,0,0,0,0,0,0,−1,0,0,0,1,0,0,0,1,0,0,0,−1,0,0,0,−1,0,0,0,1,0,0,0,0,0,0,0,0,0,0,0,0,0,0,0,1,0,0,0,−1,0,0,0,1,0,0,0,−1,0,0,0,−1,0,0,0,1,0,0,0,0,0,0,0,−1,0,0,0,1,0,0,0,−1,0,0,0,−1,0,0,0,−1,0,0,0,1,0,0,0,0,0,0,0}

For 40 MHz transmission, the N-TF sequence with the format of an LSTF40, optimized for estimation order P=8, is given by:

N-TF(LSTF40,P=8)=sqrt(128/24)·{0,0,0,0,0,0,0,0,1,0,0,0,1,0,0,0,1,0,0,0,−1,0,0,0,−1,0,0,0,1,0,0,0,0,0,0,0,1,0,0,0,−1,0,0,0,1,0,0,0,1,0,0,0,1,0,0,0,1,0,0,0,0,0,0,0,0,0,0,0,0,0,0,0,1,0,0,0,1,0,0,0,1,0,0,0,1,0,0,0,1,0,0,0,1,0,0,0,0,0,0,0,1,0,0,0,1,0,0,0,1,0,0,0,−1,0,0,0,1,0,0,0,1,0,0,0,0,0,0,0}

For 40 MHz transmission, the N-TF sequence with the format of an LSTF40, optimized for estimation order P=9, is given by:

N-TF(LSTF40,P=9)=sqrt(128/24)·{0,0,0,0,0,0,0,0,1,0,0,0,1,0,0,0,1,0,0,0,−1,0,0,0,1,0,0,0,−1,0,0,0,0,0,0,0,−1,0,0,0,1,0,0,0,1,0,0,0,1,0,0,0,−1,0,0,0,1,0,0,0,0,0,0,0,0,0,0,0,0,0,0,0,1,0,0,0,−1,0,0,0,1,0,0,0,−1,0,0,0,1,0,0,0,1,0,0,0,0,0,0,0,−1,0,0,0,1,0,0,0,−1,0,0,0,1,0,0,0,−1,0,0,0,1,0,0,0,0,0,0,0}

For 40 MHz transmission, the N-TF sequence with the format of an LSTF40, optimized for estimation order P=10, is given by:

N-TF(LSTF40,P=10)=sqrt(128/24)·{0,0,0,0,0,0,0,0,−1,0,0,0,−1,0,0,0,−1,0,0,0,−1,0,0,0,−1,0,0,0,−1,0,0,0,0,0,0,0,−1,0,0,0,−1,0,0,0,1,0,0,0,−1,0,0,0,−1,0,0,0,−1,0,0,0,0,0,0,0,0,0,0,0,0,0,0,0,−1,0,0,0,−1,0,0,0,−1,0,0,0,−1,0,0,0,1,0,0,0,−1,0,0,0,0,0,0,0,−1,0,0,0,−1,0,0,0,−1,0,0,0,−1,0,0,0,1,0,0,0,−1,0,0,0,0,0,0,0}

### List5

For 40 MHz transmission, the N-TF sequence with the format of an LLTF40, optimized for estimation order P=3, is given by:

N-TF(LLTF40,P=3)=sqrt(128/104)·{0,0,0,0,0,0,−1,−1,1,−1,−1,1,1,−1,1,1,1,−1,1,−1,1,−1,−1,1,1,−1,1,−1,1,−1,1,−1,0,−1,1,−1,−1,−1,1,−1,−1,1,1,−1,1,1,1,−1,1,−1,−1,1,1,−1,1,−1,−1,1,1,0,0,0,0,0,0,0,0,0,0,0,1,−1,1,−1,1,1,1,−1,1,1,−1,1,1,−1,1,1,1,−1,1,−1,1,1,1,−1,−1,−1,0,−1,−1,1,1,1,1,1,−1,1,1,−1,1,1,−1,−1,1,−1,−1,1,1,−1,1,1,1,−1,1,0,0,0,0,0}

For 40 MHz transmission, the N-TF sequence with the format of an LLTF40, optimized for estimation order P=4, is given by:

N-TF(LLTF40,P=4)=sqrt(128/104).

{0,0,0,0,0,0,−1,1,−1,1,−1,1,−1,1,1,−1,−1,−1,−1,−1,−1,−1,−1,−1,−1,−1,−1,−1,1,−1,−1,−1,0,1,−1,−1,−1,1,−1,1,1,1,−1,1,−1,−1,−1,1,−1,−1,1,1,1,−1,−1,−1,1,1,−1,0,0,0,0,0,0,0,0,0,0,0,−1,−1,−1,−1,−1,1,−1,−1,−1,−1,−1,1,−1,1,−1,1,−1,1,−1,1,−1,1,−1,1,−1,1,0,−1,−1,1,1,−1,−1,−1,−1,−1,−1,−1,−1,−1,−1,−1,−1,1,−1,−1,−1,−1,−1,1,−1,1,−1,0,0,0,0,0}

For 40 MHz transmission, the N-TF sequence with the format of an LLTF40, optimized for estimation order P=5, is given by:

N-TF(LLTF40,P=5)=sqrt(128/104)·{0,0,0,0,0,0,−1,−1,−1,1,−1,−1,1,1,−1,1,−1,−1,−1,−1,−1,1,−1,−1,1,1,−1,1,−1,1,−1,−1,0,−1,−1,1,−1,1,−1,−1,1,1,−1,−1,−1,−1,1,1,−1,−1,−1,−1,−1,−1,−1,−1,−1,1,−1,0,0,0,0,0,0,0,0,0,0,0,−1,1,−1,1,1,−1,−1,−1,−1,1,−1,−1,−1,1,−1,−1,−1,−1,1,−1,−1,−1,−1,1,−1,1,0,1,−1,1,−1,−1,1,−1,−1,1,−1,1,−1,−1,−1,1,−1,−1,−1,−1,1,−1,−1,1,1,1,−1,0,0,0,0,0}

For 40 MHz transmission, the N-TF sequence with the format of an LLTF40, optimized for estimation order P=6, is given by:

N-TF(LLTF40,P=6)=sqrt(128/104)·{0,0,0,0,0,0,−1,−1,−1,−1,−1,−1,1,−1,1,−1,1,1,−1,1,1,−1,1,−1,1,−1,1,1,−1,−1,−1,−1,0,−1,1,−1,1,−1,−1,1,1,1,1,−1,−1,−1,1,1,1,−1,−1,−1,−1,−1,−1,1,1,−1,−1,0,0,0,0,0,0,0,0,0,0,0,−1,−1,−1,−1,−1,−1,1,−1,1,−1,−1,−1,−1,1,−1,−1,1,−1,1,−1,1,1,1,−1,−1,−1,0,−1,1,−1,1,−1,−1,−1,−1,−1,−1,−1,1,−1,−1,−1,1,−1,−1,−1,−1,−1,1,−1,1,1,1,0,0,0,0,0}

For 40 MHz transmission, the N-TF sequence with the format of an LLTF40, optimized for estimation order P=7, is given by:

N-TF(LLTF40,P=7)=sqrt(128/104)·{0,0,0,0,0,0,−1,−1,−1,−1,−1,−1,−1,−1,−1,−1,−1,−1,1,−1,1,−1,1,−1,1,−1,−1,−1,−1,−1,1,−1,0,−1,1,−1,−1,1,−1,1,−1,−1,−1,−1,1,−1,−1,−1,−1,−1,1,1,1,−1,1,−1,1,−1,1,0,0,0,0,0,0,0,0,0,0,0,−1,−1,−1,−1,−1,−1,1,−1,−1,−1,−1,1,1,−1,1,−1,1,−1,1,1,−1,−1,1,−1,1,1,0,1,1,−1,−1,−1,−1,−1,−1,−1,−1,−1,−1,−1,−1,−1,−1,−1,1,−1,1,−1,1,−1,1,1,−1,0,0,0,0,0}

For 40 MHz transmission, the N-TF sequence with the format of an LLTF40, optimized for estimation order P=8, is given by:

N-TF(LLTF40,P=8)=sqrt(128/104)·{0,0,0,0,0,0,−1,1,−1,1,−1,−1,1,−1,1,1,−1,1,−1,1,−1,1,−1,1,−1,−1,1,−1,−1,1,−1,−1,0,1,−1,1,1,−1,1,1,−1,1,1,−1,1,−1,−1,1,−1,−1,1,−1,−1,1,−1,1,−1,1,−1,0,0,0,0,0,0,0,0,0,0,0,−1,1,−1,1,−1,−1,1,−1,−1,1,−1,1,−1,1,−1,1,−1,1,−1,−1,1,−1,−1,1,−1,1,0,1,−1,−1,1,−1,1,1,−1,1,−1,1,1,1,−1,1,−1,−1,1,−1,−1,1,−1,1,−1,1,1,0,0,0,0,0}

For 40 MHz transmission, the N-TF sequence with the format of an LLTF40, optimized for estimation order P=9, is given by:

N-TF(LLTF40,P=9)=sqrt(128/104)·{0,0,0,0,0,0,1,1,−1,1,1,1,−1,1,1,1,−1,1,−1,1,−1,1,−1,−1,−1,1,−1,−1,−1,1,1,−1,0,−1,1,1,1,−1,−1,1,1,1,−1,1,1,1,−1,1,−1,1,−1,1,−1,−1,−1,1,−1,−1,−1,0,0,0,0,0,0,0,0,0,0,0,1,1,−1,1,1,1,−1,1,−1,1,−1,1,−1,1,−1,1,−1,1,−1,1,−1,−1,−1,1,1,−1,0,−1,1,1,1,−1,−1,1,1,1,−1,−1,1,1,−1,1,−1,1,−1,1,−1,−1,−1,1,−1,−1,−1,0,0,0,0,0}

For 40 MHz transmission, the N-TF sequence with the format of an LLTF40, optimized for estimation order P=10, is given by:

N-TF(LLTF40,P=10)=sqrt(128/104)·{0,0,0,0,0,0,1,−1,1,−1,1,−1,1,−1,1,−1,1,1,1,1,1,−1,−1,−1,1,1,1,1,1,−1,1,−1,0,−1,1,−1,1,1,1,1,1,1,1,1,1,1,−1,−1,1,1,1,1,1,−1,−1,−1,1,1,1,0,0,0,0,0,0,0,0,0,0,0,1,−1,1,−1,1,1,1,−1,1,−1,1,1,1,1,−1,−1,−1,1,1,1,1,1,1,−1,1,−1,0,−1,1,−1,1,1,1,1,1,1,1,1,1,−1,−1,−1,1,1,1,1,1,−1,−1,−1,1,1,1,0,0,0,0,0}

### List6

For 40 MHz transmission, the N-TF sequence with the format of an VHTLTF40, optimized for estimation order P=3, is given by:

N-TF(VHTLTF40,P=3)=sqrt(128/114)·{0,0,0,0,0,0,1,−1,−1,−1,1,−1,1,−1,1,1,1,−1,1,−1,1,−1,1,1,1,−1,−1,−1,1,−1,1,1,1,1,1,−1,1,1,1,−1,1,1,1,1,1,1,1,1,−1,−1,1,−1,1,−1,−1,−1,1,−1,1,−1,1,1,−1,0,0,0,−1,1,−1,1,1,−1,−1,−1,1,−1,1,−1,1,−1,−1,−1,1,1,1,−1,1,1,−1,1,−1,−1,1,−1,1,−1,1,−1,1,−1,1,1,1,−1,−1,−1,1,−1,1,−1,−1,1,1,−1,−1,1,1,−1,1,−1,1,−1,1,0,0,0,0,0}

For 40 MHz transmission, the N-TF sequence with the format of an VHTLTF40, optimized for estimation order P=4, is given by:

N-TF(VHTLTF40,P=4)=sqrt(128/114)·{0,0,0,0,0,0,1,−1,−1,1,−1,1,1,−1,−1,1,−1,1,−1,−1,−1,−1,−1,−1,−1,1,−1,−1,−1,1,−1,1,−1,1,−1,−1,−1,1,−1,1,1,1,−1,1,−1,1,−1,1,−1,−1,−1,1,−1,−1,−1,−1,−1,1,−1,−1,−1,1,−1,0,0,0,1,1,−1,1,−1,1,1,1,−1,−1,−1,1,−1,−1,−1,−1,−1,1,−1,−1,−1,1,−1,−1,−1,1,−1,1,−1,−1,−1,1,1,1,−1,−1,−1,−1,−1,1,−1,1,1,−1,1,−1,−1,−1,−1,−1,−1,−1,1,−1,1,−1,−1,0,0,0,0,0}

For 40 MHz transmission, the N-TF sequence with the format of an VHTLTF40, optimized for estimation order P=5, is given by:

N-TF(VHTLTF40,P=5)=sqrt(128/114)·{0,0,0,0,0,0,−1,1,1,−1,−1,−1,−1,1,−1,1,−1,1,1,1,−1,−1,−1,1,1,−1,−1,1,−1,1,−1,−1,−1,1,−1,1,−1,−1,1,1,−1,1,−1,1,−1,1,1,−1,−1,1,−1,−1,−1,1,1,−1,−1,−1,1,1,−1,1,−1,0,0,0,−1,1,1,1,−1,1,−1,1,−1,1,−1,−1,−1,1,1,−1,−1,−1,−1,−1,−1,1,−1,1,−1,−1,−1,−1,−1,1,−1,−1,−1,−1,−1,−1,−1,−1,−1,1,−1,−1,−1,−1,−1,−1,−1,−1,−1,1,−1,1,−1,−1,−1,1,−1,0,0,0,0,0}

For 40 MHz transmission, the N-TF sequence with the format of an VHTLTF40, optimized for estimation order P=6, is given by:

N-TF(VHTLTF40,P=6)=sqrt(128/114)·{0,0,0,0,0,0,−1,−1,−1,1,1,1,1,1,1,1,1,1,−1,1,1,−1,1,−1,−1,−1,−1,−1,1,1,−1,1,−1,1,−1,1,1,1,1,1,1,1,1,1,1,1,1,1,1,1,−1,1,−1,1,1,1,−1,1,−1,1,−1,1,−1,0,0,0,−1,−1,−1,1,1,1,1,1,1,1,1,1,1,1,1,1,−1,1,1,1,−1,−1,1,1,1,1,−1,1,−1,1,1,1,−1,−1,−1,1,1,1,1,1,1,1,1,1,−1,1,−1,1,1,1,−1,1,−1,1,−1,1,1,0,0,0,0,0}

For 40 MHz transmission, the N-TF sequence with the format of an VHTLTF40, optimized for estimation order P=7, is given by:

N-TF(VHTLTF40,P=7)=sqrt(128/114)·{0,0,0,0,0,0,1,1,−1,1,1,1,1,1,1,−1,1,−1,1,−1,1,−1,1,1,1,1,1,1,1,1,1,−1,1,−1,1,−1,1,−1,1,−1,1,1,1,1,1,1,1,1,1,−1,1,1,1,−1,−1,−1,1,1,−1,−1,1,−1,−1,0,0,0,1,1,1,1,1,−1,1,−1,1,−1,1,−1,1,1,−1,1,1,1,1,1,1,−1,1,1,1,−1,1,−1,1,1,1,1,1,1,1,1,−1,−1,1,−1,1,−1,1,−1,1,−1,1,1,−1,−1,1,1,−1,1,1,−1,1,0,0,0,0,0}

For 40 MHz transmission, the N-TF sequence with the format of an VHTLTF40, optimized for estimation order P=8, is given by:

N-TF(VHTLTF40,P=8)=sqrt(128/114)·{0,0,0,0,0,0,1,1,1,−1,1,−1,1,−1,1,1,1,−1,1,1,1,1,1,1,1,−1,1,1,1,1,1,−1,−1,−1,1,1,1,1,1,−1,−1,1,1,1,1,1,1,1,1,1,1,−1,−1,−1,1,1,1,1,1,−1,−1,−1,−1,0,0,0,1,−1,1,1,1,1,1,1,1,−1,1,1,1,−1,1,−1,1,1,1,1,1,1,1,−1,−1,−1,1,1,1,1,1,1,1,1,1,1,−1,−1,1,1,1,1,1,−1,−1,−1,1,1,1,1,1,−1,−1,−1,1,1,1,0,0,0,0,0}

For 40 MHz transmission, the N-TF sequence with the format of an VHTLTF40, optimized for estimation order P=9, is given by:

N-TF(VHTLTF40,P=9)=sqrt(128/114)·{0,0,0,0,0,0,−1,−1,−1,1,−1,1,−1,1,−1,−1,1,1,−1,−1,−1,1,−1,1,−1,−1,−1,1,−1,−1,−1,1,−1,1,−1,−1,−1,1,1,−1,1,1,−1,1,−1,1,−1,1,1,−1,−1,−1,1,−1,−1,1,−1,−1,−1,1,−1,−1,−1,0,0,0,−1,−1,−1,1,−1,−1,−1,−1,1,1,−1,−1,−1,1,−1,1,−1,−1,−1,1,1,−1,−1,1,−1,1,−1,1,−1,−1,1,−1,−1,−1,−1,1,−1,1,−1,−1,−1,1,−1,−1,−1,1,−1,1,−1,−1,−1,1,1,−1,1,−1,−1,0,0,0,0,0}

For 40 MHz transmission, the N-TF sequence with the format of an VHTLTF40, optimized for estimation order P=10, is given by:

N-TF(VHTLTF40,P=10)=sqrt(128/114)·{0,0,0,0,0,0,−1,−1,−1,−1,−1,1,−1,−1,−1,−1,1,1,1,1,1,−1,1,1,1,1,−1,1,−1,1,1,−1,1,−1,−1,−1,−1,1,−1,−1,1,1,1,−1,−1,1,1,1,1,−1,1,−1,1,1,−1,−1,−1,−1,1,−1,1,−1,−1,0,0,0,1,−1,1,−1,1,−1,1,1,1,−1,1,−1,1,−1,1,−1,1,−1,−1,−1,−1,−1,1,−1,1,−1,1,−1,1,1,1,1,1,−1,1,−1,1,1,−1,1,−1,−1,1,−1,1,−1,−1,−1,−1,1,1,−1,1,−1,1,1,1,0,0,0,0,0}

### List7

For 20 MHz transmission, the N-TF sequence with the format of an HESTF20, optimized for estimation order P=3, is given by:

N-TF(HESTF20,P=3)=sqrt(256/14)·{0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0}

For 20 MHz transmission, the N-TF sequence with the format of an HESTF20, optimized for estimation order P=4, is given by:

N-TF(HESTF20,P=4)=sqrt(256/14)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0}

For 20 MHz transmission, the N-TF sequence with the format of an HESTF20, optimized for estimation order P=5, is given by:

N-TF(HESTF20,P=5)=sqrt(256/14)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0}

For 20 MHz transmission, the N-TF sequence with the format of an HESTF20, optimized for estimation order P=6, is given by:

N-TF(HESTF20,P=6)=sqrt(256/14)·{0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0, 0,0,0,0,0,0,0,0,0,0,0,1,0,0,0,0,0,0,0,0,0,0,0,0,0,0,0}

For 20 MHz transmission, the N-TF sequence with the format of an HESTF20, optimized for estimation order P=7, is given by:

N-TF(HESTF20,P=7)=sqrt(256/14)·{0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0}

For 20 MHz transmission, the N-TF sequence with the format of an HESTF20, optimized for estimation order P=8, is given by:

N-TF(HESTF20,P=8)=sqrt(256/14)·{0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0}

For 20 MHz transmission, the N-TF sequence with the format of an HESTF20, optimized for estimation order P=9, is given by:

N-TF(HESTF20,P=9)=sqrt(256/14)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0}

For 20 MHz transmission, the N-TF sequence with the format of an HESTF20, optimized for estimation order P=10, is given by:

N-TF(HESTF20,P=10)=sqrt(256/14)·{0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0, 0,0,0,0,0,0,0,0,0,0,0,1,0,0,0,0,0,0,0,0,0,0,0,0,0,0,0}

### List8

For 80 MHz transmission, the N-TF sequence with the format of an LSTF80, optimized for estimation order P=3, is given by:

N-TF(LSTF80, P=3)=sqrt(256/48)·{0,0,0,0,0,0,0,0,1,0,0,0,−1,0,0,0,−1,0,0,0,−1,0,0,0,−1,0,0,0,−1,0,0,0,0,0,0,0,1,0,0,0,1,0,0,0,1,0,0,0,−1,0,0,0,−1,0,0,0,−1,0,0,0,0,0,0,0,0,0,0,0,0,0,0,0,−1,0,0,0,1,0,0,0,−1,0,0,0,−1,0,0,0,−1,0,0,0,1,0,0,0,0,0,0,0,1,0,0,0,1,0,0,0,−1,0,0,0,−1,0,0,0,−1,0,0,0,−1,0,0,0,0,0,0,0,0,0,0,0,0,0,0,0,1,0,0,0,1,0,0,0,−1,0,0,0,−1,0,0,0,−1,0,0,0,−1,0,0,0,0,0,0,0,−1,0,0,0,−1,0,0,0,−1,0,0,0,−1,0,0,0,−1,0,0,0,−1,0,0,0,0,0,0,0,0,0,0,0,0,0,0,0,1,0,0,0,−1,0,0,0,−1,0,0,0,−1,0,0,0,−1,0,0,0,1,0,0,0,0,0,0,0,1,0,0,0,−1,0,0,0,−1,0,0,0,−1,0,0,0,−1,0,0,0,−1,0,0,0,0,0,0,0}

For 80 MHz transmission, the N-TF sequence with the format of an LSTF80, optimized for estimation order P=4, is given by:

N-TF(LSTF80, P=4)=sqrt(256/48)·{0,0,0,0,0,0,0,0,−1,0,0,0,−1,0,0,0,−1,0,0,0,−1,0,0,0,−1,0,0,0,1,0,0,0,0,0,0,0,−1,0,0,0,1,0,0,0,1,0,0,0,−1,0,0,0,1,0,0,0,−1,0,0,0,0,0,0,0,0,0,0,0,0,0,0,0,−1,0,0,0,1,0,0,0,−1,0,0,0,−1,0,0,0,−1,0,0,0,1,0,0,0,0,0,0,0,1,0,0,0,−1,0,0,0,−1,0,0,0,1,0,0,0,−1,0,0,0,−1,0,0,0,0,0,0,0,0,0,0,0,0,0,0,0,1,0,0,0,−1,0,0,0,−1,0,0,0,1,0,0,0,−1,0,0,0,1,0,0,0,0,0,0,0,−1,0,0,0,−1,0,0,0,−1,0,0,0,−1,0,0,0,−1,0,0,0,−1,0,0,0,0,0,0,0,0,0,0,0,0,0,0,0,−1,0,0,0,1,0,0,0,−1,0,0,0,−1,0,0,0,1,0,0,0,1,0,0,0,0,0,0,0,1,0,0,0,−1,0,0,0,−1,0,0,0,−1,0,0,0,−1,0,0,0,−1,0,0,0,0,0,0,0}

For 80 MHz transmission, the N-TF sequence with the format of an LSTF80, optimized for estimation order P=5, is given by:

N-TF(LSTF80, P=5)=sqrt(256/48)·{0,0,0,0,0,0,0,0,−1,0,0,0,−1,0,0,0,1,0,0,0,−1,0,0,0,−1,0,0,0,−1,0,0,0,0,0,0,0,−1,0,0,0,−1,0,0,0,1,0,0,0,−1,0,0,0,−1,0,0,0,−1,0,0,0,0,0,0,0,0,0,0,0,0,0,0,0,1,0,0,0,−1,0,0,0,1,0,0,0,−1,0,0,0,1,0,0,0,−1,0,0,0,0,0,0,0,−1,0,0,0,1,0,0,0,−1,0,0,0,−1,0,0,0,−1,0,0,0,−1,0,0,0,0,0,0,0,0,0,0,0,0,0,0,0,1,0,0,0,1,0,0,0,1,0,0,0,−1,0,0,0,1,0,0,0,−1,0,0,0,0,0,0,0,−1,0,0,0,1,0,0,0,−1,0,0,0,−1,0,0,0,−1,0,0,0,−1,0,0,0,0,0,0,0,0,0,0,0,0,0,0,0,1,0,0,0,−1,0,0,0,1,0,0,0,−1,0,0,0,1,0,0,0,1,0,0,0,0,0,0,0,1,0,0,0,1,0,0,0,−1,0,0,0,−1,0,0,0,−1,0,0,0,−1,0,0,0,0,0,0,0}

For 80 MHz transmission, the N-TF sequence with the format of an LSTF80, optimized for estimation order P=6, is given by:

N-TF(LSTF80, P=6)=sqrt(256/48)·{0,0,0,0,0,0,0,0,−1,0,0,0,−1,0,0,0,−1,0,0,0,1,0,0,0,−1,0,0,0,−1,0,0,0,0,0,0,0,−1,0,0,0,1,0,0,0,1,0,0,0,−1,0,0,0,1,0,0,0,−1,0,0,0,0,0,0,0,0,0,0,0,0,0,0,0,−1,0,0,0,−1,0,0,0,−1,0,0,0,1,0,0,0,−1,0,0,0,1,0,0,0,0,0,0,0,−1,0,0,0,−1,0,0,0,−1,0,0,0,−1,0,0,0,1,0,0,0,−1,0,0,0,0,0,0,0,0,0,0,0,0,0,0,0,1,0,0,0,−1,0,0,0,−1,0,0,0,1,0,0,0,−1,0,0,0,1,0,0,0,0,0,0,0,−1,0,0,0,−1,0,0,0,1,0,0,0,−1,0,0,0,1,0,0,0,−1,0,0,0,0,0,0,0,0,0,0,0,0,0,0,0,−1,0,0,0,−1,0,0,0,−1,0,0,0,1,0,0,0,−1,0,0,0,1,0,0,0,0,0,0,0,−1,0,0,0,1,0,0,0,−1,0,0,0,−1,0,0,0,1,0,0,0,−1,0,0,0,0,0,0,0}

For 80 MHz transmission, the N-TF sequence with the format of an LSTF80, optimized for estimation order P=7, is given by:

N-TF(LSTF80, P=7)=sqrt(256/48)·{0,0,0,0,0,0,0,0,1,0,0,0,−1,0,0,0,−1,0,0,0,−1,0,0,0,−1,0,0,0,−1,0,0,0,0,0,0,0,−1,0,0,0,−1,0,0,0,1,0,0,0,1,0,0,0,−1,0,0,0,1,0,0,0,0,0,0,0,0,0,0,0,0,0,0,0,1,0,0,0,−1,0,0,0,−1,0,0,0,−1,0,0,0,−1,0,0,0,−1,0,0,0,0,0,0,0,−1,0,0,0,−1,0,0,0,−1,0,0,0,1,0,0,0,−1,0,0,0,1,0,0,0,0,0,0,0,0,0,0,0,0,0,0,0,1,0,0,0,1,0,0,0,−1,0,0,0,−1,0,0,0,−1,0,0,0,−1,0,0,0,0,0,0,0,−1,0,0,0,−1,0,0,0,−1,0,0,0,1,0,0,0,−1,0,0,0,1,0,0,0,0,0,0,0,0,0,0,0,0,0,0,0,1,0,0,0,−1,0,0,0,−1,0,0,0,−1,0,0,0,−1,0,0,0,−1,0,0,0,0,0,0,0,1,0,0,0,−1,0,0,0,−1,0,0,0,1,0,0,0,−1,0,0,0,−1,0,0,0,0,0,0,0}

For 80 MHz transmission, the N-TF sequence with the format of an LSTF80, optimized for estimation order P=8, is given by:

N-TF(LSTF80, P=8)=sqrt(256/48)·{0,0,0,0,0,0,0,0,−1,0,0,0,−1,0,0,0,−1,0,0,0,−1,0,0,0,1,0,0,0,−1,0,0,0,0,0,0,0,−1,0,0,0,1,0,0,0,1,0,0,0,−1,0,0,0,−1,0,0,0,1,0,0,0,0,0,0,0,0,0,0,0,0,0,0,0,1,0,0,0,−1,0,0,0,−1,0,0,0,−1,0,0,0,1,0,0,0,−1,0,0,0,0,0,0,0,−1,0,0,0,1,0,0,0,−1,0,0,0,−1,0,0,0,−1,0,0,0,1,0,0,0,0,0,0,0,0,0,0,0,0,0,0,0,−1,0,0,0,1,0,0,0,−1,0,0,0,−1,0,0,0,1,0,0,0,−1,0,0,0,0,0,0,0,−1,0,0,0,1,0,0,0,−1,0,0,0,−1,0,0,0,−1,0,0,0,1,0,0,0,0,0,0,0,0,0,0,0,0,0,0,0,−1,0,0,0,−1,0,0,0,−1,0,0,0,−1,0,0,0,1,0,0,0,−1,0,0,0,0,0,0,0,1,0,0,0,1,0,0,0,−1,0,0,0,−1,0,0,0,−1,0,0,0,1,0,0,0,0,0,0,0}

For 80 MHz transmission, the N-TF sequence with the format of an LSTF80, optimized for estimation order P=9, is given by:

N-TF(LSTF80, P=9)=sqrt(256/48)·{0,0,0,0,0,0,0,0,−1,0,0,0,−1,0,0,0,−1,0,0,0,−1,0,0,0,−1,0,0,0,−1,0,0,0,0,0,0,0,1,0,0,0,−1,0,0,0,1,0,0,0,1,0,0,0,−1,0,0,0,−1,0,0,0,0,0,0,0,0,0,0,0,0,0,0,0,−1,0,0,0,−1,0,0,0,1,0,0,0,1,0,0,0,1,0,0,0,1,0,0,0,0,0,0,0,−1,0,0,0,−1,0,0,0,1,0,0,0,−1,0,0,0,−1,0,0,0,−1,0,0,0,0,0,0,0,0,0,0,0,0,0,0,0,−1,0,0,0,−1,0,0,0,−1,0,0,0,−1,0,0,0,−1,0,0,0,−1,0,0,0,0,0,0,0,1,0,0,0,1,0,0,0,−1,0,0,0,−1,0,0,0,1,0,0,0,−1,0,0,0,0,0,0,0,0,0,0,0,0,0,0,0,−1,0,0,0,−1,0,0,0,−1,0,0,0,1,0,0,0,−1,0,0,0,−1,0,0,0,0,0,0,0,−1,0,0,0,−1,0,0,0,−1,0,0,0,−1,0,0,0,1,0,0,0,−1,0,0,0,0,0,0,0}

For 80 MHz transmission, the N-TF sequence with the format of an LSTF80, optimized for estimation order P=10, is given by:

N-TF(LSTF80, P=10)=sqrt(256/48)·{0,0,0,0,0,0,0,0,1,0,0,0,−1,0,0,0,1,0,0,0,−1,0,0,0,1,0,0,0,−1,0,0,0,0,0,0,0,−1,0,0,0,1,0,0,0,1,0,0,0,1,0,0,0,1,0,0,0,1,0,0,0,0,0,0,0,0,0,0,0,0,0,0,0,1,0,0,0,1,0,0,0,−1,0,0,0,1,0,0,0,1,0,0,0,−1,0,0,0,0,0,0,0,−1,0,0,0,1,0,0,0,1,0,0,0,1,0,0,0,1,0,0,0,1,0,0,0,0,0,0,0,0,0,0,0,0,0,0,0,1,0,0,0,1,0,0,0,1,0,0,0,−1,0,0,0,−1,0,0,0,−1,0,0,0,0,0,0,0,−1,0,0,0,1,0,0,0,−1,0,0,0,1,0,0,0,−1,0,0,0,1,0,0,0,0,0,0,0,0,0,0,0,0,0,0,0,1,0,0,0,1,0,0,0,1,0,0,0,−1,0,0,0,1,0,0,0,−1,0,0,0,0,0,0,0,1,0,0,0,1,0,0,0,−1,0,0,0,1,0,0,0,1,0,0,0,1,0,0,0,0,0,0,0}

### List9

For 20 MHz transmission, the N-TF sequence with the format of an HELTF1×20, optimized for estimation order P=3, is given by:

N-TF(HELTF1X20,P=3)=sqrt(256/60)·{0,0,0,0,0,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,0,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,−1,0,0,0,−1,0,0,0,−1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,0,0,0,0}

For 20 MHz transmission, the N-TF sequence with the format of an HELTF1X20, optimized for estimation order P=4, is given by:

N-TF(HELTF1X20,P=4)=sqrt(256/60)·{0,0,0,0,0,0,0,0,1,0,0,0,1,0,0,0,−1,0,0,0,−1,0,0,0,−1,0,0,0,−1,0,0,0,1,0,0,0,−1,0,0,0,−1,0,0,0,1,0,0,0,1,0,0,0,1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,−1,0,0,0,−1,0,0,0,−1,0,0,0,−1,0,0,0,0,0,0,0,−1,0,0,0,1,0,0,0,−1,0,0,0,1,0,0,0,−1,0,0,0,1,0,0,0,−1,0,0,0,−1,0,0,0,−1,0,0,0,1,0,0,0,−1,0,0,0,−1,0,0,0,1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,−1,0,0,0,0,0,0,0}

For 20 MHz transmission, the N-TF sequence with the format of an HELTF1X20, optimized for estimation order P=5, is given by:

N-TF(HELTF1X20,P=5)=sqrt(256/60)·{0,0,0,0,0,0,0,0,1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,0,0,0,0,1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,−1,0,0,0,1,0,0,0,1,0,0,0,1,0,0,0,−1,0,0,0,−1,0,0,0,1,0,0,0,−1,0,0,0,1,0,0,0,1,0,0,0,−1,0,0,0,−1,0,0,0,0,0,0,0}

For 20 MHz transmission, the N-TF sequence with the format of an HELTF1X20, optimized for estimation order P=6, is given by:

N-TF(HELTF1X20,P=6)=sqrt(256/60)·{0,0,0,0,0,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,0,0,0,0,1,0,0,0,1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,1,0,0,0,−1,0,0,0,−1,0,0,0,−1,0,0,0,−1,0,0,0,−1,0,0,0,−1,0,0,0,0,0,0,0}

For 20 MHz transmission, the N-TF sequence with the format of an HELTF1X20, optimized for estimation order P=7, is given by:

N-TF(HELTF1X20,P=7)=sqrt(256/60)·{0,0,0,0,0,0,0,0,−1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,−1,0,0,0,0,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,0,0,0,0}

For 20 MHz transmission, the N-TF sequence with the format of an HELTF1X20, optimized for estimation order P=8, is given by:

N-TF(HELTF1X20,P=8)=sqrt(256/60)·{0,0,0,0,0,0,0,0,−1,0,0,0,1,0,0,0,−1,0,0,0,−1,0,0,0,−1,0,0,0,1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,−1,0,0,0,−1,0,0,0,−1,0,0,0,1,0,0,0,0,0,0,0,−1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,1,0,0,0,1,0,0,0,−1,0,0,0,−1,0,0,0,1,0,0,0,−1,0,0,0,−1,0,0,0,−1,0,0,0,1,0,0,0,−1,0,0,0,0,0,0,0}

For 20 MHz transmission, the N-TF sequence with the format of an HELTF1X20, optimized for estimation order P=9, is given by:

N-TF(HELTF1X20,P=9)=sqrt(256/60)·{0,0,0,0,0,0,0,0,1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,−1,0,0,0,1,0,0,0,1,0,0,0,1,0,0,0,1,0,0,0,1,0,0,0,0,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,−1,0,0,0,−1,0,0,0,1,0,0,0,1,0,0,0,0,0,0,0}

For 20 MHz transmission, the N-TF sequence with the format of an HELTF1X20, optimized for estimation order P=10, is given by:

N-TF(HELTF1X20,P=10)=sqrt(256/60)·{0,0,0,0,0,0,0,0,−1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,1,0,0,0,1,0,0,0,0,0,0,0,1,0,0,0,−1,0,0,0,1,0,0,0,1,0,0,0,−1,0,0,0,1,0,0,0,−1,0,0,0,−1,0,0,0,−1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,−1,0,0,0,1,0,0,0,−1,0,0,0,1,0,0,0,−1,0,0,0,−1,0,0,0,−1,0,0,0,0,0,0,0}

### List10

For 20 MHz transmission, the N-TF sequence with the format of an HELTF2X20, optimized for estimation order P=3, is given by:

N-TF(HELTF2X20,P=3)=sqrt(256/122)·{0,0,0,0,0,0,1,0,1,0,1,0,1,0,−1,0,−1,0,−1,0,1,0,−1,0,−1,0,1,0,1,0,1,0,1,0,1,0,1,0,−1,0,−1,0,−1,0,−1,0,1,0,1,0,−1,0,−1,0,1,0,1,0,1,0,−1,0,1,0,−1,0,1,0,−1,0,1,0,−1,0,1,0,1,0,1,0,1,0,1,0,1,0,−1,0,−1,0,1,0,1,0,−1,0,−1,0,1,0,−1,0,−1,0,1,0,1,0,−1,0,1,0,1,0,1,0,−1,0,−1,0,−1,0,1,0,1,0,1,0,0,0,−1,0,1,0,1,0,−1,0,1,0,1,0,−1,0,1,0,1,0,1,0,1,0,−1,0,−1,0,−1,0,−1,0,−1,0,−1,0,−1,0,1,0,1,0,1,0,1,0,1,0,1,0,−1,0,−1,0,−1,0,−1,0,−1,0,−1,0,−1,0,1,0,−1,0,1,0,1,0,−1,0,−1,0,1,0,−1,0,−1,0,−1,0,−1,0,−1,0,1,0,1,0,1,0,1,0,1,0,−1,0,1,0,−1,0,1,0,−1,0,−1,0,1,0,1,0,1,0,1,0,−1,0,1,0,−1,0,0,0,0,0}

For 20 MHz transmission, the N-TF sequence with the format of an HELTF2X20, optimized for estimation order P=4, is given by:

N-TF(HELTF2X20,P=4)=sqrt(256/122)·{0,0,0,0,0,0,−1,0,1,0,−1,0,1,0,−1,0,1,0,1,0,−1,0,−1,0,−1,0,−1,0,1,0,−1,0,−1,0,1,0,1,0,−1,0,1,0,1,0,1,0,1,0,1,0,1,0,−1,0,−1,0,1,0,1,0,1,0,1,0,−1,0,1,0,1,0,1,0,1,0,−1,0,1,0,−1,0,−1,0,−1,0,1,0,−1,0,1,0,−1,0,1,0,−1,0,1,0,1,0,1,0,1,0,1,0,−1,0,−1,0,−1,0,1,0,−1,0,1,0,−1,0,1,0,1,0,1,0,1,0,0,0,1,0,1,0,1,0,1,0,−1,0,1,0,1,0,1,0,1,0,−1,0,−1,0,1,0,−1,0,1,0,1,0,−1,0,−1,0,1,0,1,0,1,0,−1,0,1,0,1,0,−1,0,−1,0,−1,0,−1,0,1,0,1,0,1,0,−1,0,1,0,1,0,1,0,1,0,1,0,−1,0,−1,0,−1,0,1,0,1,0,1,0,1,0,1,0,−1,0,−1,0,−1,0,1,0,1,0,1,0,−1,0,1,0,−1,0,1,0,−1,0,−1,0,1,0,−1,0,−1,0,1,0,−1,0,0,0,0,0}

For 20 MHz transmission, the N-TF sequence with the format of an HELTF2X20, optimized for estimation order P=5, is given by:

N-TF(HELTF2X20,P=5)=sqrt(256/122)·{0,0,0,0,0,0,−1,0,1,0,1,0,1,0,−1,0,−1,0,1,0,1,0,1,0,1,0,1,0,1,0,−1,0,1,0,1,0,1,0,1,0,1,0,−1,0,1,0,1,0,−1,0,1,0,1,0,−1,0,1,0,1,0,−1,0,1,0,1,0,−1,0,−1,0,−1,0,1,0,1,0,1,0,−1,0,1,0,1,0,1,0,−1,0,1,0,1,0,−1,0,1,0,1,0,1,0,1,0,1,0,1,0,1,0,−1,0,−1,0,−1,0,1,0,−1,0,1,0,1,0,1,0,1,0,1,0,0,0,−1,0,1,0,1,0,1,0,1,0,1,0,1,0,1,0,1,0,−1,0,1,0,1,0,−1,0,−1,0,1,0,1,0,−1,0,1,0,1,0,1,0,1,0,−1,0,−1,0,1,0,−1,0,−1,0,1,0,−1,0,−1,0,1,0,1,0,−1,0,−1,0,1,0,−1,0,1,0,−1,0,1,0,1,0,1,0,−1,0,1,0,1,0,1,0,1,0,1,0,1,0,1,0,1,0,1,0,1,0,1,0,−1,0,−1,0,1,0,−1,0,−1,0,1,0,1,0,−1,0,1,0,0,0,0,0}

For 20 MHz transmission, the N-TF sequence with the format of an HELTF2X20, optimized for estimation order P=6, is given by:

N-TF(HELTF2X20,P=6)=sqrt(256/122)·{0,0,0,0,0,0,1,0,−1,0,1,0,1,0,1,0,−1,0,1,0,−1,0,1,0,−1,0,−1,0,−1,0,−1,0,−1,0,−1,0,−1,0,−1,0,−1,0,−1,0,1,0,1,0,1,0,1,0,1,0,1,0,−1,0,1,0,−1,0,1,0,1,0,1,0,−1,0,1,0,−1,0,1,0,1,0,1,0,1,0,1,0,−1,0,1,0,1,0,1,0,1,0,1,0,−1,0,−1,0,−1,0,−1,0,−1,0,1,0,−1,0,1,0,−1,0,1,0,1,0,1,0,−1,0,1,0,−1,0,1,0,0,0,−1,0,−1,0,−1,0,−1,0,−1,0,−1,0,1,0,1,0,1,0,−1,0,1,0,1,0,1,0,1,0,−1,0,−1,0,1,0,1,0,1,0,1,0,1,0,1,0,1,0,1,0,1,0,1,0,1,0,−1,0,1,0,−1,0,−1,0,1,0,−1,0,1,0,−1,0,−1,0,−1,0,−1,0,1,0,1,0,1,0,−1,0,1,0,−1,0,−1,0,−1,0,1,0,−1,0,1,0,−1,0,1,0,1,0,1,0,1,0,1,0,1,0,1,0,1,0,1,0,1,0,1,0,0,0,0,0}

For 20 MHz transmission, the N-TF sequence with the format of an HELTF2X20, optimized for estimation order P=7, is given by:

N-TF(HELTF2X20,P=7)=sqrt(256/122)·{0,0,0,0,0,0,−1,0,−1,0,1,0,−1,0,−1,0,−1,0,−1,0,−1,0,1,0,−1,0,−1,0,−1,0,1,0,1,0,1,0,1,0,1,0,1,0,1,0,1,0,1,0,1,0,1,0,−1,0,1,0,−1,0,1,0,1,0,−1,0,−1,0,1,0,−1,0,−1,0,−1,0,−1,0,−1,0,1,0,1,0,1,0,−1,0,1,0,−1,0,1,0,1,0,1,0,−1,0,1,0,−1,0,1,0,−1,0,−1,0,1,0,1,0,−1,0,1,0,−1,0,−1,0,−1,0,−1,0,−1,0,1,0,0,0,1,0,−1,0,1,0,1,0,1,0,1,0,−1,0,−1,0,1,0,−1,0,1,0,1,0,−1,0,−1,0,−1,0,−1,0,1,0,−1,0,−1,0,−1,0,−1,0,−1,0,1,0,−1,0,−1,0,−1,0,1,0,1,0,1,0,−1,0,1,0,−1,0,1,0,1,0,1,0,−1,0,−1,0,−1,0,1,0,−1,0,1,0,1,0,−1,0,1,0,1,0,−1,0,−1,0,−1,0,−1,0,−1,0,1,0,1,0,1,0,−1,0,−1,0,−1,0,1,0,1,0,1,0,−1,0,1,0,0,0,0,0}

For 20 MHz transmission, the N-TF sequence with the format of an HELTF2X20, optimized for estimation order P=8, is given by:

N-TF(HELTF2X20,P=8)=sqrt(256/122)·{0,0,0,0,0,0,−1,0,−1,0,1,0,1,0,1,0,1,0,1,0,1,0,1,0,1,0,1,0,−1,0,1,0,1,0,−1,0,1,0,1,0,1,0,1,0,1,0,1,0,1,0,1,0,1,0,1,0,1,0,1,0,−1,0,1,0,1,0,1,0,1,0,1,0,1,0,1,0,1,0,1,0,1,0,−1,0,1,0,1,0,−1,0,−1,0,1,0,−1,0,1,0,1,0,−1,0,1,0,1,0,1,0,1,0,1,0,1,0,−1,0,−1,0,1,0,−1,0,−1,0,1,0,1,0,0,0,1,0,1,0,1,0,1,0,1,0,1,0,−1,0,−1,0,1,0,−1,0,−1,0,1,0,−1,0,−1,0,1,0,1,0,1,0,1,0,1,0,1,0,−1,0,1,0,−1,0,−1,0,−1,0,−1,0,−1,0,1,0,−1,0,1,0,1,0,1,0,1,0,1,0,−1,0,1,0,1,0,−1,0,1,0,−1,0,1,0,1,0,1,0,1,0,1,0,1,0,1,0,−1,0,1,0,1,0,−1,0,1,0,1,0,−1,0,1,0,1,0,−1,0,1,0,1,0,1,0,1,0,0,0,0,0}

For 20 MHz transmission, the N-TF sequence with the format of an HELTF2X20, optimized for estimation order P=9, is given by:

N-TF(HELTF2X20,P=9)=sqrt(256/122)·{0,0,0,0,0,0,1,0,1,0,1,0,−1,0,−1,0,1,0,1,0,1,0,1,0,−1,0,1,0,−1,0,1,0,1,0,1,0,1,0,1,0,−1,0,1,0,1,0,1,0,1,0,1,0,−1,0,−1,0,−1,0,1,0,1,0,1,0,1,0,1,0,−1,0,−1,0,−1,0,1,0,1,0,1,0,−1,0,−1,0,−1,0,1,0,1,0,1,0,1,0,1,0,−1,0,−1,0,−1,0,1,0,1,0,1,0,−1,0,−1,0,−1,0,1,0,1,0,1,0,1,0,1,0,1,0,1,0,0,0,1,0,1,0,1,0,−1,0,1,0,−1,0,1,0,1,0,1,0,−1,0,1,0,1,0,1,0,−1,0,1,0,1,0,1,0,−1,0,1,0,−1,0,1,0,1,0,1,0,−1,0,1,0,1,0,1,0,−1,0,1,0,1,0,1,0,−1,0,1,0,−1,0,1,0,1,0,1,0,−1,0,1,0,1,0,1,0,1,0,1,0,1,0,1,0,−1,0,1,0,−1,0,1,0,1,0,1,0,−1,0,1,0,1,0,1,0,−1,0,−1,0,1,0,1,0,1,0,1,0,0,0,0,0}

For 20 MHz transmission, the N-TF sequence with the format of an HELTF2X20, optimized for estimation order P=10, is given by:

N-TF(HELTF2X20,P=10)=sqrt(256/122)·{0,0,0,0,0,0,−1,0,−1,0,1,0,−1,0,1,0,1,0,−1,0,−1,0,−1,0,1,0,1,0,−1,0,−1,0,−1,0,−1,0,1,0,1,0,1,0,1,0,1,0,1,0,−1,0,1,0,1,0,−1,0,−1,0,1,0,−1,0,−1,0,−1,0,−1,0,−1,0,−1,0,−1,0,−1,0,1,0,1,0,−1,0,−1,0,−1,0,1,0,−1,0,1,0,−1,0,−1,0,1,0,−1,0,−1,0,−1,0,1,0,1,0,−1,0,−1,0,−1,0,1,0,−1,0,−1,0,−1,0,1,0,−1,0,1,0,0,0,−1,0,−1,0,−1,0,1,0,1,0,−1,0,−1,0,−1,0,−1,0,1,0,1,0,−1,0,−1,0,−1,0,1,0,−1,0,−1,0,−1,0,−1,0,−1,0,1,0,1,0,−1,0,−1,0,−1,0,−1,0,1,0,−1,0,−1,0,1,0,−1,0,1,0,1,0,1,0,−1,0,−1,0,−1,0,−1,0,−1,0,−1,0,−1,0,1,0,−1,0,−1,0,−1,0,−1,0,1,0,−1,0,−1,0,1,0,−1,0,1,0,−1,0,−1,0,−1,0,−1,0,−1,0,−1,0,−1,0,−1,0,−1,0,0,0,0,0}

### List11

For 80 MHz transmission, the N-TF sequence with the format of an LLTF80, optimized for estimation order P=3, is given by:

N-TF(LLTF80, P=3)=sqrt(256/208)·{0,0,0,0,0,0,1,−1,1,1,1,−1,1,1,1,1,−1,−1,−1,1,−1,−1,1,1,1,−1,1,1,−1,−1,−1,−1,0,−1,1,1,1,−1,−1,−1,1,1,1,1,1,1,1,1,1,1,−1,−1,−1,−1,1,1,1,1,1,0,0,0,0,0,0,0,0,0,0,0,1,−1,−1,−1,−1,−1,−1,1,1,1,1,1,−1,−1,−1,−1,−1,1,−1,1,1,1,−1,−1,−1,−1,0,−1,−1,1,−1,1,−1,1,−1,−1,1,−1,−1,−1,1,1,1,−1,1,1,1,−1,−1,−1,1,1,1,0,0,0,0,0,0,0,0,0,0,0,−1,−1,1,1,−1,−1,1,1,1,−1,−1,1,−1,−1,1,−1,1,1,1,1,1,−1,1,1,−1,−1,0,1,1,−1,1,1,1,1,−1,−1,−1,1,1,1,1,−1,−1,−1,−1,1,−1,−1,1,1,1,1,1,0,0,0,0,0,0,0,0,0,0,0,1,−1,−1,−1,1,−1,1,1,1,1,1,1,−1,−1,1,1,−1,−1,1,1,1,1,1,−1,−1,−1,0,−1,−1,1,1,1,1,−1,−1,1,−1,−1,−1,1,1,1,1,1,−1,−1,−1,1,−1,1,1,1,1,0,0,0,0,0}

For 80 MHz transmission, the N-TF sequence with the format of an LLTF80, optimized for estimation order P=4, is given by:

N-TF(LLTF80, P=4)=sqrt(256/208)·{0,0,0,0,0,0,1,−1,−1,−1,1,1,1,−1,−1,−1,1,1,−1,−1,−1,1,1,1,1,−1,1,−1,−1,−1,1,−1,0,−1,−1,1,−1,1,−1,−1,−1,1,1,1,1,1,−1,−1,1,1,−1,1,−1,−1,1,1,−1,1,1,0,0,0,0,0,0,0,0,0,0,0,1,1,−1,−1,1,1,1,−1,−1,−1,1,1,−1,−1,−1,1,1,1,−1,1,1,1,−1,1,1,1,0,−1,−1,−1,1,−1,1,−1,−1,−1,1,1,1,1,−1,−1,−1,1,1,1,−1,−1,1,1,1,−1,1,0,0,0,0,0,0,0,0,0,0,0,1,1,1,−1,1,−1,1,1,−1,1,−1,1,1,−1,−1,−1,1,1,−1,−1,1,−1,−1,−1,1,1,0,1,1,1,1,1,1,1,−1,1,1,−1,1,−1,1,−1,−1,1,1,1,−1,−1,−1,1,1,1,−1,0,0,0,0,0,0,0,0,0,0,0,−1,1,−1,1,1,1,−1,−1,1,1,1,−1,1,−1,−1,−1,1,1,1,1,1,−1,−1,1,1,1,0,−1,−1,−1,1,1,1,1,−1,−1,1,1,−1,1,−1,1,−1,1,1,−1,1,−1,1,1,1,1,1,0,0,0,0,0}

For 80 MHz transmission, the N-TF sequence with the format of an LLTF80, optimized for estimation order P=5, is given by:

N-TF(LLTF80, P=5)=sqrt(256/208)·{0,0,0,0,0,0,−1,−1,1,1,1,1,1,1,1,1,−1,1,1,1,−1,−1,1,−1,−1,−1,−1,−1,−1,−1,−1,−1,0,1,−1,1,1,1,1,1,1,1,1,1,1,1,1,1,−1,−1,−1,−1,−1,−1,−1,−1,−1,−1,−1,0,0,0,0,0,0,0,0,0,0,0,1,1,1,−1,−1,1,1,1,−1,1,−1,1,1,1,−1,−1,1,1,1,1,1,−1,−1,−1,1,1,0,−1,−1,−1,1,1,−1,−1,1,1,1,1,−1,1,1,1,1,1,1,1,−1,−1,1,1,1,−1,1,0,0,0,0,0,0,0,0,0,0,0,−1,1,1,1,−1,1,1,−1,−1,1,−1,1,−1,−1,1,−1,−1,−1,−1,−1,1,−1,−1,1,1,−1,0,−1,1,1,1,−1,1,−1,1,1,−1,−1,1,1,−1,1,−1,1,−1,1,1,1,1,1,1,−1,1,0,0,0,0,0,0,0,0,0,0,0,1,1,1,1,1,1,1,1,1,1,1,−1,1,1,1,−1,−1,−1,−1,−1,−1,−1,−1,−1,1,−1,0,1,1,1,1,1,1,1,1,1,1,1,−1,−1,−1,1,−1,−1,−1,−1,−1,−1,−1,−1,1,1,1,0,0,0,0,0}

For 80 MHz transmission, the N-TF sequence with the format of an LLTF80, optimized for estimation order P=6, is given by:

N-TF(LLTF80, P=6)=sqrt(256/208)·{0,0,0,0,0,0,−1,1,−1,1,−1,−1,−1,−1,1,−1,1,1,1,−1,1,−1,−1,−1,1,−1,−1,1,−1,−1,−1,1,0,1,−1,−1,1,−1,1,1,1,1,1,1,1,1,−1,−1,1,1,1,1,−1,−1,−1,−1,1,−1,1,0,0,0,0,0,0,0,0,0,0,0,−1,−1,−1,−1,1,−1,1,1,−1,−1,−1,−1,1,1,1,−1,1,−1,−1,−1,1,−1,1,1,1,−1,0,1,−1,1,1,1,−1,1,−1,1,−1,−1,−1,1,1,−1,1,−1,−1,−1,−1,1,−1,−1,−1,1,1,0,0,0,0,0,0,0,0,0,0,0,1,−1,−1,−1,−1,1,1,1,1,1,1,1,1,−1,1,1,1,−1,−1,−1,−1,−1,1,1,−1,1,0,−1,1,−1,1,1,1,−1,1,−1,−1,−1,1,1,−1,1,−1,−1,−1,−1,−1,−1,1,−1,1,1,−1,0,0,0,0,0,0,0,0,0,0,0,1,−1,1,1,−1,−1,1,−1,1,1,1,1,1,−1,−1,1,−1,1,1,−1,−1,−1,1,−1,1,−1,0,1,−1,1,−1,1,−1,−1,1,−1,−1,−1,−1,−1,−1,1,−1,1,1,−1,1,1,−1,1,−1,1,1,0,0,0,0,0}

For 80 MHz transmission, the N-TF sequence with the format of an LLTF80, optimized for estimation order P=7, is given by:

N-TF(LLTF80, P=7)=sqrt(256/208)·{0,0,0,0,0,0,−1,1,1,1,−1,1,−1,−1,1,−1,−1,−1,−1,1,−1,1,1,−1,−1,1,−1,−1,1,−1,−1,1,0,1,−1,1,−1,−1,−1,1,−1,1,1,1,1,1,−1,−1,−1,−1,−1,−1,−1,1,−1,−1,−1,1,−1,0,0,0,0,0,0,0,0,0,0,0,1,−1,−1,−1,−1,−1,1,1,−1,−1,−1,1,1,−1,−1,−1,−1,−1,−1,−1,−1,1,−1,−1,1,1,0,1,1,1,1,1,−1,−1,−1,1,−1,−1,−1,−1,−1,1,−1,−1,−1,1,−1,−1,−1,1,−1,1,1,0,0,0,0,0,0,0,0,0,0,0,−1,1,1,1,−1,−1,−1,−1,−1,1,−1,−1,1,−1,1,−1,−1,−1,−1,−1,−1,−1,−1,1,−1,1,0,1,−1,1,1,1,−1,1,−1,−1,−1,−1,−1,−1,−1,−1,−1,1,−1,−1,−1,1,1,−1,−1,−1,−1,0,0,0,0,0,0,0,0,0,0,0,1,−1,−1,1,1,1,1,−1,−1,−1,−1,−1,−1,−1,−1,1,−1,−1,1,−1,1,1,−1,1,1,1,0,1,−1,1,−1,1,−1,1,1,1,1,1,−1,1,−1,−1,−1,−1,−1,1,−1,1,−1,1,−1,−1,−1,0,0,0,0,0}

For 80 MHz transmission, the N-TF sequence with the format of an LLTF80, optimized for estimation order P=8, is given by:

N-TF(LLTF80, P=8)=sqrt(256/208)·{0,0,0,0,0,0,−1,1,−1,1,1,−1,1,1,−1,1,−1,−1,−1,−1,1,−1,−1,1,1,1,−1,1,−1,−1,−1,1,0,1,1,1,1,−1,−1,1,1,1,1,1,1,−1,1,−1,−1,1,−1,1,−1,1,−1,1,−1,1,1,0,0,0,0,0,0,0,0,0,0,0,1,−1,1,−1,−1,1,−1,−1,−1,1,1,1,−1,1,−1,1,1,−1,−1,1,−1,1,−1,1,1,1,0,−1,−1,1,−1,1,−1,1,1,−1,1,−1,1,−1,−1,−1,−1,1,−1,1,−1,1,−1,−1,1,−1,−1,0,0,0,0,0,0,0,0,0,0,0,−1,1,−1,1,−1,1,1,1,−1,1,−1,−1,−1,−1,−1,1,−1,1,1,1,1,−1,−1,−1,−1,1,0,1,−1,1,1,1,1,−1,−1,1,−1,−1,−1,1,−1,1,−1,1,−1,1,1,−1,1,−1,1,−1,−1,0,0,0,0,0,0,0,0,0,0,0,−1,1,−1,1,−1,1,−1,1,1,1,1,1,−1,1,−1,1,1,−1,1,−1,1,1,1,1,−1,1,0,−1,−1,−1,1,1,−1,1,1,1,1,1,−1,1,−1,1,1,−1,1,−1,1,1,−1,1,−1,−1,1,0,0,0,0,0}

For 80 MHz transmission, the N-TF sequence with the format of an LLTF80, optimized for estimation order P=9, is given by:

N-TF(LLTF80, P=9)=sqrt(256/208)·{0,0,0,0,0,0,1,−1,−1,1,−1,−1,1,−1,1,−1,−1,−1,1,−1,1,−1,−1,−1,−1,−1,1,−1,1,1,−1,−1,0,−1,1,1,1,−1,−1,−1,−1,1,1,1,−1,−1,−1,−1,−1,1,−1,−1,1,−1,−1,1,−1,−1,1,0,0,0,0,0,0,0,0,0,0,0,−1,−1,1,−1,1,1,−1,−1,−1,−1,−1,1,−1,1,−1,1,−1,1,−1,1,−1,1,−1,−1,−1,1,0,1,1,1,−1,−1,−1,−1,−1,1,−1,−1,1,−1,−1,1,1,−1,1,−1,−1,−1,−1,1,1,1,1,0,0,0,0,0,0,0,0,0,0,0,1,−1,−1,1,−1,−1,−1,−1,−1,1,−1,1,−1,−1,−1,−1,−1,1,−1,1,1,−1,−1,1,−1,−1,0,−1,−1,−1,−1,1,1,1,1,−1,−1,−1,−1,−1,1,−1,−1,1,−1,−1,1,−1,−1,1,−1,−1,−1,0,0,0,0,0,0,0,0,0,0,0,−1,1,1,−1,1,−1,1,−1,−1,−1,−1,−1,−1,−1,1,1,1,−1,−1,−1,−1,−1,1,−1,1,1,0,−1,1,−1,1,1,−1,−1,−1,−1,−1,−1,1,1,−1,1,−1,−1,−1,1,1,1,−1,−1,−1,−1,−1,0,0,0,0,0}

For 80 MHz transmission, the N-TF sequence with the format of an LLTF80, optimized for estimation order P=10, is given by:

N-TF(LLTF80, P=10)=sqrt(256/208)·{0,0,0,0,0,0,−1,−1,−1,−1,1,−1,1,1,1,−1,1,−1,1,−1,1,−1,1,−1,1,1,1,−1,1,−1,−1,−1,0,−1,−1,−1,1,1,1,1,−1,−1,1,1,1,1,1,1,1,−1,1,−1,1,−1,−1,−1,−1,−1,1,0,0,0,0,0,0,0,0,0,0,0,1,1,1,1,−1,−1,−1,1,−1,1,−1,−1,−1,1,1,1,1,−1,−1,−1,1,1,1,1,1,1,0,−1,1,−1,1,−1,1,−1,1,−1,1,−1,−1,−1,1,−1,−1,−1,−1,−1,1,1,1,1,1,−1,1,0,0,0,0,0,0,0,0,0,0,0,1,−1,−1,−1,1,−1,1,−1,1,−1,1,−1,1,−1,1,−1,1,1,1,−1,1,−1,−1,−1,−1,−1,0,−1,−1,−1,1,1,1,1,−1,−1,−1,1,1,1,1,1,1,−1,1,−1,1,−1,−1,−1,1,−1,1,0,0,0,0,0,0,0,0,0,0,0,1,1,1,1,−1,−1,−1,1,−1,1,1,1,−1,1,1,1,1,−1,−1,−1,1,1,1,1,1,1,0,−1,1,−1,1,−1,1,−1,1,−1,1,−1,−1,−1,−1,−1,−1,−1,−1,−1,1,1,1,1,1,−1,1,0,0,0,0,0}

### List12

For 20 MHz transmission, the N-TF sequence with the format of an HELTF20, optimized for estimation order P=3, is given by:

N-TF(HELTF20,P=3)=sqrt(256/242)·{0,0,0,0,0,0,−1,−1,−1,1,1,−1,1,−1,1,−1,1,−1,1,−1,1,−1,1,−1,1,−1,1,1,−1,1,1,1,1,−1,1,1,1,−1,1,1,−1,−1,1,1,1,−1,1,−1,1,−1,−1,1,−1,1,1,−1,1,−1,1,−1,−1,−1,−1,1,1,−1,1,−1,1,−1,1,1,−1,−1,1,1,1,1,−1,−1,−1,−1,−1,1,−1,−1,1,−1,1,1,1,−1,1,−1,−1,1,1,−1,1,−1,1,−1,−1,1,−1,1,−1,1,1,−1,1,−1,1,−1,1,1,−1,1,−1,−1,1,−1,1,−1,1,−1,1,0,0,0,1,−1,1,1,1,1,−1,1,1,−1,1,1,1,−1,1,−1,−1,−1,1,1,−1,1,−1,−1,−1,−1,1,−1,−1,−1,−1,1,−1,−1,1,1,1,−1,1,−1,1,−1,1,−1,−1,−1,1,−1,1,−1,1,1,−1,−1,1,−1,−1,−1,−1,1,−1,−1,1,−1,1,−1,1,1,1,−1,1,−1,−1,−1,1,−1,−1,−1,1,1,−1,1,1,1,−1,−1,1,1,−1,−1,−1,1,1,−1,1,−1,1,−1,−1,1,−1,−1,−1,1,1,−1,−1,−1,1,1,−1,−1,1,−1,−1,−1,1,1,1,1,1,0,0,0,0,0}

For 20 MHz transmission, the N-TF sequence with the format of an HELTF20, optimized for estimation order P=4, is given by:

N-TF(HELTF20,P=4)=sqrt(256/242)·{0,0,0,0,0,0,1,1,−1,1,−1,−1,1,−1,−1,1,−1,1,−1,1,−1,1,−1,−1,1,1,−1,−1,−1,−1,1,1,1,1,−1,1,1,1,−1,1,−1,1,1,1,−1,−1,1,1,1,1,−1,−1,−1,1,−1,1,1,−1,−1,−1,−1,1,1,−1,−1,1,−1,1,−1,−1,1,1,−1,−1,−1,1,−1,−1,1,1,1,−1,−1,1,1,1,−1,1,−1,−1,1,1,1,−1,−1,−1,−1,1,−1,1,−1,−1,1,1,−1,−1,−1,−1,1,1,1,−1,−1,1,1,1,1,1,−1,1,−1,1,1,1,1,1,1,0,0,0,−1,1,1,1,1,1,−1,1,1,−1,1,1,−1,1,−1,−1,−1,1,−1,1,−1,1,1,1,−1,1,−1,−1,1,−1,1,−1,1,1,−1,1,−1,1,1,1,−1,1,1,1,−1,1,−1,−1,−1,1,1,1,−1,−1,−1,1,1,1,−1,−1,1,1,1,1,−1,−1,−1,1,1,1,−1,−1,1,1,1,−1,−1,1,1,1,−1,−1,1,−1,−1,1,1,1,−1,1,−1,1,1,−1,−1,1,1,1,−1,1,−1,1,−1,1,1,−1,−1,−1,−1,1,1,1,−1,1,−1,1,−1,1,1,1,1,0,0,0,0,0}

For 20 MHz transmission, the N-TF sequence with the format of an HELTF20, optimized for estimation order P=5, is given by:

N-TF(HELTF20,P=5)=sqrt(256/242)·{0,0,0,0,0,0,1,−1,1,1,−1,1,1,−1,1,1,1,−1,−1,1,1,1,1,1,−1,1,−1,1,−1,−1,1,−1,−1,1,1,−1,1,1,1,−1,−1,1,1,1,1,1,1,−1,1,1,1,−1,1,1,1,1,1,−1,1,1,1,−1,1,1,1,1,1,1,−1,−1,1,1,−1,−1,1,1,−1,1,−1,1,1,1,−1,1,1,1,1,1,1,−1,−1,1,1,−1,1,1,1,−1,1,1,1,−1,−1,1,−1,1,1,1,−1,1,1,1,−1,1,−1,1,1,1,1,−1,−1,1,1,1,1,−1,1,0,0,0,−1,1,−1,−1,−1,1,−1,−1,1,1,−1,1,1,1,−1,1,1,−1,1,1,1,−1,1,−1,1,−1,1,1,1,−1,1,1,−1,−1,−1,1,−1,1,1,1,1,1,1,1,1,1,−1,−1,−1,−1,1,−1,1,−1,1,1,1,−1,−1,1,1,−1,1,1,−1,1,1,1,−1,1,1,1,1,1,1,−1,1,1,1,−1,1,1,1,1,1,1,1,1,−1,−1,−1,1,−1,1,1,1,−1,1,−1,−1,−1,1,1,−1,−1,−1,1,1,−1,−1,1,1,1,1,1,−1,1,1,1,−1,1,0,0,0,0,0}

For 20 MHz transmission, the N-TF sequence with the format of an HELTF20, optimized for estimation order P=6, is given by:

N-TF(HELTF20,P=6)=sqrt(256/242)·{0,0,0,0,0,0,1,1,−1,1,−1,1,1,1,−1,1,−1,−1,−1,1,−1,1,1,−1,−1,1,−1,−1,1,−1,−1,1,−1,−1,1,−1,1,1,−1,−1,1,−1,1,1,−1,−1,−1,−1,1,1,−1,−1,1,1,−1,1,−1,−1,1,−1,−1,1,−1,1,1,−1,1,1,−1,−1,1,−1,1,1,−1,1,1,−1,1,1,1,−1,1,1,−1,1,−1,1,1,1,−1,1,−1,−1,1,1,−1,1,−1,1,−1,−1,1,1,−1,1,−1,1,1,1,−1,1,−1,1,1,1,−1,1,−1,1,1,1,−1,1,−1,1,1,0,0,0,−1,1,−1,1,−1,1,−1,1,1,1,1,1,−1,1,1,1,1,1,−1,1,1,−1,1,1,−1,1,1,1,1,1,−1,−1,1,−1,−1,1,−1,−1,−1,1,−1,1,−1,−1,1,1,−1,−1,−1,1,1,−1,1,1,−1,−1,1,−1,1,1,−1,1,1,−1,−1,1,−1,−1,1,−1,−1,1,1,−1,1,1,−1,1,−1,1,1,1,1,1,−1,1,1,1,1,1,−1,1,−1,−1,1,1,−1,1,−1,1,−1,−1,1,1,−1,1,−1,1,−1,−1,−1,1,−1,−1,−1,−1,−1,1,−1,1,1,0,0,0,0,0}

For 20 MHz transmission, the N-TF sequence with the format of an HELTF20, optimized for estimation order P=7, is given by:

N-TF(HELTF20,P=7)=sqrt(256/242)·{0,0,0,0,0,0,−1,1,−1,−1,−1,−1,1,1,−1,−1,−1,−1,1,1,−1,−1,−1,1,−1,−1,1,−1,1,−1,−1,−1,−1,1,−1,1,−1,−1,1,1,1,1,1,1,1,−1,−1,1,−1,−1,−1,−1,1,−1,−1,−1,−1,1,−1,−1,−1,−1,−1,−1,−1,1,1,1,−1,−1,−1,−1,1,−1,−1,−1,−1,−1,−1,−1,−1,1,−1,−1,−1,−1,1,−1,−1,−1,1,−1,1,−1,−1,1,1,−1,−1,−1,−1,−1,1,−1,−1,1,−1,1,−1,−1,−1,1,1,−1,−1,−1,−1,1,1,−1,−1,1,−1,−1,−1,−1,1,0,0,0,−1,−1,−1,−1,−1,1,1,−1,−1,−1,−1,1,1,−1,1,1,−1,1,−1,1,1,1,−1,1,−1,−1,−1,1,−1,−1,1,−1,−1,−1,−1,−1,1,−1,−1,−1,−1,−1,−1,−1,−1,1,1,−1,−1,1,−1,1,1,−1,−1,1,−1,1,−1,1,1,1,1,−1,−1,−1,1,−1,1,1,1,−1,−1,−1,1,1,−1,−1,−1,−1,−1,−1,−1,−1,1,1,−1,−1,−1,1,1,1,−1,1,1,1,−1,1,1,1,1,−1,−1,−1,1,−1,1,−1,−1,1,1,−1,1,−1,−1,1,1,−1,1,−1,1,0,0,0,0,0}

For 20 MHz transmission, the N-TF sequence with the format of an HELTF20, optimized for estimation order P=8, is given by:

N-TF(HELTF20,P=8)=sqrt(256/242)·{0,0,0,0,0,0,1,1,1,−1,−1,−1,1,−1,−1,−1,1,1,1,−1,−1,1,1,1,1,1,−1,1,1,1,−1,−1,1,1,1,−1,1,1,1,1,−1,−1,1,−1,1,−1,−1,−1,1,−1,−1,−1,−1,1,1,−1,−1,1,1,1,−1,−1,−1,1,1,−1,−1,−1,1,1,1,−1,−1,1,1,1,1,−1,1,1,−1,−1,−1,1,1,1,−1,−1,1,1,1,−1,−1,1,1,−1,−1,−1,−1,1,1,−1,−1,−1,1,1,−1,−1,1,1,1,1,−1,1,1,1,1,1,1,1,1,1,1,1,1,1,1,0,0,0,−1,−1,−1,−1,−1,−1,1,−1,−1,1,−1,1,1,1,1,1,−1,1,1,−1,−1,−1,1,1,1,−1,1,1,1,1,1,1,1,1,−1,−1,−1,−1,−1,−1,−1,−1,−1,−1,1,−1,−1,1,1,1,−1,−1,−1,−1,−1,−1,−1,−1,1,1,−1,−1,1,1,1,1,1,−1,−1,1,1,−1,−1,1,1,1,−1,1,1,−1,1,1,−1,1,1,−1,−1,−1,−1,−1,1,−1,−1,1,1,1,1,1,1,1,1,1,1,−1,−1,1,−1,−1,1,1,1,1,1,1,1,1,1,1,−1,1,1,0,0,0,0,0}

For 20 MHz transmission, the N-TF sequence with the format of an HELTF20, optimized for estimation order P=9, is given by:

N-TF(HELTF20,P=9)=sqrt(256/242)·{0,0,0,0,0,0,1,−1,1,1,−1,1,1,1,−1,−1,−1,−1,1,−1,−1,−1,1,1,1,−1,1,−1,1,−1,1,1,1,−1,−1,−1,1,1,−1,−1,1,−1,1,1,−1,−1,−1,−1,1,−1,1,−1,1,−1,1,1,1,1,−1,1,1,−1,1,−1,−1,1,1,−1,−1,−1,1,−1,1,−1,1,−1,1,−1,−1,1,1,−1,−1,−1,1,−1,1,1,1,1,1,−1,1,−1,−1,−1,1,−1,1,1,−1,−1,1,1,−1,−1,1,1,1,1,−1,−1,−1,−1,−1,−1,1,−1,1,−1,1,1,1,1,−1,1,1,0,0,0,−1,−1,1,1,1,1,1,−1,1,1,1,−1,−1,−1,−1,1,1,−1,−1,−1,1,1,1,−1,1,1,1,1,−1,−1,−1,−1,1,−1,1,1,−1,1,1,1,1,1,1,−1,1,−1,−1,−1,−1,−1,−1,1,1,1,1,−1,−1,−1,1,1,−1,−1,−1,1,1,−1,−1,−1,1,1,1,1,1,−1,−1,−1,1,−1,1,1,−1,−1,1,1,−1,−1,1,−1,1,1,1,−1,−1,−1,−1,−1,1,−1,−1,1,1,1,1,−1,−1,1,1,1,1,−1,−1,−1,−1,−1,−1,1,1,1,1,1,1,0,0,0,0,0}

For 20 MHz transmission, the N-TF sequence with the format of an HELTF20, optimized for estimation order P=10, is given by:

N-TF(HELTF20,P=10)=sqrt(256/242)·{0,0,0,0,0,0,−1,−1,−1,1,−1,1,1,1,−1,−1,−1,−1,−1,−1,−1,1,−1,1,1,1,−1,1,−1,1,−1,−1,−1,1,−1,1,1,−1,−1,−1,1,1,−1,−1,1,1,−1,1,1,−1,−1,1,−1,−1,−1,−1,1,−1,−1,1,1,−1,1,−1,−1,1,−1,−1,1,−1,−1,1,−1,−1,−1,−1,1,1,−1,−1,−1,−1,−1,−1,−1,−1,−1,−1,1,1,−1,1,1,−1,−1,−1,−1,−1,−1,1,−1,1,−1,1,−1,−1,−1,1,−1,−1,−1,−1,1,1,1,1,−1,−1,−1,1,1,−1,−1,1,−1,1,−1,0,0,0,−1,−1,−1,−1,1,−1,−1,1,1,1,1,−1,−1,1,−1,−1,−1,−1,−1,1,−1,1,−1,−1,1,1,−1,−1,1,−1,−1,1,−1,1,−1,1,1,1,−1,1,−1,−1,−1,−1,−1,1,−1,−1,1,−1,−1,1,1,−1,−1,−1,−1,1,−1,−1,1,1,−1,1,−1,−1,−1,−1,−1,1,1,1,1,1,−1,1,−1,−1,−1,−1,−1,1,−1,1,1,1,−1,1,−1,−1,−1,−1,−1,1,−1,1,1,−1,−1,1,−1,−1,−1,−1,−1,−1,−1,1,1,−1,1,1,−1,1,1,−1,−1,−1,−1,1,−1,0,0,0,0,0}

### List13

For 40 MHz transmission, the N-TF sequence with the format of an HESTF40, optimized for estimation order P=3, is given by:

N-TF(HESTF40,P=3)=sqrt(512/30)·{0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0}

For 40 MHz transmission, the N-TF sequence with the format of an HESTF40, optimized for estimation order P=4, is given by:

N-TF(HESTF40,P=4)=sqrt(512/30)·{0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0, 0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0 ,0,0,0,0,0,0,0,0}

For 40 MHz transmission, the N-TF sequence with the format of an HESTF40, optimized for estimation order P=5, is given by:

N-TF(HESTF40,P=5)=sqrt(512/30)·{0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0}

For 40 MHz transmission, the N-TF sequence with the format of an HESTF40, optimized for estimation order P=6, is given by:

N-TF(HESTF40,P=6)=sqrt(512/30)·{0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0}

For 40 MHz transmission, the N-TF sequence with the format of an HESTF40, optimized for estimation order P=7, is given by:

N-TF(HESTF40,P=7)=sqrt(512/30)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0}

For 40 MHz transmission, the N-TF sequence with the format of an HESTF40, optimized for estimation order P=8, is given by:

N-TF(HESTF40,P=8)=sqrt(512/30)·{0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0}

For 40 MHz transmission, the N-TF sequence with the format of an HESTF40, optimized for estimation order P=9, is given by:

N-TF(HESTF40,P=9)=sqrt(512/30)·{0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0}

For 40 MHz transmission, the N-TF sequence with the format of an HESTF40, optimized for estimation order P=10, is given by:

N-TF(HESTF40,P=10)=sqrt(512/30)·{0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0}

### List14

For 40 MHz transmission, the N-TF sequence with the format of an HELTF40, optimized for estimation order P=3, is given by:

N-TF(HELTF40,P=3)=sqrt(512/484)·{0,0,0,0,0,0,0,0,0,0,0,0,1,1,1,−1,1,−1,−1,1,−1,1,−1,1,−1,1,1,−1,1,1,−1,1,1,1,1,1,−1,1,1,−1,−1,−1,1,1,1,1,1,−1,1,1,−1,1,−1,−1,1,1,−1,1,1,1,1,−1,1,−1,−1,1,1,−1,1,1,−1,−1,1,−1,1,−1,−1,1,−1,−1,1,1,−1,−1,1,−1,1,−1,−1,−1,1,−1,1,−1,1,1,1,1,−1,1,−1,−1,−1,1,−1,1,−1,1,1,1,1,1,1,1,−1,1,1,1,1,1,1,−1,−1,−1,1,−1,1,−1,−1,1,1,1,1,−1,1,−1,−1,1,−1,−1,1,−1,1,1,−1,−1,1,−1,1,−1,1,1,−1,1,1,−1,−1,1,−1,−1,−1,1,−1,1,−1,−1,1,−1,−1,1,−1,1,1,−1,1,−1,1,1,1,−1,1,1,−1,1,−1,1,−1,1,−1,1,−1,1,−1,−1,1,−1,−1,−1,1,−1,1,−1,1,1,−1,−1,1,1,1,−1,−1,1, 1,1,−1,1,−1,1,−1,−1,−1,−1,1,1,−1,1,1,−1,1,−1,−1,1,1,1,−1,1,−1,1,−1,−1,−1,−1,−1,1,−1,1,1,1,1,1,1,−1,1,1,0,0,0,0,0,1,1,−1,−1,1,1,−1,1,−1,−1,1,−1,1,1,−1,1,−1,−1,−1,1,−1,1,−1,1,−1,1,−1,1,−1,−1,−1,−1,−1,−1,1,1,1,1,1,−1,1,−1,1,−1,1,−1,1,1,1,−1,1,−1,1,1,−1,−1,−1,1,1,1,1,1,1,−1,1,−1,−1,−1,−1,−1,−1,−1,1,−1,1,−1,1,1,−1,1,−1,1,−1,−1,−1,−1,1,1,−1,1,−1,−1,−1,1,1,1,1,−1,1,−1,1,1,−1,−1,1,−1,1,1,−1,−1,1,1,−1,1,−1,−1,1,1,1,1,−1,1,1,−1,1,−1,−1,−1,1,−1,1,1,−1,1,−1,1,1,−1,1,1,−1,1,−1,1,1,−1,1,−1,−1,1,−1,−1,−1,−1,1,1,−1,1,1,1,−1,−1,−1,−1,1,−1,1,1,−1,−1,1,−1,1,1,−1,−1,−1,−1,1,−1,1,1,1,−1,1,−1,−1,−1,−1,1,1,−1,1,−1,−1,−1,−1,−1,−1,−1,−1,1,1,−1,1,1,−1,1,1,1,1,1,1,1,−1,−1,−1,−1,1,1,1,−1,1,−1,1,−1,−1,−1,−1,1,1,−1,1,−1,−1,−1,1,1,−1,−1,1,1,0,0,0,0,0,0,0,0,0,0,0}

For 40 MHz transmission, the N-TF sequence with the format of an HELTF40, optimized for estimation order P=4, is given by:

N-TF(HELTF40,P=4)=sqrt(512/484)·{0,0,0,0,0,0,0,0,0,0,0,0,1,1,1,−1,1,1,1,1,−1,−1,−1,1,−1,−1,1,1,1,1,−1,1,1,1,1,−1,1,1,1,−1,1,−1,1,−1,1,1,−1,1,−1,−1,−1,1,1,−1,−1,−1,1,−1,−1,1,1,1,1,1,1,−1,−1,1,−1,−1,1,1,1,−1,−1,−1,−1,1,−1,−1,1,1,1,1,−1,−1,1,−1,−1,−1,1,−1,1,1,−1,−1,−1,−1,−1,−1,1,1,−1,−1,−1,−1,1,−1,1,−1,1,−1,−1,1,1,1,−1,−1,−1,1,−1,1,−1,−1,1,1,1,1,−1,−1,1,−1,−1,−1,1,−1,1,−1,−1,1,1,−1,−1,−1,1,1,−1,−1,−1,1,1,1,−1,−1,1,1,1,−1,1,1,1,−1,−1,1,1,1,1,1,−1,1,1,−1,−1,1,1,1,1,1,1,−1,−1,1,1,1,1,1,1,−1,−1,1,1,1,−1,1,1,1,1,1,1,1,1,−1,1,1,1,1,−1,1,1,1,−1,1,1,1,1,−1,1,1,−1,1,−1,−1,1,1,1,1,1,−1,−1,−1,1,−1,1,1,1,1,−1,1,1,1,−1,1,1,−1,1,−1,−1,1,−1,−1,1,−1,1,1,0,0,0,0,0,1,−1,1,−1,1,1,−1,−1,1,1,−1,−1,1,−1,−1,−1,−1,1,−1,−1,−1,1,−1,1,1,−1,−1,1,−1,−1,−1,−1,−1,1,−1,1,−1,1,−1,−1,−1,−1,1,1,−1,1,1,1,1,1,−1,−1,1,−1,1,−1,1,1,1,−1,1,1,−1,−1,−1,1,−1,1,1,−1,1,1,1,−1,−1,1,1,1,−1,1,1,−1,−1,−1,−1,1,1,1,−1,1,1,1,1,−1,−1,−1,1,−1,1,1,1,1,1,1,1,1,1,1,1,1,−1,−1,−1,1,−1,1,1,1,1,1,1,−1,1,−1,1,1,−1,1,−1,1,1,−1,1,−1,1,1,1,1,1,1,1,−1,1,1,−1,1,1,1,1,−1,−1,−1,−1,1,1,1,−1,1,1,−1,−1,−1,−1,−1,−1,−1,−1,1,1,−1,−1,−1,1,−1,−1,−1,−1,−1,1,−1,1,−1,−1,−1,−1,1,−1,−1,−1,−1,−1,−1,1,−1,−1,−1,−1,−1,1,−1,−1,1,1,−1,−1,−1,−1,−1,1,−1,−1,−1,−1,−1,−1,−1,−1,1,−1,−1,1,1,1,1,−1,−1,−1,−1,−1,−1,1,−1,1,−1,1,1,−1,1,1,−1,−1,−1,0,0,0,0,0,0,0,0,0,0,0}

For 40 MHz transmission, the N-TF sequence with the format of an HELTF40, optimized for estimation order P=5, is given by:

N-TF(HELTF40,P=5)=sqrt(512/484)·{0,0,0,0,0,0,0,0,0,0,0,0,1,−1,−1,−1,−1,1,1,−1,1,1,1,−1,−1,1,1,−1,1,1,−1,−1,−1,1,1,−1,1,1,1,1,−1,−1,−1,1,1,−1,−1,−1,−1,1,−1,−1,−1,−1,−1,−1,−1,−1,−1,−1,−1,1,−1,−1,1,1,−1,1,−1,−1,1,−1,1,−1,−1,1,1,1,−1,1,−1,−1,1,−1,1,−1,−1,1,−1,−1,−1,−1,1,−1,−1,−1,−1,−1,1,1,−1,−1,−1,−1,−1,1,−1,1,−1,−1,1,1,1,−1,−1,1,1,−1,−1,1,1,1,1,−1,1,−1,−1,1,−1,1,−1,−1,1,−1,1,1,−1,1,1,1,−1,−1,−1,1,−1,−1,−1,1,−1,1,−1,−1,−1,−1,−1,−1,−1,−1,1,−1,−1,−1,1,−1,1,1,−1,−1,−1,1,−1,1,−1,−1,1,−1,−1,−1,−1,−1,−1,−1,−1,1,−1,−1,1,1,−1,1,1,−1,1,1,1,−1,−1,1,−1,−1,1,1,1,1,−1,−1,−1,−1,−1,1,1,−1,−1,1,1,−1,−1,−1,−1,1,1,1,1,−1,1,1,1,−1,1,−1,1,1,1,1,−1,1,1,1,−1,−1,1,−1,−1,−1,−1,−1,−1,−1,−1,−1,−1,−1,1,−1,0,0,0,0,0,1,−1,−1,1,1,−1,−1,−1,1,−1,−1,1,−1,1,1,−1,−1,1,−1,−1,−1,−1,−1,−1,1,1,1,1,1,−1,−1,−1,−1,1,−1,−1,1,−1,−1,−1,1,−1,−1,−1,1,1,−1,1,1,−1,1,1,−1,1,1,−1,1,1,−1,1,1,1,−1,1,−1,1,1,−1,1,−1,1,−1,1,−1,1,1,1,−1,−1,1,1,−1,−1,1,−1,1,−1,1,−1,−1,1,−1,1,−1,1,1,−1,−1,−1,1,−1,−1,−1,−1,−1,−1,−1,1,1,−1,−1,−1,−1,−1,1,−1,−1,−1,1,−1,1,−1,−1,−1,−1,1,−1,1,−1,−1,1,−1,1,1,−1,1,−1,−1,1,−1,−1,−1,1,−1,−1,1,−1,1,−1,−1,1,−1,−1,−1,−1,−1,1,1,−1,1,−1,1,1,−1,1,1,1,1,1,1,1,1,1,1,−1,−1,−1,1,−1,−1,1,−1,−1,−1,−1,−1,−1,−1,1,1,−1,−1,−1,1,−1,1,1,−1,1,1,1,−1,−1,−1,1,−1,−1,−1,1,−1,−1,−1,−1,−1,−1,−1,1,1,1,1,1,−1,−1,−1,−1,−1,1,−1,1,−1,−1,1,−1,−1,−1,1,1,−1,1,1,−1,1,0,0,0,0,0,0,0,0,0,0,0}

For 40 MHz transmission, the N-TF sequence with the format of an HELTF40, optimized for estimation order P=6, is given by:

N-TF(HELTF40,P=6)=sqrt(512/484)·{0,0,0,0,0,0,0,0,0,0,0,0,−1,−1,−1,1,−1,1,−1,1,−1,1,−1,1,1,−1,−1,−1,1,1,−1,−1,−1,1,1,1,−1,−1,−1,−1,1,−1,1,−1,−1,−1,1,−1,−1,1,−1,−1,−1,1,1,1,−1,−1,−1,1,−1,−1,−1,−1,1,1,1,−1,−1,1,−1,1,1,−1,1,−1,−1,−1,−1,1,1,1,−1,1,1,1,1,1,−1,−1,−1,−1,−1,−1,−1,−1,−1,−1,1,−1,1,1,1,1,−1,1,−1,−1,1,−1,−1,1,1,−1,1,−1,−1,1,−1,1,1,−1,1,−1,1,−1,−1,−1,−1,−1,1,−1,1,1,−1,−1,1,−1,1,1,−1,−1,−1,−1,−1,−1,−1,−1,1,−1,−1,1,−1,−1,−1,1,−1,1,−1,−1,1,−1,−1,−1,−1,1,−1,−1,1,1,1,1,−1,−1,−1,1,1,−1,−1,1,−1,1,1,−1,−1,1,−1,1,1,−1,−1,−1,−1,1,1,1,1,1,−1,−1,1,1,−1,−1,1,1,1,1,−1,−1,1,−1,−1,−1,1,−1,1,−1,−1,−1,−1,−1,−1,−1,−1,1,−1,−1,1,−1,−1,1,1,−1,−1,1,−1,−1,−1,−1,−1,1,1,−1,1,−1,1,1,−1,1,1,1,1,−1,0,0,0,0,0,1,−1,−1,−1,−1,1,1,−1,1,1,−1,−1,1,1,−1,−1,−1,−1,1,1,−1,−1,−1,−1,−1,1,−1,1,1,−1,1,−1,−1,−1,−1,−1,−1,1,1,1,1,−1,−1,−1,−1,−1,1,−1,−1,−1,−1,−1,−1,−1,−1,1,1,−1,−1,−1,−1,−1,1,1,1,1,1,−1,−1,1,−1,1,1,−1,−1,−1,−1,1,−1,−1,1,1,−1,1,1,−1,−1,1,−1,−1,1,−1,−1,1,1,1,1,−1,−1,1,−1,1,1,1,1,1,1,−1,−1,1,−1,1,1,−1,−1,1,−1,−1,−1,1,1,1,1,1,−1,−1,1,−1,−1,−1,1,−1,−1,−1,−1,−1,1,−1,−1,−1,1,−1,1,−1,−1,−1,−1,1,1,−1,−1,−1,1,−1,1,1,−1,−1,1,−1,1,1,−1,−1,−1,−1,−1,−1,−1,1,−1,−1,−1,1,1,−1,−1,1,1,1,1,−1,1,−1,1,1,1,−1,1,1,1,1,−1,−1,1,1,−1,−1,1,−1,1,−1,−1,1,1,1,−1,−1,−1,−1,−1,1,1,−1,−1,−1,1,−1,−1,−1,−1,−1,1,−1,−1,1,−1,1,−1,1,−1,−1,−1,−1,−1,−1,1,1,1,−1,−1,1,0,0,0,0,0,0,0,0,0,0,0}

For 40 MHz transmission, the N-TF sequence with the format of an HELTF40, optimized for estimation order P=7, is given by:

N-TF(HELTF40,P=7)=sqrt(512/484)·{0,0,0,0,0,0,0,0,0,0,0,0,1,−1,1,1,1,−1,1,−1,1,1,−1,−1,−1,−1,−1,−1,−1,1,1,−1,1,1,−1,1,−1,1,1,−1,−1,1,1,1,1,1,1,1,1,−1,1,−1,−1,1,−1,1,−1,−1,−1,−1,−1,1,−1,1,−1,−1,−1,1,−1,−1,1,1,1,1,1,−1,1,1,1,−1,−1,−1,−1,1,1,1,1,−1,−1,1,1,−1,1,−1,1,−1,−1,−1,−1,1,1,−1,1,1,−1,−1,−1,1,1,−1,−1,1,1,−1,1,1,1,−1,−1,−1,−1,−1,−1,−1,1,−1,1,−1,1,−1,1,−1,1,−1,1,−1,−1,−1,1,−1,1,1,−1,−1,1,−1,1,−1,−1,−1,−1,−1,1,−1,−1,−1,1,−1,−1,1,−1,−1,1,−1,1,−1,1,−1,−1,1,1,−1,1,−1,1,−1,1,−1,−1,1,−1,1,−1,−1,1,−1,−1,1,−1,−1,1,−1,1,1,−1,−1,1,1,−1,−1,1,−1,−1,−1,−1,1,1,1,−1,1,−1,1,−1,−1,−1,−1,−1,−1,−1,−1,−1,−1,1,−1,1,−1,−1,−1,−1,−1,−1,1,−1,−1,−1,−1,−1,1,−1,1,1,−1,1,−1,−1,−1,−1,−1,−1,−1,−1,1,−1,1,0,0,0,0,0,−1,−1,−1,1,1,1,1,1,1,−1,−1,1,1,1,1,−1,−1,−1,−1,1,−1,1,−1,1,−1,1,−1,1,1,1,−1,−1,−1,1,−1,1,−1,1,1,1,−1,1,−1,1,−1,1,1,−1,−1,−1,−1,1,−1,−1,−1,−1,−1,1,1,−1,−1,1,−1,−1,1,1,−1,−1,−1,1,1,1,−1,1,1,1,−1,1,−1,1,−1,1,−1,1,−1,−1,−1,−1,−1,−1,1,−1,−1,1,−1,1,1,1,1,1,−1,1,−1,−1,1,1,1,−1,−1,−1,1,1,−1,−1,−1,1,−1,−1,−1,−1,−1,1,−1,−1,−1,−1,1,−1,1,−1,1,−1,1,−1,1,−1,−1,−1,−1,−1,−1,−1,1,−1,−1,−1,−1,1,−1,−1,1,1,−1,−1,−1,−1,−1,1,−1,1,−1,−1,1,1,−1,−1,−1,1,1,−1,−1,1,1,1,−1,1,−1,1,−1,1,−1,−1,−1,−1,−1,1,−1,1,1,1,1,1,−1,1,1,−1,1,1,1,−1,−1,1,−1,1,−1,−1,−1,1,−1,1,−1,−1,−1,−1,−1,1,−1,−1,−1,−1,1,1,−1,1,−1,−1,−1,−1,−1,1,1,1,−1,1,−1,1,−1,1,−1,−1,−1,1,0,0,0,0,0,0,0,0,0,0,0}

For 40 MHz transmission, the N-TF sequence with the format of an HELTF40, optimized for estimation order P=8, is given by:

N-TF(HELTF40,P=8)=sqrt(512/484)·{0,0,0,0,0,0,0,0,0,0,0,0,1,−1,−1,−1,−1,1,1,−1,−1,1,−1,−1,−1,−1,1,−1,−1,1,−1,1,1,−1,1,−1,1,1,−1,1,1,1,1,1,−1,1,1,−1,−1,1,1,−1,−1,−1,1,−1,−1,−1,1,1,−1,−1,−1,1,1,−1,−1,1,−1,−1,−1,1,1,1,−1,1,−1,1,1,−1,1, 1,1,1,1,1,1,−1,−1,1,−1,1,1,−1,1,1,−1,−1,−1,1,−1,−1,1,1,−1,1,−1,−1,−1,−1,−1,1,−1,1,1,1,1,−1,1,−1,1,1,1,1,1,−1,1,1,−1,1,1,−1,1,1,−1,1,−1,1,−1,−1,1,1,−1,1,−1,1,−1,−1,1,1,1,1,1,−1,1,−1,1,−1,1,−1,−1,1,1,−1,−1,−1,1,−1,−1,1,−1,−1,−1,−1,−1,1,−1,−1,−1,1,−1,−1,−1,1,1,1,1,−1,−1,−1,1,−1,−1,1,1,−1,−1,−1,1,−1,−1,1,1,−1,1,1,−1,1,−1,1,−1,1,1,−1,−1,1,−1,1,−1,−1,1,1,−1,1,−1,1,1,−1,1,1,−1,−1,1,1,1,−1,1,−1,1,1,1,−1,1,−1,−1,1,−1,−1,−1,1,1,1,1,1,0,0,0,0,0,1,1,1,1,−1,1,−1,1,−1,1,−1,1,−1,1,−1,1,−1,−1,−1,1,−1,−1,1,−1,1,−1,−1,−1,1,1,1,1,−1,1,1,1,1,1,1,−1,−1,1,1,1,−1,−1,−1,1,−1,−1,−1,1,−1,−1,−1,−1,1,1,−1,−1,1,−1,−1,−1,1,1,−1,−1,1,−1,1,−1,1,1,1,1,1,1,−1,1,1,1,1,−1,−1,1,−1,1,−1,1,−1,1,1,−1,−1,1,1,−1,1,−1,1,1,1,−1,1,−1,1,−1,−1,−1,1, 1, 1,1,1,1,−1,1,1,1,1,1,−1,1,−1,1,−1,1,−1,−1,−1,1,−1,−1,1,−1,−1,−1,−1,−1,1,1,−1,−1,1,−1,−1,−1,−1,1,1,−1,−1,1,−1,1,−1,1,1,1,−1,1,−1,1,−1,−1,−1,1,1,1,−1,−1,1,1,−1,1,1,1,−1,−1,1,−1,−1,1,−1,−1,1,1,−1,−1,1,1,−1,−1,1,−1,1,1,1,1,−1,1,−1,−1,−1,1,−1,1,1,−1,1,−1,−1,−1,1,−1,1,−1,1,−1,−1,−1,1,−1,−1,−1,1,1,−1,1,1,−1,−1,−1,−1,1,1,1,1,1,1,−1,0,0,0,0,0,0,0,0,0,0,0}

For 40 MHz transmission, the N-TF sequence with the format of an HELTF40, optimized for estimation order P=9, is given by:

N-TF(HELTF40,P=9)=sqrt(512/484)·{0,0,0,0,0,0,0,0,0,0,0,0,−1,−1,−1,−1,−1,1,1,1,1,1,1,−1,1,−1,−1,1,−1,1,1,1,−1,−1,1,−1,−1,−1,1,1,1,1,1,1,1,−1,−1,1,1,−1,1,1,−1,1,−1,−1,1,1,1,1,1,1,1,−1,−1,−1,−1,1,1,1,1,1,−1,−1,−1,1,1,−1,1,−1,1,1,−1,1,1,1,1,−1,1,−1,1,1,−1,−1,−1,1,−1,−1,1,1,1,1,−1,−1,1,1,1,1,1,−1,1,1,1,−1,1,−1,1,1,1,−1,−1,1,1,−1,1,1,1,1,1,−1,1,1,1,1,1,1,1,−1,1,1,−1,−1,1,−1,1,1,−1,1,1,1,−1,−1,1,−1,1,1,1,−1,1,1,1,1,−1,−1,1,1,1,−1,−1,1,−1,1,1,−1,1,1,1,−1,1,1,−1,1,1,−1,1,1,−1,−1,1,1,1,1,−1,1,1,1,1,1,−1,1,−1,1,1,−1,1,1,−1,−1,1,−1,1,1,1,1,1,1,1,−1,1,1,1,1,1,−1,1,1,−1,1,1,1,1,1,1,−1,1,1,−1,1,1,1,1,1,1,−1,1,1,−1,−1,1,−1,1,1,1,1,0,0,0,0,0,1,1,1,1,−1,−1,1,−1,1,1,1,1,1,1,−1,−1,−1,−1,−1,1,1,1,1,1,−1,−1,−1,1,1,1,1,−1,1,1,1,1,1,1,−1,1,1,−1,1,1,1,1,1,1,−1,1,−1,1,1,1,−1,−1,−1,1,−1,1,1,1,1,1,−1,−1,1,1,−1,1,1,1,1,−1,1,−1,−1,1,1,1,1,1,−1,1,−1,−1,1,1,−1,1,−1,−1,−1,−1,−1,−1,−1,−1,1,1,1,1,−1,1,−1,1,−1,1,1,1,1,1,1,1,1,−1,1,1,1,1,1,1,1,1,−1,−1,1,−1,1,1,1,1,−1,−1,−1,1,1,−1,1,−1,1,−1,−1,1,−1,−1,1,1,1,1,1,−1,−1,1,−1,1,−1,1,−1,−1,−1,−1,1,1,−1,1,1,1,−1,−1,−1,−1,1,−1,1,−1,1,−1,−1,−1,−1,−1,−1,1,1,1,1,1,−1,−1,−1,1,−1,1,1,−1,−1,1,−1,1,−1,1,1,1,1,−1,1,1,1,−1,−1,−1,−1,1,1,−1,1,−1,1,−1,1,1,−1,1,−1,−1,1,−1,−1,1,−1,1,−1,1,−1,1,−1,1,1,1,1,1,0,0,0,0,0,0,0,0,0,0,0}

For 40 MHz transmission, the N-TF sequence with the format of an HELTF40, optimized for estimation order P=10, is given by:

N-TF(HELTF40,P=10)=sqrt(512/484)·{0,0,0,0,0,0,0,0,0,0,0,0,1,−1,1,−1,1,−1,−1,−1,1,1,1,−1,1,1,−1,1,−1,1,−1,1,−1,1,−1,−1,1,1,1,−1,1,1,1,1,1,1,−1,−1,1,−1,1,−1,1,1,1,1,−1,1,−1,1,1,1,−1,1,−1,−1,1,−1,−1,1,1,1,1,−1,1,−1,1,−1,1,−1,−1,−1,1,1,1,1,−1,1,−1,1,−1,1,−1,1,1,1,−1,−1,−1,−1,1,−1,1,−1,1,−1,1,−1,−1,1,−1,−1,−1,−1,−1,1,1,1,1,1,−1,1,−1,−1,1,1,1,−1,1,−1,1,−1,1,1,1,−1,1,−1,−1,1,1,−1,−1,1,−1,1,−1,1,1,1,1,1,−1,−1,1,1,−1,−1,1,−1,1,1,1,1,1,1,1,1,−1,1,−1,1,1,−1,−1,−1,−1,1,1,1,−1,1,1,−1,1,−1,−1,−1,1,−1,−1,−1,−1,−1,1,−1,1,1,−1,1,1,−1,1,−1,−1,1,1,1,1,1,1,1,1,1,−1,1,−1,−1,−1,−1,−1,1,−1,1,−1,1,1,1,1,1,−1,−1,−1,−1,−1,1,−1,−1,−1,1,−1,−1,1,1,−1,1,−1,−1,−1,1,1,1,−1,−1,0,0,0,0,0,−1,1,−1,1,−1,−1,−1,1,1,1,1,1,1,−1,1,−1,1,1,−1,−1,−1,1,−1,1,−1,−1,1,−1,1,1,−1,1,1,1,1,1,1,−1,1,−1,1,1,1,−1,1,−1,1,1,−1,−1,−1,−1,−1,−1,−1,−1,1,1,1,1,−1,1,1,1,1,1,−1,1,−1,1,−1,1,−1,1,1,1,−1,−1,−1,−1,1,−1,1,−1,−1,−1,1,1,−1,1,1,−1,1,−1,−1,1,−1,−1,−1,−1,−1,−1,1,−1,1,−1,1,−1,1,−1,1,−1,−1,1,−1,−1,−1,−1,−1,1,1,−1,1,1,−1,1,1,1,−1,−1,−1,1,−1,−1,−1,1,1,−1,1,−1,1,1,1,1,−1,−1,−1,1,−1,1,1,1,1,1,1,1,1,−1,−1,−1,1,−1,1,−1,1,−1,1,−1,1,−1,1,−1,1,1,1,1,−1,−1,−1,1,−1,1,−1,1,−1,1,1,−1,−1,−1,1,−1,−1,−1,−1,1,1,1,1,−1,−1,1,1,−1,−1,−1,−1,1,−1,1,−1,1,−1,1,1,1,1,−1,1,1,1,−1,−1,−1,−1,−1,1,−1,1,1,1,1,1,−1,1,1,−1,1,1,1,−1,1,0,0,0,0,0,0,0,0,0,0,0}

### List15

For 40 MHz transmission, the N-TF sequence with the format of an HELTF2X40, optimized for estimation order P=3, is given by:

N-TF(HELTF2X40,P=3)=sqrt(512/242)·{0,0,0,0,0,0,0,0,0,0,0,0,1,0,−1,0,−1,0,−1,0,−1,0,−1,0,1,0,−1,0,−1,0,1,0,−1,0,−1,0,−1,0,1,0,1,0,1,0,1,0,−1,0,−1,0,1,0,1,0,1,0,−1,0,1,0,1,0,1,0,−1,0,1,0,1,0,1,0,−1,0,−1,0,−1,0,1,0,1,0,1,0,1,0,−1,0,−1,0,−1,0,1,0,1,0,−1,0,1,0,−1,0,−1,0,1,0,1,0,1,0,1,0,−1,0,−1,0,−1,0,−1,0,1,0,1,0,1,0,1,0,−1,0,−1,0,1,0,1,0,−1,0,1,0,−1,0,−1,0,1,0,−1,0,1,0,−1,0,1,0,−1,0,1,0,−1,0,−1,0,−1,0,1,0,1,0,1,0,−1,0,−1,0,1,0,−1,0,1,0,−1,0,−1,0,1,0,−1,0,1,0,−1,0,1,0,1,0,1,0,−1,0,−1,0,1,0,−1,0,1,0,−1,0,−1,0,−1,0,1,0,−1,0,1,0,1,0,1,0,1,0,−1,0,−1,0,1,0,1,0,1,0,−1,0,1,0,−1,0,1,0,1,0,1,0,1,0,−1,0,1,0,0,0,0,0,0,0,1,0,1,0,−1,0,−1,0,1,0,1,0,1,0,1,0,1,0,−1,0,−1,0,−1,0,−1,0,−1,0,1,0,−1,0,1,0,−1,0,−1,0,−1,0,1,0,1,0,−1,0,1,0,−1,0,1,0,1,0,1,0,1,0,−1,0,1,0,1,0,−1,0,−1,0,1,0,−1,0,1,0,−1,0,−1,0,1,0,−1,0,1,0,−1,0,1,0,1,0,−1,0,1,0,−1,0,1,0,1,0,1,0,−1,0,−1,0,−1,0,1,0,1,0,1,0,−1,0,−1,0,−1,0,−1,0,−1,0,−1,0,1,0,1,0,−1,0,1,0,1,0,1,0,1,0,1,0,1,0,−1,0,−1,0,−1,0,1,0,1,0,−1,0,1,0,−1,0,−1,0,−1,0,−1,0,1,0,1,0,−1,0,−1,0,−1,0,1,0,−1,0,−1,0,−1,0,−1,0,1,0,−1,0,−1,0,1,0,1,0,−1,0,−1,0,1,0,−1,0,1,0,1,0,1,0,−1,0,−1,0,−1,0,−1,0,1,0,1,0,1,0,−1,0,1,0,−1,0,−1,0,−1,0,1,0,1,0,−1,0,−1,0,0,0,0,0,0,0,0,0,0,0}

For 40 MHz transmission, the N-TF sequence with the format of an HELTF2X40, optimized for estimation order P=4, is given by:

N-TF(HELTF2X40,P=4)=sqrt(512/242)·{0,0,0,0,0,0,0,0,0,0,0,0,1,0,−1,0,−1,0,−1,0,−1,0,1,0,1,0,−1,0,−1,0,−1,0,−1,0,1,0,1,0,1,0,1,0,1,0,1,0,1,0,1,0,1,0,−1,0,−1,0,1,0,−1,0,−1,0,−1,0,−1,0,−1,0,1,0,−1,0,−1,0,1,0,1,0,1,0,−1,0,1,0,−1,0,1,0,1,0,1,0,1,0,1,0,−1,0,−1,0,−1,0,−1,0,−1,0,−1,0,−1,0,−1,0,−1,0,−1,0,1,0,1,0,1,0,1,0,1,0,1,0,1,0,1,0,1,0,1,0,1,0,1,0,−1,0,−1,0,−1,0,−1,0,−1,0,−1,0,−1,0,−1,0,−1,0,−1,0,−1,0,1,0,1,0,1,0,1,0,1,0,1,0,−1,0,1,0,1,0,1,0,1,0,−1,0,1,0,−1,0,1,0,1,0,−1,0,1,0,1,0,1,0,1,0,−1,0,1,0,1,0,1,0,1,0,1,0,−1,0,−1,0,1,0,−1,0,1,0,1,0,1,0,−1,0,−1,0,1,0,1,0,−1,0,1,0,−1,0,−1,0,1,0,1,0,−1,0,−1,0,0,0,0,0,0,0,−1,0,−1,0,−1,0,−1,0,−1,0,1,0,1,0,1,0,−1,0,1,0,1,0,1,0,1,0,1,0,1,0,1,0,−1,0,−1,0,−1,0,1,0,1,0,−1,0,−1,0,−1,0,1,0,−1,0,1,0,1,0,1,0,1,0,−1,0,1,0,1,0,1,0,1,0,−1,0,−1,0,1,0,−1,0,−1,0,−1,0,−1,0,−1,0,−1,0,1,0,1,0,−1,0,−1,0,1,0,1,0,1,0,1,0,1,0,1,0,1,0,−1,0,1,0,1,0,−1,0,−1,0,−1,0,1,0,−1,0,−1,0,−1,0,1,0,−1,0,−1,0,−1,0,1,0,1,0,1,0,−1,0,1,0,1,0,−1,0,1,0,1,0,1,0,−1,0,−1,0,−1,0,1,0,1,0,−1,0,−1,0,1,0,−1,0,1,0,1,0,−1,0,1,0,1,0,1,0,−1,0,−1,0,1,0,−1,0,−1,0,1,0,1,0,1,0,−1,0,−1,0,−1,0,1,0,−1,0,−1,0,1,0,−1,0,1,0,1,0,1,0,1,0,1,0,1,0,1,0,−1,0,−1,0,−1,0,−1,0,0,0,0,0,0,0,0,0,0,0}

For 40 MHz transmission, the N-TF sequence with the format of an HELTF2X40, optimized for estimation order P=5, is given by:

N-TF(HELTF2X40,P=5)=sqrt(512/242)·{0,0,0,0,0,0,0,0,0,0,0,0,1,0,1,0,1,0,1,0,1,0,−1,0,1,0,1,0,1,0,1,0,1,0,1,0,1,0,−1,0,−1,0,−1,0,−1,0,1,0,1,0,−1,0,−1,0,−1,0,−1,0,−1,0,1,0,−1,0,1,0,−1,0,1,0,−1,0,1,0,1,0,1,0,1,0,1,0,−1,0,−1,0,−1,0,−1,0,−1,0,1,0,1,0,1,0,1,0,1,0,1,0,1,0,1,0,1,0,−1,0,1,0,−1,0,1,0,−1,0,−1,0,−1,0,−1,0,−1,0,−1,0,−1,0,1,0,1,0,1,0,−1,0,1,0,1,0,1,0,−1,0,−1,0,−1,0,−1,0,−1,0,1,0,−1,0,1,0,1,0,1,0,−1,0,−1,0,−1,0,1,0,1,0,1,0,−1,0,1,0,1,0,−1,0,−1,0,1,0,−1,0,1,0,−1,0,1,0,−1,0,−1,0,−1,0,−1,0,1,0,1,0,1,0,−1,0,1,0,1,0,1,0,1,0,1,0,1,0,1,0,−1,0,−1,0,−1,0,−1,0,1,0,−1,0,1,0,−1,0,1,0,−1,0,1,0,1,0,1,0,0,0,0,0,0,0,−1,0,−1,0,−1,0,−1,0,−1,0,−1,0,1,0,−1,0,−1,0,−1,0,1,0,1,0,1,0,−1,0,−1,0,1,0,−1,0,−1,0,1,0,−1,0,1,0,1,0,1,0,−1,0,−1,0,1,0,1,0,1,0,1,0,1,0,1,0,−1,0,1,0,1,0,1,0,−1,0,1,0,−1,0,−1,0,−1,0,−1,0,−1,0,−1,0,−1,0,−1,0,1,0,−1,0,−1,0,1,0,−1,0,−1,0,−1,0,1,0,1,0,1,0,−1,0,−1,0,−1,0,−1,0,−1,0,1,0,−1,0,1,0,1,0,1,0,1,0,1,0,1,0,1,0,1,0,−1,0,−1,0,1,0,−1,0,−1,0,−1,0,−1,0,−1,0,−1,0,−1,0,−1,0,1,0,−1,0,−1,0,−1,0,1,0,1,0,−1,0,1,0,−1,0,1,0,−1,0,1,0,−1,0,−1,0,−1,0,1,0,−1,0,1,0,1,0,1,0,−1,0,1,0,−1,0,1,0,1,0,1,0,1,0,1,0,−1,0,−1,0,1,0,−1,0,−1,0,−1,0,−1,0,−1,0,−1,0,1,0,1,0,1,0,0,0,0,0,0,0,0,0,0,0}

For 40 MHz transmission, the N-TF sequence with the format of an HELTF2X40, optimized for estimation order P=6, is given by:

N-TF(HELTF2X40,P=6)=sqrt(512/242)·{0,0,0,0,0,0,0,0,0,0,0,0,1,0,1,0,−1,0,1,0,−1,0,−1,0,−1,0,1,0,1,0,−1,0,1,0,1,0,−1,0,1,0,1,0,−1,0,1,0,1,0,−1,0,1,0,−1,0,−1,0,1,0,1,0,1,0,1,0,1,0,−1,0,1,0,−1,0,−1,0,1,0,1,0,−1,0,1,0,−1,0,−1,0,1,0,−1,0,1,0,1,0,−1,0,−1,0,1,0,−1,0,−1,0,1,0,−1,0,1,0,−1,0,−1,0,1,0,−1,0,−1,0,1,0,−1,0,−1,0,1,0,1,0,1,0,1,0,1,0,1,0,1,0,1,0,1,0,1,0,−1,0,−1,0,−1,0,−1,0,−1,0,1,0,1,0,−1,0,1,0,1,0,−1,0,1,0,−1,0,1,0,1,0,−1,0,1,0,1,0,−1,0,1,0,−1,0,−1,0,1,0,−1,0,1,0,−1,0,1,0,1,0,−1,0,1,0,−1,0,1,0,1,0,1,0,1,0,1,0,1,0,−1,0,−1,0,1,0,1,0,1,0,−1,0,1,0,1,0,−1,0,1,0,1,0,−1,0,1,0,−1,0,−1,0,1,0,−1,0,0,0,0,0,0,0,1,0,−1,0,1,0,1,0,1,0,1,0,1,0,1,0,−1,0,−1,0,−1,0,1,0,−1,0,1,0,−1,0,1,0,1,0,−1,0,1,0,1,0,1,0,−1,0,1,0,−1,0,1,0,1,0,−1,0,−1,0,−1,0,1,0,1,0,−1,0,1,0,1,0,−1,0,−1,0,1,0,1,0,1,0,1,0,1,0,−1,0,1,0,1,0,−1,0,1,0,−1,0,−1,0,1,0,−1,0,−1,0,1,0,1,0,−1,0,1,0,1,0,−1,0,1,0,−1,0,1,0,1,0,−1,0,1,0,−1,0,1,0,−1,0,1,0,−1,0,1,0,1,0,1,0,−1,0,−1,0,−1,0,−1,0,1,0,−1,0,−1,0,1,0,−1,0,1,0,−1,0,−1,0,1,0,1,0,−1,0,1,0,1,0,1,0,1,0,−1,0,1,0,1,0,1,0,1,0,1,0,−1,0,−1,0,−1,0,−1,0,−1,0,−1,0,1,0,−1,0,1,0,1,0,1,0,1,0,1,0,−1,0,1,0,−1,0,−1,0,1,0,−1,0,1,0,1,0,−1,0,1,0,−1,0,1,0,0,0,0,0,0,0,0,0,0,0}

For 40 MHz transmission, the N-TF sequence with the format of an HELTF2X40, optimized for estimation order P=7, is given by:

N-TF(HELTF2X40,P=7)=sqrt(512/242)·{0,0,0,0,0,0,0,0,0,0,0,0,1,0,−1,0,−1,0,1,0,1,0,−1,0,1,0,1,0,−1,0,−1,0,1,0,1,0,−1,0,1,0,1,0,−1,0,1,0,1,0,1,0,−1,0,1,0,1,0,−1,0,1,0,1,0,−1,0,−1,0,1,0,1,0,1,0,−1,0,1,0,1,0,1,0,−1,0,1,0,−1,0,−1,0,1,0,1,0,−1,0,−1,0,1,0,1,0,−1,0,1,0,−1,0,−1,0,1,0,−1,0,−1,0,−1,0,1,0,−1,0,1,0,1,0,1,0,−1,0,1,0,1,0,1,0,−1,0,1,0,−1,0,1,0,1,0,1,0,1,0,1,0,1,0,1,0,−1,0,1,0,−1,0,−1,0,1,0,1,0,−1,0,−1,0,−1,0,1,0,1,0,−1,0,1,0,1,0,−1,0,1,0,1,0,−1,0,−1,0,1,0,1,0,−1,0,−1,0,1,0,−1,0,−1,0,1,0,−1,0,−1,0,−1,0,−1,0,1,0,1,0,1,0,1,0,−1,0,1,0,1,0,−1,0,−1,0,1,0,−1,0,1,0,1,0,1,0,−1,0,1,0,1,0,1,0,−1,0,0,0,0,0,0,0,1,0,1,0,−1,0,−1,0,1,0,−1,0,−1,0,−1,0,−1,0,1,0,1,0,1,0,−1,0,−1,0,−1,0,1,0,1,0,−1,0,−1,0,−1,0,1,0,−1,0,1,0,1,0,1,0,−1,0,1,0,−1,0,−1,0,1,0,−1,0,−1,0,1,0,−1,0,−1,0,1,0,1,0,−1,0,1,0,−1,0,−1,0,−1,0,1,0,−1,0,−1,0,−1,0,−1,0,−1,0,1,0,−1,0,−1,0,1,0,1,0,1,0,−1,0,−1,0,−1,0,1,0,1,0,1,0,−1,0,−1,0,−1,0,1,0,1,0,−1,0,−1,0,1,0,1,0,−1,0,1,0,1,0,−1,0,1,0,1,0,−1,0,−1,0,1,0,−1,0,1,0,1,0,1,0,−1,0,1,0,1,0,−1,0,−1,0,1,0,−1,0,−1,0,1,0,1,0,−1,0,−1,0,−1,0,1,0,1,0,−1,0,−1,0,−1,0,1,0,1,0,−1,0,−1,0,−1,0,−1,0,1,0,1,0,−1,0,−1,0,1,0,1,0,1,0,−1,0,−1,0,−1,0,1,0,−1,0,−1,0,−1,0,1,0,0,0,0,0,0,0,0,0,0,0}

For 40 MHz transmission, the N-TF sequence with the format of an HELTF2X40, optimized for estimation order P=8, is given by:

N-TF(HELTF2X40,P=8)=sqrt(512/242)·{0,0,0,0,0,0,0,0,0,0,0,0,−1,0,−1,0,1,0,1,0,1,0,1,0,1,0,−1,0,1,0,−1,0,1,0,1,0,1,0,1,0,−1,0,−1,0,1,0,1,0,1,0,1,0,−1,0,1,0,1,0,−1,0,1,0,1,0,1,0,1,0,1,0,1,0,−1,0,−1,0,1,0,1,0,1,0,1,0,1,0,−1,0,−1,0,−1,0,−1,0,1,0,1,0,−1,0,1,0,−1,0,1,0,1,0,1,0,1,0,1,0,1,0,−1,0,1,0,−1,0,1,0,1,0,−1,0,1,0,−1,0,−1,0,−1,0,1,0,1,0,1,0,−1,0,1,0,1,0,−1,0,1,0,1,0,1,0,1,0,−1,0,1,0,1,0,−1,0,1,0,1,0,−1,0,1,0,−1,0,1,0,1,0,1,0,1,0,1,0,−1,0,1,0,1,0,1,0,1,0,−1,0,1,0,1,0,1,0,1,0,−1,0,1,0,1,0,1,0,−1,0,1,0,−1,0,1,0,1,0,1,0,1,0,1,0,−1,0,−1,0,−1,0,−1,0,1,0,1,0,1,0,1,0,−1,0,−1,0,1,0,−1,0,0,0,0,0,0,0,1,0,−1,0,−1,0,−1,0,1,0,−1,0,1,0,1,0,−1,0,1,0,−1,0,1,0,1,0,1,0,1,0,−1,0,−1,0,−1,0,−1,0,1,0,1,0,−1,0,1,0,−1,0,1,0,1,0,1,0,1,0,1,0,1,0,1,0,−1,0,1,0,1,0,1,0,1,0,1,0,1,0,−1,0,1,0,−1,0,−1,0,1,0,−1,0,1,0,1,0,−1,0,1,0,1,0,1,0,−1,0,1,0,1,0,1,0,1,0,1,0,1,0,1,0,−1,0,−1,0,1,0,−1,0,1,0,1,0,1,0,1,0,−1,0,1,0,1,0,1,0,1,0,1,0,1,0,1,0,1,0,1,0,1,0,1,0,1,0,1,0,−1,0,−1,0,−1,0,−1,0,1,0,−1,0,1,0,1,0,−1,0,−1,0,−1,0,−1,0,1,0,1,0,1,0,1,0,−1,0,−1,0,−1,0,−1,0,1,0,1,0,−1,0,−1,0,−1,0,−1,0,1,0,−1,0,−1,0,1,0,1,0,1,0,1,0,1,0,1,0,1,0,1,0,1,0,1,0,1,0,1,0,0,0,0,0,0,0,0,0,0,0}

For 40 MHz transmission, the N-TF sequence with the format of an HELTF2X40, optimized for estimation order P=9, is given by:

N-TF(HELTF2X40,P=9)=sqrt(512/242)·{0,0,0,0,0,0,0,0,0,0,0,0,1,0,−1,0,−1,0,−1,0,1,0,1,0,−1,0,−1,0,−1,0,1,0,1,0,1,0,1,0,1,0,1,0,1,0,1,0,1,0,1,0,−1,0,1,0,−1,0,1,0,−1,0,1,0,1,0,1,0,1,0,−1,0,1,0,1,0,−1,0,−1,0,−1,0,1,0,1,0,1,0,−1,0,1,0,−1,0,1,0,1,0,1,0,−1,0,1,0,1,0,1,0,−1,0,−1,0,1,0,1,0,−1,0,−1,0,−1,0,1,0,1,0,1,0,1,0,−1,0,1,0,1,0,1,0,1,0,−1,0,−1,0,1,0,1,0,1,0,−1,0,−1,0,1,0,1,0,1,0,1,0,1,0,1,0,1,0,1,0,1,0,1,0,1,0,−1,0,1,0,1,0,−1,0,1,0,−1,0,1,0,−1,0,−1,0,1,0,1,0,1,0,−1,0,−1,0,1,0,1,0,−1,0,−1,0,−1,0,1,0,−1,0,1,0,1,0,1,0,1,0,−1,0,1,0,1,0,1,0,1,0,1,0,1,0,−1,0,−1,0,1,0,1,0,1,0,−1,0,1,0,1,0,0,0,0,0,0,0,1,0,1,0,1,0,1,0,1,0,−1,0,−1,0,−1,0,−1,0,−1,0,1,0,1,0,1,0,1,0,−1,0,1,0,1,0,1,0,−1,0,−1,0,1,0,1,0,1,0,−1,0,−1,0,1,0,1,0,1,0,1,0,1,0,1,0,1,0,1,0,1,0,1,0,1,0,1,0,1,0,−1,0,−1,0,1,0,1,0,1,0,−1,0,−1,0,1,0,1,0,1,0,−1,0,1,0,−1,0,1,0,1,0,−1,0,−1,0,−1,0,−1,0,1,0,1,0,1,0,−1,0,1,0,1,0,1,0,1,0,1,0,1,0,1,0,1,0,−1,0,−1,0,1,0,−1,0,−1,0,−1,0,−1,0,1,0,1,0,1,0,1,0,1,0,1,0,1,0,1,0,−1,0,−1,0,1,0,1,0,1,0,−1,0,−1,0,1,0,1,0,1,0,1,0,1,0,1,0,−1,0,1,0,−1,0,1,0,1,0,1,0,1,0,−1,0,−1,0,−1,0,1,0,1,0,1,0,1,0,1,0,1,0,1,0,1,0,−1,0,1,0,1,0,−1,0,−1,0,1,0,0,0,0,0,0,0,0,0,0,0}

For 40 MHz transmission, the N-TF sequence with the format of an HELTF2X40, optimized for estimation order P=10, is given by:

N-TF(HELTF2X40,P=10)=sqrt(512/242)·{0,0,0,0,0,0,0,0,0,0,0,0,1,0,−1,0,1,0,−1,0,1,0,1,0,1,0,1,0,1,0,−1,0,−1,0,1,0,1,0,−1,0,−1,0,1,0,1,0,1,0,1,0,−1,0,1,0,−1,0,1,0,−1,0,−1,0,−1,0,−1,0,−1,0,1,0,1,0,1,0,−1,0,1,0,1,0,−1,0,−1,0,1,0,−1,0,−1,0,1,0,1,0,1,0,−1,0,1,0,−1,0,1,0,1,0,−1,0,1,0,−1,0,1,0,1,0,1,0,1,0,1,0,1,0,−1,0,1,0,1,0,−1,0,1,0,1,0,−1,0,−1,0,1,0,−1,0,1,0,−1,0,1,0,1,0,−1,0,−1,0,−1,0,1,0,−1,0,−1,0,1,0,1,0,1,0,−1,0,1,0,−1,0,1,0,−1,0,1,0,−1,0,1,0,1,0,−1,0,1,0,1,0,1,0,1,0,−1,0,1,0,−1,0,−1,0,−1,0,1,0,−1,0,−1,0,1,0,1,0,−1,0,−1,0,1,0,1,0,1,0,−1,0,−1,0,−1,0,−1,0,1,0,−1,0,1,0,1,0,1,0,−1,0,−1,0,1,0,1,0,0,0,0,0,0,0,−1,0,−1,0,1,0,1,0,1,0,−1,0,1,0,−1,0,1,0,−1,0,−1,0,1,0,−1,0,−1,0,1,0,−1,0,1,0,1,0,1,0,−1,0,1,0,−1,0,−1,0,−1,0,1,0,1,0,1,0,1,0,1,0,1,0,−1,0,1,0,1,0,−1,0,−1,0,−1,0,1,0,−1,0,1,0,1,0,1,0,−1,0,1,0,−1,0,−1,0,1,0,−1,0,−1,0,−1,0,1,0,1,0,−1,0,1,0,−1,0,1,0,−1,0,1,0,1,0,−1,0,−1,0,1,0,−1,0,−1,0,1,0,1,0,1,0,1,0,−1,0,1,0,−1,0,1,0,1,0,1,0,−1,0,−1,0,1,0,−1,0,1,0,1,0,−1,0,−1,0,−1,0,1,0,−1,0,−1,0,−1,0,1,0,−1,0,1,0,1,0,1,0,−1,0,−1,0,1,0,−1,0,−1,0,1,0,−1,0,1,0,−1,0,1,0,−1,0,−1,0,1,0,1,0,−1,0,1,0,−1,0,−1,0,−1,0,1,0,1,0,−1,0,1,0,1,0,−1,0,1,0,−1,0,1,0,−1,0,−1,0,0,0,0,0,0,0,0,0,0,0}

### List16

For 40 MHz transmission, the N-TF sequence with the format of an HELTF40, optimized for estimation order P=3, is given by:

N-TF(HELTF40,P=3)=sqrt(512/484)·{0,0,0,0,0,0,0,0,0,0,0,0,1,1,1,−1,1,−1,−1,1,−1,1,−1,1,−1,1,1,−1,1,1,−1,1,1,1,1,1,−1,1,1,−1,−1,−1,1,1,1,1,1,−1,1,1,−1,1,−1,−1,1,1,−1,1,1,1,1,−1,1,−1,−1,1,1,−1,1,1,−1,−1,1,−1,1,−1,−1,1,−1,−1,1,1,−1,−1,1,−1,1,−1,−1,−1,1,−1,1,−1,1,1,1,1,−1,1,−1,−1,−1,1,−1,1,−1,1,1,1,1,1,1,1,−1,1,1,1,1,1,1,−1,−1,−1,1,−1,1,−1,−1,1,1,1,1,−1,1,−1,−1,1,−1,−1,1,−1,1,1,−1,−1,1,−1,1,−1,1,1,−1,1,1,−1,−1,1,−1,−1,−1,1,−1,1,−1,−1,1,−1,−1,1,−1,1,1,−1,1,−1,1,1,1,−1,1,1,−1,1,−1,1,−1,1,−1,1,−1,1,−1,−1,1,−1,−1,−1,1,−1,1,−1,1,1,−1,−1,1,1,1,−1,−1,1,1,1,−1,1,−1,1,−1,−1,−1,−1,1,1,−1,1,1,−1,1,−1,−1,1,1,1,−1,1,−1,1,−1,−1,−1,−1,−1,1,−1,1,1,1,1,1,1,−1,1,1,0,0,0,0,0,1,1,−1,−1,1,1,−1,1,−1,−1,1,−1,1,1,−1,1,−1,−1,−1,1,−1,1,−1,1,−1,1,−1,1,−1,−1,−1,−1,−1,−1,1,1,1,1,1,−1,1,−1,1,−1,1,−1,1,1,1,−1,1,−1,1,1,−1,−1,−1,1,1,1,1,1,1,−1,1,−1,−1,−1,−1,−1,−1,−1,1,−1,1,−1,1,1,−1,1,−1,1,−1,−1,−1,−1,1,1,−1,1,−1,−1,−1,1,1,1,1,−1,1,−1,1,1,−1,−1,1,−1,1,1,−1,−1,1,1,−1,1,−1,−1,1,1,1,1,−1,1,1,−1,1,−1,−1,−1,1,−1,1,1,−1,1,−1,1,1,−1,1,1,−1,1,−1,1,1,−1,1,−1,−1,1,−1,−1,−1,−1,1,1,−1,1,1,1,−1,−1,−1,−1,1,−1,1,1,−1,−1,1,−1,1,1,−1,−1,−1,−1,1,−1,1,1,1,−1,1,−1,−1,−1,−1,1,1,−1,1,−1,−1,−1,−1,−1,−1,−1,−1,1,1,−1,1,1,−1,1,1,1,1,1,1,1,−1,−1,−1,−1,1,1,1,−1,1,−1,1,−1,−1,−1,−1,1,1,−1,1,−1,−1,−1,1,1,−1,−1,1,1,0,0,0,0,0,0,0,0,0,0,0}

For 40 MHz transmission, the N-TF sequence with the format of an HELTF40, optimized for estimation order P=4, is given by:

N-TF(HELTF40,P=4)=sqrt(512/484)·{0,0,0,0,0,0,0,0,0,0,0,0,1,1,1,−1,1,1,1,1,−1,−1,−1,1,−1,−1,1,1,1,1,−1,1,1,1,1,−1,1,1,1,−1,1,−1,1,−1,1,1,−1,1,−1,−1,−1,1,1,−1,−1,−1,1,−1,−1,1,1,1,1,1,1,−1,−1,1,−1,−1,1,1,1,−1,−1,−1,−1,1,−1,−1,1,1,1,1,−1,−1,1,−1,−1,−1,1,−1,1,1,−1,−1,−1,−1,−1,−1,1,1,−1,−1,−1,−1,1,−1,1,−1,1,−1,−1,1,1,1,−1,−1,−1,1,−1,1,−1,−1,1,1,1,1,−1,−1,1,−1,−1,−1,1,−1,1,−1,−1,1,1,−1,−1,−1,1,1,−1,−1,−1,1,1,1,−1,−1,1,1,1,−1,1,1,1,−1,−1,1,1,1,1,1,−1,1,1,−1,−1,1,1,1,1,1,1,−1,−1,1,1,1,1,1,1,−1,−1,1,1,1,−1,1,1,1,1,1,1,1,1,−1,1,1,1,1,−1,1,1,1,−1,1,1,1,1,−1,1,1,−1,1,−1,−1,1,1,1,1,1,−1,−1,−1,1,−1,1,1,1,1,−1,1,1,1,−1,1,1,−1,1,−1,−1,1,−1,−1,1,1,1,1,0,0,0,0,0,1,−1,1,−1,1,1,−1,−1,1,1,−1,−1,1,−1,−1,−1,−1,1,−1,−1,−1,1,−1,1,1,−1,−1,1,−1,−1,−1,−1,−1,1,−1,1,−1,1,−1,−1,−1,−1,1,1,−1,1,1,1,1,1,−1,−1,1,−1,1,−1,1,1,1,−1,1,1,−1,−1,−1,1,−1,1,1,−1,1,1,1,−1,−1,1,1,1,−1,1,1,−1,−1,−1,−1,1,1,1,−1,1,1,1,1,−1,−1,−1,1,−1,1,1,1,1,1,1,1,1,1,1,1,1,−1,−1,−1,1,−1,1,1,1,1,1,1,−1,1,−1,1,1,−1,1,−1,1,1,−1,1,−1,1,1,1,1,1,1,1,−1,1,1,−1,1,1,1,1,−1,−1,−1,−1,1,1,1,−1,1,1,−1,1,−1,−1,−1,−1,−1,−1,1,1,−1,−1,−1,1,−1,−1,−1,−1,−1,1,−1,1,−1,−1,−1,−1,1,−1,−1,−1,−1,−1,−1,1,−1,−1,−1,−1,−1,−1,−1,−1,1,1,−1,−1,−1,−1,−1,1,−1,−1,−1,−1,−1,−1,−1,−1,1,−1,−1,1,1,1,1,−1,−1,−1,−1,−1,−1,1,−1,1,−1,1,1,−1,1,1,−1,−1,−1,0,0,0,0,0,0,0,0,0,0,0}

For 40 MHz transmission, the N-TF sequence with the format of an HELTF40, optimized for estimation order P=5, is given by:

N-TF(HELTF40,P=5)=sqrt(512/484)·{0,0,0,0,0,0,0,0,0,0,0,0,1,−1,−1,−1,−1,1,1,−1,1,1,1,−1,−1,1,1,−1,1,1,−1,−1,−1,1,1,−1,1,1,1,1,−1,−1,−1,1,1,−1,−1,−1,−1,1,−1,−1,−1,−1,−1,−1,−1,−1,−1,−1,−1,1,−1,−1,1,1,−1,1,−1,−1,1,−1,1,−1,−1,1,1,1,−1,1,−1,−1,1,−1,1,−1,−1,1,−1,−1,−1,−1,1,−1,−1,−1,−1,−1,1,1,−1,−1,−1,−1,−1,1,−1,1,−1,−1,1,1,1,−1,−1,1,1,−1,−1,1,1,1,1,−1,1,−1,−1,1,−1,1,−1,−1,1,−1,1,1,−1,1,1,1,−1,−1,−1,1,−1,−1,−1,1,−1,1,−1,−1,−1,−1,−1,−1,−1,−1,1,−1,−1,−1,1,−1,1,1,−1,−1,−1,1,−1,1,−1,−1,1,−1,−1,−1,−1,−1,−1,−1,−1,1,−1,−1,1,1,−1,1,1,−1,1,1,1,−1,−1,1,−1,−1,1,1,1,1,−1,−1,−1,−1,−1,1,1,−1,−1,1,1,−1,−1,−1,−1,1,1,1,1,−1,1,1,1,−1,1,−1,1,1,1,1,−1,1,1,1,−1,−1,1,−1,−1,−1,−1,1,−1,−1,−1,−1,−1,−1,1,−1,0,0,0,0,0,1,−1,−1,1,1,−1,−1,−1,1,−1,−1,1,−1,1,1,−1,−1,1,−1,−1,−1,−1,−1,−1,1,1,1,1,1,−1,−1,−1,−1,1,−1,−1,1,−1,−1,−1,1,−1,−1,−1,1,1,−1,1,1,−1,1,1,−1,1,1,−1,1,1,−1,1,1,1,−1,1,−1,1,1,−1,1,−1,1,−1,1,−1,1,1,1,−1,−1,1,1,−1,−1,1,−1,1,−1,1,−1,−1,1,−1,1,−1,1,1,−1,−1,−1,1,−1,−1,−1,−1,−1,−1,−1,1,1,−1,−1,−1,−1,−1,1,−1,−1,−1,1,−1,1,−1,−1,−1,−1,1,−1,1,−1,−1,1,−1,1,1,−1,1,−1,−1,1,−1,−1,−1,1,−1,−1,1,−1,−1,−1,−1,1,−1,−1,−1,−1,−1,1,1,−1,1,−1,1,1,−1,1,1,1,1,1,1,1,1,1,1,−1,−1,−1,1,−1,−1,1,−1,−1,−1,−1,−1,−1,−1,1,1,−1,−1,−1,1,−1,1,1,−1,1,1,1,−1,−1,−1,1,−1,−1,−1,1,−1,−1,−1,−1,−1,−1,−1,1,1,1,1,1,−1,−1,−1,−1,−1,1,−1,1,−1,−1,1,−1,−1,−1,1,1,−1,1,1,−1,1,0,0,0,0,0,0,0,0,0,0,0}

For 40 MHz transmission, the N-TF sequence with the format of an HELTF40, optimized for estimation order P=6, is given by:

N-TF(HELTF40,P=6)=sqrt(512/484)·{0,0,0,0,0,0,0,0,0,0,0,0,−1,−1,−1,1,−1,1,−1,1,−1,1,−1,1,1,−1,−1,−1,1,1,−1,−1,−1,1,1,1,−1,−1,−1,−1,1,−1,1,−1,−1,−1,1,−1,−1,1,−1,−1,−1,1,1,1,−1,−1,−1,1,−1,−1,−1,−1,1,1,1,−1,−1,1,−1,1,1,−1,1,−1,−1,−1,−1,1,1,1,−1,−1,1,1,1,1,−1,−1,−1,−1,−1,−1,−1,−1,−1,−1,1,−1,1,1,1,1,−1,1,−1,−1,1,−1,−1,1,1,−1,1,−1,−1,1,−1,1,1,−1,1,−1,1,−1,−1,−1,−1,−1,1,−1,1,1,−1,−1,1,−1,1,1,−1,−1,−1,−1,−1,−1,−1,−1,1,−1,−1,1,−1,−1,−1,1,−1,1,−1,−1,1,−1,−1,1,−1,1,−1,−1,1,1,1,1,−1,−1,−1,1,1,−1,−1,1,−1,1,1,−1,−1,1,−1,1,1,−1,−1,−1,−1,1, 1,1,1,1,−1,−1,1,1,−1,−1,1,1,1,1,−1,−1,1,−1,−1,−1,1,−1,1,−1,−1,−1,−1,−1,−1,−1,−1,1,−1,−1,1,−1,−1,1,1,−1,−1,1,−1,−1,−1,−1,−1,1,1,−1,1,−1,1,1,−1,1,1,1,1,−1,0,0,0,0,0,1,−1,−1,−1,−1,1,1,−1,1,1,−1,−1,1,1,−1,−1,−1,−1,1,1,−1,−1,−1,−1,−1,1,−1,1,1,−1,1,−1,−1,−1,−1,−1,−1,1,1,1,1,−1,−1,−1,−1,−1,1,−1,−1,−1,−1,−1,−1,−1,−1,1,1,−1,−1,−1,−1,−1,1,1,1,1,1,−1,−1,1,−1,1,1,−1,−1,−1,−1,1,−1,−1,1,1,−1,1,1,−1,−1,1,−1,−1,1,−1,−1,1,1,1,1,−1,−1,1,−1,1,1,1,1,1,1,−1,−1,1,−1,1,1,−1,−1,1,−1,−1,−1,1,1,1,1,1,−1,−1,1,−1,−1,−1,1,−1,−1,−1,−1,−1,1,−1,−1,−1,1,−1,1,−1,−1,1,−1,1,1,−1,−1,−1,1,−1,1,1,−1,−1,1,−1,1,1,−1,−1,−1,−1,−1,−1,−1,1,−1,−1,−1,1,1,−1,−1,1,1,1,1,−1,1,−1,1,1,−1,−1,1,1,1,1,−1,−1,1,1,−1,−1,1,−1,1,−1,−1,1,1,1,−1,−1,−1,−1,−1,1,1,−1,−1,−1,1,−1,−1,−1,−1,−1,1,−1,−1,1,−1,1,−1,1,−1,−1,−1,−1,−1,−1,1,1,1,−1,−1,1,0,0,0,0,0,0,0,0,0,0,0}

For 40 MHz transmission, the N-TF sequence with the format of an HELTF40, optimized for estimation order P=7, is given by:

N-TF(HELTF40,P=7)=sqrt(512/484)·{0,0,0,0,0,0,0,0,0,0,0,0,1,−1,1,1,1,−1,1,−1,1,1,−1,−1,−1,−1,−1,−1,−1,1,1,−1,1,1,−1,1,−1,1,1,−1,−1,1,1,1,1,1,1,1,1,−1,1,−1,−1,1,−1,1,−1,−1,−1,−1,−1,1,−1,1,−1,−1,−1,1,−1,−1,1,1,1,1,1,−1,1,1,1,−1,−1,−1,−1,1,1,1,1,−1,−1,1,1,−1,1,−1,1,−1,−1,−1,−1,1,1,−1,1,1,−1,−1,−1,1,1,−1,−1,1,1,−1,1,1,1,−1,−1,−1,−1,−1,−1,−1,1,−1,1,−1,1,−1,1,−1,1,−1,1,−1,−1,−1,1,−1,1,1,−1,−1,1,−1,1,−1,−1,−1,−1,−1,1,−1,−1,−1,1,−1,−1,1,−1,−1,1,−1,1,−1,1,−1,−1,1,1,−1,1,−1,1,−1,1,−1,−1,1,−1,1,−1,−1,1,−1,−1,1,−1,−1,1,−1,1,1,−1,−1,1,1,−1,−1,1,−1,−1,−1,−1,1,1,1,−1,1,−1,1,−1,−1,−1,−1,−1,−1,−1,−1,−1,−1,1,−1,1,−1,−1,−1,−1,−1,−1,1,−1,−1,−1,−1,−1,1,−1,1,1,−1,1,−1,−1,1,−1,−1,−1,−1,−1,1,−1,1,0,0,0,0,0,−1,−1,−1,1,1,1,1,1,1,−1,−1,1,1,1,1,−1,−1,−1,−1,1,−1,1,−1,1,−1,1,−1,1,1,1,−1,−1,−1,1,−1,1,−1,1,1,1,−1,1,−1,1,−1,1,1,−1,−1,−1,−1,1,−1,−1,−1,−1,−1,1,1,−1,−1,1,−1,−1,1,1,−1,−1,−1,1,1,1,−1,1,1,1,−1,1,−1,1,−1,1,−1,1,−1,−1,−1,−1,−1,−1,1,−1,−1,1,−1,1,1,1,1,1,−1,1,−1,−1,1,1,1,−1,−1,−1,1,1,−1,−1,−1,1,−1,−1,−1,−1,−1,1,−1,−1,−1,−1,1,−1,1,−1,1,−1,1,−1,1,−1,−1,−1,−1,−1,−1,−1,1,−1,−1,−1,−1,1,−1,−1,1,1,−1,−1,−1,−1,−1,1,−1,1,−1,−1,1,1,−1,−1,−1,1,1,−1,−1,1,1,1,−1,1,−1,1,−1,1,−1,−1,−1,−1,−1,1,−1,1,1,1,−1,1,−1,1,1,−1,1,1,1,−1,−1,1,−1,1,−1,−1,−1,1,−1,1,−1,−1,−1,−1,−1,1,−1,−1,−1,−1,1,1,−1,1,−1,−1,−1,−1,−1,1,1,1,−1,1,−1,1,−1,1,−1,−1,−1,1,0,0,0,0,0,0,0,0,0,0,0}

For 40 MHz transmission, the N-TF sequence with the format of an HELTF40, optimized for estimation order P=8, is given by:

N-TF(HELTF40,P=8)=sqrt(512/484)·{0,0,0,0,0,0,0,0,0,0,0,0,1,−1,−1,−1,−1,1,1,−1,−1,1,−1,−1,−1,−1,1,−1,−1,1,−1,1,1,−1,1,−1,1,1,−1,1,1,1,1,1,−1,1,1,−1,−1,1,1,−1,−1,−1,1,−1,−1,−1,1,1,−1,−1,−1,1,1,−1,−1,1,−1,−1,−1,1,1,1,−1,1,−1,1,1,−1,1, 1,1,1,1,1,1,−1,−1,1,−1,1,1,−1,1,1,−1,−1,−1,1,−1,−1,1,1,−1,1,−1,−1,−1,−1,−1,1,−1,1,1,1,1,−1,1,−1,1,1,1,1,1,−1,−1,1,−1,1,1,−1,1,1,−1,1,−1,1,−1,−1,1,1,−1,1,−1,1,−1,−1,1,1,1,1,1,−1,1,−1,1,−1,1,−1,−1,1,1,−1,−1,−1,1,−1,1,1,−1,−1,−1,−1,−1,1,−1,−1,−1,1,−1,−1,−1,1,1,1,1,−1,−1,−1,1,−1,−1,1,1,−1,−1,−1,1,−1,−1,1,1,−1,1,1,−1,1,−1,1,−1,1,1,−1,−1,1,−1,1,−1,−1,1,1,−1,1,−1,1,1,−1,1,1,−1,−1,1,1,1,−1,1,−1,1,1,1,−1,1,−1,−1,1,−1,−1,−1,1,1,1,1,1,0,0,0,0,0,1,1,1,1,−1,1,−1,1,−1,1,−1,1,−1,1,−1,1,−1,−1,−1,1,−1,−1,1,−1,1,−1,−1,−1,1,1,1,1,−1,1,1,1,1,1,1,−1,−1,1,1,1,−1,−1,−1,1,−1,−1,−1,1,−1,−1,−1,−1,1,1,−1,−1,1,−1,−1,−1,1,1,−1,−1,1,−1,1,−1,1,1,1,1,1,1,−1,1,1,1,1,−1,−1,1,−1,1,−1,1,−1,1,1,−1,−1,1,1,−1,1,−1,1,1,1,−1,1,−1,1,−1,−1,−1,1,1,1,1,1,1,−1,1,1,1,1,1,−1,1,−1,1,−1,1,−1,−1,−1,1,−1,−1,1,−1,−1,−1,−1,−1,1,1,−1,−1,1,−1,−1,−1,−1,1,1,−1,−1,1,−1,1,−1,1,1,1,−1,1,−1,1,−1,−1,−1,1,1,1,−1,−1,1,1,−1,1,1,1,−1,−1,1,−1,−1,1,−1,−1,1,1,−1,−1,1,1,−1,−1,1,−1,1,1,−1,1,−1,1,−1,−1,−1,1,−1,1,1,−1,1,−1,−1,−1,1,−1,1,−1,1,−1,−1,−1,1,−1,−1,−1,1,1,−1,1,1,−1,−1,−1,−1,1,1,1,1,1,1,−1,0,0,0,0,0,0,0,0,0,0,0}

For 40 MHz transmission, the N-TF sequence with the format of an HELTF40, optimized for estimation order P=9, is given by:

N-TF(HELTF40,P=9)=sqrt(512/484)·{0,0,0,0,0,0,0,0,0,0,0,0,−1,−1,−1,−1,−1,1,1,1,1,1,1,−1,1,−1,−1,1,−1,1,1,1,−1,−1,1,−1,−1,−1,1,1,1,1,1,1,1,−1,−1,1,1,−1,1,1,−1,1,−1,−1,1,1,1,1,1,1,1,−1,−1,−1,−1,1,1,1,1,1,−1,−1,−1,1,1,−1,1,−1,1,1,−1,1,−1,1,1,−1,1,−1,1,1,−1,−1,−1,1,−1,−1,1,1,1,1,−1,−1,1,1,1,1,1,−1,1,1,1,−1,1,−1,1,1,1,−1,−1,1,1,−1,1,1,1,1,1,−1,1,1,1,1,1,1,1,−1,1,1,−1,−1,1,−1,1,1,−1,1,1,1,−1,−1,1,−1,1,1,1,−1,1,1,1,1,−1,−1,1,1,1,−1,−1,1,−1,1,1,−1,1,1,1,−1,1,1,−1,1,1,−1,1,1,−1,−1,1,1,1,1,−1,1,1,1,1,1,−1,1,−1,1,1,−1,1,1,−1,−1,1,−1,1,1,1,1,1,1,1,−1,1,1,1,1,1,−1,1,1,−1,1,1,1,1,1,1,−1,1,1,−1,1,1,1,1,1,1,−1,1,1,−1,−1,1,−1,1,1,1,1,0,0,0,0,0,1,1,1,1,−1,−1,1,−1,1,1,1,1,1,1,−1,−1,−1,−1,−1,1,1,1,1,1,−1,−1,−1,1,1,1,1,−1,1,1,1,1,1,1,−1,1,1,−1,1,1,1,1,1,1,−1,1,−1,1,1,1,−1,−1,−1,1,−1,1,1,1,1,1,−1,−1,1,1,−1,1,1,1,1,−1,1,−1,−1,1,1,1,1,1,−1,1,−1,−1,1,1,−1,1,−1,−1,−1,−1,−1,−1,−1,−1,1,1,1,1,−1,1,−1,1,−1,1,1,1,1,1,1,1,1,−1,1,1,1,1,1,1,1,1,−1,−1,1,−1,1,1,1,1,−1,−1,−1,1,1,−1,1,−1,1,−1,−1,1,−1,−1,1,1,1,1,1,−1,−1,1,−1,1,−1,1,−1,−1,−1,−1,1,1,−1,1,1,1,−1,−1,−1,−1,1,−1,1,−1,1,−1,−1,−1,−1,−1,−1,1,1,1,1,1,−1,−1,−1,1,−1,1,1,−1,−1,1,−1,1,−1,1,1,1,1,−1,1,1,1,−1,−1,−1,−1,1,1,−1,1,−1,1,−1,1,1,−1,1,−1,−1,1,−1,−1,1,−1,1,−1,1,−1,1,−1,1,1,1,1,1,0,0,0,0,0,0,0,0,0,0,0}

For 40 MHz transmission, the N-TF sequence with the format of an HELTF40, optimized for estimation order P=10, is given by:

N-TF(HELTF40,P=10)=sqrt(512/484)·{0,0,0,0,0,0,0,0,0,0,0,0,1,−1,1,−1,1,−1,−1,−1,1,1,1,−1,1,1,−1,1,−1,1,−1,1,−1,1,−1,−1,1,1,1,−1,1,1,1,1,1,1,−1,−1,1,−1,1,−1,1,1,1,1,−1,1,−1,1,1,1,−1,1,−1,−1,1,−1,−1,1,1,1,1,−1,1,−1,1,−1,1,−1,−1,−1,1,1,1,1,−1,1,−1,1,−1,1,−1,1,1,1,−1,−1,−1,−1,1,−1,1,−1,1,−1,1,−1,−1,1,−1,−1,−1,−1,−1,1, 1,1,1,1,−1,1,−1,−1,1,1,1,−1,1,−1,1,−1,1,1,1,−1,1,−1,−1,1,1,−1,−1,1,−1,1,−1,1,1,1,1,1,−1,−1,1,1,−1,−1,1,−1,1,1,1,1,1,1,1,1,1,1,−1,1,1,−1,−1,−1,−1,1,1,1,−1,1,1,−1,1,−1,−1,−1,1,−1,−1,−1,−1,−1,1,−1,1,1,−1,1,1,−1,1,−1,−1,1,1,1,−1,1,1,1,1,1,−1,1,−1,−1,−1,−1,−1,1,−1,1,−1,1,1,1,1,1,−1,−1,−1,−1,−1,1,−1,−1,−1,1,−1,−1,1,1,−1,1,−1,−1,−1,1,1,1,−1,−1,0,0,0,0,0,−1,1,−1,1,−1,−1,−1,1,1,1,1,1,1,−1,1,−1,1,1,−1,−1,−1,1,−1,1,−1,−1,1,−1,1,1,1,1,1,1,1,1,1,−1,1,−1,1,1,1,−1,1,−1,1,1,−1,−1,−1,−1,−1,−1,−1,−1,1,1,1,1,−1,1,1,1,1,1,−1,1,−1,1,−1,1,−1,1,1,1,−1,−1,−1,−1,1,−1,1,−1,−1,−1,1,1,−1,1,1,−1,1,−1,−1,1,−1,−1,−1,−1,−1,−1,1,−1,1,−1,1,−1,1,−1,1,−1,−1,1,−1,−1,−1,−1,−1,1,1,−1,1,1,−1,1,1,1,−1,−1,−1,1,−1,−1,−1,1,1,−1,1,−1,1,1,1,1,−1,−1,−1,1,−1,1, 1,1,1,1,1,1,1,−1,−1,−1,1,−1,1,−1,1,−1,1,−1,1,−1,1,−1,1,1,1,1,−1,−1,−1,1,−1,1,−1,1,−1,1,1,−1,−1,−1,1,−1,−1,−1,−1,1,1,1,1,−1,−1,1,1,−1,−1,−1,−1,1,−1,1,−1,1,−1,1,1,1,1,−1,1,1,1,−1,−1,−1,−1,−1,1,−1,1,1,1,1,1,−1,1,1,−1,1,1,1,−1,1,0,0,0,0,0,0,0,0,0,0,0}

### List17

For 80 MHz transmission, the N-TF sequence with the format of an HESTF80, optimized for estimation order P=3, is given by:

N-TF(HESTF80,P=3)=sqrt(1024/62)·{0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0}

For 80 MHz transmission, the N-TF sequence with the format of an HESTF80, optimized for estimation order P=4, is given by:

N-TF(HESTF80,P=4)=sqrt(1024/62)·{0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0}

For 80 MHz transmission, the N-TF sequence with the format of an HESTF80, optimized for estimation order P=5, is given by:

N-TF(HESTF80,P=5)=sqrt(1024/62)·{0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0}

For 80 MHz transmission, the N-TF sequence with the format of an HESTF80, optimized for estimation order P=6, is given by:

N-TF(HESTF80,P=6)=sqrt(1024/62)·{0,0,0,0,−1,0,0,0,1,0,0,0,−1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,−1,0,0,0,−1,0,0,0,1,0,0,0,−1,0,0,0,1,0,0,0,1,0,0,0,1,0,0,0,1,0,0,0,−1,0,0,0,1,0,0,0,1,0,0,0,−1,0,0,0,1,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0, 0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1}

For 80 MHz transmission, the N-TF sequence with the format of an HESTF80, optimized for estimation order P=7, is given by:

N-TF(HESTF80,P=7)=sqrt(1024/62)·{0,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1}

For 80 MHz transmission, the N-TF sequence with the format of an HESTF80, optimized for estimation order P=8, is given by:

N-TF(HESTF80,P=8)=sqrt(1024/62)·{0,0,0,0,−1,0,0,0,−1,0,0,0,−1,0,0,0,−1,0,0,0,1,0,0,0,−1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,−1,0,0,0,−1,0,0,0,−1,0,0,0,−1,0,0,0,1,0,0,0,1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,1,0,0,0,−1,0,0,0,−1,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1}

For 80 MHz transmission, the N-TF sequence with the format of an HESTF80, optimized for estimation order P=9, is given by:

N-TF(HESTF80,P=9)=sqrt(1024/62)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0}

For 80 MHz transmission, the N-TF sequence with the format of an HESTF80, optimized for estimation order P=10, is given by:

N-TF(HESTF80,P=10)=sqrt(1024/62)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0 ,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0, 0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0 ,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0, 0,0,0,1,0,0,0,0,0,0,0,0,0,0,0,0,0,0,0,1,0,0,0,0,1,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0}

### List18

For 80 MHz transmission, the N-TF sequence with the format of an HELTF1X80, optimized for estimation order P=3, is given by:

N-TF(HELTF1X80,P=3)=sqrt(1024/250)·{0,0,0,0,0,0,0,0,0,0,0,0,1,0,0,0,−1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,1,0,0,0,1,0,0,0,1,0,0,0,−1,0,0,0,1,0,0,0,1,0,0,0,−1,0,0,0,−1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,1,0,0,0,−1,0,0,0,1,0,0,0,−1,0,0,0,−1,0,0,0,1,0,0,0,−1,0,0,0,−1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,1,0,0,0,1,0,0,0,−1,0,0,0,−1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,1,0,0,0,1,0,0,0,1,0,0,0,−1,0,0,0,1,0,0,0,−1,0,0,0,0,0,0,0,1,0,0,0,1,0,0,0,−1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,−1,0,0,0,−1,0,0,0,1,0,0,0,−1,0,0,0,−1,0,0,0,−1,0,0,0,1,0,0,0,−1,0,0,0,1,0,0,0,1,0,0,0,−1,0,0,0,−1,0,0,0,−1,0,0,0,1,0,0,0,1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,1,0,0,0,−1,0,0,0,1,0,0,0,1,0,0,0,−1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,1,0,0,0,1,0,0,0,−1,0,0,0,1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,1,0,0,0,1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,−1,0,0,0,0,0,0,0,0,0,0,0}

For 80 MHz transmission, the N-TF sequence with the format of an HELTF1X80, optimized for estimation order P=4, is given by:

N-TF(HELTF1X80,P=4)=sqrt(1024/250)·{0,0,0,0,0,0,0,0,0,0,0,0,−1,0,0,0,−1,0,0,0,1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,−1,0,0,0,−1,0,0,0,1,0,0,0,−1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,−1,0,0,0,1,0,0,0,1,0,0,0,1,0,0,0,1,0,0,0,−1,0,0,0,1,0,0,0,1,0,0,0,−1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,1,0,0,0,−1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,1,0,0,0,1,0,0,0,1,0,0,0,−1,0,0,0,1,0,0,0,−1,0,0,0,−1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,1,0,0,0,1,0,0,0,−1,0,0,0,1,0,0,0,1,0,0,0,−1,0,0,0,1,0,0,0,0,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,1,0,0,0,1,0,0,0,1,0,0,0,−1,0,0,0,−1,0,0,0,1,0,0,0,−1,0,0,0,−1,0,0,0,−1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,1,0,0,0,1,0,0,0,−1,0,0,0,−1,0,0,0,1,0,0,0,−1,0,0,0,1,0,0,0,1,0,0,0,−1,0,0,0,−1,0,0,0,1,0,0,0,1,0,0,0,−1,0,0,0,−1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,−1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,−1,0,0,0,−1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,1,0,0,0,0,0,0,0,0,0,0,0}

For 80 MHz transmission, the N-TF sequence with the format of an HELTF1X80, optimized for estimation order P=5, is given by:

N-TF(HELTF1X80,P=5)=sqrt(1024/250)·{0,0,0,0,0,0,0,0,0,0,0,0,1,0,0,0,−1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,1,0,0,0,−1,0,0,0,−1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,1,0,0,0,−1,0,0,0,−1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,−1,0,0,0,−1,0,0,0,−1,0,0,0,−1,0,0,0,1,0,0,0,1,0,0,0,−1,0,0,0,−1,0,0,0,1,0,0,0,−1,0,0,0,−1,0,0,0,1,0,0,0,−1,0,0,0,−1,0,0,0,1,0,0,0,−1,0,0,0,−1,0,0,0,1,0,0,0,1,0,0,0,1,0,0,0,−1,0,0,0,1,0,0,0,1,0,0,0,−1,0,0,0,1,0,0,0,1,0,0,0,1,0,0,0,1,0,0,0,−1,0,0,0,−1,0,0,0,−1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,1,0,0,0,−1,0,0,0,−1,0,0,0,−1,0,0,0,−1,0,0,0,−1,0,0,0,1,0,0,0,0,0,0,0,−1,0,0,0,1,0,0,0,−1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,−1,0,0,0,1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,1,0,0,0,−1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,−1,0,0,0,1,0,0,0,1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,1,0,0,0,−1,0,0,0,1,0,0,0,1,0,0,0,1,0,0,0,−1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,−1,0,0,0,−1,0,0,0,−1,0,0,0,1,0,0,0,−1,0,0,0,−1,0,0,0,1,0,0,0,1,0,0,0,1,0,0,0,1,0,0,0,1,0,0,0,0,0,0,0,0,0,0,0}

For 80 MHz transmission, the N-TF sequence with the format of an HELTF1X80, optimized for estimation order P=6, is given by:

N-TF(HELTF1X80,P=6)=sqrt(1024/250)·{0,0,0,0,0,0,0,0,0,0,0,0,1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,1,0,0,0,−1,0,0,0,−1,0,0,0,1,0,0,0,1,0,0,0,1,0,0,0,1,0,0,0,1,0,0,0,1,0,0,0,−1,0,0,0,1,0,0,0,1,0,0,0,−1,0,0,0,1,0,0,0,1,0,0,0,1,0,0,0,−1,0,0,0,1,0,0,0,−1,0,0,0,−1,0,0,0,1,0,0,0,1,0,0,0,1,0,0,0,−1,0,0,0,1,0,0,0,1,0,0,0,−1,0,0,0,1,0,0,0,1,0,0,0,1,0,0,0,−1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,1,0,0,0,1,0,0,0,0,0,0,0,−1,0,0,0,−1,0,0,0,−1,0,0,0,−1,0,0,0,−1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,−1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,1,0,0,0,−1,0,0,0,−1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,1,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,0,0,0,0,0,0,0,0}

For 80 MHz transmission, the N-TF sequence with the format of an HELTF1X80, optimized for estimation order P=7, is given by:

N-TF(HELTF1X80,P=7)=sqrt(1024/250)·{0,0,0,0,0,0,0,0,0,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,−1,0,0,0,−1,0,0,0,−1,0,0,0,1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,−1,0,0,0,−1,0,0,0,1,0,0,0,−1,0,0,0,1,0,0,0,−1,0,0,0,1,0,0,0,0,0,0,0,−1,0,0,0,1,0,0,0,−1,0,0,0,1,0,0,0,1,0,0,0,−1,0,0,0,−1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,1,0,0,0,−1,0,0,0,1,0,0,0,−1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,1,0,0,0,1,0,0,0,−1,0,0,0,1,0,0,0,1,0,0,0,−1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,1,0,0,0,1,0,0,0,−1,0,0,0,1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,−1,0,0,0,1,0,0,0,1,0,0,0,1,0,0,0,1,0,0,0,1,0,0,0,1,0,0,0,1,0,0,0,0,0,0,0,0,0,0,0}

For 80 MHz transmission, the N-TF sequence with the format of an HELTF1X80, optimized for estimation order P=8, is given by:

N-TF(HELTF1X80,P=8)=sqrt(1024/250)·{0,0,0,0,0,0,0,0,0,0,0,0,1,0,0,0,−1,0,0,0,1,0,0,0,−1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,−1,0,0,0,1,0,0,0,−1,0,0,0,−1,0,0,0,−1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,−1,0,0,0,1,0,0,0,−1,0,0,0,−1,0,0,0,1,0,0,0,1,0,0,0,−1,0,0,0,−1,0,0,0,−1,0,0,0,−1,0,0,0,−1,0,0,0,−1,0,0,0,1,0,0,0,−1,0,0,0,1,0,0,0,−1,0,0,0,−1,0,0,0,1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,1,0,0,0,1,0,0,0,−1,0,0,0,1,0,0,0,1,0,0,0,−1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,1,0,0,0,−1,0,0,0,1,0,0,0,−1,0,0,0,1,0,0,0,−1,0,0,0,−1,0,0,0,−1,0,0,0,1,0,0,0,−1,0,0,0,−1,0,0,0,1,0,0,0,0,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,−1,0,0,0,1,0,0,0,−1,0,0,0,1,0,0,0,−1,0,0,0,−1,0,0,0,−1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,−1,0,0,0,−1,0,0,0,−1,0,0,0,1,0,0,0,−1,0,0,0,−1,0,0,0,−1,0,0,0,1,0,0,0,1,0,0,0,−1,0,0,0,−1,0,0,0,−1,0,0,0,1,0,0,0,1,0,0,0,1,0,0,0,−1,0,0,0,1,0,0,0,−1,0,0,0,−1,0,0,0,1,0,0,0,1,0,0,0,−1,0,0,0,−1,0,0,0,1,0,0,0,−1,0,0,0,1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,−1,0,0,0,−1,0,0,0,1,0,0,0,1,0,0,0,−1,0,0,0,1,0,0,0,1,0,0,0,1,0,0,0,−1,0,0,0,0,0,0,0,0,0,0,0}

For 80 MHz transmission, the N-TF sequence with the format of an HELTF1X80, optimized for estimation order P=9, is given by:

N-TF(HELTF1X80,P=9)=sqrt(1024/250)·{0,0,0,0,0,0,0,0,0,0,0,0,−1,0,0,0,1,0,0,0,−1,0,0,0,1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,1,0,0,0,−1,0,0,0,−1,0,0,0,1,0,0,0,−1,0,0,0,1,0,0,0,1,0,0,0,0,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,1,0,0,0,−1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,1,0,0,0,−1,0,0,0,−1,0,0,0,1,0,0,0,−1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,−1,0,0,0,−1,0,0,0,1,0,0,0,−1,0,0,0,−1,0,0,0,1,0,0,0,−1,0,0,0,1,0,0,0,1,0,0,0,−1,0,0,0,1,0,0,0,1,0,0,0,−1,0,0,0,1,0,0,0,1,0,0,0,−1,0,0,0,1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,−1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,1,0,0,0,1,0,0,0,0,0,0,0,0,0,0,0}

For 80 MHz transmission, the N-TF sequence with the format of an HELTF1X80, optimized for estimation order P=10, is given by:

N-TF(HELTF1X80,P=10)=sqrt(1024/250)·{0,0,0,0,0,0,0,0,0,0,0,0,1,0,0,0,1,0,0,0,−1,0,0,0,−1,0,0,0,1,0,0,0,1,0,0,0,−1,0,0,0,−1,0,0,0,1,0,0,0,1,0,0,0,−1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,1,0,0,0,1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,1,0,0,0,−1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,−1,0,0,0,1,0,0,0,1,0,0,0,−1,0,0,0,−1,0,0,0,1,0,0,0,−1,0,0,0,−1,0,0,0,−1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,1,0,0,0,−1,0,0,0,1,0,0,0,−1,0,0,0,1,0,0,0,1,0,0,0,1,0,0,0,1,0,0,0,−1,0,0,0,−1,0,0,0,1,0,0,0,−1,0,0,0,−1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,−1,0,0,0,−1,0,0,0,1,0,0,0,−1,0,0,0,−1,0,0,0,−1,0,0,0,−1,0,0,0,1,0,0,0,−1,0,0,0,1,0,0,0,−1,0,0,0,1,0,0,0,0,0,0,0,1,0,0,0,−1,0,0,0,1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,1,0,0,0,−1,0,0,0,−1,0,0,0,1,0,0,0,−1,0,0,0,1,0,0,0,−1,0,0,0,1,0,0,0,−1,0,0,0,−1,0,0,0,1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,−1,0,0,0,1,0,0,0,−1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,−1,0,0,0,1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,−1,0,0,0,1,0,0,0,1,0,0,0,1,0,0,0,−1,0,0,0,1,0,0,0,−1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,0,0,0,0,0,0,0,0}

### List19

For 80 MHz transmission, the N-TF sequence with the format of an HELTF2X80, optimized for estimation order P=3, is given by:

N-TF(HELTF2X80,P=3)=sqrt(1024/498)·{0,0,0,0,0,0,0,0,0,0,0,0,1,0,−1,0,−1,0,−1,0,1,0,−1,0,1,0,−1,0,1,0,1,0,−1,0,1,0,1,0,1,0,1,0,−1,0,1,0,1,0,−1,0,−1,0,−1,0,−1,0,1,0,1,0,−1,0,1,0,−1,0,1,0,1,0,−1,0,−1,0,−1,0,−1,0,1,0,−1,0,1,0,1,0,1,0,−1,0,−1,0,1,0,−1,0,1,0,1,0,−1,0,1,0,−1,0,1,0,1,0,1,0,−1,0,−1,0,1,0,−1,0,−1,0,1,0,1,0,1,0,−1,0,1,0,1,0,1,0,−1,0,1,0,−1,0,−1,0,1,0,1,0,−1,0,−1,0,−1,0,−1,0,1,0,1,0,−1,0,−1,0,1,0,−1,0,1,0,−1,0,1,0,−1,0,−1,0,−1,0,−1,0,−1,0,1,0,1,0,−1,0,1,0,−1,0,1,0,1,0,−1,0,−1,0,1,0,1,0,1,0,1,0,−1,0,1,0,−1,0,1,0,−1,0,1,0,−1,0,−1,0,−1,0,−1,0,1,0,−1,0,−1,0,1,0,−1,0,1,0,1,0,1,0,1,0,−1,0,1,0,−1,0,−1,0,1,0,−1,0,−1,0,−1,0,−1,0,−1,0,−1,0,1,0,1,0,−1,0,−1,0,−1,0,1,0,1,0,−1,0,−1,0,−1,0,1,0,−1,0,−1,0,1,0,−1,0,1,0,1,0,1,0,1,0,1,0,1,0,1,0,−1,0,−1,0,−1,0,1,0,1,0,−1,0,−1,0,1,0,−1,0,−1,0,−1,0,1,0,1,0,−1,0,1,0,−1,0,1,0,1,0,−1,0,1,0,−1,0,1,0,−1,0,1,0,−1,0,−1,0,1,0,−1,0,1,0,1,0,−1,0,1,0,−1,0,1,0,1,0,1,0,1,0,−1,0,1,0,1,0,−1,0,1,0,−1,0,1,0,1,0,−1,0,1,0,−1,0,1,0,−1,0,1,0,−1,0,1,0,1,0,−1,0,−1,0,−1,0,−1,0,−1,0,−1,0,−1,0,1,0,1,0,1,0,−1,0,−1,0,1,0,1,0,−1,0,1,0,1,0,−1,0,1,0,−1,0,1,0,−1,0,−1,0,1,0,−1,0,1,0,1,0,1,0,1,0,1,0,1,0,−1,0,1,0,−1,0,1,0,−1,0,−1,0,1,0,−1,0,−1,0,−1,0,−1,0,−1,0,−1,0,0,0,0,0,0,0,1,0,−1,0,1,0,−1,0,1,0,−1,0,−1,0,−1,0,−1,0,1,0,1,0,−1,0,1,0,−1,0,1,0,−1,0,−1,0,1,0,−1,0,−1,0,1,0,1,0,−1,0,−1,0,1,0,−1,0,1,0,1,0,1,0,1,0,−1,0,1,0,1,0,1,0,−1,0,1,0,1,0,−1,0,1,0,1,0,1,0,−1,0,−1,0,1,0,1,0,−1,0,−1,0,1,0,1,0,1,0,−1,0,−1,0,−1,0,1,0,1,0,−1,0,−1,0,−1,0,−1,0,−1,0,1,0,−1,0,1,0,1,0,1,0,1,0,−1,0,1,0,1,0,1,0,−1,0,1,0,−1,0,1,0,1,0,−1,0,−1,0,1,0,−1,0,1,0,−1,0,−1,0,1,0,1,0,1,0,1,0,−1,0,1,0,−1,0,−1,0,1,0,−1,0,1,0,1,0,−1,0,−1,0,−1,0,1,0,1,0,1,0,1,0,1,0,1,0,1,0,1,0,−1,0,1,0,1,0,1,0,−1,0,−1,0,−1,0,1,0,−1,0,1,0,1,0,1,0,1,0,1,0,−1,0,1,0,−1,0,1,0,1,0,−1,0,1,0,1,0,1,0,−1,0,−1,0,1,0,1,0,1,0,1,0,−1,0,1,0,−1,0,−1,0,−1,0,1,0,−1,0,1,0,1,0,−1,0,−1,0,−1,0,1,0,1,0,−1,0,−1,0,−1,0,1,0,1,0,−1,0,−1,0,1,0,1,0,1,0,−1,0,1,0,1,0,−1,0,1,0,1,0,−1,0,1,0,−1,0,1,0,−1,0,−1,0,1,0,1,0,1,0,−1,0,1,0,1,0,1,0,−1,0,−1,0,1,0,−1,0,−1,0,1,0,−1,0,−1,0,1,0,−1,0,−1,0,1,0,1,0,1,0,1,0,−1,0,1,0,−1,0,1,0,1,0,−1,0,1,0,1,0,−1,0,1,0,1,0,1,0,1,0,1,0,−1,0,−1,0,−1,0,1,0,1,0,−1,0,−1,0,−1,0,−1,0,1,0,−1,0,−1,0,1,0,−1,0,−1,0,1,0,1,0,1,0,−1,0,1,0,−1,0,−1,0,−1,0,−1,0,1,0,−1,0,−1,0,−1,0,1,0,1,0,−1,0,1,0,1,0,−1,0,−1,0,−1,0,1,0,−1,0,1,0,−1,0,1,0,1,0,1,0,0,0,0,0,0,0,0,0,0,0}

For 80 MHz transmission, the N-TF sequence with the format of an HELTF2X80, optimized for estimation order P=4, is given by:

N-TF(HELTF2X80,P=4)=sqrt(1024/498)·{0,0,0,0,0,0,0,0,0,0,0,0,1,0,1,0,−1,0,1,0,1,0,−1,0,1,0,1,0,−1,0,−1,0,−1,0,−1,0,−1,0,−1,0,−1,0,1,0,1,0,1,0,1,0,−1,0,−1,0,1,0,1,0,−1,0,−1,0,−1,0,1,0,−1,0,−1,0,1,0,1,0,1,0,1,0,−1,0,1,0,1,0,−1,0,1,0,1,0,−1,0,−1,0,−1,0,1,0,−1,0,−1,0,1,0,1,0,1,0,−1,0,1,0,1,0,−1,0,1,0,1,0,1,0,−1,0,1,0,−1,0,1,0,−1,0,1,0,−1,0,1,0,−1,0,1,0,−1,0,1,0,−1,0,1,0,−1,0,−1,0,1,0,−1,0,1,0,−1,0,1,0,−1,0,−1,0,−1,0,1,0,−1,0,1,0,1,0,1,0,−1,0,1,0,1,0,1,0,−1,0,1,0,1,0,1,0,1,0,1,0,1,0,−1,0,−1,0,1,0,−1,0,1,0,−1,0,1,0,−1,0,1,0,1,0,−1,0,−1,0,1,0,−1,0,1,0,−1,0,−1,0,1,0,1,0,−1,0,1,0,−1,0,−1,0,1,0,1,0,−1,0,1,0,1,0,−1,0,−1,0,−1,0,−1,0,−1,0,−1,0,−1,0,−1,0,−1,0,−1,0,1,0,−1,0,−1,0,1,0,−1,0,1,0,−1,0,−1,0,−1,0,1,0,−1,0,1,0,−1,0,−1,0,1,0,−1,0,−1,0,1,0,1,0,1,0,−1,0,1,0,1,0,1,0,1,0,1,0,1,0,1,0,−1,0,1,0,1,0,−1,0,1,0,−1,0,−1,0,−1,0,1,0,1,0,1,0,1,0,−1,0,−1,0,1,0,1,0,1,0,−1,0,1,0,−1,0,1,0,−1,0,1,0,−1,0,−1,0,1,0,1,0,−1,0,1,0,1,0,1,0,−1,0,1,0,−1,0,−1,0,1,0,1,0,−1,0,−1,0,−1,0,1,0,1,0,−1,0,−1,0,1,0,−1,0,1,0,1,0,1,0,−1,0,1,0,−1,0,1,0,1,0,−1,0,−1,0,−1,0,1,0,1,0,1,0,−1,0,1,0,−1,0,1,0,−1,0,1,0,−1,0,−1,0,1,0,1,0,−1,0,1,0,1,0,1,0,−1,0,1,0,1,0,1,0,1,0,1,0,1,0,1,0,−1,0,1,0,1,0,−1,0,−1,0,−1,0,0,0,0,0,0,0,−1,0,1,0,−1,0,−1,0,1,0,−1,0,−1,0,1,0,−1,0,1,0,−1,0,1,0,−1,0,1,0,−1,0,1,0,1,0,1,0,1,0,−1,0,1,0,1,0,−1,0,1,0,1,0,−1,0,1,0,−1,0,−1,0,1,0,−1,0,−1,0,1,0,1,0,1,0,1,0,1,0,1,0,1,0,−1,0,1,0,−1,0,1,0,1,0,1,0,1,0,1,0,1,0,−1,0,−1,0,−1,0,1,0,−1,0,1,0,1,0,1,0,1,0,1,0,−1,0,−1,0,−1,0,−1,0,1,0,−1,0,1,0,−1,0,1,0,−1,0,1,0,−1,0,−1,0,1,0,1,0,−1,0,1,0,1,0,−1,0,1,0,1,0,1,0,−1,0,1,0,1,0,1,0,−1,0,−1,0,−1,0,−1,0,−1,0,1,0,−1,0,1,0,−1,0,1,0,1,0,−1,0,1,0,1,0,1,0,−1,0,−1,0,1,0,−1,0,1,0,1,0,1,0,1,0,−1,0,−1,0,1,0,1,0,1,0,1,0,−1,0,−1,0,1,0,−1,0,−1,0,1,0,−1,0,−1,0,1,0,1,0,1,0,−1,0,1,0,1,0,1,0,−1,0,−1,0,1,0,−1,0,1,0,−1,0,1,0,−1,0,1,0,−1,0,1,0,−1,0,−1,0,1,0,1,0,−1,0,1,0,−1,0,−1,0,−1,0,1,0,1,0,1,0,−1,0,1,0,−1,0,1,0,−1,0,−1,0,−1,0,1,0,−1,0,1,0,1,0,1,0,1,0,1,0,1,0,1,0,−1,0,−1,0,1,0,−1,0,1,0,−1,0,1,0,−1,0,1,0,1,0,1,0,−1,0,1,0,1,0,1,0,1,0,−1,0,−1,0,−1,0,−1,0,1,0,−1,0,1,0,1,0,1,0,−1,0,1,0,−1,0,1,0,−1,0,1,0,1,0,−1,0,−1,0,−1,0,−1,0,−1,0,−1,0,1,0,−1,0,1,0,−1,0,1,0,−1,0,1,0,1,0,−1,0,−1,0,−1,0,1,0,1,0,−1,0,1,0,1,0,1,0,−1,0,−1,0,1,0,1,0,1,0,1,0,1,0,−1,0,1,0,−1,0,−1,0,1,0,1,0,−1,0,−1,0,−1,0,1,0,1,0,−1,0,1,0,−1,0,−1,0,−1,0,−1,0,1,0,1,0,1,0,0,0,0,0,0,0,0,0,0,0}

For 80 MHz transmission, the N-TF sequence with the format of an HELTF2X80, optimized for estimation order P=5, is given by:

N-TF(HELTF2X80,P=5)=sqrt(1024/498)·{0,0,0,0,0,0,0,0,0,0,0,0,1,0,−1,0,1,0,−1,0,1,0,−1,0,1,0,−1,0,1,0,1,0,1,0,−1,0,1,0,−1,0,1,0,1,0,−1,0,1,0,1,0,1,0,1,0,−1,0,1,0,1,0,−1,0,1,0,−1,0,−1,0,1,0,−1,0,1,0,1,0,−1,0,1,0,−1,0,−1,0,1,0,−1,0,−1,0,1,0,1,0,1,0,1,0,−1,0,1,0,−1,0,1,0,−1,0,1,0,1,0,−1,0,1,0,1,0,1,0,−1,0,1,0,−1,0,1,0,−1,0,1,0,1,0,1,0,1,0,1,0,−1,0,1,0,−1,0,1,0,−1,0,−1,0,−1,0,1,0,1,0,−1,0,−1,0,−1,0,1,0,1,0,1,0,1,0,−1,0,−1,0,1,0,−1,0,1,0,−1,0,−1,0,−1,0,−1,0,1,0,1,0,−1,0,1,0,−1,0,1,0,1,0,−1,0,−1,0,−1,0,−1,0,−1,0,−1,0,1,0,1,0,1,0,−1,0,−1,0,1,0,1,0,−1,0,1,0,−1,0,−1,0,1,0,1,0,1,0,1,0,−1,0,−1,0,−1,0,−1,0,1,0,1,0,−1,0,1,0,−1,0,1,0,−1,0,−1,0,1,0,1,0,−1,0,1,0,−1,0,1,0,−1,0,−1,0,−1,0,1,0,1,0,1,0,−1,0,−1,0,1,0,−1,0,1,0,1,0,1,0,1,0,−1,0,1,0,−1,0,−1,0,−1,0,1,0,−1,0,−1,0,−1,0,1,0,−1,0,−1,0,1,0,−1,0,1,0,1,0,−1,0,1,0,−1,0,1,0,−1,0,1,0,1,0,1,0,1,0,−1,0,−1,0,1,0,−1,0,1,0,−1,0,−1,0,−1,0,−1,0,1,0,−1,0,−1,0,1,0,−1,0,1,0,1,0,−1,0,−1,0,−1,0,−1,0,−1,0,−1,0,1,0,−1,0,−1,0,−1,0,−1,0,1,0,−1,0,−1,0,−1,0,−1,0,1,0,1,0,−1,0,−1,0,1,0,−1,0,1,0,1,0,1,0,−1,0,1,0,1,0,1,0,1,0,1,0,−1,0,1,0,−1,0,−1,0,−1,0,1,0,−1,0,−1,0,1,0,1,0,1,0,−1,0,1,0,1,0,−1,0,1,0,−1,0,1,0,1,0,−1,0,−1,0,1,0,−1,0,1,0,1,0,1,0,−1,0,−1,0,0,0,0,0,0,0,−1,0,−1,0,1,0,1,0,1,0,−1,0,1,0,−1,0,1,0,−1,0,1,0,1,0,1,0,−1,0,1,0,−1,0,1,0,−1,0,1,0,1,0,1,0,1,0,1,0,−1,0,1,0,−1,0,−1,0,1,0,1,0,−1,0,−1,0,1,0,1,0,−1,0,1,0,−1,0,1,0,1,0,1,0,−1,0,−1,0,1,0,1,0,1,0,−1,0,−1,0,1,0,−1,0,1,0,−1,0,1,0,−1,0,−1,0,−1,0,−1,0,1,0,1,0,1,0,−1,0,1,0,1,0,1,0,−1,0,−1,0,1,0,1,0,1,0,−1,0,−1,0,−1,0,1,0,−1,0,1,0,1,0,1,0,1,0,1,0,1,0,1,0,−1,0,1,0,−1,0,−1,0,−1,0,−1,0,1,0,−1,0,−1,0,−1,0,−1,0,−1,0,−1,0,−1,0,1,0,1,0,−1,0,1,0,−1,0,1,0,1,0,−1,0,−1,0,−1,0,1,0,1,0,−1,0,−1,0,−1,0,1,0,1,0,−1,0,−1,0,−1,0,−1,0,1,0,−1,0,1,0,1,0,1,0,1,0,1,0,−1,0,1,0,−1,0,−1,0,1,0,1,0,−1,0,−1,0,−1,0,−1,0,−1,0,−1,0,−1,0,1,0,1,0,1,0,−1,0,1,0,1,0,−1,0,−1,0,−1,0,−1,0,−1,0,−1,0,−1,0,1,0,−1,0,1,0,−1,0,−1,0,−1,0,−1,0,1,0,−1,0,−1,0,1,0,1,0,1,0,1,0,−1,0,−1,0,1,0,−1,0,1,0,−1,0,1,0,−1,0,−1,0,1,0,−1,0,1,0,−1,0,−1,0,−1,0,1,0,−1,0,1,0,1,0,1,0,1,0,1,0,−1,0,−1,0,−1,0,1,0,−1,0,−1,0,−1,0,1,0,−1,0,1,0,−1,0,−1,0,−1,0,1,0,1,0,−1,0,1,0,1,0,−1,0,1,0,−1,0,−1,0,−1,0,−1,0,1,0,−1,0,−1,0,1,0,−1,0,1,0,1,0,1,0,−1,0,1,0,−1,0,−1,0,1,0,1,0,1,0,1,0,1,0,1,0,1,0,−1,0,−1,0,−1,0,1,0,−1,0,−1,0,1,0,−1,0,1,0,1,0,−1,0,1,0,1,0,1,0,1,0,1,0,1,0,1,0,1,0,−1,0,−1,0,−1,0,1,0,0,0,0,0,0,0,0,0,0,0}

For 80 MHz transmission, the N-TF sequence with the format of an HELTF2X80, optimized for estimation order P=6, is given by:

N-TF(HELTF2X80,P=6)=sqrt(1024/498)·{0,0,0,0,0,0,0,0,0,0,0,0,1,0,1,0,−1,0,1,0,−1,0,−1,0,−1,0,−1,0,−1,0,−1,0,1,0,1,0,−1,0,−1,0,1,0,−1,0,1,0,1,0,1,0,1,0,−1,0,−1,0,−1,0,1,0,−1,0,1,0,−1,0,1,0,1,0,1,0,−1,0,−1,0,−1,0,1,0,−1,0,−1,0,1,0,1,0,−1,0,1,0,1,0,−1,0,1,0,1,0,−1,0,−1,0,−1,0,1,0,−1,0,−1,0,−1,0,1,0,1,0,−1,0,1,0,1,0,1,0,−1,0,1,0,1,0,1,0,1,0,−1,0,−1,0,1,0,−1,0,1,0,1,0,−1,0,1,0,1,0,−1,0,1,0,−1,0,1,0,−1,0,−1,0,−1,0,1,0,−1,0,1,0,1,0,−1,0,1,0,1,0,1,0,−1,0,−1,0,1,0,1,0,−1,0,1,0,1,0,1,0,−1,0,1,0,1,0,−1,0,−1,0,−1,0,1,0,1,0,−1,0,1,0,1,0,1,0,−1,0,1,0,−1,0,1,0,−1,0,−1,0,1,0,−1,0,1,0,−1,0,−1,0,−1,0,1,0,1,0,1,0,−1,0,1,0,−1,0,1,0,1,0,−1,0,−1,0,1,0,1,0,1,0,−1,0,−1,0,1,0,1,0,−1,0,1,0,−1,0,−1,0,−1,0,−1,0,1,0,1,0,−1,0,1,0,1,0,−1,0,1,0,−1,0,1,0,1,0,1,0,−1,0,1,0,−1,0,1,0,1,0,−1,0,1,0,1,0,1,0,−1,0,−1,0,1,0,−1,0,1,0,1,0,1,0,−1,0,1,0,1,0,1,0,1,0,−1,0,−1,0,1,0,1,0,1,0,−1,0,−1,0,1,0,−1,0,1,0,1,0,1,0,−1,0,1,0,1,0,−1,0,1,0,−1,0,−1,0,1,0,−1,0,1,0,−1,0,1,0,−1,0,1,0,−1,0,1,0,−1,0,1,0,−1,0,−1,0,1,0,−1,0,−1,0,−1,0,1,0,1,0,1,0,−1,0,1,0,1,0,−1,0,1,0,−1,0,1,0,1,0,−1,0,1,0,1,0,−1,0,1,0,1,0,1,0,1,0,−1,0,1,0,1,0,−1,0,−1,0,1,0,−1,0,1,0,1,0,−1,0,1,0,1,0,1,0,−1,0,−1,0,1,0,1,0,1,0,−1,0,1,0,−1,0,0,0,0,0,0,0,−1,0,1,0,−1,0,1,0,−1,0,−1,0,−1,0,−1,0,−1,0,−1,0,1,0,1,0,1,0,−1,0,1,0,1,0,−1,0,−1,0,−1,0,1,0,−1,0,−1,0,1,0,−1,0,1,0,1,0,1,0,1,0,1,0,−1,0,1,0,−1,0,1,0,1,0,1,0,−1,0,1,0,1,0,−1,0,−1,0,−1,0,1,0,1,0,−1,0,1,0,1,0,−1,0,−1,0,−1,0,1,0,−1,0,−1,0,1,0,1,0,−1,0,−1,0,1,0,−1,0,−1,0,1,0,−1,0,1,0,−1,0,1,0,−1,0,−1,0,1,0,1,0,1,0,−1,0,1,0,−1,0,−1,0,−1,0,−1,0,−1,0,1,0,1,0,1,0,−1,0,1,0,−1,0,−1,0,1,0,1,0,1,0,−1,0,−1,0,1,0,−1,0,1,0,−1,0,1,0,−1,0,1,0,−1,0,−1,0,−1,0,−1,0,−1,0,1,0,−1,0,−1,0,1,0,−1,0,1,0,−1,0,−1,0,−1,0,1,0,−1,0,−1,0,−1,0,−1,0,1,0,−1,0,−1,0,1,0,1,0,1,0,1,0,1,0,1,0,−1,0,1,0,−1,0,1,0,−1,0,1,0,−1,0,1,0,−1,0,−1,0,−1,0,1,0,−1,0,1,0,−1,0,1,0,1,0,−1,0,1,0,−1,0,1,0,−1,0,1,0,1,0,1,0,−1,0,−1,0,1,0,−1,0,1,0,−1,0,−1,0,−1,0,−1,0,1,0,1,0,−1,0,−1,0,1,0,−1,0,1,0,1,0,1,0,−1,0,1,0,1,0,1,0,−1,0,−1,0,1,0,−1,0,−1,0,1,0,1,0,−1,0,−1,0,1,0,1,0,−1,0,−1,0,1,0,1,0,−1,0,1,0,−1,0,−1,0,−1,0,−1,0,1,0,−1,0,−1,0,1,0,−1,0,1,0,1,0,−1,0,1,0,−1,0,−1,0,1,0,1,0,−1,0,1,0,−1,0,1,0,1,0,1,0,−1,0,−1,0,1,0,1,0,−1,0,−1,0,−1,0,−1,0,1,0,1,0,1,0,1,0,−1,0,−1,0,−1,0,−1,0,−1,0,1,0,−1,0,−1,0,1,0,−1,0,1,0,1,0,−1,0,−1,0,1,0,−1,0,1,0,−1,0,−1,0,−1,0,1,0,−1,0,−1,0,1,0,1,0,−1,0,1,0,0,0,0,0,0,0,0,0,0,0}

For 80 MHz transmission, the N-TF sequence with the format of an HELTF2X80, optimized for estimation order P=7, is given by:

N-TF(HELTF2X80,P=7)=sqrt(1024/498)·{0,0,0,0,0,0,0,0,0,0,0,0,1,0,1,0,−1,0,−1,0,1,0,1,0,1,0,−1,0,1,0,1,0,1,0,1,0,1,0,1,0,1,0,−1,0,−1,0,1,0,1,0,1,0,−1,0,1,0,−1,0,−1,0,1,0,1,0,1,0,1,0,−1,0,−1,0,−1,0,−1,0,−1,0,−1,0,−1,0,−1,0,−1,0,1,0,1,0,1,0,1,0,1,0,−1,0,−1,0,1,0,1,0,1,0,−1,0,−1,0,−1,0,1,0,1,0,−1,0,1,0,−1,0,1,0,1,0,1,0,1,0,1,0,−1,0,1,0,−1,0,1,0,1,0,−1,0,1,0,−1,0,1,0,−1,0,−1,0,1,0,−1,0,−1,0,−1,0,1,0,1,0,1,0,1,0,−1,0,1,0,−1,0,−1,0,−1,0,−1,0,−1,0,−1,0,−1,0,1,0,1,0,1,0,1,0,−1,0,1,0,1,0,−1,0,1,0,1,0,−1,0,1,0,−1,0,1,0,−1,0,1,0,−1,0,−1,0,1,0,1,0,−1,0,1,0,1,0,1,0,1,0,1,0,1,0,−1,0,1,0,−1,0,−1,0,−1,0,−1,0,−1,0,−1,0,1,0,−1,0,−1,0,1,0,−1,0,1,0,1,0,−1,0,−1,0,1,0,−1,0,1,0,1,0,−1,0,−1,0,−1,0,−1,0,−1,0,−1,0,1,0,1,0,1,0,1,0,1,0,1,0,1,0,−1,0,−1,0,1,0,−1,0,1,0,1,0,1,0,−1,0,−1,0,−1,0,1,0,1,0,1,0,−1,0,−1,0,1,0,1,0,1,0,1,0,−1,0,1,0,−1,0,−1,0,−1,0,−1,0,1,0,−1,0,−1,0,−1,0,−1,0,1,0,1,0,1,0,1,0,1,0,1,0,1,0,1,0,1,0,−1,0,−1,0,−1,0,−1,0,−1,0,−1,0,−1,0,−1,0,1,0,1,0,1,0,1,0,−1,0,1,0,−1,0,1,0,1,0,1,0,−1,0,1,0,1,0,1,0,−1,0,−1,0,1,0,−1,0,1,0,−1,0,1,0,1,0,−1,0,−1,0,−1,0,−1,0,1,0,1,0,1,0,1,0,−1,0,−1,0,−1,0,1,0,1,0,−1,0,−1,0,−1,0,−1,0,1,0,−1,0,−1,0,1,0,1,0,−1,0,−1,0,−1,0,1,0,1,0,−1,0,1,0,1,0,1,0,0,0,0,0,0,0,1,0,−1,0,−1,0,−1,0,1,0,1,0,−1,0,−1,0,1,0,−1,0,1,0,1,0,1,0,1,0,1,0,−1,0,1,0,−1,0,−1,0,−1,0,1,0,1,0,1,0,1,0,−1,0,1,0,−1,0,1,0,1,0,−1,0,1,0,1,0,−1,0,−1,0,1,0,−1,0,1,0,1,0,−1,0,−1,0,1,0,1,0,−1,0,1,0,1,0,−1,0,1,0,1,0,1,0,1,0,1,0,−1,0,−1,0,1,0,−1,0,−1,0,1,0,−1,0,−1,0,−1,0,1,0,1,0,1,0,1,0,1,0,1,0,1,0,1,0,1,0,−1,0,−1,0,1,0,−1,0,1,0,−1,0,1,0,1,0,−1,0,−1,0,−1,0,1,0,1,0,−1,0,−1,0,1,0,−1,0,1,0,−1,0,1,0,1,0,−1,0,−1,0,−1,0,1,0,−1,0,−1,0,1,0,1,0,1,0,1,0,1,0,1,0,1,0,−1,0,−1,0,1,0,1,0,−1,0,−1,0,−1,0,1,0,1,0,1,0,1,0,1,0,1,0,1,0,−1,0,1,0,1,0,1,0,−1,0,−1,0,−1,0,−1,0,1,0,−1,0,−1,0,1,0,1,0,−1,0,1,0,1,0,1,0,1,0,1,0,1,0,1,0,−1,0,1,0,−1,0,−1,0,−1,0,−1,0,1,0,1,0,1,0,−1,0,1,0,1,0,1,0,1,0,−1,0,−1,0,−1,0,1,0,1,0,−1,0,1,0,−1,0,−1,0,−1,0,−1,0,1,0,1,0,1,0,−1,0,1,0,1,0,1,0,1,0,−1,0,−1,0,−1,0,−1,0,−1,0,1,0,1,0,1,0,−1,0,−1,0,1,0,1,0,1,0,1,0,−1,0,−1,0,1,0,−1,0,1,0,1,0,1,0,−1,0,−1,0,1,0,−1,0,−1,0,1,0,−1,0,1,0,1,0,−1,0,−1,0,1,0,1,0,−1,0,−1,0,1,0,1,0,1,0,1,0,−1,0,1,0,1,0,−1,0,−1,0,1,0,−1,0,−1,0,−1,0,−1,0,1,0,1,0,−1,0,−1,0,1,0,1,0,−1,0,1,0,−1,0,1,0,−1,0,−1,0,1,0,1,0,1,0,−1,0,1,0,1,0,1,0,1,0,1,0,−1,0,−1,0,−1,0,−1,0,−1,0,1,0,1,0,0,0,0,0,0,0,0,0,0,0}

For 80 MHz transmission, the N-TF sequence with the format of an HELTF2X80, optimized for estimation order P=8, is given by:

N-TF(HELTF2X80,P=8)=sqrt(1024/498)·{0,0,0,0,0,0,0,0,0,0,0,0,1,0,−1,0,1,0,−1,0,1,0,1,0,1,0,−1,0,−1,0,1,0,1,0,−1,0,1,0,−1,0,1,0,−1,0,1,0,1,0,1,0,1,0,1,0,−1,0,1,0,1,0,−1,0,−1,0,1,0,−1,0,1,0,−1,0,1,0,−1,0,−1,0,1,0,1,0,−1,0,1,0,−1,0,1,0,1,0,1,0,−1,0,−1,0,−1,0,−1,0,−1,0,1,0,1,0,−1,0,−1,0,1,0,−1,0,1,0,1,0,−1,0,−1,0,−1,0,1,0,−1,0,1,0,1,0,1,0,−1,0,−1,0,−1,0,1,0,1,0,1,0,−1,0,−1,0,1,0,1,0,1,0,1,0,−1,0,−1,0,1,0,1,0,1,0,1,0,−1,0,1,0,1,0,−1,0,1,0,−1,0,1,0,−1,0,−1,0,1,0,1,0,−1,0,1,0,−1,0,−1,0,1,0,−1,0,−1,0,1,0,−1,0,1,0,−1,0,1,0,−1,0,1,0,−1,0,−1,0,−1,0,1,0,−1,0,1,0,−1,0,−1,0,−1,0,1,0,1,0,1,0,−1,0,−1,0,1,0,−1,0,1,0,−1,0,−1,0,1,0,−1,0,1,0,−1,0,−1,0,−1,0,−1,0,−1,0,1,0,1,0,1,0,1,0,1,0,−1,0,−1,0,1,0,1,0,−1,0,−1,0,1,0,−1,0,1,0,1,0,1,0,−1,0,−1,0,−1,0,1,0,−1,0,1,0,1,0,1,0,−1,0,−1,0,1,0,−1,0,−1,0,−1,0,1,0,1,0,1,0,−1,0,1,0,−1,0,1,0,−1,0,−1,0,−1,0,1,0,−1,0,1,0,−1,0,1,0,1,0,1,0,−1,0,−1,0,1,0,1,0,−1,0,−1,0,−1,0,1,0,1,0,1,0,−1,0,1,0,−1,0,1,0,1,0,1,0,−1,0,1,0,−1,0,1,0,−1,0,1,0,1,0,1,0,−1,0,−1,0,−1,0,1,0,−1,0,−1,0,−1,0,1,0,−1,0,1,0,−1,0,1,0,−1,0,−1,0,1,0,1,0,−1,0,1,0,−1,0,−1,0,−1,0,1,0,1,0,1,0,−1,0,−1,0,1,0,−1,0,1,0,1,0,1,0,1,0,1,0,1,0,−1,0,−1,0,1,0,−1,0,1,0,−1,0,1,0,1,0,−1,0,1,0,−1,0,−1,0,0,0,0,0,0,0,−1,0,−1,0,1,0,1,0,1,0,−1,0,−1,0,−1,0,1,0,1,0,1,0,−1,0,−1,0,−1,0,−1,0,−1,0,1,0,−1,0,1,0,1,0,1,0,−1,0,1,0,−1,0,1,0,−1,0,−1,0,1,0,1,0,1,0,1,0,−1,0,−1,0,−1,0,−1,0,−1,0,1,0,1,0,−1,0,−1,0,1,0,1,0,1,0,1,0,−1,0,−1,0,1,0,1,0,1,0,−1,0,1,0,1,0,−1,0,−1,0,−1,0,1,0,1,0,−1,0,1,0,−1,0,−1,0,1,0,1,0,−1,0,−1,0,−1,0,1,0,1,0,−1,0,−1,0,1,0,1,0,1,0,−1,0,−1,0,1,0,−1,0,1,0,−1,0,1,0,1,0,−1,0,−1,0,−1,0,1,0,−1,0,1,0,−1,0,1,0,−1,0,1,0,−1,0,−1,0,−1,0,−1,0,−1,0,1,0,1,0,1,0,1,0,−1,0,1,0,−1,0,−1,0,1,0,−1,0,1,0,−1,0,1,0,1,0,−1,0,−1,0,1,0,−1,0,1,0,−1,0,1,0,1,0,1,0,−1,0,1,0,1,0,1,0,−1,0,−1,0,1,0,1,0,1,0,−1,0,−1,0,1,0,−1,0,1,0,1,0,1,0,−1,0,1,0,−1,0,1,0,1,0,−1,0,1,0,−1,0,−1,0,1,0,1,0,−1,0,−1,0,−1,0,1,0,−1,0,1,0,−1,0,−1,0,1,0,−1,0,−1,0,1,0,1,0,−1,0,1,0,1,0,1,0,1,0,−1,0,−1,0,−1,0,−1,0,1,0,−1,0,1,0,1,0,1,0,−1,0,−1,0,−1,0,1,0,1,0,1,0,−1,0,1,0,1,0,1,0,−1,0,−1,0,−1,0,1,0,1,0,−1,0,−1,0,1,0,1,0,1,0,−1,0,1,0,−1,0,1,0,1,0,−1,0,−1,0,1,0,−1,0,1,0,1,0,−1,0,1,0,1,0,1,0,−1,0,−1,0,1,0,1,0,−1,0,1,0,1,0,1,0,1,0,1,0,−1,0,1,0,1,0,−1,0,−1,0,−1,0,1,0,−1,0,1,0,−1,0,−1,0,1,0,−1,0,1,0,−1,0,−1,0,1,0,1,0,−1,0,−1,0,−1,0,1,0,1,0,1,0,−1,0,1,0,−1,0,1,0,−1,0,−1,0,1,0,0,0,0,0,0,0,0,0,0,0}

For 80 MHz transmission, the N-TF sequence with the format of an HELTF2X80, optimized for estimation order P=9, is given by:

N-TF(HELTF2X80,P=9)=sqrt(1024/498)·{0,0,0,0,0,0,0,0,0,0,0,0,1,0,−1,0,−1,0,−1,0,1,0,−1,0,1,0,−1,0,1,0,1,0,1,0,−1,0,1,0,−1,0,1,0,1,0,−1,0,1,0,1,0,1,0,1,0,−1,0,1,0,1,0,1,0,−1,0,−1,0,−1,0,1,0,−1,0,−1,0,1,0,1,0,1,0,−1,0,−1,0,1,0,−1,0,−1,0,1,0,1,0,1,0,−1,0,−1,0,1,0,−1,0,1,0,1,0,−1,0,1,0,−1,0,−1,0,1,0,−1,0,−1,0,−1,0,1,0,1,0,−1,0,−1,0,1,0,−1,0,−1,0,−1,0,−1,0,1,0,1,0,−1,0,−1,0,−1,0,1,0,1,0,−1,0,1,0,−1,0,−1,0,1,0,−1,0,1,0,−1,0,−1,0,−1,0,1,0,−1,0,1,0,−1,0,1,0,−1,0,−1,0,1,0,1,0,−1,0,−1,0,−1,0,1,0,−1,0,1,0,1,0,−1,0,−1,0,1,0,1,0,1,0,1,0,1,0,−1,0,1,0,1,0,1,0,−1,0,1,0,−1,0,−1,0,−1,0,1,0,1,0,1,0,−1,0,−1,0,1,0,1,0,1,0,1,0,1,0,1,0,−1,0,−1,0,−1,0,−1,0,1,0,1,0,−1,0,−1,0,1,0,1,0,−1,0,−1,0,1,0,−1,0,1,0,1,0,1,0,−1,0,1,0,1,0,−1,0,−1,0,−1,0,−1,0,−1,0,−1,0,−1,0,1,0,−1,0,1,0,−1,0,1,0,−1,0,−1,0,1,0,−1,0,1,0,−1,0,1,0,1,0,−1,0,1,0,−1,0,−1,0,1,0,1,0,−1,0,1,0,−1,0,1,0,−1,0,−1,0,1,0,1,0,1,0,1,0,−1,0,1,0,−1,0,−1,0,1,0,1,0,1,0,1,0,−1,0,1,0,−1,0,1,0,−1,0,−1,0,−1,0,1,0,−1,0,1,0,−1,0,−1,0,1,0,−1,0,−1,0,1,0,1,0,1,0,1,0,−1,0,1,0,−1,0,−1,0,1,0,−1,0,−1,0,1,0,−1,0,1,0,1,0,−1,0,−1,0,1,0,1,0,−1,0,−1,0,1,0,1,0,−1,0,−1,0,1,0,1,0,1,0,−1,0,−1,0,−1,0,−1,0,−1,0,−1,0,−1,0,1,0,−1,0,−1,0,1,0,−1,0,−1,0,1,0,1,0,1,0,−1,0,0,0,0,0,0,0,1,0,−1,0,1,0,1,0,1,0,−1,0,−1,0,−1,0,1,0,−1,0,1,0,−1,0,1,0,−1,0,1,0,−1,0,−1,0,−1,0,1,0,1,0,1,0,1,0,−1,0,−1,0,1,0,−1,0,−1,0,1,0,1,0,−1,0,1,0,−1,0,−1,0,−1,0,1,0,1,0,1,0,1,0,−1,0,−1,0,−1,0,1,0,1,0,−1,0,−1,0,−1,0,1,0,−1,0,1,0,−1,0,1,0,1,0,−1,0,−1,0,−1,0,−1,0,1,0,−1,0,−1,0,1,0,−1,0,1,0,−1,0,−1,0,1,0,1,0,1,0,1,0,1,0,1,0,−1,0,1,0,1,0,−1,0,−1,0,1,0,1,0,1,0,−1,0,−1,0,1,0,−1,0,−1,0,1,0,1,0,1,0,1,0,−1,0,1,0,−1,0,1,0,−1,0,1,0,−1,0,−1,0,−1,0,1,0,−1,0,−1,0,−1,0,1,0,−1,0,−1,0,−1,0,1,0,1,0,−1,0,−1,0,1,0,1,0,1,0,−1,0,1,0,−1,0,1,0,−1,0,−1,0,−1,0,1,0,1,0,−1,0,−1,0,−1,0,1,0,1,0,−1,0,1,0,−1,0,1,0,−1,0,−1,0,−1,0,−1,0,1,0,1,0,−1,0,−1,0,−1,0,1,0,1,0,−1,0,1,0,−1,0,1,0,1,0,−1,0,−1,0,1,0,−1,0,1,0,1,0,−1,0,−1,0,−1,0,−1,0,−1,0,−1,0,−1,0,1,0,−1,0,1,0,1,0,−1,0,1,0,−1,0,−1,0,−1,0,1,0,1,0,1,0,1,0,−1,0,−1,0,−1,0,1,0,−1,0,1,0,1,0,−1,0,−1,0,1,0,−1,0,1,0,−1,0,1,0,−1,0,−1,0,−1,0,−1,0,−1,0,1,0,−1,0,1,0,−1,0,1,0,−1,0,1,0,−1,0,−1,0,−1,0,1,0,−1,0,1,0,−1,0,−1,0,1,0,1,0,1,0,−1,0,−1,0,1,0,1,0,−1,0,1,0,1,0,1,0,1,0,−1,0,1,0,1,0,−1,0,1,0,−1,0,−1,0,1,0,1,0,1,0,−1,0,1,0,1,0,1,0,1,0,−1,0,−1,0,1,0,1,0,1,0,−1,0,−1,0,−1,0,1,0,1,0,−1,0,1,0,1,0,1,0,−1,0,−1,0,−1,0,0,0,0,0,0,0,0,0,0,0}

For 80 MHz transmission, the N-TF sequence with the format of an HELTF2X80, optimized for estimation order P=10, is given by:

N-TF(HELTF2X80,P=10)=sqrt(1024/498)·{0,0,0,0,0,0,0,0,0,0,0,0,1,0,−1,0,−1,0,−1,0,−1,0,−1,0,−1,0,−1,0,1,0,1,0,−1,0,−1,0,−1,0,−1,0,−1,0,1,0,1,0,−1,0,−1,0,−1,0,−1,0,−1,0,−1,0,−1,0,1,0,−1,0,−1,0,1,0,−1,0,−1,0,1,0,1,0,−1,0,1,0,1,0,−1,0,−1,0,1,0,−1,0,−1,0,1,0,1,0,−1,0,−1,0,−1,0,1,0,1,0,1,0,1,0,−1,0,−1,0,−1,0,1,0,−1,0,1,0,1,0,−1,0,−1,0,−1,0,−1,0,1,0,−1,0,1,0,1,0,−1,0,−1,0,−1,0,1,0,−1,0,−1,0,−1,0,−1,0,−1,0,−1,0,1,0,1,0,−1,0,1,0,−1,0,−1,0,−1,0,−1,0,1,0,−1,0,−1,0,1,0,−1,0,−1,0,−1,0,−1,0,−1,0,1,0,1,0,−1,0,−1,0,1,0,−1,0,−1,0,−1,0,−1,0,1,0,1,0,−1,0,1,0,1,0,−1,0,−1,0,−1,0,1,0,1,0,−1,0,−1,0,−1,0,1,0,1,0,1,0,−1,0,1,0,−1,0,1,0,1,0,1,0,1,0,−1,0,−1,0,−1,0,1,0,−1,0,1,0,1,0,−1,0,−1,0,1,0,1,0,−1,0,−1,0,−1,0,−1,0,−1,0,−1,0,−1,0,−1,0,−1,0,−1,0,−1,0,1,0,−1,0,1,0,−1,0,1,0,1,0,1,0,−1,0,−1,0,1,0,−1,0,−1,0,1,0,1,0,1,0,1,0,1,0,−1,0,1,0,1,0,−1,0,1,0,−1,0,1,0,1,0,1,0,−1,0,−1,0,−1,0,−1,0,1,0,−1,0,−1,0,−1,0,1,0,1,0,1,0,−1,0,−1,0,1,0,−1,0,−1,0,1,0,1,0,1,0,−1,0,1,0,1,0,−1,0,1,0,1,0,1,0,1,0,−1,0,1,0,1,0,−1,0,−1,0,1,0,−1,0,−1,0,1,0,−1,0,−1,0,−1,0,−1,0,−1,0,1,0,1,0,1,0,−1,0,1,0,1,0,1,0,−1,0,−1,0,1,0,−1,0,−1,0,1,0,1,0,−1,0,1,0,1,0,−1,0,1,0,1,0,1,0,1,0,1,0,1,0,−1,0,−1,0,−1,0,−1,0,−1,0,−1,0,−1,0,−1,0,−1,0,−1,0,1,0,−1,0,−1,0,0,0,0,0,0,0,−1,0,1,0,−1,0,1,0,−1,0,−1,0,1,0,−1,0,−1,0,1,0,1,0,1,0,1,0,1,0,1,0,1,0,1,0,−1,0,−1,0,1,0,−1,0,−1,0,1,0,1,0,−1,0,1,0,−1,0,1,0,−1,0,−1,0,1,0,1,0,−1,0,−1,0,1,0,−1,0,−1,0,−1,0,−1,0,−1,0,−1,0,−1,0,−1,0,−1,0,−1,0,−1,0,−1,0,1,0,1,0,−1,0,1,0,−1,0,−1,0,1,0,−1,0,1,0,1,0,−1,0,−1,0,1,0,1,0,−1,0,−1,0,−1,0,−1,0,−1,0,1,0,1,0,1,0,1,0,−1,0,−1,0,−1,0,−1,0,1,0,−1,0,−1,0,1,0,1,0,−1,0,−1,0,1,0,1,0,1,0,1,0,1,0,−1,0,1,0,1,0,1,0,1,0,−1,0,−1,0,1,0,−1,0,−1,0,−1,0,1,0,1,0,1,0,−1,0,−1,0,1,0,1,0,−1,0,−1,0,−1,0,−1,0,1,0,1,0,1,0,1,0,−1,0,−1,0,−1,0,1,0,−1,0,−1,0,−1,0,−1,0,−1,0,−1,0,1,0,−1,0,−1,0,−1,0,1,0,−1,0,−1,0,−1,0,−1,0,−1,0,−1,0,1,0,1,0,1,0,1,0,−1,0,−1,0,1,0,−1,0,−1,0,−1,0,1,0,1,0,−1,0,−1,0,−1,0,1,0,−1,0,−1,0,1,0,1,0,1,0,1,0,1,0,−1,0,−1,0,−1,0,−1,0,−1,0,1,0,−1,0,−1,0,1,0,−1,0,−1,0,−1,0,−1,0,1,0,−1,0,−1,0,1,0,1,0,−1,0,−1,0,1,0,−1,0,−1,0,−1,0,1,0,1,0,1,0,1,0,−1,0,1,0,−1,0,1,0,−1,0,1,0,−1,0,−1,0,1,0,−1,0,1,0,1,0,−1,0,−1,0,1,0,1,0,−1,0,−1,0,1,0,1,0,−1,0,−1,0,1,0,−1,0,−1,0,1,0,1,0,−1,0,−1,0,1,0,−1,0,−1,0,−1,0,−1,0,1,0,1,0,1,0,−1,0,1,0,1,0,−1,0,−1,0,−1,0,−1,0,−1,0,−1,0,−1,0,−1,0,1,0,−1,0,−1,0,1,0,1,0,−1,0,1,0,1,0,1,0,−1,0,1,0,−1,0,−1,0,−1,0,−1,0,1,0,1,0,0,0,0,0,0,0,0,0,0,0}

### List20

For 80 MHz transmission, the N-TF sequence with the format of an HELTF80, optimized for estimation order P=3, is given by:

N-TF(HELTF80,P=3)=sqrt(1024/996)·{0,0,0,0,0,0,0,0,0,0,0,0,1,1,−1,−1,1,1,−1,−1,−1,1,−1,−1,1,−1,−1,−1,1,1,−1,1,−1,−1,−1,−1,−1,1,−1,1,1,1,1,1,−1,1,−1,−1,−1,1,1,−1,1,−1,1,−1,−1,−1,−1,−1,−1,−1,1,1,−1,1,−1,−1,−1,−1,1,−1,−1,−1,−1,−1,−1,−1,−1,−1,1,1,1,−1,−1,−1,−1,−1,−1,−1,1,1,−1,−1,−1,1,−1,−1,−1,−1,−1,1,1,1,−1,1,1,−1,−1,1,1,−1,−1,−1,1,1,1,−1,1,1,1,1,−1,1,1,−1,1,1,1,−1,1,−1,−1,−1,1,1,1,−1,−1,−1,1,−1,1,−1,1,−1,1,−1,1,−1,−1,−1,1,−1,−1,−1,1,−1,1,1,1,−1,1,1,1,−1,1,1,1,−1,−1,−1,1,−1,−1,−1,1,−1,−1,1,−1,−1,1,−1,−1,−1,−1,1,1,1,−1,−1,1,1,−1,1,1,1,−1,−1,1,−1,−1,1,−1,−1,1,−1,−1,1,1,1,−1,−1,1,−1,−1,−1,−1,1,1,−1,−1,1,−1,−1,1,−1,1,−1,1,−1,1,1,1,−1,−1,−1,−1,−1,1,−1,−1,1,−1,−1,−1,1,−1,1,1,1,1,−1,−1,1,−1,1,1,1,1,1,−1,1,−1,1,−1,−1,−1,−1,1,−1,−1,−1,−1,−1,1,−1,−1,1,1,1,1,1,−1,−1,−1,1,1,1,−1,−1,1,−1,−1,−1,1,−1,−1,−1,−1,−1,1,−1,−1,−1,−1,−1,1,1,1,1,−1,−1,−1,−1,1,1,1,1,1,−1,−1,−1,−1,−1,−1,−1,1,1,−1,−1,−1,1,1,−1,1,1,−1,−1,−1,1,1,1,1,−1,−1,−1,−1,−1,−1,−1,−1,−1,−1,1,1,−1,−1,−1,1,1,−1,1,−1,−1,−1,−1,−1,−1,1,1,−1,1,1,1,1,−1,−1,−1,1,1,−1,−1,−1,−1,−1,−1,−1,1,1,1,−1,−1,1,−1,1,−1,1,1,−1,−1,−1,−1,1,1,−1,1,1,1,−1,1,1,−1,1,−1,−1,−1,−1,1,1,1,−1,1,−1,−1,1,−1,1,1,−1,−1,1,1,−1,−1,1,1,−1,1,1,1,−1,−1,−1,−1,−1,1,−1,1,1,1,1,1,−1,−1,−1,1,−1,1,−1,−1,−1,−1,−1,1,1,1,−1,1,−1,−1,1,−1,−1,−1,−1,1,1,1,−1,−1,1,−1,−1,−1,−1,1,1,1,−1,−1,−1,1,1,1,−1,−1,−1,1,1,1,−1,−1,1,−1,1,−1,−1,−1,0,0,0,0,0,1,−1,1,−1,1,−1,1,−1,1,−1,1,−1,−1,1,1,−1,−1,1,−1,1,−1,−1,−1,1,−1,1,1,−1,1,−1,1,−1,−1,−1,−1,1,1,1,−1,1,−1,1,−1,−1,1,1,1,−1,−1,1,−1,−1,−1,−1,−1,−1,1,−1,1,1,−1,−1,−1,−1,−1,1,1,−1,1,−1,−1,−1,−1,1,1,1,1,1,−1,−1,−1,−1,1,1,1,−1,1,1,−1,−1,1,−1,1,1,1,−1,1,−1,1,−1,−1,−1,−1,1,1,−1,−1,−1,−1,−1,−1,1,1,1,1,−1,−1,−1,−1,−1,−1,−1,1,1,1,−1,−1,−1,−1,1,−1,1,−1,1,1,1,−1,−1,−1,1,−1,−1,−1,1,1,−1,−1,−1,1,−1,1,−1,1,−1,1,−1,1,−1,1,1,−1,1,−1,1,−1,1,−1,−1,−1,1,−1,−1,−1,1,1,−1,−1,−1,1,−1,1,1,1,−1,−1,−1,1,1,−1,1,1,1,1,−1,−1,−1,−1,−1,−1,−1,1,−1,−1,−1,−1,1,−1,1,−1,−1,1,1,1,−1,−1,1,−1,−1,1,1,−1,−1,1,−1,1,1,1,1,−1,−1,−1,−1,−1,1,−1,1,−1,−1,1,1,−1,−1,1,1,1,1,1,1,1,−1,1,1,1,1,−1,−1,−1,1,1,−1,−1,1,−1,−1,1,1,−1,−1,−1,−1,−1,1,1,−1,1,−1,1,−1,1,−1,1,1,1,1,1,1,−1,−1,−1,1,1,−1,−1,1,−1,−1,1,−1,1,−1,1,−1,−1,1,−1,−1,−1,−1,−1,1,1,1,−1,1,1,1,−1,1,1,1,−1,1,−1,1,−1,1,1,−1,−1,−1,−1,1,1,−1,1,1,−1,1,1,1,−1,−1,−1,1,−1,−1,1,−1,1,−1,1,1,1,1,−1,−1,1,−1,−1,−1,−1,−1,−1,−1,1,−1,1,1,1,1,1,−1,1,−1,−1,−1,−1,1,1,−1,−1,−1,−1,−1,−1,1,−1,1,−1,1,−1,1,−1,1,1,1,1,−1,−1,1,−1,1,1,1,−1,1,1,1,−1,1,−1,−1,1,1,−1,−1,−1,1,−1,−1,1,−1,1,−1,−1,−1,1,−1,1,−1,1,1,1,−1,−1,1,−1,1,1,−1,1,1,1,−1,1,1,1,1,1,−1,1,−1,1,−1,−1,1,−1,−1,−1,1,1,−1,−1,−1,−1,1,1,1,−1,1,−1,−1,−1,1,1,−1,−1,−1,−1,−1,1,−1,−1,1,1,−1,1,1,−1,−1,−1,1,1,1,1,−1,1,−1,0,0,0,0,0,0,0,0,0,0,0}

For 80 MHz transmission, the N-TF sequence with the format of an HELTF80, optimized for estimation order P=4, is given by:

N-TF(HELTF80,P=4)=sqrt(1024/996)·{0,0,0,0,0,0,0,0,0,0,0,0,1,1,−1,−1,1,−1,−1,1,1,1,−1,−1,1,−1,1,1,1,−1,1,−1,1,1,−1,−1,1,1,−1,−1,1,1,1,1,1,1,1,−1,1,−1,1,−1,1,1,−1,1,−1,1,−1,−1,−1,−1,−1,−1,−1,1,1,−1,1,−1,−1,−1,−1,−1,1,1,1,1,1,−1,1,1,1,1,1,1,−1,−1,−1,−1,−1,−1,−1,1,−1,1,1,−1,−1,1,−1,1,1,−1,1,1,−1,1,1,−1,−1,−1,1,1,−1,−1,−1,−1,−1,−1,1,−1,1,1,1,1,1,1,1,1,−1,−1,1,−1,−1,1,−1,1,1,−1,−1,−1,−1,1,1,−1,−1,−1,−1,−1,1,1,−1,1,1,1,1,1,1,−1,1,−1,−1,−1,1,−1,1,1,−1,1,−1,1,1,−1,−1,1,1,−1,1,1,1,−1,1,1,1,1,1,−1,−1,−1,−1,1,−1,−1,−1,1,1,−1,1,−1,1,−1,−1,−1,1,1,1,1,1,1,1,1,1,1,−1,−1,−1,−1,1,−1,−1,1,−1,1,−1,1,1,1,1,−1,−1,−1,−1,1,−1,−1,1,1,1,1,1,−1,1,−1,−1,1,1,−1,1,−1,1,−1,−1,−1,1,−1,1,−1,1,−1,1,1,1,1,1,1,1,1,1,1,1,−1,−1,−1,−1,−1,1,−1,1,−1,−1,−1,1,1,−1,−1,1,−1,1,1,−1,1,1,−1,1,1,1,1,−1,1,1,−1,1,−1,−1,1,−1,−1,1,1,1,−1,1,−1,1,1,−1,−1,1,1,−1,1,−1,1,−1,1,1,−1,1,−1,−1,−1,−1,1,1,−1,1,−1,1,1,1,1,−1,1,−1,1,−1,−1,−1,−1,−1,−1,−1,−1,−1,−1,1,−1,−1,−1,−1,1,1,1,1,1,1,−1,1,1,1,−1,1,−1,−1,−1,1,−1,−1,−1,−1,1,−1,1,1,−1,−1,1,1,−1,−1,−1,1,1,−1,−1,1,1,1,1,−1,1,1,−1,−1,1,−1,−1,1,−1,−1,1,1,1,1,1,1,1,1,1,−1,−1,1,1,−1,1,−1,1,−1,1,−1,1,−1,1,1,1,1,−1,1,1,1,1,1,1,−1,−1,−1,1,−1,−1,1,−1,1,1,−1,−1,1,−1,1,1,−1,−1,−1,−1,−1,−1,−1,−1,1,1,1,1,−1,−1,1,1,−1,1,1,−1,−1,1,1,1,1,−1,1,−1,1,1,1,−1,1,−1,−1,−1,1,−1,1,−1,1,1,1,1,−1,−1,−1,−1,1,−1,0,0,0,0,0,1,1,1,−1,1,1,1,1,−1,−1,−1,1,1,1,1,−1,−1,−1,1,1,−1,−1,1,−1,−1,1,1,1,−1,−1,−1,1,−1,1,1,−1,1,−1,−1,1,−1,−1,1,1,−1,−1,−1,1,−1,−1,−1,1,1,1,−1,−1,1,1,1,1,−1,1,1,1,1,−1,1,−1,−1,1,1,−1,1,−1,−1,−1,1,−1,−1,1,1,1,1,1,1,1,−1,−1,−1,1,−1,1,−1,1,−1,−1,−1,1,1,−1,−1,−1,−1,−1,1,−1,−1,−1,−1,1,1,1,−1,1,−1,1,−1,−1,1,1,1,−1,1,−1,1,1,−1,1,−1,1,−1,1,−1,−1,1,−1,1,−1,1,−1,−1,−1,1,1,−1,1,−1,−1,1,−1,−1,1,1,1,−1,−1,1,1,1,−1,−1,1,−1,−1,−1,−1,1,1,−1,−1,1,1,−1,−1,−1,1,−1,1,1,−1,−1,1,−1,1,1,1,1,1,−1,−1,1,1,1,1,1,−1,1,−1,−1,−1,1,−1,−1,−1,1,−1,−1,1,1,−1,−1,−1,−1,−1,1,1,−1,1,1,1,1,1,−1,1,−1,1,−1,−1,−1,−1,−1,−1,−1,1,1,−1,−1,−1,1,1,1,−1,−1,1,1,1,1,−1,1,−1,1,−1,−1,−1,1,−1,1,−1,−1,−1,−1,−1,1,1,−1,−1,1,−1,1,−1,−1,−1,−1,−1,1,−1,1,1,−1,1,−1,1,−1,1,−1,−1,−1,−1,−1,1,1,1,−1,1,−1,1,1,−1,−1,1,−1,1,1,1,−1,1,1,1,−1,−1,1,1,1,1,1,1,1,−1,1,1,−1,1,−1,1,−1,1,−1,−1,−1,1,−1,−1,1,−1,1,1,−1,1,1,−1,1,−1,1,1,−1,−1,−1,1,1,1,1,1,−1,−1,1,1,1,−1,−1,−1,−1,−1,1,−1,1,−1,−1,−1,−1,−1,1,1,1,1,1,−1,1,1,1,1,−1,1,−1,−1,1,−1,−1,−1,1,1,−1,−1,1,−1,−1,1,1,1,−1,−1,−1,1,−1,1,1,−1,1,1,−1,−1,1,−1,1,−1,−1,1,−1,−1,−1,−1,−1,1,−1,−1,−1,−1,−1,−1,1,1,1,−1,−1,1,1,1,1,−1,1,−1,1,−1,−1,−1,1,−1,−1,−1,1,1,−1,1,1,1,1,1,1,−1,−1,1,−1,1,−1,−1,−1,−1,1,−1,−1,1,1,−1,−1,1,1,1,1,1,1,1,1,−1,1,1,1,−1,1,1,1,−1,−1,−1,1,−1,−1,−1,−1,1,0,0,0,0,0,0,0,0,0,0,0}

For 80 MHz transmission, the N-TF sequence with the format of an HELTF80, optimized for estimation order P=5, is given by:

N-TF(HELTF80,P=5)=sqrt(1024/996)·{0,0,0,0,0,0,0,0,0,0,0,0,−1,1,1,−1,−1,1,−1,−1,−1,1,1,1,1,1,1,−1,−1,−1,−1,−1,1,1,1,1,1,1,−1,1,−1,1,−1,1,1,1,−1,1,1,−1,−1,−1,−1,1,−1,1,−1,−1,−1,−1,−1,1,1,−1,1,−1,1,−1,1,−1,−1,1,1,1,−1,1,1,−1,−1,−1,−1,1,−1,1,−1,−1,−1,−1,−1,−1,1,−1,−1,1,1,−1,−1,1,−1,−1,−1,−1,−1,−1,1,−1,−1,−1,1,−1,1,−1,1,−1,1,−1,1,−1,1,−1,1,1,−1,1,−1,1,−1,1,1,1,−1,−1,−1,1,−1,1,1,−1,−1,−1,1,1,−1,1,−1,1,−1,−1,1,1,−1,−1,−1,−1,1,1,−1,−1,1,1,−1,−1,−1,1,1,1,1,1,1,1,1,−1,1,−1,−1,−1,1,1,1,1,1,−1,−1,1,−1,1,1,1,1,−1,−1,−1,−1,−1,−1,1,1,1,−1,1,1,−1,−1,1,1,1,1,−1,−1,1,1,−1,1,−1,−1,1,1,1,−1,1,−1,−1,−1,−1,1,1,−1,−1,1,−1,−1,−1,−1,−1,−1,1,1,1, 1,1,1,1,−1,−1,−1,−1,1,1,−1,−1,−1,1,−1,1,1,−1,−1,1,1,1,−1,1,−1,1,−1,1,−1,−1,1,−1,−1,−1,−1,1,1,1,1,1,−1,1,−1,1,1,−1,1,1,−1,1,1,−1,1,−1,1,−1,−1,−1,1,1,1,−1,1,−1,1,−1,1,1,−1,−1,−1,−1,−1,1,1,1,1,−1,−1,−1,1,−1,1,1,1,−1,1,1,1,−1,1,1,−1,1,1,1,1,−1,−1,−1,−1,−1,−1,1,1,1,1,−1,1,−1,1,1,1,−1,1,1,−1,1,1,−1,1,1,1,−1,−1,−1,−1,1,−1,−1,−1,1,1,−1,1,1,−1,−1,−1,−1,1,1,−1,1,1,−1,1,1,1,−1,−1,−1,−1,−1,1,1,1,−1,1,−1,1,−1,1,−1,−1,−1,1,−1,1,−1,1,1,1,−1,1,−1,−1,1,1,1,−1,−1,−1,−1,−1,1,−1,−1,1,1,−1,−1,−1,1,−1,−1,1,1,1,−1,1,1,−1,1,1,1,1,−1,−1,−1,−1,−1,−1,1,−1,1,1,1,−1,−1,−1,1,1,1,1,−1,1,1,−1,1,−1,−1,−1,1,−1,−1,1,1,−1,1,−1,−1,−1,1,1,1,1,−1,1,1,−1,1,1,−1,−1,1,−1,1,1,−1,−1,−1,−1,−1,−1,1,1,−1,1,−1,−1,−1,0,0,0,0,0,1,1,1,−1,−1,−1,−1,1,1,−1,1,1,1,1,1,−1,1,−1,−1,−1,−1,1,1,1,−1,−1,1,1,1,1,1,1,−1,−1,1,−1,−1,−1,1,1,1,−1,1,−1,1,−1,−1,1,−1,−1,1,−1,−1,1,1,1,−1,1,1,−1,−1,−1,1,1,1,−1,−1,1,1,1,1,1,1,−1,−1,−1,−1,1,1,1,−1,−1,1,1,1,−1,1,1,−1,1,1,−1,−1,−1,−1,1,−1,−1,−1,−1,−1,−1,1,1,1,−1,1,1,−1,1,1,−1,1,1,−1,1,1,−1,−1,−1,−1,1,1,−1,1,1,1,1,1,−1,1,1,−1,−1,−1,−1,−1,−1,1,−1,1,1,−1,1,1,−1,1,−1,−1,−1,−1,1,1,1,1,1,−1,−1,1,−1,−1,1,−1,1,1,1,1,1,−1,−1,−1,1,1,1,−1,1,−1,1,−1,−1,−1,−1,−1,1,−1,1,−1,−1,1,1,1,−1,−1,−1,1,−1,1,1,1,−1,1,1,−1,1,1,−1,−1,−1,1,−1,1,1,1,1,1,−1,−1,1,−1,−1,1,1,1,−1,1,1,1,1,−1,−1,1,1,−1,1,1,−1,1,−1,1,1,1,−1,1,−1,1,−1,1,−1,1,−1,−1,−1,1,1,−1,−1,−1,1,−1,−1,1,1,−1,1,−1,−1,−1,−1,1,1,1,1,1,−1,1,−1,1,−1,−1,1,−1,1,−1,−1,1,1,−1,1,−1,−1,−1,1,−1,−1,1,1,1,1,−1,−1,−1,−1,−1,1,1,1,1,1,1,1,1,−1,1,−1,−1,−1,1,−1,1,1,1,−1,1,−1,−1,−1,1,−1,1,1,1,1,1,−1,−1,1,−1,−1,−1,1,−1,−1,1,−1,1,1,−1,−1,−1,1,−1,1,−1,−1,−1,1,−1,1,−1,−1,1,−1,1,−1,1,−1,1,1,1,−1,1,1,−1,−1,1,−1,1,1,−1,−1,1,1,−1,−1,1,1,−1,1,1,1,−1,1,1,1,−1,−1,−1,−1,−1,−1,1,−1,1,1,−1,1,1,−1,−1,−1,−1,1,−1,1,1,−1,1,−1,1,−1,−1,1,1,1,1,−1,−1,1,1,1,1,1,1,1,−1,−1,−1,−1,−1,1,1,1,−1,1,1,−1,−1,1,1,−1,1,1,−1,−1,−1,−1,−1,−1,−1,1,1,1,1,1,−1,−1,−1,1,−1,−1,1,1,1,1,1,1,1,−1,1,−1,−1,−1,1,−1,−1,1,−1,−1,1,1,1,−1,1,−1,−1,−1,−1,−1,0,0,0,0,0,0,0,0,0,0,0}

For 80 MHz transmission, the N-TF sequence with the format of an HELTF80, optimized for estimation order P=6, is given by:

N-TF(HELTF80,P=6)=sqrt(1024/996)·{0,0,0,0,0,0,0,0,0,0,0,0,−1,1,−1,−1,1,1,1,−1,−1,1,1,1,−1,1,1,1,−1,−1,1,−1,−1,−1,1,−1,−1,1,−1,1,1,1,−1,1,1,−1,1,1,1,−1,−1,1,−1,1,1,−1,−1,1,−1,−1,−1,1,−1,1,−1,−1,−1,−1,−1,−1,−1,−1,−1,−1,−1,−1,1,−1,1,−1,−1,1,1,1,−1,1,1,−1,1,1,1,−1,1,1,−1,1,1,1,1,1,1,1,1,−1,1,1,−1,−1,1,−1,−1,−1,−1,1,−1,1,−1,−1,1,1,−1,−1,−1,1,1,−1,−1,−1,−1,−1,1,1,1,−1,−1,1,1,−1,−1,−1,−1,−1,−1,1,1,−1,−1,1,−1,1,−1,−1,1,−1,−1,1,1,1,−1,1,1,1,−1,−1,1,−1,−1,1,1,1,1,−1,1,1,−1,−1,−1,1,−1,1,−1,−1,−1,−1,1,−1,−1,−1,−1,1,−1,1,−1,−1,−1,1,1,1,1,−1,1,1,1,1,1,1,1,−1,−1,−1,−1,−1,−1,1,−1,1,1,1,1,−1,−1,1,1,−1,1,−1,−1,−1,1,−1,1,1,1,1,1,1,1,1,1,−1,−1,−1,1,1,1,−1,1,−1,−1,−1,1,1,−1,1,−1,−1,−1,−1,−1,−1,1,−1,1,1,1,1,1,1,−1,−1,1,−1,1,1,1,−1,1,1,1,1,1,−1,−1,1,−1,−1,1,−1,−1,1,−1,−1,1,1,−1,−1,−1,1,1,−1,−1,1,−1,1,−1,1,1,−1,−1,1,−1,1,1,1,1,1,1,−1,1,−1,1,1,1,1,−1,1,−1,1,1,1,−1,−1,−1,1,−1,1,1,−1,1,−1,1,1,−1,−1,1,−1,1,−1,1,1,−1,1,1,1,1,1,−1,1,1,1,−1,−1,−1,1,−1,−1,−1,−1,−1,1,1,1,1,−1,−1,−1,1,−1,−1,−1,1,−1,1,1,1,−1,1,1,−1,−1,1,1,1,1,−1,1,1,1,−1,1,1,1,−1,1,−1,−1,−1,1,1,1,1,1,1,−1,1,1,1,1,−1,−1,1,1,1,1,1,−1,−1,1,1,−1,1,−1,1,−1,1,−1,−1,−1,−1,−1,−1,1,−1,−1,1,−1,−1,−1,1,1,−1,1,−1,1,1,1,1,1,1,1,1,1,−1,1,−1,−1,−1,1,1,−1,1,−1,−1,1,1,−1,−1,−1,1,1,−1,−1,−1,1,−1,−1,−1,−1,−1,1,−1,−1,1,1,−1,1,−1,1,−1,1,1,1,1,1,−1,1,1,1,−1,−1,0,0,0,0,0,−1,1,−1,−1,1,1,1,1,−1,1,1,1,1,−1,−1,1,1,1,−1,1,−1,−1,−1,−1,−1,−1,1,−1,−1,−1,−1,−1,1,−1,−1,−1,1,−1,1,1,1,1,1,−1,−1,1,1,−1,−1,1,−1,1,1,1,−1,1,−1,−1,1,1,1,−1,−1,−1,1,−1,−1,1,−1,−1,1,−1,1,1,1,−1,−1,−1,1,−1,1,1,1,1,1,−1,−1,1,1,−1,−1,1,1,1,−1,1,1,1,1,−1,−1,1,−1,−1,1,1,−1,−1,1,−1,1,−1,−1,1,−1,1,−1,1,1,−1,1,1,1,1,1,−1,1,−1,1,−1,1,1,1,1,−1,−1,1,1,−1,1,−1,−1,1,−1,1,1,−1,−1,1,1,−1,−1,−1,−1,1,1,−1,1,−1,−1,−1,1,1,−1,−1,−1,1,−1,1,1,1,−1,1,−1,1,−1,−1,−1,1,1,1,−1,−1,−1,−1,1,1,−1,−1,−1,1,1,1,1,−1,−1,1,1,−1,1,1,−1,1,−1,1,1,1,1,−1,−1,−1,1,1,−1,1,−1,1,1,−1,−1,1,1,−1,1,1,−1,1,1,1,−1,1,−1,−1,1,1,−1,1,1,1,1,−1,−1,−1,1,−1,−1,−1,1,−1,−1,−1,1,1,1,−1,1,−1,−1,−1,1,−1,1,1,−1,1,−1,1,1,−1,1,1,1,1,−1,1,1,−1,−1,1,−1,−1,−1,1,1,−1,−1,−1,−1,1,−1,−1,1,1,−1,−1,−1,1,−1,1,1,−1,1,1,1,−1,1,−1,1,−1,1,1,1,1,−1,1,1,−1,1,1,1,1,1,−1,−1,−1,−1,1,1,−1,−1,1,−1,−1,−1,−1,−1,1,−1,−1,−1,−1,−1,−1,1,1,1,1,1,1,1,1,1,1,1,1,1,1,1,1,1,1,1,−1,−1,−1,−1,−1,−1,−1,1,−1,−1,1,−1,1,1,−1,1,−1,−1,−1,1,1,1,−1,1,−1,1,1,1,1,1,−1,−1,1,−1,1,1,−1,−1,−1,1,−1,1,1,1,−1,1,−1,−1,1,1,1,1,1,−1,1,1,1,−1,1,1,−1,−1,1,−1,−1,1,1,−1,−1,−1,−1,1,−1,−1,1,1,1,−1,−1,1,1,−1,−1,1,1,1,1,1,1,1,−1,−1,1,−1,1,1,1,1,−1,−1,1,1,1,−1,1,−1,−1,−1,−1,−1,1,−1,−1,−1,1,−1,1,1,1,−1,−1,−1,−1,−1,−1,−1,1,1,−1,1,−1,1,1,1,1,1,0,0,0,0,0,0,0,0,0,0,0}

For 80 MHz transmission, the N-TF sequence with the format of an HELTF80, optimized for estimation order P=7, is given by:

N-TF(HELTF80,P=7)=sqrt(1024/996)·{0,0,0,0,0,0,0,0,0,0,0,0,−1,−1,1,−1,−1,−1,1,−1,−1,1,−1,−1,1,−1,−1,1,−1,1,−1,−1,−1,1,1,1,−1,−1,−1,−1,1,1,1,−1,1,1,1,−1,1,−1,1,−1,−1,1,−1,−1,−1,−1,−1,−1,−1,1,1,1,1,−1,1,1,1,1,1,1,−1,1,1,1,−1,1,1,1,−1,1,1,1,−1,−1,−1,−1,1,−1,−1,1,1,1,−1,−1,−1,1,−1,−1,1,−1,−1,1,−1,−1,−1,−1,1,1,1,−1,−1,1,−1,−1,−1,1,−1,−1,1,1,1,−1,1,1,−1,−1,−1,−1,1,−1,−1,1,1,1,1,1,−1,1,1,1,1,−1,−1,1,−1,−1,−1,−1,1,−1,1,−1,1,1,−1,−1,1,1,−1,1,1,−1,−1,−1,−1,1,−1,−1,1,−1,1,−1,−1,−1,−1,1,1,1,1,−1,1,1,1,1,1,1,−1,−1,1,−1,1,1,1,−1,−1,−1,1,1,−1,−1,−1,1,1,−1,1,1,−1,1,−1,−1,−1,−1,−1,−1,1,−1,1,−1,−1,1,1,1,1,−1,−1,−1,−1,−1,−1,−1,−1,−1,1,−1,1,1,1,−1,1,−1,1,1,1,1,1,−1,1,1,1,1,−1,1,1,−1,−1,−1,1,−1,−1,1,−1,−1,−1,−1,−1,−1,−1,−1,1,1,−1,−1,1,−1,−1,−1,1,1,−1,−1,−1,−1,1,−1,1,−1,−1,1,1,−1,−1,1,−1,1,1,−1,1,1,1,−1,−1,1,−1,−1,−1,−1,1,−1,1,1,1,1,−1,−1,1,1,−1,−1,1,1,1,−1,1,1,1,1,−1,−1,−1,−1,1,−1,1,1,1,−1,1,−1,1,1,1,−1,−1,1,−1,−1,1,−1,1,−1,−1,1,1,1,−1,−1,−1,1,−1,−1,−1,1,1,−1,−1,−1,−1,−1,1,1,−1,−1,−1,−1,−1,−1,1,1,−1,−1,−1,−1,1,1,1,1,−1,1,1,−1,1,−1,1,−1,1,1,−1,−1,−1,−1,1,1,1,−1,−1,1,1,1,−1,−1,1,−1,−1,−1,−1,−1,1,−1,1,−1,−1,−1,1,−1,1,−1,−1,−1,−1,−1,−1,−1,1,1,1,1,−1,1,1,−1,−1,−1,1,−1,1,1,−1,1,1,−1,1,−1,−1,−1,−1,−1,1,1,−1,1,−1,1,−1,−1,1,−1,−1,−1,1,1,−1,−1,1,1,1,−1,−1,−1,−1,−1,−1,1,1,1,1,−1,1,1,1,1,−1,−1,1,1,1,−1,1,1,1,−1,−1,−1,−1,−1,1,−1,1,−1,0,0,0,0,0,1,1,−1,1,−1,−1,1,−1,−1,1,−1,1,−1,−1,−1,1,−1,−1,1,−1,1,1,−1,1,1,−1,1,−1,1,1,−1,1,−1,−1,−1,−1,−1,−1,1,1,−1,−1,−1,−1,−1,1,1,−1,1,1,−1,1,1,−1,−1,1,1,1,−1,−1,1,−1,−1,1,−1,−1,−1,−1,−1,−1,1,1,1,1,−1,1,1,−1,1,1,−1,−1,1,1,−1,1,−1,−1,1,1,−1,−1,−1,1,−1,−1,−1,1,1,−1,1,1,−1,−1,−1,−1,1,−1,−1,1,−1,−1,−1,−1,−1,1,−1,−1,−1,1,−1,1,1,−1,−1,−1,1,−1,−1,1,−1,1,1,1,−1,−1,−1,1,1,1,−1,−1,−1,−1,1,1,1,1,1,−1,−1,−1,−1,−1,−1,−1,1,−1,−1,−1,−1,−1,−1,1,1,−1,−1,−1,−1,−1,−1,1,−1,−1,1,1,1,1,−1,−1,1,1,−1,−1,−1,−1,−1,1,1,1,−1,−1,−1,−1,−1,−1,1,1,−1,1,−1,1,−1,1,1,1,1,−1,−1,1,−1,−1,−1,1,−1,1,−1,−1,−1,1,−1,1,−1,−1,1,1,−1,−1,−1,−1,−1,1,−1,−1,−1,−1,1,1,1,−1,−1,−1,−1,−1,−1,1,1,−1,1,−1,−1,1,1,−1,1,1,−1,−1,−1,−1,−1,1,−1,1,−1,1,−1,−1,1,1,−1,1,−1,−1,1,1,−1,−1,−1,−1,−1,1,1,1,−1,1,−1,−1,1,−1,1,−1,1,−1,−1,1,1,1,−1,1,1,−1,1,1,−1,1,1,1,1,−1,1,−1,−1,1,1,−1,1,−1,1,−1,1,−1,−1,1,−1,1,−1,−1,−1,−1,−1,1,−1,−1,−1,−1,1,−1,−1,−1,1,−1,1,−1,1,1,1,−1,−1,−1,1,1,1,−1,1,1,−1,1,1,−1,−1,−1,−1,1,1,−1,−1,1,1,1,−1,−1,1,1,1,1,−1,1,1,1,−1,1,1,−1,−1,−1,1,1,−1,1,−1,1,1,−1,−1,−1,1,1,−1,−1,1,1,1,−1,−1,−1,1,1,−1,1,−1,−1,−1,1,−1,−1,−1,1,1,1,−1,−1,1,−1,−1,−1,1,−1,−1,1,−1,−1,−1,−1,1,−1,−1,−1,1,−1,−1,1,−1,−1,1,−1,1,−1,1,−1,1,−1,1,−1,1,−1,1,1,−1,1,−1,−1,−1,1,1,−1,−1,−1,1,−1,−1,−1,1,−1,1,−1,1,−1,1,−1,1,1,1,−1,1,−1,−1,−1,1,1,1,1,−1,1,−1,1,1,1,0,0,0,0,0,0,0,0,0,0,0}

For 80 MHz transmission, the N-TF sequence with the format of an HELTF80, optimized for estimation order P=8, is given by:

N-TF(HELTF80,P=8)=sqrt(1024/996)·{0,0,0,0,0,0,0,0,0,0,0,0,−1,−1,−1,−1,−1,−1,−1,1,1,1,−1,1,1,−1,1,−1,1,1,1,1,1,1,−1,1,1,1,1,1,−1,1,−1,−1,1,−1,1,1,−1,−1,1,1,1,−1,−1,−1,−1,1,1,−1,1,−1,1,1,−1,1,1,1,1,1,−1,1,1,−1,1,−1,1,1,1,1,−1,1,1,−1,1,−1,1,1,−1,1,−1,−1,−1,−1,−1,1,1,−1,1,1,−1,−1,−1,1,1,1,−1,1,1,−1,1,1,1,1,1,−1,1,−1,1,−1,1,1,1,1,−1,1, 1,1,1,1,1,1,1,−1,−1,1,−1,−1,1,−1,1,1,1,1,1,1,−1,−1,1,1,−1,1,−1,1,−1,1,1,1,1,−1,−1,−1,1,1,−1,1,1,−1,1,−1,−1,1,1,1,1,1,1,1,1,−1,−1,1,−1,−1,1,−1,1,1,−1,1,1,−1,1,−1,1,1,−1,−1,1,1,1,1,−1,−1,−1,1,−1,1,−1,−1,1,1,1,1,1,1,1,−1,1,1,−1,1,−1,−1,1,−1,1,−1,−1,−1,−1,1,1,−1,1,1,−1,1,1,−1,1,1,1,−1,−1,1, 1, 1, 1, 1,1,1,1,−1,1,−1,1,1,−1,1,−1,1,1,1,−1,−1,1,1,−1,1,−1,−1,−1,1,−1,−1,1,−1,1,−1,−1,1,−1,1,−1,−1,1,1,−1,−1,1,−1,1,−1,−1,1,−1,−1,1,1,−1,−1,−1,1,−1,1,1,−1,1,−1,1,1,−1,−1,−1,−1,−1,−1,−1,1,1,−1,1,−1,1,−1,1,−1,−1,1,−1,−1,−1,−1,1,1,−1,1,1,−1,1,1,−1,1,−1,−1,1,1,1,1,1,−1,1,−1,−1,−1,1,1,−1,−1,−1,1,1,1,1,−1,1,−1,−1,−1,1,1,1,−1,1,−1,−1,1,1,1,1,1,1,1,1,1,1,1,−1,1,−1,−1,1,−1,1,1,−1,−1,1,1,1,1,−1,1,−1,1,1,−1,1,1,−1,−1,−1,1,1,1,1,1,−1,−1,1,−1,1,1,1,1,1,1,−1,−1,1,−1,1,−1,1,1,1,1,−1,−1,1,−1,1,1,1,1,1,−1,1,−1,1,1,−1,1,−1,1,−1,1,1,−1,1,1,1,−1,−1,1,−1,1,−1,1,1,−1,1,1,1,1,1,1,1,1,−1,−1,1,1,1,1,−1,1,1,1,−1,1,1,1,−1,1,−1,1,1,1,−1,−1,1,1,1,−1,1,1,1,1,0,0,0,0,0,1,1,1,1,1,1,−1,−1,−1,−1,1,−1,1,1,1,1,1,−1,−1,1,−1,−1,1,−1,1,1,1,−1,1,−1,1,1,1,−1,1,1,1,−1,−1,−1,−1,1,−1,−1,1,−1,1,1,−1,1,1,−1,1,1,1,1,1,1,1,−1,1,1,1,1,−1,1,−1,−1,−1,−1,1,1,1,1,1,1,−1,1,1,−1,−1,−1,1,1,−1,−1,−1,−1,1,1,1,1,−1,1,−1,1,−1,1,1,1,−1,1,−1,1,1,1,−1,1,−1,1,1,−1,−1,1,1,1,−1,−1,−1,1,1,1,1,1,−1,1,−1,−1,−1,−1,−1,−1,−1,−1,1,−1,1,1,−1,−1,1,1,1,−1,1,1,−1,1,−1,1,1,−1,1,−1,−1,1,1,−1,1,−1,−1,1,−1,−1,−1,−1,1,−1,1,−1,1,1,−1,−1,−1,−1,1,−1,1,1,−1,1,1,−1,−1,−1,1,1,1,1,−1,−1,1,1,1,−1,1,1,1,1,1,1,1,1,1,−1,−1,1,1,1,1,−1,1,1,−1,−1,1,−1,1,1,1,−1,1,−1,1,−1,1,−1,1,−1,1,1,−1,1,1,−1,1,1,1,1,1,1,1,−1,−1,1,1,1,−1,1,−1,−1,−1,−1,−1,1,−1,−1,1,−1,1,1,−1,1,1,−1,−1,−1,1,1,1,1,1,1,−1,−1,1,1,1,1,1,1,1,1,1,1,1,−1,−1,1,−1,1,1,1,−1,−1,1,1,1,1,−1,1,−1,1,−1,1,1,1,1,1,1,−1,1,1,1,1,1,1,1,−1,1,1,1,−1,1,1,−1,−1,1,1,1,1,−1,1,−1,−1,1,−1,−1,1,1,1,−1,−1,−1,−1,−1,−1,−1,1,1,1,1,−1,1,1,−1,1,1,−1,−1,1,1,1,1,1,1,1,−1,−1,1,1,1,1,−1,−1,−1,1,−1,−1,−1,−1,1,−1,1,1,−1,1,1,−1,−1,−1,1,1,1,1,−1,1,1,−1,−1,−1,−1,1,1,1,1,1,1,1,1,−1,1,−1,1,−1,−1,−1,1,1,1,−1,1,1,1,−1,−1,1,−1,1,−1,1,−1,−1,−1,−1,1,−1,1,1,−1,1,−1,−1,−1,1,−1,−1,1,1,−1,1,−1,1,1,−1,1,1,−1,1,1,1,−1,1,−1,−1,1,1,−1,1,−1,1,1,−1,−1,−1,1,−1,1,−1,1,1,−1,1,1,−1,1,1,1,−1,−1,1,−1,1,−1,1,1,1,0,0,0,0,0,0,0,0,0,0,0}

For 80 MHz transmission, the N-TF sequence with the format of an HELTF80, optimized for estimation order P=9, is given by:

N-TF(HELTF80,P=9)=sqrt(1024/996)·{0,0,0,0,0,0,0,0,0,0,0,0,−1,−1,−1,1,1,1,−1,1,1,−1,−1,1,−1,1,1,−1,−1,−1,1,1,1,1,−1,−1,1,−1,1,1,−1,1,−1,1,1,1,1,1,−1,1,−1,1,1,1,−1,1,−1,−1,1,1,1,1,−1,1,−1,−1,1,1,1,−1,−1,1,1,−1,−1,−1,−1,−1,−1,−1,−1,1,−1,1,−1,1,1,1,1,1,−1,1,1,−1,−1,1,1,−1,−1,−1,1,1,−1,1,−1,−1,−1,−1,1,1,−1,1,1,1,−1,1,1,1,1,1,−1,1,1,−1,1,−1,1,1,1,−1,1,1,1,1,−1,1,−1,1,−1,1,−1,−1,1,1,1,−1,1,1,1,−1,1,1,−1,1,1,1,−1,1,−1,−1,−1,−1,−1,−1,−1,−1,−1,1,1,1,−1,−1,1,1,−1,1,−1,−1,−1,1,−1,−1,−1,−1,1,1,1,1,1,−1,−1,−1,1,1,−1,−1,1,−1,1,1,1,1,−1,1,1,1,−1,1,1,−1,1,−1,1,1,−1,1,1,1,1,1,1,−1,−1,1,−1,−1,−1,−1,1,−1,−1,1,−1,1,−1,1,−1,−1,1,−1,−1,1,−1,−1,1,1,1,−1,1,−1,−1,−1,−1,−1,1,−1,1,−1,−1,1,−1,1,−1,−1,−1,−1,1,1,1,1,1,1,1,−1,1,−1,1,1,−1,−1,1,1,1,1,1,1,1,1,−1,1,−1,1,−1,−1,1,1,−1,1,1,−1,1,1,−1,−1,1,1,−1,−1,−1,1,−1,1,1,1,−1,1,−1,1,−1,1,1,1,−1,1,−1,1,−1,−1,1,1,−1,−1,1,1,1,1,1,1,−1,1,1,1,−1,1,−1,1,1,−1,1,1,−1,1,−1,1,1,−1,−1,1,1,1,1,1,−1,1,1,−1,1,1,−1,1,−1,−1,−1,1,−1,1,−1,−1,1,1,−1,1,1,−1,1,1,−1,−1,1,1,−1,−1,−1,−1,−1,−1,1,1,−1,−1,−1,−1,−1,−1,−1,1,−1,−1,1,1,1,1,1,−1,1,−1,−1,1,1,1,1,1,1,1,1,1,−1,1,−1,1,−1,−1,1,1,1,−1,1,1,−1,1,1,1,−1,−1,−1,1,1,−1,1,1,1,1,1,−1,−1,1,1,−1,−1,1,1,1,1,−1,−1,1,1,−1,−1,1,1,1,−1,−1,−1,−1,1,−1,1,−1,1,1,−1,−1,−1,1,1,−1,−1,1,−1,1,1,1,1,−1,1,−1,−1,−1,−1,1,−1,−1,1,−1,1,−1,−1,1,0,0,0,0,0,−1,1,1,−1,1,1,1,1,−1,1,1,−1,1,1,−1,−1,−1,−1,1,−1,1,−1,1,1,1,−1,1,1,−1,1,1,1,1,−1,1,1,1,−1,−1,−1,−1,1,1,−1,−1,−1,1,1,1,−1,1,1,−1,−1,−1,1,−1,1,1,−1,1,−1,1,−1,1,−1,1,−1,1,1,−1,−1,1,−1,−1,1,−1,1,1,1,1,−1,1,1,−1,−1,−1,−1,−1,−1,1,1,1,−1,1,1,1,−1,1,−1,1,−1,1,−1,−1,−1,1,1,1,−1,1,1,−1,1,1,−1,−1,−1,1,1,1,1,−1,1,1,−1,1,1,−1,−1,−1,1,1,−1,1,−1,1,−1,−1,−1,−1,1,1,−1,1,−1,1,1,1,1,−1,−1,1,−1,1,1,−1,−1,1,−1,1,1,1,1,−1,−1,−1,−1,1,−1,−1,−1,−1,1,1,−1,−1,−1,1,1,−1,−1,1,−1,1,−1,−1,1,1,−1,−1,1,−1,−1,−1,1,−1,−1,−1,−1,−1,−1,1,−1,1,1,1,1,1,−1,−1,−1,1,1,−1,1,1,1,1,−1,1,−1,−1,1,1,−1,1,1,−1,1,1,−1,1,−1,1,1,−1,−1,1,1,−1,1,−1,−1,−1,−1,1,1,1,−1,1,1,1,−1,−1,−1,1,−1,1,1,1,1,−1,−1,−1,−1,−1,1,−1,−1,−1,1,1,−1,1,−1,1,−1,1,1,1,−1,−1,1,−1,−1,−1,−1,1,−1,−1,−1,1,1,1,−1,1,−1,1,1,1,1,1,1,1,1,−1,1,−1,1,−1,−1,−1,−1,1, 1, 1,1,1,1,−1,1,1,−1,1,1,−1,1,1,1,−1,1,−1,1,1,1,−1,−1,1,−1,1,−1,−1,1,−1,1,−1,1,−1,−1,−1,1,−1,−1,−1,−1,1,1,1,1,1,−1,−1,1,1,−1,−1,−1,1,1,1,1,1,1,1,−1,−1,−1,−1,1,−1,−1,−1,−1,1,1,1,1,1,−1,1,1,1,−1,1,−1,1,1,−1,1,−1,1,1,−1,1,1,1,−1,−1,−1,−1,−1,1,−1,1,1,1,1,−1,1,1,−1,−1,−1,−1,1,−1,1,−1,1,1,−1,1,−1,1,−1,1,1,−1,−1,1,1,1,−1,−1,1,−1,−1,1,1,−1,−1,−1,−1,1,−1,1,1,−1,1,1,1,−1,−1,−1,1,−1,1,−1,−1,1,−1,1,1,−1,1,−1,−1,1,−1,1,−1,1,−1,1,−1,−1,1,1,1,1,1,−1,−1,−1,−1,1,−1,0,0,0,0,0,0,0,0,0,0,0}

For 80 MHz transmission, the N-TF sequence with the format of an HELTF80, optimized for estimation order P=10, is given by:

N-TF(HELTF80,P=10)=sqrt(1024/996)·{0,0,0,0,0,0,0,0,0,0,0,0,−1,1,−1,1,−1,1,−1,−1,−1,1,1,1,1,−1,−1,1,−1,−1,1,1,−1,−1,−1,1,−1,−1,−1,−1,1,1,−1,1,−1,−1,−1,−1,−1,−1,−1,1,1,−1,1,1,−1,1,−1,−1,1,−1,1,−1,1,1,−1,−1,−1,1,−1,1,−1,1,1,−1,−1,1,−1,−1,1,−1,−1,−1,1,−1,−1,−1,−1,1,1,1,1,1,1,1,1,−1,1,−1,−1,−1,−1,−1,−1,−1,−1,−1,1,1,−1,1,−1,1,1,1,−1,−1,1,−1,−1,−1,1,−1,1,1,−1,−1,−1,1,−1,1,1,1,1,−1,−1,−1,−1,1,1,−1,1,1,−1,−1,1,−1,−1,−1,−1,−1,1,1,−1,−1,−1,−1,−1,−1,1,−1,−1,1,1,−1,−1,1,−1,−1,1,1,1,1,1,−1,−1,−1,−1,−1,1,1,−1,−1,1,−1,−1,−1,1,−1,−1,1,−1,1,1,−1,−1,−1,−1,−1,−1,1,1,1,1,1,−1,1,−1,1,−1,−1,1,1,1,−1,−1,−1,−1,−1,−1,1,1,−1,−1,−1,1,−1,−1,−1,1,1,1,−1,1,1,−1,−1,1,−1,1,−1,−1,−1,1,1,−1,1,1,−1,1,1,1,−1,−1,−1,−1,−1,−1,1,−1,−1,1,1,−1,1,−1,−1,1,1,1,1,−1,1,−1,−1,1,1,−1,−1,−1,−1,1,1,1,1,1,1,1,1,−1,−1,1,1,−1,−1,1,−1,−1,−1,−1,−1,1,1,1,−1,1,−1,−1,1,1,1,−1,1,−1,−1,1,−1,1,−1,−1,−1,1,1,−1,−1,1,1,1,1,−1,−1,1,−1,−1,1,−1,1,−1,1,−1,1,1,1,1,−1,−1,−1,1,−1,−1,1,−1,−1,−1,−1,1,−1,1,1,1,1,−1,1,−1,1,−1,1,1,1,1,1,1,−1,−1,1,1,1,1,1,1,1,−1,−1,1,−1,1,−1,1,1,−1,1,1,1,−1,−1,−1,−1,1,−1,−1,1,−1,−1,1,−1,−1,1,−1,−1,1,1,1,1,1,1,1,−1,1,−1,1,−1,−1,1,−1,−1,1,−1,−1,1,1,1,−1,−1,−1,−1,−1,−1,−1,1,−1,−1,1,1,−1,1,1,1,−1,1,1,1,1,−1,−1,−1,−1,1,−1,1,1,1,−1,1,1,1,1,1,−1,−1,1,−1,−1,1,1,−1,−1,1,−1,1,1,1,1,−1,1,−1,−1,1,1,−1,1,1,1,−1,−1,−1,−1,1,1,1,1,−1,−1,−1,1,−1,−1,−1,1,1,0,0,0,0,0,1,−1,−1,1,1,1,1,1,1,−1,−1,−1,−1,−1,1,1,1,1,1,−1,1,−1,1,1,1,−1,1,1,1,−1,−1,1,−1,1,−1,1,1,−1,1,1,−1,1,−1,1,1,1,−1,1,1,1,1,−1,−1,1,−1,−1,1,1,−1,−1,−1,−1,1,1,1,1,−1,1,1,1,−1,1,−1,1,1,1,1,−1,−1,−1,−1,1,1,−1,1,1,1,1,1,1,1,1,1,1,1,1,−1,−1,−1,−1,−1,1,1,1,1,1,1,1,1,1,−1,1,1,−1,−1,1,1,−1,−1,1,1,−1,−1,1,1,1,1,1,1,1,−1,−1,1,1,1,1,−1,1,−1,1,−1,1,−1,1,1,1,−1,1,−1,−1,1,−1,−1,1,−1,−1,1,1,1,−1,−1,−1,−1,1,−1,1,1,1,1,−1,1,1,1,1,−1,−1,−1,1,1,1,1,1,−1,1,−1,1,1,1,−1,−1,1,1,1,1,1,1,−1,−1,1,−1,1,−1,1,1,−1,−1,−1,−1,−1,−1,1,1,1,1,1,−1,1,1,1,−1,1,−1,1,−1,1,1,−1,1,−1,1,−1,1,1,1,1,1,1,−1,−1,−1,−1,1,−1,1,1,1,1,−1,−1,−1,−1,−1,1,1,−1,1,−1,1,−1,1,−1,−1,1,−1,−1,−1,1,−1,−1,1,−1,−1,1,1,−1,1,1,1,1,−1,−1,1,1,1,1,1,1,1,1,−1,1,1,−1,−1,−1,1,−1,1,−1,−1,1,−1,1,−1,1,−1,1,−1,−1,1,−1,1,−1,−1,1,−1,1,−1,1,−1,1,1,1,1,1,−1,−1,−1,−1,−1,−1,1,−1,1,1,1,−1,−1,1,−1,1,−1,1,−1,1,1,−1,−1,−1,−1,1,1,1,−1,1,1,1,−1,−1,1,1,1,1,−1,−1,1,1,−1,1,1,−1,−1,1,−1,−1,−1,−1,1,1,−1,−1,−1,1,−1,1,1,−1,−1,1,1,1,−1,−1,−1,1,1,−1,−1,−1,−1,1,−1,−1,1,−1,1,1,−1,−1,−1,−1,−1,1,−1,−1,1,−1,−1,−1,−1,−1,−1,1,1,1,1,1,1,1,1,1,−1,1,1,−1,−1,1,−1,−1,1,1,1,−1,−1,1,−1,1,−1,−1,−1,1,−1,1,1,1,−1,−1,1,1,−1,1,1,1,1,−1,1,−1,1,−1,1,−1,−1,1,1,−1,−1,−1,1,1,−1,1,1,−1,−1,−1,1,−1,−1,−1,1,1,1,−1,−1,−1,1,−1,−1,0,0,0,0,0,0,0,0,0,0,0}

### List21

For 160 MHz transmission, the N-TF sequence with the format of an HESTF160, optimized for estimation order P=3, is given by:

N-TF(HESTF160,P=3)=sqrt(2048/124)·{0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0}

For 160 MHz transmission, the N-TF sequence with the format of an HESTF160, optimized for estimation order P=4, is given by:

N-TF(HESTF160,P=4)=sqrt(2048/124)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,00,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0}

For 160 MHz transmission, the N-TF sequence with the format of an HESTF160, optimized for estimation order P=5, is given by:

N-TF(HESTF160,P=5)=sqrt(2048/124)·{0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0 ,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0, 0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0 ,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0, 0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0 ,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0}

For 160 MHz transmission, the N-TF sequence with the format of an HESTF160, optimized for estimation order P=6, is given by:

N-TF(HESTF160,P=6)=sqrt(2048/124)·{0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0, 0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0}

For 160 MHz transmission, the N-TF sequence with the format of an HESTF160, optimized for estimation order P=7, is given by:

N-TF(HESTF160,P=7)=sqrt(2048/124)·{0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0}

For 160 MHz transmission, the N-TF sequence with the format of an HESTF160, optimized for estimation order P=8, is given by:

N-TF(HESTF160,P=8)=sqrt(2048/124)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0}

For 160 MHz transmission, the N-TF sequence with the format of an HESTF160, optimized for estimation order P=9, is given by:

N-TF(HESTF160,P=9)=sqrt(2048/124)·{0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0}

For 160 MHz transmission, the N-TF sequence with the format of an HESTF160, optimized for estimation order P=10, is given by:

N-TF(HESTF160,P=10)=sqrt(2048/124)·{0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0, 0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0 ,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0}

### List22

For 160 MHz transmission, the N-TF sequence with the format of an HELTF1X160, optimized for estimation order P=3, is given by:

N-TF(HELTF1X160,P=3)=sqrt(2048/500)·{0,0,0,0,0,0,0,0,0,0,0,0,−1,0,0,0,−1,0,0,0,1,0,0,0,−1,0,0,0,−1,0,0,0,1,0,0,0,−1,0,0,0,1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,−1,0,0,0,−1,0,0,0,1,0,0,0,−1,0,0,0,−1,0,0,0,1,0,0,0,−1,0,0,0,1,0,0,0,−1,0,0,0,1,0,0,0,−1,0,0,0,−1,0,0,0,1,0,0,0,−1,0,0,0,−1,0,0,0,1,0,0,0,−1,0,0,0,1,0,0,0,−1,0,0,0,−1,0,0,0,1,0,0,0,−1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,1,0,0,0,1,0,0,0,1,0,0,0,−1,0,0,0,−1,0,0,0,−1,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,1,0,0,0,1,0,0,0,−1,0,0,0,1,0,0,0,1,0,0,0,−1,0,0,0,1,0,0,0,1,0,0,0,−1,0,0,0,−1,0,0,0,1,0,0,0,1,0,0,0,−1,0,0,0,−1,0,0,0,1,0,0,0,−1,0,0,0,0,0,0,0,−1,0,0,0,−1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,−1,0,0,0,−1,0,0,0,−1,0,0,0,−1,0,0,0,1,0,0,0,1,0,0,0,1,0,0,0,1,0,0,0,1,0,0,0,1,0,0,0,−1,0,0,0,1,0,0,0,−1,0,0,0,−1,0,0,0,−1,0,0,0,1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,−1,0,0,0,−1,0,0,0,1,0,0,0,−1,0,0,0,1,0,0,0,−1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,−1,0,0,0,−1,0,0,0,−1,0,0,0,1,0,0,0,1,0,0,0,1,0,0,0,−1,0,0,0,1,0,0,0,1,0,0,0,−1,0,0,0,−1,0,0,0,1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,1,0,0,0,1,0,0,0,0,0,0,0,0,0,0,0,0,0,0,0,0,0,0,0,0,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,−1,0,0,0,1,0,0,0,−1,0,0,0,−1,0,0,0,1,0,0,0,−1,0,0,0,1,0,0,0,−1,0,0,0,1,0,0,0,1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,−1,0,0,0,1,0,0,0,1,0,0,0,−1,0,0,0,−1,0,0,0,−1,0,0,0,1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,−1,0,0,0,−1,0,0,0,1,0,0,0,−1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,1,0,0,0,−1,0,0,0,−1,0,0,0,1,0,0,0,1,0,0,0,1,0,0,0,−1,0,0,0,1,0,0,0,1,0,0,0,−1,0,0,0,1,0,0,0,−1,0,0,0,−1,0,0,0,1,0,0,0,−1,0,0,0,1,0,0,0,−1,0,0,0,1,0,0,0,1,0,0,0,1,0,0,0,1,0,0,0,−1,0,0,0,−1,0,0,0,1,0,0,0,0,0,0,0,1,0,0,0,1,0,0,0,−1,0,0,0,1,0,0,0,1,0,0,0,1,0,0,0,−1,0,0,0,1,0,0,0,−1,0,0,0,−1,0,0,0,−1,0,0,0,−1,0,0,0,−1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,1,0,0,0,1,0,0,0,1,0,0,0,1,0,0,0,1,0,0,0,1,0,0,0,1,0,0,0,−1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,−1,0,0,0,1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,1,0,0,0,−1,0,0,0,−1,0,0,0,1,0,0,0,−1,0,0,0,−1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,−1,0,0,0,1,0,0,0,0,0,0,0,0,0,0,0}

For 160 MHz transmission, the N-TF sequence with the format of an HELTF1X160, optimized for estimation order P=4, is given by:

N-TF(HELTF1X160,P=4)=sqrt(2048/500)·{0,0,0,0,0,0,0,0,0,0,0,0,−1,0,0,0,−1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,1,0,0,0,1,0,0,0,−1,0,0,0,−1,0,0,0,−1,0,0,0,1,0,0,0,1,0,0,0,−1,0,0,0,−1,0,0,0,−1,0,0,0,1,0,0,0,1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,−1,0,0,0,−1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,1,0,0,0,1,0,0,0,0,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,1,0,0,0,1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,1,0,0,0,1,0,0,0,−1,0,0,0,1,0,0,0,1,0,0,0,−1,0,0,0,−1,0,0,0,−1,0,0,0,1,0,0,0,−1,0,0,0,−1,0,0,0,1,0,0,0,1,0,0,0,−1,0,0,0,1,0,0,0,1,0,0,0,−1,0,0,0,−1,0,0,0,−1,0,0,0,1,0,0,0,−1,0,0,0,−1,0,0,0,1,0,0,0,1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,−1,0,0,0,−1,0,0,0,1,0,0,0,−1,0,0,0,−1,0,0,0,−1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,−1,0,0,0,1,0,0,0,1,0,0,0,1,0,0,0,1,0,0,0,−1,0,0,0,−1,0,0,0,1,0,0,0,−1,0,0,0,−1,0,0,0,−1,0,0,0,−1,0,0,0,1,0,0,0,−1,0,0,0,1,0,0,0,−1,0,0,0,1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,1,0,0,0,1,0,0,0,−1,0,0,0,−1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,0,0,0,0,0,0,0,0,0,0,0,0,0,0,0,0,0,0,0,0,1,0,0,0,1,0,0,0,1,0,0,0,−1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,−1,0,0,0,1,0,0,0,1,0,0,0,−1,0,0,0,−1,0,0,0,1,0,0,0,1,0,0,0,1,0,0,0,−1,0,0,0,−1,0,0,0,1,0,0,0,−1,0,0,0,1,0,0,0,1,0,0,0,−1,0,0,0,−1,0,0,0,−1,0,0,0,1,0,0,0,1,0,0,0,1,0,0,0,−1,0,0,0,1,0,0,0,1,0,0,0,−1,0,0,0,1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,−1,0,0,0,−1,0,0,0,−1,0,0,0,−1,0,0,0,1,0,0,0,−1,0,0,0,−1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,−1,0,0,0,−1,0,0,0,0,0,0,0,−1,0,0,0,1,0,0,0,−1,0,0,0,1,0,0,0,1,0,0,0,1,0,0,0,1,0,0,0,−1,0,0,0,−1,0,0,0,−1,0,0,0,1,0,0,0,1,0,0,0,−1,0,0,0,1,0,0,0,−1,0,0,0,−1,0,0,0,1,0,0,0,−1,0,0,0,1,0,0,0,−1,0,0,0,−1,0,0,0,−1,0,0,0,1,0,0,0,1,0,0,0,1,0,0,0,1,0,0,0,1,0,0,0,1,0,0,0,1,0,0,0,1,0,0,0,1,0,0,0,−1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,−1,0,0,0,−1,0,0,0,1,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,−1,0,0,0,−1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,1,0,0,0,−1,0,0,0,−1,0,0,0,−1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,−1,0,0,0,0,0,0,0,0,0,0,0}

For 160 MHz transmission, the N-TF sequence with the format of an HELTF1X160, optimized for estimation order P=5, is given by:

N-TF(HELTF1X160,P=5)=sqrt(2048/500)·{0,0,0,0,0,0,0,0,0,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,1,0,0,0,−1,0,0,0,1,0,0,0,−1,0,0,0,1,0,0,0,1,0,0,0,−1,0,0,0,−1,0,0,0,1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,−1,0,0,0,1,0,0,0,−1,0,0,0,1,0,0,0,1,0,0,0,1,0,0,0,1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,1,0,0,0,1,0,0,0,−1,0,0,0,−1,0,0,0,1,0,0,0,−1,0,0,0,1,0,0,0,−1,0,0,0,1,0,0,0,−1,0,0,0,1,0,0,0,1,0,0,0,1,0,0,0,1,0,0,0,−1,0,0,0,−1,0,0,0,1,0,0,0,−1,0,0,0,1,0,0,0,1,0,0,0,−1,0,0,0,−1,0,0,0,−1,0,0,0,1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,−1,0,0,0,1,0,0,0,1,0,0,0,−1,0,0,0,−1,0,0,0,−1,0,0,0,−1,0,0,0,1,0,0,0,−1,0,0,0,−1,0,0,0,−1,0,0,0,1,0,0,0,1,0,0,0,−1,0,0,0,0,0,0,0,1,0,0,0,1,0,0,0,−1,0,0,0,1,0,0,0,−1,0,0,0,1,0,0,0,1,0,0,0,−1,0,0,0,1,0,0,0,−1,0,0,0,−1,0,0,0,1,0,0,0,−1,0,0,0,1,0,0,0,−1,0,0,0,−1,0,0,0,−1,0,0,0,1,0,0,0,1,0,0,0,−1,0,0,0,−1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,1,0,0,0,−1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,−1,0,0,0,−1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,−1,0,0,0,1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,0,0,0,0,0,0,0,0,0,0,0,0,0,0,0,0,0,0,0,0,−1,0,0,0,1,0,0,0,−1,0,0,0,−1,0,0,0,1,0,0,0,−1,0,0,0,−1,0,0,0,1,0,0,0,1,0,0,0,−1,0,0,0,1,0,0,0,1,0,0,0,−1,0,0,0,1,0,0,0,−1,0,0,0,1,0,0,0,1,0,0,0,−1,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,1,0,0,0,−1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,−1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,−1,0,0,0,1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,1,0,0,0,1,0,0,0,−1,0,0,0,0,0,0,0,−1,0,0,0,1,0,0,0,−1,0,0,0,−1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,1,0,0,0,−1,0,0,0,1,0,0,0,1,0,0,0,−1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,1,0,0,0,1,0,0,0,1,0,0,0,−1,0,0,0,−1,0,0,0,1,0,0,0,−1,0,0,0,−1,0,0,0,−1,0,0,0,1,0,0,0,1,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,−1,0,0,0,1,0,0,0,1,0,0,0,−1,0,0,0,1,0,0,0,1,0,0,0,−1,0,0,0,−1,0,0,0,1,0,0,0,−1,0,0,0,−1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,1,0,0,0,1,0,0,0,−1,0,0,0,1,0,0,0,−1,0,0,0,1,0,0,0,1,0,0,0,−1,0,0,0,1,0,0,0,−1,0,0,0,−1,0,0,0,1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,0,0,0,0,0,0,0,0}

For 160 MHz transmission, the N-TF sequence with the format of an HELTF1X160, optimized for estimation order P=6, is given by:

N-TF(HELTF1X160,P=6)=sqrt(2048/500)·{0,0,0,0,0,0,0,0,0,0,0,0,−1,0,0,0,1,0,0,0,1,0,0,0,−1,0,0,0,−1,0,0,0,1,0,0,0,−1,0,0,0,−1,0,0,0,1,0,0,0,1,0,0,0,−1,0,0,0,1,0,0,0,−1,0,0,0,1,0,0,0,−1,0,0,0,−1,0,0,0,1,0,0,0,1,0,0,0,−1,0,0,0,−1,0,0,0,1,0,0,0,−1,0,0,0,−1,0,0,0,−1,0,0,0,−1,0,0,0,1,0,0,0,−1,0,0,0,1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,−1,0,0,0,1,0,0,0,1,0,0,0,−1,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,−1,0,0,0,1,0,0,0,1,0,0,0,1,0,0,0,1,0,0,0,1,0,0,0,−1,0,0,0,1,0,0,0,−1,0,0,0,−1,0,0,0,1,0,0,0,−1,0,0,0,1,0,0,0,−1,0,0,0,1,0,0,0,1,0,0,0,1,0,0,0,−1,0,0,0,0,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,−1,0,0,0,−1,0,0,0,1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,1,0,0,0,−1,0,0,0,1,0,0,0,1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,1,0,0,0,1,0,0,0,−1,0,0,0,−1,0,0,0,1,0,0,0,1,0,0,0,−1,0,0,0,−1,0,0,0,1,0,0,0,1,0,0,0,1,0,0,0,−1,0,0,0,−1,0,0,0,1,0,0,0,−1,0,0,0,−1,0,0,0,−1,0,0,0,−1,0,0,0,−1,0,0,0,1,0,0,0,−1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,1,0,0,0,1,0,0,0,−1,0,0,0,1,0,0,0,−1,0,0,0,−1,0,0,0,−1,0,0,0,1,0,0,0,−1,0,0,0,−1,0,0,0,1,0,0,0,1,0,0,0,−1,0,0,0,1,0,0,0,−1,0,0,0,1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,1,0,0,0,−1,0,0,0,1,0,0,0,0,0,0,0,0,0,0,0,0,0,0,0,0,0,0,0,0,0,0,0,1,0,0,0,−1,0,0,0,1,0,0,0,−1,0,0,0,−1,0,0,0,1,0,0,0,−1,0,0,0,−1,0,0,0,1,0,0,0,−1,0,0,0,−1,0,0,0,1,0,0,0,1,0,0,0,−1,0,0,0,−1,0,0,0,−1,0,0,0,−1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,−1,0,0,0,1,0,0,0,−1,0,0,0,1,0,0,0,1,0,0,0,1,0,0,0,1,0,0,0,−1,0,0,0,−1,0,0,0,1,0,0,0,−1,0,0,0,−1,0,0,0,−1,0,0,0,1,0,0,0,−1,0,0,0,1,0,0,0,1,0,0,0,−1,0,0,0,−1,0,0,0,1,0,0,0,−1,0,0,0,−1,0,0,0,−1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,−1,0,0,0,1,0,0,0,−1,0,0,0,−1,0,0,0,−1,0,0,0,1,0,0,0,1,0,0,0,1,0,0,0,−1,0,0,0,−1,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,0,0,0,0,−1,0,0,0,−1,0,0,0,1,0,0,0,−1,0,0,0,1,0,0,0,−1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,1,0,0,0,−1,0,0,0,1,0,0,0,−1,0,0,0,−1,0,0,0,1,0,0,0,−1,0,0,0,−1,0,0,0,1,0,0,0,−1,0,0,0,−1,0,0,0,1,0,0,0,1,0,0,0,1,0,0,0,−1,0,0,0,1,0,0,0,−1,0,0,0,−1,0,0,0,1,0,0,0,−1,0,0,0,−1,0,0,0,−1,0,0,0,−1,0,0,0,−1,0,0,0,1,0,0,0,−1,0,0,0,−1,0,0,0,1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,−1,0,0,0,1,0,0,0,−1,0,0,0,−1,0,0,0,1,0,0,0,−1,0,0,0,−1,0,0,0,−1,0,0,0,1,0,0,0,−1,0,0,0,1,0,0,0,−1,0,0,0,−1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,−1,0,0,0,1,0,0,0,−1,0,0,0,1,0,0,0,−1,0,0,0,−1,0,0,0,1,0,0,0,−1,0,0,0,−1,0,0,0,1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,0,0,0,0,0,0,0,0}

For 160 MHz transmission, the N-TF sequence with the format of an HELTF1X160, optimized for estimation order P=7, is given by:

N-TF(HELTF1X160,P=7)=sqrt(2048/500)·{0,0,0,0,0,0,0,0,0,0,0,0,1,0,0,0,−1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,−1,0,0,0,1,0,0,0,−1,0,0,0,1,0,0,0,−1,0,0,0,−1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,−1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,1,0,0,0,1,0,0,0,1,0,0,0,−1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,−1,0,0,0,1,0,0,0,−1,0,0,0,1,0,0,0,1,0,0,0,1,0,0,0,−1,0,0,0,1,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,1,0,0,0,−1,0,0,0,−1,0,0,0,0,0,0,0,−1,0,0,0,1,0,0,0,1,0,0,0,1,0,0,0,1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,−1,0,0,0,1,0,0,0,1,0,0,0,−1,0,0,0,−1,0,0,0,1,0,0,0,−1,0,0,0,−1,0,0,0,1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,1,0,0,0,−1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,−1,0,0,0,1,0,0,0,−1,0,0,0,−1,0,0,0,−1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,−1,0,0,0,−1,0,0,0,1,0,0,0,1,0,0,0,1,0,0,0,−1,0,0,0,−1,0,0,0,0,0,0,0,0,0,0,0,0,0,0,0,0,0,0,0,0,0,0,0,1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,−1,0,0,0,1,0,0,0,−1,0,0,0,1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,−1,0,0,0,1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,1,0,0,0,1,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,1,0,0,0,1,0,0,0,−1,0,0,0,1,0,0,0,0,0,0,0,1,0,0,0,1,0,0,0,1,0,0,0,1,0,0,0,1,0,0,0,1,0,0,0,−1,0,0,0,1,0,0,0,1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,−1,0,0,0,−1,0,0,0,−1,0,0,0,1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,−1,0,0,0,−1,0,0,0,1,0,0,0,−1,0,0,0,−1,0,0,0,1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,−1,0,0,0,1,0,0,0,0,0,0,0,0,0,0,0}

For 160 MHz transmission, the N-TF sequence with the format of an HELTF1X160, optimized for estimation order P=8, is given by:

N-TF(HELTF1X160,P=8)=sqrt(2048/500) {0,0,0,0,0,0,0,0,0,0,0,0,−1,0,0,0,−1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,−1,0,0,0,−1,0,0,0,−1,0,0,0,1,0,0,0,−1,0,0,0,−1,0,0,0,1,0,0,0,−1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,−1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,−1,0,0,0,−1,0,0,0,1,0,0,0,1,0,0,0,1,0,0,0,1,0,0,0,−1,0,0,0,0,0,0,0,1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,1,0,0,0,−1,0,0,0,1,0,0,0,−1,0,0,0,−1,0,0,0,−1,0,0,0,1,0,0,0,1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,1,0,0,0,−1,0,0,0,−1,0,0,0,−1,0,0,0,−1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,1,0,0,0,0,0,0,0,0,0,0,0,0,0,0,0,0,0,0,0,0,0,0,0,1,0,0,0,1,0,0,0,1,0,0,0,−1,0,0,0,1,0,0,0,1,0,0,0,−1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,1,0,0,0,−1,0,0,0,−1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,1,0,0,0,−1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,−1,0,0,0,1,0,0,0,−1,0,0,0,−1,0,0,0,1,0,0,0,−1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,−1,0,0,0,1,0,0,0,−1,0,0,0,−1,0,0,0,1,0,0,0,−1,0,0,0,−1,0,0,0,−1,0,0,0,−1,0,0,0,1,0,0,0,1,0,0,0,−1,0,0,0,1,0,0,0,1,0,0,0,−1,0,0,0,1,0,0,0,1,0,0,0,1,0,0,0,−1,0,0,0,1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,0,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,1,0,0,0,−1,0,0,0,−1,0,0,0,1,0,0,0,1,0,0,0,1,0,0,0,1,0,0,0,−1,0,0,0,1,0,0,0,−1,0,0,0,−1,0,0,0,−1,0,0,0,1,0,0,0,−1,0,0,0,−1,0,0,0,1,0,0,0,−1,0,0,0,1,0,0,0,1,0,0,0,−1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,0,0,0,0,0,0,0,0}

For 160 MHz transmission, the N-TF sequence with the format of an HELTF1X160, optimized for estimation order P=9, is given by:

N-TF(HELTF1X160,P=9)=sqrt(2048/500) {0,0,0,0,0,0,0,0,0,0,0,0,1,0,0,0,−1,0,0,0,−1,0,0,0,−1,0,0,0,1,0,0,0,1,0,0,0,1,0,0,0,1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,1,0,0,0,−1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,1,0,0,0,−1,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,1,0,0,0,1,0,0,0,1,0,0,0,−1,0,0,0,−1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,−1,0,0,0,−1,0,0,0,−1,0,0,0,0,0,0,0,1,0,0,0,1,0,0,0,1,0,0,0,1,0,0,0,1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,−1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,−1,0,0,0,−1,0,0,0,1,0,0,0,1,0,0,0,1,0,0,0,−1,0,0,0,1,0,0,0,1,0,0,0,1,0,0,0,−1,0,0,0,1,0,0,0,−1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,−1,0,0,0,−1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,−1,0,0,0,0,0,0,0,0,0,0,0,0,0,0,0,0,0,0,0,0,0,0,0,−1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,−1,0,0,0,−1,0,0,0,1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,1,0,0,0,1,0,0,0,−1,0,0,0,−1,0,0,0,1,0,0,0,1,0,0,0,−1,0,0,0,−1,0,0,0,−1,0,0,0,−1,0,0,0,−1,0,0,0,−1,0,0,0,1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,1,0,0,0,1,0,0,0,0,0,0,0,−1,0,0,0,1,0,0,0,1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,1,0,0,0,−1,0,0,0,−1,0,0,0,−1,0,0,0,−1,0,0,0,−1,0,0,0,1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,−1,0,0,0,−1,0,0,0,−1,0,0,0,1,0,0,0,−1,0,0,0,1,0,0,0,1,0,0,0,−1,0,0,0,−1,0,0,0,1,0,0,0,1,0,0,0,1,0,0,0,−1,0,0,0,−1,0,0,0,1,0,0,0,−1,0,0,0,−1,0,0,0,1,0,0,0,−1,0,0,0,−1,0,0,0,−1,0,0,0,1,0,0,0,−1,0,0,0,1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,1,0,0,0,0,0,0,0,0,0,0,0}

For 160 MHz transmission, the N-TF sequence with the format of an HELTF1X160, optimized for estimation order P=10, is given by:

N-TF(HELTF1X160,P=10)=sqrt(2048/500)·{0,0,0,0,0,0,0,0,0,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,−1,0,0,0,1,0,0,0,−1,0,0,0,−1,0,0,0,1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,1,0,0,0,0,0,0,0,−1,0,0,0,1,0,0,0,1,0,0,0,1,0,0,0,−1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,−1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,−1,0,0,0,1,0,0,0,−1,0,0,0,1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,1,0,0,0,−1,0,0,0,−1,0,0,0,1,0,0,0,−1,0,0,0,1,0,0,0,1,0,0,0,1,0,0,0,−1,0,0,0,−1,0,0,0,1,0,0,0,−1,0,0,0,−1,0,0,0,1,0,0,0,1,0,0,0,−1,0,0,0,−1,0,0,0,1,0,0,0,−1,0,0,0,1,0,0,0,−1,0,0,0,−1,0,0,0,−1,0,0,0,−1,0,0,0,1,0,0,0,−1,0,0,0,−1,0,0,0,−1,0,0,0,1,0,0,0,1,0,0,0,1,0,0,0,1,0,0,0,0,0,0,0,0,0,0,0,0,0,0,0,0,0,0,0,0,0,0,0,1,0,0,0,−1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,−1,0,0,0,1,0,0,0,−1,0,0,0,1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,−1,0,0,0,1,0,0,0,1,0,0,0,−1,0,0,0,−1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,−1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,−1,0,0,0,−1,0,0,0,0,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,1,0,0,0,1,0,0,0,−1,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,−1,0,0,0,−1,0,0,0,−1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,−1,0,0,0,0,0,0,0,0,0,0,0}

### List23

For 160 MHz transmission, the N-TF sequence with the format of an HELTF2X160, optimized for estimation order P=3, is given by:

N-TF(HELTF2X160,P=3)=sqrt(2048/996)·{0,0,0,0,0,0,0,0,0,0,0,0,−1,0,1,0,−1,0,1,0,−1,0,−1,0,1,0,−1,0,1,0,−1,0,−1,0,1,0,−1,0,1,0,−1,0,−1,0,1,0,1,0,−1,0,1,0,−1,0,1,0,1,0,−1,0,−1,0,1,0,−1,0,−1,0,1,0,−1,0,−1,0,1,0,−1,0,−1,0,1,0,1,0,1,0,−1,0,−1,0,1,0,1,0,1,0,−1,0,−1,0,1,0,1,0,1,0,−1,0,1,0,1,0,−1,0,−1,0,1,0,1,0,1,0,1,0,1,0,1,0,−1,0,−1,0,1,0,1,0,1,0,1,0,1,0,−1,0,1,0,−1,0,−1,0,1,0,1,0,1,0,1,0,1,0,−1,0,−1,0,−1,0,−1,0,1,0,1,0,1,0,1,0,1,0,1,0,1,0,−1,0,−1,0,1,0,1,0,−1,0,−1,0,1,0,1,0,1,0,−1,0,1,0,−1,0,1,0,−1,0,1,0,1,0,−1,0,1,0,−1,0,1,0,−1,0,−1,0,1,0,1,0,−1,0,1,0,−1,0,−1,0,−1,0,−1,0,−1,0,−1,0,1,0,1,0,1,0,−1,0,−1,0,1,0,1,0,−1,0,1,0,1,0,1,0,−1,0,1,0,−1,0,−1,0,1,0,1,0,−1,0,−1,0,−1,0,−1,0,−1,0,1,0,1,0,1,0,−1,0,1,0,1,0,1,0,1,0,1,0,−1,0,1,0,−1,0,1,0,−1,0,−1,0,1,0,−1,0,1,0,−1,0,1,0,1,0,1,0,1,0,1,0,−1,0,−1,0,1,0,1,0,−1,0,−1,0,1,0,1,0,1,0,−1,0,1,0,1,0,1,0,−1,0,−1,0,1,0,1,0,−1,0,−1,0,1,0,1,0,−1,0,1,0,−1,0,1,0,1,0,1,0,−1,0,1,0,1,0,1,0,−1,0,−1,0,1,0,1,0,1,0,−1,0,1,0,1,0,−1,0,−1,0,1,0,−1,0,−1,0,1,0,1,0,−1,0,1,0,−1,0,−1,0,1,0,−1,0,1,0,−1,0,1,0,−1,0,1,0,−1,0,−1,0,−1,0,1,0,1,0,1,0,−1,0,1,0,1,0,−1,0,1,0,1,0,1,0,1,0,−1,0,1,0,1,0,1,0,−1,0,1,0,1,0,1,0,1,0,−1,0,1,0,1,0,1,0,−1,0,1,0,0,0,0,0,0,0,−1,0,−1,0,−1,0,1,0,1,0,1,0,−1,0,−1,0,−1,0,1,0,−1,0,1,0,1,0,1,0,1,0,1,0,−1,0,−1,0,1,0,1,0,−1,0,−1,0,−1,0,−1,0,−1,0,1,0,1,0,−1,0,1,0,1,0,1,0,−1,0,−1,0,−1,0,−1,0,1,0,−1,0,−1,0,1,0,1,0,1,0,−1,0,1,0,−1,0,−1,0,−1,0,1,0,1,0,1,0,−1,0,−1,0,−1,0,1,0,−1,0,1,0,−1,0,1,0,1,0,1,0,−1,0,−1,0,1,0,1,0,1,0,1,0,−1,0,1,0,1,0,1,0,−1,0,−1,0,−1,0,1,0,−1,0,1,0,−1,0,1,0,1,0,−1,0,1,0,−1,0,1,0,1,0,1,0,−1,0,1,0,−1,0,−1,0,−1,0,−1,0,−1,0,1,0,1,0,−1,0,1,0,1,0,−1,0,−1,0,−1,0,−1,0,1,0,1,0,−1,0,−1,0,−1,0,−1,0,−1,0,−1,0,1,0,1,0,1,0,1,0,−1,0,−1,0,1,0,1,0,1,0,1,0,1,0,1,0,1,0,1,0,−1,0,1,0,−1,0,−1,0,1,0,−1,0,1,0,1,0,1,0,1,0,−1,0,−1,0,1,0,1,0,1,0,−1,0,1,0,−1,0,−1,0,−1,0,1,0,−1,0,1,0,−1,0,−1,0,1,0,1,0,−1,0,1,0,1,0,−1,0,1,0,−1,0,1,0,1,0,1,0,1,0,−1,0,1,0,−1,0,−1,0,1,0,1,0,1,0,1,0,1,0,−1,0,1,0,−1,0,−1,0,−1,0,1,0,1,0,1,0,−1,0,1,0,−1,0,−1,0,−1,0,−1,0,1,0,1,0,−1,0,1,0,−1,0,−1,0,1,0,1,0,1,0,−1,0,1,0,−1,0,−1,0,1,0,−1,0,−1,0,−1,0,1,0,1,0,1,0,−1,0,−1,0,1,0,−1,0,−1,0,1,0,1,0,1,0,1,0,−1,0,−1,0,−1,0,1,0,−1,0,−1,0,1,0,1,0,1,0,1,0,1,0,−1,0,−1,0,−1,0,−1,0,−1,0,1,0,−1,0,−1,0,−1,0,−1,0,1,0,−1,0,−1,0,−1,0,1,0,1,0,1,0,1,0,−1,0,−1,0,1,0,1,0,1,0,1,0,1,0,1,0,−1,0,0,0,0,0,0,0,0,0,0,0,0,0,0,0,0,0,0,0,0,0,0,0,−1,0,−1,0,1,0,1,0,1,0,−1,0,−1,0,−1,0,1,0,1,0,−1,0,1,0,1,0,1,0,1,0,1,0,1,0,−1,0,−1,0,−1,0,−1,0,−1,0,1,0,1,0,1,0,−1,0,1,0,1,0,1,0,1,0,1,0,−1,0,1,0,1,0,−1,0,−1,0,1,0,−1,0,1,0,1,0,1,0,−1,0,−1,0,1,0,−1,0,1,0,1,0,1,0,−1,0,1,0,1,0,−1,0,1,0,1,0,−1,0,−1,0,−1,0,1,0,1,0,1,0,1,0,1,0,1,0,1,0,−1,0,1,0,1,0,1,0,−1,0,−1,0,1,0,1,0,1,0,−1,0,1,0,1,0,1,0,1,0,−1,0,−1,0,1,0,1,0,1,0,−1,0,−1,0,−1,0,−1,0,1,0,−1,0,−1,0,1,0,−1,0,1,0,1,0,1,0,−1,0,1,0,1,0,1,0,−1,0,−1,0,1,0,−1,0,−1,0,−1,0,1,0,−1,0,−1,0,−1,0,1,0,−1,0,−1,0,1,0,1,0,1,0,1,0,−1,0,−1,0,1,0,1,0,−1,0,−1,0,1,0,−1,0,1,0,1,0,−1,0,−1,0,−1,0,1,0,1,0,−1,0,1,0,1,0,1,0,−1,0,1,0,−1,0,−1,0,−1,0,1,0,−1,0,−1,0,−1,0,1,0,−1,0,−1,0,−1,0,1,0,1,0,1,0,−1,0,−1,0,1,0,−1,0,−1,0,1,0,1,0,−1,0,1,0,1,0,1,0,1,0,−1,0,1,0,1,0,1,0,1,0,1,0,1,0,1,0,1,0,−1,0,−1,0,1,0,−1,0,−1,0,1,0,1,0,−1,0,1,0,1,0,−1,0,1,0,−1,0,−1,0,1,0,1,0,−1,0,−1,0,1,0,−1,0,−1,0,−1,0,−1,0,1,0,−1,0,1,0,−1,0,1,0,1,0,−1,0,1,0,1,0,−1,0,−1,0,1,0,−1,0,−1,0,−1,0,−1,0,1,0,−1,0,−1,0,−1,0,1,0,−1,0,1,0,1,0,1,0,1,0,1,0,−1,0,1,0,−1,0,−1,0,−1,0,1,0,1,0,1,0,1,0,−1,0,−1,0,−1,0,−1,0,−1,0,−1,0,1,0,−1,0,1,0,1,0,−1,0,−1,0,−1,0,1,0,1,0,−1,0,−1,0,1,0,0,0,0,0,0,0,1,0,1,0,−1,0,−1,0,−1,0,−1,0,1,0,1,0,1,0,1,0,−1,0,−1,0,−1,0,1,0,1,0,1,0,1,0,−1,0,1,0,−1,0,1,0,1,0,1,0,−1,0,−1,0,1,0,1,0,1,0,−1,0,−1,0,1,0,1,0,1,0,1,0,1,0,1,0,−1,0,−1,0,1,0,1,0,−1,0,1,0,−1,0,1,0,1,0,−1,0,−1,0,−1,0,1,0,1,0,1,0,1,0,1,0,−1,0,−1,0,−1,0,1,0,1,0,1,0,1,0,1,0,−1,0,−1,0,−1,0,−1,0,1,0,−1,0,1,0,1,0,1,0,−1,0,1,0,−1,0,1,0,1,0,1,0,−1,0,−1,0,−1,0,1,0,1,0,−1,0,−1,0,−1,0,−1,0,−1,0,−1,0,1,0,1,0,1,0,−1,0,1,0,1,0,1,0,1,0,1,0,1,0,1,0,−1,0,−1,0,−1,0,−1,0,1,0,−1,0,1,0,1,0,1,0,−1,0,−1,0,−1,0,1,0,1,0,−1,0,−1,0,1,0,1,0,−1,0,−1,0,1,0,−1,0,−1,0,1,0,−1,0,1,0,1,0,1,0,1,0,1,0,−1,0,−1,0,−1,0,−1,0,−1,0,−1,0,1,0,1,0,−1,0,1,0,−1,0,−1,0,−1,0,1,0,1,0,1,0,−1,0,−1,0,−1,0,1,0,−1,0,1,0,1,0,−1,0,−1,0,−1,0,−1,0,1,0,1,0,−1,0,−1,0,−1,0,1,0,1,0,−1,0,−1,0,−1,0,1,0,−1,0,−1,0,1,0,1,0,1,0,−1,0,−1,0,1,0,−1,0,−1,0,−1,0,−1,0,−1,0,1,0,1,0,−1,0,−1,0,−1,0,−1,0,−1,0,1,0,1,0,1,0,−1,0,−1,0,1,0,1,0,1,0,1,0,−1,0,−1,0,−1,0,−1,0,1,0,1,0,−1,0,−1,0,−1,0,1,0,1,0,−1,0,−1,0,−1,0,1,0,1,0,−1,0,−1,0,−1,0,−1,0,1,0,−1,0,−1,0,1,0,1,0,1,0,1,0,1,0,1,0,1,0,−1,0,1,0,−1,0,−1,0,−1,0,1,0,1,0,−1,0,1,0,1,0,1,0,−1,0,−1,0,−1,0,−1,0,1,0,1,0,1,0,1,0,−1,0,−1,0,−1,0,−1,0,1,0,0,0,0,0,0,0,0,0,0,0}

For 160 MHz transmission, the N-TF sequence with the format of an HELTF2X160, optimized for estimation order P=4, is given by:

N-TF(HELTF2X160,P=4)=sqrt(2048/996)·{0,0,0,0,0,0,0,0,0,0,0,0,1,0,1,0,1,0,1,0,1,0,1,0,1,0,1,0,−1,0,−1,0,1,0,1,0,1,0,−1,0,−1,0,−1,0,1,0,1,0,1,0,−1,0,−1,0,1,0,1,0,1,0,1,0,−1,0,−1,0,−1,0,1,0,−1,0,−1,0,−1,0,1,0,1,0,−1,0,1,0,1,0,−1,0,−1,0,−1,0,1,0,1,0,−1,0,1,0,−1,0,−1,0,−1,0,−1,0,−1,0,1,0,−1,0,−1,0,−1,0,−1,0,−1,0,1,0,−1,0,−1,0,1,0,−1,0,−1,0,1,0,−1,0,1,0,1,0,−1,0,−1,0,−1,0,1,0,1,0,1,0,1,0,−1,0,−1,0,1,0,1,0,1,0,−1,0,−1,0,−1,0,−1,0,1,0,−1,0,−1,0,1,0,−1,0,1,0,−1,0,1,0,−1,0,1,0,1,0,1,0,1,0,−1,0,−1,0,−1,0,1,0,−1,0,1,0,1,0,−1,0,−1,0,−1,0,−1,0,1,0,1,0,1,0,1,0,−1,0,1,0,−1,0,1,0,−1,0,1,0,−1,0,1,0,1,0,1,0,1,0,1,0,−1,0,−1,0,1,0,−1,0,−1,0,−1,0,−1,0,−1,0,1,0,1,0,1,0,−1,0,−1,0,−1,0,−1,0,1,0,−1,0,−1,0,−1,0,1,0,−1,0,1,0,1,0,1,0,−1,0,−1,0,1,0,1,0,−1,0,1,0,1,0,−1,0,1,0,1,0,1,0,1,0,−1,0,1,0,1,0,1,0,1,0,−1,0,−1,0,−1,0,−1,0,1,0,−1,0,−1,0,1,0,−1,0,1,0,1,0,−1,0,−1,0,−1,0,1,0,1,0,−1,0,−1,0,−1,0,1,0,−1,0,1,0,1,0,1,0,−1,0,1,0,1,0,−1,0,1,0,1,0,−1,0,−1,0,1,0,1,0,1,0,1,0,1,0,1,0,1,0,−1,0,−1,0,1,0,−1,0,−1,0,1,0,1,0,−1,0,1,0,−1,0,1,0,1,0,1,0,1,0,1,0,−1,0,−1,0,−1,0,−1,0,1,0,−1,0,−1,0,1,0,−1,0,−1,0,−1,0,−1,0,−1,0,−1,0,1,0,1,0,−1,0,1,0,1,0,1,0,1,0,1,0,−1,0,−1,0,−1,0,1,0,−1,0,−1,0,1,0,1,0,1,0,1,0,1,0,0,0,0,0,0,0,1,0,−1,0,1,0,1,0,−1,0,1,0,−1,0,−1,0,−1,0,−1,0,−1,0,−1,0,1,0,1,0,1,0,1,0,1,0,−1,0,−1,0,1,0,1,0,1,0,1,0,−1,0,1,0,−1,0,1,0,1,0,−1,0,1,0,1,0,1,0,1,0,−1,0,−1,0,1,0,1,0,−1,0,1,0,1,0,−1,0,−1,0,−1,0,1,0,1,0,−1,0,1,0,1,0,1,0,−1,0,1,0,−1,0,−1,0,1,0,−1,0,−1,0,−1,0,−1,0,−1,0,−1,0,−1,0,−1,0,1,0,−1,0,1,0,−1,0,1,0,1,0,1,0,1,0,1,0,−1,0,−1,0,−1,0,−1,0,1,0,1,0,−1,0,−1,0,1,0,1,0,1,0,−1,0,−1,0,−1,0,−1,0,1,0,1,0,−1,0,1,0,−1,0,1,0,1,0,1,0,−1,0,1,0,−1,0,1,0,1,0,−1,0,−1,0,1,0,−1,0,−1,0,1,0,−1,0,1,0,1,0,−1,0,1,0,1,0,−1,0,1,0,−1,0,−1,0,−1,0,−1,0,1,0,1,0,1,0,1,0,1,0,1,0,1,0,−1,0,1,0,1,0,−1,0,−1,0,−1,0,−1,0,1,0,−1,0,−1,0,1,0,−1,0,−1,0,−1,0,−1,0,1,0,−1,0,1,0,1,0,1,0,−1,0,1,0,1,0,1,0,−1,0,1,0,1,0,1,0,1,0,−1,0,1,0,1,0,−1,0,−1,0,1,0,−1,0,−1,0,−1,0,−1,0,1,0,−1,0,1,0,1,0,1,0,1,0,−1,0,1,0,1,0,1,0,−1,0,−1,0,−1,0,1,0,1,0,−1,0,1,0,1,0,1,0,1,0,−1,0,−1,0,−1,0,1,0,1,0,1,0,−1,0,1,0,1,0,1,0,1,0,1,0,1,0,−1,0,1,0,−1,0,−1,0,1,0,1,0,1,0,−1,0,−1,0,1,0,−1,0,−1,0,−1,0,−1,0,−1,0,1,0,1,0,−1,0,1,0,−1,0,1,0,−1,0,1,0,1,0,−1,0,−1,0,1,0,1,0,−1,0,1,0,1,0,1,0,1,0,−1,0,1,0,−1,0,−1,0,−1,0,1,0,−1,0,1,0,−1,0,1,0,1,0,−1,0,1,0,1,0,1,0,1,0,1,0,1,0,1,0,1,0,0,0,0,0,0,0,0,0,0,0,0,0,0,0,0,0,0,0,0,0,0,0,−1,0,−1,0,−1,0,1,0,1,0,1,0,−1,0,1,0,−1,0,−1,0,1,0,−1,0,1,0,−1,0,−1,0,1,0,1,0,1,0,1,0,−1,0,−1,0,−1,0,−1,0,1,0,−1,0,−1,0,1,0,−1,0,1,0,1,0,1,0,−1,0,−1,0,−1,0,1,0,1,0,1,0,1,0,1,0,1,0,1,0,1,0,1,0,−1,0,1,0,1,0,−1,0,−1,0,−1,0,−1,0,−1,0,−1,0,−1,0,1,0,−1,0,1,0,−1,0,1,0,−1,0,1,0,1,0,−1,0,1,0,1,0,−1,0,1,0,−1,0,−1,0,1,0,1,0,−1,0,1,0,−1,0,1,0,1,0,−1,0,−1,0,−1,0,−1,0,−1,0,1,0,−1,0,−1,0,1,0,−1,0,−1,0,1,0,−1,0,1,0,1,0,1,0,−1,0,−1,0,1,0,1,0,1,0,−1,0,−1,0,−1,0,1,0,1,0,1,0,−1,0,−1,0,1,0,−1,0,1,0,1,0,1,0,1,0,1,0,−1,0,−1,0,−1,0,1,0,1,0,−1,0,1,0,−1,0,1,0,−1,0,−1,0,−1,0,1,0,1,0,1,0,−1,0,1,0,−1,0,−1,0,1,0,1,0,−1,0,1,0,−1,0,−1,0,−1,0,−1,0,1,0,1,0,−1,0,1,0,−1,0,−1,0,1,0,1,0,−1,0,−1,0,1,0,1,0,−1,0,−1,0,−1,0,−1,0,1,0,1,0,1,0,1,0,1,0,−1,0,1,0,−1,0,−1,0,−1,0,1,0,1,0,1,0,−1,0,−1,0,−1,0,1,0,1,0,1,0,1,0,−1,0,1,0,1,0,1,0,1,0,1,0,1,0,1,0,1,0,−1,0,−1,0,−1,0,1,0,−1,0,1,0,1,0,1,0,−1,0,−1,0,−1,0,1,0,1,0,−1,0,−1,0,−1,0,−1,0,1,0,−1,0,1,0,−1,0,−1,0,1,0,−1,0,1,0,−1,0,1,0,−1,0,−1,0,1,0,1,0,1,0,1,0,1,0,1,0,1,0,1,0,−1,0,−1,0,−1,0,−1,0,−1,0,1,0,−1,0,−1,0,−1,0,1,0,−1,0,1,0,1,0,1,0,1,0,−1,0,−1,0,1,0,−1,0,1,0,1,0,1,0,1,0,1,0,1,0,−1,0,−1,0,1,0,1,0,0,0,0,0,0,0,1,0,1,0,−1,0,−1,0,1,0,1,0,−1,0,1,0,1,0,−1,0,1,0,1,0,1,0,1,0,−1,0,1,0,−1,0,−1,0,−1,0,−1,0,1,0,−1,0,1,0,−1,0,−1,0,1,0,−1,0,−1,0,−1,0,−1,0,1,0,1,0,−1,0,1,0,1,0,1,0,−1,0,1,0,1,0,−1,0,1,0,1,0,−1,0,−1,0,1,0,−1,0,−1,0,1,0,−1,0,−1,0,1,0,1,0,1,0,−1,0,−1,0,1,0,1,0,1,0,1,0,−1,0,1,0,1,0,1,0,1,0,−1,0,1,0,−1,0,−1,0,1,0,1,0,1,0,1,0,−1,0,−1,0,−1,0,1,0,1,0,−1,0,−1,0,1,0,−1,0,1,0,1,0,−1,0,1,0,1,0,1,0,1,0,−1,0,−1,0,1,0,1,0,1,0,1,0,1,0,1,0,−1,0,−1,0,−1,0,1,0,1,0,1,0,−1,0,1,0,1,0,1,0,1,0,−1,0,−1,0,1,0,−1,0,1,0,1,0,−1,0,−1,0,1,0,1,0,−1,0,1,0,−1,0,1,0,1,0,−1,0,1,0,−1,0,1,0,1,0,1,0,−1,0,1,0,1,0,−1,0,−1,0,−1,0,1,0,−1,0,−1,0,1,0,1,0,1,0,−1,0,1,0,−1,0,−1,0,1,0,1,0,1,0,1,0,−1,0,1,0,−1,0,−1,0,1,0,−1,0,−1,0,1,0,−1,0,−1,0,−1,0,1,0,1,0,−1,0,−1,0,1,0,1,0,−1,0,−1,0,−1,0,1,0,1,0,1,0,1,0,−1,0,1,0,1,0,−1,0,1,0,−1,0,−1,0,−1,0,1,0,−1,0,−1,0,−1,0,1,0,1,0,1,0,−1,0,−1,0,−1,0,−1,0,−1,0,−1,0,1,0,−1,0,1,0,1,0,−1,0,−1,0,1,0,−1,0,1,0,1,0,−1,0,−1,0,−1,0,−1,0,1,0,1,0,1,0,1,0,1,0,1,0,1,0,−1,0,−1,0,1,0,1,0,−1,0,−1,0,1,0,−1,0,1,0,1,0,−1,0,−1,0,−1,0,−1,0,1,0,1,0,1,0,1,0,1,0,−1,0,1,0,−1,0,1,0,−1,0,1,0,1,0,−1,0,1,0,1,0,1,0,−1,0,−1,0,−1,0,1,0,−1,0,0,0,0,0,0,0,0,0,0,0}

For 160 MHz transmission, the N-TF sequence with the format of an HELTF2X160, optimized for estimation order P=5, is given by:

N-TF(HELTF2X160,P=5)=sqrt(2048/996)·{0,0,0,0,0,0,0,0,0,0,0,0,−1,0,−1,0,1,0,1,0,1,0,−1,0,−1,0,1,0,1,0,1,0,1,0,−1,0,−1,0,1,0,−1,0,1,0,1,0,1,0,1,0,1,0,1,0,1,0,1,0,−1,0,−1,0,−1,0,−1,0,1,0,−1,0,1,0,−1,0,−1,0,1,0,−1,0,1,0,1,0,1,0,−1,0,1,0,1,0,1,0,−1,0,1,0,−1,0,1,0,−1,0,1,0,1,0,−1,0,1,0,1,0,1,0,−1,0,−1,0,−1,0,1,0,−1,0,1,0,−1,0,−1,0,1,0,−1,0,−1,0,−1,0,−1,0,1,0,1,0,−1,0,1,0,1,0,1,0,−1,0,−1,0,1,0,1,0,1,0,−1,0,1,0,−1,0,1,0,−1,0,−1,0,1,0,−1,0,−1,0,1,0,1,0,1,0,−1,0,1,0,−1,0,1,0,1,0,1,0,−1,0,−1,0,1,0,1,0,−1,0,−1,0,−1,0,−1,0,1,0,1,0,1,0,1,0,1,0,−1,0,1,0,−1,0,−1,0,−1,0,−1,0,1,0,1,0,−1,0,1,0,−1,0,−1,0,1,0,1,0,−1,0,1,0,1,0,1,0,−1,0,1,0,1,0,−1,0,−1,0,1,0,1,0,1,0,1,0,−1,0,1,0,−1,0,1,0,−1,0,−1,0,1,0,−1,0,1,0,1,0,1,0,1,0,1,0,1,0,1,0,1,0,1,0,1,0,1,0,1,0,1,0,−1,0,−1,0,1,0,−1,0,−1,0,−1,0,−1,0,−1,0,1,0,−1,0,−1,0,−1,0,−1,0,1,0,−1,0,1,0,1,0,−1,0,−1,0,−1,0,−1,0,1,0,−1,0,−1,0,1,0,1,0,1,0,1,0,−1,0,−1,0,−1,0,−1,0,1,0,1,0,1,0,−1,0,1,0,1,0,1,0,−1,0,−1,0,−1,0,−1,0,1,0,1,0,1,0,−1,0,1,0,−1,0,1,0,−1,0,−1,0,1,0,−1,0,−1,0,−1,0,1,0,1,0,−1,0,−1,0,1,0,1,0,1,0,1,0,1,0,−1,0,−1,0,−1,0,−1,0,−1,0,1,0,1,0,−1,0,1,0,−1,0,1,0,−1,0,−1,0,−1,0,−1,0,1,0,1,0,1,0,−1,0,1,0,−1,0,−1,0,1,0,1,0,−1,0,1,0,1,0,−1,0,1,0,0,0,0,0,0,0,−1,0,−1,0,1,0,−1,0,−1,0,1,0,1,0,1,0,1,0,−1,0,1,0,1,0,1,0,1,0,1,0,1,0,−1,0,1,0,1,0,1,0,1,0,−1,0,1,0,−1,0,1,0,−1,0,−1,0,1,0,−1,0,−1,0,−1,0,−1,0,1,0,−1,0,1,0,−1,0,1,0,−1,0,1,0,1,0,−1,0,1,0,1,0,1,0,−1,0,1,0,1,0,−1,0,1,0,−1,0,−1,0,1,0,1,0,−1,0,−1,0,−1,0,1,0,1,0,−1,0,−1,0,1,0,−1,0,−1,0,1,0,−1,0,1,0,−1,0,−1,0,1,0,1,0,−1,0,1,0,1,0,1,0,−1,0,−1,0,−1,0,1,0,−1,0,−1,0,1,0,−1,0,−1,0,−1,0,−1,0,1,0,1,0,−1,0,−1,0,−1,0,−1,0,1,0,−1,0,1,0,−1,0,−1,0,−1,0,−1,0,−1,0,−1,0,1,0,−1,0,−1,0,−1,0,−1,0,1,0,−1,0,−1,0,−1,0,−1,0,1,0,−1,0,−1,0,−1,0,−1,0,1,0,1,0,1,0,1,0,1,0,1,0,−1,0,−1,0,1,0,−1,0,−1,0,1,0,−1,0,−1,0,1,0,−1,0,−1,0,1,0,−1,0,−1,0,1,0,−1,0,1,0,−1,0,−1,0,1,0,−1,0,−1,0,−1,0,−1,0,1,0,1,0,1,0,−1,0,−1,0,−1,0,1,0,1,0,−1,0,1,0,−1,0,1,0,1,0,1,0,1,0,1,0,1,0,−1,0,1,0,1,0,1,0,−1,0,−1,0,1,0,1,0,1,0,−1,0,−1,0,1,0,−1,0,1,0,−1,0,1,0,1,0,1,0,1,0,1,0,1,0,−1,0,1,0,−1,0,−1,0,1,0,1,0,1,0,−1,0,−1,0,1,0,1,0,−1,0,1,0,−1,0,1,0,−1,0,1,0,−1,0,1,0,1,0,−1,0,1,0,−1,0,1,0,1,0,−1,0,−1,0,−1,0,−1,0,1,0,−1,0,1,0,−1,0,−1,0,1,0,1,0,−1,0,−1,0,1,0,1,0,1,0,1,0,−1,0,1,0,1,0,−1,0,1,0,−1,0,1,0,1,0,−1,0,1,0,−1,0,1,0,1,0,1,0,1,0,−1,0,1,0,1,0,1,0,1,0,−1,0,1,0,1,0,−1,0,0,0,0,0,0,0,0,0,0,0,0,0,0,0,0,0,0,0,0,0,0,0,1,0,1,0,−1,0,−1,0,−1,0,−1,0,1,0,−1,0,−1,0,1,0,−1,0,1,0,−1,0,1,0,−1,0,−1,0,−1,0,−1,0,−1,0,1,0,−1,0,−1,0,−1,0,−1,0,1,0,−1,0,1,0,−1,0,1,0,1,0,−1,0,1,0,−1,0,−1,0,−1,0,1,0,−1,0,1,0,−1,0,−1,0,−1,0,1,0,1,0,−1,0,1,0,−1,0,−1,0,1,0,1,0,−1,0,−1,0,−1,0,−1,0,−1,0,1,0,1,0,1,0,−1,0,−1,0,1,0,1,0,−1,0,1,0,1,0,−1,0,1,0,−1,0,−1,0,−1,0,1,0,−1,0,1,0,1,0,1,0,1,0,−1,0,−1,0,1,0,1,0,−1,0,1,0,−1,0,1,0,−1,0,−1,0,1,0,−1,0,−1,0,1,0,1,0,−1,0,−1,0,1,0,1,0,−1,0,−1,0,1,0,−1,0,−1,0,−1,0,−1,0,−1,0,−1,0,−1,0,−1,0,1,0,−1,0,1,0,1,0,−1,0,−1,0,1,0,1,0,1,0,1,0,1,0,−1,0,1,0,−1,0,1,0,−1,0,1,0,1,0,−1,0,1,0,1,0,1,0,−1,0,−1,0,1,0,1,0,−1,0,1,0,−1,0,−1,0,1,0,−1,0,−1,0,−1,0,1,0,1,0,−1,0,1,0,1,0,−1,0,−1,0,1,0,−1,0,−1,0,1,0,1,0,1,0,1,0,1,0,1,0,1,0,−1,0,−1,0,1,0,1,0,1,0,1,0,1,0,1,0,−1,0,−1,0,−1,0,1,0,−1,0,1,0,1,0,−1,0,−1,0,−1,0,−1,0,−1,0,−1,0,1,0,1,0,1,0,1,0,−1,0,1,0,−1,0,1,0,−1,0,−1,0,1,0,1,0,−1,0,1,0,−1,0,−1,0,−1,0,−1,0,−1,0,1,0,−1,0,−1,0,−1,0,−1,0,1,0,−1,0,−1,0,1,0,1,0,1,0,−1,0,−1,0,1,0,−1,0,−1,0,1,0,−1,0,−1,0,1,0,−1,0,−1,0,1,0,−1,0,−1,0,1,0,−1,0,1,0,1,0,−1,0,1,0,1,0,1,0,1,0,−1,0,−1,0,−1,0,−1,0,1,0,1,0,−1,0,1,0,−1,0,1,0,−1,0,−1,0,−1,0,−1,0,−1,0,−1,0,1,0,1,0,1,0,0,0,0,0,0,0,−1,0,1,0,1,0,−1,0,1,0,−1,0,1,0,−1,0,−1,0,1,0,1,0,−1,0,1,0,1,0,1,0,1,0,−1,0,−1,0,−1,0,−1,0,−1,0,−1,0,1,0,1,0,1,0,−1,0,−1,0,1,0,−1,0,1,0,1,0,−1,0,−1,0,−1,0,1,0,1,0,−1,0,1,0,1,0,1,0,1,0,1,0,−1,0,−1,0,−1,0,−1,0,−1,0,1,0,1,0,1,0,1,0,1,0,1,0,1,0,−1,0,−1,0,−1,0,−1,0,1,0,−1,0,−1,0,−1,0,−1,0,−1,0,−1,0,−1,0,−1,0,−1,0,1,0,1,0,1,0,1,0,1,0,−1,0,−1,0,1,0,−1,0,1,0,1,0,1,0,1,0,1,0,1,0,1,0,−1,0,1,0,−1,0,1,0,1,0,1,0,1,0,−1,0,−1,0,1,0,−1,0,−1,0,1,0,1,0,−1,0,1,0,1,0,1,0,1,0,−1,0,−1,0,−1,0,−1,0,1,0,−1,0,1,0,1,0,1,0,−1,0,−1,0,−1,0,−1,0,1,0,−1,0,1,0,−1,0,−1,0,1,0,−1,0,1,0,1,0,1,0,−1,0,1,0,1,0,−1,0,1,0,1,0,1,0,−1,0,−1,0,1,0,1,0,−1,0,−1,0,−1,0,−1,0,−1,0,1,0,−1,0,−1,0,−1,0,1,0,1,0,1,0,1,0,−1,0,−1,0,−1,0,−1,0,1,0,1,0,−1,0,−1,0,−1,0,−1,0,−1,0,−1,0,1,0,1,0,−1,0,1,0,−1,0,1,0,1,0,−1,0,−1,0,−1,0,−1,0,−1,0,1,0,−1,0,1,0,−1,0,−1,0,−1,0,1,0,1,0,1,0,1,0,−1,0,1,0,−1,0,1,0,−1,0,−1,0,1,0,1,0,1,0,1,0,1,0,1,0,1,0,−1,0,1,0,1,0,1,0,−1,0,1,0,−1,0,−1,0,−1,0,−1,0,1,0,−1,0,−1,0,1,0,−1,0,1,0,1,0,−1,0,1,0,1,0,1,0,−1,0,1,0,1,0,1,0,1,0,−1,0,−1,0,1,0,1,0,−1,0,1,0,1,0,−1,0,1,0,−1,0,1,0,1,0,1,0,−1,0,−1,0,−1,0,1,0,1,0,−1,0,1,0,−1,0,−1,0,1,0,−1,0,−1,0,−1,0,0,0,0,0,0,0,0,0,0,0}

For 160 MHz transmission, the N-TF sequence with the format of an HELTF2X160, optimized for estimation order P=6, is given by:

N-TF(HELTF2X160,P=6)=sqrt(2048/996)·{0,0,0,0,0,0,0,0,0,0,0,0,−1,0,−1,0,−1,0,−1,0,−1,0,−1,0,1,0,−1,0,1,0,1,0,−1,0,1,0,1,0,−1,0,−1,0,1,0,1,0,1,0,1,0,1,0,−1,0,1,0,−1,0,1,0,−1,0,−1,0,1,0,−1,0,−1,0,−1,0,1,0,−1,0,1,0,1,0,1,0,−1,0,−1,0,1,0,−1,0,1,0,1,0,1,0,−1,0,1,0,−1,0,1,0,−1,0,1,0,−1,0,−1,0,−1,0,1,0,−1,0,−1,0,−1,0,−1,0,−1,0,−1,0,1,0,1,0,1,0,1,0,−1,0,1,0,−1,0,−1,0,−1,0,1,0,−1,0,−1,0,−1,0,1,0,−1,0,−1,0,−1,0,−1,0,1,0,−1,0,−1,0,1,0,−1,0,−1,0,1,0,1,0,1,0,−1,0,−1,0,1,0,−1,0,1,0,−1,0,1,0,−1,0,1,0,1,0,−1,0,1,0,−1,0,−1,0,1,0,−1,0,1,0,1,0,1,0,1,0,−1,0,1,0,1,0,1,0,−1,0,1,0,1,0,−1,0,1,0,−1,0,−1,0,1,0,−1,0,−1,0,1,0,1,0,1,0,1,0,−1,0,−1,0,1,0,1,0,−1,0,−1,0,1,0,1,0,−1,0,−1,0,−1,0,−1,0,−1,0,1,0,−1,0,1,0,1,0,−1,0,−1,0,1,0,−1,0,1,0,−1,0,1,0,1,0,1,0,1,0,1,0,1,0,1,0,−1,0,−1,0,−1,0,1,0,1,0,1,0,1,0,1,0,−1,0,−1,0,−1,0,1,0,1,0,1,0,1,0,−1,0,1,0,1,0,1,0,1,0,−1,0,1,0,1,0,1,0,−1,0,−1,0,−1,0,−1,0,1,0,1,0,1,0,1,0,1,0,1,0,1,0,−1,0,−1,0,−1,0,1,0,1,0,1,0,−1,0,1,0,1,0,1,0,−1,0,1,0,−1,0,1,0,1,0,−1,0,1,0,1,0,−1,0,1,0,−1,0,1,0,1,0,−1,0,−1,0,−1,0,1,0,1,0,1,0,−1,0,1,0,1,0,1,0,−1,0,1,0,1,0,−1,0,1,0,−1,0,1,0,−1,0,−1,0,1,0,1,0,1,0,1,0,1,0,1,0,1,0,1,0,−1,0,1,0,1,0,−1,0,1,0,−1,0,−1,0,1,0,−1,0,1,0,−1,0,0,0,0,0,0,0,1,0,−1,0,−1,0,1,0,−1,0,−1,0,1,0,−1,0,1,0,−1,0,1,0,−1,0,−1,0,1,0,−1,0,−1,0,1,0,−1,0,1,0,−1,0,−1,0,−1,0,1,0,1,0,1,0,−1,0,1,0,−1,0,−1,0,1,0,1,0,−1,0,−1,0,−1,0,1,0,1,0,−1,0,−1,0,1,0,−1,0,−1,0,−1,0,−1,0,1,0,−1,0,1,0,1,0,1,0,−1,0,−1,0,−1,0,−1,0,1,0,−1,0,−1,0,1,0,−1,0,−1,0,−1,0,−1,0,1,0,−1,0,−1,0,−1,0,1,0,1,0,−1,0,−1,0,1,0,−1,0,−1,0,−1,0,1,0,−1,0,1,0,1,0,1,0,1,0,1,0,1,0,−1,0,−1,0,−1,0,1,0,−1,0,−1,0,−1,0,1,0,−1,0,1,0,−1,0,1,0,−1,0,1,0,−1,0,−1,0,1,0,−1,0,−1,0,−1,0,1,0,1,0,−1,0,−1,0,−1,0,−1,0,1,0,−1,0,1,0,−1,0,1,0,1,0,1,0,1,0,1,0,−1,0,−1,0,−1,0,1,0,−1,0,1,0,−1,0,−1,0,1,0,−1,0,1,0,1,0,1,0,1,0,−1,0,−1,0,1,0,−1,0,−1,0,−1,0,1,0,−1,0,1,0,1,0,1,0,1,0,−1,0,−1,0,−1,0,1,0,1,0,1,0,1,0,−1,0,1,0,−1,0,1,0,1,0,−1,0,1,0,1,0,−1,0,1,0,−1,0,1,0,−1,0,1,0,1,0,1,0,−1,0,1,0,−1,0,−1,0,1,0,1,0,−1,0,−1,0,1,0,−1,0,1,0,−1,0,1,0,1,0,−1,0,−1,0,−1,0,1,0,1,0,−1,0,1,0,1,0,1,0,1,0,−1,0,1,0,1,0,−1,0,−1,0,1,0,1,0,−1,0,1,0,1,0,−1,0,1,0,1,0,1,0,1,0,1,0,1,0,1,0,−1,0,1,0,−1,0,1,0,−1,0,−1,0,1,0,−1,0,1,0,−1,0,1,0,−1,0,−1,0,−1,0,−1,0,1,0,1,0,−1,0,1,0,−1,0,1,0,1,0,−1,0,1,0,−1,0,1,0,−1,0,−1,0,1,0,1,0,1,0,−1,0,−1,0,1,0,−1,0,−1,0,−1,0,1,0,−1,0,1,0,1,0,1,0,1,0,0,0,0,0,0,0,0,0,0,0,0,0,0,0,0,0,0,0,0,0,0,0,−1,0,−1,0,−1,0,−1,0,−1,0,1,0,1,0,−1,0,−1,0,1,0,1,0,−1,0,−1,0,−1,0,−1,0,1,0,−1,0,1,0,1,0,1,0,1,0,−1,0,−1,0,−1,0,1,0,1,0,−1,0,1,0,−1,0,−1,0,1,0,1,0,1,0,−1,0,1,0,−1,0,−1,0,−1,0,1,0,1,0,−1,0,−1,0,1,0,1,0,−1,0,−1,0,−1,0,1,0,−1,0,−1,0,1,0,1,0,1,0,−1,0,−1,0,1,0,−1,0,−1,0,−1,0,−1,0,1,0,−1,0,−1,0,−1,0,1,0,1,0,−1,0,−1,0,−1,0,1,0,1,0,−1,0,1,0,−1,0,−1,0,1,0,1,0,1,0,−1,0,−1,0,1,0,−1,0,1,0,−1,0,−1,0,1,0,−1,0,−1,0,−1,0,−1,0,−1,0,1,0,−1,0,−1,0,1,0,−1,0,1,0,−1,0,1,0,1,0,1,0,−1,0,−1,0,−1,0,−1,0,−1,0,−1,0,−1,0,1,0,1,0,−1,0,−1,0,−1,0,1,0,1,0,1,0,1,0,1,0,1,0,1,0,1,0,−1,0,−1,0,1,0,1,0,−1,0,−1,0,1,0,1,0,−1,0,−1,0,−1,0,−1,0,1,0,1,0,1,0,−1,0,−1,0,1,0,−1,0,−1,0,1,0,−1,0,1,0,1,0,1,0,−1,0,−1,0,1,0,1,0,1,0,−1,0,−1,0,−1,0,1,0,1,0,−1,0,1,0,1,0,1,0,1,0,1,0,1,0,1,0,−1,0,−1,0,1,0,−1,0,−1,0,1,0,1,0,1,0,1,0,1,0,−1,0,1,0,1,0,−1,0,1,0,1,0,1,0,1,0,1,0,1,0,1,0,1,0,1,0,−1,0,−1,0,1,0,1,0,−1,0,1,0,1,0,1,0,−1,0,−1,0,1,0,1,0,1,0,−1,0,1,0,1,0,1,0,1,0,1,0,1,0,1,0,1,0,−1,0,1,0,1,0,−1,0,−1,0,1,0,−1,0,1,0,−1,0,−1,0,−1,0,1,0,1,0,1,0,1,0,1,0,−1,0,1,0,−1,0,−1,0,−1,0,−1,0,−1,0,−1,0,1,0,−1,0,−1,0,−1,0,−1,0,1,0,1,0,−1,0,1,0,−1,0,1,0,1,0,−1,0,1,0,−1,0,1,0,0,0,0,0,0,0,−1,0,1,0,1,0,−1,0,1,0,−1,0,1,0,1,0,−1,0,−1,0,−1,0,−1,0,−1,0,−1,0,−1,0,1,0,−1,0,1,0,1,0,1,0,−1,0,1,0,−1,0,1,0,1,0,−1,0,−1,0,−1,0,−1,0,1,0,−1,0,1,0,1,0,−1,0,1,0,1,0,−1,0,1,0,−1,0,1,0,−1,0,1,0,−1,0,−1,0,1,0,1,0,−1,0,−1,0,−1,0,−1,0,1,0,1,0,1,0,1,0,−1,0,1,0,−1,0,1,0,−1,0,−1,0,1,0,−1,0,1,0,−1,0,−1,0,1,0,−1,0,1,0,−1,0,1,0,−1,0,1,0,1,0,−1,0,1,0,−1,0,1,0,−1,0,1,0,1,0,1,0,1,0,−1,0,−1,0,−1,0,−1,0,−1,0,1,0,−1,0,1,0,−1,0,−1,0,−1,0,−1,0,−1,0,1,0,−1,0,−1,0,1,0,1,0,1,0,−1,0,1,0,1,0,−1,0,−1,0,−1,0,−1,0,1,0,−1,0,1,0,1,0,1,0,1,0,1,0,1,0,−1,0,−1,0,1,0,−1,0,1,0,1,0,−1,0,−1,0,1,0,1,0,1,0,1,0,−1,0,1,0,−1,0,1,0,1,0,−1,0,−1,0,−1,0,−1,0,1,0,1,0,−1,0,−1,0,−1,0,1,0,1,0,−1,0,1,0,−1,0,−1,0,−1,0,1,0,1,0,1,0,1,0,1,0,1,0,−1,0,1,0,1,0,−1,0,1,0,1,0,1,0,1,0,1,0,1,0,1,0,1,0,−1,0,1,0,−1,0,1,0,−1,0,1,0,1,0,1,0,1,0,1,0,−1,0,−1,0,−1,0,1,0,−1,0,−1,0,1,0,1,0,1,0,−1,0,−1,0,−1,0,1,0,−1,0,−1,0,1,0,1,0,−1,0,−1,0,−1,0,−1,0,1,0,1,0,−1,0,1,0,1,0,1,0,−1,0,1,0,−1,0,−1,0,1,0,1,0,1,0,1,0,1,0,1,0,1,0,1,0,−1,0,−1,0,1,0,−1,0,1,0,−1,0,1,0,−1,0,1,0,1,0,−1,0,1,0,1,0,−1,0,−1,0,−1,0,1,0,1,0,1,0,1,0,−1,0,−1,0,1,0,−1,0,−1,0,−1,0,1,0,1,0,−1,0,1,0,−1,0,1,0,−1,0,0,0,0,0,0,0,0,0,0,0}

For 160 MHz transmission, the N-TF sequence with the format of an HELTF2X160, optimized for estimation order P=7, is given by:

N-TF(HELTF2X160,P=7)=sqrt(2048/996)·{0,0,0,0,0,0,0,0,0,0,0,0,1,0,−1,0,−1,0,1,0,1,0,1,0,−1,0,−1,0,−1,0,1,0,−1,0,−1,0,1,0,−1,0,−1,0,1,0,1,0,1,0,−1,0,1,0,1,0,−1,0,1,0,1,0,1,0,−1,0,1,0,1,0,1,0,−1,0,−1,0,1,0,1,0,1,0,1,0,−1,0,−1,0,−1,0,1,0,−1,0,−1,0,−1,0,1,0,1,0,1,0,1,0,1,0,−1,0,1,0,1,0,1,0,−1,0,−1,0,−1,0,−1,0,1,0,1,0,1,0,1,0,−1,0,1,0,1,0,−1,0,1,0,1,0,1,0,−1,0,−1,0,1,0,−1,0,−1,0,−1,0,−1,0,−1,0,−1,0,1,0,1,0,−1,0,−1,0,1,0,1,0,−1,0,1,0,−1,0,−1,0,−1,0,1,0,−1,0,1,0,−1,0,−1,0,−1,0,1,0,−1,0,−1,0,−1,0,1,0,1,0,1,0,−1,0,−1,0,1,0,1,0,1,0,−1,0,−1,0,1,0,1,0,1,0,1,0,−1,0,−1,0,−1,0,1,0,−1,0,1,0,1,0,1,0,1,0,−1,0,1,0,−1,0,−1,0,1,0,−1,0,−1,0,1,0,−1,0,1,0,−1,0,−1,0,1,0,1,0,−1,0,−1,0,−1,0,−1,0,1,0,−1,0,1,0,−1,0,−1,0,1,0,1,0,−1,0,−1,0,1,0,1,0,−1,0,−1,0,1,0,−1,0,−1,0,1,0,−1,0,1,0,1,0,1,0,1,0,1,0,−1,0,−1,0,−1,0,−1,0,−1,0,−1,0,−1,0,−1,0,1,0,1,0,1,0,−1,0,1,0,−1,0,1,0,−1,0,1,0,−1,0,−1,0,−1,0,−1,0,−1,0,1,0,1,0,1,0,1,0,1,0,1,0,1,0,1,0,1,0,−1,0,1,0,−1,0,−1,0,1,0,1,0,−1,0,−1,0,1,0,1,0,1,0,1,0,1,0,−1,0,1,0,−1,0,−1,0,−1,0,−1,0,−1,0,1,0,−1,0,−1,0,−1,0,1,0,1,0,1,0,1,0,−1,0,1,0,−1,0,1,0,−1,0,−1,0,1,0,−1,0,1,0,1,0,1,0,1,0,1,0,1,0,1,0,1,0,1,0,1,0,−1,0,1,0,−1,0,−1,0,−1,0,−1,0,1,0,1,0,−1,0,−1,0,−1,0,−1,0,0,0,0,0,0,0,−1,0,−1,0,−1,0,1,0,1,0,1,0,−1,0,1,0,−1,0,−1,0,1,0,−1,0,1,0,−1,0,1,0,−1,0,1,0,1,0,−1,0,−1,0,1,0,1,0,1,0,1,0,−1,0,1,0,1,0,−1,0,1,0,−1,0,−1,0,1,0,1,0,−1,0,−1,0,−1,0,1,0,−1,0,1,0,−1,0,1,0,−1,0,−1,0,−1,0,1,0,1,0,−1,0,−1,0,−1,0,1,0,−1,0,−1,0,−1,0,1,0,−1,0,1,0,1,0,1,0,1,0,1,0,−1,0,1,0,1,0,1,0,−1,0,1,0,1,0,1,0,1,0,1,0,1,0,−1,0,−1,0,1,0,1,0,−1,0,1,0,1,0,1,0,−1,0,1,0,−1,0,1,0,−1,0,1,0,1,0,1,0,−1,0,−1,0,−1,0,1,0,1,0,−1,0,−1,0,−1,0,−1,0,−1,0,1,0,1,0,−1,0,−1,0,−1,0,1,0,1,0,1,0,−1,0,−1,0,−1,0,1,0,−1,0,1,0,−1,0,−1,0,−1,0,1,0,1,0,1,0,−1,0,−1,0,−1,0,1,0,−1,0,1,0,1,0,1,0,−1,0,1,0,−1,0,1,0,−1,0,−1,0,1,0,−1,0,1,0,1,0,−1,0,1,0,1,0,1,0,−1,0,−1,0,1,0,−1,0,−1,0,1,0,1,0,1,0,−1,0,−1,0,−1,0,−1,0,−1,0,1,0,1,0,1,0,1,0,1,0,1,0,1,0,1,0,1,0,−1,0,1,0,1,0,−1,0,−1,0,−1,0,−1,0,−1,0,−1,0,1,0,−1,0,1,0,−1,0,1,0,−1,0,1,0,−1,0,−1,0,−1,0,1,0,−1,0,1,0,−1,0,−1,0,−1,0,1,0,1,0,−1,0,−1,0,1,0,1,0,−1,0,−1,0,1,0,1,0,1,0,1,0,1,0,−1,0,−1,0,−1,0,−1,0,−1,0,−1,0,1,0,1,0,−1,0,−1,0,−1,0,−1,0,1,0,−1,0,1,0,1,0,−1,0,1,0,−1,0,−1,0,−1,0,1,0,−1,0,1,0,1,0,−1,0,−1,0,−1,0,−1,0,1,0,1,0,−1,0,−1,0,1,0,1,0,−1,0,1,0,1,0,1,0,1,0,1,0,−1,0,1,0,−1,0,−1,0,1,0,−1,0,−1,0,−1,0,−1,0,0,0,0,0,0,0,0,0,0,0,0,0,0,0,0,0,0,0,0,0,0,0,1,0,−1,0,−1,0,−1,0,−1,0,−1,0,−1,0,−1,0,−1,0,−1,0,1,0,1,0,−1,0,1,0,1,0,1,0,−1,0,−1,0,1,0,1,0,−1,0,1,0,−1,0,1,0,−1,0,−1,0,−1,0,1,0,1,0,−1,0,1,0,1,0,−1,0,1,0,−1,0,1,0,−1,0,1,0,1,0,1,0,1,0,−1,0,−1,0,1,0,1,0,−1,0,−1,0,1,0,−1,0,1,0,1,0,1,0,−1,0,−1,0,1,0,1,0,1,0,−1,0,1,0,1,0,1,0,1,0,−1,0,−1,0,−1,0,−1,0,1,0,1,0,1,0,1,0,1,0,1,0,1,0,1,0,1,0,−1,0,1,0,1,0,1,0,−1,0,−1,0,−1,0,−1,0,1,0,1,0,−1,0,−1,0,1,0,1,0,1,0,−1,0,−1,0,1,0,−1,0,−1,0,1,0,1,0,−1,0,1,0,1,0,1,0,1,0,1,0,−1,0,1,0,−1,0,1,0,1,0,1,0,−1,0,1,0,1,0,1,0,1,0,1,0,−1,0,−1,0,−1,0,1,0,1,0,1,0,−1,0,−1,0,−1,0,−1,0,−1,0,−1,0,−1,0,1,0,1,0,1,0,1,0,1,0,−1,0,1,0,−1,0,1,0,−1,0,1,0,−1,0,1,0,1,0,−1,0,−1,0,−1,0,1,0,−1,0,1,0,1,0,−1,0,−1,0,1,0,1,0,−1,0,1,0,−1,0,1,0,−1,0,−1,0,1,0,1,0,−1,0,−1,0,−1,0,1,0,−1,0,−1,0,−1,0,−1,0,−1,0,−1,0,−1,0,−1,0,−1,0,−1,0,1,0,1,0,1,0,1,0,−1,0,−1,0,1,0,1,0,1,0,1,0,1,0,−1,0,−1,0,1,0,1,0,−1,0,−1,0,−1,0,1,0,1,0,1,0,−1,0,−1,0,−1,0,−1,0,1,0,−1,0,−1,0,−1,0,−1,0,1,0,1,0,−1,0,1,0,−1,0,1,0,1,0,1,0,−1,0,−1,0,−1,0,−1,0,−1,0,−1,0,−1,0,1,0,−1,0,−1,0,1,0,−1,0,1,0,−1,0,1,0,1,0,1,0,−1,0,−1,0,−1,0,−1,0,1,0,−1,0,1,0,1,0,−1,0,1,0,−1,0,1,0,1,0,−1,0,−1,0,1,0,1,0,−1,0,1,0,0,0,0,0,0,0,1,0,1,0,−1,0,−1,0,−1,0,1,0,−1,0,−1,0,−1,0,−1,0,−1,0,−1,0,1,0,1,0,1,0,−1,0,1,0,1,0,1,0,−1,0,1,0,−1,0,−1,0,−1,0,1,0,−1,0,−1,0,1,0,1,0,1,0,−1,0,1,0,1,0,1,0,−1,0,1,0,−1,0,1,0,−1,0,−1,0,1,0,−1,0,1,0,−1,0,1,0,−1,0,1,0,1,0,1,0,−1,0,1,0,1,0,1,0,1,0,1,0,−1,0,−1,0,1,0,1,0,1,0,1,0,1,0,1,0,1,0,1,0,−1,0,1,0,−1,0,−1,0,1,0,1,0,−1,0,1,0,−1,0,−1,0,1,0,1,0,1,0,1,0,1,0,1,0,−1,0,−1,0,−1,0,−1,0,−1,0,−1,0,−1,0,−1,0,−1,0,1,0,−1,0,1,0,−1,0,1,0,1,0,1,0,−1,0,1,0,−1,0,−1,0,−1,0,1,0,1,0,−1,0,−1,0,−1,0,−1,0,−1,0,1,0,1,0,−1,0,−1,0,−1,0,1,0,−1,0,1,0,1,0,1,0,−1,0,−1,0,1,0,−1,0,−1,0,1,0,−1,0,1,0,−1,0,−1,0,−1,0,−1,0,−1,0,1,0,1,0,1,0,−1,0,1,0,−1,0,1,0,−1,0,1,0,1,0,1,0,1,0,−1,0,1,0,1,0,1,0,1,0,−1,0,−1,0,−1,0,−1,0,−1,0,1,0,1,0,−1,0,−1,0,1,0,1,0,1,0,−1,0,−1,0,1,0,1,0,1,0,1,0,−1,0,−1,0,−1,0,1,0,1,0,1,0,−1,0,1,0,−1,0,1,0,1,0,1,0,−1,0,−1,0,−1,0,1,0,1,0,−1,0,1,0,1,0,1,0,1,0,−1,0,1,0,−1,0,1,0,1,0,1,0,1,0,1,0,1,0,1,0,−1,0,1,0,−1,0,1,0,−1,0,−1,0,−1,0,1,0,−1,0,1,0,1,0,1,0,1,0,−1,0,−1,0,−1,0,−1,0,1,0,1,0,1,0,−1,0,−1,0,1,0,1,0,−1,0,−1,0,1,0,−1,0,−1,0,1,0,1,0,1,0,−1,0,−1,0,−1,0,1,0,1,0,1,0,−1,0,1,0,1,0,1,0,1,0,−1,0,1,0,−1,0,−1,0,1,0,−1,0,−1,0,0,0,0,0,0,0,0,0,0,0}

For 160 MHz transmission, the N-TF sequence with the format of an HELTF2X160, optimized for estimation order P=8, is given by:

N-TF(HELTF2X160,P=8)=sqrt(2048/996)·{0,0,0,0,0,0,0,0,0,0,0,0,1,0,−1,0,1,0,−1,0,−1,0,−1,0,−1,0,1,0,1,0,−1,0,−1,0,1,0,1,0,1,0,−1,0,1,0,1,0,1,0,1,0,−1,0,−1,0,1,0,−1,0,−1,0,1,0,1,0,1,0,−1,0,1,0,−1,0,−1,0,−1,0,−1,0,−1,0,1,0,1,0,−1,0,1,0,1,0,1,0,1,0,−1,0,−1,0,−1,0,−1,0,1,0,1,0,1,0,1,0,−1,0,1,0,1,0,−1,0,1,0,1,0,1,0,1,0,1,0,1,0,1,0,1,0,−1,0,1,0,1,0,1,0,1,0,1,0,−1,0,−1,0,1,0,1,0,1,0,1,0,−1,0,−1,0,1,0,−1,0,1,0,−1,0,−1,0,−1,0,−1,0,−1,0,−1,0,1,0,1,0,−1,0,1,0,−1,0,−1,0,−1,0,−1,0,−1,0,1,0,1,0,1,0,1,0,−1,0,1,0,1,0,1,0,1,0,1,0,−1,0,1,0,−1,0,1,0,−1,0,1,0,1,0,1,0,1,0,−1,0,−1,0,1,0,1,0,−1,0,1,0,−1,0,1,0,1,0,−1,0,−1,0,1,0,1,0,−1,0,1,0,1,0,1,0,1,0,1,0,1,0,1,0,−1,0,−1,0,1,0,−1,0,−1,0,−1,0,1,0,1,0,1,0,−1,0,1,0,1,0,1,0,1,0,1,0,1,0,−1,0,1,0,1,0,−1,0,1,0,1,0,−1,0,1,0,1,0,1,0,1,0,−1,0,−1,0,1,0,−1,0,1,0,1,0,−1,0,−1,0,1,0,1,0,−1,0,−1,0,1,0,−1,0,1,0,1,0,−1,0,1,0,−1,0,−1,0,−1,0,−1,0,1,0,−1,0,−1,0,−1,0,1,0,1,0,1,0,1,0,−1,0,−1,0,1,0,1,0,−1,0,1,0,−1,0,−1,0,1,0,1,0,1,0,1,0,1,0,1,0,1,0,−1,0,1,0,1,0,−1,0,1,0,−1,0,−1,0,1,0,−1,0,1,0,−1,0,1,0,−1,0,−1,0,1,0,−1,0,−1,0,1,0,1,0,1,0,1,0,1,0,−1,0,1,0,−1,0,1,0,−1,0,1,0,1,0,1,0,1,0,1,0,1,0,1,0,1,0,1,0,−1,0,−1,0,−1,0,−1,0,−1,0,1,0,1,0,−1,0,0,0,0,0,0,0,1,0,1,0,1,0,1,0,−1,0,1,0,−1,0,−1,0,1,0,1,0,−1,0,−1,0,1,0,−1,0,−1,0,1,0,−1,0,1,0,−1,0,−1,0,1,0,−1,0,1,0,−1,0,1,0,1,0,1,0,−1,0,−1,0,1,0,1,0,1,0,1,0,−1,0,1,0,1,0,−1,0,1,0,1,0,−1,0,−1,0,1,0,−1,0,−1,0,1,0,1,0,1,0,1,0,−1,0,1,0,1,0,−1,0,1,0,−1,0,−1,0,−1,0,1,0,−1,0,1,0,1,0,1,0,1,0,1,0,−1,0,−1,0,1,0,1,0,−1,0,1,0,−1,0,1,0,−1,0,−1,0,1,0,1,0,−1,0,1,0,−1,0,−1,0,1,0,1,0,−1,0,1,0,1,0,1,0,1,0,1,0,1,0,1,0,1,0,−1,0,1,0,−1,0,−1,0,−1,0,1,0,1,0,−1,0,1,0,−1,0,1,0,1,0,−1,0,1,0,−1,0,1,0,−1,0,−1,0,1,0,1,0,1,0,−1,0,1,0,−1,0,−1,0,−1,0,1,0,−1,0,1,0,1,0,−1,0,1,0,1,0,−1,0,1,0,1,0,1,0,1,0,1,0,1,0,1,0,1,0,−1,0,1,0,1,0,−1,0,1,0,1,0,1,0,1,0,1,0,−1,0,1,0,1,0,−1,0,1,0,−1,0,1,0,1,0,−1,0,1,0,−1,0,1,0,1,0,1,0,1,0,−1,0,−1,0,1,0,1,0,−1,0,1,0,1,0,−1,0,1,0,1,0,1,0,−1,0,−1,0,1,0,−1,0,1,0,1,0,−1,0,1,0,1,0,1,0,−1,0,−1,0,−1,0,−1,0,−1,0,1,0,1,0,1,0,1,0,−1,0,1,0,1,0,1,0,−1,0,1,0,1,0,−1,0,1,0,1,0,−1,0,1,0,−1,0,1,0,1,0,1,0,−1,0,−1,0,−1,0,−1,0,1,0,−1,0,−1,0,−1,0,1,0,1,0,1,0,1,0,1,0,1,0,1,0,1,0,1,0,1,0,−1,0,1,0,1,0,1,0,1,0,−1,0,1,0,1,0,1,0,1,0,1,0,1,0,1,0,−1,0,−1,0,−1,0,−1,0,1,0,−1,0,−1,0,1,0,1,0,1,0,1,0,1,0,1,0,1,0,1,0,1,0,0,0,0,0,0,0,0,0,0,0,0,0,0,0,0,0,0,0,0,0,0,0,1,0,1,0,1,0,−1,0,−1,0,1,0,−1,0,−1,0,−1,0,−1,0,−1,0,−1,0,1,0,1,0,1,0,1,0,1,0,−1,0,−1,0,1,0,−1,0,−1,0,−1,0,−1,0,1,0,1,0,1,0,−1,0,1,0,−1,0,1,0,1,0,1,0,−1,0,1,0,−1,0,1,0,−1,0,−1,0,−1,0,−1,0,1,0,−1,0,1,0,1,0,−1,0,1,0,−1,0,−1,0,1,0,1,0,1,0,1,0,1,0,1,0,−1,0,1,0,1,0,1,0,1,0,−1,0,1,0,1,0,1,0,−1,0,1,0,−1,0,1,0,−1,0,−1,0,1,0,1,0,−1,0,1,0,1,0,1,0,−1,0,−1,0,1,0,1,0,−1,0,−1,0,−1,0,1,0,−1,0,−1,0,−1,0,−1,0,−1,0,1,0,1,0,1,0,−1,0,−1,0,−1,0,−1,0,−1,0,−1,0,1,0,−1,0,1,0,1,0,1,0,1,0,1,0,1,0,−1,0,1,0,−1,0,1,0,1,0,1,0,1,0,1,0,1,0,1,0,−1,0,−1,0,−1,0,1,0,−1,0,1,0,1,0,1,0,1,0,1,0,−1,0,−1,0,1,0,−1,0,1,0,−1,0,−1,0,−1,0,1,0,−1,0,1,0,1,0,−1,0,1,0,1,0,−1,0,−1,0,−1,0,1,0,1,0,−1,0,1,0,−1,0,1,0,1,0,1,0,1,0,−1,0,1,0,1,0,1,0,1,0,1,0,−1,0,−1,0,−1,0,−1,0,−1,0,−1,0,1,0,1,0,−1,0,1,0,−1,0,1,0,1,0,−1,0,−1,0,1,0,1,0,1,0,−1,0,1,0,1,0,1,0,1,0,1,0,−1,0,−1,0,−1,0,−1,0,1,0,−1,0,1,0,−1,0,−1,0,1,0,−1,0,1,0,1,0,−1,0,1,0,1,0,1,0,1,0,1,0,1,0,1,0,−1,0,−1,0,1,0,1,0,−1,0,1,0,1,0,−1,0,1,0,1,0,−1,0,−1,0,1,0,1,0,−1,0,−1,0,−1,0,−1,0,1,0,1,0,1,0,−1,0,1,0,−1,0,−1,0,−1,0,1,0,1,0,1,0,1,0,1,0,−1,0,1,0,1,0,1,0,1,0,1,0,1,0,1,0,1,0,−1,0,1,0,1,0,1,0,−1,0,0,0,0,0,0,0,1,0,1,0,1,0,1,0,−1,0,−1,0,1,0,1,0,−1,0,1,0,−1,0,1,0,1,0,−1,0,1,0,1,0,−1,0,−1,0,−1,0,−1,0,1,0,1,0,1,0,−1,0,1,0,−1,0,−1,0,1,0,1,0,−1,0,1,0,1,0,1,0,1,0,−1,0,1,0,1,0,1,0,−1,0,1,0,1,0,−1,0,1,0,−1,0,1,0,−1,0,−1,0,−1,0,−1,0,1,0,1,0,1,0,1,0,−1,0,1,0,−1,0,1,0,1,0,1,0,1,0,1,0,1,0,−1,0,−1,0,1,0,−1,0,1,0,1,0,−1,0,1,0,−1,0,−1,0,−1,0,1,0,1,0,1,0,1,0,−1,0,1,0,−1,0,1,0,1,0,1,0,−1,0,1,0,−1,0,−1,0,1,0,−1,0,1,0,1,0,−1,0,1,0,1,0,1,0,−1,0,−1,0,−1,0,1,0,1,0,−1,0,−1,0,1,0,1,0,1,0,−1,0,1,0,−1,0,1,0,1,0,−1,0,−1,0,1,0,1,0,1,0,1,0,−1,0,1,0,−1,0,−1,0,1,0,−1,0,−1,0,−1,0,1,0,−1,0,−1,0,1,0,−1,0,1,0,−1,0,−1,0,−1,0,1,0,1,0,1,0,1,0,1,0,1,0,1,0,−1,0,−1,0,−1,0,1,0,1,0,1,0,1,0,−1,0,1,0,1,0,−1,0,−1,0,−1,0,−1,0,−1,0,−1,0,1,0,1,0,1,0,1,0,1,0,1,0,1,0,1,0,−1,0,1,0,1,0,−1,0,−1,0,1,0,1,0,1,0,1,0,1,0,−1,0,1,0,−1,0,−1,0,1,0,−1,0,1,0,−1,0,1,0,−1,0,1,0,−1,0,−1,0,1,0,−1,0,1,0,1,0,−1,0,1,0,−1,0,1,0,−1,0,1,0,−1,0,−1,0,1,0,−1,0,1,0,1,0,−1,0,1,0,1,0,−1,0,1,0,1,0,1,0,1,0,1,0,1,0,−1,0,1,0,−1,0,−1,0,1,0,1,0,−1,0,1,0,1,0,1,0,1,0,1,0,−1,0,−1,0,1,0,−1,0,−1,0,1,0,1,0,1,0,1,0,1,0,1,0,1,0,−1,0,−1,0,1,0,−1,0,1,0,1,0,−1,0,1,0,−1,0,1,0,1,0,1,0,0,0,0,0,0,0,0,0,0,0}

For 160 MHz transmission, the N-TF sequence with the format of an HELTF2X160, optimized for estimation order P=9, is given by:

N-TF(HELTF2X160,P=9)=sqrt(2048/996)·{0,0,0,0,0,0,0,0,0,0,0,0,1,0,1,0,1,0,−1,0,1,0,−1,0,1,0,1,0,1,0,1,0,1,0,1,0,1,0,1,0,1,0,1,0,1,0,1,0,1,0,−1,0,−1,0,1,0,−1,0,1,0,1,0,1,0,1,0,1,0,−1,0,−1,0,−1,0,−1,0,−1,0,−1,0,−1,0,−1,0,−1,0,1,0,1,0,−1,0,−1,0,1,0,−1,0,−1,0,−1,0,1,0,1,0,1,0,1,0,−1,0,1,0,1,0,1,0,1,0,1,0,−1,0,1,0,1,0,1,0,1,0,1,0,1,0,1,0,1,0,−1,0,1,0,1,0,1,0,−1,0,1,0,1,0,1,0,1,0,−1,0,1,0,1,0,−1,0,1,0,−1,0,−1,0,1,0,1,0,−1,0,1,0,1,0,−1,0,−1,0,1,0,−1,0,−1,0,−1,0,1,0,−1,0,1,0,−1,0,1,0,1,0,−1,0,1,0,1,0,1,0,1,0,1,0,−1,0,1,0,−1,0,−1,0,−1,0,1,0,1,0,1,0,1,0,1,0,−1,0,1,0,1,0,−1,0,1,0,−1,0,1,0,1,0,1,0,−1,0,1,0,1,0,−1,0,1,0,−1,0,1,0,1,0,−1,0,−1,0,1,0,−1,0,−1,0,1,0,−1,0,−1,0,−1,0,1,0,1,0,1,0,1,0,1,0,1,0,1,0,−1,0,−1,0,1,0,1,0,1,0,1,0,−1,0,1,0,1,0,−1,0,1,0,1,0,−1,0,1,0,−1,0,−1,0,1,0,−1,0,1,0,1,0,−1,0,−1,0,−1,0,1,0,−1,0,−1,0,−1,0,−1,0,1,0,1,0,−1,0,1,0,1,0,−1,0,1,0,−1,0,1,0,−1,0,−1,0,1,0,1,0,1,0,1,0,−1,0,−1,0,−1,0,−1,0,1,0,−1,0,1,0,−1,0,−1,0,1,0,1,0,−1,0,1,0,−1,0,1,0,1,0,−1,0,1,0,−1,0,−1,0,−1,0,−1,0,−1,0,1,0,−1,0,1,0,−1,0,−1,0,−1,0,−1,0,1,0,−1,0,−1,0,1,0,1,0,1,0,1,0,1,0,−1,0,1,0,1,0,1,0,1,0,1,0,−1,0,1,0,1,0,1,0,1,0,1,0,1,0,−1,0,−1,0,−1,0,−1,0,−1,0,−1,0,1,0,1,0,−1,0,0,0,0,0,0,0,1,0,1,0,1,0,−1,0,−1,0,1,0,1,0,−1,0,1,0,−1,0,−1,0,−1,0,1,0,−1,0,−1,0,1,0,−1,0,1,0,−1,0,1,0,1,0,−1,0,1,0,−1,0,−1,0,1,0,1,0,−1,0,−1,0,−1,0,−1,0,1,0,1,0,−1,0,1,0,−1,0,−1,0,1,0,1,0,−1,0,1,0,−1,0,−1,0,−1,0,1,0,1,0,−1,0,1,0,−1,0,1,0,1,0,1,0,−1,0,−1,0,−1,0,−1,0,1,0,−1,0,1,0,1,0,−1,0,1,0,1,0,1,0,1,0,1,0,−1,0,−1,0,1,0,−1,0,−1,0,1,0,−1,0,1,0,1,0,−1,0,1,0,−1,0,−1,0,1,0,1,0,−1,0,1,0,−1,0,−1,0,1,0,1,0,1,0,1,0,−1,0,−1,0,1,0,1,0,−1,0,1,0,1,0,1,0,−1,0,1,0,−1,0,1,0,−1,0,−1,0,1,0,−1,0,1,0,−1,0,1,0,1,0,1,0,1,0,1,0,−1,0,1,0,−1,0,1,0,1,0,1,0,1,0,−1,0,−1,0,1,0,1,0,1,0,1,0,1,0,1,0,1,0,1,0,1,0,−1,0,−1,0,−1,0,1,0,1,0,−1,0,−1,0,1,0,1,0,1,0,1,0,−1,0,1,0,1,0,−1,0,1,0,−1,0,−1,0,1,0,−1,0,1,0,−1,0,1,0,1,0,1,0,−1,0,−1,0,1,0,−1,0,1,0,−1,0,1,0,1,0,1,0,1,0,1,0,−1,0,1,0,−1,0,1,0,−1,0,1,0,1,0,1,0,1,0,1,0,1,0,−1,0,−1,0,1,0,−1,0,−1,0,1,0,1,0,1,0,1,0,1,0,1,0,−1,0,1,0,1,0,−1,0,−1,0,1,0,1,0,1,0,−1,0,1,0,1,0,1,0,1,0,−1,0,−1,0,−1,0,1,0,−1,0,1,0,−1,0,−1,0,1,0,−1,0,1,0,1,0,−1,0,1,0,1,0,1,0,1,0,1,0,1,0,−1,0,−1,0,1,0,−1,0,1,0,1,0,−1,0,1,0,1,0,1,0,1,0,1,0,1,0,−1,0,−1,0,1,0,1,0,1,0,−1,0,−1,0,−1,0,1,0,1,0,1,0,−1,0,1,0,1,0,−1,0,1,0,0,0,0,0,0,0,0,0,0,0,0,0,0,0,0,0,0,0,0,0,0,0,1,0,1,0,1,0,−1,0,1,0,1,0,−1,0,1,0,−1,0,−1,0,−1,0,1,0,1,0,−1,0,1,0,−1,0,1,0,1,0,−1,0,1,0,−1,0,−1,0,−1,0,−1,0,1,0,1,0,1,0,−1,0,−1,0,−1,0,1,0,1,0,1,0,1,0,−1,0,−1,0,1,0,1,0,1,0,−1,0,−1,0,−1,0,−1,0,1,0,1,0,1,0,1,0,1,0,1,0,1,0,1,0,1,0,1,0,1,0,1,0,1,0,1,0,1,0,1,0,1,0,−1,0,1,0,1,0,1,0,−1,0,1,0,−1,0,1,0,1,0,−1,0,1,0,1,0,−1,0,1,0,−1,0,−1,0,−1,0,−1,0,1,0,−1,0,−1,0,−1,0,1,0,1,0,1,0,−1,0,−1,0,−1,0,1,0,1,0,1,0,1,0,1,0,1,0,−1,0,1,0,1,0,1,0,1,0,−1,0,1,0,1,0,1,0,1,0,1,0,1,0,−1,0,1,0,−1,0,1,0,1,0,−1,0,1,0,1,0,1,0,1,0,−1,0,1,0,1,0,1,0,−1,0,1,0,1,0,1,0,1,0,1,0,−1,0,−1,0,1,0,−1,0,1,0,−1,0,−1,0,−1,0,1,0,1,0,1,0,1,0,−1,0,1,0,1,0,−1,0,−1,0,−1,0,1,0,1,0,−1,0,1,0,−1,0,1,0,1,0,1,0,1,0,−1,0,1,0,1,0,1,0,−1,0,−1,0,−1,0,−1,0,1,0,−1,0,−1,0,−1,0,1,0,−1,0,1,0,1,0,−1,0,1,0,−1,0,−1,0,−1,0,−1,0,1,0,1,0,1,0,1,0,1,0,1,0,1,0,−1,0,−1,0,−1,0,1,0,1,0,1,0,−1,0,1,0,−1,0,−1,0,−1,0,1,0,1,0,−1,0,−1,0,1,0,−1,0,1,0,1,0,1,0,1,0,1,0,−1,0,1,0,1,0,1,0,1,0,1,0,1,0,1,0,1,0,1,0,−1,0,−1,0,1,0,−1,0,−1,0,−1,0,1,0,−1,0,−1,0,1,0,1,0,1,0,1,0,−1,0,−1,0,−1,0,1,0,1,0,−1,0,1,0,1,0,−1,0,1,0,1,0,−1,0,1,0,1,0,1,0,1,0,1,0,−1,0,1,0,1,0,1,0,1,0,0,0,0,0,0,0,1,0,1,0,1,0,1,0,−1,0,−1,0,1,0,1,0,−1,0,1,0,−1,0,1,0,1,0,−1,0,1,0,1,0,−1,0,−1,0,−1,0,1,0,1,0,1,0,−1,0,−1,0,1,0,−1,0,1,0,1,0,−1,0,1,0,1,0,1,0,1,0,1,0,−1,0,1,0,1,0,1,0,−1,0,−1,0,1,0,1,0,1,0,−1,0,1,0,−1,0,−1,0,1,0,−1,0,1,0,1,0,−1,0,−1,0,−1,0,1,0,−1,0,1,0,1,0,1,0,1,0,1,0,1,0,1,0,1,0,1,0,−1,0,1,0,1,0,−1,0,1,0,−1,0,−1,0,1,0,1,0,−1,0,1,0,−1,0,1,0,1,0,1,0,1,0,−1,0,1,0,−1,0,1,0,−1,0,−1,0,1,0,−1,0,−1,0,−1,0,1,0,1,0,1,0,−1,0,−1,0,1,0,−1,0,−1,0,1,0,−1,0,−1,0,1,0,1,0,1,0,1,0,1,0,−1,0,1,0,1,0,−1,0,−1,0,1,0,1,0,1,0,1,0,−1,0,1,0,1,0,−1,0,−1,0,1,0,1,0,1,0,1,0,−1,0,1,0,1,0,1,0,1,0,1,0,−1,0,−1,0,1,0,−1,0,1,0,1,0,−1,0,1,0,1,0,−1,0,−1,0,−1,0,−1,0,−1,0,1,0,−1,0,−1,0,1,0,1,0,−1,0,−1,0,−1,0,−1,0,−1,0,−1,0,1,0,1,0,1,0,1,0,1,0,−1,0,1,0,1,0,−1,0,1,0,−1,0,1,0,1,0,1,0,1,0,1,0,1,0,−1,0,−1,0,−1,0,1,0,−1,0,1,0,−1,0,1,0,1,0,1,0,1,0,−1,0,−1,0,1,0,1,0,1,0,1,0,−1,0,−1,0,−1,0,−1,0,1,0,1,0,−1,0,−1,0,−1,0,1,0,1,0,1,0,1,0,−1,0,−1,0,−1,0,−1,0,1,0,−1,0,1,0,1,0,1,0,1,0,−1,0,1,0,−1,0,−1,0,−1,0,−1,0,1,0,1,0,−1,0,1,0,1,0,1,0,−1,0,−1,0,1,0,−1,0,−1,0,1,0,1,0,1,0,1,0,1,0,1,0,1,0,1,0,−1,0,1,0,−1,0,1,0,−1,0,−1,0,−1,0,−1,0,1,0,1,0,1,0,0,0,0,0,0,0,0,0,0,0}

For 160 MHz transmission, the N-TF sequence with the format of an HELTF2X160, optimized for estimation order P=10, is given by:

N-TF(HELTF2X160,P=10)=sqrt(2048/996)·{0,0,0,0,0,0,0,0,0,0,0,0,1,0,−1,0,1,0,1,0,−1,0,−1,0,−1,0,1,0,1,0,1,0,1,0,−1,0,1,0,1,0,−1,0,−1,0,1,0,1,0,−1,0,1,0,1,0,−1,0,−1,0,−1,0,−1,0,1,0,1,0,−1,0,1,0,−1,0,1,0,−1,0,1,0,−1,0,1,0,1,0,−1,0,1,0,−1,0,1,0,−1,0,−1,0,1,0,1,0,1,0,−1,0,1,0,−1,0,−1,0,1,0,1,0,−1,0,1,0,1,0,1,0,−1,0,−1,0,−1,0,1,0,1,0,−1,0,1,0,1,0,−1,0,−1,0,1,0,−1,0,−1,0,−1,0,1,0,−1,0,1,0,1,0,−1,0,−1,0,1,0,1,0,1,0,−1,0,−1,0,−1,0,−1,0,−1,0,−1,0,−1,0,−1,0,−1,0,−1,0,1,0,1,0,−1,0,1,0,1,0,1,0,1,0,−1,0,−1,0,−1,0,−1,0,−1,0,−1,0,−1,0,−1,0,−1,0,1,0,1,0,−1,0,−1,0,−1,0,1,0,1,0,−1,0,−1,0,−1,0,−1,0,1,0,1,0,−1,0,−1,0,1,0,−1,0,1,0,−1,0,1,0,−1,0,−1,0,1,0,1,0,−1,0,1,0,−1,0,1,0,−1,0,−1,0,1,0,−1,0,1,0,−1,0,1,0,−1,0,−1,0,−1,0,−1,0,1,0,−1,0,1,0,1,0,1,0,−1,0,1,0,1,0,−1,0,−1,0,−1,0,1,0,1,0,−1,0,−1,0,−1,0,1,0,1,0,1,0,−1,0,1,0,1,0,−1,0,−1,0,−1,0,1,0,1,0,−1,0,−1,0,1,0,1,0,−1,0,1,0,1,0,−1,0,1,0,1,0,−1,0,1,0,−1,0,−1,0,1,0,1,0,−1,0,−1,0,−1,0,−1,0,1,0,1,0,1,0,1,0,−1,0,1,0,1,0,1,0,−1,0,1,0,−1,0,−1,0,1,0,−1,0,−1,0,1,0,1,0,−1,0,1,0,1,0,−1,0,−1,0,1,0,1,0,1,0,−1,0,−1,0,−1,0,1,0,−1,0,−1,0,1,0,1,0,1,0,1,0,−1,0,−1,0,1,0,1,0,1,0,−1,0,1,0,1,0,−1,0,−1,0,1,0,−1,0,1,0,1,0,−1,0,1,0,1,0,1,0,−1,0,1,0,1,0,−1,0,1,0,−1,0,0,0,0,0,0,0,−1,0,1,0,1,0,−1,0,−1,0,1,0,−1,0,−1,0,1,0,−1,0,−1,0,−1,0,−1,0,1,0,−1,0,−1,0,−1,0,−1,0,−1,0,1,0,−1,0,1,0,−1,0,1,0,−1,0,1,0,−1,0,1,0,1,0,1,0,−1,0,1,0,−1,0,−1,0,1,0,1,0,−1,0,−1,0,1,0,−1,0,−1,0,−1,0,−1,0,−1,0,1,0,1,0,−1,0,1,0,−1,0,−1,0,1,0,1,0,−1,0,−1,0,1,0,1,0,−1,0,1,0,1,0,−1,0,1,0,−1,0,−1,0,−1,0,1,0,−1,0,−1,0,1,0,−1,0,−1,0,1,0,1,0,−1,0,−1,0,1,0,1,0,−1,0,−1,0,−1,0,−1,0,1,0,−1,0,−1,0,−1,0,1,0,−1,0,1,0,−1,0,−1,0,−1,0,−1,0,−1,0,−1,0,1,0,1,0,−1,0,−1,0,1,0,−1,0,−1,0,1,0,−1,0,−1,0,−1,0,1,0,1,0,1,0,−1,0,−1,0,1,0,−1,0,−1,0,1,0,−1,0,1,0,1,0,−1,0,1,0,1,0,1,0,−1,0,−1,0,−1,0,−1,0,1,0,−1,0,−1,0,1,0,−1,0,1,0,1,0,−1,0,1,0,1,0,1,0,−1,0,1,0,1,0,−1,0,1,0,−1,0,1,0,1,0,1,0,−1,0,1,0,1,0,1,0,−1,0,−1,0,1,0,1,0,−1,0,−1,0,−1,0,1,0,−1,0,−1,0,−1,0,1,0,−1,0,1,0,−1,0,−1,0,−1,0,−1,0,1,0,−1,0,1,0,−1,0,−1,0,1,0,−1,0,1,0,−1,0,−1,0,−1,0,−1,0,1,0,−1,0,1,0,−1,0,−1,0,−1,0,1,0,−1,0,1,0,−1,0,−1,0,1,0,−1,0,−1,0,1,0,1,0,−1,0,−1,0,1,0,−1,0,−1,0,−1,0,−1,0,1,0,−1,0,−1,0,−1,0,1,0,−1,0,−1,0,1,0,−1,0,−1,0,1,0,−1,0,−1,0,−1,0,1,0,−1,0,1,0,−1,0,−1,0,−1,0,−1,0,1,0,1,0,1,0,−1,0,−1,0,1,0,1,0,−1,0,−1,0,1,0,−1,0,−1,0,−1,0,−1,0,−1,0,1,0,1,0,−1,0,1,0,−1,0,−1,0,1,0,−1,0,−1,0,−1,0,1,0,−1,0,0,0,0,0,0,0,0,0,0,0,0,0,0,0,0,0,0,0,0,0,0,0,−1,0,1,0,−1,0,1,0,−1,0,−1,0,1,0,−1,0,1,0,1,0,−1,0,−1,0,−1,0,1,0,1,0,−1,0,1,0,−1,0,−1,0,1,0,−1,0,1,0,1,0,1,0,−1,0,−1,0,−1,0,−1,0,−1,0,1,0,−1,0,−1,0,1,0,1,0,−1,0,1,0,−1,0,−1,0,−1,0,−1,0,−1,0,1,0,1,0,1,0,1,0,1,0,−1,0,1,0,1,0,1,0,1,0,−1,0,−1,0,−1,0,1,0,−1,0,−1,0,−1,0,−1,0,1,0,1,0,−1,0,1,0,−1,0,−1,0,−1,0,−1,0,−1,0,1,0,−1,0,1,0,1,0,1,0,−1,0,−1,0,1,0,1,0,1,0,−1,0,1,0,−1,0,1,0,1,0,1,0,1,0,1,0,1,0,−1,0,1,0,1,0,−1,0,1,0,1,0,1,0,1,0,1,0,1,0,1,0,1,0,−1,0,−1,0,1,0,1,0,−1,0,1,0,1,0,−1,0,1,0,−1,0,−1,0,1,0,−1,0,−1,0,1,0,1,0,−1,0,−1,0,1,0,−1,0,−1,0,1,0,1,0,−1,0,1,0,−1,0,1,0,−1,0,−1,0,−1,0,1,0,−1,0,−1,0,1,0,−1,0,1,0,1,0,1,0,1,0,1,0,1,0,−1,0,−1,0,1,0,−1,0,1,0,−1,0,1,0,−1,0,1,0,−1,0,−1,0,−1,0,−1,0,−1,0,−1,0,−1,0,−1,0,−1,0,−1,0,1,0,1,0,−1,0,−1,0,1,0,−1,0,−1,0,1,0,1,0,−1,0,1,0,−1,0,1,0,−1,0,−1,0,−1,0,−1,0,1,0,−1,0,−1,0,1,0,1,0,−1,0,−1,0,−1,0,1,0,1,0,1,0,−1,0,1,0,1,0,−1,0,−1,0,1,0,−1,0,−1,0,1,0,−1,0,1,0,1,0,−1,0,−1,0,−1,0,1,0,−1,0,−1,0,1,0,1,0,−1,0,1,0,−1,0,−1,0,−1,0,−1,0,1,0,−1,0,1,0,−1,0,−1,0,−1,0,−1,0,−1,0,1,0,−1,0,−1,0,1,0,−1,0,−1,0,−1,0,−1,0,1,0,−1,0,−1,0,−1,0,−1,0,−1,0,1,0,−1,0,−1,0,−1,0,−1,0,1,0,1,0,1,0,−1,0,−1,0,1,0,−1,0,1,0,1,0,0,0,0,0,0,0,−1,0,−1,0,1,0,−1,0,1,0,1,0,−1,0,−1,0,1,0,−1,0,1,0,1,0,−1,0,−1,0,1,0,−1,0,1,0,1,0,−1,0,1,0,−1,0,−1,0,−1,0,1,0,−1,0,1,0,1,0,1,0,1,0,−1,0,1,0,1,0,−1,0,−1,0,1,0,−1,0,−1,0,1,0,−1,0,1,0,−1,0,1,0,−1,0,−1,0,1,0,1,0,−1,0,−1,0,−1,0,1,0,1,0,−1,0,1,0,−1,0,−1,0,−1,0,−1,0,1,0,−1,0,−1,0,1,0,1,0,−1,0,−1,0,1,0,−1,0,−1,0,1,0,1,0,−1,0,1,0,−1,0,−1,0,−1,0,−1,0,−1,0,1,0,−1,0,1,0,−1,0,1,0,−1,0,−1,0,−1,0,1,0,1,0,−1,0,−1,0,1,0,1,0,1,0,−1,0,−1,0,−1,0,1,0,−1,0,−1,0,−1,0,1,0,1,0,−1,0,1,0,−1,0,1,0,1,0,−1,0,1,0,1,0,1,0,1,0,1,0,−1,0,−1,0,−1,0,−1,0,1,0,−1,0,−1,0,−1,0,1,0,−1,0,−1,0,1,0,−1,0,1,0,−1,0,−1,0,−1,0,−1,0,−1,0,−1,0,1,0,−1,0,−1,0,−1,0,−1,0,1,0,1,0,−1,0,1,0,−1,0,1,0,1,0,−1,0,−1,0,1,0,1,0,1,0,1,0,1,0,−1,0,1,0,1,0,−1,0,−1,0,−1,0,−1,0,1,0,−1,0,−1,0,1,0,1,0,−1,0,−1,0,−1,0,−1,0,−1,0,1,0,1,0,−1,0,−1,0,−1,0,−1,0,−1,0,−1,0,1,0,−1,0,−1,0,1,0,−1,0,−1,0,1,0,−1,0,−1,0,1,0,−1,0,1,0,1,0,1,0,−1,0,1,0,1,0,−1,0,1,0,1,0,−1,0,−1,0,−1,0,1,0,1,0,1,0,1,0,1,0,1,0,−1,0,1,0,−1,0,1,0,−1,0,−1,0,1,0,1,0,−1,0,−1,0,1,0,1,0,1,0,1,0,1,0,−1,0,−1,0,1,0,−1,0,1,0,−1,0,−1,0,1,0,1,0,−1,0,−1,0,−1,0,−1,0,1,0,1,0,1,0,1,0,1,0,1,0,1,0,−1,0,1,0,1,0,−1,0,1,0,1,0,1,0,−1,0,−1,0,1,0,0,0,0,0,0,0,0,0,0,0}

### List24

For 160 MHz transmission, the N-TF sequence with the format of an HELTF160, optimized for estimation order P=3, is given by:

N-TF(HELTF160,P=3)=sqrt(2048/1992)·{0,0,0,0,0,0,0,0,0,0,0,0,1,−1,1,1,−1,1,−1,1,−1,−1,−1,1,−1,−1,−1,−1,−1,1,1,1,−1,−1,1,−1,1,1,−1,1,−1,1,1,1,1,1,1,−1,−1,1,−1,1,−1,−1,1,−1,1,−1,−1,1,−1,1,1,−1,−1,−1,−1,1,−1,−1,1,1,−1,1,1,1,1,1,1,−1,−1,−1,1,−1,1,1,1,1,−1,1,−1,1,1,1,−1,1,−1,1,−1,1,1,−1,−1,−1,−1,−1,1,1,1,1,1,−1,1,1,1,1,−1,1,−1,1,−1,−1,−1,1,−1,1,1,1,−1,1,−1,−1,−1,−1,−1,−1,−1,−1,−1,−1,−1,−1,−1,−1,1,1,−1,−1,1,1,−1,1,1,1,1,−1,1,−1,−1,1,−1,−1,−1,1,1,1,−1,−1,−1,1,1,−1,−1,−1,−1,1,−1,−1,1,1,−1,1,1,−1,−1,−1,1,−1,−1,−1,−1,−1,−1,1,−1,−1,1,−1,−1,1,−1,1,−1,1,−1,−1,−1,1,1,1,−1,1,−1,1,−1,1,−1,−1,1,−1,1,1,1,1,1,−1,1,1,−1,1,−1,−1,−1,1,1,1,−1,−1,−1,−1,−1,−1,−1,1,1,1,1,1,−1,1,1,1,1,−1,−1,1,−1,1,1,−1,−1,−1,−1,−1,−1,1,−1,−1,1,1,−1,−1,−1,−1,−1,−1,−1,−1,1,1,1,1,−1,−1,−1,1,−1,−1,−1,1,1,1,−1,−1,1,−1,−1,−1,−1,1,1,−1,1,−1,1,1,−1,−1,−1,1,1,1,1,−1,1,1,1,−1,−1,1,−1,1,1,−1,1,−1,1,1,−1,1,1,−1,1,1,1,−1,−1,−1,−1,−1,1,−1,−1,1,1,−1,−1,−1,1,1,1,1,1,1,1,−1,−1,−1,1,1,−1,−1,1,1,1,1,1,1,1,1,1,−1,−1,−1,1,1,−1,1,−1,−1,1,1,1,1,1,1,1,1,1,−1,1,−1,1,−1,1,−1,−1,1,−1,−1,1,1,−1,1,−1,1,1,1,1,1,1,−1,1,−1,1,−1,1,−1,−1,1,−1,1,1,−1,−1,1,1,−1,−1,1,1,−1,1,1,−1,1,−1,1,−1,−1,−1,1,−1,−1,1,1,1,1,1,−1,−1,−1,1,−1,1,1,1,1,1,1,1,1,1,1,−1,−1,−1,−1,1,1,1,−1,1,1,1,−1,1,−1,1,−1,1,−1,−1,1,1,1,−1,1,1,1,1,1,1,1,1,1,1,−1,1,1,1,−1,1,−1,−1,1,−1,−1,1,−1,0,0,0,0,0,1,1,−1,−1,−1,1,−1,1,−1,1,1,−1,−1,1,1,1,−1,−1,1,−1,1,1,−1,1,−1,−1,1,−1,−1,1,1,1,−1,−1,1,−1,−1,−1,1,−1,−1,1,1,1,−1,1,1,1,−1,1,−1,1,1,1,1,1,1,1,−1,−1,1,−1,−1,−1,−1,1,−1,−1,1,−1,−1,1,−1,1,1,1,1,1,−1,−1,1,1,1,−1,−1,1,−1,1,1,−1,−1,−1,−1,−1,−1,1,1,−1,1,1,1,1,1,−1,1,−1,−1,−1,−1,−1,−1,1,1,1,−1,1,−1,−1,−1,−1,−1,1,1,−1,1,1,−1,−1,1,−1,1,1,−1,−1,−1,1,1,1,1,−1,−1,1,1,1,−1,−1,1,1,1,1,1,−1,1,1,−1,1,1,1,−1,−1,−1,−1,1,−1,−1,−1,−1,−1,1,−1,−1,1,−1,−1,−1,−1,−1,1,1,1,1,1,−1,−1,−1,−1,1,−1,1,−1,1,−1,1,1,1,1,1,1,−1,−1,1,1,1,−1,−1,−1,−1,−1,−1,−1,−1,−1,1,1,1,1,1,−1,−1,1,−1,−1,1,1,1,1,1,−1,−1,1,−1,−1,−1,−1,1,1,1,−1,−1,1,−1,−1,1,−1,−1,−1,1,1,−1,−1,1,−1,−1,−1,−1,1,1,−1,1,1,1,1,−1,−1,−1,1,1,1,−1,−1,−1,1,−1,−1,1,−1,−1,1,−1,1,−1,−1,−1,1,−1,−1,−1,1,−1,1,1,1,1,1,1,−1,1,1,−1,1,−1,1,1,1,1,1,−1,1,−1,1,1,1,−1,−1,1,1,−1,−1,−1,1,−1,−1,−1,−1,−1,1,1,−1,1,−1,−1,1,1,1,1,−1,−1,1,1,−1,−1,−1,1,−1,1,−1,−1,1,−1,−1,1,−1,−1,1,−1,1,−1,1,−1,−1,−1,−1,−1,1,−1,−1,1,−1,−1,1,1,1,1,1,−1,1,−1,1,−1,−1,−1,−1,−1,−1,−1,1,1,1,−1,1,−1,−1,1,1,−1,1,−1,1,1,1,1,−1,1,1,1,1,−1,−1,1,1,−1,1,−1,1,−1,1,−1,1,1,−1,1,−1,1,1,1,1,1,1,1,−1,1,1,−1,1,1,1,1,1,1,1,1,1,1,−1,−1,−1,1,1,1,1,−1,−1,−1,1,1,−1,−1,1,1,1,−1,1,−1,1,1,−1,1,−1,1,1,1,1,1,−1,−1,1,1,1,−1,1,1,1,−1,1,−1,−1,1,1,−1,−1,−1,−1,1,1,1,−1,1,1,0,0,0,0,0,0,0,0,0,0,0,0,0,0,0,0,0,0,0,0,0,0,0,−1,−1,−1,1,1,−1,1,1,1,−1,−1,1,−1,1,−1,1,1,1,1,−1,−1,1,−1,−1,−1,−1,1,1,1,1,1,1,1,1,1,−1,−1,−1,−1,−1,1,−1,−1,1,−1,1,1,1,−1,1,−1,1,−1,−1,1,−1,1,−1,−1,1,−1,1,1,1,1,1,−1,1,−1,1,−1,1,−1,1,1,−1,1,−1,−1,−1,−1,1,−1,1,1,1,−1,1,−1,−1,1,−1,1,−1,1,−1,−1,1,−1,1,−1,1,1,−1,1,−1,−1,−1,1,1,1,−1,1,1,−1,−1,−1,1,1,1,−1,−1,−1,1,−1,−1,1,−1,−1,1,−1,−1,1,1,1,−1,−1,1,1,1,−1,1,1,1,1,1,1,1,1,−1,−1,1,−1,−1,−1,−1,−1,−1,1,1,−1,−1,1,−1,−1,−1,−1,1,−1,−1,−1,1,−1,−1,−1,−1,1,−1,1,1,1,−1,−1,1,1,−1,1,1,−1,1,−1,−1,−1,−1,−1,1,1,1,−1,−1,1,−1,−1,−1,−1,−1,1,1,1,1,−1,1,−1,1,−1,1,1,−1,1,−1,1,1,−1,−1,1,−1,−1,−1,−1,1,−1,1,−1,1,−1,1,−1,−1,1,1,−1,1,1,−1,1,1,1,−1,−1,1,1,1,1,1,1,1,1,−1,1,−1,1,1,−1,1,1,−1,1,1,−1,−1,1,1,1,1,−1,−1,−1,1,1,−1,−1,−1,−1,1,1,1,1,−1,1,1,1,1,1,1,1,1,1,1,1,−1,−1,−1,−1,−1,1,−1,1,−1,1,1,1,1,1,1,−1,−1,1,1,1,1,1,1,1,1,−1,1,1,1,1,−1,1,1,1,1,−1,1,1,1,−1,−1,−1,1,−1,1,1,−1,1,1,1,−1,1,−1,1,1,1,−1,−1,−1,1,−1,−1,−1,1,1,1, 1, 1,1,1,1,−1,−1,1,−1,1,−1,1,−1,1,1,−1,−1,−1,1,1,−1,1,1,−1,1,−1,1,−1,1,−1,−1,1,1,−1,1,1,−1,1,1,1,−1,−1,−1,1,1,1,−1,1,1,1,1,−1,1,−1,−1,1,1,1,1,−1,1,−1,−1,−1,1,1,−1,1,1,1,1,1,−1,1,−1,−1,1,1,−1,1,1,1,−1,−1,−1,1,−1,−1,−1,1,−1,1,1,1,−1,−1,−1,1,1,−1,−1,1,1,−1,1,−1,1,1,1,1,1,−1,1,1,−1,1,−1,−1,1,−1,−1,1,1,−1,1,1,−1,−1,1,1,1,−1,−1,0,0,0,0,0,1,1,1,1,−1,−1,1,−1,1,−1,1,−1,1,1,−1,1,−1,−1,1,1,−1,1,1,1,1,1,−1,1,−1,−1,1,1,1,−1,−1,1,1,1,−1,−1,−1,−1,1,1,1,1,1,1,1,−1,−1,1,−1,−1,−1,−1,1,1,1,−1,1,1,−1,−1,−1,−1,−1,1,1,1,−1,1,1,1,−1,−1,1,−1,1,1,1,1,1,−1,−1,1,1,1,1,1,1,−1,−1,−1,−1,−1,1,−1,−1,1,1,1,−1,1,1,1,1,1,−1,−1,1,1,−1,1,1,−1,1,−1,1,−1,−1,1,−1,−1,1,1,−1,1,−1,1,1,1,1,−1,1,1,1,−1,1,−1,−1,1,1,1,−1,1,1,−1,−1,−1,−1,−1,1,1,1,−1,−1,1,1,−1,−1,1,−1,−1,1,−1,1,1,1,−1,−1,1,−1,−1,−1,1,−1,−1,1,−1,1,1,−1,1,−1,−1,1,1,1,1,−1,1,−1,−1,−1,−1,−1,1,−1,1,−1,−1,−1,−1,1,−1,−1,−1,1,1,1,1,1,−1,−1,−1,1,1,−1,−1,−1,1,1,1,−1,1,1,−1,1,−1,1,−1,1,1,−1,1,1,1,1,−1,1,1,−1,1,1,−1,1,−1,−1,−1,−1,−1,1,−1,−1,1,1,−1,−1,−1,1,−1,1,−1,1,1,1,1,1,−1,−1,−1,−1,−1,−1,−1,1,−1,1,−1,−1,−1,−1,1,−1,−1,1,−1,1,−1,1,−1,−1,1,−1,−1,−1,−1,−1,1,−1,1,1,1,1,1,1,−1,1,−1,−1,−1,−1,1,1,−1,−1,1,1,−1,−1,1,1,1,−1,1,−1,1,−1,1,−1,1,−1,−1,1,1,1,−1,1,1,−1,−1,−1,1,−1,1,−1,−1,1,−1,1,−1,−1,−1,−1,−1,1,−1,1,1,1,−1,1,1,−1,−1,1,1,−1,1,−1,1,−1,1,−1,1,−1,−1,1,1,−1,−1,1,1,−1,1,−1,1,1,−1,−1,1,−1,−1,−1,1,1,1,1,−1,−1,1,−1,−1,1,1,−1,1,−1,1,−1,−1,−1,1,1,1,1,1,−1,1,−1,1,−1,−1,1,1,1,−1,−1,1,1,1,−1,1,−1,−1,1,1,−1,1,1,1,1,1,−1,1,1,1,1,1,1,1,1,−1,1,−1,1,1,1,1,−1,1,−1,−1,−1,−1,−1,−1,1,−1,−1,1,−1,1,−1,1,−1,−1,1,1,−1,−1,1,−1,−1,1,−1,1,1,1,−1,1,1,1,1,1,1,1,0,0,0,0,0,0,0,0,0,0,0}

For 160 MHz transmission, the N-TF sequence with the format of an HELTF160, optimized for estimation order P=4, is given by:

N-TF(HELTF160,P=4)=sqrt(2048/1992) {0,0,0,0,0,0,0,0,0,0,0,0,−1,−1,1,−1,1,−1,1,−1,−1,−1,−1,1,−1,−1,1,1,−1,−1,−1,−1,−1,−1,−1,1,−1,1,1,−1,−1,1,1,−1,−1,1,−1,−1,−1,1,−1,−1,1,1,−1,1,1,1,−1,−1,−1,1,1,−1,−1,1,−1,1,1,−1,1,−1,1,−1,1,1,1,−1,1,−1,−1,1,−1,−1,−1,−1,1,−1,−1,1,−1,−1,−1,−1,−1,1,−1,1,1,−1,1,1,1,−1,1,1,1,−1,1,−1,−1,−1,1,−1,1,1,1,−1,1,−1,1,1,1,−1,1,1,−1,1,1,−1,1,−1,1,−1,−1,−1,1,−1,−1,−1,1,−1,−1,1,1,−1,−1,−1,1,1,−1,−1,−1,−1,−1,1,−1,−1,−1,−1,−1,−1,−1,−1,1,1,1,−1,−1,1,−1,1,−1,−1,−1,1,−1,−1,−1,1,−1,1,−1,1,−1,−1,1,−1,1,−1,−1,1,−1,−1,−1,−1,−1,1,−1,1,1,−1,1,1,1,1,−1,1,−1,−1,−1,1,1,1,1,1,−1,−1,−1,−1,−1,−1,−1,−1,1,1,−1,1,−1,−1,−1,−1,1,−1,1,−1,1,1,−1,−1,−1,−1,1,−1,−1,−1,1,−1,−1,−1,1,−1,1,1,−1,1,−1,−1,−1,−1,−1,−1,1,−1,−1,1,1,−1,−1,−1,1,−1,1,−1,−1,1,−1,1,−1,1,1,−1,1,1,1,−1,1,−1,−1,1,1,−1,1,−1,−1,1,1,−1,−1,1,−1,−1,−1,−1,1,1,1,1,−1,−1,1,−1,−1,−1,1,1,1,−1,−1,1,1,−1,−1,1,−1,−1,1,−1,1,−1,−1,1,−1,−1,−1,−1,1,1,1,−1,−1,−1,−1,−1,1,−1,1,1,1,−1,−1,1,−1,−1,−1,1,−1,−1,1,1,−1,1,1,1,1,1,1,−1,−1,1,1,−1,1,−1,−1,1,1,1,1,−1,−1,1,−1,1,1,1,−1,−1,−1,1,−1,1,−1,1,1,1,−1,−1,1,−1,1,−1,−1,1,−1,1,−1,−1,−1,1,−1,1,1,1,1,−1,−1,−1,1,1,−1,1,−1,−1,−1,1,−1,1,−1,1,1,−1,−1,−1,1,−1,−1,−1,1,−1,−1,−1,−1,1,1,−1,−1,1,1,−1,−1,−1,1,−1,1,−1,1,−1,1,−1,−1,−1,1,−1,1,1,1,−1,1,−1,1,1,−1,−1,1,−1,1,−1,1,−1,−1,−1,1,1,1,1,−1,−1,−1,−1,−1,−1,−1,1,−1,1,−1,1,1,1,−1,−1,1,−1,−1,1,−1,−1,1,1,0,0,0,0,0,1,1,1,−1,1,1,1,−1,−1,−1,1,−1,1,−1,−1,1,−1,1,1,−1,1,−1,−1,−1,1,−1,1,−1,−1,−1,1,−1,−1,1,−1,−1,−1,1,1,−1,1,1,1,−1,−1,−1,1,−1,−1,−1,1,−1,−1,−1,1,1,1,1,−1,1,1,1,−1,1,−1,1,−1,1,−1,1,1,1,1,−1,−1,−1,−1,1,−1,−1,1,1,1,−1,−1,−1,−1,−1,1,−1,1,1,−1,−1,1,1,1,1,1,1,−1,−1,−1,−1,−1,−1,−1,1,−1,−1,1,1,−1,−1,−1,−1,−1,−1,1,1,−1,1,1,−1,−1,−1,1,1,−1,1,1,−1,−1,1,1,1,1,1,1,−1,−1,−1,1,−1,−1,−1,−1,1,1,−1,−1,−1,−1,−1,−1,−1,1,1,1,1,−1,1,1,−1,1,1,−1,1,1,−1,1,1,−1,1,−1,−1,1,−1,−1,−1,−1,1,1,−1,−1,−1,−1,−1,−1,−1,−1,1,1,1,1,1,−1,−1,−1,1, 1,1,1,1,−1,1,−1,−1,1,−1,1,1,−1,1,−1,−1,−1,1,1,1,−1,1,1,1,−1,−1,−1,−1,1,−1,1,−1,1,1,1,1,1,−1,1,1,1,−1,1,−1,−1,1,−1,−1,1,1,1,−1,1,−1,1,−1,1,1,1,1,1,1,−1,−1,−1,−1,−1,1,−1,−1,1,−1,1,−1,−1,−1,1,1,1,−1,−1,1,1,−1,−1,1,−1,1,−1,1,1,−1,1,−1,−1,−1,1,1,1,1,−1,1,1,−1,−1,−1,1,−1,1,−1,1,−1,−1,−1,−1,1,−1,−1,−1,−1,1,1,−1,−1,1,1,−1,1,−1,1,1,−1,1,1,−1,−1,1,−1,1,1,1,1,1,−1,1,−1,−1,1,1,1,−1,−1,−1,1,1,−1,1,1,−1,1,1,1,1,−1,−1,−1,−1,1,1,−1,1,1,−1,1,−1,−1,−1,1,−1,1,1,1,1,−1,1,−1,−1,1,−1,1,1,−1,1,1,1,−1,1,−1,1,1,1,1,−1,1,−1,1,−1,−1,1,1,1,1,−1,−1,1,−1,−1,−1,−1,1,1,1,−1,1,1,−1,1,−1,1,1,1,−1,−1,−1,1,−1,1,−1,1,−1,1,−1,−1,1,−1,−1,−1,1,1,−1,−1,1,−1,−1,1, 1,1,1,1,−1,−1,1,1,1,1,1,−1,1,1,−1,−1,−1,−1,−1,−1,−1,1,1,1,−1,1,−1,−1,−1,1,−1,1,1,−1,1,1,1,1,1,1,1,1,1,0,0,0,0,0,0,0,0,0,0,0,0,0,0,0,0,0,0,0,0,0,0,0,1,1,−1,−1,1,1,1,−1,1,−1,1,−1,1,−1,−1,−1,1,−1,−1,−1,−1,−1,−1,−1,−1,−1,−1,1,1,1,−1,1,1,1,−1,1,1,−1,1,−1,1,−1,−1,−1,−1,−1,−1,−1,−1,−1,1,−1,−1,−1,−1,−1,1,1,1,1,1,1,−1,−1,−1,−1,1,1,−1,1,1,1,−1,−1,1,−1,−1,−1,−1,1,−1,1,−1,1,1,1,−1,−1,−1,1,−1,1,−1,−1,1,1,1,−1,1,1,1,−1,1,1,−1,−1,1,−1,1,1,−1,−1,1,−1,1,−1,−1,1,1,1,−1,−1,1,1,−1,−1,−1,1,1,1,1,1,1,−1,1,−1,−1,−1,−1,1,1,1,1,1,−1,−1,−1,−1,1,1,−1,−1,−1,1,1,−1,−1,1,1,−1,1,−1,−1,−1,1,−1,1,−1,−1,−1,−1,1,−1,−1,−1,−1,−1,1,1,−1,1,−1,1,1,1,1,−1,−1,1,−1,1,−1,−1,1,−1,−1,1,−1,1,−1,−1,−1,1,−1,−1,1,−1,1,−1,−1,−1,−1,1,1,−1,−1,1,1,1,−1,1,1,1,−1,−1,−1,−1,−1,1,−1,−1,1,1,1,−1,−1,1,1,−1,−1,−1,−1,1,−1,−1,1,1,1,1,1,−1,−1,1,1,−1,−1,−1,1,1,1,−1,1,1,−1,−1,1,1,1,−1,1,−1,−1,−1,−1,−1,1,1,1,1,1,1,−1,−1,−1,−1,−1,−1,1,−1,1,−1,−1,−1,−1,1,−1,−1,1,−1,1,−1,1,1,1,−1,1,1,1,−1,−1,−1,−1,−1,1,−1,1,−1,1,1,−1,−1,1,−1,−1,−1,−1,−1,−1,−1,−1,−1,−1,−1,1,1,−1,−1,1,−1,1,1,−1,1,1,1,−1,1,−1,1,1,−1,−1,−1,−1,−1,1,1,−1,−1,−1,1,1,−1,1,−1,−1,−1,−1,1,−1,−1,1,1,−1,1,1,−1,1,−1,−1,1,1,1,−1,1,−1,1,−1,1,1,−1,1,1,1,−1,−1,1,−1,1,1,1,−1,1,−1,−1,−1,1,−1,1,1,1,−1,−1,1,1,−1,1,1,1,1,−1,−1,1,−1,−1,−1,1,−1,1,1,1,−1,−1,1,−1,−1,−1,1,−1,1,−1,−1,1,1,1,1,1,1,−1,−1,−1,1,−1,1,1,1,1,1,1,1,−1,1,1,−1,−1,1,−1,1,−1,1,−1,1,1,−1,−1,1,1,1,−1,−1,1,1,1,−1,1,−1,−1,1,−1,1,−1,1,−1,−1,−1,−1,1,1,0,0,0,0,0,−1,−1,1,−1,1,−1,1,−1,1,−1,−1,1,1,−1,−1,−1,−1,1,−1,1,1,1,1,−1,1,1,−1,1,−1,−1,1,−1,−1,−1,−1,1,1,1,−1,−1,1,−1,−1,1,−1,−1,−1,−1,1,−1,1,−1,−1,1,−1,−1,−1,1,1,1,−1,−1,−1,−1,−1,1,1,−1,−1,−1,−1,−1,−1,−1,1,1,−1,1,−1,1,−1,−1,−1,−1,1,1,1,1,1,−1,1,−1,1,1,1,−1,−1,−1,1,−1,−1,1,1,1,−1,1,1,−1,−1,1,−1,1,1,1,−1,−1,1,−1,1,−1,−1,−1,−1,1,1,−1,−1,1,1,1,1,−1,1,−1,1,−1,−1,1,−1,1,1,1,−1,−1,1,−1,1,−1,1,−1,−1,1,1,1,1,−1,1,1,1,−1,−1,1,−1,−1,1,−1,1,−1,1,1,−1,−1,1,−1,−1,−1,1,−1,−1,1,1,−1,−1,−1,−1,−1,1,1,−1,1,−1,−1,−1,1,−1,−1,−1,1,1,−1,−1,1,−1,1,1,1,1,1,1,1,−1,1,−1,−1,1,−1,1,1,1,−1,1,−1,−1,−1,1,1,−1,1,1,1,−1,−1,−1,−1,−1,1,−1,1,−1,−1,−1,1,1,−1,1,−1,1,1,1,1,1,−1,1,−1,−1,−1,−1,−1,−1,1,−1,−1,−1,−1,−1,−1,−1,1,−1,−1,−1,−1,1,1,1,1,−1,−1,1,1,1,−1,1,1,−1,−1,−1,1,1,1,−1,−1,−1,−1,−1,1,1,−1,−1,−1,−1,−1,1,−1,−1,−1,−1,1,−1,−1,−1,−1,1,1,1,1,1,1,1,−1,−1,1,−1,−1,−1,−1,1,1,−1,−1,−1,−1,−1,−1,1,1,−1,−1,1,1,1,1,1,1,−1,−1,1,−1,−1,1,1,−1,−1,1,−1,1,1,1,−1,−1,−1,1,−1,−1,1,−1,1,−1,1,−1,1,−1,1,1,−1,1,−1,1,1,1,1,−1,1,−1,1,−1,−1,−1,1,1,−1,−1,−1,1,1,−1,1,−1,−1,−1,−1,1,−1,1,−1,1,1,1,1,1,−1,−1,−1,1,−1,−1,1,−1,−1,−1,−1,−1,1,1,−1,−1,1,−1,−1,−1,1,1,−1,1,−1,1,1,−1,−1,−1,1,−1,−1,−1,1,−1,1,1,−1,−1,−1,1,1,−1,−1,−1,1,1,−1,−1,1,−1,−1,1,1,1,1,1,1,1,−1,1,−1,1,−1,−1,−1,1,1,−1,−1,−1,−1,−1,1,1,1,−1,1,1,−1,1,−1,1,−1,1,1,1,0,0,0,0,0,0,0,0,0,0,0}

For 160 MHz transmission, the N-TF sequence with the format of an HELTF160, optimized for estimation order P=5, is given by:

N-TF(HELTF160,P=5)=sqrt(2048/1992)·{0,0,0,0,0,0,0,0,0,0,0,0,1,−1,1,1,−1,1,1,1,−1,1,−1,−1,−1,−1,1,−1,1,1,1,−1,−1,1,1,1,1,−1,1,−1,1,1,1,1,1,−1,1,1,−1,1,1,1,−1,1,1,1,−1,−1,1,−1,1,−1,1,−1,1,1,−1,1,−1,1,−1,−1,−1,1,1,−1,1,−1,1,−1,1,−1,1,1,1,1,1,−1,−1,1,−1,−1,1,−1,−1,−1,1,1,−1,1,1,−1,−1,1,−1,−1,−1,1,1,1,−1,1,−1,1,1,−1,−1,−1,1,−1,1,1,−1,1,1,1,1,1,1,−1,−1,−1,−1,1,1,1,−1,1,−1,−1,−1,−1,−1,−1,1,−1,1,−1,1,1,−1,1,−1,−1,−1,−1,−1,1,−1,1,−1,−1,−1,1,1,1,−1,1,1,1,1,1,1,1,−1,−1,1,1,−1,1,1,1,−1,1,−1,−1,−1,1,−1,1,−1,1,1,−1,1,1,−1,−1,1,1,−1,−1,−1,1,−1,1,1,−1,−1,1,−1,1,−1,−1,1,−1,1,1,1,1,−1,1,1,−1,−1,1,−1,−1,−1,1,1,1,1,−1,−1,1,−1,−1,1,1,−1,1,−1,1,−1,1,1,1,−1,1,−1,1,−1,1,−1,−1,−1,1,−1,−1,1,−1,−1,−1,1,−1,1,1,−1,−1,1,1,−1,1,1,1,−1,1,−1,−1,1,−1,−1,−1,1,1,1,1,1,1,−1,1,−1,−1,1,1,−1,−1,1,1,−1,1,1,−1,1,−1,1,−1,1,−1,−1,−1,−1,1,−1,−1,1,−1,1,1,1,−1,−1,−1,1,−1,1,1,1,−1,1,1,1,−1,−1,1,1,−1,1,−1,1,−1,1,−1,1,−1,−1,1,1,1,1,1,1,−1,1,1,1,1,−1,1,1,1,1,−1,1,1,1,1,−1,−1,−1,1,1,1,−1,−1,1,1,1,1,−1,1,1,1,−1,1,1,−1,1,1,1,1,1,1,1,1,−1,−1,−1,1,1,1,−1,−1,1,1,−1,1,−1,1,−1,1,−1,−1,−1,1,−1,1,−1,1,−1,−1,1,−1,−1,−1,−1,1,−1,1,−1,1,1,1,−1,−1,1,−1,−1,−1,−1,1,−1,−1,−1,−1,1,−1,−1,1,1,1,1,1,−1,−1,1,1,1,−1,−1,−1,1,1,−1,1,1,1,−1,−1,−1,1,−1,1,1,1,−1,−1,−1,1,−1,−1,1,1,−1,1,1,1,1,1,1,−1,1,−1,−1,1,−1,1,1,1,−1,−1,1,1,1,1,1,1,1,−1,0,0,0,0,0,−1,1,1,1,1,−1,1,−1,−1,−1,−1,−1,1,−1,1,1,1,1,−1,1,1,1,1,1,1,−1,1,1,1,1,1,−1,−1,1,−1,−1,1,1,1,−1,1,1,1,−1,1,1,1,1,1,1,−1,1,1,1,−1,−1,1,−1,1,−1,1,1,−1,1,1,1,−1,−1,1,−1,−1,1,1,−1,1,−1,1,−1,1,−1,−1,−1,1,1,−1,−1,−1,−1,−1,−1,−1,1,−1,1,1,1,−1,−1,−1,−1,−1,−1,−1,−1,1,1,−1,−1,1,1,−1,1,−1,1,1,−1,1,1,−1,1,1,1,1,1,1,−1,1,−1,1,1,1,−1,1,1,−1,1,1,1,1,−1,−1,−1,1,−1,−1,−1,−1,−1,−1,1,1,−1,−1,−1,1,−1,−1,−1,1,−1,−1,−1,1,1,1,−1,1,−1,−1,1,−1,−1,−1,1,−1,−1,1,−1,−1,1,1,−1,1,1,−1,−1,−1,−1,1,−1,1,1,1,1,1,1,1,1,−1,−1,−1,1,−1,−1,1,1,−1,1,1,1,1,1,1,−1,−1,1,−1,1,1,−1,1,1,−1,1,−1,−1,−1,1,−1,−1,1,1,1,−1,1,1,1,1,1,1,−1,−1,−1,1,−1,−1,1,−1,−1,1,−1,−1,−1,1,1,−1,−1,−1,−1,1,1,1,1,−1,1,−1,−1,−1,1,1,−1,1,−1,1,−1,1,1,−1,−1,−1,−1,1,−1,1,−1,1,−1,−1,−1,−1,−1,1,1,1,1,−1,1,−1,−1,−1,−1,1,−1,−1,−1,1,1,1,−1,1,−1,−1,1,1,−1,1,−1,1,1,1,−1,1,1,−1,1,−1,1,1,−1,1,1,1,1,−1,1,−1,−1,−1,−1,−1,1,−1,−1,−1,1,1,1,−1,1,−1,1,−1,−1,1,1,−1,−1,−1,1,1,−1,1,1,−1,1,−1,−1,1,1,1,−1,−1,1,1,1,1,1,−1,1,−1,1,−1,1,1,1,1,1,1,−1,1,−1,1,1,−1,1,−1,1,−1,−1,−1,1,1,1,1,1,1,1,−1,−1,1,−1,−1,−1,1,−1,1,1,1,−1,−1,−1,−1,−1,1,−1,−1,−1,1,1,−1,−1,−1,1,−1,1,1,1,1,−1,−1,−1,−1,−1,1,1,1,1,−1,−1,−1,1,1,−1,−1,1,−1,−1,−1,1,−1,−1,−1,1,1,1,−1,−1,−1,1,1,−1,1,1,−1,1,1,1,1,−1,−1,1,1,1,1,1,1,1,−1,1,−1,−1,1,1,−1,−1,1,1,1,0,0,0,0,0,0,0,0,0,0,0,0,0,0,0,0,0,0,0,0,0,0,0,1,1,−1,−1,−1,−1,−1,1,−1,−1,1,−1,1,1,1,1,1,1,1,1,−1,1,−1,−1,−1,1,−1,1,1,1,−1,1,1,1,1,−1,−1,−1,−1,1,−1,1,−1,1,−1,−1,−1,−1,−1,1,1,1,1,1,−1,1,1,−1,−1,−1,1,1,−1,1,−1,1,1,−1,−1,1,−1,1,−1,1,1,1,−1,1,−1,1,−1,1,−1,1,−1,1,1,−1,−1,−1,1,1,1,1,−1,−1,−1,1,−1,1,1,−1,−1,−1,−1,1,−1,1,−1,−1,−1,1,−1,−1,1,1,−1,−1,1,1,−1,1,1,1,−1,1,1,1,−1,−1,−1,1,1,1,1,−1,−1,−1,−1,1,1,−1,1,1,1,1,1,−1,1,−1,1,−1,−1,1,1,1,1,−1,1,1,−1,−1,1,−1,1,−1,1,−1,1,−1,1,1,1,−1,1,−1,1,−1,−1,1,−1,−1,1,−1,1,1,1,−1,1,−1,−1,1,−1,1,1,1,1,1,−1,1,1,1,−1,1,−1,−1,−1,1,−1,−1,−1,1,1,1,−1,1,1,1,1,1,−1,−1,−1,−1,−1,1,1,1,−1,1,1,−1,1,1,−1,−1,−1,1,−1,−1,1,−1,1,1,1,1,1,1,−1,−1,1,1,1,1,1,1,−1,1,1,1,1,1,−1,−1,1,−1,−1,−1,1,1,−1,1,1,1,−1,1,1,−1,1,1,1,1,−1,−1,1,−1,−1,−1,1,1,−1,1,−1,−1,−1,−1,−1,1,−1,1,1,1,1,−1,−1,−1,−1,−1,1,1,1,−1,−1,1,−1,1,−1,1,1,1,−1,−1,1,1,−1,1,1,−1,−1,1,1,1,1,−1,−1,−1,1,1,−1,1,−1,−1,1,1,−1,−1,−1,−1,1,1,1,−1,1,−1,1,−1,1,−1,1,1,−1,−1,−1,1,1,1,−1,1,−1,1,1,1,1,−1,−1,1,−1,1,1,1,1,1,−1,1,1,1,1,1,−1,1,1,1,−1,−1,1,−1,1,−1,1,1,−1,1,1,−1,−1,1,−1,1,1,1,1,−1,1,1,1,1,−1,−1,−1,−1,−1,1,−1,1,1,1,1,1,1,−1,1,1,−1,−1,−1,1,1,−1,−1,−1,1,−1,1,1,1,1,−1,−1,−1,1,1,−1,1,−1,1,−1,−1,−1,−1,−1,−1,−1,1,−1,1,1,1,1,1,1,1,1,1,1,−1,−1,−1,−1,−1,−1,−1,1,1,−1,1,1,−1,−1,1,−1,−1,−1,−1,−1,−1,1,1,1,0,0,0,0,0,−1,−1,−1,−1,1,−1,1,−1,−1,−1,1,−1,1,−1,1,−1,1,1,1,1,−1,1,1,1,−1,−1,−1,1,1,−1,1,1,−1,−1,−1,−1,1,−1,1,1,1,−1,−1,1,−1,−1,−1,1,1,−1,1,−1,1,−1,1,−1,−1,−1,−1,−1,1,−1,1,−1,1,1,1,−1,1,1,−1,−1,1,1,1,1,1,−1,1,−1,1,−1,−1,−1,1,1,1,1,−1,1,1,1,−1,−1,−1,−1,−1,1,1,1,1,1,1,1,−1,−1,−1,1,1,1,−1,1,−1,1,1,1,−1,−1,−1,1,1,1,1,1,−1,1,−1,−1,−1,−1,1,1,1,1,1,1,−1,1,1,1,−1,−1,1,1,−1,1,1,−1,1,1,−1,−1,1,−1,−1,−1,−1,−1,−1,1,1,1,1,−1,1,1,1,1,−1,−1,1,1,−1,1,1,1,−1,1,1,−1,1,1,1,1,1,−1,1,−1,−1,−1,−1,−1,1,1,1,−1,1,1,−1,−1,1,−1,1,−1,1,−1,1,1,1,1,1,−1,1,−1,1,−1,1,−1,1,−1,1,−1,−1,−1,−1,−1,1,−1,1,−1,1,−1,−1,−1,−1,−1,1,1,1,−1,−1,−1,1,−1,1,1,−1,−1,1,−1,1,−1,−1,1,−1,1,1,−1,−1,−1,−1,−1,−1,1,−1,−1,1,−1,1,−1,1,−1,1,−1,1,−1,−1,−1,1,−1,1,−1,1,1,1,1,1,1,−1,−1,−1,−1,−1,−1,1,1,1,1,1,1,1,−1,1,1,1,1,1,1,−1,−1,1,−1,1,1,−1,1,1,1,1,1,−1,−1,−1,−1,−1,−1,1,1,1,−1,−1,1,1,−1,−1,−1,1,1,1,1,1,1,−1,−1,1,−1,−1,−1,−1,−1,−1,−1,1,−1,1,1,1,−1,1,1,−1,1,−1,1,1,1,1,−1,−1,1,−1,1,−1,−1,1,−1,−1,1,1,1,1,−1,1,−1,−1,1,−1,−1,1,1,1,−1,−1,−1,1,−1,−1,1,1,−1,−1,1,1,−1,1,−1,−1,1,−1,1,−1,1,1,−1,−1,−1,1,1,1,1,−1,−1,1,1,1,1,−1,−1,−1,1,1,−1,1,1,1,−1,−1,−1,−1,−1,1,−1,−1,−1,1,−1,1,−1,1,−1,1,1,−1,1,−1,−1,1,−1,1,1,1,1,−1,−1,−1,−1,1,−1,−1,1,1,1,1,−1,−1,−1,1,−1,1,1,1,−1,1,1,1,1,−1,−1,1,−1,−1,1,1,−1,−1,1,1,1,0,0,0,0,0,0,0,0,0,0,0}

For 160 MHz transmission, the N-TF sequence with the format of an HELTF160, optimized for estimation order P=6, is given by:

N-TF(HELTF160,P=6)=sqrt(2048/1992)·{0,0,0,0,0,0,0,0,0,0,0,0,1,−1,1,1,−1,1,−1,1,−1,−1,1,1,1,−1,1,−1,1,1,−1,−1,−1,1,1,−1,−1,1,−1,1,1,−1,1,1,1,−1,−1,1,−1,−1,1,−1,−1,1,−1,1,−1,1,−1,−1,−1,−1,−1,−1,1,−1,1,1,−1,−1,1,1,−1,1,−1,−1,1,−1,1,−1,−1,1,1,1,−1,1,1,1,−1,−1,1,1,1,−1,1,−1,−1,1,1,1,1,1,−1,−1,−1,−1,−1,1,1,−1,−1,1,−1,1,−1,−1,1,1,1,1,1,1,1,1,1,−1,1,1,1,1,1,−1,−1,−1,1,1,−1,1,1,−1,1,−1,−1,−1,1,1,−1,−1,−1,1,−1,1,1,−1,−1,−1,1,−1,1,1,1,1,1,1,1,1,1,−1,1,−1,1,−1,1,−1,1,1,1,−1,1,1,1,1,−1,−1,1,−1,1,−1,−1,1,1,−1,−1,1,−1,−1,1,−1,−1,−1,−1,−1,1,1,1,1,−1,1,1,1,1,1,1,1,1,−1,−1,1,1,−1,−1,−1,1,1,−1,1,1,−1,−1,1,−1,−1,1,1,1,−1,−1,1,1,−1,−1,1,1,−1,1,1,−1,1,1,1,−1,1,1,−1,1,1,1,−1,−1,−1,−1,1,1,−1,−1,1,1,−1,1,1,−1,1,1,−1,1,1,1,−1,−1,1,1,1,−1,−1,1,1,1,1,−1,−1,1,1,−1,1,−1,1,−1,−1,−1,1,−1,−1,1,1,−1,−1,1,−1,−1,1,1,−1,−1,−1,1,1,−1,1,−1,−1,−1,1,−1,−1,1,1,1,1,1,−1,−1,−1,−1,−1,−1,1,1,1,1,−1,−1,−1,1,1,−1,1,1,−1,1,−1,−1,1,−1,1,−1,1,1,1,1,1,−1,−1,1,−1,−1,1,1,1,1,1,−1,−1,−1,−1,−1,1,−1,−1,1,1,−1,−1,−1,−1,−1,1,1,1,1,−1,−1,1,−1,1,1,1,1,−1,−1,1,1,1,1,−1,−1,−1,1,−1,1,1,1,−1,1,−1,−1,1,−1,−1,−1,1,1,−1,−1,1,1,−1,1,−1,1,1,−1,1,1,−1,−1,−1,−1,−1,1,1,−1,1,−1,−1,−1,−1,1,−1,1,1,1,1,1,−1,1,1,1,1,1,−1,−1,−1,1,1,1,1,−1,−1,1,−1,−1,−1,−1,−1,1,−1,1,−1,−1,1,1,−1,1,1,−1,1,1,1,1,1,1,1,−1,1,−1,1,−1,−1,−1,−1,1,−1,1,−1,−1,−1,1,1,−1,1,0,0,0,0,0,−1,1,1,1,−1,1,1,−1,1,1,1,−1,1,−1,1,1,1,−1,−1,−1,−1,1,−1,1,1,−1,−1,1,1,1,1,−1,−1,−1,1,1,1,−1,1,−1,−1,−1,−1,1,1,−1,−1,−1,1,−1,−1,−1,−1,1,−1,1,−1,−1,1,−1,1,1,1,1,1,1,−1,1,1,−1,−1,−1,1,−1,−1,−1,−1,1,1,1,1,−1,1,−1,1,1,−1,1,−1,−1,1,1,1,−1,−1,−1,1,1,−1,−1,1,1,−1,−1,1,1,−1,1,1,1,−1,1,1,−1,1,1,1,1,−1,−1,−1,1,1,−1,1,−1,1,1,−1,−1,−1,1,−1,−1,−1,−1,1,1,1,−1,−1,1,1,−1,1,1,1,−1,1,−1,−1,−1,1,1,−1,−1,1,1,1,−1,1,−1,−1,−1,−1,1,−1,1,1,1,1,1,−1,1,1,1,−1,−1,1,−1,1,−1,−1,1,−1,1,−1,−1,1,−1,1,−1,−1,−1,−1,1,1,1,1,1,1,1,−1,−1,1,−1,1,−1,−1,1,−1,−1,1,−1,1,1,1,1,1,−1,1,1,1,−1,−1,−1,−1,−1,1,1,−1,−1,1,1,−1,−1,−1,1,−1,−1,−1,1,1,1,−1,1,1,−1,1,−1,1,1,1,−1,−1,−1,−1,−1,1,1,1,1,1,1,−1,−1,−1,1,−1,1,1,1,−1,−1,1,−1,−1,−1,1,1,1,−1,−1,1,−1,1,1,−1,1,−1,−1,1,−1,1,1,1,1,−1,1,1,1,1,1,1,1,−1,−1,1,−1,1,1,1,1,−1,−1,1,−1,1,1,1,−1,1,−1,1,−1,−1,−1,−1,−1,1,−1,−1,−1,1,−1,1,1,1,1,−1,1,1,−1,1,1,1,−1,1,1,−1,−1,1,1,1,−1,−1,−1,−1,−1,−1,−1,−1,−1,1,−1,−1,1,1,−1,−1,−1,−1,−1,1,−1,−1,1,−1,1,−1,−1,1,1,1,1,1,−1,1,−1,−1,−1,1,1,−1,−1,1,−1,1,1,1,−1,−1,−1,−1,−1,1,−1,−1,−1,−1,1,−1,1,−1,−1,−1,−1,−1,−1,1,−1,1,−1,−1,1,1,1,1,−1,−1,1,−1,1,1,−1,1,1,−1,1,−1,1,−1,1,−1,−1,−1,−1,−1,1,1,−1,1,−1,−1,−1,−1,−1,1,1,−1,−1,1,1,1,−1,−1,−1,1,−1,1,−1,1,−1,−1,−1,1,1,1,1,1,1,−1,−1,1,−1,−1,−1,−1,−1,−1,−1,1,−1,−1,1,1,−1,−1,0,0,0,0,0,0,0,0,0,0,0,0,0,0,0,0,0,0,0,0,0,0,0,1,−1,1,−1,1,−1,−1,−1,−1,−1,1,−1,1,1,−1,−1,−1,−1,1,−1,1,1,1,1,−1,1,1,−1,1,1,1,−1,1,−1,1,1,1,−1,−1,1,−1,1,1,1,−1,−1,1,−1,−1,−1,−1,1,1,−1,−1,−1,−1,−1,−1,1,1,−1,1,1,1,1,1,−1,−1,1,1,1,−1,1,1,−1,1,1,−1,1,1,−1,1,−1,1,1,−1,1,1,−1,−1,1,1,1,1,−1,1,1,1,−1,−1,−1,−1,−1,1,1,−1,1,1,1,−1,1,−1,1,1,1,1,1,−1,1,−1,1,1,−1,−1,1,−1,1,−1,1,−1,−1,−1,1,−1,1,−1,1,1,−1,1,−1,−1,1,−1,−1,1,1,1,−1,−1,1,−1,−1,1,−1,1,1,−1,−1,−1,1,−1,−1,1,1,1,1,−1,−1,1,1,−1,−1,−1,−1,1,1,−1,−1,1,1,1,−1,−1,1,−1,1,1,1,−1,1,1,1,−1,1,1,−1,−1,1,−1,1,−1,−1,−1,1,−1,1,−1,1,−1,−1,−1,1,−1,1,−1,1,1,−1,1,1,−1,−1,1,−1,−1,1,1,1,−1,−1,1,1,1,1,−1,1,−1,1,1,−1,1,−1,−1,−1,1,1,−1,1,−1,1,−1,1,1,1,1,1,1,−1,1,1,1,1,−1,−1,−1,−1,−1,1,−1,1,1,−1,1,1,1,1,−1,1,1,−1,−1,−1,1,1,−1,−1,−1,−1,1,1,−1,−1,−1,1,−1,1,−1,−1,−1,1,1,1,−1,1,−1,1,−1,1,1,−1,1,−1,−1,−1,1,−1,1,1,−1,1,1,1,1,1,−1,−1,−1,1,−1,−1,−1,1,1,−1,−1,−1,−1,1,−1,−1,−1,−1,−1,−1,1,−1,−1,−1,−1,1,1,−1,−1,1,1,1,1,−1,−1,1,−1,−1,1,−1,1,−1,1,1,−1,1,1,1,−1,−1,−1,−1,−1,−1,1,−1,−1,1,1,1,−1,1,−1,−1,1,1,1,1,−1,1,1,1,−1,1,1,1,−1,1,1,−1,−1,1,1,1,−1,−1,1,−1,−1,−1,1,−1,−1,1,−1,1,−1,−1,−1,−1,−1,−1,−1,1,1,−1,1,−1,−1,1,1,1,1,1,1,1,−1,1,1,1,1,1,−1,1,−1,1,1,−1,−1,−1,1,1,−1,1,−1,1,1,1,1,1,−1,−1,1,1,−1,1,1,1,1,1,−1,−1,−1,−1,1,1,1,1,1,1,1,−1,−1,−1,1,1,−1,−1,−1,−1,−1,−1,0,0,0,0,0,−1,−1,−1,1,1,1,−1,−1,1,−1,1,1,−1,1,−1,−1,−1,−1,−1,1,−1,−1,−1,1,−1,−1,1,−1,−1,1,1,−1,−1,1,1,−1,−1,1,−1,−1,1,1,−1,−1,1,1,1,−1,−1,−1,1,1,1,−1,−1,1,−1,1,−1,−1,1,−1,1,1,−1,1,−1,−1,1,−1,−1,−1,1,1,−1,1,−1,1,−1,−1,−1,−1,1,−1,−1,−1,−1,−1,−1,1,−1,1,1,1,1,1,−1,1,−1,1,−1,−1,1,1,1,−1,1,−1,−1,1,−1,−1,−1,1,−1,1,−1,1,−1,1,−1,1,−1,−1,−1,−1,1,1,1,1,1,1,1,1,−1,1,−1,−1,−1,−1,−1,1,1,1,1,−1,−1,1,1,1,1,−1,−1,1,−1,−1,1,1,−1,−1,1,−1,−1,1,1,1,−1,−1,−1,−1,1,1,1,−1,−1,−1,1,1,−1,1,1,−1,−1,1,−1,−1,1,−1,1,−1,1,1,1,1,−1,1,1,1,−1,−1,−1,1,1,−1,1,−1,−1,−1,1,1,1,1,1,1,1,1,−1,1,1,1,1,−1,1,−1,−1,−1,1,1,−1,−1,1,−1,−1,1,−1,−1,−1,1,1,1,1,1,−1,−1,1,1,−1,−1,−1,1,1,1,1,1,1,1,1,−1,1,1,1,−1,1,1,1,−1,1,1,−1,1,1,1,−1,−1,1,1,−1,−1,1,−1,−1,1,1,1,−1,1,1,1,−1,1,1,1,1,1,1,1,1,1,−1,1,1,−1,1,1,−1,1,1,1,1,−1,−1,1,1,−1,−1,−1,1,1,−1,−1,−1,1,1,1,−1,1,−1,−1,1,−1,−1,1,1,1,1,1,1,1,1,1,−1,−1,−1,1,1,1,−1,1,1,−1,−1,1,−1,1,−1,−1,1,−1,1,−1,1,−1,−1,−1,−1,1,−1,−1,1,1,1,1,1,1,1,1,1,1,−1,−1,1,1,−1,1,1,−1,1,1,1,−1,−1,1,1,−1,−1,1,1,−1,1,−1,−1,1,1,−1,−1,−1,1,1,1,−1,−1,−1,1,−1,1,1,−1,1,1,−1,1,−1,−1,−1,−1,−1,1,−1,1,1,1,−1,−1,1,−1,−1,1,1,1,1,1,−1,−1,−1,1,1,−1,1,1,−1,−1,−1,1,−1,−1,1,1,1,1,1,1,−1,1,−1,1,−1,−1,−1,−1,1,−1,−1,−1,1,−1,1,1,1,1,1,−1,−1,1,−1,1,1,−1,1,1,1,1,1,1,1,−1,1,1,1,0,0,0,0,0,0,0,0,0,0,0}

For 160 MHz transmission, the N-TF sequence with the format of an HELTF160, optimized for estimation order P=7, is given by:

N-TF(HELTF160,P=7)=sqrt(2048/1992)·{0,0,0,0,0,0,0,0,0,0,0,0,−1,−1,−1,−1,−1,1,1,−1,1,1,−1,1,1,−1,−1,1,−1,−1,−1,1,−1,−1,−1,1,−1,−1,1,−1,1,1,1,1,1,−1,1,1,−1,−1,1,1,−1,−1,−1,−1,1,1,−1,−1,−1,−1,1,−1,1,−1,1,1,1,1,1,−1,−1,1,1,−1,1,1,−1,−1,1,−1,−1,1,1,1,−1,−1,1,1,−1,1,−1,−1,1,−1,1,1,−1,1,1,1,−1,−1,1,−1,−1,−1,1,1,−1,1,−1,−1,−1,−1,1,1,−1,−1,−1,1,−1,−1,−1,1,1,1,−1,−1,1,−1,1,−1,−1,1,1,1,1,1,−1,1,1,−1,−1,1,1,−1,−1,1,−1,1,1,1,1,−1,−1,−1,1,−1,−1,−1,1,1,1,1,1,−1,1,−1,−1,−1,1,1,−1,1,1,−1,−1,1,1,−1,−1,−1,1,1,1,−1,1,−1,−1,−1,−1,1,−1,1,1,−1,−1,1,−1,−1,1,1,−1,1,−1,1,1,1,−1,−1,−1,−1,−1,−1,1,1,−1,1,−1,1,−1,1,−1,1,1,1,−1,1,1,1,−1,−1,−1,1,−1,−1,1,−1,1,−1,1,−1,−1,1,1,1,1,1,1,−1,−1,−1,−1,−1,1,−1,−1,−1,−1,−1,1,1,−1,−1,−1,−1,1,−1,1,−1,−1,1,1,1,−1,1,1,1,−1,−1,1,1,−1,−1,−1,1,1,−1,1,1,1,−1,−1,1,−1,−1,−1,1,−1,1,1,−1,−1,1,1,1,−1,1,−1,−1,−1,−1,−1,−1,−1,−1,−1,−1,1,−1,−1,−1,1,−1,−1,1,1,1,1,1,−1,−1,1,1,−1,−1,1,−1,1,1,−1,1,−1,1,−1,−1,−1,−1,−1,1,−1,1,1,1,−1,−1,1,1,1,1,1,1,−1,−1,−1,1,−1,−1,1,1,−1,1,−1,1,1,1,−1,−1,−1,1,1,1,1,1,−1,1,1,−1,−1,−1,1,1,1,−1,−1,1,1,−1,−1,−1,1,1,−1,1,1,−1,−1,1,−1,−1,1,1,−1,1,−1,−1,−1,1,1,1,−1,−1,−1,−1,1,−1,1,1,−1,−1,−1,1,−1,1,−1,1,−1,1,1,1,−1,−1,1,1,−1,−1,−1,−1,1,−1,1,1,1,−1,1,−1,−1,1,1,1,1,−1,−1,1,−1,−1,1,1,−1,1,−1,1,−1,1,−1,1,−1,−1,−1,1,1,1,−1,−1,−1,1,1,1,−1,−1,1,1,−1,−1,−1,1,1,−1,−1,−1,−1,1,−1,1,1,−1,−1,1,0,0,0,0,0,−1,1,1,−1,−1,1,1,−1,1,1,1,−1,−1,−1,−1,1,−1,−1,1,−1,−1,1,1,1,1,1,1,1,−1,−1,−1,1,1,1,−1,1,−1,1,−1,1,1,−1,−1,1,−1,1,−1,−1,1,1,−1,1,−1,−1,1,1,−1,1,−1,1,−1,−1,−1,−1,1,1,1,−1,1,−1,1,1,1,−1,−1,−1,1,−1,1,−1,1,1,−1,1,1,−1,−1,1,−1,−1,−1,−1,1,1,1,1,1,−1,1,1,−1,−1,1,1,1,−1,−1,1,1,1,−1,−1,1,1,−1,1,1,−1,1,1,1,1,1,1,−1,1,−1,−1,−1,−1,1,−1,1,1,−1,−1,1,1,1,−1,−1,1,−1,1,1,1,−1,−1,1,−1,1,1,1,−1,−1,1,1,−1,−1,−1,1,1,1,1,1,1,−1,−1,1,1,−1,1,−1,−1,−1,−1,−1,−1,−1,−1,1,1,−1,−1,−1,−1,1,−1,1,1,1,1,−1,−1,1,−1,1,1,−1,−1,−1,−1,−1,1,−1,−1,−1,−1,−1,−1,−1,1,1,−1,1,−1,−1,−1,−1,−1,−1,1,−1,−1,−1,1,−1,−1,−1,1,−1,−1,−1,1,1,1,1,−1,−1,−1,−1,−1,−1,1,1,−1,−1,1,−1,1,−1,−1,−1,−1,1,−1,−1,1,−1,1,−1,1,−1,1,1,−1,−1,−1,−1,1,1,−1,−1,1,1,−1,1,−1,1,1,1,−1,1,−1,1,1,1,−1,−1,1,1,−1,−1,−1,−1,1,1,1,−1,−1,−1,1,−1,−1,1,−1,1,1,1,1,−1,−1,1,1,1,−1,1,−1,1,1,1,1,−1,−1,−1,1,−1,1,−1,−1,−1,−1,1,−1,1,1,−1,1,1,−1,−1,1,1,−1,1,−1,−1,1,−1,1,1,−1,−1,1,−1,−1,1,−1,1,1,−1,−1,−1,−1,1,−1,1,1,1,−1,−1,1,1,−1,−1,−1,1,−1,1,−1,−1,−1,1,−1,−1,−1,1,−1,−1,1,1,−1,1,−1,−1,−1,−1,−1,−1,1,−1,−1,1,1,−1,−1,−1,1,−1,1,1,−1,−1,−1,−1,1,−1,−1,−1,−1,−1,−1,−1,−1,−1,−1,−1,−1,−1,−1,1,1,1,1,1,−1,−1,1,−1,−1,−1,−1,1,1,1,−1,1,1,−1,−1,−1,1,1,1,1,1,−1,−1,1,−1,−1,1,1,−1,−1,−1,−1,1,1,1,−1,1,−1,−1,−1,1,−1,−1,1,−1,1,−1,−1,1,1,−1,1,1,1,−1,−1,−1,1,−1,−1,1,1,1,0,0,0,0,0,0,0,0,0,0,0,0,0,0,0,0,0,0,0,0,0,0,0,1,1,1,−1,−1,−1,−1,1,1,1,1,−1,1,−1,−1,−1,1,−1,1,−1,1,−1,1,−1,1,−1,1,1,−1,1,−1,−1,1,1,−1,1,1,−1,−1,−1,1,1,−1,1,1,1,1,1,−1,−1,1,1,−1,−1,1,−1,−1,−1,1,1,−1,−1,1,1,−1,−1,−1,−1,1,−1,1,1,1,1,1,1,1,−1,−1,1,−1,−1,1,1,−1,1,1,1,−1,−1,1,−1,1,−1,1,1,−1,1,−1,−1,−1,−1,1,1,1,1,1,1,1,−1,−1,1,1,−1,1,−1,−1,1,−1,−1,1,1,1,1,−1,1,1,−1,1,1,−1,−1,−1,1,−1,1,−1,1,1,−1,1,−1,−1,1,1,−1,1,1,1,−1,−1,−1,−1,−1,−1,1,−1,−1,1,1,−1,−1,1,1,1,1,1,−1,−1,−1,1,1,1,1,−1,−1,−1,−1,−1,1,1,−1,1,−1,1,−1,1,1,−1,−1,−1,−1,−1,1,−1,−1,1,−1,1,−1,1,−1,1,−1,1,1,−1,1,1,−1,−1,−1,1,1,1,−1,1,1,1,−1,−1,−1,−1,1,1,−1,−1,1,−1,1,1,1,1,−1,−1,1,1,−1,−1,−1,1,1,1,1,1,1,−1,1,−1,1,1,−1,1,1,−1,1,1,1,−1,1,1,−1,−1,−1,1,1,1,−1,−1,1,1,−1,1,1,−1,1,1,1,−1,1,1,−1,1,1,1,−1,−1,1,1,−1,1,−1,−1,1,1,−1,−1,1,1,−1,−1,−1,1,1,1,−1,−1,1,−1,−1,1,−1,1,1,−1,1,−1,−1,1,−1,−1,1,−1,−1,−1,1,1,−1,−1,−1,1,−1,1,1,−1,−1,1,−1,−1,−1,1,1,−1,1,−1,1,−1,−1,−1,−1,−1,1,−1,1,−1,1,−1,−1,−1,1,−1,−1,1,−1,−1,1,1,−1,1,1,−1,−1,−1,−1,−1,1,1,−1,−1,−1,−1,1,1,1,−1,−1,−1,−1,−1,−1,−1,−1,1,1,1,−1,1,−1,1,−1,1,−1,−1,−1,1,1,1,1,1,−1,−1,1,1,−1,−1,1,−1,−1,−1,−1,−1,1,1,1,−1,−1,1,1,1,1,−1,1,−1,1,1,1,1,1,−1,1,1,1,1,1,−1,1,1,−1,1,−1,−1,1,1,−1,1,−1,1,−1,−1,1,1,−1,1,1,−1,−1,−1,1,1,−1,1,1,1,1,1,−1,1,1,−1,−1,1,−1,1,−1,−1,−1,−1,−1,1,−1,−1,1,1,1,−1,−1,1,−1,0,0,0,0,0,−1,−1,1,−1,−1,−1,−1,1,−1,−1,−1,−1,1,1,−1,1,1,−1,1,1,−1,1,1,1,−1,−1,1,1,−1,−1,−1,1,−1,−1,1,1,−1,−1,−1,−1,−1,1,1,−1,−1,−1,1,−1,−1,1,−1,−1,1,1,1,−1,−1,−1,1,−1,1,−1,1,1,1,−1,−1,−1,−1,−1,1,−1,1,1,1,−1,−1,1,−1,1,1,1,−1,−1,−1,−1,1,1,−1,1,−1,1,−1,1,1,1,−1,1,1,1,−1,1,−1,−1,−1,1,−1,−1,1,1,−1,1,−1,−1,−1,1,−1,1,−1,1,−1,1,1,−1,−1,−1,1,−1,−1,1,1,1,1,−1,1,1,1,−1,1,1,1,−1,1,−1,1,−1,1,1,1,1,1,1,−1,−1,−1,1,1,1,1,−1,−1,1,−1,1,−1,1,1,−1,1,−1,−1,−1,−1,1,1,1,1,1,−1,1,−1,1,1,1,−1,−1,−1,1,−1,1,−1,1,−1,−1,1,1,−1,−1,−1,1,−1,1,−1,−1,1,−1,−1,1,−1,1,1,1,1,−1,−1,−1,1,−1,1,1,1,−1,1,1,1,−1,1,−1,−1,−1,1,−1,−1,1,1,−1,−1,1,1,1,1,−1,−1,1,1,−1,−1,1,−1,−1,1,1,−1,1,−1,−1,1,−1,−1,1,1,1,1,1,−1,1,1,1,1,1,−1,1,−1,1,−1,1,1,1,−1,−1,−1,−1,−1,−1,−1,1,1,1,−1,−1,1,1,1,−1,1,−1,1,−1,−1,1,1,−1,1,−1,−1,1,1,1,−1,1,−1,−1,1,−1,1,−1,−1,−1,1,−1,1,1,−1,1,−1,−1,−1,−1,1,−1,1,−1,1,−1,−1,−1,1,−1,−1,1,−1,−1,−1,−1,1,1,1,−1,−1,−1,−1,−1,1,−1,−1,1,−1,−1,−1,−1,−1,1,1,1,1,−1,1,1,−1,1,−1,−1,1,−1,1,1,−1,1,−1,−1,1,−1,−1,1,−1,1,−1,1,1,1,1,1,−1,−1,−1,−1,−1,1,1,−1,−1,−1,−1,−1,1,−1,1,1,1,−1,−1,−1,−1,−1,−1,1,1,1,−1,−1,1,1,1,−1,1,1,−1,1,1,1,1,−1,−1,−1,1,−1,−1,−1,1,−1,−1,1,1,1,−1,−1,1,1,−1,1,1,−1,−1,−1,1,1,1,−1,1,−1,1,1,−1,−1,−1,1,−1,−1,1,1,1,−1,1,−1,1,1,−1,1,−1,1,1,1,1,1,−1,1,−1,−1,1,1,1,−1,1,1,−1,−1,1,1,0,0,0,0,0,0,0,0,0,0,0}

For 160 MHz transmission, the N-TF sequence with the format of an HELTF160, optimized for estimation order P=8, is given by:

N-TF(HELTF160,P=8)=sqrt(2048/1992)·{0,0,0,0,0,0,0,0,0,0,0,0,1,−1,1,−1,−1,1,1,−1,−1,−1,1,1,1,−1,−1,−1,−1,−1,1,1,−1,1,1,1,−1,−1,1,1,1,−1,1,1,−1,−1,1,1,−1,1,−1,−1,1,−1,1,−1,−1,1,1,1,−1,−1,1,1,1,−1,−1,−1,−1,1,1,−1,1,−1,1,−1,−1,1,1,−1,−1,−1,1,1,1,1,1,1,−1,−1,−1,1,−1,1,1,−1,1,−1,1,−1,−1,−1,−1,−1,−1,1,−1,1,−1,−1,−1,−1,1,−1,1,1,−1,−1,1,1,−1,1,1,1,1,−1,1,−1,1,1,1,1,−1,−1,1,−1,−1,−1,−1,1,−1,−1,1,−1,−1,1,1,−1,1,−1,1,1,−1,−1,1,1,−1,−1,1,−1,1,−1,1,1,1,−1,1,1,−1,1,1,−1,1,−1,1,1,−1,−1,−1,1,−1,1,1,1,1,1,1,−1,1,1,−1,1,1,−1,−1,1,1,1,1,−1,−1,−1,1,1,1,−1,1,1,1,−1,1,−1,1,−1,−1,1,−1,1,1,1,1,−1,1,1,1,−1,1,−1,−1,1,1,1,1,1,−1,1,1,−1,1,1,1,−1,1,1,−1,−1,1,1,1,−1,1,1,1,1,−1,1,1,1,−1,1,1,−1,1,1,−1,1,1,1,−1,1,−1,−1,−1,−1,1,1,−1,−1,1,1,1,−1,−1,1,1,1,−1,1,1,1,−1,1,1,1,1,1,−1,1,1,−1,1,−1,−1,1,1,−1,1,−1,1,−1,1,−1,−1,−1,−1,1,1,−1,−1,1,1,−1,1,1,1,1,1,1,1,−1,−1,−1,1,1,1,1,1,−1,−1,−1,1,−1,−1,1,1,−1,−1,−1,1,−1,−1,1,1,1,1,−1,−1,−1,1,−1,−1,1,−1,−1,1,−1,1,1,1,−1,−1,−1,1,1,−1,−1,−1,1,−1,1,1,1,1,1,−1,−1,1,1,−1,1,−1,1,1,−1,−1,1,−1,1,1,1,1,−1,1,−1,1,1,−1,−1,1,1,−1,1,1,−1,−1,1,1,1,1,1,1,1,−1,−1,1,1,−1,−1,1,−1,1,−1,1,1,−1,1,1,1,−1,−1,1,1,1,−1,1,−1,1,1,−1,1,1,1,1,−1,−1,−1,−1,1,1,−1,1,−1,1,1,1,1,−1,1,1,−1,−1,−1,−1,1,1,−1,1,1,−1,−1,1,−1,1,1,1,1,−1,1,−1,1,−1,−1,−1,−1,1,−1,1,−1,−1,1,−1,−1,−1,1,1,−1,−1,1,−1,1,0,0,0,0,0,−1,1,−1,−1,1,−1,−1,1,1,1,1,−1,−1,1,−1,1,1,1,1,1,−1,1,−1,−1,−1,−1,1,1,−1,1,1,−1,1,−1,−1,−1,−1,−1,−1,1,1,−1,−1,1,−1,1,−1,−1,1,−1,−1,−1,−1,1,−1,1,−1,1,−1,1,1,−1,1,1,1,1,−1,1,−1,−1,1,1,−1,1,−1,−1,1,−1,1,1,−1,1,1,1,1,−1,1,−1,1,1,−1,1,−1,−1,1,1,1,−1,1,1,1,1,−1,1,−1,−1,−1,1,−1,1,1,−1,−1,1,1,−1,1,1,−1,1,1,1,−1,1,−1,−1,−1,1,−1,−1,1,−1,−1,1,−1,1,−1,1,−1,1,−1,−1,1,−1,1,1,−1,1,−1,−1,1,−1,−1,1,1,1,−1,1,−1,1,−1,−1,1,1,1,−1,1,−1,−1,1,−1,−1,−1,1,−1,−1,1,−1,1,1,1,−1,−1,1,1,−1,−1,−1,−1,−1,1,−1,−1,1,1,−1,−1,1,1,1,−1,1,1,−1,−1,−1,−1,−1,−1,1,1,1,−1,1,−1,1,1,1,1,1,−1,1,−1,−1,−1,1,−1,1,1,1,1,1,1,1,1,1,1,−1,1,1,−1,−1,−1,−1,1,1,−1,1,1,1,−1,1,−1,1,1,1,−1,1,−1,1,−1,−1,1,1,1,1,1,−1,1,1,1,1,−1,1,−1,−1,1,1,1,1,1,−1,−1,−1,1,1,−1,−1,1,1,1,1,1,−1,1,1,1,1,1,−1,−1,1,1,1,1,1,−1,−1,−1,−1,−1,1,−1,−1,−1,1,1,−1,−1,−1,1,1,−1,1,1,−1,1,−1,−1,−1,1,−1,−1,1,−1,−1,−1,−1,1,1,1,−1,−1,1,1,−1,−1,−1,−1,−1,1,1,−1,1,1,1,−1,−1,−1,1,1,1,1,1,1,1,−1,1,−1,−1,−1,−1,−1,−1,1,1,1,1,1,1,1,−1,1,−1,−1,−1,1,−1,−1,1,−1,1,−1,1,1,−1,−1,1,−1,1,1,1,1,1,1,1,−1,−1,1,1,−1,1,1,−1,1,1,−1,1,−1,1,−1,1,−1,1,−1,1,−1,1,1,1,−1,−1,1,1,1,−1,−1,1,1,1,−1,1,−1,1,1,−1,1,−1,−1,1,1,1,1,−1,−1,1,−1,1,1,1,1,1,−1,−1,1,1,−1,1,−1,−1,−1,−1,1,1,1,−1,1,1,−1,−1,1,1,1,−1,−1,−1,1,1,1,1,1,−1,1,1,1,−1,1,−1,0,0,0,0,0,0,0,0,0,0,0,0,0,0,0,0,0,0,0,0,0,0,0,−1,−1,1,1,1,−1,−1,1,−1,1,−1,−1,−1,−1,1,−1,−1,−1,1,1,1,1,1,−1,1,−1,−1,−1,1,1,1,−1,−1,−1,−1,−1,1,−1,−1,1,1,1,1,1,−1,1,1,−1,1,−1,−1,1,1,1,−1,−1,1,1,−1,−1,−1,1,1,−1,−1,−1,1,−1,1,−1,−1,1,−1,−1,−1,1,−1,1,1,−1,−1,−1,1,1,−1,1,−1,−1,1,−1,−1,−1,1,1,1,−1,1,−1,−1,−1,1,−1,1,1,1,1,1,−1,−1,1,−1,−1,1,−1,1,−1,−1,−1,−1,1,1,1,−1,−1,1,−1,1,−1,−1,1,1,−1,1,−1,1,1,1,1,1,−1,1,1,−1,−1,1,−1,−1,−1,−1,−1,1,−1,1,1,1,1,1,1,−1,−1,−1,−1,1,−1,−1,−1,1,1,1,1,−1,−1,−1,−1,1,1,1,1,1,−1,1,1,1,−1,−1,1,−1,1,1,1,1,−1,−1,−1,1,−1,−1,−1,1,−1,1,1,1,1,1,1,−1,−1,1,1,−1,1,−1,1,−1,−1,1,−1,1,−1,−1,1,1,1,1,1,−1,1,1,−1,−1,−1,1,−1,1,1,−1,1,−1,−1,−1,1,1,1,−1,1,1,−1,−1,−1,1, 1,1,1,1,−1,−1,1,1,−1,−1,1,1,−1,−1,−1,−1,1,1,−1,−1,1,1,1,1,−1,−1,1,−1,−1,1,−1,−1,−1,1,−1,−1,1,−1,1,1,−1,1,−1,1,1,−1,−1,1,−1,−1,1,1,−1,−1,1,1,−1,−1,−1,−1,1,1,−1,1,1,1,−1,−1,1,−1,1,−1,−1,1,−1,1,1,1,−1,−1,1,1,−1,−1,−1,1,1,1,−1,1,−1,1,1,−1,1,−1,1,1,−1,1,1,−1,1,1,−1,−1,1,1,−1,1,−1,1,1,−1,−1,1,−1,−1,−1,−1,−1,−1,1,−1,1,−1,−1,1,1,1,−1,−1,1,1,−1,1,−1,1,1,1,−1,−1,−1,−1,−1,−1,−1,−1,−1,1,−1,1,−1,−1,1,−1,1,1,−1,−1,−1,−1,−1,1,1,−1,−1,1,−1,−1,−1,1,−1,1,−1,1,1,1,−1,−1,−1,1,−1,−1,1,1,1,−1,−1,−1,1,1,1,−1,−1,1,−1,1,−1,1,1,1,1,−1,1,−1,1,1,1,−1,−1,1,1,1,−1,−1,1,1,1,1,1,−1,1,−1,1,−1,−1,1,−1,1,1,−1,1,1,1,−1,1,−1,−1,−1,−1,1,−1,−1,1,1,1,0,0,0,0,0,1,1,−1,1,−1,1,−1,1,−1,−1,−1,−1,−1,−1,−1,−1,1,1,−1,1,−1,1,−1,1,1,1,−1,−1,1,1,1,1,−1,1,−1,1,−1,1,1,−1,1,1,−1,−1,−1,1,1,1,1,1,−1,1,−1,−1,−1,−1,−1,1,−1,−1,1,1,−1,−1,1,1,1,−1,−1,1, 1,1,1,1,−1,−1,1,−1,1,1,−1,1,1,−1,1,1,1,1,−1,1,1,1,1,1,−1,−1,1,1,−1,1,1,−1,−1,1,1,1,1,1,−1,1,−1,−1,−1,−1,−1,−1,1,1,1,−1,1,−1,1,1,1,1,−1,1,−1,−1,−1,−1,1,1,1,−1,1,−1,−1,1,−1,1,−1,1,1,−1,1,1,1,1,1,−1,−1,1,−1,1,−1,−1,1,−1,1,1,1,−1,1,−1,1,1,−1,1,−1,1,1,1,1,1,1,1,−1,−1,−1,1,1,−1,1,−1,−1,1,1,−1,−1,−1,−1,1,−1,−1,1,−1,1,1,1,−1,−1,−1,−1,1,−1,1,1,1,1,1,−1,−1,1,−1,1,1,1,1,1,1,1,1,−1,−1,−1,1,−1,1,−1,1,−1,1,1,1,−1,1,−1,1,−1,1,1,−1,1,1,1,−1,1,−1,−1,1,1,1,1,−1,−1,−1,−1,1,−1,1,−1,1,1,1,−1,1,−1,−1,−1,−1,−1,−1,−1,−1,−1,−1,1,−1,1,−1,1,1,1,−1,−1,−1,1,1,−1,−1,1,1,1,−1,−1,−1,1,1,1,1,1,−1,−1,1,−1,−1,1,−1,1,−1,1,−1,−1,−1,1,1,−1,−1,−1,1,1,−1,1,−1,1,1,−1,−1,1,1,1,−1,−1,1,−1,1,−1,−1,−1,1,1,1,1,1,1,−1,−1,1,−1,−1,−1,1,1,1,−1,1,−1,−1,−1,1,1,−1,1,1,1,1,1,−1,1,−1,−1,1,−1,−1,−1,1,1,−1,−1,−1,1,1,−1,1,−1,1,−1,−1,−1,1,1,1,1,1,−1,−1,−1,1,−1,1,1,1,−1,−1,−1,−1,−1,1,1,1,−1,−1,−1,−1,−1,−1,1,−1,−1,1,−1,1,−1,−1,1,1,−1,1,1,1,1,−1,1,1,1,1,−1,−1,−1,1,−1,1,−1,−1,−1,−1,1,1,1,1,−1,−1,1,1,1,1,1,−1,−1,1,−1,−1,−1,1,−1,−1,−1,1,1,1,1,1,−1,−1,−1,1,1,1,−1,−1,−1,−1,−1,1,−1,−1,−1,1,1,−1,−1,−1,1,−1,−1,1,0,0,0,0,0,0,0,0,0,0,0}

For 160 MHz transmission, the N-TF sequence with the format of an HELTF160, optimized for estimation order P=9, is given by:

N-TF(HELTF160,P=9)=sqrt(2048/1992)·{0,0,0,0,0,0,0,0,0,0,0,0,1,−1,1,1,−1,1,1,−1,1,−1,1,−1,1,−1,1,1,1,1,−1,−1,−1,1,1,−1,1,1,−1,−1,1,−1,1,−1,1,−1,1,1,1,1,−1,−1,1,−1,−1,−1,−1,1,−1,1,−1,−1,1,−1,1,1,−1,1,1,1,−1,1,−1,−1,1,−1,−1,−1,1,−1,−1,1,1,1,1,−1,1,−1,−1,1,−1,−1,−1,−1,−1,−1,−1,1,−1,1,−1,−1,−1,1,1,−1,1,−1,1,−1,−1,−1,1,−1,1,1,1,1,−1,−1,−1,−1,−1,1,1,−1,1,−1,1,−1,−1,−1,1,−1,1,1,−1,1,1,−1,−1,−1,−1,−1,1,−1,−1,−1,1,1,1,1,−1,−1,1,−1,−1,−1,1,−1,−1,−1,−1,1,−1,1,1,1,1,1,−1,−1,−1,−1,−1,1,1,1,−1,1,1,−1,−1,1,1,1,−1,1,1,1,−1,−1,1,−1,−1,−1,−1,−1,1,−1,−1,1,−1,1,1,1,−1,1,−1,1,−1,−1,1,−1,−1,1,−1,−1,−1,1,1,−1,−1,−1,−1,−1,−1,−1,−1,−1,1,−1,1,1,1,−1,1,1,−1,−1,−1,−1,−1,−1,−1,1,1,−1,−1,1,−1,−1,1,−1,1,−1,1,−1,−1,1,−1,1,−1,1,−1,−1,1,1,1,1,−1,−1,−1,−1,−1,1,1,1,1,1,−1,1,−1,−1,1,−1,1,−1,1,1,1,−1,−1,1,1,1,−1,−1,−1,1,−1,−1,−1,1,1,1,−1,−1,−1,−1,−1,−1,1,−1,−1,−1,−1,1,1,1,−1,−1,−1,−1,−1,−1,−1,1,1,1,−1,1,1,−1,−1,1,1,1,−1,1,−1,−1,−1,1,1,−1,−1,−1,1,1,−1,1,1,1,−1,−1,1,−1,1,1,−1,−1,−1,1,−1,−1,1,1,1,1,1,−1,−1,1,1,1,1,−1,1,−1,−1,−1,1,1,1,1,−1,1,1,−1,−1,−1,1,−1,1,−1,1,−1,1,1,−1,1,−1,1,−1,−1,−1,−1,1,1,1,1,−1,−1,1,−1,1,1,1,1,1,1,−1,−1,−1,−1,−1,−1,−1,1,−1,1,−1,−1,1,−1,−1,1,−1,−1,1,−1,−1,1,−1,1,−1,−1,−1,−1,1,1,−1,−1,−1,1,−1,−1,−1,−1,−1,1,−1,−1,1,−1,−1,1,−1,1,−1,−1,1,−1,1,1,−1,−1,1,1,1,−1,−1,−1,1,−1,1,−1,−1,1,1,1,1,−1,1,−1,1,1,−1,1,−1,−1,−1,−1,1,−1,−1,1,−1,1,0,0,0,0,0,1,1,1,1,−1,−1,−1,−1,−1,1,−1,−1,1,−1,−1,1,−1,−1,1,1,1,−1,1,−1,−1,1,−1,1,−1,1,−1,−1,1,−1,−1,−1,1,1,1,−1,−1,−1,1,1,1,−1,1,−1,1,−1,1,−1,−1,−1,−1,−1,1,1,1,1,1,−1,−1,−1,−1,−1,1,−1,−1,−1,−1,1,−1,−1,−1,1,−1,−1,1,−1,1,−1,−1,−1,1,−1,1,−1,−1,1,1,1,−1,1,1,−1,−1,1,1,1,−1,1,1,1,−1,−1,1,1,−1,1,−1,1,1,−1,−1,−1,1,−1,1,1,−1,−1,−1,1,−1,1,−1,1,−1,−1,−1,−1,−1,−1,−1,1,−1,1,1,1,−1,−1,1,1,−1,1,−1,1,1,1,−1,1,1,−1,−1,−1,−1,−1,−1,−1,−1,−1,1,1,−1,−1,1,−1,1,−1,−1,−1,1,−1,−1,1,−1,1,−1,−1,1,−1,1,−1,−1,−1,1,1,−1,−1,1,−1,−1,−1,−1,1,1,1,−1,1,−1,−1,−1,−1,−1,−1,1,−1,1,1,1,−1,1,−1,1,1,1,1,−1,1,1,−1,1,−1,−1,−1,−1,−1,−1,1,−1,−1,1,−1,−1,1,−1,−1,−1,−1,−1,−1,1,−1,1,1,−1,−1,−1,−1,1,−1,1,−1,−1,−1,−1,1,1,−1,−1,1,−1,−1,−1,−1,1,−1,−1,−1,−1,1,−1,−1,−1,−1,−1,−1,1,−1,−1,1,1,1,1,−1,−1,1,1,−1,1,1,−1,1,−1,−1,1,1,1,−1,−1,−1,1,−1,−1,1,1,−1,1,−1,1,−1,−1,−1,−1,−1,1,−1,1,−1,1,1,1,1,−1,1,−1,1,1,1,1,1,1,1,−1,−1,−1,1,1,−1,−1,−1,1,1,−1,−1,−1,1,1,−1,−1,1,−1,−1,1,−1,1,1,1,1,−1,−1,−1,1,−1,1,−1,−1,1,−1,−1,1,1,−1,−1,−1,−1,1,1,1,−1,1,−1,1,1,1,−1,−1,1,1,−1,−1,1,1,1,−1,1,−1,−1,−1,−1,−1,−1,−1,1,1,−1,−1,−1,−1,1,1,1,1,−1,1,−1,−1,1,−1,−1,1,1,−1,−1,1,1,−1,−1,1,−1,−1,−1,1,−1,1,1,1,1,−1,−1,−1,−1,−1,1,−1,−1,1,1,1,1,−1,−1,1,1,−1,−1,−1,1,1,−1,1,1,1,1,−1,−1,1,−1,1,1,−1,1,−1,−1,−1,−1,−1,1,−1,1,−1,1,−1,1,−1,−1,−1,−1,−1,−1,1,−1,−1,1,−1,1,1,0,0,0,0,0,0,0,0,0,0,0,0,0,0,0,0,0,0,0,0,0,0,0,1,−1,−1,1,1,1,−1,−1,1,−1,1,−1,1,1,1,−1,−1,−1,−1,−1,−1,−1,−1,1,1,−1,1,−1,1,−1,1,−1,1,−1,1,1,−1,−1,−1,−1,−1,−1,−1,1,1,1,−1,−1,1,1,−1,−1,−1,−1,1,−1,−1,1,1,1,−1,1,1,−1,−1,−1,−1,1,−1,1,1,1,−1,1,−1,−1,−1,−1,1,−1,1,1,−1,1,−1,−1,−1,1,1,1,1,−1,−1,−1,1,−1,−1,−1,−1,−1,−1,1,1,−1,1,1,1,−1,−1,−1,−1,1,−1,−1,1,−1,1,−1,−1,−1,1,−1,−1,−1,−1,1,−1,1,−1,−1,−1,1,−1,−1,1,−1,1,−1,−1,−1,−1,1,−1,1,−1,−1,−1,1,−1,−1,1,−1,−1,1,−1,1,1,−1,1,1,−1,1,−1,−1,−1,1,−1,1,−1,1,1,−1,−1,−1,1,1,−1,−1,1,1,−1,−1,−1,−1,1,1,−1,1,−1,−1,1,1,−1,1,−1,−1,−1,1,−1,−1,1,−1,1,−1,−1,−1,−1,1,1,−1,1,−1,1,1,−1,−1,−1,1,−1,1,1,1,1,1,1,−1,1,1,−1,1,1,−1,−1,1,−1,1,−1,1,−1,−1,1,−1,−1,−1,−1,1,−1,−1,−1,1,1,1,−1,−1,1,1,−1,1,−1,1,−1,1,1,1,1,1,−1,−1,−1,−1,−1,−1,−1,−1,1,1,1,−1,−1,1,−1,−1,1,−1,−1,−1,−1,1,−1,1,1,−1,1,1,−1,1,1,−1,−1,1,1,1,1,−1,1,−1,−1,−1,1,1,−1,1,−1,1,1,−1,−1,−1,−1,1,1,1,1,1,1,1,1,1,−1,1,1,−1,1,−1,1,−1,−1,−1,1,1,1,1,1,1,1,−1,1,1,−1,1,1,1,1,1,−1,−1,−1,1,1,1,1,−1,1,1,−1,−1,−1,−1,1,1,−1,−1,1,1,−1,−1,1,−1,1,−1,1,−1,1,1,1,1,−1,−1,−1,−1,−1,1,−1,1,1,−1,1,−1,1,−1,−1,−1,−1,−1,−1,1,1,−1,−1,1,−1,−1,−1,1,1,1,1,1,−1,1,−1,1,−1,−1,1,−1,1,−1,1,1,−1,1,1,−1,1,1,1,−1,−1,1,1,−1,1,1,−1,1,−1,−1,1,−1,1,1,−1,−1,1,1,1,−1,−1,1,1,1,1,1,1,−1,1,−1,−1,−1,1,1,1,1,−1,−1,−1,−1,1,−1,1,1,−1,−1,−1,1,−1,−1,−1,1,1,−1,1,−1,−1,1,1,1,0,0,0,0,0,−1,1,−1,1,1,−1,1,1,1,1,1,−1,−1,−1,1,−1,1,1,−1,1,−1,1,1,−1,1,1,1,1,−1,1,−1,1,1,−1,1,−1,1,1,−1,−1,−1,−1,−1,1,1,1,1,−1,−1,1,1,−1,−1,1,1,−1,−1,1,−1,−1,−1,−1,1,1,−1,−1,−1,−1,1,−1,1,−1,−1,1,−1,1,−1,1,1,1,−1,−1,−1,−1,1,−1,1,−1,1,1,1,1,1,−1,1,−1,−1,1,−1,−1,−1,−1,1,−1,−1,−1,−1,1,1,1,1,−1,1,1,1,−1,−1,−1,−1,−1,−1,−1,1,−1,1,1,−1,−1,1,−1,1,−1,−1,−1,−1,1,−1,1,−1,−1,1,−1,−1,−1,−1,1,−1,1,1,−1,−1,−1,−1,−1,−1,−1,−1,1,−1,1,−1,−1,−1,1,−1,1,−1,1,1,1,−1,−1,−1,1,1,1,−1,1,1,1,1,−1,−1,1,1,−1,1,1,−1,1,−1,1,1,−1,1,−1,−1,1,−1,1,1,1,1,1, 1,1,1,1,1,1,1,1,1,1,1,1,1,1,1,−1,−1,1,−1,−1,1,1,−1,−1,−1,1,1,−1,1,−1,1,−1,−1,−1,1,1,−1,1,−1,1,−1,−1,−1,−1,1,1,−1,1,1,−1,−1,−1,1,1,−1,1,−1,−1,1,−1,−1,1,1,1,−1,1,1,−1,−1,−1,1,1,1,1,1,1,−1,−1,1,1,−1,−1,−1,−1,1,1,−1,1,1,1,−1,1,−1,−1,1,−1,1,−1,−1,−1,−1,1,1,1,−1,1,1,−1,1,−1,−1,−1,1,−1,−1,1,−1,−1,−1,1,−1,−1,1,1,1,1,1,1,−1,1,−1,1,−1,1,−1,1,1,1,−1,1,−1,1,−1,−1,1,1,−1,1,−1,−1,1,−1,1,1,−1,1,1,1,−1,−1,−1,−1,1,1,−1,−1,−1,1,1,1,1,1,−1,−1,−1,1,1,−1,1,1,1,1,−1,−1,−1,1,−1,1,−1,1,−1,1,−1,1,−1,1,−1,1,−1,1,−1,1,1,1,−1,1,−1,1,1,−1,−1,1,1,1,1,−1,1,1,1,−1,−1,1,1,1,−1,1,−1,1,−1,−1,−1,−1,1,1,1,1,1,1,−1,1,−1,−1,1,1,1,−1,1,1,1,−1,−1,1,1,1,1,1,−1,1,1,−1,−1,−1,1,−1,−1,1,1,1,1,−1,−1,−1,1,−1,1,−1,−1,1,1,−1,−1,−1,1,−1,−1,−1,−1,1,−1,1,1,1,−1,1,0,0,0,0,0,0,0,0,0,0,0}

For 160 MHz transmission, the N-TF sequence with the format of an HELTF160, optimized for estimation order P=10, is given by:

N-TF(HELTF160,P=10)=sqrt(2048/1992)·{0,0,0,0,0,0,0,0,0,0,0,0,1,1,−1,−1,1,−1,1,−1,−1,−1,−1,−1,1,1,−1,−1,1,−1,1,−1,−1,1,−1,1,−1,1,−1,−1,1,1,1,1,−1,1,−1,1,−1,−1,−1,−1,−1,1,−1,1,1,−1,−1,1,−1,1,−1,−1,−1,−1,1,−1,1,−1,1,1,1,−1,−1,1,1,1,1,−1,−1,1,1,−1,1,1,−1,1,−1,−1,1,−1,−1,1,−1,−1,1,−1,1,−1,1,−1,1,−1,−1,−1,−1,−1,1,1,1,1,1,1,−1,1,−1,−1,−1,−1,−1,1,1,1,−1,1,−1,−1,−1,1,1,−1,−1,−1,1,−1,1,1,1,−1,1,−1,1,1,−1,1,1,−1,1,−1,1,−1,−1,−1,1,1,−1,1,1,1,−1,1,−1,1,1,−1,1,1,−1,1,1,1,1,1,1,−1,−1,−1,−1,−1,−1,1,1,1,1,1,1,−1,1,1,1,−1,−1,−1,−1,−1,−1,−1,1,1,−1,1,−1,1,1,−1,1,−1,1,−1,1,−1,−1,1,1,1,−1,1,−1,1,1,−1,−1,1,−1,−1,1,1,1,−1,1,−1,−1,1,−1,1,−1,1,−1,1,−1,1,1,−1,1,−1,−1,−1,1,−1,1,−1,1,1,−1,1,1,−1,1,1,1,−1,1,1,1,−1,−1,−1,−1,−1,1,−1,−1,−1,−1,1,−1,−1,1,1,−1,1,1,−1,1,−1,1,−1,1,−1,1,−1,−1,−1,−1,1,1,1,1,1,1,−1,−1,−1,1,1,−1,−1,−1,1,1,1,−1,1,−1,1,1,−1,−1,1,−1,1,1,−1,1,1,−1,1,−1,1,1,1,−1,1,1,−1,1,−1,1,−1,−1,1,−1,−1,1,−1,1,1,−1,−1,1,−1,1,1,1,−1,1,−1,1,1,−1,1,−1,1,−1,1,1,1,1,−1,−1,−1,1,−1,1,1,1,−1,1,1,1,1,1,1,−1,1,1,−1,−1,−1,1,1,1,−1,−1,−1,1,−1,−1,1,−1,1,−1,−1,−1,1,1,1,−1,−1,1,1,1,−1,−1,1,−1,1,1,1,−1,−1,−1,1,−1,−1,1,−1,1,−1,−1,−1,1,−1,−1,−1,1,1,−1,−1,−1,−1,−1,1,1,1,−1,−1,1, 1,1,1,1,−1,−1,1,−1,1,−1,1,1,1,−1,−1,1,−1,1,−1,1,−1,1,−1,1,1,1,1,1,1,1,−1,1,−1,−1,1,−1,−1,1,−1,−1,−1,−1,−1,1,1,−1,1,−1,1,1,−1,−1,1,1,1,−1,−1,1,1,1,−1,0,0,0,0,0,1,1,1,1,1,1,−1,−1,−1,1,1,−1,1,1,−1,1,−1,1,−1,−1,−1,−1,1,1,−1,−1,−1,1,−1,−1,1,−1,1,1,−1,1,−1,1,−1,1,−1,−1,1,−1,−1,−1,1,1,1,1,−1,−1,1,−1,−1,1,−1,1,−1,1,−1,−1,−1,1,1,−1,1,−1,1,−1,1,−1,1,1,1,−1,1,−1,−1,1,1,1,−1,−1,−1,−1,−1,1,−1,1,1,−1,1,1,−1,1,−1,1,−1,1,1,1,−1,−1,1,1,1,1,1,1,1,1,1,1,−1,−1,1,−1,−1,1,1,1,1,−1,−1,1,−1,−1,−1,−1,−1,1,1,1,−1,1,−1,−1,−1,1,−1,1,−1,1,1,1,1,−1,1,−1,1,−1,−1,−1,−1,1,−1,−1,−1,1,1,1,1,−1,−1,−1,1,−1,−1,−1,1,1,1,1,1,1,−1,−1,1,1,−1,1,1,1,1,−1,−1,−1,−1,−1,1,1,−1,1,1,−1,1,−1,−1,−1,−1,−1,−1,−1,−1,1,1,1,1,−1,−1,1,−1,1,1,1,−1,−1,−1,1,−1,1,−1,−1,−1,−1,1,1,1,−1,−1,1,1,1,−1,−1,1,1,−1,1,1,1,1,1,−1,−1,−1,1,1,1,1,−1,1,−1,1,1,1,−1,−1,1,1,−1,1,1,−1,1,1,−1,1,−1,1,1,1,1,1,1,−1,1,−1,1,−1,1,−1,1,1,1,−1,−1,−1,1,−1,−1,1,−1,−1,−1,−1,1,−1,−1,1,1,1,1,1,−1,1,1,1,−1,−1,−1,1,−1,1,−1,1,−1,−1,1,−1,1,−1,1,−1,1,1,−1,1,1,1,−1,−1,1,−1,−1,1,1,1,1,1,−1,−1,−1,−1,1,1,−1,1,−1,−1,−1,1,1,1,1,1,1,−1,1,−1,1,−1,1,−1,−1,−1,−1,1,1,1,1,−1,−1,−1,−1,−1,−1,−1,−1,1,1,1,−1,−1,1,1,1,1,−1,1,−1,1,−1,−1,1,1,1,−1,−1,1,1,−1,1,1,−1,1,1,1,−1,1,−1,1,−1,1,1,1,1,1,−1,−1,1,−1,1,−1,−1,1,−1,1,1,−1,−1,1,1,−1,−1,−1,−1,1,1,1,1,−1,−1,1,1,1,−1,−1,−1,1,−1,1,1,−1,−1,1,−1,−1,1,1,−1,−1,1,−1,−1,1,1,−1,1,−1,1,1,1,−1,1,−1,−1,−1,1,1,1,−1,−1,1,1,1,−1,−1,−1,−1,−1,1,1,1,−1,1,1,0,0,0,0,0,0,0,0,0,0,0,0,0,0,0,0,0,0,0,0,0,0,0,1,1,−1,1,1,−1,−1,−1,1,−1,−1,−1,−1,1,−1,1,1,−1,1,1,−1,1,1,−1,1,−1,−1,−1,1,−1,1,1,−1,1,−1,−1,1,−1,−1,1,1,1,1,1,1,1,−1,1,−1,1,1,1,−1,1,−1,1,1,−1,1,1,−1,−1,1,−1,−1,1,1,−1,−1,1,1,−1,−1,1,−1,−1,1,1,−1,−1,1,1,−1,−1,1,1,−1,1,1,1,1,1,1,−1,−1,−1,−1,−1,−1,−1,−1,1,1,−1,1,−1,−1,−1,1,1,−1,1,1,1,1,1,1,1,−1,1,1,−1,−1,−1,1,1,−1,1,1,−1,1,−1,−1,1,1,1,−1,−1,−1,1,−1,1,1,1,1,1,1,−1,1,−1,−1,−1,−1,1,−1,1,−1,1,1,1,−1,1,−1,−1,−1,−1,1,1,1,−1,−1,−1,−1,−1,1,1,−1,−1,−1,1,1,1,1,−1,−1,−1,−1,1,−1,1,−1,1,−1,−1,1,1,−1,−1,−1,1,−1,1,1,1,−1,−1,1,1,1,1,1,1,1,1,−1,1,−1,−1,−1,−1,1,−1,−1,−1,−1,−1,1,−1,1,1,1,1,1,1,−1,1,−1,−1,1,1,−1,1,−1,−1,1,−1,1,−1,1,1,−1,−1,−1,−1,1,1,1,1,−1,1,−1,1,−1,1,1,1,1,−1,1,1,1,1,−1,1,1,1,1,−1,−1,1,−1,1,1,−1,1,1,1,−1,1,−1,1,−1,−1,1,−1,−1,1,1,−1,−1,−1,1,−1,−1,1,1,1,−1,−1,−1,−1,−1,1,−1,−1,1,−1,−1,1,1,−1,−1,1,−1,1,−1,1,−1,1,−1,1,−1,1,1,−1,1,−1,−1,−1,−1,−1,1,1,−1,1,−1,−1,1,−1,1,1,−1,−1,1,−1,1,1,1,−1,1,1,1,1,−1,−1,−1,1,1,−1,−1,−1,1,1,−1,1,1,1,1,1,−1,−1,1,1,1,−1,−1,−1,1,−1,−1,1,1,1,−1,−1,−1,−1,−1,1,−1,1,−1,1,−1,−1,1,−1,1,−1,1,1,1,−1,1,1,1,1,1,−1,1,−1,1,1,1,1,1,1,−1,1,−1,−1,1,−1,−1,1,1,1,1,−1,1,−1,−1,−1,−1,−1,−1,−1,−1,−1,−1,1,1,−1,1,1,−1,1,1,−1,1,−1,1,−1,−1,1,−1,1,−1,1,−1,−1,−1,1,1,1,−1,1,1,1,1,−1,1,1,1,1,−1,1,1,1,−1,1,−1,−1,1,1,−1,1,1,0,0,0,0,0,−1,−1,1,1,−1,1,1,1,1,−1,−1,−1,−1,−1,1,1,1,1,1,1,1,−1,−1,1,−1,1,1,−1,−1,−1,−1,−1,1,1,1,1,1,1,1,−1,−1,−1,−1,1,−1,1,1,1,1,1,1,1,−1,−1,1,−1,−1,1,1,−1,1,1,1,1,−1,1,−1,−1,1,1,1,−1,−1,−1,1,1,1,1,−1,1,1,−1,1,−1,−1,−1,−1,−1,−1,1,−1,1,1,−1,1,−1,−1,−1,−1,−1,1,−1,1,1,1,1,1,−1,1,−1,1,−1,−1,1,1,1,1,1,−1,1,−1,1,1,−1,−1,1,1,1,−1,1,−1,−1,−1,−1,−1,1,−1,1,−1,−1,−1,−1,−1,−1,1,−1,−1,1,−1,1,−1,−1,−1,−1,1,−1,−1,1,1,−1,1,1,−1,1,1,1,−1,−1,1,1,1,1,−1,1,1,−1,1,−1,1,−1,1,−1,1,−1,−1,1,−1,1,−1,1,1,1,−1,−1,1,1,1,1,−1,1,−1,−1,1,1,−1,1,1,−1,−1,1,−1,−1,−1,−1,1,1,1,−1,1,1,−1,1,−1,1,−1,1,1,1,1,−1,1,−1,1,−1,−1,1,−1,−1,1,1,1,1,1,1,−1,1,−1,−1,1,−1,−1,−1,1,−1,1,1,−1,−1,1,−1,−1,−1,−1,1,1,1,−1,−1,−1,1,1,1,−1,1,−1,−1,−1,−1,−1,1,1,1,1,−1,1,1,1,−1,1,−1,1,1,−1,1,1,1,−1,−1,1,1,−1,1,−1,1,−1,1,−1,1,−1,1,−1,1,−1,1,−1,1,−1,−1,1,−1,1,1,−1,1,−1,−1,1,−1,1,−1,1,1,1,1,−1,1,−1,−1,−1,−1,−1,−1,−1,1,−1,1,1,1,−1,1,−1,1,1, 1,1,1,1,−1,1,−1,1,1,1,1,1,−1,1,−1,−1,1,1,1,−1,−1,−1,1,1,−1,−1,−1,−1,−1,1,−1,1,1,1,1,−1,−1,−1,1,−1,−1,−1,−1,−1,1,1,−1,1,1,1,−1,1,−1,−1,−1,−1,−1,1,−1,1,1,1,1,1,−1,1,−1,−1,−1,1,1,1,−1,−1,1,1,1,1,−1,1,−1,−1,1,−1,1,1, 1, 1, 1,1,1,1,−1,1,1,−1,−1,1,−1,1,1,−1,1,1,1,1,−1,−1,1,−1,1,1,−1,1,1,−1,1,1,−1,1,1,−1,1,−1,−1,1,−1,−1,1,−1,−1,1,1,−1,1,1,1,1,−1,1,−1,−1,−1,1,1,0,0,0,0,0,0,0,0,0}.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such a software may also be distributed in other forms, such as via the Internet or other wired or wireless telecommunication systems.

The elements of the disclosed devices, apparatus and systems may be implemented by corresponding hardware and/or software elements, for instance appropriated circuits. A circuit is a structural assemblage of electronic components including conventional circuit elements, integrated circuits including application specific integrated circuits, standard integrated circuits, application specific standard products, and field programmable gate arrays. Further a circuit includes central processing units, graphics processing units, and microprocessors which are programmed or configured according to software code. A circuit does not include pure software, although a circuit includes the above-described hardware executing software.

It follows a list of further embodiments of the disclosed subject matter:
1. First communication device configured to communicate with a second communication device, the first communication device comprising circuitry configured to:
   transmit a first training field comprising a channel estimation sequence for use by the second communication device to estimate the channel between the first communication device and the second communication device;
   transmit a second training field comprising a nonlinearity estimation sequence for use by the second communication device to estimate nonlinearities between the first and second communication devices, the second training field having a higher peak-to-average-power ratio and/or a different average power than the first training field;
   receive nonlinearity feedback from the second communication device with respect to the estimated nonlinearities; and
   use the received nonlinearity feedback to configure a subsequent transmission.
2. First communication device according to embodiment 1,
wherein the circuitry is configured to transmit a first data unit including the first training field and the second training field and to transmit one or more second data units, wherein the transmission of the one or more second data units has been configured by use of the received nonlinearity feedback.
3. First communication device according to any preceding embodiment,
wherein the circuitry is configured to select a nonlinearity estimation sequence for transmission in the second training field based on one or more of the total number of tones, a number of nonzero tones and an estimation order of the nonlinearity estimation sequence.
4. First communication device according to any preceding embodiment,
wherein the circuitry is configured to select a nonlinearity estimation sequence for transmission in the second training field from a group of nonlinearity estimation sequences, the group comprising the lists disclosed herein as List1 to List 24.
5. First communication device according to embodiment 4,
wherein the circuitry is configured to perform one or more of the following operations to the selected nonlinearity estimation sequence before transmitting it in the second training field:
   shifting the phase of the selected nonlinearity estimation sequence by an angle;
   flipping left and right in frequency domain to mirror the frequency axis;
   transforming the selected nonlinearity estimation sequence into the time domain;
   transforming the selected nonlinearity estimation sequence into the time domain and flipping left and right in the time domain to mirror the time axis;
   transforming the selected nonlinearity estimation sequence into the time domain and rearranging or permuting samples of the selected nonlinearity estimation sequence in time domain;
   transforming the selected nonlinearity estimation sequence into the time domain and concatenating a copy or a part of the selected nonlinearity estimation sequence or a cyclic prefix to the selected nonlinearity estimation sequence; and
   transforming the selected nonlinearity estimation sequence into the time domain and concatenating another selected nonlinearity estimation sequence after transforming it into the time domain.
6. First communication device according to any preceding embodiment,
wherein the circuitry is configured to transmit a third training field, in particular as part of a first data unit including the first training field and the second training field, the third training field being identical to the second training field or comprising a nonlinearity estimation sequence optimized for a different estimation order than the nonlinearity estimation sequence comprised in the second training field.
7. First communication device according to any preceding embodiment,
wherein the circuitry is configured to transmit, in particular as part of a first data unit including the first training field and the second training field, one or more of:
   a feedback estimation order indicator indicating the desired estimation order of the nonlinearity feedback;
   a transmission estimation order indicator indicating the estimation order of the nonlinearity estimation sequence comprised in the second training field; and
   another transmission estimation order indicator indicating the estimation order of a nonlinearity estimation sequence comprised in a third training field if a third training field is transmitted.
8. First communication device according to any preceding embodiment, wherein the circuitry is configured to use the received nonlinearity feedback to configure the subsequent transmission by one or more of:
   applying predistortion to one or more subsequent data units to be transmitted based on the received nonlinearity feedback before transmission of said one or more subsequent data units;
   transmitting a further second training field, in particular in another data unit comprising the first training field and the further second training field, the further second training field comprising a further nonlinearity estimation sequence, in particular having a different estimation order than the nonlinearity estimation sequence comprising in the second training field.
9. First communication device according to any preceding embodiment,
wherein the circuitry is configured to transmit, before transmitting the second training field, a nonlinearity estimation announcement,
   wherein the nonlinearity estimation announcement and the second training field are transmitted on a first frequency band, and
   wherein the nonlinearity estimation announcement instructs the second communication device to tune to a second frequency band different from the first frequency band, in particular a second frequency band that is adjacent to the first frequency band, during transmission of the second training field by the first communication device and optionally to tune to the first frequency band for transmission of the nonlinearity feedback to the first communication device.
10. First communication device according to embodiment 9,
wherein the circuitry is configured to reserve the second frequency band before transmitting the nonlinearity estimation announcement.
11. First communication device according to embodiment 9 or 10,
wherein the circuitry is configured to transmit the nonlinearity estimation announcement and to receive the nonlinearity feedback on a direct link or internal link between the first communication device and the second communication device.
12. First communication device according to any preceding embodiment,
wherein the circuitry is configured to transmit the first training field and the second training field on a first frequency band and to receive the nonlinearity feedback on a second frequency band different from the first frequency band, in particular a second frequency band that is adjacent to the first frequency band, or on a direct link or internal link between the first communication device and the second communication device.
13. First communication device according to any preceding embodiment,
wherein the circuitry is configured to
   transmit, before transmitting the second training field, a nonlinearity estimation announcement on a second frequency band,
   wherein the second training field is transmitted on a first frequency band and the nonlinearity estimation announcement is transmitted on a second frequency band different from the first frequency band, in particular a second frequency band that is adjacent to the first frequency band or on a direct link or internal link between the first communication device and the second communication device, and
   wherein the nonlinearity estimation announcement instructs the second communication device to tune to the first frequency band after reception of the second training field; and
   receive the nonlinearity feedback on the second frequency band or on the direct link or the internal link between the first communication device and the second communication device.
14. Second communication device configured to communicate with a first communication device, the second communication device comprising circuitry configured to:
   receive a first training field comprising a channel estimation sequence and a second training field comprising a nonlinearity estimation sequence, the second training field having a higher peak-to-average-power ratio and/or a different average power than the first training field;
   estimate nonlinearities between the first and second communication devices based on the received second training field; and
   transmit nonlinearity feedback with respect to the estimated nonlinearities to the first communication device.
15. Second communication device according to embodiment 14,
wherein the circuitry is configured to estimate, before estimating the nonlinearities, the channel between the first communication device and the second communication device based on the received first training field, and perform channel equalization applying the channel estimate on the second training field.
16. Second communication device according to embodiment 14 or 15,
wherein the circuitry is configured to include in the nonlinearity feedback one or more of:
   coefficients of a polynomial representing the nonlinearity;
   an optimal estimation order;
   a feedback estimation order; and
   an accuracy indicator indicating the accuracy of the estimated nonlinearities.
17. Second communication device according to embodiment 16,
wherein the circuitry is configured to determine the coefficients of a polynomial representing the nonlinearity based on an estimation matrix.
18. Second communication device according to embodiment 16 or 17,
wherein the circuitry is configured to determine the optimal estimation order based on a signal-to-noise ratio of the received second training field.
19. Second communication device according to any of embodiments 16 to 18,
wherein the circuitry is configured to determine the accuracy of the nonlinearities using one or more of:
   a correctly received data field within a first data unit comprising the first training field and the second training field;
   a received third training field of the first PPDU, the third training field being identical to the second training field or comprising a nonlinearity estimation sequence optimized for a different estimation order than the nonlinearity estimation sequence comprised in the second training field; and
   a received further second training field.
20. Second communication device according to any of embodiments 14 to 19,
wherein the circuitry is configured to
   receive a third training field, in particular as part of a first data unit including the first training field and the second training field, the third training field being identical to the second training field or comprising a nonlinearity estimation sequence optimized for a different estimation order than the nonlinearity estimation sequence comprised in the second training field;
   estimate nonlinearities between the first and second communication devices by use of the received third training field and/or determine the accuracy of the nonlinearities estimated by use of the received second training field; and
   transmit the nonlinearity feedback including information with respect to the nonlinearities estimated by use of the received second training field and/or information with respect to the nonlinearities estimated by use of the third training field.
21. Second communication device according to any of embodiments 14 to 20,
wherein the circuitry is configured to
   receive, before receiving the second training field, a nonlinearity estimation announcement on a first frequency band;
   tune to a second frequency band different from the first frequency band, in particular a second frequency band that is adjacent to the first frequency band, during transmission of the second training field by the first communication device and receive out-of-band emissions caused by the transmission of the second training field by the first communication device; and
   tune to the first frequency band and transmit the nonlinearity feedback to the first communication device.
22. Second communication device according to any of embodiments 14 to 21,
wherein the circuitry is configured to perform self-interference cancellation based on the estimated nonlinearities and one or more data units received from the first communication device after reception of a first data unit including the first training field and the second training field.
23. First communication method of a first communication device configured to communicate with a second communication device, the first communication method comprising:
   transmitting a first training field comprising a channel estimation sequence for use by the second communication device to estimate the channel between the first communication device and the second communication device;
   transmitting a second training field comprising a nonlinearity estimation sequence for use by the second communication device to estimate nonlinearities between the first and second communication devices, the second training field having a higher peak-to-average-power ratio and/or a different average power than the first training field;
   receiving nonlinearity feedback from the second communication device with respect to the estimated nonlinearities; and
   using the received nonlinearity feedback to configure a subsequent transmission.
24. Second communication method of a second communication device configured to communicate with a first communication device, the second communication method comprising:
   receiving a first training field comprising a channel estimation sequence and a second training field comprising a nonlinearity estimation sequence, the second training field having a higher peak-to-average-power ratio and/or a different average power than the first training field;
   estimating nonlinearities between the first and second communication devices based on the received second training field; and
   transmitting nonlinearity feedback with respect to the estimated nonlinearities to the first communication device.
25. A non-transitory computer-readable recording medium that stores therein a computer program product, which, when executed by a processor, causes the method according to embodiment 23 or 24 to be performed.
26. A computer program comprising program code means for causing a computer to perform the steps of said method according to embodiment 23 or 24 when said computer program is carried out on a computer.

1. First communication device configured to communicate with a second communication device, the first communication device comprising circuitry configured to:
transmit a first training field comprising a channel estimation sequence for use by the second communication device to estimate the channel between the first communication device and the second communication device;
transmit a second training field comprising a nonlinearity estimation sequence for use by the second communication device to estimate nonlinearities between the first and second communication devices, the second training field having a higher peak-to-average-power ratio and/or a different average power than the first training field;
receive nonlinearity feedback from the second communication device with respect to the estimated nonlinearities; and
use the received nonlinearity feedback to configure a subsequent transmission.

2. First communication device according to claim 1,
wherein the circuitry is configured to transmit a first data unit including the first training field and the second training field and to transmit one or more second data units, wherein the transmission of the one or more second data units has been configured by use of the received nonlinearity feedback.

3. First communication device according to claim 1,
wherein the circuitry is configured to select a nonlinearity estimation sequence for transmission in the second training field based on one or more of the total number of tones, a number of nonzero tones and an estimation order of the nonlinearity estimation sequence.

4. First communication device according to claim 1,
wherein the circuitry is configured to select a nonlinearity estimation sequence for transmission in the second training field from a group of nonlinearity estimation sequences, the group comprising:
List1
For 20 MHz transmission, the N-TF sequence with the format of an LSTF20, optimized for estimation order P=3, is given by:
N-TF(LSTF20,P=3)=sqrt(64/12)·{0,0,0,0,0,0,0,0,−1,0,0,0,−1,0,0,0,−1,0,0,0,−1,0,0,0,−1,0,0,0,1,0,0,0,0,0,0,0,−1,0,0,0,−1,0,0,0,−1,0,0,0,−1,0,0,0,−1,0,0,0,1,0,0,0,0,0,0,0}
For 20 MHz transmission, the N-TF sequence with the format of an LSTF20, optimized for estimation order P=4, is given by:
N-TF(LSTF20,P=4)=sqrt(64/12)·{0,0,0,0,0,0,0,0,−1,0,0,0,−1,0,0,0,1,0,0,0,−1,0,0,0,−1,0,0,0,−1,0,0,0,0,0,0,0,−1,0,0,0,−1,0,0,0,−1,0,0,0,1,0,0,0,−1,0,0,0,−1,0,0,0,0,0,0,0}
For 20 MHz transmission, the N-TF sequence with the format of an LSTF20, optimized for estimation order P=5, is given by:
N-TF(LSTF20,P=5)=sqrt(64/12)·{0,0,0,0,0,0,0,0,−1,0,0,0,−1,0,0,0,−1,0,0,0,−1,0,0,0,−1,0,0,0,1,0,0,0,0,0,0,0,1,0,0,0,−1,0,0,0,−1,0,0,0,−1,0,0,0,−1,0,0,0,−1,0,0,0,0,0,0,0}
For 20 MHz transmission, the N-TF sequence with the format of an LSTF20, optimized for estimation order P=6, is given by:
N-TF(LSTF20,P=6)=sqrt(64/12)·{0,0,0,0,0,0,0,0,1,0,0,0,−1,0,0,0,−1,0,0,0,−1,0,0,0,1,0,0,0,−1,0,0,0,0,0,0,0,−1,0,0,0,1,0,0,0,−1,0,0,0,−1,0,0,0,−1,0,0,0,1,0,0,0,0,0,0,0}
For 20 MHz transmission, the N-TF sequence with the format of an LSTF20, optimized for estimation order P=7, is given by:
N-TF(LSTF20,P=7)=sqrt(64/12)·{0,0,0,0,0,0,0,0,−1,0,0,0,−1,0,0,0,−1,0,0,0,−1,0,0,0,−1,0,0,0,−1,0,0,0,0,0,0,0,1,0,0,0,1,0,0,0,−1,0,0,0,−1,0,0,0,−1,0,0,0,1,0,0,0,0,0,0,0}
For 20 MHz transmission, the N-TF sequence with the format of an LSTF20, optimized for estimation order P=8, is given by:
N-TF(LSTF20,P=8)=sqrt(64/12)·{0,0,0,0,0,0,0,0,−1,0,0,0,−1,0,0,0,−1,0,0,0,1,0,0,0,1,0,0,0,1,0,0,0,0,0,0,0,−1,0,0,0,−1,0,0,0,−1,0,0,0,−1,0,0,0,1,0,0,0,1,0,0,0,0,0,0,0}
For 20 MHz transmission, the N-TF sequence with the format of an LSTF20, optimized for estimation order P=9, is given by:
N-TF(LSTF20,P=9)=sqrt(64/12)·{0,0,0,0,0,0,0,0,1,0,0,0,−1,0,0,0,1,0,0,0,−1,0,0,0,1,0,0,0,−1,0,0,0,0,0,0,0,1,0,0,0,1,0,0,0,−1,0,0,0,−1,0,0,0,1,0,0,0,1,0,0,0,0,0,0,0}
For 20 MHz transmission, the N-TF sequence with the format of an LSTF20, optimized for estimation order P=10, is given by:
N-TF(LSTF20,P=10)=sqrt(64/12)·{0,0,0,0,0,0,0,0,−1,0,0,0,−1,0,0,0,−1,0,0,0,1,0,0,0,1,0,0,0,1,0,0,0,0,0,0,0,−1,0,0,0,−1,0,0,0,1,0,0,0,−1,0,0,0,−1,0,0,0,−1,0,0,0,0,0,0,0}
List2
For 20 MHz transmission, the N-TF sequence with the format of an LLTF20, optimized for estimation order P=3, is given by:
N-TF(LLTF20,P=3)=sqrt(64/52)·{0,0,0,0,0,0,−1,−1,1,1,−1,1,−1,1,−1,1,−1,1,−1,1,−1,1,1,1,−1,1,−1,1,−1,1,−1,−1,0,−1,1,1,1,1,1,1,1,−1,−1,1,1,1,−1,1,−1,1,−1,1,−1,1,−1,1,−1,1,−1,0,0,0,0,0}
For 20 MHz transmission, the N-TF sequence with the format of an LLTF20, optimized for estimation order P=4, is given by:
N-TF(LLTF20,P=4)=sqrt(64/52)·{0,0,0,0,0,0,1,−1,−1,1,−1,−1,−1,−1,−1,−1,−1,1,−1,−1,−1,1,−1,1,−1,1,−1,−1,−1,1,−1,−1,0,1,−1,−1,−1,−1,−1,−1,−1,−1,−1,−1,−1,−1,−1,1,−1,−1,−1,1,−1,1,−1,1,−1,1,1,0,0,0,0,0}
For 20 MHz transmission, the N-TF sequence with the format of an LLTF20, optimized for estimation order P=5, is given by:
N-TF(LLTF20,P=5)=sqrt(64/52)·{0,0,0,0,0,0,−1,−1,1,1,1,1,1,1,1,1,−1,1,−1,1,−1,1,−1,1,−1,1,−1,1,1,1,1,1,0,1,1,1,1,1,1,1,−1,1,−1,1,−1,1,−1,1,1,1,−1,1,1,1,1,1,1,1,1,0,0,0,0,0}
For 20 MHz transmission, the N-TF sequence with the format of an LLTF20, optimized for estimation order P=6, is given by:
N-TF(LLTF20,P=6)=sqrt(64/52)·{0,0,0,0,0,0,1,1,1,1,1,1,1,1,1,1,1,1,−1,1,−1,1,−1,1,−1,1,−1,1,−1,1,−1,1,0,1,−1,−1,−1,1,−1,1,1,1,1,1,1,1,1,1,1,1,1,1,−1,1,−1,1,−1,1,−1,0,0,0,0,0}
For 20 MHz transmission, the N-TF sequence with the format of an LLTF20, optimized for estimation order P=7, is given by:
N-TF(LLTF20,P=7)=sqrt(64/52)·{0,0,0,0,0,0,−1,1,−1,1,−1,1,−1,1,−1,1,1,1,1,1,1,1,1,1,1,1,1,1,1,1,1,1,0,1,1,1,−1,1,−1,1,−1,1,−1,1,−1,1,−1,1,−1,1,−1,1,−1,1, 1, 1, 1, 1, 1,0,0,0,0,0}
For 20 MHz transmission, the N-TF sequence with the format of an LLTF20, optimized for estimation order P=8, is given by:
N-TF(LLTF20,P=8)=sqrt(64/52)·{0,0,0,0,0,0,−1,−1,−1,−1,−1,−1,−1,−1,−1,−1,−1,−1,−1,−1,−1,−1,−1,−1,−1,−1,−1,1,−1,1,−1,1,0,1,−1,1,−1,1,−1,1,−1,1,−1,1,−1,1,−1,1,−1,1,−1,−1,−1,−1,−1,−1,−1,−1,−1,0,0,0,0,0}
For 20 MHz transmission, the N-TF sequence with the format of an LLTF20, optimized for estimation order P=9, is given by:
N-TF(LLTF20,P=9)=sqrt(64/52)·{0,0,0,0,0,0,−1,1,−1,1,−1,1,1,−1,−1,1,1,−1,1,1,−1,1,−1,1,−1,1,1,−1,1,1,−1,1,0,1,−1,1,−1,1,−1,−1,1,−1,−1,1,−1,−1,−1,1,−1,−1,−1,1,−1,−1,1,−1,−1,1,−1,0,0,0,0,0}
For 20 MHz transmission, the N-TF sequence with the format of an LLTF20, optimized for estimation order P=10, is given by:
N-TF(LLTF20,P=10)=sqrt(64/52)·{0,0,0,0,0,0,−1,−1,−1,−1,−1,−1,−1,−1,−1,−1,1,−1,−1,−1,−1,1,−1,−1,1,−1,−1,−1,−1,1,−1,−1,0,−1,−1,−1,1,−1,−1,1,1,−1,1,−1,−1,1,−1,−1,−1,−1,−1,1,1,−1,−1,1,−1,−1,−1,0,0,0,0,0}
List3
For 20 MHz transmission, the N-TF sequence with the format of an VHTLTF20, optimized for estimation order P=3, is given by:
N-TF(VHTLTF20,P=3)=sqrt(64/56)·{0,0,0,0,−1,−1,−1,−1,1,−1,−1,−1,−1,−1,1,−1,1,−1,−1,−1,1,−1,1,−1,1,−1,−1,−1,−1,−1,−1,−1,0,−1,1,−1,1,−1,−1,−1,−1,−1,−1,−1,−1,1,−1,−1,−1,1,−1,1,−1,−1,−1,1,−1,−1,−1,1,−1,0,0,0}
For 20 MHz transmission, the N-TF sequence with the format of an VHTLTF20, optimized for estimation order P=4, is given by:
N-TF(VHTLTF20,P=4)=sqrt(64/56)·{0,0,0,0,1,1,−1,−1,1,−1,1,−1,1,−1,1,−1,1,−1,−1,−1,1,−1,−1,−1,1,−1,−1,−1,−1,−1,−1,−1,0,−1,−1,−1,−1,−1,1,−1,−1,−1,1,−1,−1,−1,1,−1,−1,−1,1,−1,−1,−1,−1,−1,−1,−1,1,1,−1,0,0,0}
For 20 MHz transmission, the N-TF sequence with the format of an VHTLTF20, optimized for estimation order P=5, is given by:
N-TF(VHTLTF20,P=5)=sqrt(64/56)·{0,0,0,0,−1,−1,1,−1,−1,−1,1,−1,−1,−1,−1,−1,−1,−1,−1,−1,1,−1,1,−1,1,−1,−1,−1,1,1,1,−1,0, 1,1,−1,−1,−1,1,−1,1,−1,1,−1,−1,−1,−1,−1,1,−1,−1,−1,1,−1,−1,−1,1,−1,−1,−1,1,0,0,0}
For 20 MHz transmission, the N-TF sequence with the format of an VHTLTF20, optimized for estimation order P=6, is given by:
N-TF(VHTLTF20,P=6)=sqrt(64/56)·{0,0,0,0,−1,−1,1,−1,−1,−1,−1,−1,1,−1,−1,−1,−1,−1,1,−1,−1,−1,1,−1,−1,−1,−1,−1,1,−1,−1,−1,0,−1,1,−1,−1,−1,1,−1,1,−1,1,−1,1,−1,−1,1,1,−1,1,−1,−1,−1,1,−1,1,−1,−1,−1,1,0,0,0}
For 20 MHz transmission, the N-TF sequence with the format of an VHTLTF20, optimized for estimation order P=7, is given by:
N-TF(VHTLTF20,P=7)=sqrt(64/56)·{0,0,0,0,−1,1,−1,1,−1,−1,−1,1,−1,−1,−1,−1,−1,1,−1,−1,−1,1,−1,1,−1,−1,−1,1,−1,−1,−1,−1,0,1,−1,−1,−1,1,−1,1,−1,−1,−1,1,−1,−1,−1,−1,−1,1,−1,−1,−1,1,−1,1,−1,−1,−1,1, 1,0,0,0}
For 20 MHz transmission, the N-TF sequence with the format of an VHTLTF20, optimized for estimation order P=8, is given by:
N-TF(VHTLTF20,P=8)=sqrt(64/56)·{0,0,0,0,1,−1,−1,−1,−1,−1,1,−1,−1,−1,1,−1,1,−1,−1,−1,1,−1,−1,−1,−1,−1,1,−1,−1,−1,1,1,0,−1,−1,−1,1,−1,−1,−1,−1,−1,1,−1,−1,−1,1,−1,1,−1,−1,−1,1,−1,−1,−1,−1,−1,−1,−1,−1,0,0,0}
For 20 MHz transmission, the N-TF sequence with the format of an VHTLTF20, optimized for estimation order P=9, is given by:
N-TF(VHTLTF20,P=9)=sqrt(64/56)·{0,0,0,0,1,1,1,1,−1,−1,1,1,−1,1,1,1,−1,1,1,1,−1,1,1,1,−1,1,−1,1,−1,1,−1,1,0,1,−1,1,−1,1,−1,1,1,1,−1,1,1,1,−1,1,1,1,−1,1,1,−1,−1,1,1,1,1,1,1,0,0,0}
For 20 MHz transmission, the N-TF sequence with the format of an VHTLTF20, optimized for estimation order P=10, is given by:
N-TF(VHTLTF20,P=10)=sqrt(64/56)·{0,0,0,0,−1,−1,1,−1,−1,1,−1,−1,1,−1,−1,−1,−1,1,−1,1,−1,1,−1,−1,−1,−1,−1,−1,−1,1,1,−1,0,−1,−1,−1,−1,−1,−1,−1,−1,−1,−1,−1,−1,1,−1,−1,−1,−1,1,−1,1,−1,1,−1,−1,−1,−1,−1,−1,0,0,0}
List4
For 40 MHz transmission, the N-TF sequence with the format of an LSTF40, optimized for estimation order P=3, is given by:
N-TF(LSTF40,P=3)=sqrt(128/24)·{0,0,0,0,0,0,0,0,1,0,0,0,−1,0,0,0,−1,0,0,0,−1,0,0,0,−1,0,0,0,−1,0,0,0,0,0,0,0,−1,0,0,0,1,0,0,0,−1,0,0,0,−1,0,0,0,−1,0,0,0,−1,0,0,0,0,0,0,0,0,0,0,0,0,0,0,0,1,0,0,0,−1,0,0,0,−1,0,0,0,1,0,0,0,−1,0,0,0,−1,0,0,0,0,0,0,0,−1,0,0,0,1,0,0,0,−1,0,0,0,−1,0,0,0,−1,0,0,0,−1,0,0,0,0,0,0,0}
For 40 MHz transmission, the N-TF sequence with the format of an LSTF40, optimized for estimation order P=4, is given by:
N-TF(LSTF40,P=4)=sqrt(128/24)·{0,0,0,0,0,0,0,0,−1,0,0,0,−1,0,0,0,1,0,0,0,1,0,0,0,1,0,0,0,−1,0,0,0,0,0,0,0,−1,0,0,0,1,0,0,0,1,0,0,0,1,0,0,0,−1,0,0,0,1,0,0,0,0,0,0,0,0,0,0,0,0,0,0,0,1,0,0,0,−1,0,0,0,1,0,0,0,1,0,0,0,1,0,0,0,−1,0,0,0,0,0,0,0,−1,0,0,0,1,0,0,0,1,0,0,0,1,0,0,0,−1,0,0,0,1,0,0,0,0,0,0,0}
For 40 MHz transmission, the N-TF sequence with the format of an LSTF40, optimized for estimation order P=5, is given by:
N-TF(LSTF40,P=5)=sqrt(128/24)·{0,0,0,0,0,0,0,0,−1,0,0,0,1,0,0,0,−1,0,0,0,1,0,0,0,−1,0,0,0,−1,0,0,0,0,0,0,0,1,0,0,0,−1,0,0,0,1,0,0,0,−1,0,0,0,1,0,0,0,1,0,0,0,0,0,0,0,0,0,0,0,0,0,0,0,−1,0,0,0,1,0,0,0,−1,0,0,0,1,0,0,0,−1,0,0,0,−1,0,0,0,0,0,0,0,1,0,0,0,−1,0,0,0,1,0,0,0,−1,0,0,0,1,0,0,0,1,0,0,0,0,0,0,0}
For 40 MHz transmission, the N-TF sequence with the format of an LSTF40, optimized for estimation order P=6, is given by:
N-TF(LSTF40,P=6)=sqrt(128/24)·{0,0,0,0,0,0,0,0,1,0,0,0,−1,0,0,0,−1,0,0,0,−1,0,0,0,1,0,0,0,−1,0,0,0,0,0,0,0,−1,0,0,0,1,0,0,0,1,0,0,0,1,0,0,0,−1,0,0,0,1,0,0,0,0,0,0,0,0,0,0,0,0,0,0,0,−1,0,0,0,−1,0,0,0,1,0,0,0,−1,0,0,0,−1,0,0,0,−1,0,0,0,0,0,0,0,1,0,0,0,1,0,0,0,−1,0,0,0,1,0,0,0,1,0,0,0,1,0,0,0,0,0,0,0}
For 40 MHz transmission, the N-TF sequence with the format of an LSTF40, optimized for estimation order P=7, is given by:
N-TF(LSTF40,P=7)=sqrt(128/24)·{0,0,0,0,0,0,0,0,−1,0,0,0,−1,0,0,0,1,0,0,0,−1,0,0,0,−1,0,0,0,−1,0,0,0,0,0,0,0,−1,0,0,0,1,0,0,0,−1,0,0,0,−1,0,0,0,−1,0,0,0,1,0,0,0,0,0,0,0,0,0,0,0,0,0,0,0,1,0,0,0,−1,0,0,0,1,0,0,0,−1,0,0,0,−1,0,0,0,−1,0,0,0,0,0,0,0,−1,0,0,0,1,0,0,0,−1,0,0,0,−1,0,0,0,−1,0,0,0,1,0,0,0,0,0,0,0}
For 40 MHz transmission, the N-TF sequence with the format of an LSTF40, optimized for estimation order P=8, is given by:
N-TF(LSTF40,P=8)=sqrt(128/24)·{0,0,0,0,0,0,0,0,1,0,0,0,1,0,0,0,1,0,0,0,−1,0,0,0,−1,0,0,0,1,0,0,0,0,0,0,0,1,0,0,0,−1,0,0,0,1,0,0,0,−1,0,0,0,1,0,0,0,1,0,0,0,0,0,0,0,0,0,0,0,0,0,0,0,1,0,0,0,1,0,0,0,1,0,0,0,1,0,0,0,−1,0,0,0,1,0,0,0,0,0,0,0,1,0,0,0,1,0,0,0,1,0,0,0,−1,0,0,0,1,0,0,0,1,0,0,0,0,0,0,0}
For 40 MHz transmission, the N-TF sequence with the format of an LSTF40, optimized for estimation order P=9, is given by:
N-TF(LSTF40,P=9)=sqrt(128/24)·{0,0,0,0,0,0,0,0,1,0,0,0,1,0,0,0,1,0,0,0,−1,0,0,0,1,0,0,0,−1,0,0,0,0,0,0,0,−1,0,0,0,1,0,0,0,−1,0,0,0,1,0,0,0,−1,0,0,0,1,0,0,0,0,0,0,0,0,0,0,0,0,0,0,0,1,0,0,0,−1,0,0,0,1,0,0,0,−1,0,0,0,1,0,0,0,−1,0,0,0,0,0,0,0,−1,0,0,0,1,0,0,0,−1,0,0,0,1,0,0,0,−1,0,0,0,1,0,0,0,0,0,0,0}
For 40 MHz transmission, the N-TF sequence with the format of an LSTF40, optimized for estimation order P=10, is given by:
N-TF(LSTF40,P=10)=sqrt(128/24)·{0,0,0,0,0,0,0,0,−1,0,0,0,−1,0,0,0,−1,0,0,0,−1,0,0,0,−1,0,0,0,−1,0,0,0,0,0,0,0,−1,0,0,0,−1,0,0,0,−1,0,0,0,−1,0,0,0,−1,0,0,0,−1,0,0,0,0,0,0,0,0,0,0,0,0,0,0,0,−1,0,0,0,−1,0,0,0,−1,0,0,0,−1,0,0,0,−1,0,0,0,−1,0,0,0,0,0,0,0,−1,0,0,0,−1,0,0,0,−1,0,0,0,−1,0,0,0,1,0,0,0,−1,0,0,0,0,0,0,0}
List5
For 40 MHz transmission, the N-TF sequence with the format of an LLTF40, optimized for estimation order P=3, is given by:
N-TF(LLTF40,P=3)=sqrt(128/104)·{0,0,0,0,0,0,−1,−1,1,−1,−1,1,1,−1,1,1,1,−1,1,−1,1,−1,−1,1,1,−1,1,−1,1,−1,1,−1,0,−1,1,−1,−1,−1,1,−1,−1,−1,1,−1,1,1,1,−1,1,−1,−1,1,1,−1,1,−1,−1,1,1,0,0,0,0,0,0,0,0,0,0,0,1,−1,1,−1,1,1,1,−1,1,1,−1,1,1,−1,1,−1,1,−1,1,−1,1,1,1,−1,−1,−1,0,−1,−1,1,1,1,1,1,−1,1,1,−1,1,1,−1,−1,1,−1,−1,1,1,−1,1,1,1,−1,1,0,0,0,0,0}
For 40 MHz transmission, the N-TF sequence with the format of an LLTF40, optimized for estimation order P=4, is given by:
N-TF(LLTF40,P=4)=sqrt(128/104)·{0,0,0,0,0,0,−1,1,−1,1,−1,1,−1,1,1,−1,−1,−1,−1,−1,−1,−1,−1,−1,−1,−1,−1,−1,1,−1,−1,−1,0,1,−1,−1,−1,1,−1,1,−1,1,−1,1,−1,−1,−1,1,−1,−1,1,1,1,−1,−1,−1,1,1,−1,0,0,0,0,0,0,0,0,0,0,0,−1,−1,−1,−1,−1,1,−1,−1,−1,−1,−1,1,−1,1,−1,1,−1,1,−1,1,−1,1,−1,1,−1,1,0,−1,−1,1,1,−1,−1,−1,−1,−1,−1,−1,−1,−1,−1,−1,−1,1,−1,−1,−1,−1,−1,1,−1,−1,−1,0,0,0,0,0}
For 40 MHz transmission, the N-TF sequence with the format of an LLTF40, optimized for estimation order P=5, is given by:
N-TF(LLTF40,P=5)=sqrt(128/104)·{0,0,0,0,0,0,−1,−1,−1,1,−1,−1,1,1,−1,1,−1,−1,−1,−1,−1,1,−1,−1,1,1,−1,1,−1,1,−1,−1,0,−1,−1,1,−1,1,−1,−1,−1,1,−1,−1,−1,−1,1,1,−1,−1,−1,−1,−1,−1,−1,−1,−1,1,−1,0,0,0,0,0,0,0,0,0,0,0,−1,1,−1,1,1,−1,−1,−1,−1,1,−1,−1,−1,1,−1,−1,−1,−1,1,−1,−1,−1,−1,1,−1,1,0,1,−1,1,−1,−1,1,−1,−1,1,−1,1,−1,−1,−1,1,−1,−1,−1,−1,1,−1,−1,1,−1,1,−1,0,0,0,0,0}
For 40 MHz transmission, the N-TF sequence with the format of an LLTF40, optimized for estimation order P=6, is given by:
N-TF(LLTF40,P=6)=sqrt(128/104)·{0,0,0,0,0,0,−1,−1,−1,−1,−1,−1,1,−1,1,−1,1,1,−1,1,1,−1,1,−1,1,−1,1,1,−1,−1,−1,−1,0,−1,1,−1,1,−1,−1,1,1,−1,1,−1,−1,−1,1,1,1,−1,−1,−1,−1,−1,−1,1,1,−1,−1,0,0,0,0,0,0,0,0,0,0,0,−1,−1,−1,−1,−1,−1,1,−1,1,−1,−1,−1,−1,1,−1,−1,1,−1,1,−1,1,1,1,−1,−1,−1,0,−1,1,−1,1,−1,−1,−1,−1,−1,−1,−1,1,−1,−1,−1,1,−1,−1,−1,−1,−1,1,−1,1,−1,1,0,0,0,0,0}
For 40 MHz transmission, the N-TF sequence with the format of an LLTF40, optimized for estimation order P=7, is given by:
N-TF(LLTF40,P=7)=sqrt(128/104)·{0,0,0,0,0,0,−1,−1,−1,−1,−1,−1,−1,−1,−1,−1,−1,−1,1,−1,1,−1,1,−1,1,−1,−1,−1,−1,−1,1,−1,0,−1,1,−1,−1,1,−1,−1,−1,−1,−1,−1,1,−1,−1,−1,−1,−1,1,1,1,−1,1,−1,1,−1,1,0,0,0,0,0,0,0,0,0,0,0,−1,−1,−1,−1,−1,−1,1,−1,−1,−1,−1,1,1,−1,1,−1,1,−1,1,1,−1,−1,1,−1,1,1,0,1,1,−1,−1,−1,−1,−1,−1,−1,−1,−1,−1,−1,−1,−1,−1,−1,1,−1,1,−1,1,−1,1,−1,−1,0,0,0,0,0}
For 40 MHz transmission, the N-TF sequence with the format of an LLTF40, optimized for estimation order P=8, is given by:
N-TF(LLTF40,P=8)=sqrt(128/104)·{0,0,0,0,0,0,−1,1,−1,1,−1,−1,1,−1,1,1,−1,1,−1,1,−1,1,−1,1,−1,−1,1,−1,−1,1,−1,−1,0,1,−1,1,1,−1,1,1,−1,1,−1,−1,1,−1,−1,1,−1,−1,1,−1,−1,1,−1,1,−1,1,−1,0,0,0,0,0,0,0,0,0,0,0,−1,1,−1,1,−1,−1,1,−1,−1,1,−1,1,−1,1,−1,1,−1,1,−1,−1,1,−1,−1,1,−1,1,0,1,−1,−1,1,−1,1,1,−1,1,−1,1,1,1,−1,1,−1,−1,1,−1,−1,1,−1,1,−1,1,−1,0,0,0,0,0}
For 40 MHz transmission, the N-TF sequence with the format of an LLTF40, optimized for estimation order P=9, is given by:
N-TF(LLTF40,P=9)=sqrt(128/104)·{0,0,0,0,0,0,1,1,−1,1,1,1,−1,1,1,1,−1,1,−1,1,−1,1,−1,−1,−1,1,−1,−1,−1,1,1,−1,0,−1,1,1,1,−1,−1,1,1,1,−1,−1,1,1,−1,1,−1,1,−1,1,−1,−1,−1,1,−1,−1,−1,0,0,0,0,0,0,0,0,0,0,0,1,1,−1,1,1,1,−1,1,−1,1,−1,1,−1,1,−1,1,−1,−1,−1,1,−1,−1,−1,1,1,−1,0,−1,1,1,1,−1,−1,1,1,1,−1,−1,1,1,−1,1,−1,1,−1,1,−1,−1,−1,1,−1,−1,−1,0,0,0,0,0}
For 40 MHz transmission, the N-TF sequence with the format of an LLTF40, optimized for estimation order P=10, is given by:
N-TF(LLTF40,P=10)=sqrt(128/104)·{0,0,0,0,0,0,1,−1,1,−1,1,−1,1,−1,1,−1,1,1,1,1,1,−1,−1,−1,1,1,1,1,1,−1,1,−1,0,−1,1,−1,1,1,1,1,1,1,1,1,1,−1,−1,−1,1,1,1,1,1,−1,−1,−1,1,1,1,0,0,0,0,0,0,0,0,0,0,0,1,−1,1,−1,1,1,1,−1,1,−1,1,1,1,1,−1,−1,−1,−1,1,1,1,1,1,−1,1,−1,0,−1,1,−1,1,1,1, 1, 1, 1,1,1,1,−1,−1,−1,1,1,1,1,−1,−1,−1,1,1,1,0,0,0,0,0}
List6
For 40 MHz transmission, the N-TF sequence with the format of an VHTLTF40, optimized for estimation order P=3, is given by:
N-TF(VHTLTF40,P=3)=sqrt(128/114)·{0,0,0,0,0,0,1,−1,−1,−1,1,−1,1,−1,1,1,1,−1,1,−1,1,−1,1,1,1,−1,−1,−1,1,−1,1,1,1,1,1,−1,1,1,1,−1,1, 1, 1, 1,−1,1,1,1,−1,−1,1,−1,1,−1,−1,−1,1,−1,1,−1,1,1,−1,0,0,0,−1,1,−1,1,1,−1,−1,−1,1,−1,1,−1,1,−1,−1,−1,1,1,1,−1,−1,1,−1,1,−1,−1,1,−1,1,−1,1,−1,1,−1,1,1,1,−1,−1,−1,1,−1,1,−1,−1,1,1,−1,−1,1,1,−1,1,−1,1,−1,1,0,0,0,0,0}
For 40 MHz transmission, the N-TF sequence with the format of an VHTLTF40, optimized for estimation order P=4, is given by:
N-TF(VHTLTF40,P=4)=sqrt(128/114)·{0,0,0,0,0,0,1,−1,−1,1,−1,1,1,−1,−1,1,−1,1,−1,−1,−1,−1,−1,−1,−1,1,−1,−1,−1,1,−1,1,−1,1,−1,−1,−1,1,−1,1,−1,1,−1,1,−1,1,−1,1,−1,−1,−1,1,−1,−1,−1,−1,−1,1,−1,−1,−1,1,−1,0,0,0,1,1,−1,1,−1,1,1,1,−1,−1,−1,1,−1,−1,−1,−1,−1,1,−1,−1,−1,1,−1,−1,−1,1,−1,1,−1,−1,−1,1,1,1,−1,−1,−1,−1,−1,1,−1,1,1,−1,1,−1,−1,−1,−1,−1,−1,−1,1,−1,−1,−1,−1,0,0,0,0,0}
For 40 MHz transmission, the N-TF sequence with the format of an VHTLTF40, optimized for estimation order P=5, is given by:
N-TF(VHTLTF40,P=5)=sqrt(128/114)·{0,0,0,0,0,0,−1,1,1,−1,−1,−1,−1,1,−1,1,−1,1,1,1,−1,−1,−1,1,1,−1,−1,1,−1,1,−1,−1,−1,1,−1,1,−1,−1,1,1,−1,−1,−1,1,−1,1,1,−1,−1,1,−1,−1,−1,1,1,−1,−1,−1,1,1,−1,1,−1,0,0,0,−1,1,1,1,−1,1,−1,1,−1,1,−1,−1,−1,1,1,−1,−1,−1,−1,−1,−1,1,−1,1,−1,−1,−1,−1,−1,1,−1,−1,−1,−1,−1,−1,−1,−1,−1,1,−1,−1,−1,−1,−1,−1,−1,−1,−1,1,−1,1,−1,−1,−1,−1,−1,0,0,0,0,0}
For 40 MHz transmission, the N-TF sequence with the format of an VHTLTF40, optimized for estimation order P=6, is given by:
N-TF(VHTLTF40,P=6)=sqrt(128/114)·{0,0,0,0,0,0,−1,−1,−1,1,1,1,1,1,1,1,1,1,−1,1,1,−1,1,−1,−1,−1,−1,−1,1,1,−1,1,−1,1,−1,1,1, 1, 1,−1,1,1,1,1,1,1,1,1,1,1,−1,1,−1,1,1,1,−1,1,−1,1,−1,1,−1,0,0,0,−1,−1,−1,1,1,1,1,1,1,1,1,1,1,1,1,1,−1,1,−1,1,−1,−1,1,1,1,1,−1,1,−1,1,1,1,−1,−1,−1,1,1,1,1,1,1,1,1,1,−1,1,−1,1,1,1,−1,1,−1,1,−1,1,1,0,0,0,0,0}
For 40 MHz transmission, the N-TF sequence with the format of an VHTLTF40, optimized for estimation order P=7, is given by:
N-TF(VHTLTF40,P=7)=sqrt(128/114)·{0,0,0,0,0,0,1,1,−1,1,1,1,1,1,1,−1,1,−1,1,−1,1,−1,1,1,1,1,1,1,1,1,1,−1,1,−1,1,−1,1,−1,1,−1,1,1,1, 1, 1, 1,−1,1,1,−1,1,1,1,−1,−1,−1,1,1,−1,−1,1,−1,−1,0,0,0,1,1,1,1,1,−1,1,−1,1,−1,1,−1,1,1,−1,1,1,1,1,1,1,−1,1,−1,1,−1,1,−1,1,1,1,1,1,1,1,1,−1,−1,1,−1,1,−1,1,−1,1,−1,1,1,−1,−1,1,1,−1,1,1,−1,1,0,0,0,0,0}
For 40 MHz transmission, the N-TF sequence with the format of an VHTLTF40, optimized for estimation order P=8, is given by:
N-TF(VHTLTF40,P=8)=sqrt(128/114)·{0,0,0,0,0,0,1,1,1,−1,1,−1,1,−1,1,1,1,−1,1,1,1,1,1,1,1,−1,1,1,1,1,1,−1,−1,−1,1,1,1,1,1,−1,−1,−1,1,1,1,1,1,1,1,1,1,−1,−1,−1,1,1,1,1,1,−1,−1,−1,−1,0,0,0,1,−1,1,1,1,1,1,1,1,−1,1,1,1,−1,1,−1,1,−1,1,1,1,1,1,−1,−1,−1,1,1,1,1,1,1,1,1,1,1,−1,−1,1,1,1,1,1,−1,−1,−1,1,1,1,1,1,−1,−1,−1,1,1,1,0,0,0,0,0}
For 40 MHz transmission, the N-TF sequence with the format of an VHTLTF40, optimized for estimation order P=9, is given by:
N-TF(VHTLTF40,P=9)=sqrt(128/114)·{0,0,0,0,0,0,−1,−1,−1,1,−1,1,−1,1,−1,−1,1,1,−1,−1,−1,1,−1,1,−1,−1,−1,1,−1,−1,−1,1,−1,1,−1,−1,−1,1,1,−1,−1,1,−1,1,−1,1,−1,1,1,−1,−1,−1,1,−1,−1,1,−1,−1,−1,1,−1,−1,−1,0,0,0,−1,−1,−1,1,−1,−1,−1,−1,1,1,−1,−1,−1,1,−1,1,−1,−1,−1,1,1,−1,−1,1,−1,1,−1,1,−1,−1,1,−1,−1,−1,−1,1,−1,1,−1,−1,−1,1,−1,−1,−1,1,−1,1,−1,−1,−1,1,1,−1,−1,−1,−1,0,0,0,0,0}
For 40 MHz transmission, the N-TF sequence with the format of an VHTLTF40, optimized for estimation order P=10, is given by:
N-TF(VHTLTF40,P=10)=sqrt(128/114)·{0,0,0,0,0,0,−1,−1,−1,−1,−1,1,−1,−1,−1,−1,1,1,1,1,1,−1,1,1,1,1,−1,1,−1,1,1,−1,1,−1,−1,−1,−1,1,−1,−1,1,−1,1,−1,−1,1,1,1,1,−1,1,−1,1,1,−1,−1,−1,−1,1,−1,1,−1,−1,0,0,0,1,−1,1,−1,1,−1,1,1,1,−1,1,−1,1,−1,1,−1,1,−1,−1,−1,−1,−1,1,−1,1,−1,1,−1,1,1,1,1,1,−1,1,−1,1,1,−1,1,−1,−1,1,−1,1,−1,−1,−1,−1,1,1,−1,1,−1,1,−1,1,0,0,0,0,0}
List7
For 20 MHz transmission, the N-TF sequence with the format of an HESTF20, optimized for estimation order P=3, is given by:
N-TF(HESTF20,P=3)=sqrt(256/14)·{0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0}
For 20 MHz transmission, the N-TF sequence with the format of an HESTF20, optimized for estimation order P=4, is given by:
N-TF(HESTF20,P=4)=sqrt(256/14)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0}
For 20 MHz transmission, the N-TF sequence with the format of an HESTF20, optimized for estimation order P=5, is given by:
N-TF(HESTF20,P=5)=sqrt(256/14)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0}
For 20 MHz transmission, the N-TF sequence with the format of an HESTF20, optimized for estimation order P=6, is given by:
N-TF(HESTF20,P=6)=sqrt(256/14)·{0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,1,0,0,0,0,0,0,0,0,0,0 ,0,0,0,0,0}
For 20 MHz transmission, the N-TF sequence with the format of an HESTF20, optimized for estimation order P=7, is given by:
N-TF(HESTF20,P=7)=sqrt(256/14)·{0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0}
For 20 MHz transmission, the N-TF sequence with the format of an HESTF20, optimized for estimation order P=8, is given by:
N-TF(HESTF20,P=8)=sqrt(256/14)·{0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0}
For 20 MHz transmission, the N-TF sequence with the format of an HESTF20, optimized for estimation order P=9, is given by:
N-TF(HESTF20,P=9)=sqrt(256/14)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0}
For 20 MHz transmission, the N-TF sequence with the format of an HESTF20, optimized for estimation order P=10, is given by:
N-TF(HESTF20,P=10)=sqrt(256/14)·{0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0}
List8
For 80 MHz transmission, the N-TF sequence with the format of an LSTF80, optimized for estimation order P=3, is given by:
N-TF(LSTF80,P=3)=sqrt(256/48)·{0,0,0,0,0,0,0,0,1,0,0,0,−1,0,0,0,−1,0,0,0,−1,0,0,0,−1,0,0,0,−1,0,0,0,0,0,0,0,1,0,0,0,1,0,0,0,−1,0,0,0,−1,0,0,0,−1,0,0,0,−1,0,0,0,0,0,0,0,0,0,0,0,0,0,0,0,−1,0,0,0,1,0,0,0,−1,0,0,0,−1,0,0,0,−1,0,0,0,1,0,0,0,0,0,0,0,1,0,0,0,1,0,0,0,−1,0,0,0,−1,0,0,0,−1,0,0,0,−1,0,0,0,0,0,0,0,0,0,0,0,0,0,0,0,−1,0,0,0,1,0,0,0,−1,0,0,0,−1,0,0,0,−1,0,0,0,−1,0,0,0,0,0,0,0,−1,0,0,0,−1,0,0,0,−1,0,0,0,−1,0,0,0,−1,0,0,0,−1,0,0,0,0,0,0,0,0,0,0,0,0,0,0,0,1,0,0,0,−1,0,0,0,−1,0,0,0,−1,0,0,0,−1,0,0,0,1,0,0,0,0,0,0,0,−1,0,0,0,−1,0,0,0,−1,0,0,0,−1,0,0,0,−1,0,0,0,−1,0,0,0,0,0,0,0}
For 80 MHz transmission, the N-TF sequence with the format of an LSTF80, optimized for estimation order P=4, is given by:
N-TF(LSTF80,P=4)=sqrt(256/48)·{0,0,0,0,0,0,0,0,−1,0,0,0,−1,0,0,0,−1,0,0,0,−1,0,0,0,−1,0,0,0,1,0,0,0,0,0,0,0,−1,0,0,0,−1,0,0,0,1,0,0,0,−1,0,0,0,1,0,0,0,−1,0,0,0,0,0,0,0,0,0,0,0,0,0,0,0,−1,0,0,0,1,0,0,0,−1,0,0,0,−1,0,0,0,−1,0,0,0,1,0,0,0,0,0,0,0,1,0,0,0,−1,0,0,0,−1,0,0,0,1,0,0,0,−1,0,0,0,−1,0,0,0,0,0,0,0,0,0,0,0,0,0,0,0,−1,0,0,0,−1,0,0,0,−1,0,0,0,1,0,0,0,−1,0,0,0,1,0,0,0,0,0,0,0,−1,0,0,0,−1,0,0,0,−1,0,0,0,−1,0,0,0,−1,0,0,0,−1,0,0,0,0,0,0,0,0,0,0,0,0,0,0,0,−1,0,0,0,1,0,0,0,−1,0,0,0,−1,0,0,0,−1,0,0,0,1,0,0,0,0,0,0,0,1,0,0,0,−1,0,0,0,−1,0,0,0,−1,0,0,0,−1,0,0,0,−1,0,0,0,0,0,0,0}
For 80 MHz transmission, the N-TF sequence with the format of an LSTF80, optimized for estimation order P=5, is given by:
N-TF(LSTF80,P=5)=sqrt(256/48)·{0,0,0,0,0,0,0,0,−1,0,0,0,−1,0,0,0,1,0,0,0,−1,0,0,0,−1,0,0,0,−1,0,0,0,0,0,0,0,−1,0,0,0,−1,0,0,0,−1,0,0,0,−1,0,0,0,−1,0,0,0,−1,0,0,0,0,0,0,0,0,0,0,0,0,0,0,0,1,0,0,0,−1,0,0,0,1,0,0,0,−1,0,0,0,1,0,0,0,−1,0,0,0,0,0,0,0,−1,0,0,0,1,0,0,0,−1,0,0,0,−1,0,0,0,−1,0,0,0,−1,0,0,0,0,0,0,0,0,0,0,0,0,0,0,0,1,0,0,0,−1,0,0,0,1,0,0,0,−1,0,0,0,1,0,0,0,−1,0,0,0,0,0,0,0,−1,0,0,0,1,0,0,0,−1,0,0,0,−1,0,0,0,−1,0,0,0,−1,0,0,0,0,0,0,0,0,0,0,0,0,0,0,0,1,0,0,0,−1,0,0,0,1,0,0,0,−1,0,0,0,1,0,0,0,−1,0,0,0,0,0,0,0,1,0,0,0,1,0,0,0,−1,0,0,0,−1,0,0,0,−1,0,0,0,−1,0,0,0,0,0,0,0}
For 80 MHz transmission, the N-TF sequence with the format of an LSTF80, optimized for estimation order P=6, is given by:
N-TF(LSTF80,P=6)=sqrt(256/48)·{0,0,0,0,0,0,0,0,−1,0,0,0,−1,0,0,0,−1,0,0,0,1,0,0,0,−1,0,0,0,−1,0,0,0,0,0,0,0,−1,0,0,0,−1,0,0,0,1,0,0,0,−1,0,0,0,1,0,0,0,−1,0,0,0,0,0,0,0,0,0,0,0,0,0,0,0,−1,0,0,0,−1,0,0,0,−1,0,0,0,1,0,0,0,−1,0,0,0,1,0,0,0,0,0,0,0,−1,0,0,0,−1,0,0,0,−1,0,0,0,−1,0,0,0,1,0,0,0,−1,0,0,0,0,0,0,0,0,0,0,0,0,0,0,0,−1,0,0,0,−1,0,0,0,−1,0,0,0,1,0,0,0,−1,0,0,0,1,0,0,0,0,0,0,0,−1,0,0,0,−1,0,0,0,1,0,0,0,−1,0,0,0,1,0,0,0,−1,0,0,0,0,0,0,0,0,0,0,0,0,0,0,0,−1,0,0,0,−1,0,0,0,−1,0,0,0,1,0,0,0,−1,0,0,0,1,0,0,0,0,0,0,0,−1,0,0,0,−1,0,0,0,−1,0,0,0,−1,0,0,0,1,0,0,0,−1,0,0,0,0,0,0,0}
For 80 MHz transmission, the N-TF sequence with the format of an LSTF80, optimized for estimation order P=7, is given by:
N-TF(LSTF80,P=7)=sqrt(256/48)·{0,0,0,0,0,0,0,0,1,0,0,0,−1,0,0,0,−1,0,0,0,−1,0,0,0,−1,0,0,0,−1,0,0,0,0,0,0,0,−1,0,0,0,−1,0,0,0,−1,0,0,0,1,0,0,0,−1,0,0,0,1,0,0,0,0,0,0,0,0,0,0,0,0,0,0,0,1,0,0,0,−1,0,0,0,−1,0,0,0,−1,0,0,0,−1,0,0,0,−1,0,0,0,0,0,0,0,−1,0,0,0,−1,0,0,0,−1,0,0,0,1,0,0,0,−1,0,0,0,1,0,0,0,0,0,0,0,0,0,0,0,0,0,0,0,1,0,0,0,−1,0,0,0,−1,0,0,0,−1,0,0,0,−1,0,0,0,−1,0,0,0,0,0,0,0,−1,0,0,0,−1,0,0,0,−1,0,0,0,1,0,0,0,−1,0,0,0,1,0,0,0,0,0,0,0,0,0,0,0,0,0,0,0,1,0,0,0,−1,0,0,0,−1,0,0,0,−1,0,0,0,−1,0,0,0,−1,0,0,0,0,0,0,0,−1,0,0,0,−1,0,0,0,−1,0,0,0,1,0,0,0,−1,0,0,0,−1,0,0,0,0,0,0,0}
For 80 MHz transmission, the N-TF sequence with the format of an LSTF80, optimized for estimation order P=8, is given by:
N-TF(LSTF80,P=8)=sqrt(256/48)·{0,0,0,0,0,0,0,0,−1,0,0,0,−1,0,0,0,−1,0,0,0,−1,0,0,0,1,0,0,0,−1,0,0,0,0,0,0,0,−1,0,0,0,1,0,0,0,−1,0,0,0,−1,0,0,0,−1,0,0,0,1,0,0,0,0,0,0,0,0,0,0,0,0,0,0,0,1,0,0,0,−1,0,0,0,−1,0,0,0,−1,0,0,0,1,0,0,0,−1,0,0,0,0,0,0,0,−1,0,0,0,1,0,0,0,−1,0,0,0,−1,0,0,0,−1,0,0,0,1,0,0,0,0,0,0,0,0,0,0,0,0,0,0,0,−1,0,0,0,−1,0,0,0,−1,0,0,0,−1,0,0,0,1,0,0,0,−1,0,0,0,0,0,0,0,−1,0,0,0,1,0,0,0,−1,0,0,0,−1,0,0,0,−1,0,0,0,1,0,0,0,0,0,0,0,0,0,0,0,0,0,0,0,−1,0,0,0,−1,0,0,0,−1,0,0,0,−1,0,0,0,1,0,0,0,−1,0,0,0,0,0,0,0,−1,0,0,0,1,0,0,0,−1,0,0,0,−1,0,0,0,−1,0,0,0,1,0,0,0,0,0,0,0}
For 80 MHz transmission, the N-TF sequence with the format of an LSTF80, optimized for estimation order P=9, is given by:
N-TF(LSTF80,P=9)=sqrt(256/48)·{0,0,0,0,0,0,0,0,−1,0,0,0,−1,0,0,0,−1,0,0,0,−1,0,0,0,−1,0,0,0,−1,0,0,0,0,0,0,0,1,0,0,0,−1,0,0,0,−1,0,0,0,1,0,0,0,−1,0,0,0,−1,0,0,0,0,0,0,0,0,0,0,0,0,0,0,0,−1,0,0,0,−1,0,0,0,1,0,0,0,−1,0,0,0,1,0,0,0,1,0,0,0,0,0,0,0,−1,0,0,0,−1,0,0,0,1,0,0,0,−1,0,0,0,−1,0,0,0,−1,0,0,0,0,0,0,0,0,0,0,0,0,0,0,0,−1,0,0,0,−1,0,0,0,−1,0,0,0,−1,0,0,0,−1,0,0,0,−1,0,0,0,0,0,0,0,−1,0,0,0,1,0,0,0,−1,0,0,0,−1,0,0,0,1,0,0,0,−1,0,0,0,0,0,0,0,0,0,0,0,0,0,0,0,−1,0,0,0,−1,0,0,0,−1,0,0,0,−1,0,0,0,−1,0,0,0,−1,0,0,0,0,0,0,0,−1,0,0,0,−1,0,0,0,−1,0,0,0,−1,0,0,0,1,0,0,0,−1,0,0,0,0,0,0,0}
For 80 MHz transmission, the N-TF sequence with the format of an LSTF80, optimized for estimation order P=10, is given by:
N-TF(LSTF80,P=10)=sqrt(256/48)·{0,0,0,0,0,0,0,0,1,0,0,0,−1,0,0,0,1,0,0,0,−1,0,0,0,1,0,0,0,−1,0,0,0,0,0,0,0,−1,0,0,0,1,0,0,0,1,0,0,0,−1,0,0,0,1,0,0,0,1,0,0,0,0,0,0,0,0,0,0,0,0,0,0,0,1,0,0,0,1,0,0,0,−1,0,0,0,1,0,0,0,1,0,0,0,−1,0,0,0,0,0,0,0,−1,0,0,0,1,0,0,0,−1,0,0,0,1,0,0,0,1,0,0,0,1,0,0,0,0,0,0,0,0,0,0,0,0,0,0,0,1,0,0,0,1,0,0,0,1,0,0,0,−1,0,0,0,−1,0,0,0,−1,0,0,0,0,0,0,0,−1,0,0,0,1,0,0,0,−1,0,0,0,1,0,0,0,−1,0,0,0,1,0,0,0,0,0,0,0,0,0,0,0,0,0,0,0,1,0,0,0,−1,0,0,0,1,0,0,0,−1,0,0,0,1,0,0,0,−1,0,0,0,0,0,0,0,1,0,0,0,1,0,0,0,−1,0,0,0,1,0,0,0,−1,0,0,0,1,0,0,0,0,0,0,0}
List9
For 20 MHz transmission, the N-TF sequence with the format of an HELTF1X20, optimized for estimation order P=3, is given by:
N-TF(HELTF1X20,P=3)=sqrt(256/60)·{0,0,0,0,0,0,0,0,1,0,0,0,1,0,0,0,−1,0,0,0,1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,0,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,−1,0,0,0,−1,0,0,0,−1,0,0,0,−1,0,0,0,−1,0,0,0,1,0,0,0,1,0,0,0,1,0,0,0,1,0,0,0,1,0,0,0,1,0,0,0,1,0,0,0,1,0,0,0,1,0,0,0,−1,0,0,0,0,0,0,0}
For 20 MHz transmission, the N-TF sequence with the format of an HELTF1X20, optimized for estimation order P=4, is given by:
N-TF(HELTF1X20,P=4)=sqrt(256/60)·{0,0,0,0,0,0,0,0,1,0,0,0,1,0,0,0,−1,0,0,0,−1,0,0,0,−1,0,0,0,−1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,−1,0,0,0,−1,0,0,0,−1,0,0,0,−1,0,0,0,0,0,0,0,−1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,−1,0,0,0,−1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,−1,0,0,0,−1,0,0,0,−1,0,0,0,−1,0,0,0,1,0,0,0,−1,0,0,0,−1,0,0,0,0,0,0,0}
For 20 MHz transmission, the N-TF sequence with the format of an HELTF1X20, optimized for estimation order P=5, is given by:
N-TF(HELTF1X20,P=5)=sqrt(256/60)·{0,0,0,0,0,0,0,0,1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,0,0,0,0,1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,−1,0,0,0,−1,0,0,0,0,0,0,0}
For 20 MHz transmission, the N-TF sequence with the format of an HELTF1X20, optimized for estimation order P=6, is given by:
N-TF(HELTF1X20,P=6)=sqrt(256/60)·{0,0,0,0,0,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,0,0,0,0,−1,0,0,0,1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,0,0,0,0}
For 20 MHz transmission, the N-TF sequence with the format of an HELTF1X20, optimized for estimation order P=7, is given by:
N-TF(HELTF1X20,P=7)=sqrt(256/60)·{0,0,0,0,0,0,0,0,−1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,−1,0,0,0,0,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,0,0,0,0}
For 20 MHz transmission, the N-TF sequence with the format of an HELTF1X20, optimized for estimation order P=8, is given by:
N-TF(HELTF1X20,P=8)=sqrt(256/60)·{0,0,0,0,0,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,−1,0,0,0,−1,0,0,0,−1,0,0,0,−1,0,0,0,0,0,0,0,−1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,0,0,0,0}
For 20 MHz transmission, the N-TF sequence with the format of an HELTF1X20, optimized for estimation order P=9, is given by:
N-TF(HELTF1X20,P=9)=sqrt(256/60)·{0,0,0,0,0,0,0,0,1,0,0,0,1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,0,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,−1,0,0,0,−1,0,0,0,1,0,0,0,1,0,0,0,0,0,0,0}
For 20 MHz transmission, the N-TF sequence with the format of an HELTF1X20, optimized for estimation order P=10, is given by:
N-TF(HELTF1X20,P=10)=sqrt(256/60) {0,0,0,0,0,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,0,0,0,0,1,0,0,0,−1,0,0,0,1,0,0,0,1,0,0,0,−1,0,0,0,1,0,0,0,−1,0,0,0,−1,0,0,0,−1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,−1,0,0,0,−1,0,0,0,0,0,0,0}
List10
For 20 MHz transmission, the N-TF sequence with the format of an HELTF2X20, optimized for estimation order P=3, is given by:
N-TF(HELTF2X20,P=3)=sqrt(256/122)·{0,0,0,0,0,0,1,0,1,0,1,0,1,0,−1,0,−1,0,−1,0,1,0,−1,0,−1,0,1,0,1,0,1,0,1,0,1,0,1,0,−1,0,−1,0,−1,0,−1,0,−1,0,1,0,−1,0,−1,0,1,0,1,0,1,0,−1,0,1,0,−1,0,1,0,−1,0,1,0,−1,0,1,0,1,0,1,0,1,0,1,0,1,0,−1,0,−1,0,1,0,1,0,−1,0,−1,0,1,0,−1,0,−1,0,1,0,1,0,−1,0,1,0,1,0,1,0,−1,0,−1,0,−1,0,1,0,1,0,1,0,0,0,−1,0,−1,0,1,0,−1,0,1,0,1,0,−1,0,1,0,1,0,1,0,1,0,−1,0,−1,0,−1,0,−1,0,−1,0,−1,0,−1,0,1,0,1,0,1,0,1,0,1,0,1,0,−1,0,−1,0,−1,0,−1,0,−1,0,−1,0,−1,0,1,0,−1,0,1,0,1,0,−1,0,−1,0,1,0,−1,0,−1,0,−1,0,−1,0,−1,0,1,0,1,0,1,0,−1,0,1,0,−1,0,1,0,−1,0,1,0,−1,0,−1,0,1,0,1,0,1,0,1,0,−1,0,1,0,−1,0,0,0,0,0}
For 20 MHz transmission, the N-TF sequence with the format of an HELTF2X20, optimized for estimation order P=4, is given by:
N-TF(HELTF2X20,P=4)=sqrt(256/122)·{0,0,0,0,0,0,−1,0,1,0,−1,0,1,0,−1,0,1,0,1,0,−1,0,−1,0,−1,0,−1,0,1,0,−1,0,−1,0,1,0,1,0,−1,0,1,0,−1,0,1,0,1,0,1,0,1,0,−1,0,−1,0,1,0,1,0,1,0,1,0,−1,0,1,0,1,0,1,0,1,0,−1,0,1,0,−1,0,−1,0,−1,0,1,0,−1,0,1,0,−1,0,1,0,−1,0,1,0,1,0,1,0,1,0,1,0,−1,0,−1,0,−1,0,1,0,−1,0,1,0,−1,0,1,0,−1,0,1,0,1,0,0,0,1,0,1,0,1,0,1,0,−1,0,1,0,1,0,1,0,1,0,−1,0,−1,0,1,0,−1,0,1,0,1,0,−1,0,−1,0,1,0,1,0,1,0,−1,0,1,0,1,0,−1,0,−1,0,−1,0,−1,0,1,0,1,0,1,0,−1,0,1,0,1,0,1,0,1,0,1,0,−1,0,−1,0,−1,0,1,0,1,0,−1,0,1,0,1,0,−1,0,−1,0,−1,0,1,0,1,0,1,0,−1,0,1,0,−1,0,1,0,−1,0,−1,0,1,0,−1,0,−1,0,1,0,−1,0,0,0,0,0}
For 20 MHz transmission, the N-TF sequence with the format of an HELTF2X20, optimized for estimation order P=5, is given by:
N-TF(HELTF2X20,P=5)=sqrt(256/122)·{0,0,0,0,0,0,−1,0,1,0,1,0,1,0,−1,0,−1,0,1,0,1,0,1,0,1,0,1,0,1,0,−1,0,1,0,1,0,1,0,1,0,1,0,−1,0,−1,0,1,0,−1,0,1,0,1,0,−1,0,1,0,1,0,−1,0,1,0,1,0,−1,0,−1,0,−1,0,1,0,1,0,1,0,−1,0,1,0,1,0,1,0,−1,0,1,0,1,0,−1,0,1,0,1,0,1,0,1,0,1,0,1,0,1,0,−1,0,−1,0,−1,0,1,0,−1,0,1,0,1,0,1,0,1,0,1,0,0,0,−1,0,1,0,−1,0,1,0,1,0,1,0,1,0,1,0,1,0,−1,0,1,0,1,0,−1,0,−1,0,1,0,1,0,−1,0,1,0,1,0,1,0,1,0,−1,0,−1,0,1,0,−1,0,−1,0,1,0,−1,0,−1,0,1,0,1,0,−1,0,−1,0,1,0,−1,0,1,0,−1,0,1,0,1,0,1,0,−1,0,1,0,1,0,1,0,1,0,−1,0,1,0,1,0,1,0,1,0,1,0,1,0,−1,0,−1,0,1,0,−1,0,−1,0,1,0,1,0,−1,0,1,0,0,0,0,0}
For 20 MHz transmission, the N-TF sequence with the format of an HELTF2X20, optimized for estimation order P=6, is given by:
N-TF(HELTF2X20,P=6)=sqrt(256/122)·{0,0,0,0,0,0,1,0,−1,0,1,0,1,0,1,0,−1,0,1,0,−1,0,1,0,−1,0,−1,0,−1,0,−1,0,−1,0,−1,0,−1,0,−1,0,−1,0,−1,0,−1,0,1,0,1,0,1,0,1,0,1,0,−1,0,1,0,−1,0,1,0,1,0,1,0,−1,0,1,0,−1,0,1,0,1,0,1,0,1,0,1,0,−1,0,1,0,1,0,1,0,1,0,1,0,−1,0,−1,0,−1,0,−1,0,−1,0,1,0,−1,0,1,0,−1,0,1,0,1,0,1,0,−1,0,1,0,−1,0,1,0,0,0,−1,0,−1,0,−1,0,−1,0,−1,0,−1,0,1,0,1,0,1,0,−1,0,1,0,1,0,1,0,1,0,−1,0,−1,0,1,0,−1,0,1,0,1,0,1,0,1,0,1,0,1,0,1,0,1,0,1,0,−1,0,1,0,−1,0,−1,0,1,0,−1,0,1,0,−1,0,−1,0,−1,0,−1,0,1,0,−1,0,1,0,−1,0,1,0,−1,0,−1,0,−1,0,1,0,−1,0,1,0,−1,0,1,0,1,0,1,0,1,0,1,0,1,0,1,0,1,0,1,0,1,0,1,0,0,0,0,0}
For 20 MHz transmission, the N-TF sequence with the format of an HELTF2X20, optimized for estimation order P=7, is given by:
N-TF(HELTF2X20,P=7)=sqrt(256/122)·{0,0,0,0,0,0,−1,0,−1,0,1,0,−1,0,−1,0,−1,0,−1,0,−1,0,1,0,−1,0,−1,0,−1,0,1,0,1,0,1,0,1,0,1,0,−1,0,1,0,1,0,1,0,1,0,1,0,−1,0,1,0,−1,0,1,0,1,0,−1,0,−1,0,1,0,−1,0,−1,0,−1,0,−1,0,−1,0,1,0,1,0,1,0,−1,0,1,0,−1,0,1,0,1,0,1,0,−1,0,1,0,−1,0,1,0,−1,0,−1,0,1,0,1,0,−1,0,1,0,−1,0,−1,0,−1,0,−1,0,−1,0,1,0,0,0,−1,0,−1,0,1,0,1,0,1,0,1,0,−1,0,−1,0,1,0,−1,0,1,0,1,0,−1,0,−1,0,−1,0,−1,0,1,0,−1,0,−1,0,−1,0,−1,0,−1,0,1,0,−1,0,−1,0,−1,0,1,0,1,0,1,0,−1,0,1,0,−1,0,1,0,1,0,1,0,−1,0,−1,0,−1,0,1,0,−1,0,1,0,1,0,−1,0,−1,0,1,0,−1,0,−1,0,−1,0,−1,0,−1,0,1,0,1,0,1,0,−1,0,−1,0,−1,0,1,0,1,0,1,0,−1,0,1,0,0,0,0,0}
For 20 MHz transmission, the N-TF sequence with the format of an HELTF2X20, optimized for estimation order P=8, is given by:
N-TF(HELTF2X20,P=8)=sqrt(256/122)·{0,0,0,0,0,0,−1,0,−1,0,1,0,1,0,1,0,1,0,1,0,1,0,1,0,1,0,1,0,−1,0,1,0,1,0,−1,0,1,0,1,0,−1,0,1,0,1,0,1,0,1,0,1,0,1,0,1,0,1,0,1,0,−1,0,1,0,1,0,1,0,1,0,1,0,1,0,1,0,1,0,1,0,1,0,−1,0,1,0,1,0,−1,0,−1,0,1,0,−1,0,1,0,1,0,−1,0,1,0,1,0,1,0,1,0,1,0,1,0,−1,0,−1,0,1,0,−1,0,−1,0,1,0,−1,0,0,0,1,0,1,0,1,0,1,0,1,0,1,0,−1,0,−1,0,1,0,−1,0,−1,0,1,0,−1,0,−1,0,1,0,1,0,1,0,1,0,1,0,1,0,−1,0,1,0,−1,0,−1,0,−1,0,−1,0,−1,0,1,0,−1,0,1,0,1,0,1,0,1,0,1,0,−1,0,1,0,1,0,−1,0,1,0,−1,0,−1,0,1,0,1,0,1,0,1,0,1,0,1,0,−1,0,1,0,1,0,−1,0,1,0,1,0,−1,0,1,0,1,0,−1,0,1,0,1,0,1,0,1,0,0,0,0,0}
For 20 MHz transmission, the N-TF sequence with the format of an HELTF2X20, optimized for estimation order P=9, is given by:
N-TF(HELTF2X20,P=9)=sqrt(256/122)·{0,0,0,0,0,0,1,0,1,0,1,0,−1,0,−1,0,1,0,1,0,1,0,1,0,−1,0,1,0,−1,0,1,0,1,0,1,0,1,0,1,0,−1,0,−1,0,1,0,1,0,1,0,1,0,−1,0,−1,0,−1,0,1,0,1,0,1,0,1,0,1,0,−1,0,−1,0,−1,0,1,0,1,0,1,0,−1,0,−1,0,−1,0,1,0,1,0,1,0,1,0,1,0,−1,0,−1,0,−1,0,1,0,1,0,1,0,−1,0,−1,0,−1,0,1,0,1,0,1,0,1,0,1,0,−1,0,1,0,0,0,1,0,1,0,1,0,−1,0,1,0,−1,0,1,0,1,0,1,0,−1,0,1,0,1,0,1,0,−1,0,1,0,1,0,1,0,−1,0,1,0,−1,0,1,0,1,0,1,0,−1,0,1,0,1,0,1,0,−1,0,1,0,1,0,1,0,−1,0,1,0,−1,0,1,0,1,0,1,0,−1,0,1,0,1,0,1,0,−1,0,1,0,1,0,1,0,−1,0,1,0,−1,0,1,0,1,0,1,0,−1,0,1,0,1,0,1,0,−1,0,−1,0,1,0,1,0,1,0,1,0,0,0,0,0}
For 20 MHz transmission, the N-TF sequence with the format of an HELTF2X20, optimized for estimation order P=10, is given by:
N-TF(HELTF2X20,P=10)=sqrt(256/122)·{0,0,0,0,0,0,−1,0,−1,0,1,0,−1,0,1,0,1,0,−1,0,−1,0,−1,0,1,0,1,0,−1,0,−1,0,−1,0,−1,0,1,0,−1,0,1,0,1,0,1,0,1,0,−1,0,1,0,1,0,−1,0,−1,0,1,0,−1,0,−1,0,−1,0,−1,0,−1,0,−1,0,−1,0,−1,0,1,0,1,0,−1,0,−1,0,−1,0,1,0,−1,0,1,0,−1,0,−1,0,1,0,−1,0,−1,0,−1,0,1,0,1,0,−1,0,−1,0,−1,0,1,0,−1,0,−1,0,−1,0,1,0,−1,0,−1,0,0,0,−1,0,−1,0,−1,0,1,0,1,0,−1,0,−1,0,−1,0,−1,0,1,0,1,0,−1,0,−1,0,−1,0,1,0,−1,0,−1,0,−1,0,−1,0,−1,0,1,0,1,0,−1,0,−1,0,−1,0,−1,0,1,0,−1,0,−1,0,1,0,−1,0,1,0,1,0,1,0,−1,0,−1,0,−1,0,−1,0,−1,0,−1,0,−1,0,−1,0,−1,0,−1,0,−1,0,−1,0,1,0,−1,0,−1,0,1,0,−1,0,1,0,−1,0,−1,0,−1,0,−1,0,−1,0,−1,0,−1,0,−1,0,−1,0,0,0,0,0}
List11
For 80 MHz transmission, the N-TF sequence with the format of an LLTF80, optimized for estimation order P=3, is given by:
N-TF(LLTF80,P=3)=sqrt(256/208)·{0,0,0,0,0,0,1,−1,1,1,1,−1,1,1,1,1,−1,−1,−1,1,−1,−1,1,1,1,−1,1,1,−1,−1,−1,−1,0,−1,1,1,1,−1,−1,−1,1,−1,1,1,1,1,1,1,1,1,−1,−1,−1,−1,1,1,1,1,1,0,0,0,0,0,0,0,0,0,0,0,1,−1,−1,−1,−1,−1,−1,1,1,1,1,1,−1,−1,−1,−1,−1,1,−1,1,1,1,−1,−1,−1,−1,0,−1,−1,1,−1,1,−1,1,−1,−1,1,−1,−1,−1,1,1,1,−1,1,1,1,−1,−1,−1,1,1,−1,0,0,0,0,0,0,0,0,0,0,0,−1,−1,1,1,−1,−1,1,1,1,−1,−1,1,−1,−1,1,−1,1,1,1,1,1,−1,1,1,−1,−1,0, 1, 1,−1,1,1,1,1,−1,−1,−1,1,1,1,1,−1,−1,−1,−1,1,−1,−1,1,1,1,1,1,0,0,0,0,0,0,0,0,0,0,0,1,−1,−1,−1,1,−1,1,−1,1,1,1,1,−1,−1,1,1,−1,−1,1,1,1,1,1,−1,−1,−1,0,−1,−1,1,1,1,1,−1,−1,1,−1,−1,−1,1,1,1,1,1,−1,−1,−1,1,−1,−1,1,1,1,0,0,0,0,0}
For 80 MHz transmission, the N-TF sequence with the format of an LLTF80, optimized for estimation order P=4, is given by:
N-TF(LLTF80,P=4)=sqrt(256/208)·{0,0,0,0,0,0,1,−1,−1,−1,1,1,1,−1,−1,−1,1,1,−1,−1,−1,1,1,1,1,−1,1,−1,−1,−1,1,−1,0,−1,−1,1,−1,1,−1,−1,−1,−1,1,1,1,1,−1,−1,1,1,−1,1,−1,−1,1,1,−1,1,1,0,0,0,0,0,0,0,0,0,0,0,1,1,−1,−1,1,1,1,−1,−1,−1,1,1,−1,−1,−1,−1,1,1,−1,1,1,1,−1,1,1,1,0,−1,−1,−1,1,−1,1,−1,−1,−1,1,1,1,1,−1,−1,−1,1,1,1,−1,−1,1,1,1,−1,1,0,0,0,0,0,0,0,0,0,0,0,1,1,1,−1,1,−1,1,1,−1,1,−1,1,1,−1,−1,−1,1,1,−1,−1,1,−1,−1,−1,1, 1,0, 1,−1,1,1,1,1,1,−1,1,1,−1,1,−1,1,−1,−1,1,1,1,−1,−1,−1,1,1,1,−1,0,0,0,0,0,0,0,0,0,0,0,−1,1,−1,1,1,1,−1,−1,1,−1,1,−1,1,−1,−1,−1,1,1,1,1,1,−1,−1,1,1,1,0,−1,−1,−1,1,1,1,1,−1,−1,1,1,−1,1,−1,1,−1,1,1,−1,1,−1,1,1,1,−1,1,0,0,0,0,0}
For 80 MHz transmission, the N-TF sequence with the format of an LLTF80, optimized for estimation order P=5, is given by:
N-TF(LLTF80,P=5)=sqrt(256/208)·{0,0,0,0,0,0,−1,−1,1,1,1,1,1,1,1,1,−1,1,1,1,−1,−1,1,−1,−1,−1,−1,−1,−1,−1,−1,−1,0,1,−1,−1,1,1,1,1,1,1,1,1,1,1,1,1,−1,−1,−1,−1,−1,−1,−1,−1,−1,−1,−1,0,0,0,0,0,0,0,0,0,0,0,1,1,1,−1,−1,1,1,1,−1,−1,−1,1,1,1,−1,−1,1,1,1,1,1,−1,−1,−1,1,1,0,−1,−1,−1,1,1,−1,−1,1,1,1,1,−1,1,1,1,1,1,1,1,−1,−1,1,1,1,−1,−1,0,0,0,0,0,0,0,0,0,0,0,−1,1,1,1,−1,1,1,−1,−1,1,−1,1,−1,−1,1,−1,−1,−1,−1,−1,1,−1,−1,1,1,−1,0,−1,1, 1, 1,−1,1,−1,1,1,−1,−1,1,1,−1,1,−1,1,−1,1,1,1,1,1,1,−1,1,0,0,0,0,0,0,0,0,0,0,0,1,1,1,1,1,1,1,1,1,1,1,−1,1,1,−1,−1,−1,−1,−1,−1,−1,−1,−1,−1,1,−1,0,1,1,1,1,1,1,1,1,1,1,1,−1,−1,1,1,−1,−1,−1,−1,−1,−1,−1,−1,−1,1,1,0,0,0,0,0}
For 80 MHz transmission, the N-TF sequence with the format of an LLTF80, optimized for estimation order P=6, is given by:
N-TF(LLTF80,P=6)=sqrt(256/208)·{0,0,0,0,0,0,−1,1,−1,1,−1,−1,−1,−1,1,−1,1,1,1,−1,1,−1,−1,−1,1,−1,−1,1,−1,−1,−1,1,0,1,−1,−1,1,−1,1,−1,1,1,1,1,1,1,−1,−1,1,1,1,1,−1,−1,−1,−1,1,−1,1,0,0,0,0,0,0,0,0,0,0,0,−1,−1,−1,−1,1,−1,1,1,−1,−1,−1,−1,−1,1,1,−1,1,−1,−1,−1,1,−1,1,1,1,−1,0,1,−1,1,1,1,−1,1,−1,1,−1,−1,−1,1,1,−1,1,−1,−1,−1,−1,1,−1,−1,−1,1,−1,0,0,0,0,0,0,0,0,0,0,0,1,−1,−1,−1,−1,1,1,1,1,1,1,1,1,−1,1,1,1,−1,−1,−1,−1,−1,1,1,−1,1,0,−1,1,−1,1, 1, 1,−1,1,−1,−1,−1,1,1,−1,1,−1,−1,−1,−1,−1,−1,1,−1,1,1,−1,0,0,0,0,0,0,0,0,0,0,0,1,−1,1,1,−1,−1,1,−1,1,1,1,1,−1,−1,−1,1,−1,1,1,−1,−1,−1,1,−1,1,−1,0,1,−1,1,−1,1,−1,−1,1,−1,−1,−1,−1,−1,−1,1,−1,1,1,−1,1,1,−1,1,−1,1,−1,0,0,0,0,0}
For 80 MHz transmission, the N-TF sequence with the format of an LLTF80, optimized for estimation order P=7, is given by:
N-TF(LLTF80,P=7)=sqrt(256/208)·{0,0,0,0,0,0,−1,1,1,1,−1,1,−1,−1,1,−1,−1,−1,−1,1,−1,1,1,−1,−1,1,−1,−1,1,−1,−1,1,0,1,−1,1,−1,−1,−1,1,−1,1,−1,1,1,1,−1,−1,−1,−1,−1,−1,−1,1,−1,−1,−1,1,−1,0,0,0,0,0,0,0,0,0,0,0,1,−1,−1,−1,−1,−1,1,1,−1,−1,−1,1,1,−1,−1,−1,−1,−1,−1,−1,−1,1,−1,−1,1,1,0,1,1,1,1,1,−1,−1,−1,1,−1,−1,−1,−1,−1,1,−1,−1,−1,1,−1,−1,−1,1,−1,1,−1,0,0,0,0,0,0,0,0,0,0,0,−1,1,1,1,−1,−1,−1,−1,−1,1,−1,−1,1,−1,1,−1,−1,−1,−1,−1,−1,−1,−1,1,−1,1,0, 1,−1,1,1,1,−1,1,−1,−1,−1,−1,−1,−1,−1,−1,−1,1,−1,−1,−1,1,1,−1,−1,−1,−1,0,0,0,0,0,0,0,0,0,0,0,1,−1,−1,1,1,1,−1,−1,−1,−1,−1,−1,−1,−1,−1,1,−1,−1,1,−1,1,1,−1,1,1,1,0,1,−1,1,−1,1,−1,1,1,1,1,1,−1,1,−1,−1,−1,−1,−1,1,−1,−1,−1,1,−1,−1,−1,0,0,0,0,0}
For 80 MHz transmission, the N-TF sequence with the format of an LLTF80, optimized for estimation order P=8, is given by:
N-TF(LLTF80,P=8)=sqrt(256/208)·{0,0,0,0,0,0,−1,1,−1,1,1,−1,1,1,−1,1,−1,−1,−1,−1,1,−1,−1,1,1,1,−1,1,−1,−1,−1,1,0,1,1,1,1,−1,−1,1,1, 1,−1,1,1,−1,1,−1,−1,1,−1,1,−1,1,−1,1,−1,1,1,0,0,0,0,0,0,0,0,0,0,0,1,−1,1,−1,−1,1,−1,−1,−1,1,1,1,−1,1,−1,1,−1,−1,−1,1,−1,1,−1,1,1,1,0,−1,−1,1,−1,1,−1,1,1,−1,1,−1,1,−1,−1,−1,−1,1,−1,1,−1,1,−1,−1,1,−1,−1,0,0,0,0,0,0,0,0,0,0,0,−1,1,−1,1,−1,1,1,1,1,−1,1,−1,−1,−1,−1,−1,1,−1,1,1,1,1,−1,−1,−1,−1,1,0,1,−1,1,1,1,−1,−1,−1,1,−1,−1,−1,1,−1,1,−1,1,−1,1,1,−1,1,−1,1,−1,−1,0,0,0,0,0,0,0,0,0,0,0,−1,1,−1,1,−1,1,−1,1,1,1,1,1,−1,1,−1,1,1,−1,1,−1,1,1,1,1,−1,1,0,−1,−1,−1,1,1,−1,1,1,1,1,1,−1,1,−1,1,1,−1,1,−1,1,1,−1,1,−1,−1,−1,0,0,0,0,0}
For 80 MHz transmission, the N-TF sequence with the format of an LLTF80, optimized for estimation order P=9, is given by:
N-TF(LLTF80,P=9)=sqrt(256/208)·{0,0,0,0,0,0,1,−1,−1,1,−1,−1,1,−1,1,−1,−1,−1,1,−1,1,−1,−1,−1,−1,−1,1,−1,1,1,−1,−1,0,−1,1,1,1,−1,−1,−1,−1,−1,1,1,−1,−1,−1,−1,−1,1,−1,−1,1,−1,−1,1,−1,−1,1,0,0,0,0,0,0,0,0,0,0,0,−1,−1,1,−1,1,1,−1,−1,−1,−1,−1,1,−1,1,−1,1,−1,1,−1,1,−1,1,−1,−1,−1,1,0,1,1,1,−1,−1,−1,−1,−1,1,−1,−1,1,−1,−1,1,1,−1,1,−1,−1,−1,−1,−1,1,1,1,0,0,0,0,0,0,0,0,0,0,0,1,−1,−1,1,−1,−1,−1,−1,−1,1,−1,1,−1,−1,−1,−1,−1,1,−1,1,1,−1,−1,1,−1,−1,0,−1,−1,−1,−1,1,1,1,1,−1,−1,−1,−1,−1,1,−1,−1,1,−1,−1,1,−1,−1,1,−1,−1,−1,0,0,0,0,0,0,0,0,0,0,0,−1,1,1,−1,1,−1,−1,−1,−1,−1,−1,−1,1,−1,1,1,1,−1,−1,−1,−1,−1,1,−1,1,1,0,−1,1,−1,1,1,−1,−1,−1,−1,−1,−1,1,1,−1,1,−1,−1,−1,1,−1,1,−1,−1,−1,−1,−1,0,0,0,0,0}
For 80 MHz transmission, the N-TF sequence with the format of an LLTF80, optimized for estimation order P=10, is given by:
N-TF(LLTF80,P=10)=sqrt(256/208)·{0,0,0,0,0,0,−1,−1,−1,−1,1,−1,1,1,1,−1,1,−1,1,−1,1,−1,1,−1,1,1,1,−1,1,−1,−1,−1,0,−1,−1,−1,1,1,1,1,−1,−1,−1,1,1,1,1,1,1,−1,1,−1,1,−1,−1,−1,−1,−1,1,0,0,0,0,0,0,0,0,0,0,0,1,1,1,1,−1,−1,−1,1,−1,1,−1,−1,−1,1,1,1,1,−1,−1,−1,1,1,1,1,1,1,0,−1,1,−1,1,−1,1,−1,1,−1,1,−1,−1,−1,1,−1,−1,−1,−1,−1,1,1,1,1,1,−1,−1,0,0,0,0,0,0,0,0,0,0,0,1,−1,−1,−1,1,−1,1,−1,1,−1,1,−1,1,−1,1,−1,1,1,1,−1,1,−1,−1,−1,−1,−1,0,−1,−1,−1,1,1,1,1,−1,−1,−1,1,1,1,1,1,1,−1,1,−1,1,−1,−1,−1,1,−1,1,0,0,0,0,0,0,0,0,0,0,0,1,1,1,1,−1,−1,−1,1,−1,1,−1,1,−1,1,1,1,1,−1,−1,−1,1,1,1,1,1,1,0,−1,1,−1,1,−1,1,−1,1,−1,1,−1,−1,−1,−1,−1,−1,−1,−1,−1,1,1,1,1,1,−1,−1,0,0,0,0,0}
List12
For 20 MHz transmission, the N-TF sequence with the format of an HELTF20, optimized for estimation order P=3, is given by:
N-TF(HELTF20,P=3)=sqrt(256/242)·{0,0,0,0,0,0,−1,−1,−1,1,1,−1,1,−1,1,−1,1,−1,1,−1,1,−1,1,−1,1,−1,1,1,−1,1,1,1,1,−1,1,1,1,−1,1,1,−1,−1,1,−1,1,−1,1,−1,1,−1,−1,1,−1,1,1,−1,1,−1,1,−1,−1,−1,−1,1,1,−1,1,−1,1,−1,1,1,−1,−1,1,1,1,1,−1,−1,−1,−1,−1,1,−1,−1,1,−1,1,1,1,−1,1,−1,−1,1,1,−1,1,−1,1,−1,−1,1,−1,1,−1,1,1,−1,1,−1,1,−1,1,1,−1,1,−1,−1,1,−1,1,−1,1,−1,−1,0,0,0,1,−1,1,1,1,1,−1,1,1,−1,1,1,1,−1,1,−1,−1,−1,1,1,−1,1,−1,−1,−1,−1,1,−1,−1,−1,−1,1,−1,−1,1,1,1,−1,−1,−1,1,−1,1,−1,−1,−1,1,−1,1,−1,1,1,−1,−1,1,−1,−1,−1,−1,1,−1,−1,1,−1,1,−1,1,1,1,−1,1,−1,−1,−1,1,−1,−1,−1,−1,1,−1,1,1,1,−1,−1,1,1,−1,−1,−1,1,1,−1,1,−1,1,−1,−1,1,−1,−1,−1,1,1,−1,−1,−1,1,1,−1,−1,1,−1,−1,−1,1,−1,1,1,1,0,0,0,0,0}
For 20 MHz transmission, the N-TF sequence with the format of an HELTF20, optimized for estimation order P=4, is given by:
N-TF(HELTF20,P=4)=sqrt(256/242)·{0,0,0,0,0,0,1,1,−1,1,−1,−1,1,−1,−1,1,−1,1,−1,1,−1,1,−1,−1,1,1,−1,−1,−1,−1,1,1,1,1,−1,1,1,1,−1,1,−1,1,−1,1,−1,−1,1,1,1,1,−1,−1,−1,1,−1,1,1,−1,−1,−1,−1,1,1,−1,−1,1,−1,1,−1,−1,1,1,−1,−1,−1,1,−1,−1,1,1,1,−1,−1,−1,1,1,−1,1,−1,−1,1,1,1,−1,−1,−1,−1,1,−1,1,−1,−1,1,1,−1,−1,−1,−1,1,1,1,−1,−1,1,1,1,1,1,−1,1,−1,1,1,1,−1,1,1,0,0,0,−1,1,1,1,1,1,−1,1,1,−1,1,1,−1,1,−1,−1,−1,1,−1,1,−1,1,1,1,−1,1,−1,−1,1,−1,1,−1,1,1,−1,1,−1,1,1,1,−1,1,1,1,−1,1,−1,−1,−1,1,1,1,−1,−1,−1,1,1,1,−1,−1,1,1,1,1,−1,−1,−1,1,1,1,−1,−1,1,1,1,−1,−1,−1,1,1,−1,−1,1,−1,−1,1,1,1,−1,1,−1,1,1,−1,−1,1,1,1,−1,1,−1,1,−1,1,1,−1,−1,−1,−1,1,1,1,−1,1,−1,1,−1,1,1,1,−1,0,0,0,0,0}
For 20 MHz transmission, the N-TF sequence with the format of an HELTF20, optimized for estimation order P=5, is given by:
N-TF(HELTF20,P=5)=sqrt(256/242)·{0,0,0,0,0,0,1,−1,1,1,−1,1,1,−1,1,1,1,−1,−1,1,1,1,1,1,−1,1,−1,1,−1,−1,1,−1,−1,1,1,−1,1,1,1,−1,−1,1,1,−1,1,1,1,−1,1,1,1,−1,1,1,1,1,1,−1,1,1,1,−1,1,1,1,1,1,1,−1,−1,1,1,−1,−1,1,1,−1,1,−1,1,1,1,−1,1,1,−1,1,1,1,−1,−1,1,1,−1,1,1,1,−1,1,1,1,−1,−1,1,−1,1,1,1,−1,1,1,1,−1,1,−1,1,1,1,1,−1,−1,1,1,1,1,−1,1,0,0,0,−1,1,−1,−1,−1,1,−1,−1,1,1,−1,1,1,1,−1,1,1,−1,1,1,1,−1,1,−1,1,−1,1,1,1,−1,1,1,−1,−1,−1,1,−1,1,1,1,1,1,−1,1,1,1,−1,−1,−1,−1,1,−1,1,−1,1,1,1,−1,−1,1,1,−1,1,1,−1,1,1,1,−1,1,1,1,1,−1,1,1,−1,1,1,1,−1,1,1,1,1,−1,−1, −1, −1, −1,1,1,−1,1,1,1,−1,1,−1,−1,−1,1,1,−1,−1,−1,1,1,−1,−1,1,1,1,1,1,−1,1,1,1,−1,1,0,0,0,0,0}
For 20 MHz transmission, the N-TF sequence with the format of an HELTF20, optimized for estimation order P=6, is given by:
N-TF(HELTF20,P=6)=sqrt(256/242)·{0,0,0,0,0,0,1,1,−1,1,−1,1,1,1,−1,1,−1,−1,−1,1,−1,1,1,−1,−1,1,−1,−1,1,−1,−1,1,−1,−1,1,−1,1,1,−1,−1,1,−1,−1,1,−1,−1,−1,−1,1,1,−1,−1,1,1,−1,1,−1,−1,1,−1,−1,1,−1,1,1,−1,1,1,−1,−1,1,−1,1,1,−1,1,1,−1,1,1,1,−1,1,1,−1,1,−1,1,1,1,−1,1,−1,−1,1,1,−1,1,−1,1,−1,−1,1,1,−1,1,−1,1,1,1,−1,1,−1,1,1,1,−1,1,−1,1,1,1,−1,1,−1,1,−1,0,0,0,−1,1,−1,1,−1,1,−1,1,1,1,1,1,−1,1,1,1,1,1,−1,1,1,−1,1,1,−1,1,1,1,1,1,−1,−1,1,−1,−1,1,−1,−1,−1,1,−1,1,−1,−1,1,1,−1,−1,−1,1,1,−1,1,1,−1,−1,1,−1,1,1,−1,1,1,−1,−1,1,−1,−1,1,−1,−1,1,1,−1,1,1,−1,1,−1,1,1,−1,1,1,−1,1,1,1,1,1,−1,1,−1,−1,1,1,−1,1,−1,1,−1,−1,1,1,−1,1,−1,1,−1,−1,−1,1,−1,−1,−1,−1,−1,1,−1,1,−1,0,0,0,0,0}
For 20 MHz transmission, the N-TF sequence with the format of an HELTF20, optimized for estimation order P=7, is given by:
N-TF(HELTF20,P=7)=sqrt(256/242)·{0,0,0,0,0,0,−1,1,−1,−1,−1,−1,1,1,−1,−1,−1,−1,1,1,−1,−1,−1,1,−1,−1,1,−1,1,−1,−1,−1,−1,1,−1,1,−1,−1,1,−1,1,1,1,1,1,−1,−1,1,−1,−1,−1,−1,1,−1,−1,−1,−1,1,−1,−1,−1,−1,−1,−1,−1,1,1,1,−1,−1,−1,−1,1,−1,−1,−1,−1,−1,−1,−1,−1,1,−1,−1,−1,−1,1,−1,−1,−1,1,−1,1,−1,−1,1,1,−1,−1,−1,−1,−1,1,−1,−1,1,−1,1,−1,−1,−1,1,1,−1,−1,−1,−1,−1,1,−1,−1,1,−1,−1,−1,−1,1,0,0,0,−1,−1,−1,−1,−1,1,1,−1,−1,−1,−1,1,1,−1,1,1,−1,1,−1,1,1,1,−1,1,−1,−1,−1,1,−1,−1,1,−1,−1,−1,−1,−1,1,−1,−1,−1,−1,−1,−1,−1,−1,1,1,−1,−1,1,−1,1,1,−1,−1,1,−1,1,−1,1,1,1,1,−1,−1,−1,1,−1,−1,1,1,−1,−1,−1,1,1,−1,−1,−1,−1,−1,−1,−1,−1,1,1,−1,−1,−1,1,1,1,−1,1,1,1,−1,1,1,1,1,−1,−1,−1,1,−1,1,−1,−1,−1,1,−1,1,−1,−1,1,1,−1,1,−1,1,0,0,0,0,0}
For 20 MHz transmission, the N-TF sequence with the format of an HELTF20, optimized for estimation order P=8, is given by:
N-TF(HELTF20,P=8)=sqrt(256/242)·{0,0,0,0,0,0,1,1,1,−1,−1,−1,1,−1,−1,−1,1,1,1,−1,−1,1, 1,1,1,1,−1,1,1,1,−1,−1,1,1,1,−1,1,1,1,1,−1,−1,1,−1,−1,−1,−1,−1,1,−1,−1,−1,−1,1,1,−1,−1,1,1,1,−1,−1,−1,1,1,−1,−1,−1,1,1,1,−1,−1,1,1,1,1,−1,1,1,−1,−1,−1,−1,1,1,−1,−1,1,1,1,−1,−1,1,1,−1,−1,−1,−1,1,1,−1,−1,−1,1,1,−1,−1,1,1,1,1,−1,1,1,1,1,1,1,1,1,1,−1,1,1,1,1,0,0,0,−1,−1,−1,−1,−1,−1,1,−1,−1,1,−1,1,1,1,1,1,−1,1,1,−1,−1,−1,1,1,1,−1,1,1,1,1,1,1,1,1,−1,−1,−1,−1,−1,−1,−1,−1,−1,−1,1,−1,−1,1,1,1,−1,−1,−1,−1,−1,−1,−1,−1,1,1,−1,−1,1,1,1,1,1,−1,−1,1,1,−1,−1,1,1,1,−1, 1,1,1,1,1,1,1,1,1,−1,1,−1,−1,1,−1,1,1,−1,1,1,−1,−1,−1,−1,−1,1,−1,−1,1, 1, 1, 1, 1, 1,1,1,1,−1,−1,1,−1,−1,1,1,1,0,0,0,0,0}
For 20 MHz transmission, the N-TF sequence with the format of an HELTF20, optimized for estimation order P=9, is given by:
N-TF(HELTF20,P=9)=sqrt(256/242)·{0,0,0,0,0,0,1,−1,1,1,−1,1,1,1,−1,−1,−1,−1,1,−1,−1,−1,1,1,1,−1,1,−1,1,−1,1,1,1,−1,−1,−1,1,1,−1,−1,1,−1,1,−1,−1,−1,−1,−1,1,−1,1,−1,1,−1,1,1,1,1,−1,1,1,−1,1,−1,−1,1,1,−1,−1,−1,1,−1,1,−1,1,−1,1,−1,−1,1,1,−1,−1,−1,1,−1,1,1,1,1,1,−1,1,−1,−1,−1,1,−1,1,1,−1,−1,1,1,−1,−1,1,1,1,1,−1,−1,−1,−1,−1,−1,1,−1,1,−1,1,1,1,1,−1,−1,1,0,0,0,−1,−1,1,1,1,1,1,−1,1,1,1,−1,−1,−1,−1,1,1,−1,−1,−1,1,1,1,−1,1,1,1,1,−1,−1,−1,−1,1,−1,1,1,−1,−1,1,1,1,1,1,−1,1,−1,−1,−1,−1,−1,−1,1,1,1,1,−1,−1,−1,1,1,−1,−1,−1,1,1,−1,−1,−1,1,1,1,1,1,−1,−1,−1,1,−1,1,−1,−1,−1,1,1,−1,−1,1,−1,1,1,1,−1,−1,−1,−1,−1,1,−1,−1,1,1,1,1,−1,−1,1,1,1,1,−1,−1,−1,−1,−1,−1,1,1,−1,1,1,1,0,0,0,0,0}
For 20 MHz transmission, the N-TF sequence with the format of an HELTF20, optimized for estimation order P=10, is given by:
N-TF(HELTF20,P=10)=sqrt(256/242)·{0,0,0,0,0,0,−1,−1,−1,1,−1,1,1,1,−1,−1,−1,−1,−1,−1,−1,1,−1,1,1,1,−1,1,−1,1,−1,−1,−1,1,−1,1,1,−1,−1,−1,−1,1,−1,−1,1,1,−1,1,1,−1,−1,1,−1,−1,−1,−1,1,−1,−1,1,1,−1,1,−1,−1,1,−1,−1,1,−1,−1,1,−1,−1,−1,−1,1,1,−1,−1,−1,−1,−1,−1,−1,−1,−1,−1,1,1,−1,1,1,−1,−1,−1,−1,−1,−1,1,−1,1,−1,1,−1,−1,−1,1,−1,−1,−1,−1,1,1,1,1,−1,−1,−1,1,−1,−1,−1,1,−1,1,−1,0,0,0,−1,−1,−1,−1,1,−1,−1,1,1,1,1,−1,−1,1,−1,−1,−1,−1,−1,1,−1,1,−1,−1,1,1,−1,−1,1,−1,−1,−1,−1,1,−1,1,1,1,−1,1,−1,−1,−1,−1,−1,1,−1,−1,1,−1,−1,1,1,−1,−1,−1,−1,1,−1,−1,1,1,−1,1,−1,−1,−1,−1,−1,1,−1,1,1,1,−1,1,−1,−1,−1,−1,−1,1,−1,1,1,1,−1,1,−1,−1,−1,−1,−1,1,−1,1,1,−1,−1,1,−1,−1,−1,−1,−1,−1,−1,1,1,−1,−1,1,−1,1,1,−1,−1,−1,−1,1,−1,0,0,0,0,0}
List13
For 40 MHz transmission, the N-TF sequence with the format of an HESTF40, optimized for estimation order P=3, is given by:
N-TF(HESTF40,P=3)=sqrt(512/30)·{0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0}
For 40 MHz transmission, the N-TF sequence with the format of an HESTF40, optimized for estimation order P=4, is given by:
N-TF(HESTF40,P=4)=sqrt(512/30)·{0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0}
For 40 MHz transmission, the N-TF sequence with the format of an HESTF40, optimized for estimation order P=5, is given by:
N-TF(HESTF40,P=5)=sqrt(512/30)·{0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0}
For 40 MHz transmission, the N-TF sequence with the format of an HESTF40, optimized for estimation order P=6, is given by:
N-TF(HESTF40,P=6)=sqrt(512/30)·{0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0}
For 40 MHz transmission, the N-TF sequence with the format of an HESTF40, optimized for estimation order P=7, is given by:
N-TF(HESTF40,P=7)=sqrt(512/30)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0}
For 40 MHz transmission, the N-TF sequence with the format of an HESTF40, optimized for estimation order P=8, is given by:
N-TF(HESTF40,P=8)=sqrt(512/30)·{0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0}
For 40 MHz transmission, the N-TF sequence with the format of an HESTF40, optimized for estimation order P=9, is given by:
N-TF(HESTF40,P=9)=sqrt(512/30)·{0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0}
For 40 MHz transmission, the N-TF sequence with the format of an HESTF40, optimized for estimation order P=10, is given by:
N-TF(HESTF40,P=10)=sqrt(512/30)·{0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0}
List14
For 40 MHz transmission, the N-TF sequence with the format of an HELTF40, optimized for estimation order P=3, is given by:
N-TF(HELTF40,P=3)=sqrt(512/484)·{0,0,0,0,0,0,0,0,0,0,0,0,1,1,1,−1,1,−1,−1,1,−1,1,−1,1,−1,1,1,−1,1,1,−1,1,1,1,1,1,−1,1,1,−1,−1,−1,1, 1,−1,1,1,−1,1,1,−1,1,−1,−1,1,1,−1,1,1,1,1,−1,1,−1,−1,1,1,−1,1,1,−1,−1,1,−1,1,−1,−1,1,−1,−1,1,1,−1,−1,1,−1,1,−1,−1,−1,1,−1,1,−1,1,1,1,1,−1,1,−1,−1,−1,1,−1,1,−1,1,1,1,1,1,1,1,−1,1,1,1,1,1,1,−1,−1,−1,1,−1,1,−1,−1,1,−1,1,1,−1,1,−1,−1,1,−1,−1,1,−1,1,1,−1,−1,1,−1,1,−1,1,1,−1,1,1,−1,−1,1,−1,−1,−1,1,−1,1,−1,−1,1,−1,−1,1,−1,−1,1,−1,1,−1,1,1,1,−1,1,1,−1,1,−1,1,−1,1,−1,1,−1,1,−1,−1,1,−1,−1,−1,1,−1,1,−1,1,1,−1,−1,1,1,1,−1,−1,−1,1,1,−1,1,−1,1,−1,−1,−1,−1,1,1,−1,1,1,−1,1,−1,−1,1,1,1,−1,1,−1,1,−1,−1,−1,−1,−1,1,−1,1,1,1,1,1,1,−1,1,−1,0,0,0,0,0,1,1,−1,−1,1,1,−1,1,−1,−1,1,−1,1,1,−1,1,−1,−1,−1,1,−1,1,−1,1,−1,1,−1,1,−1,−1,−1,−1,−1,−1,1,−1,1,1,1,−1,1,−1,1,−1,1,−1,1,1,1,−1,1,−1,1,1,−1,−1,−1,1,1,1,1,1,1,−1,1,−1,−1,−1,−1,−1,−1,−1,1,−1,1,−1,−1,1,−1,1,−1,1,−1,−1,−1,−1,1,1,−1,1,−1,−1,−1,1,1,1,1,−1,1,−1,1,1,−1,−1,1,−1,1,1,−1,−1,1,1,−1,1,−1,−1,1,−1,1,1,−1,1,1,−1,1,−1,−1,−1,1,−1,1,1,−1,1,−1,1,1,−1,1,1,−1,1,−1,1,1,−1,1,−1,−1,1,−1,−1,−1,−1,1,1,−1,1,1,−1,−1,−1,−1,−1,1,−1,1,1,−1,−1,1,−1,1,1,−1,−1,−1,−1,1,−1,1,1,1,−1,1,−1,−1,−1,−1,1,1,−1,1,−1,−1,−1,−1,−1,−1,−1,−1,1,1,−1,1,1,−1,1,1,1,1,1,1,1,−1,−1,−1,−1,1,1,1,−1,1,−1,1,−1,−1,−1,−1,1,1,−1,1,−1,−1,−1,1,1,−1,−1,1,−1,0,0,0,0,0,0,0,0,0,0,0}
For 40 MHz transmission, the N-TF sequence with the format of an HELTF40, optimized for estimation order P=4, is given by:
N-TF(HELTF40,P=4)=sqrt(512/484)·{0,0,0,0,0,0,0,0,0,0,0,0,1,1,1,−1,1,1,1,1,−1,−1,−1,1,−1,−1,1,1,1,1,−1,1,1,−1,1,1,−1,1,−1,1,−1,−1,1,−1,1,−1,−1,−1,1,1,−1,−1,−1,1,−1,−1,1,1,1,1,1,1,−1,−1,1,−1,−1,1,1,1,−1,−1,−1,−1,1,−1,−1,1,1,1,1,−1,−1,1,−1,−1,−1,1,−1,1,1,−1,−1,−1,−1,−1,−1,1,1,−1,−1,−1,−1,1,−1,1,−1,1,−1,−1,1,1,1,−1,−1,−1,1,−1,1,−1,−1,1,−1,1,1,−1,−1,1,−1,−1,−1,1,−1,1,−1,−1,1,1,−1,−1,−1,1,1,−1,−1,−1,1,1,1,−1,−1,1,1,1,−1,1,1,1,−1,−1,1,1,1,−1,1,−1,1,1,−1,−1,1,1,1,1,1,1,−1,−1,1,1,1,1,1,1,−1,−1,1,1,1,−1,1,1,1,1,1,1,1,1,−1,1,1,1,1,−1,1,1,1,−1,1,−1,1,1,−1,1,1,−1,1,−1,−1,1,1,1,1,1,−1,−1,−1,1,−1,1,1,1,1,−1,1,1,1,−1,1,1,−1,1,−1,−1,1,−1,−1,1,−1,1,1,0,0,0,0,0,1,−1,1,−1,1,1,−1,−1,1,1,−1,−1,1,−1,−1,−1,−1,1,−1,−1,−1,1,−1,1,1,−1,−1,1,−1,−1,−1,−1,−1,−1,−1,1,−1,1,−1,−1,−1,−1,1,1,−1,1,1,1,1,1,−1,−1,1,−1,1,−1,1,1,1,−1,1,1,−1,−1,−1,1,−1,1,1,−1,1,1,1,−1,−1,−1,1,1,−1,1,1,−1,−1,−1,−1,1,1,1,−1,1,1,1,1,−1,−1,−1,1,−1,1,1,1, 1, 1, 1,1,1,1,1,1,1,−1,−1,−1,1,−1,1,−1,1,1,1,1,−1,1,−1,1,1,−1,1,−1,1,1,−1,1,−1,1,1,1,1, 1,1,1,1,−1,1,1,−1,1,1,1,1,−1,−1,1,−1,1,1,1,−1,1,1,−1,−1,−1,−1,−1,−1,−1,−1,1,1,−1,−1,−1,1,−1,−1,−1,−1,−1,1,−1,1,−1,−1,−1,−1,1,−1,−1,−1,−1,−1,−1,1,−1,−1,−1,−1,−1,−1,−1,−1,1,1,−1,−1,−1,−1,−1,1,−1,−1,−1,−1,−1,−1,−1,−1,1,−1,−1,1,1,1,1,−1,−1,−1,−1,−1,−1,1,−1,1,−1,1,1,−1,1,−1,−1,−1,−1,0,0,0,0,0,0,0,0,0,0,0}
For 40 MHz transmission, the N-TF sequence with the format of an HELTF40, optimized for estimation order P=5, is given by:
N-TF(HELTF40,P=5)=sqrt(512/484)·{0,0,0,0,0,0,0,0,0,0,0,0,1,−1,−1,−1,−1,1,1,−1,1,1,1,−1,−1,1,1,−1,1,1,−1,−1,−1,1,1,−1,1,1,1,1,−1,−1,−1,−1,1,−1,−1,−1,−1,1,−1,−1,−1,−1,−1,−1,−1,−1,−1,−1,−1,1,−1,−1,1,1,−1,1,−1,−1,1,−1,1,−1,−1,1,1,1,−1,1,−1,−1,−1,−1,1,−1,−1,1,−1,−1,−1,−1,1,−1,−1,−1,−1,−1,1,1,−1,−1,−1,−1,−1,1,−1,1,−1,−1,1,1,1,−1,−1,1,1,−1,−1,1,1,1,−1,−1,1,−1,−1,1,−1,1,−1,−1,1,−1,1,1,−1,1,1,1,−1,−1,−1,1,−1,−1,−1,1,−1,1,−1,−1,−1,−1,−1,−1,−1,−1,1,−1,−1,−1,−1,−1,1,1,−1,−1,−1,1,−1,1,−1,−1,1,−1,−1,−1,−1,−1,−1,−1,−1,1,−1,−1,1,1,−1,1,1,−1,1,1,1,−1,−1,1,−1,−1,1,1,1,−1,−1,−1,−1,−1,−1,1,1,−1,−1,1,1,−1,−1,−1,−1,1,1,1,1,−1,1,1,1,−1,1,−1,1,1,1,1,−1,1,1,1,−1,−1,1,−1,−1,−1,−1,−1,−1,−1,−1,−1,−1,−1,1,−1,0,0,0,0,0,1,−1,−1,1,1,−1,−1,−1,1,−1,−1,1,−1,1,1,−1,−1,1,−1,−1,−1,−1,−1,−1,1,−1,1,1,1,−1,−1,−1,−1,1,−1,−1,1,−1,−1,−1,1,−1,−1,−1,1,1,−1,1,1,−1,1,1,−1,1,1,−1,1,1,−1,1,1,1,−1,1,−1,1,1,−1,1,−1,1,−1,1,−1,1,1,1,−1,−1,1,1,−1,−1,1,−1,1,−1,1,−1,−1,1,−1,1,−1,1,1,−1,−1,−1,1,−1,−1,−1,−1,−1,−1,−1,1,−1,−1,−1,−1,−1,−1,1,−1,−1,−1,1,−1,1,−1,−1,−1,−1,1,−1,1,−1,−1,1,−1,1,1,−1,1,−1,−1,1,−1,−1,−1,1,−1,−1,1,−1,−1,−1,−1,1,−1,−1,−1,−1,−1,1,1,−1,1,−1,1,1,−1,1,1,1,1,1,1,1,1,1,1,−1,−1,−1,1,−1,−1,1,−1,−1,−1,−1,−1,−1,−1,−1,1,−1,−1,−1,1,−1,1,1,−1,1,1,1,−1,−1,−1,1,−1,−1,−1,1,−1,−1,−1,−1,−1,−1,−1,1,1,1,1,1,−1,−1,−1,−1,−1,1,−1,−1,−1,−1,1,−1,−1,−1,1,1,−1,1,1,−1,1,0,0,0,0,0,0,0,0,0,0,0}
For 40 MHz transmission, the N-TF sequence with the format of an HELTF40, optimized for estimation order P=6, is given by:
N-TF(HELTF40,P=6)=sqrt(512/484)·{0,0,0,0,0,0,0,0,0,0,0,0,−1,−1,−1,1,−1,1,−1,1,−1,1,−1,1,1,−1,−1,−1,1,1,−1,−1,−1,1,1,1,−1,−1,−1,−1,1,−1,−1,−1,−1,−1,1,−1,−1,1,−1,−1,−1,1,1,1,−1,−1,−1,1,−1,−1,−1,−1,1,1,1,−1,−1,1,−1,1,1,−1,1,−1,−1,−1,−1,1,1,1,−1,−1,1,1,1,1,−1,−1,−1,−1,−1,−1,−1,−1,−1,−1,1,−1,1,1,1,1,−1,1,−1,−1,1,−1,−1,1,1,−1,1,−1,−1,1,−1,1,1,−1,1,−1,−1,−1,−1,−1,−1,−1,1,−1,1,1,−1,−1,1,−1,1,1,−1,−1,−1,−1,−1,−1,−1,−1,1,−1,−1,1,−1,−1,−1,1,−1,1,−1,−1,1,−1,−1,−1,−1,1,−1,−1,1,1,1,1,−1,−1,−1,1,1,−1,−1,1,−1,1,1,−1,−1,1,−1,1,1,−1,−1,−1,−1,1,1,1,1,1,−1,−1,1,1,−1,−1,1,−1,1,1,−1,−1,1,−1,−1,−1,1,−1,1,−1,−1,−1,−1,−1,−1,−1,−1,1,−1,−1,1,−1,−1,1,1,−1,−1,1,−1,−1,−1,−1,−1,1,1,−1,−1,−1,1,1,−1,1,1,1,1,−1,0,0,0,0,0,1,−1,−1,−1,−1,1,1,−1,1,1,−1,−1,1,1,−1,−1,−1,−1,1,1,−1,−1,−1,−1,−1,1,−1,1,1,−1,1,−1,−1,−1,−1,−1,−1,1,1,1,1,−1,−1,−1,−1,−1,1,−1,−1,−1,−1,−1,−1,−1,−1,1,1,−1,−1,−1,−1,−1,−1,1,1,1,1,−1,−1,1,−1,1,1,−1,−1,−1,−1,1,−1,−1,1,1,−1,1,1,−1,−1,1,−1,−1,1,−1,−1,1,1,1,1,−1,−1,1,−1,1,1,1,−1,1,1,−1,−1,1,−1,1,1,−1,−1,1,−1,−1,−1,1,1,1,1,1,−1,−1,1,−1,−1,−1,1,−1,−1,−1,−1,−1,1,−1,−1,−1,1,−1,1,−1,−1,−1,−1,1,1,−1,−1,−1,1,−1,1,1,−1,−1,1,−1,1,1,−1,−1,−1,−1,−1,−1,−1,1,−1,−1,−1,1,1,−1,−1,1,1,1,1,−1,1,−1,1,1,−1,−1,1,1,1,1,−1,−1,1,1,−1,−1,1,−1,1,−1,−1,1,1,1,−1,−1,−1,−1,−1,1,1,−1,−1,−1,1,−1,−1,−1,−1,−1,1,−1,−1,1,−1,−1,−1,1,−1,−1,−1,−1,−1,−1,1,1,1,−1,−1,1,0,0,0,0,0,0,0,0,0,0,0}
For 40 MHz transmission, the N-TF sequence with the format of an HELTF40, optimized for estimation order P=7, is given by:
N-TF(HELTF40,P=7)=sqrt(512/484)·{0,0,0,0,0,0,0,0,0,0,0,0,1,−1,1,1,1,−1,1,−1,1,1,−1,−1,−1,−1,−1,−1,−1,1,1,−1,1,1,−1,1,−1,1,1,−1,−1,1,1,1,−1,1,1,1,1,−1,1,−1,−1,1,−1,1,−1,−1,−1,−1,−1,1,−1,1,−1,−1,−1,1,−1,−1,1,1,1,1,1,−1,1,1,1,−1,−1,−1,−1,1,1,−1,1,−1,−1,1,1,−1,1,−1,1,−1,−1,−1,−1,1,1,−1,1,1,−1,−1,−1,1,1,−1,−1,1,1,−1,1,1,1,−1,−1,−1,−1,−1,−1,−1,1,−1,−1,−1,1,−1,1,−1,1,−1,1,−1,−1,−1,1,−1,1,1,−1,−1,1,−1,1,−1,−1,−1,−1,−1,1,−1,−1,−1,1,−1,−1,1,−1,−1,1,−1,1,−1,1,−1,−1,1,1,−1,1,−1,1,−1,1,−1,−1,1,−1,1,−1,−1,1,−1,−1,1,−1,−1,1,−1,1,1,−1,−1,1,1,−1,−1,1,−1,−1,−1,−1,1,−1,1,−1,1,−1,1,−1,−1,−1,−1,−1,−1,−1,−1,−1,−1,1,−1,1,−1,−1,−1,−1,−1,−1,1,−1,−1,−1,−1,−1,1,−1,1,1,−1,1,−1,−1,−1,−1,−1,−1,−1,−1,1,−1,1,0,0,0,0,0,−1,−1,−1,1,1,1,1,1,1,−1,−1,1,1,1,1,−1,−1,−1,−1,1,−1,1,−1,1,−1,1,−1,1,−1,1,−1,−1,−1,1,−1,1,−1,1,1,1,−1,1,−1,1,−1,1,1,−1,−1,−1,−1,1,−1,−1,−1,−1,−1,1,1,−1,−1,1,−1,−1,1,1,−1,−1,−1,−1,1,1,−1,1,1,1,−1,1,−1,1,−1,1,−1,1,−1,−1,−1,−1,−1,−1,1,−1,−1,1,−1,1,1,1,1,1,−1,1,−1,−1,1,1,1,−1,−1,−1,1,−1,−1,−1,−1,1,−1,−1,−1,−1,−1,1,−1,−1,−1,−1,1,−1,1,−1,1,−1,1,−1,1,−1,−1,−1,−1,−1,−1,−1,1,−1,−1,−1,−1,1,−1,−1,−1,1,−1,−1,−1,−1,−1,1,−1,1,−1,−1,1,1,−1,−1,−1,1,1,−1,−1,1,1,1,−1,1,−1,1,−1,1,−1,−1,−1,−1,−1,1,−1,1,1,1,−1,1,−1,1,1,−1,1,1,1,−1,−1,1,−1,1,−1,−1,−1,1,−1,1,−1,−1,−1,−1,−1,1,−1,−1,−1,−1,1,1,−1,1,−1,−1,−1,−1,−1,1,−1,1,−1,1,−1,1,−1,1,−1,−1,−1,1,0,0,0,0,0,0,0,0,0,0,0}
For 40 MHz transmission, the N-TF sequence with the format of an HELTF40, optimized for estimation order P=8, is given by:
N-TF(HELTF40,P=8)=sqrt(512/484)·{0,0,0,0,0,0,0,0,0,0,0,0,1,−1,−1,−1,−1,1,1,−1,−1,1,−1,−1,−1,−1,1,−1,−1,1,−1,1,1,−1,1,−1,1,1,−1,1, 1, 1, 1,−1,−1,1,1,−1,−1,1,1,−1,−1,−1,1,−1,−1,−1,1,1,−1,−1,−1,1,1,−1,−1,1,−1,−1,−1,1,1,1,−1,1,−1,1,1,−1,1,1,1,1,−1,1,1,−1,−1,1,−1,1,1,−1,1,1,−1,−1,−1,1,−1,−1,1,1,−1,1,−1,−1,−1,−1,−1,1,−1,1,1,1,1,−1,1,1,1,1,1,−1,−1, −1,1,1,−1,1,1,−1,1,1,−1,1,−1,1,−1,1,−1,1,1,−1,1,−1,1,−1,−1,1,1,1,1,1,−1,1,−1,1,−1,1,−1,−1,1,1,−1,−1,−1,1,−1,−1,1,−1,−1,−1,−1,−1,1,−1,−1,−1,1,−1,−1,−1,1,1,1,1,−1,−1,−1,1,−1,−1,1,1,−1,−1,−1,1,−1,−1,1,1,−1,1,1,−1,1,−1,−1,−1,1,1,−1,−1,1,−1,1,−1,−1,1,1,−1,1,−1,1,1,−1,1,1,−1,−1,1,1,1,−1,1,−1,1,1,1,−1,1,−1,−1,1,−1,−1,−1,1,1,1,−1,1,0,0,0,0,0,1,1,1,1,−1,1,−1,1,−1,1,−1,1,−1,1,−1,1,−1,−1,−1,1,−1,−1,1,−1,1,−1,−1,−1,1,1,1,1,−1,1,1,1,−1,1,1,−1,−1,1,1,1,−1,−1,−1,1,−1,−1,−1,1,−1,−1,−1,−1,1,1,−1,−1,1,−1,−1,−1,1,1,−1,−1,1,−1,1,−1,1,1,1,−1,1,1,−1,1,1,1,1,−1,−1,1,−1,1,−1,1,−1,1,1,−1,−1,1,1,−1,1,−1,1,1,1,−1,1,−1,1,−1,−1,−1,1,1,1,1,1,1,−1,1,−1,1,1,1,−1,1,−1,1,−1,1,−1,−1,−1,1,−1,−1,1,−1,−1,−1,−1,−1,1,1,−1,−1,1,−1,−1,−1,−1,1,1,−1,−1,1,−1,1,−1,−1,1,1,−1,1,−1,1,−1,−1,−1,1,1,1,−1,−1,1,1,−1,1,1,1,−1,−1,1,−1,−1,1,−1,−1,1,1,−1,−1,1,1,−1,−1,1,−1,1,1,−1,1,−1,1,−1,−1,−1,1,−1,1,1,−1,1,−1,−1,−1,1,−1,1,−1,1,−1,−1,−1,1,−1,−1,−1,1,1,−1,1,1,−1,−1,−1,−1,1,1,1,−1,1,1,−1,0,0,0,0,0,0,0,0,0,0,0}
For 40 MHz transmission, the N-TF sequence with the format of an HELTF40, optimized for estimation order P=9, is given by:
N-TF(HELTF40,P=9)=sqrt(512/484)·{0,0,0,0,0,0,0,0,0,0,0,0,−1,−1,−1,−1,−1,1,1,1,1,1,1,−1,1,−1,−1,1,−1,1,1,1,−1,−1,1,−1,−1,−1,1, 1, 1, 1, 1,−1,1,−1,−1,1,1,−1,1,1,−1,1,−1,−1,1,1,1,1,1,1,1,−1,−1,−1,−1,1,1,1,1,1,−1,−1,−1,1,1,−1,1,−1,1,1,−1,1,−1,1,1,−1,1,−1,1,1,−1,−1,−1,1,−1,−1,1,1,1,1,−1,−1,1,1,1,1,1,−1,1,1,1,−1,1,−1,1,1,1,−1,−1,1,1,−1,1,1,1,1,−1,−1,1,1,1,1,1,1,1,−1,1,1,−1,−1,1,−1,1,1,−1,1,1,1,−1,−1,1,−1,1,1,1,−1,1,1,1,1,−1,−1,1,1,1,−1,−1,1,−1,1,−1,−1,1,1,1,−1,1,1,−1,1,1,−1,1,1,−1,−1,1,1,1,1,−1,1,1,1,1,1,−1,1,−1,1,1,−1,1,1,−1,−1,1,−1,1,1,1,1,−1,1,1,−1,1,1,1,1,1,−1,1,1,−1,1,1,1,1,1,1,−1,1,1,−1,1,1,1,1,1,1,−1,1,1,−1,−1,1,−1,1,1,1,1,0,0,0,0,0,1,1,1,1,−1,−1,1,−1,1,1,1,1,1,1,−1,−1,−1,−1,−1,1,1,1,1,1,−1,−1,−1,1,1,1,1,−1,1,1,1,−1,1,1,−1,1,1,−1,1,1,1,1,1,1,−1,1,−1,1,1,1,−1,−1,−1,1,−1,1,1,1,1,1,−1,−1,1,1,−1,1,1,1,1,−1,1,−1,−1,1,1,−1,1,1,−1,1,−1,−1,1,1,−1,1,−1,−1,−1,−1,−1,−1,−1,−1,1,1,1,1,−1,1,−1,1,−1,1,1,1,1,1,1,1,1,−1,1,1,1,1,1,−1,1,1,−1,−1,1,−1,1,1,1,1,−1,−1,−1,1,1,−1,1,−1,1,−1,−1,1,−1,−1,1,1,1,1,1,−1,−1,1,−1,1,−1,1,−1,−1,−1,−1,−1,1,−1,1,1,1,−1,−1,−1,−1,1,−1,1,−1,1,−1,−1,−1,−1,−1,−1,1,1,1,1,1,−1,−1,−1,1,−1,1,1,−1,−1,1,−1,1,−1,1,−1,1,1,−1,1,1,1,−1,−1,−1,−1,1,1,−1,1,−1,1,−1,1,1,−1,1,−1,−1,1,−1,−1,1,−1,1,−1,1,−1,1,−1,1,1,−1,1,1,0,0,0,0,0,0,0,0,0,0,0}
For 40 MHz transmission, the N-TF sequence with the format of an HELTF40, optimized for estimation order P=10, is given by:
N-TF(HELTF40,P=10)=sqrt(512/484)·{0,0,0,0,0,0,0,0,0,0,0,0,1,−1,1,−1,1,−1,−1,−1,1,1,1,−1,1,1,−1,1,−1,1,−1,1,1,−1,−1,1,1,1,−1,1,−1,1,1,1,1,−1,−1,1,−1,1,−1,1,1,1,1,−1,1,−1,1,1,1,−1,1,−1,−1,1,−1,−1,1,1,1,1,−1,1,−1,1,−1,1,−1,−1,−1,1,1,−1,1,−1,1,−1,1,−1,1,−1,1,1,1,−1,−1,−1,−1,1,−1,1,−1,1,−1,1,−1,−1,1,−1,−1,−1,−1,−1,1,1,1,1,1,−1,1,−1,−1,1,−1,1,−1,1,−1,1,−1,1,1,1,−1,1,−1,−1,1,1,−1,−1,1,−1,1,−1,1,1,1,1,1,−1,−1,1,1,−1,−1,1,−1,1,1,1,1,1,1,1,1,−1,1,−1,1,1,−1,−1,−1,−1,1,1,1,−1,1,1,−1,1,−1,−1,−1,1,−1,−1,−1,−1,−1,1,−1,1,1,−1,1,1,−1,1,−1,−1,1,1,1,−1,1,1,1,1,1,−1,1,−1,−1,−1,−1,−1,1,−1,1,−1,1,1,1,1,1,−1,−1,−1,−1,−1,1,−1,−1,−1,1,−1,−1,1,1,−1,1,−1,−1,−1,−1,1,1,−1,−1,0,0,0,0,0,−1,1,−1,1,−1,−1,−1,1,1,1,1,1,1,−1,1,−1,1,1,−1,−1,−1,1,−1,1,−1,−1,1,−1,1,1,−1,1,1,1,1,1,1,−1,1,−1,1,1,1,−1,1,−1,1,1,−1,−1,−1,−1,−1,−1,−1,−1,1,1,1,1,−1,1,1,1,1,1,−1,1,−1,1,−1,1,−1,−1,1,1,−1,−1,−1,−1,1,−1,1,−1,−1,−1,1,1,−1,1,1,−1,1,−1,−1,1,−1,−1,−1,−1,−1,−1,1,−1,1,−1,1,−1,1,−1,1,−1,−1,−1,−1,−1,−1,−1,−1,1,1,−1,1,1,−1,1,1,1,−1,−1,−1,1,−1,−1,−1,1,1,−1,1,−1,1,1,1,1,−1,−1,−1,1,−1,1,1,1,1,1,−1,1,1,−1,−1,−1,1,−1,1,−1,1,−1,1,−1,1,−1,1,−1,1,1,1,1,−1,−1,−1,1,−1,1,−1,1,−1,1,1,−1,−1,−1,1,−1,−1,−1,−1,−1,1,1,1,−1,−1,1,1,−1,−1,−1,−1,1,−1,1,−1,1,−1,1,1,1,1,−1,1,1,1,−1,−1,−1,−1,−1,1,−1,1,1,1,1,1,−1,1,1,−1,1,−1,1,−1,1,0,0,0,0,0,0,0,0,0,0,0}
List15
For 40 MHz transmission, the N-TF sequence with the format of an HELTF2X40, optimized for estimation order P=3, is given by:
N-TF(HELTF2X40,P=3)=sqrt(512/242)·{0,0,0,0,0,0,0,0,0,0,0,0,1,0,−1,0,−1,0,−1,0,−1,0,−1,0,1,0,−1,0,−1,0,1,0,−1,0,−1,0,−1,0,1,0,1,0,−1,0,1,0,−1,0,−1,0,1,0,1,0,1,0,−1,0,1,0,1,0,1,0,−1,0,1,0,1,0,1,0,−1,0,−1,0,−1,0,1,0,1,0,1,0,1,0,−1,0,−1,0,−1,0,1,0,1,0,−1,0,1,0,−1,0,−1,0,1,0,1,0,1,0,1,0,−1,0,−1,0,−1,0,−1,0,1,0,1,0,1,0,1,0,−1,0,−1,0,−1,0,1,0,−1,0,1,0,−1,0,−1,0,1,0,−1,0,1,0,−1,0,1,0,−1,0,1,0,−1,0,−1,0,−1,0,1,0,1,0,1,0,−1,0,−1,0,1,0,−1,0,1,0,−1,0,−1,0,1,0,−1,0,1,0,−1,0,1,0,1,0,1,0,−1,0,−1,0,1,0,−1,0,1,0,−1,0,−1,0,−1,0,1,0,−1,0,−1,0,1,0,1,0,1,0,−1,0,−1,0,1,0,1,0,1,0,−1,0,1,0,−1,0,1,0,1,0,1,0,1,0,−1,0,1,0,0,0,0,0,0,0,1,0,1,0,−1,0,−1,0,1,0,1,0,1,0,1,0,1,0,−1,0,−1,0,−1,0,−1,0,−1,0,1,0,−1,0,1,0,−1,0,−1,0,−1,0,1,0,1,0,−1,0,1,0,−1,0,−1,0,1,0,1,0,1,0,−1,0,1,0,1,0,−1,0,−1,0,1,0,−1,0,1,0,−1,0,−1,0,1,0,−1,0,1,0,−1,0,1,0,1,0,−1,0,1,0,−1,0,1,0,1,0,1,0,−1,0,−1,0,−1,0,1,0,1,0,1,0,−1,0,−1,0,−1,0,−1,0,−1,0,−1,0,1,0,1,0,−1,0,1,0,−1,0,1,0,1,0,1,0,1,0,−1,0,−1,0,−1,0,1,0,1,0,−1,0,1,0,−1,0,−1,0,−1,0,−1,0,1,0,1,0,−1,0,−1,0,−1,0,1,0,−1,0,−1,0,−1,0,−1,0,1,0,−1,0,−1,0,1,0,1,0,−1,0,−1,0,1,0,−1,0,1,0,1,0,1,0,−1,0,−1,0,−1,0,−1,0,−1,0,1,0,1,0,−1,0,1,0,−1,0,−1,0,−1,0,1,0,1,0,−1,0,−1,0,0,0,0,0,0,0,0,0,0,0}
For 40 MHz transmission, the N-TF sequence with the format of an HELTF2X40, optimized for estimation order P=4, is given by:
N-TF(HELTF2X40,P=4)=sqrt(512/242)·{0,0,0,0,0,0,0,0,0,0,0,0,1,0,−1,0,−1,0,−1,0,−1,0,1,0,1,0,−1,0,−1,0,−1,0,−1,0,1,0,1,0,1,0,1,0,1,0,−1,0,1,0,1,0,1,0,−1,0,−1,0,1,0,−1,0,−1,0,−1,0,−1,0,−1,0,1,0,−1,0,−1,0,1,0,1,0,1,0,−1,0,1,0,−1,0,1,0,1,0,1,0,1,0,1,0,−1,0,−1,0,−1,0,−1,0,−1,0,−1,0,−1,0,−1,0,−1,0,−1,0,−1,0,1,0,1,0,1,0,1,0,1,0,1,0,1,0,1,0,1,0,1,0,1,0,−1,0,−1,0,−1,0,−1,0,−1,0,−1,0,−1,0,−1,0,−1,0,−1,0,−1,0,1,0,1,0,1,0,1,0,1,0,1,0,−1,0,1,0,1,0,1,0,1,0,−1,0,1,0,−1,0,1,0,1,0,−1,0,1,0,1,0,1,0, 1,0,−1,0,−1,0,1,0,1,0,1,0,1,0,−1,0,−1,0,1,0,−1,0,1,0,1,0,1,0,−1,0,−1,0,1,0,1,0,−1,0,1,0,−1,0,−1,0,1,0,1,0,−1,0,−1,0,0,0,0,0,0,0,−1,0,−1,0,−1,0,−1,0,−1,0,1,0,1,0,1,0,−1,0,1,0,1,0,1,0,1,0,1,0,1,0,1,0,−1,0,−1,0,−1,0,−1,0,1,0,−1,0,−1,0,−1,0,1,0,−1,0,1,0,1,0,1,0,1,0,−1,0,1,0,1,0,1,0,1,0,−1,0,−1,0,1,0,−1,0,−1,0,−1,0,−1,0,−1,0,−1,0,1,0,1,0,−1,0,−1,0,1,0,1,0,1,0,1,0,1,0,1,0,1,0,−1,0,1,0,1,0,−1,0,−1,0,−1,0,1,0,−1,0,−1,0,−1,0,−1,0,−1,0,−1,0,−1,0,1,0,1,0,1,0,−1,0,1,0,1,0,−1,0,1,0,1,0,1,0,−1,0,−1,0,−1,0,1,0,1,0,−1,0,−1,0,1,0,−1,0,1,0,1,0,−1,0,1,0,1,0,1,0,−1,0,−1,0,1,0,−1,0,−1,0,1,0,1,0,1,0,−1,0,−1,0,−1,0,1,0,−1,0,−1,0,1,0,−1,0,−1,0,1,0,1,0,1,0,1,0,1,0,1,0,−1,0,−1,0,−1,0,−1,0,0,0,0,0,0,0,0,0,0,0}
For 40 MHz transmission, the N-TF sequence with the format of an HELTF2X40, optimized for estimation order P=5, is given by:
N-TF(HELTF2X40,P=5)=sqrt(512/242)·{0,0,0,0,0,0,0,0,0,0,0,0,1,0,1,0,1,0,1,0,1,0,−1,0,1,0,1,0,1,0,1,0,1,0,1,0,1,0,−1,0,−1,0,−1,0,−1,0,−1,0,1,0,−1,0,−1,0,−1,0,−1,0,−1,0,1,0,−1,0,1,0,−1,0,1,0,−1,0,1,0,1,0,1,0,1,0,1,0,−1,0,−1,0,−1,0,−1,0,−1,0,1,0,1,0,1,0,1,0,1,0,1,0,1,0,1,0,1,0,−1,0,1,0,−1,0,1,0,−1,0,−1,0,−1,0,−1,0,−1,0,−1,0,−1,0,1,0,1,0,−1,0,−1,0,1,0,1,0,1,0,−1,0,−1,0,−1,0,−1,0,−1,0,1,0,−1,0,1,0,1,0,1,0,−1,0,−1,0,−1,0,1,0,1,0,1,0,−1,0,1,0,1,0,−1,0,−1,0,1,0,−1,0,1,0,−1,0,1,0,−1,0,−1,0,−1,0,−1,0,1,0,1,0,1,0,−1,0,−1,0,1,0,1,0,1,0,1,0,1,0,1,0,−1,0,−1,0,−1,0,−1,0,1,0,−1,0,1,0,−1,0,1,0,−1,0,1,0,1,0,1,0,0,0,0,0,0,0,−1,0,−1,0,−1,0,−1,0,−1,0,−1,0,1,0,−1,0,−1,0,−1,0,1,0,1,0,1,0,−1,0,−1,0,1,0,−1,0,−1,0,1,0,−1,0,1,0,1,0,−1,0,−1,0,−1,0,1,0,1,0,1,0,1,0,1,0,1,0,−1,0,1,0,1,0,1,0,−1,0,1,0,−1,0,−1,0,−1,0,−1,0,−1,0,−1,0,−1,0,−1,0,1,0,−1,0,−1,0,1,0,−1,0,−1,0,−1,0,1,0,1,0,1,0,−1,0,−1,0,−1,0,−1,0,−1,0,1,0,−1,0,1,0,−1,0,1,0,1,0,1,0,1,0,1,0,1,0,−1,0,−1,0,1,0,−1,0,−1,0,−1,0,−1,0,−1,0,−1,0,−1,0,−1,0,1,0,−1,0,−1,0,−1,0,1,0,1,0,−1,0,1,0,−1,0,1,0,−1,0,1,0,−1,0,−1,0,−1,0,1,0,−1,0,1,0,1,0,1,0,−1,0,1,0,−1,0,1,0,−1,0,1,0,1,0,1,0,−1,0,−1,0,1,0,−1,0,−1,0,−1,0,−1,0,−1,0,−1,0,1,0,1,0,1,0,0,0,0,0,0,0,0,0,0,0}
For 40 MHz transmission, the N-TF sequence with the format of an HELTF2X40, optimized for estimation order P=6, is given by:
N-TF(HELTF2X40,P=6)=sqrt(512/242)·{0,0,0,0,0,0,0,0,0,0,0,0,1,0,1,0,−1,0,1,0,−1,0,−1,0,−1,0,1,0,1,0,−1,0,1,0,1,0,−1,0,1,0,1,0,−1,0,1,0,−1,0,−1,0,1,0,−1,0,−1,0,1,0,1,0,1,0,1,0,1,0,−1,0,1,0,−1,0,−1,0,1,0,1,0,−1,0,1,0,−1,0,−1,0,1,0,−1,0,1,0,1,0,−1,0,−1,0,1,0,−1,0,−1,0,1,0,−1,0,1,0,−1,0,−1,0,1,0,−1,0,−1,0,1,0,−1,0,−1,0,1,0,−1,0,1,0,1,0,1,0,1,0,1,0,1,0,1,0,1,0,−1,0,−1,0,−1,0,−1,0,−1,0,1,0,1,0,−1,0,1,0,1,0,−1,0,1,0,−1,0,1,0,1,0,−1,0,1,0,1,0,−1,0,1,0,−1,0,−1,0,1,0,−1,0,1,0,−1,0,1,0,1,0,−1,0,1,0,−1,0,1,0,1,0,−1,0,1,0,1,0,1,0,−1,0,−1,0,1,0,1,0,1,0,−1,0,1,0,1,0,−1,0,1,0,1,0,−1,0,1,0,−1,0,−1,0,1,0,−1,0,0,0,0,0,0,0,1,0,−1,0,1,0,1,0,1,0,1,0,1,0,1,0,−1,0,−1,0,−1,0,1,0,−1,0,1,0,−1,0,1,0,1,0,−1,0,1,0,−1,0,1,0,−1,0,1,0,−1,0,1,0,1,0,−1,0,−1,0,−1,0,1,0,1,0,−1,0,1,0,1,0,−1,0,−1,0,1,0,1,0,1,0,1,0,1,0,−1,0,1,0,1,0,−1,0,1,0,−1,0,−1,0,1,0,−1,0,−1,0,1,0,1,0,−1,0,1,0,1,0,−1,0,1,0,−1,0,1,0,1,0,−1,0,1,0,−1,0,−1,0,−1,0,1,0,−1,0,1,0,1,0,1,0,−1,0,−1,0,−1,0,−1,0,1,0,−1,0,−1,0,1,0,−1,0,1,0,−1,0,−1,0,1,0,1,0,−1,0,1,0,1,0,1,0,1,0,−1,0,1,0,1,0,1,0,1,0,1,0,−1,0,−1,0,−1,0,−1,0,−1,0,−1,0,1,0,−1,0,−1,0,1,0,1,0,1,0,1,0,−1,0,1,0,−1,0,−1,0,1,0,−1,0,1,0,1,0,−1,0,1,0,−1,0,1,0,0,0,0,0,0,0,0,0,0,0}
For 40 MHz transmission, the N-TF sequence with the format of an HELTF2X40, optimized for estimation order P=7, is given by:
N-TF(HELTF2X40,P=7)=sqrt(512/242)·{0,0,0,0,0,0,0,0,0,0,0,0,1,0,−1,0,−1,0,1,0,1,0,−1,0,1,0,1,0,−1,0,−1,0,1,0,1,0,−1,0,1,0,1,0,−1,0,−1,0,1,0,1,0,−1,0,1,0,1,0,−1,0,1,0,1,0,−1,0,−1,0,1,0,1,0,1,0,−1,0,1,0,1,0,1,0,−1,0,1,0,−1,0,−1,0,1,0,1,0,−1,0,−1,0,1,0,1,0,−1,0,1,0,−1,0,−1,0,1,0,−1,0,−1,0,−1,0,1,0,−1,0,1,0,1,0,1,0,−1,0,1,0,1,0,−1,0,−1,0,1,0,−1,0,1,0,1,0,1,0,1,0,1,0,1,0,1,0,−1,0,1,0,−1,0,−1,0,1,0,1,0,−1,0,−1,0,−1,0,1,0,1,0,−1,0,1,0,1,0,−1,0,1,0,1,0,−1,0,−1,0,1,0,1,0,−1,0,−1,0,1,0,−1,0,−1,0,1,0,−1,0,−1,0,−1,0,−1,0,−1,0,1,0,1,0,1,0,−1,0,1,0,1,0,−1,0,−1,0,1,0,−1,0,1,0,1,0,1,0,−1,0,1,0,1,0,1,0,−1,0,0,0,0,0,0,0,1,0,1,0,−1,0,−1,0,1,0,−1,0,−1,0,−1,0,−1,0,1,0,1,0,1,0,−1,0,−1,0,−1,0,1,0,1,0,−1,0,−1,0,−1,0,1,0,−1,0,1,0,1,0,−1,0,−1,0,1,0,−1,0,−1,0,1,0,−1,0,−1,0,1,0,−1,0,−1,0,1,0,1,0,−1,0,1,0,−1,0,−1,0,−1,0,1,0,−1,0,−1,0,−1,0,−1,0,−1,0,1,0,−1,0,−1,0,1,0,1,0,1,0,−1,0,−1,0,−1,0,1,0,1,0,1,0,−1,0,−1,0,−1,0,1,0,1,0,−1,0,−1,0,1,0,−1,0,−1,0,1,0,1,0,−1,0,1,0,1,0,−1,0,−1,0,1,0,−1,0,1,0,1,0,1,0,−1,0,1,0,1,0,−1,0,−1,0,1,0,−1,0,−1,0,1,0,1,0,−1,0,−1,0,−1,0,1,0,1,0,−1,0,−1,0,−1,0,1,0,1,0,−1,0,−1,0,−1,0,−1,0,1,0,1,0,−1,0,−1,0,1,0,−1,0,1,0,−1,0,−1,0,−1,0,1,0,−1,0,−1,0,−1,0,1,0,0,0,0,0,0,0,0,0,0,0}
For 40 MHz transmission, the N-TF sequence with the format of an HELTF2X40, optimized for estimation order P=8, is given by:
N-TF(HELTF2X40,P=8)=sqrt(512/242)·{0,0,0,0,0,0,0,0,0,0,0,0,−1,0,−1,0,1,0,1,0,1,0,1,0,1,0,−1,0,1,0,−1,0,1,0,1,0,1,0,1,0,−1,0,−1,0,1,0,−1,0,1,0,1,0,−1,0,1,0,1,0,−1,0,1,0,1,0,1,0,1,0,1,0,1,0,−1,0,−1,0,1,0,1,0,1,0,1,0,1,0,−1,0,−1,0,−1,0,−1,0,1,0,1,0,−1,0,1,0,−1,0,1,0,1,0,1,0,1,0,1,0,1,0,−1,0,1,0,−1,0,1,0,1,0,−1,0,1,0,−1,0,−1,0,−1,0,−1,0,1,0,1,0,−1,0,1,0,1,0,−1,0,1,0,1,0,1,0,1,0,−1,0,1,0,1,0,−1,0,1,0,1,0,−1,0,1,0,−1,0,1,0,1,0,1,0,1,0,1,0,−1,0,1,0,1,0,1,0,1,0,−1,0,1,0,1,0,1,0,1,0,−1,0,1,0,1,0,1,0,−1,0,1,0,−1,0,−1,0,1,0,1,0,1,0,1,0,−1,0,−1,0,−1,0,−1,0,1,0,1,0,1,0,1,0,−1,0,−1,0,1,0,−1,0,0,0,0,0,0,0,1,0,−1,0,−1,0,−1,0,1,0,−1,0,1,0,1,0,−1,0,1,0,−1,0,1,0,1,0,1,0,1,0,−1,0,−1,0,−1,0,−1,0,1,0,1,0,−1,0,1,0,−1,0,−1,0,1,0,1,0,1,0,1,0,1,0,1,0,−1,0,1,0,1,0,1,0,1,0,1,0,1,0,−1,0,1,0,−1,0,−1,0,1,0,−1,0,1,0,1,0,−1,0,1,0,1,0,1,0,−1,0,1,0,1,0,1,0,1,0,1,0,1,0,1,0,−1,0,−1,0,1,0,−1,0,1,0,1,0,1,0,1,0,−1,0,1,0,1,0,−1,0,1,0,1,0,1,0,1,0,1,0,1,0,1,0,1,0,1,0,1,0,−1,0,−1,0,−1,0,−1,0,1,0,−1,0,1,0,1,0,−1,0,−1,0,−1,0,−1,0,1,0,1,0,1,0,1,0,−1,0,−1,0,−1,0,−1,0,1,0,1,0,−1,0,−1,0,−1,0,−1,0,1,0,−1,0,−1,0,1,0,1,0,−1,0,1,0,1,0,1,0,1,0,1,0,1,0,1,0,1,0,1,0,0,0,0,0,0,0,0,0,0,0}
For 40 MHz transmission, the N-TF sequence with the format of an HELTF2X40, optimized for estimation order P=9, is given by:
N-TF(HELTF2X40,P=9)=sqrt(512/242)·{0,0,0,0,0,0,0,0,0,0,0,0,1,0,−1,0,−1,0,−1,0,1,0,1,0,−1,0,−1,0,−1,0,1,0,1,0,1,0,1,0,1,0,1,0,−1,0,1,0,1,0,1,0,−1,0,1,0,−1,0,1,0,−1,0,1,0,1,0,1,0,1,0,−1,0,1,0,1,0,−1,0,−1,0,−1,0,1,0,1,0,1,0,−1,0,−1,0,−1,0,1,0,1,0,1,0,−1,0,1,0,1,0,1,0,−1,0,−1,0,1,0,1,0,−1,0,−1,0,−1,0,1,0,1,0,1,0,1,0,−1,0,1,0,1,0,1,0,1,0,−1,0,−1,0,1,0,1,0,1,0,−1,0,−1,0,1,0,1,0,1,0,1,0,1,0,1,0,1,0,1,0,1,0,1,0,1,0,−1,0,−1,0,1,0,−1,0,1,0,−1,0,1,0,−1,0,−1,0,1,0,1,0,1,0,−1,0,−1,0,1,0,1,0,−1,0,−1,0,−1,0,1,0,−1,0,1,0,1,0,1,0,1,0,−1,0,1,0,1,0,1,0,1,0,1,0,1,0,−1,0,−1,0,1,0,1,0,1,0,−1,0,−1,0,1,0,0,0,0,0,0,0,1,0,1,0,1,0,1,0,1,0,−1,0,−1,0,−1,0,−1,0,−1,0,1,0,1,0,1,0,1,0,−1,0,1,0,1,0,1,0,−1,0,−1,0,1,0,1,0,1,0,−1,0,−1,0,1,0,1,0,1,0,1,0,1,0,1,0,1,0,1,0,1,0,1,0,1,0,1,0,1,0,−1,0,−1,0,−1,0,1,0,1,0,−1,0,−1,0,1,0,1,0,1,0,−1,0,1,0,−1,0,1,0,1,0,−1,0,−1,0,−1,0,−1,0,1,0,1,0,1,0,−1,0,1,0,1,0,1,0,1,0,1,0,1,0,1,0,1,0,−1,0,−1,0,1,0,−1,0,−1,0,−1,0,−1,0,1,0,1,0,1,0, 1,0,−1,0, 1,0, 1,0, 1, 0,−1,0,−1,0,1,0,1,0,1,0,−1,0,−1,0,1,0,1,0,1,0,1,0,1,0,1,0,−1,0,1,0,−1,0,1,0,1,0,−1,0,1,0,−1,0,−1,0,−1,0,1,0,1,0,1,0,1,0,1,0,1,0,1,0,1,0,−1,0,1,0,1,0,−1,0,−1,0,1,0,0,0,0,0,0,0,0,0,0,0}
For 40 MHz transmission, the N-TF sequence with the format of an HELTF2X40, optimized for estimation order P=10, is given by:
N-TF(HELTF2X40,P=10)=sqrt(512/242)·{0,0,0,0,0,0,0,0,0,0,0,0,1,0,−1,0,1,0,−1,0,1,0,1,0,1,0,1,0,1,0,−1,0,−1,0,1,0,1,0,−1,0,−1,0,1,0,1,0,−1,0,1,0,−1,0,1,0,−1,0,1,0,−1,0,−1,0,−1,0,−1,0,−1,0,1,0,1,0,1,0,−1,0,1,0,1,0,−1,0,−1,0,1,0,−1,0,−1,0,1,0,1,0,1,0,−1,0,1,0,−1,0,1,0,1,0,−1,0,1,0,−1,0,1,0,1,0,1,0,1,0,1,0,1,0,−1,0,1,0,1,0,−1,0,−1,0,1,0,−1,0,−1,0,1,0,−1,0,1,0,−1,0,1,0,1,0,−1,0,−1,0,−1,0,1,0,−1,0,−1,0,1,0,1,0,1,0,−1,0,1,0,−1,0,1,0,−1,0,1,0,−1,0,1,0,1,0,−1,0,1,0,1,0,1,0,1,0,−1,0,1,0,−1,0,−1,0,−1,0,1,0,−1,0,−1,0,1,0,1,0,−1,0,−1,0,1,0,−1,0,1,0,−1,0,−1,0,−1,0,−1,0,1,0,−1,0,1,0,1,0,1,0,−1,0,−1,0,1,0,1,0,0,0,0,0,0,0,−1,0,−1,0,1,0,1,0,1,0,−1,0,1,0,−1,0,1,0,−1,0,−1,0,1,0,−1,0,−1,0,1,0,−1,0,1,0,1,0,1,0,−1,0,1,0,−1,0,−1,0,−1,0,1,0,−1,0,1,0,1,0,1,0,1,0,−1,0,1,0,1,0,−1,0,−1,0,−1,0,1,0,−1,0,1,0,1,0,1,0,−1,0,1,0,−1,0,−1,0,1,0,−1,0,−1,0,−1,0,1,0,1,0,−1,0,1,0,−1,0,1,0,−1,0,1,0,1,0,−1,0,−1,0,1,0,−1,0,−1,0,1,0,1,0,1,0,1,0,−1,0,1,0,−1,0,1,0,−1,0,1,0,−1,0,−1,0,1,0,−1,0,1,0,1,0,−1,0,−1,0,−1,0,1,0,−1,0,−1,0,−1,0,1,0,−1,0,1,0,1,0,1,0,−1,0,−1,0,1,0,−1,0,−1,0,1,0,−1,0,1,0,−1,0,1,0,−1,0,−1,0,1,0,1,0,−1,0,1,0,−1,0,−1,0,−1,0,1,0,1,0,−1,0,−1,0,1,0,−1,0,1,0,−1,0,1,0,−1,0,−1,0,0,0,0,0,0,0,0,0,0,0}
List16
For 40 MHz transmission, the N-TF sequence with the format of an HELTF40, optimized for estimation order P=3, is given by:
N-TF(HELTF40,P=3)=sqrt(512/484)·{0,0,0,0,0,0,0,0,0,0,0,0,1,1,1,−1,1,−1,−1,1,−1,1,−1,1,−1,1,1,−1,1,1,−1,1,1,1,1,1,−1,1,1,−1,−1,−1,1,1,−1,1,1,−1,1,1,−1,1,−1,−1,1,1,−1,1,1,1,1,−1,1,−1,−1,1,1,−1,1,1,−1,−1,1,−1,1,−1,−1,1,−1,−1,1,1,−1,−1,1,−1,1,−1,−1,−1,1,−1,1,−1,1,1,1,1,−1,1,−1,−1,−1,1,−1,1,−1,1,1,1,1,1,1,1,−1,1,1,1,1,1,1,−1,−1,−1,1,−1,1,−1,−1,1,−1,1,1,−1,1,−1,−1,1,−1,−1,1,−1,1,1,−1,−1,1,−1,1,−1,1,1,−1,1,1,−1,−1,1,−1,−1,−1,1,−1,1,−1,−1,1,−1,−1,1,−1,−1,1,−1,1,−1,1,1,1,−1,1,1,−1,1,−1,1,−1,1,−1,1,−1,1,−1,−1,1,−1,−1,−1,1,−1,1,−1,1,1,−1,−1,1,1,1,−1,−1,−1,1,1,−1,1,−1,1,−1,−1,−1,−1,1,1,−1,1,1,−1,1,−1,−1,1,1,1,−1,1,−1,1,−1,−1,−1,−1,−1,1,−1,1,1,1,1,1,1,−1,1,−1,0,0,0,0,0,1,1,−1,−1,1,1,−1,1,−1,−1,1,−1,1,1,−1,1,−1,−1,−1,1,−1,1,−1,1,−1,1,−1,1,−1,−1,−1,−1,−1,−1,1,−1,1,1,1,−1,1,−1,1,−1,1,−1,1,−1,1,−1,1,1,−1,−1,−1,1,1,1,1,1,1,−1,1,−1,−1,−1,−1,−1,−1,−1,1,−1,1,−1,−1,1,−1,1,−1,1,−1,−1,−1,−1,1,1,1,1,1,−1,1,−1,1,1,−1,1,1,−1,1,1,−1,−1,1,1,−1,1,−1,−1,1,−1,1,1,−1,1,1,−1,1,−1,−1,−1,1,−1,1,1,−1,1,−1,1,1,−1,1,1,−1,1,−1,1,1,−1,1,−1,−1,1,−1,−1,−1,−1,1,1,−1,1,1,−1,−1,−1,−1,−1,1,−1,1,1,−1,−1,1,−1,1,1,−1,−1,−1,−1,1,−1,1,1,1,−1,1,−1,−1,−1,−1,1,1,−1,1,−1,−1,−1,−1,−1,−1,−1,−1,1,1,−1,1,1,−1,1,1,1,1,1,1,1,−1,−1,−1,−1,1,1,1,−1,1,−1,1,−1,−1,−1,−1,1,1,−1,1,−1,−1,−1,1,1,−1,−1,1,−1,0,0,0,0,0,0,0,0,0,0,0}
For 40 MHz transmission, the N-TF sequence with the format of an HELTF40, optimized for estimation order P=4, is given by:
N-TF(HELTF40,P=4)=sqrt(512/484)·{0,0,0,0,0,0,0,0,0,0,0,0,1,1,1,−1,1,1,1,1,−1,−1,−1,1,−1,−1,1,1,1,1,−1,1,1,1,1,−1,1,1,1,−1,1,−1,1,−1,−1,1,−1,1,−1,−1,−1,1,1,−1,−1,−1,1,−1,−1,1,1,1,1,1,1,−1,−1,1,−1,−1,1,1,1,−1,−1,−1,−1,1,−1,−1,1,1,1,1,−1,−1,1,−1,−1,−1,1,−1,1,1,−1,−1,−1,−1,−1,−1,1,1,−1,−1,−1,−1,1,−1,1,−1,1,−1,−1,1,1,1,−1,−1,−1,1,−1,1,−1,−1,1,−1,1,1,−1,−1,1,−1,−1,−1,1,−1,1,−1,−1,1,1,−1,−1,−1,1,1,−1,−1,−1,1,1,1,−1,−1,1,1,1,−1,1,1,1,−1,−1,1,1,1,−1,1,−1,1,1,−1,−1,1,1,1,1,1,1,−1,−1,1,1,1,1,1,1,−1,−1,1,1,1,−1,1,1,1,1,1,1,1,1,−1,1,1,1,1,−1,1,1,1,−1,1,−1,1,1,−1,1,1,−1,1,−1,−1,1,1,1,1,1,−1,−1,−1,1,−1,1,1,1,1,−1,1,1,1,−1,1,1,−1,1,−1,−1,1,−1,−1,1,−1,1,1,0,0,0,0,0,1,−1,1,−1,1,1,−1,−1,1,1,−1,−1,1,−1,−1,−1,−1,1,−1,−1,−1,1,−1,1,1,−1,−1,1,−1,−1,−1,−1,−1,−1,−1,1,−1,1,−1,−1,−1,−1,1,1,−1,1,1,1,1,1,−1,−1,1,−1,1,−1,1,1,1,−1,1,1,−1,−1,−1,1,−1,1,1,−1,1,1,1,−1,−1,−1,1,1,−1,1,1,−1,−1,−1,−1,1,1,1,−1,1,1,1,1,−1,−1,−1,1,−1,1,1,1,1,1,1,1,1,1,1,1,1,−1,−1,−1,1,−1,1,−1,1,1,1,1,−1,1,−1,1,1,−1,1,−1,1,1,−1,1,−1,1,1,1,1,1,1,1,−1,1,1,−1,1,1,1,1,−1,−1,−1,−1,1,1,1,−1,1,1,−1,−1,−1,−1,−1,−1,−1,−1,1,1,−1,−1,−1,1,−1,−1,−1,−1,−1,1,−1,1,−1,−1,−1,−1,1,−1,−1,−1,−1,−1,−1,1,−1,−1,−1,−1,−1,−1,−1,−1,1,1,−1,−1,−1,−1,−1,1,−1,−1,−1,−1,−1,−1,−1,−1,1,−1,−1,1,1,1,1,−1,−1,−1,−1,−1,−1,1,−1,1,−1,1,1,−1,1,−1,−1,−1,−1,0,0,0,0,0,0,0,0,0,0,0}
For 40 MHz transmission, the N-TF sequence with the format of an HELTF40, optimized for estimation order P=5, is given by:
N-TF(HELTF40,P=5)=sqrt(512/484)·{0,0,0,0,0,0,0,0,0,0,0,0,1,−1,−1,−1,−1,1,1,−1,1,1,1,−1,−1,1,1,−1,1,1,−1,−1,−1,1,1,−1,1,1,1,1,−1,−1,−1,−1,1,−1,−1,−1,−1,1,−1,−1,−1,−1,−1,−1,−1,−1,−1,−1,−1,1,−1,−1,1,1,−1,1,−1,−1,1,−1,1,−1,−1,1,1,1,−1,1,−1,−1,−1,−1,1,−1,−1,1,−1,−1,−1,−1,1,−1,−1,−1,−1,−1,1,1,−1,−1,−1,−1,−1,1,−1,1,−1,−1,1,1,1,−1,−1,1,1,−1,−1,1,1,1,−1,−1,1,−1,−1,1,−1,1,−1,−1,1,−1,1,1,−1,1,1,1,−1,−1,−1,1,−1,−1,−1,1,−1,1,−1,−1,−1,−1,−1,−1,−1,−1,1,−1,−1,−1,−1,−1,1,1,−1,−1,−1,1,−1,1,−1,−1,1,−1,−1,−1,−1,−1,−1,−1,−1,1,−1,−1,1,1,−1,1,1,−1,1,1,1,−1,−1,1,−1,−1,1,1,1,−1,−1,−1,−1,−1,−1,1,1,−1,−1,1,1,−1,−1,−1,−1,1,1,1,1,−1,1,1,1,−1,1,−1,1,1,1,1,−1,1,1,1,−1,−1,1,−1,−1,−1,−1,−1,−1,−1,−1,−1,−1,−1,1,−1,0,0,0,0,0,1,−1,−1,1,1,−1,−1,−1,1,−1,−1,1,−1,1,1,−1,−1,1,−1,−1,−1,−1,−1,−1,1,−1,1,1,1,−1,−1,−1,−1,1,−1,−1,1,−1,−1,−1,1,−1,−1,−1,1,1,−1,1,1,−1,1,1,−1,1,1,−1,1,1,−1,1,1,1,−1,1,−1,1,1,−1,1,−1,1,−1,1,−1,1,1,1,−1,−1,1,1,−1,−1,1,−1,1,−1,1,−1,−1,1,−1,1,−1,1,1,−1,−1,−1,1,−1,−1,−1,−1,−1,−1,−1,1,−1,−1,−1,−1,−1,−1,1,−1,−1,−1,1,−1,1,−1,−1,−1,−1,1,−1,1,−1,−1,1,−1,1,1,−1,1,−1,−1,1,−1,−1,−1,1,−1,−1,1,−1,−1,−1,−1,1,−1,−1,−1,−1,−1,1,1,−1,1,−1,1,1,−1,1,1,1,1,1,1,1,1,1,1,−1,−1,−1,1,−1,−1,1,−1,−1,−1,−1,−1,−1,−1,−1,1,−1,−1,−1,1,−1,1,1,−1,1,1,1,−1,−1,−1,1,−1,−1,−1,1,−1,−1,−1,−1,−1,−1,−1,1,1,1,1,1,−1,−1,−1,−1,−1,1,−1,−1,−1,−1,1,−1,−1,−1,1,1,−1,1,1,−1,1,0,0,0,0,0,0,0,0,0,0,0}
For 40 MHz transmission, the N-TF sequence with the format of an HELTF40, optimized for estimation order P=6, is given by:
N-TF(HELTF40,P=6)=sqrt(512/484)·{0,0,0,0,0,0,0,0,0,0,0,0,−1,−1,−1,1,−1,1,−1,1,−1,1,−1,1,1,−1,−1,−1,1,1,−1,−1,−1,1,1,1,−1,−1,−1,−1,1,−1,−1,−1,−1,−1,1,−1,−1,1,−1,−1,−1,1,1,1,−1,−1,−1,1,−1,−1,−1,−1,1,1,1,−1,−1,1,−1,1,1,−1,1,−1,−1,−1,−1,1, 1, 1,−1,−1,1,1,1,1,−1,−1,−1,−1,−1,−1,−1,−1,−1,−1,1,−1,1,1,1,1,−1,1,−1,−1,1,−1,−1,1,1,−1,1,−1,−1,1,−1,1,1,−1,1,−1,−1,−1,−1,−1,−1,−1,1,−1,1,1,−1,−1,1,−1,1,1,−1,−1,−1,−1,−1,−1,−1,−1,1,−1,−1,1,−1,−1,−1,1,−1,1,−1,−1,1,−1,−1,−1,−1,1,−1,−1,1,1,1,1,−1,−1,−1,1,1,−1,−1,1,−1,1,1,−1,−1,1,−1,1,1,−1,−1,−1,−1,1,1,1,1,1,−1,−1,1,1,−1,−1,1,−1,1,1,−1,−1,1,−1,−1,−1,1,−1,1,−1,−1,−1,−1,−1,−1,−1,−1,1,−1,−1,1,−1,−1,1,1,−1,−1,1,−1,−1,−1,−1,−1,1,1,−1,−1,−1,1,1,−1,1,1,1,1,−1,0,0,0,0,0,1,−1,−1,−1,−1,1,1,−1,1,1,−1,−1,1,1,−1,−1,−1,−1,1,1,−1,−1,−1,−1,−1,1,−1,1,1,−1,1,−1,−1,−1,−1,−1,−1,1,1,1,1,−1,−1,−1,−1,−1,1,−1,−1,−1,−1,−1,−1,−1,−1,1,1,−1,−1,−1,−1,−1,−1,1,1,1,1,−1,−1,1,−1,1,1,−1,−1,−1,−1,1,−1,−1,1,1,−1,1,1,−1,−1,1,−1,−1,1,−1,−1,1,1,1,1,−1,−1,1,−1,1,1,1,−1,1,1,−1,−1,1,−1,1,1,−1,−1,1,−1,−1,−1,1,1,1,1,1,−1,−1,1,−1,−1,−1,1,−1,−1,−1,−1,−1,1,−1,−1,−1,1,−1,1,−1,−1,−1,−1,1,1,−1,−1,−1,1,−1,1,1,−1,−1,1,−1,1,1,−1,−1,−1,−1,−1,−1,−1,1,−1,−1,−1,1,1,−1,−1,1,1,1,1,−1,1,−1,1,1,−1,−1,1,1,1,1,−1,−1,1,1,−1,−1,1,−1,1,−1,−1,1,1,1,−1,−1,−1,−1,−1,1,1,−1,−1,−1,1,−1,−1,−1,−1,−1,1,−1,−1,1,−1,−1,−1,1,−1,−1,−1,−1,−1,−1,1,1,1,−1,−1,1,0,0,0,0,0,0,0,0,0,0,0}
For 40 MHz transmission, the N-TF sequence with the format of an HELTF40, optimized for estimation order P=7, is given by:
N-TF(HELTF40,P=7)=sqrt(512/484)·{0,0,0,0,0,0,0,0,0,0,0,0,1,−1,1,1,1,−1,1,−1,1,1,−1,−1,−1,−1,−1,−1,−1,1,1,−1,1,1,−1,1,−1,1,1,−1,−1,1, 1, 1,−1,1,1,1,1,−1,1,−1,−1,1,−1,1,−1,−1,−1,−1,−1,1,−1,1,−1,−1,−1,1,−1,−1,1,1,1,1,1,−1,1,1,1,−1,−1,−1,−1,1,1,−1,1,−1,−1,1,1,−1,1,−1,1,−1,−1,−1,−1,1,1,−1,1,1,−1,−1,−1,1,1,−1,−1,1,1,−1,1,1,1,−1,−1,−1,−1,−1,−1,−1,1,−1,−1,−1,1,−1,1,−1,1,−1,1,−1,−1,−1,1,−1,1,1,−1,−1,1,−1,1,−1,−1,−1,−1,−1,1,−1,−1,−1,1,−1,−1,1,−1,−1,1,−1,1,−1,1,−1,−1,1,1,−1,1,−1,1,−1,1,−1,−1,1,−1,1,−1,−1,1,−1,−1,1,−1,−1,1,−1,1,1,−1,−1,1,1,−1,−1,1,−1,−1,−1,−1,1,−1,1,−1,1,−1,1,−1,−1,−1,−1,−1,−1,−1,−1,−1,−1,1,−1,1,−1,−1,−1,−1,−1,−1,1,−1,−1,−1,−1,−1,1,−1,1,1,−1,1,−1,−1,−1,−1,−1,−1,−1,−1,1,−1,1,0,0,0,0,0,−1,−1,−1,1,1,1,1,1,1,−1,−1,1,1,1,1,−1,−1,−1,−1,1,−1,1,−1,1,−1,1,−1,1,−1,1,−1,−1,−1,1,−1,1,−1,1,1,1,−1,1,−1,1,−1,1,1,−1,−1,−1,−1,1,−1,−1,−1,−1,−1,1,1,−1,−1,1,−1,−1,1,1,−1,−1,−1,−1,1,1,−1,1,1,1,−1,1,−1,1,−1,1,−1,1,−1,−1,−1,−1,−1,−1,1,−1,−1,1,−1,1,1,1,1,1,−1,1,−1,−1,1,1,1,−1,−1,−1,1,−1,−1,−1,−1,1,−1,−1,−1,−1,−1,1,−1,−1,−1,−1,1,−1,1,−1,1,−1,1,−1,1,−1,−1,−1,−1,−1,−1,−1,1,−1,−1,−1,−1,1,−1,−1,−1,1,−1,−1,−1,−1,−1,1,−1,1,−1,−1,1,1,−1,−1,−1,1,1,−1,−1,1,1,1,−1,1,−1,1,−1,1,−1,−1,−1,−1,−1,1,−1,1,1,1,−1,1,−1,1,1,−1,1,1,1,−1,−1,1,−1,1,−1,−1,−1,1,−1,1,−1,−1,−1,−1,−1,1,−1,−1,−1,−1,1,1,−1,1,−1,−1,−1,−1,−1,1,−1,1,−1,1,−1,1,−1,1,−1,−1,−1,1,0,0,0,0,0,0,0,0,0,0,0}
For 40 MHz transmission, the N-TF sequence with the format of an HELTF40, optimized for estimation order P=8, is given by:
N-TF(HELTF40,P=8)=sqrt(512/484)·{0,0,0,0,0,0,0,0,0,0,0,0,1,−1,−1,−1,−1,1,1,−1,−1,1,−1,−1,−1,−1,1,−1,−1,1,−1,1,1,−1,1,−1,1,1,−1,1, 1, 1, 1,−1,−1,1,1,−1,−1,1,1,−1,−1,−1,1,−1,−1,−1,1,1,−1,−1,−1,1,1,−1,−1,1,−1,−1,−1,1,1,1,−1,1,−1,1,1,−1,1,1,1,1,−1,1,1,−1,−1,1,−1,1,1,−1,1,1,−1,−1,−1,1,−1,−1,1,1,−1,1,−1,−1,−1,−1,−1,1,−1,1,1,1,1,−1,1,−1,1,1,1,1,1,−1,−1,1,−1,1,1,−1,1,1,−1,1,−1,1,−1,−1,1,1,−1,1,−1,1,−1,−1,1,1,1,1,1,−1,1,−1,1,−1,1,−1,−1,1,1,−1,−1,−1,1,−1,−1,1,−1,−1,−1,−1,−1,1,−1,−1,−1,1,−1,−1,−1,1,1,1,1,−1,−1,−1,1,−1,−1,1,1,−1,−1,−1,1,−1,−1,1,1,−1,1,1,−1,1,−1,−1,−1,1,1,−1,−1,1,−1,1,−1,−1,1,1,−1,1,−1,1,1,−1,1,1,−1,−1,1,1,1,−1,1,−1,1,1,1,−1,1,−1,−1,1,−1,−1,−1,1,1,1,−1,1,0,0,0,0,0,1,1,1,1,−1,1,−1,1,−1,1,−1,1,−1,1,−1,1,−1,−1,−1,1,−1,−1,1,−1,1,−1,−1,−1,1,1,1,1,−1,1,1,1,−1,1,1,−1,−1,1,1,1,−1,−1,−1,1,−1,−1,−1,1,−1,−1,−1,−1,1,1,−1,−1,1,−1,−1,−1,1,1,−1,−1,1,−1,1,−1,1,1,1,−1,1,1,−1,1,1,1,1,−1,−1,1,−1,1,−1,1,−1,1,1,−1,−1,1,1,−1,1,−1,1,1,1,−1,1,−1,1,−1,−1,−1,1,1,1,1,1,1,−1,1,−1,1,1,1,−1,1,−1,1,−1,1,−1,−1,−1,1,−1,−1,1,−1,−1,−1,−1,−1,1,1,−1,−1,1,−1,−1,−1,−1,1,1,−1,−1,1,−1,1,−1,−1,1,1,−1,1,−1,1,−1,−1,−1,1,1,1,−1,−1,1,1,−1,1,1,1,−1,−1,1,−1,−1,1,−1,−1,1,1,−1,−1,1,1,−1,−1,1,−1,1,1,−1,1,−1,1,−1,−1,−1,1,−1,1,1,−1,1,−1,−1,−1,1,−1,1,−1,1,−1,−1,−1,1,−1,−1,−1,1,1,−1,1,1,−1,−1,−1,−1,1,1,1,−1,1,1,−1,0,0,0,0,0,0,0,0,0,0,0}
For 40 MHz transmission, the N-TF sequence with the format of an HELTF40, optimized for estimation order P=9, is given by:
N-TF(HELTF40,P=9)=sqrt(512/484)·{0,0,0,0,0,0,0,0,0,0,0,0,−1,−1,−1,−1,−1,1,1,1,1,1,1,−1,1,−1,−1,1,−1,1,1,1,−1,−1,1,−1,−1,−1,1,1,1, 1, 1,−1,1,−1,−1,1,1,−1,1,1,−1,1,−1,−1,1,1,1,1,1,1,1,−1,−1,−1,−1,1,1,1,1,1,−1,−1,−1,1,1,−1,1,−1,1,1,−1,1,−1,1,1,−1,1,−1,1,1,−1,−1,−1,1,−1,−1,1,1,1,1,−1,−1,1,1,1,1,1,−1,1,1,1,−1,1,−1,1,1,1,−1,−1,1,1,−1,1,1,1,1,−1,−1,1,1,1,1,1,1,1,−1,1,1,−1,−1,1,−1,1,1,−1,1,1,1,−1,−1,1,−1,1,1,1,−1,1,1,1,1,−1,−1,1,1,1,−1,−1,1,−1,1,−1,−1,1,1,1,−1,1,1,−1,1,1,−1,1,1,−1,−1,1,1,1,1,−1,1,1,1,1,1,−1,1,−1,1,1,−1,1,1,−1,−1,1,−1,1,1,1,1,−1,1,1,−1,1,1,1,1,1,−1,1,1,−1,1,1,1,1,1,1,−1,1,1,−1,1,1,1,1,1,1,−1,1,1,−1,−1,1,−1,1,1,1,1,0,0,0,0,0,1,1,1,1,−1,−1,1,−1,1,1,1,1,1,1,−1,−1,−1,−1,−1,1,1,1,1,1,−1,−1,−1,1,1,1,1,−1,1,1,1,−1,1,1,−1,1,1,−1,1,1,1,1,1,1,−1,1,−1,1,1,1,−1,−1,−1,1,−1,1,1,1,1,1,−1,−1,1,1,−1,1,1,1,1,−1,1,−1,−1,1,1,−1,1,1,−1,1,−1,−1,1,1,−1,1,−1,−1,−1,−1,−1,−1,−1,−1,1,1,1,1,−1,1,−1,1,−1,1,1,1,1,1,1,1,1,−1,1,1,1,1,1,−1,1,1,−1,−1,1,−1,1,1,1,1,−1,−1,−1,1,1,−1,1,−1,1,−1,−1,1,−1,−1,1,1,1,1,1,−1,−1,1,−1,1,−1,1,−1,−1,−1,−1,−1,1,−1,1,1,1,−1,−1,−1,−1,1,−1,1,−1,1,−1,−1,−1,−1,−1,−1,1,1,1,1,1,−1,−1,−1,1,−1,1,1,−1,−1,1,−1,1,−1,1,−1,1,1,−1,1,1,1,−1,−1,−1,−1,1,1,−1,1,−1,1,−1,1,1,−1,1,−1,−1,1,−1,−1,1,−1,1,−1,1,−1,1,−1,1,1,−1,1,1,0,0,0,0,0,0,0,0,0,0,0}
For 40 MHz transmission, the N-TF sequence with the format of an HELTF40, optimized for estimation order P=10, is given by:
N-TF(HELTF40,P=10)=sqrt(512/484)·{0,0,0,0,0,0,0,0,0,0,0,0,1,−1,1,−1,1,−1,−1,−1,1,1,1,−1,1,1,−1,1,−1,1,−1,1,−1,1,−1,−1,1,1,1,−1,1,−1,1,1,1,1,−1,−1,1,−1,1,−1,1,1,1,1,−1,1,−1,1,1,1,−1,1,−1,−1,1,−1,−1,1,1,1,1,−1,1,−1,1,−1,1,−1,−1,−1,1,1,−1,1,−1,1,−1,1,−1,1,−1,1,1,1,−1,−1,−1,−1,1,−1,1,−1,1,−1,1,−1,−1,1,−1,−1,−1,−1,−1,1,1,1,1,1,−1,1,−1,−1,1,−1,1,−1,1,−1,1,−1,1,1,1,−1,1,−1,−1,1,1,−1,−1,1,−1,1,−1,1,1,1,1,1,−1,−1,1,1,−1,−1,1,−1,1,1,1,1,1,1,1,1,−1,1,−1,1,1,−1,−1,−1,−1,1,1,1,−1,1,1,−1,1,−1,−1,−1,1,−1,−1,−1,−1,−1,1,−1,1,1,−1,1,1,−1,1,−1,−1,1,1,1,−1,1,1,1,1,1,−1,1,−1,−1,−1,−1,−1,1,−1,1,−1,1,1,1,1,1,−1,−1,−1,−1,−1,1,−1,−1,−1,1,−1,−1,1,1,−1,1,−1,−1,−1,−1,1,1,−1,−1,0,0,0,0,0,−1,1,−1,1,−1,−1,−1,1,1,1,1,1,1,−1,1,−1,1,1,−1,−1,−1,1,−1,1,−1,−1,1,−1,1,1,−1,1,1,1,1,1,1,−1,1,−1,1,1,1,−1,1,−1,1,1,−1,−1,−1,−1,−1,−1,−1,−1,1,1,1,1,−1,1,1,1,1,1,−1,1,−1,1,−1,1,−1,−1,1,1,−1,−1,−1,−1,1,−1,1,−1,−1,−1,1,1,−1,1,1,−1,1,−1,−1,1,−1,−1,−1,−1,−1,−1,1,−1,1,−1,1,−1,1,−1,1,−1,−1,−1,−1,−1,−1,−1,−1,1,1,−1,1,1,−1,1,1,1,−1,−1,−1,1,−1,−1,−1,1,1,−1,1,−1,1,1,1,1,−1,−1,−1,1,−1,1,1,1,1,1,−1,1,1,−1,−1,−1,1,−1,1,−1,1,−1,1,−1,1,−1,1,−1,1,1,1,1,−1,−1,−1,1,−1,1,−1,1,−1,1,1,−1,−1,−1,1,−1,−1,−1,−1,−1,1,1,1,−1,−1,1,1,−1,−1,−1,−1,1,−1,1,−1,1,−1,1,1,1,1,−1,1,1,1,−1,−1,−1,−1,−1,1,−1,1,1,1,1,1,−1,1,1,−1,1,−1,1,−1,1,0,0,0,0,0,0,0,0,0,0,0}
List17
For 80 MHz transmission, the N-TF sequence with the format of an HESTF80, optimized for estimation order P=3, is given by:
N-TF(HESTF80,P=3)=sqrt(1024/62)·{0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0}
For 80 MHz transmission, the N-TF sequence with the format of an HESTF80, optimized for estimation order P=4, is given by:
N-TF(HESTF80,P=4)=sqrt(1024/62)·{0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0}
For 80 MHz transmission, the N-TF sequence with the format of an HESTF80, optimized for estimation order P=5, is given by:
N-TF(HESTF80,P=5)=sqrt(1024/62)·{0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0}
For 80 MHz transmission, the N-TF sequence with the format of an HESTF80, optimized for estimation order P=6, is given by:
N-TF(HESTF80,P=6)=sqrt(1024/62)·{0,0,0,0,−1,0,0,0,1,0,0,0,−1,0,0,0,−1,0,0,0,1,0,0,0,−1,0,0,0,1,0,0,0,−1,0,0,0,−1,0,0,0,1,0,0,0,−1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,−1,0,0,0,−1,0,0,0,1,0,0,0,−1,0,0,0,1,0,0,0,1,0,0,0,−1,0,0,0,1,0,0,0,−1,0,0,0,1,0,0,0,1,0,0,0,−1,0,0,0,1,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1}
For 80 MHz transmission, the N-TF sequence with the format of an HESTF80, optimized for estimation order P=7, is given by:
N-TF(HESTF80,P=7)=sqrt(1024/62)·{0,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1}
For 80 MHz transmission, the N-TF sequence with the format of an HESTF80, optimized for estimation order P=8, is given by:
N-TF(HESTF80,P=8)=sqrt(1024/62)·{0,0,0,0,−1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,−1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,1,0,0,0,−1,0,0,0,−1,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1}
For 80 MHz transmission, the N-TF sequence with the format of an HESTF80, optimized for estimation order P=9, is given by:
N-TF(HESTF80,P=9)=sqrt(1024/62)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0}
For 80 MHz transmission, the N-TF sequence with the format of an HESTF80, optimized for estimation order P=10, is given by:
N-TF(HESTF80,P=10)=sqrt(1024/62)·{0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0, 0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0}
List18
For 80 MHz transmission, the N-TF sequence with the format of an HELTF1X80, optimized for estimation order P=3, is given by:
N-TF(HELTF1X80,P=3)=sqrt(1024/250)·{0,0,0,0,0,0,0,0,0,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,−1,0,0,0,−1,0,0,0,1,0,0,0,1,0,0,0,1,0,0,0,−1,0,0,0,1,0,0,0,1,0,0,0,−1,0,0,0,−1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,−1,0,0,0,−1,0,0,0,1,0,0,0,1,0,0,0,1,0,0,0,1,0,0,0,−1,0,0,0,1,0,0,0,−1,0,0,0,−1,0,0,0,1,0,0,0,−1,0,0,0,−1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,1,0,0,0,−1,0,0,0,−1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,0,0,0,0,1,0,0,0,1,0,0,0,−1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,1,0,0,0,1,0,0,0,−1,0,0,0,−1,0,0,0,1,0,0,0,−1,0,0,0,−1,0,0,0,−1,0,0,0,1,0,0,0,−1,0,0,0,1,0,0,0,1,0,0,0,−1,0,0,0,−1,0,0,0,−1,0,0,0,1,0,0,0,1,0,0,0,1,0,0,0,−1,0,0,0,1,0,0,0,1,0,0,0,−1,0,0,0,−1,0,0,0,−1,0,0,0,−1,0,0,0,−1,0,0,0,−1,0,0,0,1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,1,0,0,0,1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,1,0,0,0,−1,0,0,0,1,0,0,0,1,0,0,0,−1,0,0,0,−1,0,0,0,1,0,0,0,−1,0,0,0,1,0,0,0,−1,0,0,0,1,0,0,0,−1,0,0,0,−1,0,0,0,−1,0,0,0,1,0,0,0,1,0,0,0,1,0,0,0,−1,0,0,0,1,0,0,0,1,0,0,0,1,0,0,0,1,0,0,0,−1,0,0,0,−1,0,0,0,1,0,0,0,1,0,0,0,−1,0,0,0,−1,0,0,0,1,0,0,0,1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,1,0,0,0,1,0,0,0,−1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,0,0,0,0,0,0,0,0}
For 80 MHz transmission, the N-TF sequence with the format of an HELTF1X80, optimized for estimation order P=4, is given by:
N-TF(HELTF1X80,P=4)=sqrt(1024/250)·{0,0,0,0,0,0,0,0,0,0,0,0,−1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,−1,0,0,0,1,0,0,0,−1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,1,0,0,0,−1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,1,0,0,0,−1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,−1,0,0,0,1,0,0,0,1,0,0,0,−1,0,0,0,1,0,0,0,−1,0,0,0,−1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,1,0,0,0,1,0,0,0,−1,0,0,0,1,0,0,0,0,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,1,0,0,0,−1,0,0,0,1,0,0,0,1,0,0,0,−1,0,0,0,−1,0,0,0,1,0,0,0,1,0,0,0,−1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,1,0,0,0,1,0,0,0,−1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,−1,0,0,0,−1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,1,0,0,0,1,0,0,0,1,0,0,0,0,0,0,0,0,0,0,0}
For 80 MHz transmission, the N-TF sequence with the format of an HELTF1X80, optimized for estimation order P=5, is given by:
N-TF(HELTF1X80,P=5)=sqrt(1024/250)·{0,0,0,0,0,0,0,0,0,0,0,0,1,0,0,0,−1,0,0,0,1,0,0,0,−1,0,0,0,−1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,−1,0,0,0,1,0,0,0,−1,0,0,0,−1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,1,0,0,0,−1,0,0,0,−1,0,0,0,−1,0,0,0,−1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,1,0,0,0,−1,0,0,0,−1,0,0,0,−1,0,0,0,−1,0,0,0,1,0,0,0,1,0,0,0,−1,0,0,0,−1,0,0,0,1,0,0,0,−1,0,0,0,−1,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,1,0,0,0,1,0,0,0,−1,0,0,0,1,0,0,0,1,0,0,0,1,0,0,0,1,0,0,0,−1,0,0,0,−1,0,0,0,−1,0,0,0,−1,0,0,0,−1,0,0,0,−1,0,0,0,1,0,0,0,−1,0,0,0,1,0,0,0,−1,0,0,0,−1,0,0,0,−1,0,0,0,−1,0,0,0,−1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,1,0,0,0,−1,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,1,0,0,0,−1,0,0,0,−1,0,0,0,−1,0,0,0,−1,0,0,0,−1,0,0,0,−1,0,0,0,0,0,0,0,−1,0,0,0,1,0,0,0,−1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,1,0,0,0,1,0,0,0,1,0,0,0,−1,0,0,0,1,0,0,0,1,0,0,0,−1,0,0,0,1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,1,0,0,0,−1,0,0,0,−1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,−1,0,0,0,1,0,0,0,−1,0,0,0,1,0,0,0,−1,0,0,0,−1,0,0,0,−1,0,0,0,−1,0,0,0,−1,0,0,0,1,0,0,0,−1,0,0,0,1,0,0,0,1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,−1,0,0,0,1,0,0,0,1,0,0,0,1,0,0,0,1,0,0,0,1,0,0,0,0,0,0,0,0,0,0,0}
For 80 MHz transmission, the N-TF sequence with the format of an HELTF1X80, optimized for estimation order P=6, is given by:
N-TF(HELTF1X80,P=6)=sqrt(1024/250)·{0,0,0,0,0,0,0,0,0,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,1,0,0,0,−1,0,0,0,1,0,0,0,1,0,0,0,1,0,0,0,−1,0,0,0,1,0,0,0,−1,0,0,0,−1,0,0,0,1,0,0,0,1,0,0,0,1,0,0,0,−1,0,0,0,1,0,0,0,1,0,0,0,−1,0,0,0,−1,0,0,0,1,0,0,0,1,0,0,0,−1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,−1,0,0,0,−1,0,0,0,−1,0,0,0,1,0,0,0,−1,0,0,0,−1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,−1,0,0,0,1,0,0,0,1,0,0,0,1,0,0,0,−1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,0,0,0,0,−1,0,0,0,−1,0,0,0,−1,0,0,0,−1,0,0,0,−1,0,0,0,1,0,0,0,1,0,0,0,−1,0,0,0,−1,0,0,0,1,0,0,0,1,0,0,0,1,0,0,0,1,0,0,0,−1,0,0,0,1,0,0,0,−1,0,0,0,−1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,1,0,0,0,−1,0,0,0,−1,0,0,0,1,0,0,0,1,0,0,0,−1,0,0,0,1,0,0,0,−1,0,0,0,−1,0,0,0,−1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,−1,0,0,0,1,0,0,0,−1,0,0,0,1,0,0,0,1,0,0,0,1,0,0,0,0,0,0,0,0,0,0,0}
For 80 MHz transmission, the N-TF sequence with the format of an HELTF1X80, optimized for estimation order P=7, is given by:
N-TF(HELTF1X80,P=7)=sqrt(1024/250)·{0,0,0,0,0,0,0,0,0,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,−1,0,0,0,−1,0,0,0,−1,0,0,0,1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,1,0,0,0,−1,0,0,0,−1,0,0,0,1,0,0,0,−1,0,0,0,1,0,0,0,−1,0,0,0,1,0,0,0,0,0,0,0,−1,0,0,0,1,0,0,0,−1,0,0,0,1,0,0,0,1,0,0,0,−1,0,0,0,−1,0,0,0,−1,0,0,0,1,0,0,0,1,0,0,0,−1,0,0,0,1,0,0,0,−1,0,0,0,1,0,0,0,1,0,0,0,−1,0,0,0,−1,0,0,0,1,0,0,0,−1,0,0,0,1,0,0,0,−1,0,0,0,−1,0,0,0,−1,0,0,0,1,0,0,0,1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,1,0,0,0,1,0,0,0,−1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,−1,0,0,0,1,0,0,0,−1,0,0,0,−1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,0,0,0,0,0,0,0,0}
For 80 MHz transmission, the N-TF sequence with the format of an HELTF1X80, optimized for estimation order P=8, is given by:
N-TF(HELTF1X80,P=8)=sqrt(1024/250)·{0,0,0,0,0,0,0,0,0,0,0,0,1,0,0,0,−1,0,0,0,1,0,0,0,−1,0,0,0,−1,0,0,0,−1,0,0,0,−1,0,0,0,−1,0,0,0,1,0,0,0,−1,0,0,0,−1,0,0,0,−1,0,0,0,−1,0,0,0,−1,0,0,0,−1,0,0,0,−1,0,0,0,1,0,0,0,−1,0,0,0,1,0,0,0,−1,0,0,0,−1,0,0,0,−1,0,0,0,−1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,1,0,0,0,1,0,0,0,−1,0,0,0,1,0,0,0,−1,0,0,0,−1,0,0,0,1,0,0,0,1,0,0,0,−1,0,0,0,−1,0,0,0,−1,0,0,0,−1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,1,0,0,0,1,0,0,0,−1,0,0,0,−1,0,0,0,1,0,0,0,−1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,1,0,0,0,1,0,0,0,−1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,1,0,0,0,−1,0,0,0,1,0,0,0,−1,0,0,0,−1,0,0,0,−1,0,0,0,−1,0,0,0,−1,0,0,0,1,0,0,0,−1,0,0,0,−1,0,0,0,1,0,0,0,0,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,−1,0,0,0,1,0,0,0,1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,−1,0,0,0,1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,1,0,0,0,−1,0,0,0,1,0,0,0,1,0,0,0,−1,0,0,0,−1,0,0,0,1,0,0,0,−1,0,0,0,1,0,0,0,1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,−1,0,0,0,−1,0,0,0,−1,0,0,0,1,0,0,0,−1,0,0,0,−1,0,0,0,−1,0,0,0,−1,0,0,0,1,0,0,0,−1,0,0,0,−1,0,0,0,−1,0,0,0,1,0,0,0,1,0,0,0,1,0,0,0,−1,0,0,0,1,0,0,0,−1,0,0,0,−1,0,0,0,1,0,0,0,1,0,0,0,−1,0,0,0,−1,0,0,0,1,0,0,0,−1,0,0,0,1,0,0,0,1,0,0,0,−1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,0,0,0,0,0,0,0,0}
For 80 MHz transmission, the N-TF sequence with the format of an HELTF1X80, optimized for estimation order P=9, is given by:
N-TF(HELTF1X80,P=9)=sqrt(1024/250)·{0,0,0,0,0,0,0,0,0,0,0,0,−1,0,0,0,1,0,0,0,−1,0,0,0,1,0,0,0,−1,0,0,0,−1,0,0,0,−1,0,0,0,1,0,0,0,−1,0,0,0,1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,−1,0,0,0,1,0,0,0,1,0,0,0,1,0,0,0,1,0,0,0,1,0,0,0,1,0,0,0,−1,0,0,0,1,0,0,0,1,0,0,0,1,0,0,0,1,0,0,0,1,0,0,0,1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,−1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,1,0,0,0,−1,0,0,0,1,0,0,0,1,0,0,0,0,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,1,0,0,0,−1,0,0,0,1,0,0,0,−1,0,0,0,−1,0,0,0,1,0,0,0,−1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,−1,0,0,0,1,0,0,0,−1,0,0,0,−1,0,0,0,1,0,0,0,−1,0,0,0,1,0,0,0,1,0,0,0,−1,0,0,0,1,0,0,0,1,0,0,0,−1,0,0,0,1,0,0,0,1,0,0,0,−1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,−1,0,0,0,1,0,0,0,1,0,0,0,−1,0,0,0,1,0,0,0,1,0,0,0,−1,0,0,0,−1,0,0,0,1,0,0,0,1,0,0,0,1,0,0,0,1,0,0,0,−1,0,0,0,1,0,0,0,−1,0,0,0,0,0,0,0,0,0,0,0}
For 80 MHz transmission, the N-TF sequence with the format of an HELTF1X80, optimized for estimation order P=10, is given by:
N-TF(HELTF1X80,P=10)=sqrt(1024/250)·{0,0,0,0,0,0,0,0,0,0,0,0,1,0,0,0,1,0,0,0,−1,0,0,0,−1,0,0,0,1,0,0,0,1,0,0,0,−1,0,0,0,−1,0,0,0,1,0,0,0,−1,0,0,0,−1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,1,0,0,0,1,0,0,0,−1,0,0,0,−1,0,0,0,−1,0,0,0,−1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,−1,0,0,0,1,0,0,0,1,0,0,0,−1,0,0,0,1,0,0,0,−1,0,0,0,−1,0,0,0,−1,0,0,0,1,0,0,0,−1,0,0,0,−1,0,0,0,−1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,1,0,0,0,−1,0,0,0,1,0,0,0,−1,0,0,0,1,0,0,0,−1,0,0,0,1,0,0,0,1,0,0,0,−1,0,0,0,−1,0,0,0,1,0,0,0,−1,0,0,0,−1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,−1,0,0,0,−1,0,0,0,1,0,0,0,−1,0,0,0,−1,0,0,0,−1,0,0,0,−1,0,0,0,−1,0,0,0,−1,0,0,0,1,0,0,0,−1,0,0,0,1,0,0,0,0,0,0,0,1,0,0,0,−1,0,0,0,1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,−1,0,0,0,1,0,0,0,−1,0,0,0,1,0,0,0,−1,0,0,0,−1,0,0,0,1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,1,0,0,0,−1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,−1,0,0,0,−1,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,0,0,0,0,0,0,0,0}
List19
For 80 MHz transmission, the N-TF sequence with the format of an HELTF2X80, optimized for estimation order P=3, is given by:
N-TF(HELTF2X80,P=3)=sqrt(1024/498)·{0,0,0,0,0,0,0,0,0,0,0,0,1,0,−1,0,−1,0,−1,0,1,0,−1,0,1,0,−1,0,1,0,1,0,−1,0,1,0,1,0,1,0,1,0,−1,0,−1,0,1,0,−1,0,−1,0,−1,0,−1,0,1,0,1,0,−1,0,1,0,−1,0,1,0,1,0,−1,0,−1,0,−1,0,−1,0,1,0,−1,0,1,0,1,0,1,0,−1,0,−1,0,1,0,−1,0,1,0,1,0,−1,0,1,0,−1,0,1,0,1,0,1,0,−1,0,−1,0,1,0,−1,0,−1,0,1,0,1,0,1,0,−1,0,−1,0,1,0,1,0,−1,0,1,0,−1,0,−1,0,1,0,1,0,−1,0,−1,0,−1,0,−1,0,1,0,1,0,−1,0,−1,0,1,0,−1,0,1,0,−1,0,1,0,−1,0,−1,0,−1,0,−1,0,−1,0,1,0,1,0,−1,0,1,0,−1,0,1,0,1,0,−1,0,−1,0,1,0,1,0,1,0,1,0,−1,0,1,0,−1,0,1,0,−1,0,−1,0,−1,0,−1,0,−1,0,−1,0,1,0,−1,0,−1,0,1,0,−1,0,1,0,1,0,1,0,1,0,−1,0,1,0,−1,0,−1,0,1,0,−1,0,−1,0,−1,0,−1,0,−1,0,−1,0,1,0,1,0,−1,0,−1,0,−1,0,1,0,1,0,−1,0,−1,0,−1,0,1,0,−1,0,−1,0,1,0,−1,0,1,0,1,0,1,0,−1,0,1,0,1,0,1,0,−1,0,−1,0,−1,0,1,0,1,0,−1,0,−1,0,1,0,−1,0,−1,0,−1,0,1,0,1,0,−1,0,1,0,−1,0,1,0,1,0,−1,0,1,0,−1,0,1,0,−1,0,1,0,−1,0,−1,0,1,0,−1,0,1,0,1,0,−1,0,1,0,−1,0,1,0,1,0,1,0,1,0,−1,0,1,0,1,0,−1,0,−1,0,−1,0,1,0,1,0,−1,0,1,0,−1,0,1,0,−1,0,1,0,−1,0,1,0,1,0,−1,0,−1,0,−1,0,−1,0,−1,0,−1,0,−1,0,−1,0,1,0,1,0,−1,0,−1,0,1,0,1,0,−1,0,1,0,1,0,−1,0,1,0,−1,0,1,0,−1,0,−1,0,1,0,−1,0,1,0,1,0,1,0,1,0,1,0,−1,0,−1,0,1,0,−1,0,1,0,−1,0,−1,0,1,0,−1,0,−1,0,−1,0,−1,0,−1,0,−1,0,0,0,0,0,0,0,1,0,−1,0,1,0,−1,0,1,0,−1,0,−1,0,−1,0,−1,0,1,0,1,0,−1,0,1,0,−1,0,1,0,−1,0,−1,0,1,0,−1,0,−1,0,1,0,1,0,−1,0,−1,0,1,0,−1,0,−1,0,1,0,1,0,1,0,−1,0,1,0,1,0,1,0,−1,0,1,0,1,0,−1,0,1,0,1,0,1,0,−1,0,−1,0,1,0,1,0,−1,0,−1,0,1,0,1,0,1,0,−1,0,−1,0,−1,0,1,0,1,0,−1,0,−1,0,−1,0,−1,0,−1,0,1,0,−1,0,1,0,1,0,1,0,1,0,−1,0,1,0,1,0,−1,0,−1,0,1,0,−1,0,1,0,1,0,−1,0,−1,0,1,0,−1,0,1,0,−1,0,−1,0,1,0,1,0,1,0,1,0,−1,0,1,0,−1,0,−1,0,1,0,−1,0,1,0,1,0,−1,0,−1,0,−1,0,1,0,1,0,1,0,1,0,1,0,1,0,1,0,1,0,−1,0,1,0,1,0,1,0,−1,0,−1,0,−1,0,1,0,−1,0,−1,0,1,0,1,0,1,0,1,0,−1,0,1,0,−1,0,1,0,1,0,−1,0,1,0,1,0,1,0,−1,0,−1,0,1,0,1,0,1,0,1,0,−1,0,1,0,−1,0,−1,0,−1,0,1,0,−1,0,1,0,1,0,−1,0,−1,0,−1,0,1,0,1,0,−1,0,−1,0,−1,0,1,0,1,0,−1,0,−1,0,1,0,1,0,1,0,−1,0,−1,0,1,0,−1,0,1,0,1,0,−1,0,1,0,−1,0,1,0,−1,0,−1,0,1,0,1,0,1,0,−1,0,1,0,1,0,1,0,−1,0,−1,0,1,0,−1,0,−1,0,1,0,−1,0,−1,0,1,0,−1,0,−1,0,1,0,1,0,1,0,1,0,−1,0,1,0,−1,0,1,0,1,0,−1,0,1,0,1,0,−1,0,1,0,1,0,−1,0,1,0,1,0,−1,0,−1,0,−1,0,1,0,1,0,−1,0,−1,0,−1,0,−1,0,1,0,−1,0,−1,0,1,0,−1,0,−1,0,1,0,1,0,1,0,−1,0,1,0,−1,0,−1,0,−1,0,−1,0,1,0,−1,0,−1,0,−1,0,1,0,1,0,−1,0,1,0,1,0,−1,0,−1,0,−1,0,1,0,−1,0,1,0,−1,0,−1,0,1,0,1,0,0,0,0,0,0,0,0,0,0,0}
For 80 MHz transmission, the N-TF sequence with the format of an HELTF2X80, optimized for estimation order P=4, is given by:
N-TF(HELTF2X80,P=4)=sqrt(1024/498)·{0,0,0,0,0,0,0,0,0,0,0,0,1,0,1,0,−1,0,1,0,1,0,−1,0,1,0,1,0,−1,0,−1,0,−1,0,−1,0,−1,0,−1,0,−1,0,1,0,−1,0,1,0,1,0,−1,0,−1,0,1,0,1,0,−1,0,−1,0,−1,0,1,0,−1,0,−1,0,1,0,1,0,1,0,1,0,−1,0,1,0,1,0,−1,0,1,0,1,0,−1,0,−1,0,−1,0,1,0,−1,0,−1,0,1,0,1,0,1,0,−1,0,1,0,1,0,−1,0,1,0,1,0,1,0,−1,0,1,0,−1,0,1,0,−1,0,1,0,−1,0,−1,0,−1,0,1,0,−1,0,1,0,−1,0,1,0,−1,0,−1,0,1,0,−1,0,1,0,−1,0,1,0,−1,0,−1,0,−1,0,1,0,−1,0,1,0,1,0,1,0,−1,0,1,0,1,0,1,0,−1,0,1,0,1,0,1,0,1,0,1,0,1,0,−1,0,−1,0,1,0,−1,0,1,0,−1,0,1,0,−1,0,1,0,1,0,−1,0,−1,0,−1,0,−1,0,1,0,−1,0,−1,0,1,0,1,0,−1,0,1,0,−1,0,−1,0,1,0,1,0,−1,0,1,0,1,0,−1,0,−1,0,−1,0,−1,0,−1,0,−1,0,−1,0,−1,0,−1,0,−1,0,1,0,−1,0,−1,0,1,0,−1,0,1,0,−1,0,−1,0,−1,0,1,0,−1,0,1,0,−1,0,−1,0,1,0,−1,0,−1,0,1,0,−1,0,1,0,−1,0,1,0,1,0,1,0,1,0,1,0,1,0,1,0,−1,0,1,0,1,0,−1,0,1,0,−1,0,−1,0,−1,0,1,0,1,0,1,0,1,0,−1,0,−1,0,1,0,1,0,1,0,−1,0,1,0,−1,0,1,0,−1,0,1,0,−1,0,−1,0,1,0,1,0,−1,0,1,0,1,0,1,0,−1,0,1,0,−1,0,−1,0,−1,0,1,0,−1,0,−1,0,−1,0,1,0,1,0,−1,0,−1,0,1,0,−1,0,1,0,1,0,1,0,−1,0,1,0,−1,0,1,0,1,0,−1,0,−1,0,−1,0,1,0,1,0,1,0,−1,0,1,0,−1,0,1,0,−1,0,1,0,−1,0,−1,0,1,0,1,0,−1,0,1,0,1,0,1,0,−1,0,1,0,1,0,1,0,−1,0,1,0,1,0,1,0,−1,0,1,0,1,0,−1,0,−1,0,−1,0,0,0,0,0,0,0,−1,0,1,0,−1,0,−1,0,1,0,−1,0,−1,0,1,0,−1,0,1,0,−1,0,1,0,−1,0,1,0,−1,0,1,0,1,0,1,0,1,0,−1,0,1,0,1,0,−1,0,1,0,1,0,−1,0,1,0,−1,0,−1,0,1,0,−1,0,−1,0,1,0,−1,0,1,0,1,0,1,0,1,0,1,0,−1,0,1,0,−1,0,1,0,1,0,1,0,1,0,1,0,1,0,−1,0,−1,0,−1,0,1,0,−1,0,1,0,1,0,1,0,1,0,1,0,−1,0,−1,0,−1,0,−1,0,1,0,−1,0,1,0,−1,0,1,0,−1,0,1,0,−1,0,−1,0,1,0,1,0,−1,0,−1,0,1,0,−1,0,1,0,1,0,1,0,−1,0,1,0,1,0,1,0,−1,0,−1,0,−1,0,−1,0,−1,0,1,0,−1,0,1,0,−1,0,1,0,1,0,−1,0,−1,0,1,0,1,0,−1,0,−1,0,1,0,−1,0,1,0,1,0,1,0,1,0,−1,0,−1,0,1,0,1,0,1,0,1,0,−1,0,−1,0,1,0,−1,0,−1,0,1,0,−1,0,−1,0,1,0,1,0,1,0,−1,0,1,0,1,0,1,0,−1,0,−1,0,1,0,−1,0,1,0,−1,0,1,0,−1,0,1,0,−1,0,1,0,−1,0,−1,0,−1,0,1,0,−1,0,1,0,−1,0,−1,0,−1,0,1,0,1,0,1,0,−1,0,1,0,−1,0,1,0,−1,0,−1,0,−1,0,1,0,−1,0,1,0,1,0,1,0,1,0,1,0,1,0,1,0,−1,0,−1,0,1,0,−1,0,1,0,−1,0,1,0,−1,0,1,0,1,0,1,0,−1,0,1,0,1,0,1,0,−1,0,−1,0,−1,0,−1,0,−1,0,1,0,−1,0,1,0,1,0,1,0,−1,0,1,0,−1,0,1,0,−1,0,1,0,1,0,−1,0,−1,0,−1,0,−1,0,−1,0,−1,0,1,0,−1,0,1,0,−1,0,1,0,−1,0,1,0,1,0,−1,0,−1,0,−1,0,1,0,1,0,−1,0,1,0,1,0,1,0,−1,0,−1,0,1,0,−1,0,1,0,1,0,1,0,−1,0,1,0,−1,0,−1,0,1,0,1,0,−1,0,−1,0,−1,0,1,0,1,0,−1,0,1,0,−1,0,−1,0,−1,0,−1,0,1,0,−1,0,1,0,0,0,0,0,0,0,0,0,0,0}
For 80 MHz transmission, the N-TF sequence with the format of an HELTF2X80, optimized for estimation order P=5, is given by:
N-TF(HELTF2X80,P=5)=sqrt(1024/498)·{0,0,0,0,0,0,0,0,0,0,0,0,1,0,−1,0,1,0,−1,0,1,0,−1,0,1,0,−1,0,1,0,1,0,1,0,−1,0,1,0,−1,0,1,0,1,0,−1,0,−1,0,1,0,1,0,1,0,−1,0,1,0,1,0,−1,0,1,0,−1,0,−1,0,1,0,−1,0,1,0,1,0,−1,0,1,0,−1,0,−1,0,1,0,−1,0,−1,0,1,0,1,0,1,0,1,0,−1,0,1,0,−1,0,1,0,−1,0,1,0,1,0,−1,0,1,0,1,0,1,0,−1,0,1,0,−1,0,1,0,−1,0,−1,0,1,0,1,0,1,0,1,0,−1,0,1,0,−1,0,1,0,−1,0,−1,0,−1,0,1,0,1,0,−1,0,−1,0,−1,0,1,0,1,0,1,0,1,0,−1,0,−1,0,1,0,−1,0,1,0,−1,0,−1,0,−1,0,−1,0,1,0,1,0,−1,0,1,0,−1,0,1,0,1,0,−1,0,−1,0,−1,0,−1,0,−1,0,−1,0,1,0,−1,0,1,0,−1,0,−1,0,1,0,1,0,−1,0,1,0,−1,0,−1,0,1,0,1,0,1,0,1,0,−1,0,−1,0,−1,0,−1,0,1,0,1,0,−1,0,1,0,−1,0,1,0,−1,0,−1,0,1,0,1,0,−1,0,1,0,−1,0,1,0,−1,0,−1,0,−1,0,1,0,1,0,1,0,−1,0,−1,0,1,0,−1,0,1,0,−1,0,1,0,1,0,−1,0,1,0,−1,0,−1,0,−1,0,1,0,−1,0,−1,0,−1,0,1,0,−1,0,−1,0,1,0,−1,0,1,0,1,0,−1,0,1,0,−1,0,1,0,−1,0,1,0,1,0,1,0,1,0,−1,0,−1,0,1,0,−1,0,1,0,−1,0,−1,0,−1,0,−1,0,1,0,−1,0,−1,0,1,0,−1,0,1,0,−1,0,−1,0,−1,0,−1,0,−1,0,−1,0,−1,0,1,0,−1,0,−1,0,−1,0,−1,0,1,0,−1,0,−1,0,−1,0,−1,0,1,0,1,0,−1,0,−1,0,1,0,−1,0,1,0,1,0,1,0,−1,0,1,0,1,0,1,0,1,0,1,0,−1,0,1,0,−1,0,−1,0,−1,0,1,0,−1,0,−1,0,1,0,1,0,1,0,−1,0,1,0,−1,0,−1,0,1,0,−1,0,1,0,1,0,−1,0,−1,0,1,0,−1,0,1,0,1,0,1,0,−1,0,−1,0,0,0,0,0,0,0,−1,0,−1,0,1,0,1,0,1,0,−1,0,1,0,−1,0,1,0,−1,0,1,0,1,0,1,0,−1,0,1,0,−1,0,1,0,−1,0,1,0,1,0,1,0,1,0,1,0,−1,0,1,0,−1,0,−1,0,1,0,−1,0,−1,0,−1,0,1,0,1,0,−1,0,1,0,−1,0,1,0,1,0,1,0,−1,0,−1,0,1,0,1,0,1,0,−1,0,−1,0,1,0,−1,0,1,0,−1,0,1,0,−1,0,−1,0,−1,0,−1,0,1,0,1,0,1,0,−1,0,1,0,1,0,1,0,−1,0,−1,0,1,0,1,0,1,0,−1,0,−1,0,−1,0,1,0,−1,0,1,0,1,0,−1,0,1,0,1,0,1,0,1,0,−1,0,1,0,−1,0,−1,0,−1,0,−1,0,1,0,−1,0,−1,0,−1,0,−1,0,−1,0,−1,0,−1,0,1,0,1,0,−1,0,1,0,−1,0,1,0,1,0,−1,0,−1,0,−1,0,1,0,1,0,−1,0,−1,0,−1,0,1,0,1,0,−1,0,−1,0,−1,0,−1,0,1,0,−1,0,−1,0,1,0,1,0,1,0,1,0,−1,0,1,0,−1,0,−1,0,1,0,1,0,−1,0,−1,0,−1,0,−1,0,−1,0,−1,0,−1,0,1,0,1,0,1,0,−1,0,1,0,1,0,−1,0,−1,0,−1,0,−1,0,−1,0,−1,0,−1,0,1,0,−1,0,1,0,−1,0,−1,0,−1,0,−1,0,1,0,−1,0,−1,0,−1,0,1,0,1,0,1,0,−1,0,−1,0,1,0,−1,0,1,0,−1,0,1,0,−1,0,−1,0,1,0,−1,0,1,0,−1,0,−1,0,−1,0,1,0,−1,0,1,0,1,0,1,0,1,0,1,0,−1,0,−1,0,−1,0,1,0,−1,0,−1,0,−1,0,1,0,−1,0,1,0,−1,0,−1,0,−1,0,1,0,1,0,−1,0,−1,0,1,0,−1,0,1,0,−1,0,−1,0,−1,0,−1,0,1,0,−1,0,−1,0,1,0,−1,0,1,0,1,0,1,0,−1,0,1,0,−1,0,−1,0,1,0,1,0,−1,0,1,0,1,0,1,0,1,0,−1,0,−1,0,−1,0,1,0,−1,0,−1,0,1,0,−1,0,1,0,1,0,−1,0,1,0,1,0,1,0, 1,0, 1,0, 1,0,−1, 0, 1, 0,−1,0,−1,0,−1,0,1,0,0,0,0,0,0,0,0,0,0,0}
For 80 MHz transmission, the N-TF sequence with the format of an HELTF2X80, optimized for estimation order P=6, is given by:
N-TF(HELTF2X80,P=6)=sqrt(1024/498)·{0,0,0,0,0,0,0,0,0,0,0,0,1,0,1,0,−1,0,1,0,−1,0,−1,0,−1,0,−1,0,−1,0,−1,0,1,0,1,0,−1,0,−1,0,1,0,−1,0,1,0,−1,0,1,0,1,0,−1,0,−1,0,−1,0,1,0,−1,0,1,0,−1,0,1,0,1,0,1,0,−1,0,−1,0,−1,0,1,0,−1,0,−1,0,1,0,1,0,−1,0,1,0,1,0,−1,0,1,0,1,0,−1,0,−1,0,−1,0,1,0,−1,0,−1,0,−1,0,1,0,1,0,−1,0,1,0,1,0,1,0,−1,0,1,0,1,0,−1,0,1,0,−1,0,−1,0,1,0,−1,0,1,0,1,0,−1,0,1,0,1,0,−1,0,1,0,−1,0,1,0,−1,0,−1,0,−1,0,1,0,−1,0,1,0,1,0,−1,0,1,0,1,0,1,0,−1,0,−1,0,1,0,1,0,−1,0,1,0,1,0,1,0,−1,0,1,0,1,0,−1,0,−1,0,−1,0,1,0,1,0,−1,0,1,0,−1,0,1,0,−1,0,1,0,−1,0,1,0,−1,0,−1,0,1,0,−1,0,1,0,−1,0,−1,0,−1,0,1,0,1,0,1,0,−1,0,1,0,−1,0,1,0,1,0,−1,0,−1,0,1,0,1,0,1,0,−1,0,−1,0,1,0,1,0,−1,0,1,0,−1,0,−1,0,−1,0,−1,0,1,0,1,0,−1,0,1,0,1,0,−1,0,1,0,−1,0,1,0,−1,0,1,0,−1,0,1,0,−1,0,1,0,1,0,−1,0,1,0,1,0,1,0,−1,0,−1,0,1,0,−1,0,1,0,1,0,1,0,−1,0,1,0,1,0,1,0,1,0,−1,0,−1,0,1,0,1,0,1,0,−1,0,−1,0,1,0,−1,0,1,0,1,0,1,0,−1,0,1,0,1,0,−1,0,1,0,−1,0,−1,0,1,0,−1,0,1,0,−1,0,−1,0,−1,0,1,0,−1,0,1,0,−1,0,1,0,−1,0,−1,0,1,0,−1,0,−1,0,−1,0,1,0,1,0,1,0,−1,0,1,0,1,0,−1,0,1,0,−1,0,1,0,1,0,−1,0,1,0,1,0,−1,0,1,0,1,0,1,0,1,0,−1,0,1,0,1,0,−1,0,−1,0,1,0,−1,0,1,0,1,0,−1,0,1,0,−1,0,1,0,−1,0,−1,0,1,0,1,0,1,0,−1,0,1,0,−1,0,0,0,0,0,0,0,−1,0,1,0,−1,0,1,0,−1,0,−1,0,−1,0,−1,0,−1,0,−1,0,1,0,1,0,1,0,−1,0,1,0,1,0,−1,0,−1,0,−1,0,1,0,−1,0,−1,0,1,0,−1,0,1,0,1,0,1,0,1,0,1,0,−1,0,1,0,−1,0,−1,0,1,0,1,0,−1,0,1,0,1,0,−1,0,−1,0,−1,0,1,0,1,0,−1,0,1,0,1,0,−1,0,−1,0,−1,0,1,0,−1,0,−1,0,1,0,1,0,−1,0,−1,0,1,0,−1,0,−1,0,1,0,−1,0,1,0,−1,0,1,0,−1,0,−1,0,1,0,1,0,1,0,−1,0,1,0,−1,0,−1,0,−1,0,−1,0,−1,0,−1,0,1,0,1,0,−1,0,1,0,−1,0,−1,0,1,0,1,0,1,0,−1,0,−1,0,1,0,−1,0,1,0,−1,0,1,0,−1,0,1,0,−1,0,−1,0,−1,0,−1,0,−1,0,1,0,−1,0,−1,0,1,0,−1,0,1,0,−1,0,−1,0,−1,0,1,0,−1,0,−1,0,−1,0,−1,0,1,0,−1,0,−1,0,1,0,1,0,1,0,−1,0,1,0,1,0,−1,0,1,0,−1,0,1,0,−1,0,1,0,−1,0,1,0,−1,0,−1,0,−1,0,1,0,−1,0,1,0,−1,0,1,0,1,0,−1,0,1,0,−1,0,1,0,−1,0,1,0,1,0,1,0,−1,0,−1,0,1,0,−1,0,1,0,−1,0,−1,0,−1,0,−1,0,1,0,1,0,−1,0,−1,0,1,0,−1,0,1,0,−1,0,1,0,−1,0,1,0,1,0,1,0,−1,0,−1,0,1,0,−1,0,−1,0,1,0,1,0,−1,0,−1,0,1,0,1,0,−1,0,−1,0,1,0,1,0,−1,0,1,0,−1,0,−1,0,−1,0,−1,0,1,0,−1,0,−1,0,1,0,−1,0,1,0,1,0,−1,0,1,0,−1,0,−1,0,1,0,1,0,−1,0,1,0,−1,0,−1,0,1,0,1,0,−1,0,−1,0,1,0,1,0,−1,0,−1,0,−1,0,−1,0,1,0,1,0,1,0,1,0,−1,0,−1,0,−1,0,−1,0,−1,0,1,0,−1,0,−1,0,1,0,−1,0,1,0,1,0,−1,0,−1,0,1,0,−1,0,1,0,−1,0,−1,0,−1,0,1,0,−1,0,−1,0,1,0,1,0,−1,0,−1,0,0,0,0,0,0,0,0,0,0,0}
For 80 MHz transmission, the N-TF sequence with the format of an HELTF2X80, optimized for estimation order P=7, is given by:
N-TF(HELTF2X80,P=7)=sqrt(1024/498)·{0,0,0,0,0,0,0,0,0,0,0,0,1,0,1,0,−1,0,−1,0,1,0,1,0,1,0,−1,0,1,0,1,0,1,0,1,0,1,0,1,0,1,0,−1,0,−1,0,−1,0,1,0,1,0,−1,0,1,0,−1,0,−1,0,1,0,1,0,1,0,1,0,−1,0,−1,0,−1,0,−1,0,−1,0,−1,0,−1,0,−1,0,−1,0,1,0,1,0,1,0,1,0,1,0,−1,0,−1,0,1,0,1,0,1,0,−1,0,−1,0,−1,0,1,0,1,0,−1,0,1,0,−1,0,1,0,−1,0,1,0,1,0,1,0,−1,0,1,0,−1,0,1,0,1,0,−1,0,1,0,−1,0,1,0,−1,0,−1,0,1,0,−1,0,−1,0,−1,0,1,0,1,0,1,0,1,0,−1,0,1,0,−1,0,−1,0,−1,0,−1,0,−1,0,−1,0,−1,0,1,0,1,0,1,0,1,0,−1,0,1,0,1,0,−1,0,1,0,1,0,−1,0,1,0,−1,0,−1,0,−1,0,1,0,−1,0,−1,0,1,0,1,0,−1,0,1,0,1,0,1,0,1,0,1,0,1,0,−1,0,1,0,−1,0,−1,0,−1,0,−1,0,−1,0,−1,0,1,0,−1,0,−1,0,1,0,−1,0,1,0,1,0,−1,0,−1,0,1,0,−1,0,1,0,1,0,−1,0,−1,0,−1,0,−1,0,−1,0,−1,0,−1,0,1,0,1,0,1,0,1,0,1,0,1,0,−1,0,−1,0,1,0,−1,0,1,0,1,0,1,0,−1,0,−1,0,−1,0,1,0,1,0,1,0,−1,0,−1,0,1,0,1,0,1,0,1,0,−1,0,1,0,−1,0,−1,0,−1,0,−1,0,1,0,−1,0,−1,0,−1,0,−1,0,1,0,1,0,1,0,1,0,1,0,1,0,−1,0,1,0,1,0,−1,0,−1,0,−1,0,−1,0,−1,0,−1,0,−1,0,−1,0,1,0,1,0,1,0,1,0,−1,0,1,0,−1,0,1,0,1,0,1,0,−1,0,1,0,1,0,1,0,−1,0,−1,0,1,0,−1,0,1,0,−1,0,1,0,1,0,−1,0,−1,0,−1,0,−1,0,1,0,1,0,1,0,1,0,−1,0,−1,0,−1,0,−1,0,1,0,−1,0,−1,0,−1,0,−1,0,1,0,−1,0,−1,0,1,0,1,0,−1,0,−1,0,−1,0,1,0,1,0,−1,0,1,0,1,0,1,0,0,0,0,0,0,0,1,0,−1,0,−1,0,−1,0,1,0,1,0,−1,0,−1,0,1,0,−1,0,1,0,1,0,1,0,1,0,1,0,−1,0,−1,0,−1,0,−1,0,−1,0,1,0,1,0,1,0,1,0,−1,0,1,0,−1,0,1,0,1,0,−1,0,1,0,1,0,−1,0,−1,0,1,0,−1,0,1,0,1,0,−1,0,−1,0,1,0,1,0,−1,0,1,0,1,0,−1,0,1,0,1,0,1,0,1,0,1,0,−1,0,−1,0,1,0,−1,0,−1,0,1,0,−1,0,−1,0,−1,0,−1,0,1,0,1,0,1,0,1,0,1,0,1,0,1,0,1,0,−1,0,−1,0,1,0,−1,0,1,0,−1,0,1,0,1,0,−1,0,−1,0,−1,0,1,0,1,0,−1,0,−1,0,1,0,−1,0,1,0,−1,0,1,0,1,0,−1,0,−1,0,−1,0,1,0,−1,0,−1,0,1,0,1,0,1,0,1,0,1,0,1,0,1,0,−1,0,−1,0,−1,0,1,0,−1,0,−1,0,−1,0,1,0,1,0,1,0,1,0,1,0,1,0,1,0,−1,0,1,0,1,0,1,0,−1,0,−1,0,−1,0,−1,0,1,0,−1,0,−1,0,1,0,1,0,−1,0,1,0,1,0,1,0,1,0,1,0,1,0,1,0,−1,0,1,0,−1,0,−1,0,−1,0,−1,0,1,0,1,0,1,0,−1,0,−1,0,1,0,1,0,1,0,−1,0,−1,0,−1,0,1,0,1,0,−1,0,1,0,−1,0,−1,0,−1,0,−1,0,1,0,1,0,1,0,−1,0,1,0,1,0,1,0,1,0,−1,0,−1,0,−1,0,−1,0,−1,0,1,0,1,0,1,0,−1,0,−1,0,1,0,1,0,1,0,1,0,−1,0,−1,0,1,0,−1,0,1,0,1,0,1,0,−1,0,−1,0,−1,0,−1,0,−1,0,1,0,−1,0,1,0,1,0,−1,0,−1,0,1,0,1,0,−1,0,−1,0,1,0,1,0,1,0,1,0,−1,0,1,0,1,0,−1,0,−1,0,1,0,−1,0,−1,0,−1,0,−1,0,1,0,1,0,−1,0,−1,0,1,0,1,0,−1,0,1,0,−1,0,1,0,−1,0,−1,0,1,0,1,0,1,0,−1,0,−1,0,1,0,1,0,1,0,1,0,−1,0,−1,0,−1,0,−1,0,−1,0,1,0,1,0,0,0,0,0,0,0,0,0,0,0}
For 80 MHz transmission, the N-TF sequence with the format of an HELTF2X80, optimized for estimation order P=8, is given by:
N-TF(HELTF2X80,P=8)=sqrt(1024/498)·{0,0,0,0,0,0,0,0,0,0,0,0,1,0,−1,0,1,0,−1,0,1,0,1,0,1,0,−1,0,−1,0,1,0,1,0,−1,0,1,0,−1,0,1,0,−1,0,−1,0,1,0,1,0,1,0,1,0,−1,0,1,0,1,0,−1,0,−1,0,1,0,−1,0,1,0,−1,0,1,0,−1,0,−1,0,1,0,1,0,−1,0,1,0,−1,0,1,0,1,0,1,0,−1,0,−1,0,−1,0,−1,0,−1,0,1,0,1,0,−1,0,−1,0,1,0,−1,0,1,0,1,0,−1,0,−1,0,−1,0,1,0,−1,0,−1,0,1,0,1,0,−1,0,−1,0,−1,0,1,0,1,0,1,0,−1,0,−1,0,1,0,1,0,1,0,1,0,−1,0,−1,0,1,0,1,0,1,0,1,0,−1,0,1,0,1,0,−1,0,1,0,−1,0,1,0,−1,0,−1,0,1,0,1,0,−1,0,1,0,−1,0,−1,0,1,0,−1,0,−1,0,1,0,−1,0,1,0,−1,0,−1,0,−1,0,1,0,−1,0,−1,0,−1,0,1,0,−1,0,1,0,−1,0,−1,0,−1,0,1,0,1,0,1,0,−1,0,−1,0,1,0,−1,0,1,0,−1,0,−1,0,1,0,−1,0,1,0,−1,0,−1,0,−1,0,−1,0,−1,0,1,0,1,0,1,0,1,0,1,0,−1,0,−1,0,1,0,1,0,−1,0,−1,0,1,0,−1,0,1,0,−1,0,1,0,−1,0,−1,0,−1,0,1,0,−1,0,1,0,1,0,1,0,−1,0,−1,0,1,0,−1,0,−1,0,−1,0,1,0,1,0,1,0,−1,0,1,0,−1,0,−1,0,−1,0,−1,0,−1,0,1,0,−1,0,1,0,−1,0,1,0,1,0,1,0,−1,0,−1,0,1,0,1,0,−1,0,−1,0,−1,0,1,0,1,0,1,0,−1,0,−1,0,−1,0,1,0,1,0,1,0,−1,0,1,0,−1,0,1,0,−1,0,1,0,1,0,1,0,−1,0,−1,0,−1,0,1,0,−1,0,−1,0,−1,0,1,0,−1,0,1,0,−1,0,1,0,−1,0,−1,0,1,0,1,0,−1,0,1,0,−1,0,−1,0,−1,0,1,0,1,0,1,0,−1,0,−1,0,1,0,−1,0,1,0,1,0,1,0,1,0,−1,0,1,0,−1,0,−1,0,1,0,−1,0,1,0,−1,0,1,0,1,0,−1,0,1,0,−1,0,−1,0,0,0,0,0,0,0,−1,0,−1,0,1,0,1,0,1,0,−1,0,−1,0,−1,0,1,0,1,0,1,0,−1,0,−1,0,−1,0,−1,0,−1,0,1,0,−1,0,1,0,1,0,1,0,−1,0,1,0,−1,0,1,0,−1,0,−1,0,−1,0,1,0,1,0,1,0,−1,0,−1,0,−1,0,−1,0,−1,0,1,0,1,0,−1,0,−1,0,1,0,1,0,1,0,1,0,−1,0,−1,0,1,0,1,0,1,0,−1,0,1,0,1,0,−1,0,−1,0,−1,0,1,0,1,0,−1,0,1,0,−1,0,−1,0,1,0,1,0,−1,0,−1,0,−1,0,1,0,1,0,−1,0,−1,0,1,0,1,0,−1,0,−1,0,−1,0,1,0,−1,0,1,0,−1,0,1,0,1,0,−1,0,−1,0,−1,0,1,0,−1,0,1,0,−1,0,1,0,−1,0,1,0,−1,0,−1,0,−1,0,−1,0,−1,0,1,0,1,0,1,0,1,0,−1,0,1,0,−1,0,−1,0,1,0,−1,0,1,0,−1,0,1,0,1,0,−1,0,−1,0,1,0,−1,0,1,0,−1,0,1,0,−1,0,1,0,−1,0,1,0,1,0,1,0,−1,0,−1,0,1,0,1,0,1,0,−1,0,−1,0,1,0,−1,0,1,0,1,0,1,0,−1,0,1,0,−1,0,1,0,1,0,−1,0,1,0,−1,0,−1,0,1,0,1,0,−1,0,−1,0,−1,0,1,0,−1,0,1,0,−1,0,−1,0,1,0,−1,0,−1,0,1,0,1,0,−1,0,1,0,−1,0,1,0,1,0,−1,0,−1,0,−1,0,−1,0,1,0,−1,0,1,0,1,0,1,0,−1,0,−1,0,−1,0,1,0,1,0,1,0,−1,0,1,0,1,0,1,0,−1,0,−1,0,−1,0,1,0,1,0,−1,0,−1,0,1,0,1,0,1,0,−1,0,1,0,−1,0,1,0,1,0,−1,0,−1,0,1,0,−1,0,1,0,1,0,−1,0,1,0,1,0,−1,0,−1,0,−1,0,1,0,1,0,−1,0,1,0,1,0,1,0,1,0,1,0,−1,0,1,0,1,0,−1,0,−1,0,−1,0,1,0,−1,0,1,0,−1,0,−1,0,1,0,−1,0,1,0,−1,0,−1,0,1,0,1,0,−1,0,−1,0,−1,0,1,0,1,0,1,0,−1,0,1,0,−1,0,1,0,−1,0,−1,0,−1,0,0,0,0,0,0,0,0,0,0,0}
For 80 MHz transmission, the N-TF sequence with the format of an HELTF2X80, optimized for estimation order P=9, is given by:
N-TF(HELTF2X80,P=9)=sqrt(1024/498)·{0,0,0,0,0,0,0,0,0,0,0,0,1,0,−1,0,−1,0,−1,0,1,0,−1,0,1,0,−1,0,1,0,1,0,1,0,−1,0,1,0,−1,0,1,0,1,0,−1,0,−1,0,1,0,1,0,1,0,−1,0,1,0,1,0,1,0,−1,0,−1,0,−1,0,1,0,−1,0,−1,0,1,0,1,0,1,0,−1,0,−1,0,1,0,−1,0,−1,0,1,0,1,0,1,0,−1,0,−1,0,1,0,−1,0,1,0,1,0,−1,0,1,0,−1,0,−1,0,1,0,−1,0,−1,0,−1,0,1,0,1,0,−1,0,−1,0,−1,0,−1,0,−1,0,−1,0,−1,0,1,0,1,0,−1,0,−1,0,−1,0,1,0,1,0,−1,0,1,0,−1,0,−1,0,1,0,−1,0,1,0,−1,0,−1,0,−1,0,1,0,−1,0,1,0,−1,0,1,0,−1,0,−1,0,1,0,1,0,−1,0,−1,0,−1,0,1,0,−1,0,1,0,1,0,−1,0,−1,0,1,0,−1,0,1,0,1,0,1,0,−1,0,1,0,1,0,1,0,−1,0,1,0,−1,0,−1,0,−1,0,1,0,1,0,1,0,−1,0,−1,0,1,0,1,0,1,0,1,0,1,0,1,0,−1,0,−1,0,−1,0,−1,0,1,0,1,0,−1,0,−1,0,1,0,1,0,−1,0,−1,0,1,0,−1,0,1,0,1,0,−1,0,−1,0,1,0,1,0,−1,0,−1,0,−1,0,−1,0,−1,0,−1,0,−1,0,1,0,−1,0,1,0,−1,0,1,0,−1,0,−1,0,1,0,−1,0,1,0,−1,0,1,0,1,0,−1,0,1,0,−1,0,−1,0,1,0,1,0,−1,0,1,0,−1,0,1,0,−1,0,−1,0,1,0,1,0,1,0,1,0,−1,0,1,0,−1,0,−1,0,−1,0,1,0,1,0,1,0,−1,0,1,0,−1,0,1,0,−1,0,−1,0,−1,0,1,0,−1,0,1,0,−1,0,−1,0,1,0,−1,0,−1,0,1,0,1,0,1,0,1,0,−1,0,1,0,−1,0,−1,0,1,0,−1,0,−1,0,1,0,−1,0,1,0,1,0,−1,0,−1,0,1,0,1,0,−1,0,−1,0,1,0,1,0,−1,0,−1,0,−1,0,1,0,1,0,−1,0,−1,0,−1,0,−1,0,−1,0,−1,0,−1,0,1,0,−1,0,−1,0,1,0,−1,0,−1,0,1,0,1,0,1,0,−1,0,0,0,0,0,0,0,1,0,−1,0,1,0,1,0,1,0,−1,0,−1,0,−1,0,1,0,−1,0,1,0,−1,0,1,0,−1,0,1,0,−1,0,−1,0,−1,0,1,0,−1,0,1,0,1,0,−1,0,−1,0,1,0,−1,0,−1,0,1,0,1,0,−1,0,1,0,−1,0,−1,0,−1,0,1,0,1,0,1,0,1,0,−1,0,−1,0,−1,0,−1,0,1,0,−1,0,−1,0,−1,0,1,0,−1,0,1,0,−1,0,1,0,1,0,−1,0,−1,0,−1,0,−1,0,1,0,−1,0,−1,0,1,0,−1,0,1,0,−1,0,−1,0,1,0,1,0,1,0,1,0,1,0,1,0,−1,0,1,0,1,0,−1,0,−1,0,1,0,1,0,1,0,−1,0,−1,0,1,0,−1,0,−1,0,1,0,−1,0,1,0,1,0,−1,0,1,0,−1,0,1,0,−1,0,1,0,−1,0,−1,0,−1,0,1,0,−1,0,−1,0,−1,0,1,0,−1,0,−1,0,−1,0,1,0,1,0,−1,0,−1,0,1,0,1,0,1,0,−1,0,1,0,−1,0,1,0,−1,0,−1,0,−1,0,1,0,1,0,−1,0,−1,0,−1,0,1,0,1,0,−1,0,1,0,−1,0,−1,0,−1,0,−1,0,−1,0,−1,0,1,0,1,0,−1,0,−1,0,−1,0,1,0,1,0,−1,0,1,0,−1,0,1,0,1,0,−1,0,−1,0,1,0,−1,0,1,0,1,0,−1,0,−1,0,−1,0,−1,0,−1,0,−1,0,−1,0,1,0,−1,0,1,0,1,0,−1,0,1,0,−1,0,−1,0,−1,0,1,0,1,0,−1,0,1,0,−1,0,−1,0,−1,0,1,0,−1,0,1,0,1,0,−1,0,−1,0,1,0,−1,0,1,0,−1,0,1,0,−1,0,−1,0,−1,0,−1,0,−1,0,1,0,−1,0,1,0,−1,0,1,0,−1,0,1,0,−1,0,−1,0,−1,0,1,0,−1,0,1,0,−1,0,−1,0,1,0,1,0,1,0,−1,0,−1,0,1,0,1,0,−1,0,−1,0,1,0,1,0,1,0,−1,0,1,0,1,0,−1,0,1,0,−1,0,−1,0,1,0,1,0,1,0,−1,0,1,0,1,0,1,0,1,0,−1,0,−1,0,1,0,1,0,−1,0,−1,0,−1,0,−1,0,1,0,1,0,−1,0,1,0,1,0,1,0,−1,0,−1,0,−1,0,0,0,0,0,0,0,0,0,0,0}
For 80 MHz transmission, the N-TF sequence with the format of an HELTF2X80, optimized for estimation order P=10, is given by:
N-TF(HELTF2X80,P=10)=sqrt(1024/498)·{0,0,0,0,0,0,0,0,0,0,0,0,1,0,−1,0,−1,0,−1,0,−1,0,−1,0,−1,0,−1,0,1,0,1,0,−1,0,−1,0,−1,0,−1,0,−1,0,1,0,−1,0,−1,0,−1,0,−1,0,−1,0,−1,0,−1,0,−1,0,1,0,−1,0,−1,0,1,0,−1,0,−1,0,1,0,1,0,−1,0,1,0,1,0,−1,0,−1,0,1,0,−1,0,−1,0,1,0,1,0,−1,0,−1,0,−1,0,1,0,1,0,1,0,1,0,−1,0,−1,0,−1,0,1,0,−1,0,1,0,1,0,−1,0,−1,0,−1,0,−1,0,−1,0,−1,0,1,0,1,0,−1,0,−1,0,−1,0,1,0,−1,0,−1,0,−1,0,−1,0,−1,0,−1,0,1,0,1,0,−1,0,1,0,−1,0,−1,0,−1,0,−1,0,1,0,−1,0,−1,0,1,0,−1,0,−1,0,−1,0,−1,0,−1,0,1,0,1,0,−1,0,−1,0,1,0,−1,0,−1,0,−1,0,−1,0,1,0,1,0,−1,0,−1,0,1,0,−1,0,−1,0,−1,0,1,0,1,0,−1,0,−1,0,−1,0,1,0,1,0,1,0,−1,0,1,0,−1,0,1,0,1,0,1,0,1,0,−1,0,−1,0,−1,0,1,0,−1,0,1,0,1,0,−1,0,−1,0,1,0,1,0,−1,0,−1,0,−1,0,−1,0,−1,0,−1,0,−1,0,−1,0,−1,0,−1,0,−1,0,1,0,−1,0,−1,0,−1,0,1,0,1,0,1,0,−1,0,−1,0,1,0,−1,0,−1,0,1,0,1,0,1,0,1,0,1,0,−1,0,1,0,1,0,−1,0,1,0,−1,0,1,0,1,0,1,0,−1,0,−1,0,−1,0,−1,0,1,0,−1,0,−1,0,−1,0,1,0,1,0,1,0,−1,0,−1,0,1,0,−1,0,−1,0,1,0,1,0,−1,0,−1,0,1,0,1,0,−1,0,1,0,1,0,1,0,1,0,−1,0,1,0,1,0,−1,0,−1,0,1,0,−1,0,−1,0,1,0,−1,0,−1,0,−1,0,−1,0,−1,0,1,0,1,0,1,0,−1,0,1,0,1,0,1,0,−1,0,−1,0,1,0,−1,0,−1,0,1,0,1,0,−1,0,1,0,1,0,−1,0,1,0,1,0,−1,0,1,0,1,0,1,0,−1,0,−1,0,−1,0,−1,0,−1,0,−1,0,−1,0,−1,0,−1,0,−1,0,1,0,−1,0,−1,0,0,0,0,0,0,0,−1,0,1,0,−1,0,1,0,−1,0,−1,0,1,0,−1,0,−1,0,1,0,1,0,1,0,1,0,1,0,1,0,1,0,1,0,−1,0,−1,0,1,0,−1,0,−1,0,1,0,1,0,−1,0,−1,0,−1,0,1,0,−1,0,−1,0,1,0,1,0,−1,0,−1,0,1,0,−1,0,−1,0,−1,0,−1,0,−1,0,−1,0,−1,0,−1,0,−1,0,−1,0,−1,0,−1,0,1,0,1,0,−1,0,1,0,−1,0,−1,0,1,0,−1,0,1,0,1,0,−1,0,−1,0,1,0,1,0,−1,0,−1,0,−1,0,−1,0,−1,0,−1,0,1,0,1,0,1,0,−1,0,−1,0,−1,0,−1,0,1,0,−1,0,−1,0,1,0,1,0,−1,0,−1,0,1,0,1,0,1,0,1,0,1,0,−1,0,1,0,1,0,1,0,1,0,−1,0,−1,0,1,0,−1,0,−1,0,−1,0,1,0,1,0,1,0,−1,0,−1,0,1,0,1,0,−1,0,−1,0,−1,0,−1,0,1,0,−1,0,1,0,1,0,−1,0,−1,0,−1,0,1,0,−1,0,−1,0,−1,0,−1,0,−1,0,−1,0,1,0,−1,0,−1,0,−1,0,1,0,−1,0,−1,0,−1,0,−1,0,−1,0,−1,0,1,0,1,0,1,0,1,0,−1,0,−1,0,1,0,−1,0,−1,0,−1,0,1,0,1,0,−1,0,−1,0,−1,0,1,0,−1,0,−1,0,1,0,1,0,−1,0,1,0,1,0,−1,0,−1,0,−1,0,−1,0,−1,0,1,0,−1,0,−1,0,1,0,−1,0,−1,0,−1,0,−1,0,1,0,−1,0,−1,0,1,0,1,0,−1,0,−1,0,1,0,−1,0,−1,0,−1,0,1,0,1,0,1,0,1,0,−1,0,1,0,−1,0,1,0,−1,0,1,0,−1,0,−1,0,1,0,−1,0,1,0,1,0,−1,0,−1,0,−1,0,1,0,−1,0,−1,0,1,0,1,0,−1,0,−1,0,1,0,−1,0,−1,0,1,0,1,0,−1,0,−1,0,1,0,−1,0,−1,0,−1,0,−1,0,1,0,1,0,−1,0,−1,0,1,0,1,0,−1,0,−1,0,−1,0,−1,0,−1,0,−1,0,−1,0,−1,0,1,0,−1,0,−1,0,1,0,1,0,−1,0,1,0,1,0,1,0,−1,0,−1,0,−1,0,−1,0,−1,0,−1,0,1,0,1,0,0,0,0,0,0,0,0,0,0,0}
List20
For 80 MHz transmission, the N-TF sequence with the format of an HELTF80, optimized for estimation order P=3, is given by:
N-TF(HELTF80,P=3)=sqrt(1024/996)·{0,0,0,0,0,0,0,0,0,0,0,0,1,1,−1,−1,1,1,−1,−1,−1,1,−1,−1,1,−1,−1,−1,1,1,−1,1,−1,−1,−1,−1,−1,1,−1,−1,1,1,1,1,−1,1,−1,−1,−1,1,1,−1,1,−1,1,−1,−1,−1,−1,−1,−1,−1,1,1,−1,1,−1,−1,−1,−1,1,−1,−1,−1,−1,−1,−1,−1,−1,−1,1,1,1,−1,−1,−1,−1,−1,−1,−1,1,1,−1,−1,−1,1,−1,−1,−1,−1,−1,1,1,1,−1,1,1,−1,−1,1,1,−1,−1,−1,1,1,1,−1,−1,1,1,1,−1,1,1,−1,1,1,1,1,−1,1,−1,−1,1,−1,1,1,1,−1,−1,−1,1,−1,1,−1,1,−1,1,−1,1,−1,−1,−1,1,−1,−1,−1,1,−1,−1,1,1,−1,1,1,1,−1,1,1,−1,1,1,−1,1,1,−1,−1,−1,1,−1,−1,1,−1,−1,1,−1,−1,−1,−1,1,1,1,−1,−1,1,1,−1,1,1,1,−1,−1,−1,−1,−1,1,−1,−1,1,−1,−1,1,1,1,−1,−1,1,−1,−1,−1,−1,1,1,−1,−1,1,−1,−1,1,−1,1,−1,1,−1,1,1,1,−1,−1,−1,−1,−1,1,−1,−1,1,−1,−1,−1,1,−1,1,1,1,1,−1,−1,1,−1,1,1,1,1,1,−1,1,−1,1,−1,−1,−1,−1,1,−1,−1,−1,−1,−1,1,−1,−1,−1,1,1,1,1,−1,−1,−1,1,1,1,−1,−1,1,−1,−1,−1,1,−1,−1,−1,−1,−1,1,−1,−1,−1,−1,−1,1,1,1,1,−1,−1,−1,−1,−1,1,1,1,1,−1,−1,−1,−1,−1,−1,−1,1,1,−1,−1,−1,1,1,−1,1,1,−1,−1,−1,1,1,1,1,−1,−1,−1,−1,−1,−1,−1,−1,−1,−1,−1,1,−1,−1,−1,1,1,−1,1,−1,−1,−1,−1,−1,−1,1,1,−1,1,1,1,1,−1,−1,−1,1,1,−1,−1,−1,−1,−1,−1,−1,1,1,1,−1,−1,1,−1,1,−1,1,1,−1,−1,−1,−1,1,1,−1,1,1,1,−1,1,1,−1,1,−1,−1,−1,−1,1,1,1,−1,1,−1,−1,1,−1,1,1,−1,−1,1,1,−1,−1,1,−1,−1,1,1,1,−1,−1,−1,−1,−1,1,−1,1,1,1,1,1,−1,−1,−1,1,−1,1,−1,−1,−1,−1,−1,1,1,1,−1,1,−1,−1,1,−1,−1,−1,−1,−1,1,1,−1,−1,1,−1,−1,−1,−1,1,1,1,−1,−1,−1,1,1,1,−1,−1,−1,1,1,1,−1,−1,1,−1,1,−1,−1,−1,0,0,0,0,0,1,−1,1,−1,−1,−1,1,−1,1,−1,1,−1,−1,1,1,−1,−1,1,−1,1,−1,−1,−1,1,−1,1,1,−1,1,−1,1,−1,−1,−1,−1,1,1,1,−1,1,−1,1,−1,−1,1,1,1,−1,−1,1,−1,−1,−1,−1,−1,−1,1,−1,1,1,−1,−1,−1,−1,−1,1,1,−1,1,−1,−1,−1,−1,1,1,1,1,1,−1,−1,−1,−1,−1,1,1,−1,1,1,−1,−1,1,−1,1,1,1,−1,1,−1,1,−1,−1,−1,−1,1,1,−1,−1,−1,−1,−1,−1,1,1,1,1,−1,−1,−1,−1,−1,−1,−1,−1,1,1,−1,−1,−1,−1,1,−1,1,−1,1,1,1,−1,−1,−1,1,−1,−1,−1,1,1,−1,−1,−1,1,−1,1,−1,1,−1,1,−1,1,−1,1,1,−1,1,−1,−1,−1,1,−1,−1,−1,1,−1,−1,−1,1,1,−1,−1,−1,1,−1,1,1,1,−1,−1,−1,1,1,−1,1,1,1,1,−1,−1,−1,−1,−1,−1,−1,1,−1,−1,−1,−1,1,−1,1,−1,−1,1,1,1,−1,−1,1,−1,−1,1,1,−1,−1,1,−1,1,1,1,1,−1,−1,−1,−1,−1,1,−1,1,−1,−1,1,1,−1,−1,−1,1,1,1,1,1,1,−1,1,1,1,1,−1,−1,−1,1,1,−1,−1,1,−1,−1,1,1,−1,−1,−1,−1,−1,1,1,−1,1,−1,1,−1,1,−1,1,1,1,1,1,−1,−1,−1,−1,1,1,−1,−1,1,−1,−1,1,−1,1,−1,1,−1,−1,1,−1,−1,−1,−1,−1,1,1,1,−1,1,1,1,−1,1,1,1,−1,1,−1,1,−1,1,−1,−1,−1,−1,−1,1,1,−1,1,1,−1,1,1,1,−1,−1,−1,1,−1,−1,1,−1,1,−1,1,1,1,1,−1,−1,1,−1,−1,−1,−1,−1,−1,−1,1,−1,1,1,1,1,1,−1,1,−1,−1,−1,−1,1,1,−1,−1,−1,−1,−1,−1,1,−1,1,−1,1,−1,1,−1,1,1,1,1,−1,−1,1,−1,1,1,1,−1,1,−1,1,−1,1,−1,−1,1,1,−1,−1,−1,1,−1,−1,1,−1,1,−1,−1,−1,1,−1,1,−1,1,1,1,−1,−1,1,−1,1,1,−1,1,1,1,−1,1,1,−1,1,1,−1,1,−1,1,−1,−1,1,−1,−1,−1,1,1,−1,−1,−1,−1,1,1,1,−1,1,−1,−1,−1,1,1,−1,−1,−1,−1,−1,1,−1,−1,1,1,−1,1,−1,−1,−1,−1,1,1,1,1,−1,1,−1,0,0,0,0,0,0,0,0,0,0,0}
For 80 MHz transmission, the N-TF sequence with the format of an HELTF80, optimized for estimation order P=4, is given by:
N-TF(HELTF80,P=4)=sqrt(1024/996)·{0,0,0,0,0,0,0,0,0,0,0,0,1,1,−1,−1,1,−1,−1,1,1,1,−1,−1,1,−1,1,1,1,−1,1,−1,1,−1,−1,1,1,−1,−1,1,1,1,−1,1,1,1,−1,1,−1,1,−1,1,1,−1,1,−1,1,−1,−1,−1,−1,−1,−1,−1,1,1,−1,1,−1,−1,−1,−1,−1,1,1,1,1,1,−1,1,1,1,1,1,−1,−1,−1,−1,−1,−1,−1,−1,1,−1,1,1,−1,−1,1,−1,1,1,−1,1,1,−1,1,1,−1,−1,−1,1,1,−1,−1,−1,−1,−1,−1,1,−1,1,1,1,−1,1,1,1,1,−1,−1,1,−1,−1,1,−1,1,1,−1,−1,−1,−1,1,1,−1,−1,−1,−1,−1,1,1,−1,1,1,1,1,1,1,−1,1,−1,−1,−1,1,−1,−1,1,−1,1,−1,1,1,−1,−1,1,1,−1,1,1,1,−1,1,1,1,1,1,−1,−1,−1,−1,1,−1,−1,−1,1,1,−1,1,−1,1,−1,−1,−1,1,1,1,1,−1,1,1,1,1,1,−1,−1,−1,−1,1,−1,−1,1,−1,1,−1,1,1,1,1,1,1,−1,−1,−1,1,−1,−1,1,1,1,1,1,−1,1,−1,−1,1,1,−1,1,−1,−1,−1,−1,−1,1,−1,1,−1,1,−1,1,1,1,1,1,1,1,1,1,1,1,−1,−1,−1,−1,−1,1,−1,1,−1,−1,−1,1,1,−1,−1,1,−1,1,1,−1,1,−1,−1,1,1,1,1,−1,1,1,−1,1,−1,−1,1,−1,−1,1,1,1,−1,1,−1,1,1,−1,−1,1,1,−1,1,−1,1,−1,1,1,−1,1,−1,−1,−1,−1,1,1,−1,1,−1,1,1,1,1,−1,1,−1,1,−1,−1,−1,−1,−1,−1,−1,−1,−1,−1,1,−1,−1,−1,−1,1,1,1,1,1,1,−1,1,1,1,−1,1,−1,−1,−1,−1,−1,−1,−1,−1,1,−1,1,1,−1,−1,1,1,−1,−1,−1,1,1,−1,−1,1,1,1,1,−1,1,1,−1,−1,1,−1,−1,1,−1,−1,1,1,1,1,−1,1,1,1,1,−1,−1,1,1,−1,1,−1,1,−1,1,−1,1,−1,1,1,1,1,−1,1,1,1,1,1,1,−1,−1,−1,1,−1,−1,1,−1,1,1,−1,−1,1,−1,−1,1,−1,−1,−1,−1,−1,−1,−1,−1,1,1,1,1,−1,−1,1,1,−1,1,1,−1,−1,1,1,1,1,−1,1,−1,1,1,1,−1,1,−1,−1,−1,1,−1,1,−1,1,1,1,1,−1,−1,−1,−1,1,−1,0,0,0,0,0,1,1,1,−1,1,1,1,1,−1,−1,1,−1,−1,−1,1,1,−1,−1,1,−1,−1,1,1,−1,−1,1,1,1,1,−1,−1,1,−1,1,1,−1,1,−1,−1,1,−1,−1,1,1,−1,−1,−1,1,−1,−1,−1,1,1,1,−1,−1,1,1,1,1,−1,1,1,1,1,−1,1,−1,−1,−1,1,−1,1,−1,−1,−1,1,−1,−1,1,1,1,1,1,1,1,−1,−1,−1,1,−1,1,−1,1,−1,−1,−1,1,1,−1,−1,−1,−1,−1,1,−1,−1,−1,−1,1,−1,1,−1,1,−1,1,−1,−1,1,1,1,−1,1,−1,1,1,−1,1,−1,1,−1,1,−1,−1,1,−1,1,−1,1,−1,−1,−1,1,1,−1,1,−1,−1,1,−1,−1,−1,1,1,−1,−1,1,1,1,−1,−1,1,−1,−1,−1,−1,1,1,−1,−1,1,1,−1,−1,−1,1,−1,1,1,−1,−1,1,−1,1,1,1,1,1,−1,−1,1,1,−1,1,1,−1,1,−1,−1,−1,1,−1,−1,−1,1,−1,−1,1,1,−1,−1,−1,−1,−1,1,1,−1,1,1,1,1,1,−1,1,−1,1,−1,−1,−1,−1,−1,−1,−1,−1,1,−1,−1,−1,1,1,1,−1,−1,1,1,1,1,−1,1,−1,1,−1,−1,−1,1,−1,1,−1,−1,−1,−1,−1,1,1,−1,−1,1,−1,1,−1,−1,−1,−1,−1,1,−1,1,1,−1,1,−1,1,−1,1,−1,−1,−1,−1,−1,1,1,1,−1,1,−1,1,1,−1,−1,1,−1,1,1,1,−1,1,1,1,−1,−1,1,1,1,−1,1,1,1,−1,1,1,−1,1,−1,1,−1,1,−1,−1,−1,1,−1,−1,1,−1,1,1,−1,1,1,−1,1,−1,1,1,−1,−1,−1,1,1,1,1,1,−1,−1,1,−1,1,−1,−1,−1,−1,−1,1,−1,1,−1,−1,−1,−1,−1,1,1,1,1,1,−1,1,1,1,1,−1,1,−1,−1,1,−1,−1,−1,1,1,−1,−1,1,−1,−1,−1,1,1,−1,−1,−1,1,−1,1,1,−1,1,1,−1,−1,1,−1,1,−1,−1,1,−1,−1,−1,−1,−1,1,−1,−1,−1,−1,−1,−1,1,1,1,−1,−1,1,1,1,−1,−1,1,−1,1,−1,−1,−1,1,−1,−1,−1,1,1,−1,1,1,1,1,1,1,−1,−1,1,−1,1,−1,−1,−1,−1,1,−1,−1,1,1,−1,−1,1,1,1,1,1,−1,1,1,−1,1,1,1,−1,1,1,1,−1,−1,−1,1,−1,−1,−1,−1,1,0,0,0,0,0,0,0,0,0,0,0}
For 80 MHz transmission, the N-TF sequence with the format of an HELTF80, optimized for estimation order P=5, is given by:
N-TF(HELTF80,P=5)=sqrt(1024/996)·{0,0,0,0,0,0,0,0,0,0,0,0,−1,1,1,−1,−1,1,−1,−1,−1,1,1,1,1,1,1,−1,−1,−1,−1,−1,1,1,1,1,1,1,−1,1,−1,1,−1,1,−1,1,−1,1,1,−1,−1,−1,−1,1,−1,1,−1,−1,−1,−1,−1,1,1,−1,1,−1,1,−1,1,−1,−1,1,1,1,−1,1,1,−1,−1,−1,−1,1,−1,1,−1,−1,−1,−1,−1,−1,1,−1,−1,1,1,−1,−1,1,−1,−1,−1,−1,−1,−1,1,−1,−1,−1,1,−1,1,−1,1,−1,1,−1,1,−1,1,−1,1,1,−1,1,−1,−1,−1,1,1,1,−1,−1,−1,1,−1,1,1,−1,−1,−1,1,1,−1,1,−1,1,−1,−1,1,1,−1,−1,−1,−1,1,1,−1,−1,1,1,−1,−1,−1,−1,1,1,1,1,1,1,1,−1,1,−1,−1,−1,1,1,1,1,1,−1,−1,1,−1,1,1,1,1,−1,−1,−1,−1,−1,−1,1,1,1,−1,1,1,−1,−1,1,1,−1,1,−1,−1,1,1,−1,1,−1,−1,1,1,1,−1,1,−1,−1,−1,−1,1,1,−1,−1,1,−1,−1,−1,−1,−1,−1,1,1,1,1,1,1,1,−1,−1,−1,−1,−1,1,−1,−1,−1,1,−1,1,1,−1,−1,1,1,1,−1,1,−1,1,−1,1,−1,−1,1,−1,−1,−1,1,1,1,1,1,1,−1,1,1,1,1,−1,1,1,−1,−1,1,−1,1,−1,1,−1,−1,−1,1,−1,1,−1,1,−1,1,1,1,−1,−1,−1,−1,−1,1,1,1,1,1,−1,−1,−1,−1,1,1,−1,1,1,1,−1,−1,1,−1,1,1,1,1,−1,−1,−1,−1,−1,−1,1,1,1,1,−1,1,−1,1,1,1,−1,1,1,−1,1,1,−1,1,1,1,−1,−1,−1,−1,1,−1,−1,−1,1,−1,−1,1,1,−1,−1,−1,−1,1,1,−1,1,1,−1,1,1,1,−1,−1,−1,−1,−1,1,1,1,−1,1,−1,1,−1,1,−1,−1,−1,1,−1,1,−1,1,1,1,−1,−1,−1,−1,1,1,1,−1,−1,−1,−1,−1,1,−1,−1,1,1,−1,−1,−1,1,−1,−1,1,1,1,−1,1,1,−1,1,1,1,1,−1,−1,−1,−1,−1,−1,1,−1,−1,1,1,−1,−1,−1,1,1,1,1,−1,1,1,−1,1,−1,−1,−1,1,−1,−1,1,1,−1,1,−1,−1,−1,1,1,1,1,−1,1,1,−1,1,1,−1,−1,1,−1,−1,1,−1,−1,−1,−1,−1,−1,1,1,−1,1,−1,−1,−1,0,0,0,0,0,1,1,1,−1,−1,−1,−1,1,1,−1,1,1,1,1,1,−1,1,−1,−1,−1,−1,−1,1,1,−1,−1,1,1,1,1,1,1,−1,−1,1,−1,−1,−1,1,1,1,−1,1,−1,1,−1,−1,1,−1,−1,1,−1,−1,1,1,1,−1,1,1,−1,−1,−1,−1,1,1,−1,−1,1,1,1,1,1,1,−1,−1,−1,−1,1,1,1,−1,−1,1,1,1,−1,1,1,−1,1,1,−1,−1,−1,−1,1,−1,−1,−1,−1,−1,−1,1,1,−1,−1,1,1,−1,1,1,−1,1,1,−1,1,1,−1,−1,−1,−1,1,1,−1,1,1,1,1,1,−1,1,1,−1,−1,−1,−1,−1,−1,1,−1,1,1,−1,1,1,−1,−1,−1,−1,−1,−1,1,1,1,1,1,−1,−1,1,−1,−1,1,−1,1,1,1,1,1,−1,−1,−1,1,1,1,−1,1,−1,1,−1,−1,−1,−1,−1,1,−1,1,−1,−1,1,1,1,−1,−1,−1,1,−1,1,1,1,−1,1,1,−1,1,1,−1,−1,−1,1,−1,1,1,1,1,1,−1,−1,1,−1,−1,1,1,1,−1,1,1,1,1,−1,−1,−1,1,−1,1,1,−1,1,−1,1,1,1,−1,1,−1,1,−1,1,−1,1,−1,−1,−1,1,1,−1,−1,−1,1,−1,−1,1,1,−1,1,−1,−1,−1,−1,1,1,1,1,1,−1,1,−1,1,−1,−1,1,−1,1,−1,−1,1,1,−1,1,−1,−1,−1,1,−1,−1,1,1,1,1,−1,−1,−1,−1,−1,1,−1,1,1,1,1,1,1,−1,1,−1,−1,−1,1,−1,1,1,1,−1,1,−1,−1,−1,1,−1,1,1,1,1,1,−1,−1,1,−1,−1,−1,1,−1,−1,1,−1,1,1,−1,−1,−1,1,−1,1,−1,−1,−1,1,−1,1,−1,−1,1,−1,1,−1,1,−1,1,1,1,−1,1,1,−1,−1,1,−1,1,1,−1,−1,1,1,−1,−1,1,1,−1,1,1,−1,−1,1,1,1,−1,−1,−1,−1,−1,−1,1,−1,1,1,−1,1,1,−1,−1,−1,−1,1,−1,1,1,−1,1,−1,1,−1,−1,1,1,1,1,−1,−1,1,1,−1,1,1,1,1,−1,−1,−1,−1,−1,1,1,1,−1,1,1,−1,−1,1,1,−1,1,1,−1,−1,−1,−1,−1,−1,−1,1,1,1,1,1,−1,−1,−1,1,−1,−1,−1,1,1,1,1,1,1,−1,1,−1,−1,−1,1,−1,−1,1,−1,−1,1,1,1,−1,1,−1,−1,−1,−1,−1,0,0,0,0,0,0,0,0,0,0,0}
For 80 MHz transmission, the N-TF sequence with the format of an HELTF80, optimized for estimation order P=6, is given by:
N-TF(HELTF80,P=6)=sqrt(1024/996)·{0,0,0,0,0,0,0,0,0,0,0,0,−1,1,−1,−1,1,1,1,−1,−1,1,1,1,−1,1,1,1,−1,−1,1,−1,−1,−1,1,−1,−1,1,−1,1,1,1,−1,−1,1,−1,1,1,1,−1,−1,1,−1,1,1,−1,−1,1,−1,−1,−1,1,−1,1,−1,−1,−1,−1,−1,−1,−1,−1,−1,−1,−1,−1,1,−1,1,−1,−1,−1,1,1,−1,1,1,−1,1,1,1,−1,1,1,−1,1,1,1,1,1,1,1,1,−1,1,1,−1,−1,1,−1,−1,−1,−1,1,−1,1,−1,−1,1,1,−1,−1,−1,−1,1,−1,−1,−1,−1,−1,1,1,1,−1,−1,1,1,−1,−1,−1,−1,−1,−1,1,1,−1,−1,1,−1,1,−1,−1,1,−1,−1,1,1,1,−1,1,1,1,−1,−1,1,−1,−1,1,1,1,1,−1,1,1,−1,−1,−1,1,−1,1,−1,−1,−1,−1,1,−1,−1,−1,−1,1,−1,1,−1,−1,−1,1,1,1,1,−1,1,−1,1,1,1,1,1,−1,−1,−1,−1,−1,−1,1,−1,1,1,1,1,−1,−1,1,1,−1,1,−1,−1,−1,1,−1,1,1,1,1,1,1,1,1,1,−1,−1,−1,1,1,−1,−1,1,−1,−1,−1,1,1,−1,1,−1,−1,−1,−1,−1,−1,1,−1,1,1,1,1,1,1,−1,−1,1,−1,1,1,1,−1,1,1,1,1,1,−1,−1,1,−1,−1,−1,−1,−1,1,−1,−1,1,1,−1,−1,−1,1,1,−1,−1,1,−1,1,−1,1,1,−1,−1,1,−1,1,1,1,1,1,1,−1,1,−1,1,1,1,1,−1,1,−1,1,1,−1,−1,−1,−1,1,−1,1,1,1,1,−1,1,1,−1,−1,1,−1,1,−1,1,1,−1,1,1,1,1,1,−1,1,1,1,−1,−1,−1,1,−1,−1,−1,−1,−1,−1,1,1,1,−1,−1,−1,1,−1,−1,−1 . . . 1,−1,1,1,1,−1,1,1,−1,−1,1,1,1,1,−1,1,1,1,−1,1,1,1,−1,1,−1,−1,−1,−1,1,1,1,1,1,−1,1,1,1,1,−1,−1,1,1,1,1,1,−1,−1,1,1,−1,1,−1,1,−1,1,−1,−1,−1,−1,−1,−1,1,−1,−1,1,−1,−1,−1,−1,1,−1,1,−1,1,1,1,1,1,1,1,1,1,−1,1,−1,−1,−1,1,1,−1,1,−1,−1,1,1,−1,−1,−1,1,1,−1,−1,−1,1,−1,−1,−1,−1,−1,1,−1,−1,1,1,−1,1,−1,1,−1,1,1,1,1,1,−1,1,1,1,−1,−1,0,0,0,0,0,−1,1,−1,−1,1,1,1,1,−1,1,1,1,1,−1,−1,1,1,1,−1,−1,−1,−1,−1,−1,−1,−1,1,−1,−1,−1,−1,−1,1,−1,−1,−1,1,−1,1,1,1,1,1,−1,−1,1,1,−1,−1,1,−1,1,1,1,−1,1,−1,−1,1,1,−1,−1,−1,−1,1,−1,−1,1,−1,−1,1,−1,1,1,1,−1,−1,−1,1,−1,1,1,1,1,1,−1,−1,1,1,−1,−1,1,1,1,−1,1,1,1,1,−1,−1,1,−1,−1,1,1,−1,−1,1,−1,1,−1,−1,1,−1,1,−1,1,1,−1,1,1,1,1,1,−1,1,−1,1,−1,1,1,1,1,−1,−1,1,1,−1,1,−1,−1,1,−1,1,−1,−1,−1,1,1,−1,−1,−1,−1,1,1,−1,1,−1,−1,−1,1,1,−1,−1,−1,1,−1,1,1,1,−1,1,−1,1,−1,−1,−1,1,1,1,−1,−1,−1,−1,−1,1,−1,−1,−1,1,1,1,1,−1,−1,1,1,−1,1,1,−1,1,−1,1,1,1,1,−1,−1,−1,1,1,−1,1,−1,1,1,−1,−1,1,1,−1,1,1,−1,1,1,−1,−1,1,−1,−1,1,1,−1,1,1,1,1,−1,−1,−1,1,−1,−1,−1,1,−1,−1,−1,1,1,1,−1,1,−1,−1,−1,1,−1,1,1,−1,1,−1,1,1,−1,1,−1,1,1,−1,1,1,−1,−1,1,−1,−1,−1,1,1,−1,−1,−1,−1,1,−1,−1,1,1,−1,−1,−1,1,−1,1,1,−1,1,1,1,−1,1,−1,1,−1,1,1,−1,1,−1,1,1,−1,1,1,1,1,1,−1,−1,−1,−1,1,1,−1,−1,1,−1,−1,−1,−1,−1,1,−1,−1,−1,−1,−1,−1,1,1,1,1,1,1,1,1,1,1,1,−1,1,1,1,1,1,1,1,−1,−1,−1,−1,−1,−1,−1,1,−1,−1,1,−1,1,1,−1,1,−1,−1,−1,1,1,1,−1,1,−1,1,1,1,1,1,−1,−1,1,−1,−1,1,−1,−1,−1,1,−1,1,1,1,−1,1,−1,−1,1,1,1,1,1,−1,1,1,1,−1,1,1,−1,−1,1,−1,−1,1,1,−1,−1,−1,−1,1,−1,−1,1,1,−1,−1,−1,1,1,−1,1,1,1,1,1,−1,−1,1,−1,1,1,1,1,−1,−1,1,1,1,−1,1,−1,−1,−1,−1,−1,1,−1,−1,−1,1,−1,1,1,−1,−1,−1,−1,−1,−1,−1,−1,1,1,−1,1,−1,1,1,1,1,1,0,0,0,0,0,0,0,0,0,0,0}
For 80 MHz transmission, the N-TF sequence with the format of an HELTF80, optimized for estimation order P=7, is given by:
N-TF(HELTF80,P=7)=sqrt(1024/996)·{0,0,0,0,0,0,0,0,0,0,0,0,−1,−1,1,−1,−1,−1,1,−1,−1,1,−1,−1,1,−1,−1,1,−1,1,−1,−1,−1,1,1,1,−1,−1,−1,−1,−1,1,1,−1,1,1,1,−1,1,−1,1,−1,−1,1,−1,−1,−1,−1,−1,−1,−1,1,1,1,1,−1,1,1,1,1,1,1,−1,1,1,1,−1,1,1,1,−1,−1,1,1,−1,−1,−1,−1,1,−1,−1,1,1,1,−1,−1,−1,1,−1,−1,1,−1,−1,1,−1,−1,−1,−1,1,1,1,−1,−1,1,−1,−1,−1,1,−1,−1,1,1,1,−1,1,1,−1,−1,−1,−1,1,−1,−1,1,1,1,1,1,−1,1,1,1,1,−1,−1,1,−1,−1,−1,−1,1,−1,1,−1,1,1,−1,−1,1,1,−1,−1,1,−1,−1,−1,−1,1,−1,−1,1,−1,1,−1,−1,−1,−1,1,1,1,1,−1,1,1,1,1,1,1,−1,−1,1,−1,1,1,1,−1,−1,−1,1,1,−1,−1,−1,−1,1,−1,1,1,−1,1,−1,−1,−1,−1,−1,−1,1,−1,1,−1,−1,1,1,1,1,−1,−1,−1,−1,−1,−1,−1,−1,−1,1,−1,1,1,1,−1,1,−1,1,−1,1,1,1,−1,1,1,1,1,−1,1,1,−1,−1,−1,1,−1,−1,1,−1,−1,−1,−1,−1,−1,−1,−1,1,1,−1,−1,1,−1,−1,−1,1,1,−1,−1,−1,−1,1,−1,1,−1,−1,1,1,−1,−1,1,−1,1,1,−1,1,1,1,−1,−1,1,−1,−1,−1,−1,1,−1,1,1,1,1,−1,−1,1,1,−1,−1,1,1,1,−1,−1,1,1,1,−1,−1,−1,−1,1,−1,1,1,1,−1,1,−1,1,1,1,−1,−1,1,−1,−1,1,−1,1,−1,−1,1,1,1,−1,−1,−1,1,−1,−1,−1,1,1,−1,−1,−1,−1,−1,1,1,−1,−1,−1,−1,−1,−1,1,1,−1,−1,−1,−1,1,1,1,1,−1,1,1,−1,1,−1,1,−1,1,1,−1,−1,−1,−1,1,1,1,−1,−1,−1,1,1,−1,−1,1,−1,−1,−1,−1,−1,1,−1,1,−1,1,1,−1,−1,−1,1,−1,1,−1,1,−1,1,−1,1,−1,−1,−1,−1,−1,1,−1,1,1,1,1,1,−1,1,1,−1,1,−1,−1,−1,−1,−1,1,1,−1,1,−1,1,−1,−1,1,−1,−1,−1,1,1,−1,−1,1,1,1,−1,−1,−1,−1,−1,1,1,1,1,1,−1,−1,1,1,1,−1,−1,1,1,1,−1,1,1,1,−1,−1,−1,−1,−1,1,−1,1,−1,0,0,0,0,0,1,1,−1,1,−1,−1,1,−1,−1,1,−1,1,−1,−1,−1,1,−1,−1,1,−1,1,1,−1,1,1,−1,1,−1,1,1,−1,1,−1,−1,−1,−1,−1,−1,1,1,−1,−1,−1,−1,−1,1,1,−1,1,1,−1,1,1,−1,−1,1,1,−1,−1,−1,1,−1,−1,1,−1,−1,−1,−1,−1,−1,1,1,1,1,−1,1,1,−1,1,1,−1,−1,1,1,−1,1,−1,−1,1,1,−1,−1,−1,1,−1,−1,−1,1,−1,−1,1,1,−1,−1,−1,−1,1,−1,−1,1,−1,−1,−1,−1,−1,1,−1,−1,−1,1,−1,1,1,−1,−1,−1,1,−1,−1,1,−1,1,1,1,−1,−1,−1,−1,1,1,−1,−1,−1,−1,1,1,1,1,1,−1,−1,−1,−1,−1,−1,−1,1,−1,−1,−1,−1,−1,−1,1,1,−1,−1,−1,−1,−1,−1,1,−1,−1,−1,1,1,1,−1,−1,1,1,−1,−1,−1,−1,−1,1,1,1,−1,−1,−1,−1,−1,−1,1,1,−1,1,−1,1,−1,1,1,1,1,−1,−1,1,−1,−1,−1,1,−1,−1,−1,−1,−1,1,−1,1,−1,−1,1,1,−1,−1,−1,−1,−1,1,−1,−1,−1,−1,1,1,1,−1,−1,−1,−1,−1,−1,1,1,−1,1,−1,−1,1,1,−1,−1,1,−1,−1,−1,−1,−1,1,−1,1,−1,1,−1,−1,1,1,−1,1,−1,−1,1,1,−1,−1,−1,−1,−1,1,1,1,−1,1,−1,−1,1,−1,1,−1,1,−1,−1,−1,1,1,−1,1,1,−1,1,1,−1,1,1,1,1,−1,1,−1,−1,1,1,−1,1,−1,1,−1,1,−1,−1,1,−1,1,−1,−1,−1,−1,−1,1,−1,−1,−1,−1,−1,−1,−1,−1,1,−1,1,−1,1,1,1,−1,−1,−1,1,1,1,−1,1,1,−1,1,1,−1,−1,−1,−1,1,1,−1,−1,1,1,1,−1,−1,1,1,1,1,−1,−1,1,1,−1,1,1,−1,−1,−1,1,1,−1,1,−1,1,1,−1,−1,−1,1,1,−1,−1,1,1,1,−1,−1,−1,1,1,−1,1,−1,−1,−1,1,−1,−1,−1,1,1,−1,−1,−1,1,−1,−1,−1,1,−1,−1,1,−1,−1,−1,−1,1,−1,−1,−1,1,−1,−1,1,−1,−1,1,−1,1,−1,1,−1,1,−1,1,−1,1,−1,1,1,−1,1,−1,−1,−1,1,1,−1,−1,−1,1,−1,−1,−1,1,−1,1,−1,1,−1,1,−1,1,1,1,−1,1,−1,−1,−1,1,1,1,1,−1,1,−1,1,1,−1,0,0,0,0,0,0,0,0,0,0,0}
For 80 MHz transmission, the N-TF sequence with the format of an HELTF80, optimized for estimation order P=8, is given by:
N-TF(HELTF80,P=8)=sqrt(1024/996)·{0,0,0,0,0,0,0,0,0,0,0,0,−1,−1,−1,−1,−1,−1,−1,1,1,1,−1,1,1,−1,1,−1,1,1,1,1,1,1,−1,1,1,1,1,1,−1,1,−1,−1,−1,−1,1,1,−1,−1,1,1,1,−1,−1,−1,−1,1,1,−1,1,−1,1,1,−1,1,1,1,1,1,−1,1,1,−1,1,−1,1,1,1,1,−1,1,1,−1,1,−1,−1,1,−1,1,−1,−1,−1,−1,−1,1,1,−1,1,1,−1,−1,−1,1,1,1,−1,1,1,−1,1,1,1,1,1,−1,1,−1,1,−1,1,1,1,1,−1,1,1,1,1,1,−1,1,1,−1,−1,1,−1,−1,1,−1,1,1,1,1,1,1,−1,−1,1,1,−1,1,−1,1,−1,1,1,1,1,−1,−1,−1,1,1,−1,1,1,−1,1,−1,−1,1,−1,1,1,1,1,1,1,−1,−1,1,−1,−1,1,−1,1,1,−1,1,1,−1,1,−1,1,1,−1,−1,1,1,1,1,−1,−1,−1,1,−1,1,−1,−1,1,1,1,−1,1,1,1,−1,1,1,−1,1,−1,−1,1,−1,1,−1,−1,−1,−1,1,1,−1,1,1,−1,1,1,−1,1,1,1,−1,−1,1,1,1,1,1,1,1,1,−1,1,−1,−1,1,−1,1,−1,1,1,1,−1,−1,1,1,−1,1,−1,−1,−1,1,−1,−1,1,−1,1,−1,−1,1,−1,1,−1,−1,1,1,−1,−1,1,−1,1,−1,−1,1,−1,−1,1,1,−1,−1,−1,1,−1,1,1,−1,1,−1,1,1,−1,−1,−1,−1,−1,−1,−1,1,1,−1,1,−1,1,−1,1,−1,−1,1,−1,−1,−1,−1,1,1,−1,1,−1,−1,1,1,−1,1,−1,−1,1,1,1,1,1,−1,1,−1,−1,−1,1,1,−1,−1,−1,1,1,1,1,−1,1,−1,−1,−1,1,1,1,−1,1,−1,−1,1,1,1,1,−1,1,1,1,1,1,1,−1,1,−1,−1,1,−1,1,1,−1,−1,1,1,1,1,−1,1,−1,1,1,−1,1,1,−1,−1,−1,1,1,1,1,1,−1,−1,1,−1,1,1,−1,1,1,1,−1,−1,1,−1,1,−1,−1,1,1,1,1,−1,−1,1,−1,1,1,1,1,−1,1,−1,1,1,−1,1,−1,1,−1,1,1,−1,1,1,1,−1,−1,1,−1,1,−1,1,1,−1,1,1,1,1,1,1,1,1,−1,1,1,1,1,−1,1,1,1,−1,1,1,1,−1,1,−1,1,1,1,−1,−1,1,1,1,−1,1,−1,1,1,0,0,0,0,0,1,1,1,1,1,1,−1,−1,−1,−1,1,−1,1,1,1,1,1,−1,−1,1,−1,−1,1,−1,1,1,1,−1,1,−1,1,1,1,−1,1,−1,1,−1,−1,−1,−1,1,−1,−1,1,−1,1,1,−1,1,1,−1,1,1,1,1,1,1,1,−1,1,1,1,1,−1,1,−1,−1,−1,−1,1,1,1,1,1,1,−1,−1,1,−1,−1,−1,1,1,−1,−1,−1,−1,1,1,1,1,−1,1,−1,1,−1,1,1,1,−1,1,−1,1,1,1,−1,1,−1,1,1,−1,−1,1,1,1,−1,−1,−1,1,−1,1,1,1,−1,1,−1,−1,−1,−1,−1,−1,−1,−1,1,−1,1,1,−1,−1,1,1,1,−1,1,1,−1,1,−1,1,1,−1,1,−1,−1,1,1,−1,1,−1,−1,−1,−1,−1,−1,−1,1,−1,1,−1,1,1,−1,−1,−1,−1,1,−1,1,1,−1,1,1,−1,−1,−1,1,1,1,1,−1,−1,1,1,1,−1,−1,1,1,1,1,1,1,1,1,−1,−1,1,1,1,1,−1,1,1,−1,−1,1,−1,1,1,1,−1,1,−1,1,−1,1,−1,1,−1,1,1,−1,1,1,−1,1,1,−1,1,1,1,1,−1,−1,1,1,1,−1,1,−1,−1,−1,−1,−1,1,−1,−1,1,−1,1,1,−1,1,1,−1,−1,−1,1,1,1,1,1,1,−1,−1,1,1,1,1,−1,1,1,1,1,1,1,−1,−1,1,−1,1,1,1,−1,−1,1,1,1,1,−1,1,−1,1,−1,1,1,1,1,1,1,−1,1,1,1,1,1,1,1,−1,1,1,1,−1,−1,1,−1,−1,1,1,1,1,−1,1,−1,−1,1,−1,−1,1,1,1,−1,−1,−1,−1,−1,−1,−1,1,1,1,1,−1,1,1,−1,1,1,−1,−1,1,1,1,1,−1,1,1,−1,−1,1,1,1,1,−1,−1,−1,1,−1,−1,−1,−1,1,−1,1,1,−1,1,1,−1,−1,−1,1,1,1,1,−1,1,1,−1,−1,−1,−1,−1,1,1,1,1,1,1,1,−1,1,−1,1,−1,−1,−1,1,1,1,−1,1,1,1,−1,−1,1,−1,1,−1,1,−1,−1,−1,−1,1,−1,1,1,−1,1,−1,−1,−1,−1,−1,−1,1,1,−1,1,−1,1,1,−1,1,1,−1,1,1,1,−1,1,−1,−1,1,1,−1,1,−1,1,1,−1,−1,−1,1,−1,1,−1,1,1,−1,1,1,−1,−1,1,1,−1,−1,1,−1,1,−1,1,1,1,0,0,0,0,0,0,0,0,0,0,0}
For 80 MHz transmission, the N-TF sequence with the format of an HELTF80, optimized for estimation order P=9, is given by:
N-TF(HELTF80,P=9)=sqrt(1024/996)·{0,0,0,0,0,0,0,0,0,0,0,0,−1,−1,−1,1,1,1,−1,1,1,−1,−1,1,−1,1,1,−1,−1,−1,1,1,1,1,−1,−1,1,−1,1,1,−1,1,−1,−1,1,1,1,1,−1,1,−1,1,1,1,−1,1,−1,−1,1,1,1,1,−1,1,−1,−1,1,1,1,−1,−1,1,1,−1,−1,−1,−1,−1,−1,−1,−1,1,−1,1,−1,−1,1,1,1,1,−1,1,1,−1,−1,1,1,−1,−1,−1,1,1,−1,1,−1,−1,−1,−1,1,1,−1,1,1,1,−1,1,1,1,1,1,−1,1,1,−1,1,−1,−1,1,1,−1,1,1,1,1,−1,1,−1,1,−1,1,−1,−1,1,1,1,−1,1,1,1,−1,1,1,−1,1,1,1,−1,1,−1,−1,−1,−1,−1,−1,−1,−1,−1,−1,1,1,−1,−1,1,1,−1,1,−1,−1,−1,1,−1,−1,−1,−1,1,1,1,1,1,−1,−1,−1,1,1,−1,−1,1,−1,1,1,1,1,−1,1,1,1,−1,1,1,−1,−1,−1,1,1,−1,1,1,1,1,1,1,−1,−1,1,−1,−1,−1,−1,1,−1,−1,1,−1,1,−1,1,−1,−1,1,−1,−1,1,−1,−1,1,1,1,−1,1,−1,−1,−1,−1,−1,1,−1,1,−1,−1,1,−1,1,−1,−1,−1,−1,1,1,1,1,1,1,1,−1,1,−1,1,1,−1,−1,1,1,1,1,1,1,1,1,−1,1,−1,1,−1,−1,−1,1,−1,1,1,−1,1,1,−1,−1,1,1,−1,−1,−1,1,−1,1,1,1,−1,1,−1,1,−1,1,1,1,−1,1,−1,1,−1,−1,1,1,−1,−1,1,1,1,−1,1,1,−1,1,1,1,−1,1,−1,1,1,−1,1,1,−1,1,−1,1,1,−1,−1,1,1,1,1,1,−1,1,1,−1,1,1,−1,1,−1,−1,−1,1,−1,1,−1,−1,−1,1,−1,1,1,−1,1,1,−1,−1,1,1,−1,−1,−1,−1,−1,−1,1,1,−1,−1,−1,−1,−1,−1,−1,1,−1,−1,1,1,1,1,1,−1,1,−1,−1,1,−1,1,1,1,1,1,1,1,−1,1,−1,1,−1,−1,1,1,1,−1,1,1,−1,1,1,1,−1,−1,−1,1,1,−1,1,1,1,1,1,−1,−1,1,1,−1,−1,1,1,1,−1,−1,−1,1,1,−1,−1,1,1,1,−1,−1,−1,−1,1,−1,1,−1,1,1,−1,−1,−1,1,1,−1,−1,1,−1,1,1,1,1,−1,1,−1,−1,−1,−1,1,−1,−1,1,−1,1,−1,−1,1,0,0,0,0,0,−1,1,1,−1,1,1,1,1,−1,1,1,−1,1,1,−1,−1,−1,−1,1,−1,1,−1,1,1,1,−1,1,1,−1,1,−1,1,1,−1,1,1,1,−1,−1,−1,−1,1,1,−1,1,1,−1,1,−1,1,1,−1,−1,−1,1,−1,1,1,−1,1,−1,1,−1,1,−1,1,−1,1,1,−1,−1,1,−1,−1,1,−1,1,1,1,1,−1,1,1,−1,−1,−1,−1,−1,−1,1,1,1,−1,1,1,1,−1,1,−1,1,−1,1,−1,−1,−1,1,1,1,−1,1,1,−1,−1,1,−1,−1,−1,1,1,1,1,−1,1,1,−1,1,1,−1,−1,−1,1,1,−1,1,−1,1,−1,−1,−1,−1,1,1,−1,1,−1,1,1,1,1,−1,−1,1,−1,1,−1,−1,−1,1,−1,1,1,1,1,−1,−1,−1,−1,1,−1,−1,−1,−1,1,1,−1,−1,−1,1,1,−1,−1,1,−1,1,−1,−1,1,1,−1,−1,1,−1,−1,−1,1,−1,−1,−1,−1,−1,−1,1,−1,1,1,1,1,1,−1,−1,−1,1,1,−1,1,1,1,1,−1,1,−1,−1,1,1,−1,1,1,−1,1,1,−1,1,−1,1,1,−1,−1,1,−1,−1,1,−1,−1,−1,−1,1,1,1,−1,1,1,1,−1,−1,−1,1,−1,1,1,1,1,−1,−1,−1,−1,−1,1,−1,−1,−1,1,1,−1,1,−1,1,−1,−1,1,1,−1,−1,1,−1,−1,−1,−1,1,−1,−1,−1,1,1,1,−1,1,−1,1,1,1,1,1,1,1,1,−1,1,−1,1,−1,−1,−1,−1,1,1,1,1,1,1,−1,−1,1,−1,1,1,−1,1,1,1,−1,1,−1,1,1,1,−1,−1,1,−1,1,−1,−1,1,−1,1,−1,1,−1,−1,−1,1,−1,−1,−1,−1,1,1,1,1,1,−1,−1,1,1,−1,−1,−1,1,1,1,1,1,1,1,−1,−1,−1,−1,1,−1,−1,−1,−1,1,1,1,1,1,−1,1,1,1,−1,1,−1,1,1,−1,1,−1,1,1,−1,1,−1,1,−1,−1,−1,−1,−1,1,−1,1,1,1,1,−1,1,1,−1,−1,−1,−1,1,−1,1,−1,1,1,−1,1,−1,1,−1,1,1,−1,−1,1,1,1,−1,−1,1,−1,−1,1,1,−1,−1,−1,−1,1,−1,1,1,−1,1,1,1,−1,−1,−1,1,−1,1,−1,−1,1,−1,1,1,−1,1,−1,−1,1,−1,1,−1,1,−1,1,−1,−1,1,1,−1,1,1,−1,−1,−1,−1,1,−1,0,0,0,0,0,0,0,0,0,0,0}
For 80 MHz transmission, the N-TF sequence with the format of an HELTF80, optimized for estimation order P=10, is given by:
N-TF(HELTF80,P=10)=sqrt(1024/996)·{0,0,0,0,0,0,0,0,0,0,0,0,−1,1,−1,1,−1,1,−1,−1,−1,1,1,1,1,−1,−1,1,−1,−1,1,1,−1,−1,−1,1,−1,−1,−1,−1,1, 1,−1,−1,−1,−1,−1,−1,−1,−1,−1,1,1,−1,1,1,−1,1,−1,−1,1,−1,1,−1,1,1,−1,−1,−1,1,−1,1,−1,1,1,−1,−1,1,−1,−1,1,−1,−1,−1,1,−1,−1,−1,−1,1,1,1,1,1,1,1,1,−1,1,−1,−1,−1,−1,−1,−1,−1,−1,−1,1,1,−1,1,−1,1,1,1,−1,−1,1,−1,−1,−1,1,−1,−1,1,−1,−1,−1,1,−1,1,1,1,1,−1,−1,−1,−1,1,1,−1,1,1,−1,−1,1,−1,−1,−1,−1,−1,1,1,−1,−1,−1,−1,−1,−1,1,−1,−1,1,−1,−1,−1,1,−1,−1,1,1,1,1,1,−1,−1,−1,−1,−1,1,1,−1,−1,1,−1,−1,−1,1,−1,−1,1,−1,1,1,−1,−1,−1,−1,−1,−1,1,1,1,−1,1,−1,1,−1,1,−1,−1,1,1,1,−1,−1,−1,−1,−1,−1,1,1,−1,−1,−1,1,−1,−1,−1,1,1,1,−1,1,1,−1,−1,1,−1,1,−1,−1,−1,1,−1,−1,1,1,−1,1,1,1,−1,−1,−1,−1,−1,−1,1,−1,−1,1,1,−1,1,−1,−1,1,1,1,1,−1,1,−1,−1,1,1,−1,−1,−1,−1,1,1,1,1,1,−1,1,1,−1,−1,1,1,−1,−1,1,−1,−1,−1,−1,−1,1,1,1,−1,1,−1,−1,1,1,1,−1,1,−1,−1,1,−1,1,−1,−1,−1,1,1,−1,−1,1,1,−1,1,−1,−1,1,−1,−1,1,−1,1,−1,1,−1,1,1,1,1,−1,−1,−1,1,−1,−1,1,−1,−1,−1,−1,1,−1,1,1,1,1,−1,1,−1,1,−1,1,1,1,−1,1,1,−1,−1,1,1,1,1,1,1,1,−1,−1,1,−1,1,−1,1,1,−1,1,1,1,−1,−1,−1,−1,1,−1,−1,1,−1,−1,1,−1,−1,1,−1,−1,−1,1,1,1,1,1,1,−1,1,−1,1,−1,−1,1,−1,−1,1,−1,−1,1,1,1,−1,−1,−1,−1,−1,−1,−1,1,−1,−1,1,1,−1,1,1,1,−1,−1,1,1,1,−1,−1,−1,−1,1,−1,1,1,1,−1,1,1,1,1,1,−1,−1,1,−1,−1,1,1,−1,−1,1,−1,1,1,1,1,−1,1,−1,−1,1,1,−1,1,1,−1,−1,−1,−1,−1,1,1,1,1,−1,−1,−1,1,−1,−1,−1,1,1,0,0,0,0,0,1,−1,−1,1,1,1,1,1,1,−1,−1,−1,−1,−1,1, 1,1,1,1,−1,−1,−1,1,1,1,−1,1,1,1,−1,−1,1,−1,1,−1,1,1,−1,1,1,−1,1,−1,1,1,1,−1,1,1,1,1,−1,−1,1,−1,−1,1,1,−1,−1,−1,−1,1,−1,1,1,−1,1,1,−1,1,−1,1,1,1,−1,1,−1,−1,1,1,1,−1,−1,1,1,1,1,1,1,1,1,1,−1,−1,−1,−1,−1,1,1,1,1,1,1,1,−1,1,−1,1,1,−1,−1,1,1,−1,−1,1,1,−1,−1,1,1,1,1,1,1,1,−1,−1,1,1,1,1,−1,1,−1,1,−1,1,−1,1,1,1,−1,1,−1,−1,1,−1,−1,1,−1,−1,1,1,1,−1,−1,−1,−1,1,−1,1,1,1,1,−1,1,1,1,1,−1,−1,−1,1,1,1,1,1,−1,1,−1,1,1,1,−1,−1,1,1,−1,1,1,1,−1,−1,1,−1,1,−1,1,1,−1,−1,−1,−1,−1,−1,1,1,1,1,1,−1,1,1,1,−1,1,−1,1,−1,1,1,−1,1,−1,1,−1,1,1,1,−1,1,1,−1,−1,−1,−1,1,−1,1,1,1,1,−1,−1,−1,−1,−1,1,1,−1,1,−1,1,−1,1,−1,−1,1,−1,−1,−1,1,−1,−1,1,−1,−1,1,1,−1,−1,1,1,1,−1,−1,1,1,1,1,1,1,1,1,−1,1,1,−1,−1,−1,1,−1,1,−1,−1,1,−1,1,−1,1,−1,1,−1,−1,1,−1,1,−1,−1,1,−1,1,−1,1,−1,1,1,1,1,1,−1,−1,−1,−1,−1,−1,1,−1,1,1,1,−1,−1,1,−1,1,−1,1,−1,1,1,−1,−1,−1,−1,1,1,1,−1,1,1,1,−1,−1,−1,1,1,1,−1,−1,1,1,−1,1,1,−1,−1,1,−1,−1,−1,−1,1,1,−1,−1,−1,1,−1,1,1,−1,−1,1,1,1,−1,−1,−1,1,1,−1,−1,−1,−1,−1,−1,−1,1,−1,1,1,−1,−1,−1,−1,−1,1,−1,−1,1,−1,−1,−1,−1,−1,−1,1,1,1,1,1,1,1,1,1,−1,1,1,−1,−1,1,−1,−1,−1,1,1,−1,−1,1,−1,1,−1,−1,−1,1,−1,1,1,1,−1,−1,1,1,−1,1,1,1,1,−1,1,−1,1,−1,1,−1,−1,1,1,−1,−1,−1,1,1,−1,−1,1,−1,−1,−1,1,−1,−1,−1,1,1,1,−1,−1,−1,1,−1,−1,0,0,0,0,0,0,0,0,0,0,0}
List21
For 160 MHz transmission, the N-TF sequence with the format of an HESTF160, optimized for estimation order P=3, is given by:
N-TF(HESTF160,P=3)=sqrt(2048/124)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0}
For 160 MHz transmission, the N-TF sequence with the format of an HESTF160, optimized for estimation order P=4, is given by:
N-TF(HESTF160,P=4)=sqrt(2048/124)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0}
For 160 MHz transmission, the N-TF sequence with the format of an HESTF160, optimized for estimation order P=5, is given by:
N-TF(HESTF160,P=5)=sqrt(2048/124)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0, 0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,1,0,0,0,0,0,0,0,0,0,0 ,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0}
For 160 MHz transmission, the N-TF sequence with the format of an HESTF160, optimized for estimation order P=6, is given by:
N-TF(HESTF160,P=6)=sqrt(2048/124)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0}
For 160 MHz transmission, the N-TF sequence with the format of an HESTF160, optimized for estimation order P=7, is given by:
N-TF(HESTF160,P=7)=sqrt(2048/124)·{0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0}
For 160 MHz transmission, the N-TF sequence with the format of an HESTF160, optimized for estimation order P=8, is given by:
N-TF(HESTF160,P=8)=sqrt(2048/124)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0}
For 160 MHz transmission, the N-TF sequence with the format of an HESTF160, optimized for estimation order P=9, is given by:
N-TF(HESTF160,P=9)=sqrt(2048/124)·{0,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0}
For 160 MHz transmission, the N-TF sequence with the format of an HESTF160, optimized for estimation order P=10, is given by:
N-TF(HESTF160,P=10)=sqrt(2048/124)·{0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0 ,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,−1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0,1,0,0,0,0,0,0,0,0,0,0,0,0,0,0,0}
List22
For 160 MHz transmission, the N-TF sequence with the format of an HELTF1X160, optimized for estimation order P=3, is given by:
N-TF(HELTF1X160,P=3)=sqrt(2048/500)·{0,0,0,0,0,0,0,0,0,0,0,0,−1,0,0,0,−1,0,0,0,1,0,0,0,−1,0,0,0,−1,0,0,0,1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,−1,0,0,0,−1,0,0,0,1,0,0,0,−1,0,0,0,−1,0,0,0,−1,0,0,0,−1,0,0,0,1,0,0,0,−1,0,0,0,1,0,0,0,−1,0,0,0,−1,0,0,0,1,0,0,0,−1,0,0,0,−1,0,0,0,1,0,0,0,−1,0,0,0,1,0,0,0,−1,0,0,0,−1,0,0,0,1,0,0,0,−1,0,0,0,1,0,0,0,−1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,1,0,0,0,−1,0,0,0,−1,0,0,0,−1,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,1,0,0,0,1,0,0,0,−1,0,0,0,1,0,0,0,1,0,0,0,−1,0,0,0,1,0,0,0,−1,0,0,0,−1,0,0,0,−1,0,0,0,1,0,0,0,1,0,0,0,−1,0,0,0,−1,0,0,0,1,0,0,0,−1,0,0,0,0,0,0,0,−1,0,0,0,−1,0,0,0,−1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,1,0,0,0,−1,0,0,0,1,0,0,0,−1,0,0,0,−1,0,0,0,−1,0,0,0,1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,−1,0,0,0,−1,0,0,0,1,0,0,0,−1,0,0,0,1,0,0,0,−1,0,0,0,−1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,1,0,0,0,−1,0,0,0,1,0,0,0,1,0,0,0,−1,0,0,0,−1,0,0,0,1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,1,0,0,0,−1,0,0,0,−1,0,0,0,1,0,0,0,1,0,0,0,1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,1,0,0,0,0,0,0,0,0,0,0,0,0,0,0,0,0,0,0,0,0,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,−1,0,0,0,1,0,0,0,−1,0,0,0,−1,0,0,0,1,0,0,0,−1,0,0,0,−1,0,0,0,−1,0,0,0,1,0,0,0,1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,−1,0,0,0,1,0,0,0,1,0,0,0,−1,0,0,0,−1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,−1,0,0,0,−1,0,0,0,1,0,0,0,−1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,1,0,0,0,1,0,0,0,−1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,1,0,0,0,−1,0,0,0,−1,0,0,0,−1,0,0,0,1,0,0,0,1,0,0,0,−1,0,0,0,1,0,0,0,1,0,0,0,−1,0,0,0,1,0,0,0,−1,0,0,0,−1,0,0,0,1,0,0,0,−1,0,0,0,1,0,0,0,−1,0,0,0,1,0,0,0,1,0,0,0,1,0,0,0,1,0,0,0,−1,0,0,0,−1,0,0,0,−1,0,0,0,0,0,0,0,1,0,0,0,1,0,0,0,−1,0,0,0,1,0,0,0,1,0,0,0,1,0,0,0,−1,0,0,0,1,0,0,0,−1,0,0,0,−1,0,0,0,−1,0,0,0,−1,0,0,0,−1,0,0,0,−1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,1,0,0,0,1,0,0,0,1,0,0,0,−1,0,0,0,1,0,0,0,1,0,0,0,1,0,0,0,−1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,−1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,1,0,0,0,−1,0,0,0,−1,0,0,0,1,0,0,0,−1,0,0,0,−1,0,0,0,−1,0,0,0,1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,−1,0,0,0,1,0,0,0,−1,0,0,0,1,0,0,0,0,0,0,0,0,0,0,0}
For 160 MHz transmission, the N-TF sequence with the format of an HELTF1X160, optimized for estimation order P=4, is given by:
N-TF(HELTF1X160,P=4)=sqrt(2048/500)·{0,0,0,0,0,0,0,0,0,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,−1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,1,0,0,0,−1,0,0,0,1,0,0,0,−1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,−1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,−1,0,0,0,−1,0,0,0,−1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,1,0,0,0,1,0,0,0,−1,0,0,0,−1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,0,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,1,0,0,0,1,0,0,0,−1,0,0,0,−1,0,0,0,1,0,0,0,1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,1,0,0,0,1,0,0,0,−1,0,0,0,1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,1,0,0,0,1,0,0,0,−1,0,0,0,−1,0,0,0,−1,0,0,0,1,0,0,0,−1,0,0,0,−1,0,0,0,1,0,0,0,1,0,0,0,1,0,0,0,1,0,0,0,1,0,0,0,1,0,0,0,1,0,0,0,−1,0,0,0,−1,0,0,0,1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,−1,0,0,0,1,0,0,0,−1,0,0,0,1,0,0,0,1,0,0,0,−1,0,0,0,−1,0,0,0,1,0,0,0,−1,0,0,0,−1,0,0,0,−1,0,0,0,−1,0,0,0,1,0,0,0,−1,0,0,0,1,0,0,0,−1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,−1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,0,0,0,0,0,0,0,0,0,0,0,0,0,0,0,0,0,0,0,0,−1,0,0,0,1,0,0,0,1,0,0,0,−1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,−1,0,0,0,−1,0,0,0,1,0,0,0,1,0,0,0,−1,0,0,0,1,0,0,0,1,0,0,0,1,0,0,0,−1,0,0,0,−1,0,0,0,1,0,0,0,1,0,0,0,−1,0,0,0,−1,0,0,0,1,0,0,0,1,0,0,0,1,0,0,0,−1,0,0,0,−1,0,0,0,1,0,0,0,−1,0,0,0,−1,0,0,0,1,0,0,0,−1,0,0,0,−1,0,0,0,−1,0,0,0,1,0,0,0,1,0,0,0,1,0,0,0,−1,0,0,0,1,0,0,0,1,0,0,0,−1,0,0,0,1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,1,0,0,0,−1,0,0,0,−1,0,0,0,−1,0,0,0,−1,0,0,0,1,0,0,0,−1,0,0,0,1,0,0,0,1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,1,0,0,0,1,0,0,0,−1,0,0,0,1,0,0,0,−1,0,0,0,−1,0,0,0,−1,0,0,0,−1,0,0,0,1,0,0,0,−1,0,0,0,−1,0,0,0,1,0,0,0,−1,0,0,0,1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,−1,0,0,0,−1,0,0,0,0,0,0,0,−1,0,0,0,1,0,0,0,−1,0,0,0,1,0,0,0,−1,0,0,0,1,0,0,0,1,0,0,0,−1,0,0,0,−1,0,0,0,−1,0,0,0,1,0,0,0,1,0,0,0,−1,0,0,0,1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,−1,0,0,0,1,0,0,0,−1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,1,0,0,0,1,0,0,0,−1,0,0,0,−1,0,0,0,1,0,0,0,−1,0,0,0,−1,0,0,0,−1,0,0,0,1,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,−1,0,0,0,−1,0,0,0,1,0,0,0,1,0,0,0,1,0,0,0,−1,0,0,0,−1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,−1,0,0,0,−1,0,0,0,−1,0,0,0,−1,0,0,0,1,0,0,0,−1,0,0,0,−1,0,0,0,−1,0,0,0,1,0,0,0,1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,−1,0,0,0,0,0,0,0,0,0,0,0}
For 160 MHz transmission, the N-TF sequence with the format of an HELTF1X160, optimized for estimation order P=5, is given by:
N-TF(HELTF1X160,P=5)=sqrt(2048/500)·{0,0,0,0,0,0,0,0,0,0,0,0,−1,0,0,0,−1,0,0,0,1,0,0,0,1,0,0,0,−1,0,0,0,1,0,0,0,−1,0,0,0,1,0,0,0,−1,0,0,0,1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,1,0,0,0,−1,0,0,0,1,0,0,0,−1,0,0,0,1,0,0,0,1,0,0,0,−1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,−1,0,0,0,1,0,0,0,−1,0,0,0,1,0,0,0,−1,0,0,0,1,0,0,0,1,0,0,0,1,0,0,0,1,0,0,0,−1,0,0,0,1,0,0,0,1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,1,0,0,0,1,0,0,0,−1,0,0,0,−1,0,0,0,1,0,0,0,−1,0,0,0,1,0,0,0,−1,0,0,0,−1,0,0,0,−1,0,0,0,1,0,0,0,1,0,0,0,1,0,0,0,1,0,0,0,−1,0,0,0,−1,0,0,0,1,0,0,0,−1,0,0,0,1,0,0,0,1,0,0,0,−1,0,0,0,−1,0,0,0,−1,0,0,0,1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,−1,0,0,0,1,0,0,0,1,0,0,0,−1,0,0,0,−1,0,0,0,−1,0,0,0,−1,0,0,0,1,0,0,0,−1,0,0,0,−1,0,0,0,−1,0,0,0,−1,0,0,0,1,0,0,0,−1,0,0,0,0,0,0,0,1,0,0,0,1,0,0,0,−1,0,0,0,1,0,0,0,−1,0,0,0,1,0,0,0,1,0,0,0,−1,0,0,0,1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,1,0,0,0,−1,0,0,0,−1,0,0,0,1,0,0,0,1,0,0,0,−1,0,0,0,1,0,0,0,−1,0,0,0,−1,0,0,0,1,0,0,0,−1,0,0,0,1,0,0,0,1,0,0,0,−1,0,0,0,1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,0,0,0,0,0,0,0,0,0,0,0,0,0,0,0,0,0,0,0,0,−1,0,0,0,1,0,0,0,−1,0,0,0,−1,0,0,0,−1,0,0,0,−1,0,0,0,−1,0,0,0,1,0,0,0,1,0,0,0,−1,0,0,0,1,0,0,0,1,0,0,0,−1,0,0,0,1,0,0,0,−1,0,0,0,−1,0,0,0,1,0,0,0,−1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,1,0,0,0,−1,0,0,0,1,0,0,0,−1,0,0,0,−1,0,0,0,1,0,0,0,−1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,−1,0,0,0,−1,0,0,0,1,0,0,0,−1,0,0,0,1,0,0,0,1,0,0,0,1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,1,0,0,0,−1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,−1,0,0,0,1,0,0,0,−1,0,0,0,1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,1,0,0,0,−1,0,0,0,0,0,0,0,−1,0,0,0,1,0,0,0,−1,0,0,0,−1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,1,0,0,0,1,0,0,0,1,0,0,0,−1,0,0,0,1,0,0,0,1,0,0,0,−1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,1,0,0,0,1,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,−1,0,0,0,1,0,0,0,1,0,0,0,1,0,0,0,−1,0,0,0,1,0,0,0,−1,0,0,0,1,0,0,0,1,0,0,0,−1,0,0,0,1,0,0,0,1,0,0,0,−1,0,0,0,1,0,0,0,1,0,0,0,−1,0,0,0,−1,0,0,0,1,0,0,0,−1,0,0,0,−1,0,0,0,1,0,0,0,−1,0,0,0,−1,0,0,0,1,0,0,0,−1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,1,0,0,0,1,0,0,0,−1,0,0,0,1,0,0,0,−1,0,0,0,−1,0,0,0,1,0,0,0,−1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,−1,0,0,0,1,0,0,0,−1,0,0,0,0,0,0,0,0,0,0,0}
For 160 MHz transmission, the N-TF sequence with the format of an HELTF1X160, optimized for estimation order P=6, is given by:
N-TF(HELTF1X160,P=6)=sqrt(2048/500)·{0,0,0,0,0,0,0,0,0,0,0,0,−1,0,0,0,1,0,0,0,1,0,0,0,−1,0,0,0,−1,0,0,0,1,0,0,0,−1,0,0,0,−1,0,0,0,1,0,0,0,−1,0,0,0,−1,0,0,0,1,0,0,0,−1,0,0,0,1,0,0,0,−1,0,0,0,−1,0,0,0,1,0,0,0,1,0,0,0,−1,0,0,0,−1,0,0,0,1,0,0,0,−1,0,0,0,−1,0,0,0,−1,0,0,0,−1,0,0,0,1,0,0,0,−1,0,0,0,1,0,0,0,1,0,0,0,−1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,−1,0,0,0,1,0,0,0,−1,0,0,0,−1,0,0,0,1,0,0,0,1,0,0,0,−1,0,0,0,1,0,0,0,1,0,0,0,−1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,1,0,0,0,−1,0,0,0,−1,0,0,0,1,0,0,0,−1,0,0,0,1,0,0,0,−1,0,0,0,1,0,0,0,−1,0,0,0,1,0,0,0,−1,0,0,0,0,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,−1,0,0,0,−1,0,0,0,1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,1,0,0,0,−1,0,0,0,−1,0,0,0,1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,1,0,0,0,1,0,0,0,−1,0,0,0,−1,0,0,0,1,0,0,0,1,0,0,0,−1,0,0,0,−1,0,0,0,−1,0,0,0,1,0,0,0,1,0,0,0,−1,0,0,0,−1,0,0,0,1,0,0,0,−1,0,0,0,−1,0,0,0,−1,0,0,0,−1,0,0,0,−1,0,0,0,1,0,0,0,−1,0,0,0,−1,0,0,0,1,0,0,0,1,0,0,0,1,0,0,0,−1,0,0,0,1,0,0,0,1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,1,0,0,0,−1,0,0,0,1,0,0,0,−1,0,0,0,−1,0,0,0,−1,0,0,0,1,0,0,0,−1,0,0,0,−1,0,0,0,1,0,0,0,1,0,0,0,−1,0,0,0,−1,0,0,0,−1,0,0,0,1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,1,0,0,0,−1,0,0,0,−1,0,0,0,0,0,0,0,0,0,0,0,0,0,0,0,0,0,0,0,0,0,0,0,1,0,0,0,−1,0,0,0,1,0,0,0,−1,0,0,0,−1,0,0,0,1,0,0,0,−1,0,0,0,−1,0,0,0,1,0,0,0,−1,0,0,0,−1,0,0,0,1,0,0,0,1,0,0,0,−1,0,0,0,−1,0,0,0,−1,0,0,0,−1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,−1,0,0,0,−1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,1,0,0,0,−1,0,0,0,−1,0,0,0,−1,0,0,0,1,0,0,0,−1,0,0,0,1,0,0,0,1,0,0,0,−1,0,0,0,−1,0,0,0,1,0,0,0,−1,0,0,0,−1,0,0,0,−1,0,0,0,−1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,−1,0,0,0,1,0,0,0,−1,0,0,0,−1,0,0,0,−1,0,0,0,−1,0,0,0,1,0,0,0,1,0,0,0,−1,0,0,0,−1,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,−1,0,0,0,−1,0,0,0,−1,0,0,0,−1,0,0,0,−1,0,0,0,−1,0,0,0,1,0,0,0,0,0,0,0,−1,0,0,0,−1,0,0,0,1,0,0,0,−1,0,0,0,1,0,0,0,−1,0,0,0,−1,0,0,0,1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,1,0,0,0,−1,0,0,0,1,0,0,0,1,0,0,0,−1,0,0,0,1,0,0,0,−1,0,0,0,1,0,0,0,−1,0,0,0,−1,0,0,0,1,0,0,0,1,0,0,0,−1,0,0,0,1,0,0,0,−1,0,0,0,−1,0,0,0,1,0,0,0,−1,0,0,0,−1,0,0,0,1,0,0,0,−1,0,0,0,−1,0,0,0,1,0,0,0,1,0,0,0,−1,0,0,0,−1,0,0,0,1,0,0,0,−1,0,0,0,−1,0,0,0,1,0,0,0,−1,0,0,0,−1,0,0,0,−1,0,0,0,−1,0,0,0,−1,0,0,0,1,0,0,0,−1,0,0,0,−1,0,0,0,1,0,0,0,−1,0,0,0,−1,0,0,0,−1,0,0,0,−1,0,0,0,−1,0,0,0,1,0,0,0,−1,0,0,0,−1,0,0,0,1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,−1,0,0,0,1,0,0,0,−1,0,0,0,−1,0,0,0,1,0,0,0,−1,0,0,0,−1,0,0,0,−1,0,0,0,−1,0,0,0,−1,0,0,0,1,0,0,0,−1,0,0,0,−1,0,0,0,1,0,0,0,1,0,0,0,−1,0,0,0,−1,0,0,0,1,0,0,0,1,0,0,0,−1,0,0,0,−1,0,0,0,1,0,0,0,−1,0,0,0,−1,0,0,0,1,0,0,0,−1,0,0,0,1,0,0,0,−1,0,0,0,−1,0,0,0,1,0,0,0,−1,0,0,0,−1,0,0,0,1,0,0,0,−1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,1,0,0,0,0,0,0,0,0,0,0,0}
For 160 MHz transmission, the N-TF sequence with the format of an HELTF1X160, optimized for estimation order P=7, is given by:
N-TF(HELTF1X160,P=7)=sqrt(2048/500)·{0,0,0,0,0,0,0,0,0,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,−1,0,0,0,1,0,0,0,−1,0,0,0,1,0,0,0,−1,0,0,0,−1,0,0,0,−1,0,0,0,−1,0,0,0,1,0,0,0,1,0,0,0,−1,0,0,0,1,0,0,0,1,0,0,0,1,0,0,0,1,0,0,0,1,0,0,0,−1,0,0,0,−1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,−1,0,0,0,1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,1,0,0,0,1,0,0,0,−1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,−1,0,0,0,1,0,0,0,−1,0,0,0,1,0,0,0,1,0,0,0,1,0,0,0,−1,0,0,0,1,0,0,0,−1,0,0,0,−1,0,0,0,1,0,0,0,1,0,0,0,−1,0,0,0,−1,0,0,0,−1,0,0,0,1,0,0,0,1,0,0,0,−1,0,0,0,1,0,0,0,1,0,0,0,−1,0,0,0,1,0,0,0,−1,0,0,0,−1,0,0,0,0,0,0,0,−1,0,0,0,1,0,0,0,1,0,0,0,1,0,0,0,1,0,0,0,1,0,0,0,−1,0,0,0,−1,0,0,0,1,0,0,0,−1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,−1,0,0,0,1,0,0,0,1,0,0,0,−1,0,0,0,−1,0,0,0,1,0,0,0,−1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,1,0,0,0,−1,0,0,0,1,0,0,0,1,0,0,0,−1,0,0,0,1,0,0,0,−1,0,0,0,1,0,0,0,1,0,0,0,−1,0,0,0,1,0,0,0,−1,0,0,0,1,0,0,0,1,0,0,0,−1,0,0,0,−1,0,0,0,−1,0,0,0,−1,0,0,0,1,0,0,0,−1,0,0,0,1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,−1,0,0,0,1,0,0,0,−1,0,0,0,−1,0,0,0,1,0,0,0,−1,0,0,0,1,0,0,0,−1,0,0,0,−1,0,0,0,−1,0,0,0,−1,0,0,0,1,0,0,0,1,0,0,0,−1,0,0,0,1,0,0,0,1,0,0,0,1,0,0,0,−1,0,0,0,−1,0,0,0,1,0,0,0,−1,0,0,0,−1,0,0,0,1,0,0,0,1,0,0,0,1,0,0,0,−1,0,0,0,−1,0,0,0,0,0,0,0,0,0,0,0,0,0,0,0,0,0,0,0,0,0,0,0,1,0,0,0,−1,0,0,0,1,0,0,0,−1,0,0,0,1,0,0,0,1,0,0,0,−1,0,0,0,1,0,0,0,1,0,0,0,−1,0,0,0,1,0,0,0,−1,0,0,0,1,0,0,0,1,0,0,0,−1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,−1,0,0,0,1,0,0,0,−1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,−1,0,0,0,1,0,0,0,1,0,0,0,1,0,0,0,1,0,0,0,−1,0,0,0,1,0,0,0,1,0,0,0,−1,0,0,0,1,0,0,0,−1,0,0,0,1,0,0,0,1,0,0,0,−1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,1,0,0,0,1,0,0,0,−1,0,0,0,1,0,0,0,0,0,0,0,1,0,0,0,−1,0,0,0,1,0,0,0,1,0,0,0,1,0,0,0,1,0,0,0,−1,0,0,0,1,0,0,0,1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,1,0,0,0,1,0,0,0,−1,0,0,0,1,0,0,0,1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,−1,0,0,0,−1,0,0,0,−1,0,0,0,1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,1,0,0,0,1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,1,0,0,0,1,0,0,0,1,0,0,0,−1,0,0,0,−1,0,0,0,1,0,0,0,−1,0,0,0,−1,0,0,0,1,0,0,0,1,0,0,0,1,0,0,0,1,0,0,0,1,0,0,0,1,0,0,0,1,0,0,0,1,0,0,0,−1,0,0,0,1,0,0,0,−1,0,0,0,−1,0,0,0,1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,−1,0,0,0,1,0,0,0,0,0,0,0,0,0,0,0}
For 160 MHz transmission, the N-TF sequence with the format of an HELTF1X160, optimized for estimation order P=8, is given by:
N-TF(HELTF1X160,P=8)=sqrt(2048/500)·{0,0,0,0,0,0,0,0,0,0,0,0,−1,0,0,0,−1,0,0,0,1,0,0,0,−1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,−1,0,0,0,−1,0,0,0,−1,0,0,0,1,0,0,0,−1,0,0,0,−1,0,0,0,1,0,0,0,−1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,−1,0,0,0,1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,−1,0,0,0,−1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,1,0,0,0,−1,0,0,0,−1,0,0,0,−1,0,0,0,1,0,0,0,1,0,0,0,1,0,0,0,1,0,0,0,−1,0,0,0,0,0,0,0,−1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,−1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,1,0,0,0,−1,0,0,0,−1,0,0,0,−1,0,0,0,1,0,0,0,−1,0,0,0,1,0,0,0,1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,1,0,0,0,−1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,1,0,0,0,−1,0,0,0,−1,0,0,0,−1,0,0,0,1,0,0,0,−1,0,0,0,1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,1,0,0,0,−1,0,0,0,1,0,0,0,1,0,0,0,0,0,0,0,0,0,0,0,0,0,0,0,0,0,0,0,0,0,0,0,1,0,0,0,1,0,0,0,1,0,0,0,−1,0,0,0,−1,0,0,0,1,0,0,0,−1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,−1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,1,0,0,0,−1,0,0,0,−1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,1,0,0,0,−1,0,0,0,−1,0,0,0,1,0,0,0,−1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,−1,0,0,0,−1,0,0,0,1,0,0,0,−1,0,0,0,−1,0,0,0,−1,0,0,0,−1,0,0,0,1,0,0,0,1,0,0,0,−1,0,0,0,1,0,0,0,1,0,0,0,−1,0,0,0,1,0,0,0,1,0,0,0,1,0,0,0,−1,0,0,0,1,0,0,0,−1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,0,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,1,0,0,0,−1,0,0,0,−1,0,0,0,1,0,0,0,−1,0,0,0,1,0,0,0,1,0,0,0,−1,0,0,0,1,0,0,0,−1,0,0,0,−1,0,0,0,−1,0,0,0,1,0,0,0,−1,0,0,0,−1,0,0,0,1,0,0,0,−1,0,0,0,1,0,0,0,1,0,0,0,−1,0,0,0,−1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,−1,0,0,0,1,0,0,0,1,0,0,0,−1,0,0,0,1,0,0,0,1,0,0,0,−1,0,0,0,1,0,0,0,−1,0,0,0,0,0,0,0,0,0,0,0}
For 160 MHz transmission, the N-TF sequence with the format of an HELTF1X160, optimized for estimation order P=9, is given by:
N-TF(HELTF1X160,P=9)=sqrt(2048/500)·{0,0,0,0,0,0,0,0,0,0,0,0,1,0,0,0,−1,0,0,0,−1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,1,0,0,0,−1,0,0,0,−1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,1,0,0,0,−1,0,0,0,1,0,0,0,1,0,0,0,−1,0,0,0,−1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,1,0,0,0,−1,0,0,0,1,0,0,0,−1,0,0,0,−1,0,0,0,−1,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,−1,0,0,0,−1,0,0,0,1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,−1,0,0,0,−1,0,0,0,−1,0,0,0,0,0,0,0,1,0,0,0,1,0,0,0,1,0,0,0,1,0,0,0,1,0,0,0,1,0,0,0,−1,0,0,0,1,0,0,0,−1,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,1,0,0,0,−1,0,0,0,1,0,0,0,−1,0,0,0,1,0,0,0,1,0,0,0,−1,0,0,0,1,0,0,0,−1,0,0,0,−1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,1,0,0,0,1,0,0,0,1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,−1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,−1,0,0,0,−1,0,0,0,−1,0,0,0,1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,−1,0,0,0,−1,0,0,0,1,0,0,0,−1,0,0,0,1,0,0,0,−1,0,0,0,1,0,0,0,1,0,0,0,1,0,0,0,−1,0,0,0,0,0,0,0,0,0,0,0,0,0,0,0,0,0,0,0,0,0,0,0,−1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,−1,0,0,0,1,0,0,0,−1,0,0,0,−1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,−1,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,−1,0,0,0,−1,0,0,0,−1,0,0,0,1,0,0,0,1,0,0,0,1,0,0,0,−1,0,0,0,−1,0,0,0,1,0,0,0,1,0,0,0,1,0,0,0,1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,1,0,0,0,−1,0,0,0,−1,0,0,0,−1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,1,0,0,0,1,0,0,0,−1,0,0,0,−1,0,0,0,1,0,0,0,−1,0,0,0,1,0,0,0,1,0,0,0,1,0,0,0,1,0,0,0,−1,0,0,0,−1,0,0,0,1,0,0,0,1,0,0,0,−1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,1,0,0,0,1,0,0,0,0,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,−1,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,1,0,0,0,−1,0,0,0,−1,0,0,0,1,0,0,0,1,0,0,0,1,0,0,0,−1,0,0,0,−1,0,0,0,−1,0,0,0,1,0,0,0,−1,0,0,0,1,0,0,0,1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,−1,0,0,0,−1,0,0,0,−1,0,0,0,1,0,0,0,−1,0,0,0,1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,0,0,0,0,0,0,0,0}
For 160 MHz transmission, the N-TF sequence with the format of an HELTF1X160, optimized for estimation order P=10, is given by:
N-TF(HELTF1X160,P=10)=sqrt(2048/500)·{0,0,0,0,0,0,0,0,0,0,0,0,1,0,0,0,1,0,0,0,1,0,0,0,−1,0,0,0,−1,0,0,0,−1,0,0,0,−1,0,0,0,1,0,0,0,1,0,0,0,−1,0,0,0,−1,0,0,0,−1,0,0,0,1,0,0,0,−1,0,0,0,1,0,0,0,−1,0,0,0,1,0,0,0,1,0,0,0,−1,0,0,0,−1,0,0,0,−1,0,0,0,1,0,0,0,−1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,1,0,0,0,1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,−1,0,0,0,1,0,0,0,1,0,0,0,−1,0,0,0,1,0,0,0,1,0,0,0,1,0,0,0,−1,0,0,0,−1,0,0,0,1,0,0,0,1,0,0,0,−1,0,0,0,1,0,0,0,1,0,0,0,−1,0,0,0,1,0,0,0,−1,0,0,0,−1,0,0,0,−1,0,0,0,1,0,0,0,1,0,0,0,1,0,0,0,1,0,0,0,−1,0,0,0,−1,0,0,0,1,0,0,0,−1,0,0,0,−1,0,0,0,−1,0,0,0,−1,0,0,0,−1,0,0,0,1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,1,0,0,0,0,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,1,0,0,0,−1,0,0,0,1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,−1,0,0,0,−1,0,0,0,1,0,0,0,1,0,0,0,−1,0,0,0,−1,0,0,0,1,0,0,0,1,0,0,0,−1,0,0,0,1,0,0,0,1,0,0,0,1,0,0,0,1,0,0,0,−1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,−1,0,0,0,1,0,0,0,−1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,−1,0,0,0,−1,0,0,0,−1,0,0,0,−1,0,0,0,1,0,0,0,1,0,0,0,−1,0,0,0,−1,0,0,0,1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,−1,0,0,0,1,0,0,0,−1,0,0,0,1,0,0,0,−1,0,0,0,−1,0,0,0,−1,0,0,0,−1,0,0,0,1,0,0,0,−1,0,0,0,−1,0,0,0,−1,0,0,0,−1,0,0,0,1,0,0,0,1,0,0,0,1,0,0,0,0,0,0,0,0,0,0,0,0,0,0,0,0,0,0,0,0,0,0,0,1,0,0,0,−1,0,0,0,1,0,0,0,1,0,0,0,1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,1,0,0,0,−1,0,0,0,1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,−1,0,0,0,1,0,0,0,1,0,0,0,1,0,0,0,−1,0,0,0,−1,0,0,0,−1,0,0,0,1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,−1,0,0,0,1,0,0,0,1,0,0,0,1,0,0,0,−1,0,0,0,−1,0,0,0,−1,0,0,0,−1,0,0,0,1,0,0,0,1,0,0,0,−1,0,0,0,−1,0,0,0,−1,0,0,0,1,0,0,0,−1,0,0,0,1,0,0,0,−1,0,0,0,−1,0,0,0,1,0,0,0,1,0,0,0,1,0,0,0,1,0,0,0,1,0,0,0,1,0,0,0,1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,1,0,0,0,−1,0,0,0,−1,0,0,0,1,0,0,0,1,0,0,0,1,0,0,0,1,0,0,0,−1,0,0,0,1,0,0,0,−1,0,0,0,1,0,0,0,1,0,0,0,1,0,0,0,1,0,0,0,−1,0,0,0,−1,0,0,0,−1,0,0,0,0,0,0,0,1,0,0,0,−1,0,0,0,1,0,0,0,−1,0,0,0,1,0,0,0,−1,0,0,0,1,0,0,0,1,0,0,0,1,0,0,0,−1,0,0,0,1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,−1,0,0,0,1,0,0,0,−1,0,0,0,1,0,0,0,−1,0,0,0,−1,0,0,0,1,0,0,0,1,0,0,0,1,0,0,0,−1,0,0,0,−1,0,0,0,−1,0,0,0,−1,0,0,0,−1,0,0,0,1,0,0,0,1,0,0,0,−1,0,0,0,−1,0,0,0,−1,0,0,0,−1,0,0,0,−1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,1,0,0,0,−1,0,0,0,1,0,0,0,−1,0,0,0,1,0,0,0,−1,0,0,0,−1,0,0,0,1,0,0,0,1,0,0,0,−1,0,0,0,1,0,0,0,−1,0,0,0,−1,0,0,0,−1,0,0,0,−1,0,0,0,1,0,0,0,1,0,0,0,−1,0,0,0,−1,0,0,0,−1,0,0,0,1,0,0,0,1,0,0,0,1,0,0,0,−1,0,0,0,−1,0,0,0,−1,0,0,0,1,0,0,0,−1,0,0,0,1,0,0,0,1,0,0,0,−1,0,0,0,−1,0,0,0,−1,0,0,0,−1,0,0,0,1,0,0,0,−1,0,0,0,−1,0,0,0,−1,0,0,0,−1,0,0,0,1,0,0,0,1,0,0,0,1,0,0,0,−1,0,0,0,−1,0,0,0,−1,0,0,0,−1,0,0,0,1,0,0,0,1,0,0,0,1,0,0,0,1,0,0,0,1,0,0,0,−1,0,0,0,−1,0,0,0,−1,0,0,0,−1,0,0,0,−1,0,0,0,−1,0,0,0,1,0,0,0,1,0,0,0,1,0,0,0,1,0,0,0,−1,0,0,0,−1,0,0,0,−1,0,0,0,−1,0,0,0,0,0,0,0,0,0,0,0}
List23
For 160 MHz transmission, the N-TF sequence with the format of an HELTF2X160, optimized for estimation order P=3, is given by:
N-TF(HELTF2X160,P=3)=sqrt(2048/996)·{0,0,0,0,0,0,0,0,0,0,0,0,−1,0,1,0,−1,0,1,0,−1,0,−1,0,1,0,−1,0,1,0,−1,0,−1,0,1,0,−1,0,1,0,−1,0,−1,0,1,0,−1,0,−1,0,1,0,−1,0,1,0,1,0,−1,0,−1,0,1,0,−1,0,−1,0,1,0,−1,0,−1,0,1,0,−1,0,−1,0,1,0,1,0,1,0,−1,0,−1,0,1,0,1,0,1,0,−1,0,−1,0,1,0,1,0,1,0,−1,0,1,0,1,0,−1,0,−1,0,1,0,1,0,1,0,1,0,1,0,1,0,−1,0,−1,0,−1,0,1,0,1,0,1,0,1,0,−1,0,1,0,−1,0,−1,0,1,0,1,0,1,0,1,0,1,0,−1,0,−1,0,−1,0,−1,0,1,0,1,0,1,0,1,0,1,0,1,0,1,0,−1,0,−1,0,1,0,1,0,−1,0,−1,0,1,0,1,0,1,0,−1,0,1,0,−1,0,1,0,−1,0,−1,0,1,0,−1,0,1,0,−1,0,1,0,−1,0,−1,0,1,0,1,0,−1,0,1,0,−1,0,−1,0,−1,0,−1,0,−1,0,−1,0,1,0,1,0,1,0,−1,0,−1,0,1,0,1,0,−1,0,1,0,1,0,1,0,−1,0,1,0,−1,0,−1,0,1,0,1,0,−1,0,−1,0,−1,0,−1,0,−1,0,1,0,1,0,1,0,−1,0,−1,0,1,0,1,0,1,0,1,0,−1,0,1,0,−1,0,1,0,−1,0,−1,0,1,0,−1,0,1,0,−1,0,1,0,1,0,1,0,1,0,1,0,−1,0,−1,0,1,0,1,0,−1,0,−1,0,1,0,1,0,1,0,−1,0,1,0,1,0,1,0,−1,0,−1,0,1,0,1,0,−1,0,−1,0,1,0,1,0,−1,0,1,0,−1,0,−1,0,1,0,1,0,−1,0,1,0,1,0,1,0,−1,0,−1,0,1,0,1,0,1,0,−1,0,1,0,1,0,−1,0,−1,0,1,0,−1,0,−1,0,1,0,1,0,−1,0,1,0,−1,0,−1,0,1,0,−1,0,1,0,−1,0,1,0,−1,0,1,0,−1,0,−1,0,−1,0,1,0,1,0,1,0,−1,0,1,0,1,0,−1,0,1,0,−1,0,1,0,1,0,−1,0,1,0,1,0,1,0,−1,0,1,0,1,0,1,0,1,0,−1,0,1,0,1,0,1,0,−1,0,1,0,0,0,0,0,0,0,−1,0,−1,0,−1,0,1,0,1,0,1,0,−1,0,−1,0,−1,0,1,0,−1,0,1,0,1,0,1,0,1,0,1,0,−1,0,−1,0,1,0,1,0,−1,0,−1,0,−1,0,−1,0,−1,0,−1,0,1,0,−1,0,1,0,1,0,1,0,−1,0,−1,0,−1,0,−1,0,1,0,−1,0,−1,0,1,0,1,0,1,0,−1,0,1,0,−1,0,−1,0,−1,0,1,0,1,0,1,0,−1,0,−1,0,−1,0,1,0,−1,0,1,0,−1,0,1,0,1,0,1,0,−1,0,−1,0,1,0,1,0,1,0,1,0,−1,0,1,0,−1,0,1,0,−1,0,−1,0,−1,0,1,0,−1,0,1,0,−1,0,1,0,1,0,−1,0,1,0,−1,0,1,0,1,0,1,0,−1,0,1,0,−1,0,−1,0,−1,0,−1,0,−1,0,1,0,1,0,−1,0,1,0,1,0,−1,0,−1,0,−1,0,−1,0,1,0,1,0,−1,0,−1,0,−1,0,−1,0,−1,0,−1,0,1,0,1,0,1,0,−1,0,−1,0,−1,0,1,0,1,0,1,0,1,0,1,0,1,0,1,0,1,0,−1,0,1,0,−1,0,−1,0,1,0,−1,0,1,0,1,0,1,0,1,0,−1,0,−1,0,1,0,1,0,1,0,−1,0,1,0,−1,0,−1,0,−1,0,1,0,−1,0,1,0,−1,0,−1,0,1,0,1,0,−1,0,1,0,1,0,−1,0,1,0,−1,0,1,0,−1,0,1,0, 1,0,−1,0,1,0,−1,0,−1,0,1,0,1,0,1,0,1,0,1,0,−1,0,1,0,−1,0,−1,0,−1,0,1,0,1,0,1,0,−1,0,1,0,−1,0,−1,0,−1,0,−1,0,1,0,1,0,−1,0,1,0,−1,0,−1,0,1,0,1,0,1,0,−1,0,1,0,−1,0,−1,0,1,0,−1,0,−1,0,−1,0,1,0,−1,0,1,0,−1,0,−1,0,1,0,−1,0,−1,0,1,0,1,0,1,0,1,0,−1,0,−1,0,−1,0,1,0,−1,0,−1,0,1,0,1,0,1,0,1,0,1,0,−1,0,−1,0,−1,0,−1,0,−1,0,1,0,−1,0,−1,0,−1,0,−1,0,1,0,−1,0,−1,0,−1,0,1,0,1,0,1,0,1,0,−1,0,−1,0,1,0,−1,0,1,0,1,0,1,0,1,0,−1,0,0,0,0,0,0,0,0,0,0,0,0,0,0,0,0,0,0,0,0,0,0,0,−1,0,−1,0,1,0,1,0,1,0,−1,0,−1,0,−1,0,1,0,1,0,−1,0,1,0,1,0,1,0,1,0,1,0,1,0,−1,0,−1,0,−1,0,−1,0,−1,0,1,0,1,0,1,0,−1,0,1,0,−1,0,1,0,1,0,1,0,−1,0,1,0,1,0,−1,0,−1,0,1,0,−1,0,1,0,1,0,1,0,−1,0,−1,0,1,0,−1,0,1,0,1,0,1,0,−1,0,1,0,1,0,−1,0,1,0,1,0,−1,0,−1,0,−1,0,1,0,1,0,1,0,1,0,1,0,1,0,1,0,−1,0,1,0,1,0,1,0,−1,0,−1,0,1,0,−1,0,1,0,−1,0,1,0,1,0,1,0,1,0,−1,0,−1,0,1,0,1,0,1,0,−1,0,−1,0,−1,0,−1,0,1,0,−1,0,−1,0,1,0,−1,0,−1,0,1,0,1,0,−1,0,1,0,1,0,1,0,−1,0,−1,0,1,0,−1,0,−1,0,−1,0,1,0,−1,0,−1,0,−1,0,1,0,−1,0,−1,0,1,0,1,0,1,0,1,0,−1,0,−1,0,1,0,1,0,−1,0,−1,0,1,0,−1,0,1,0,1,0,−1,0,−1,0,−1,0,1,0,1,0,−1,0,−1,0,1,0,1,0,−1,0,1,0,−1,0,−1,0,−1,0,1,0,−1,0,−1,0,−1,0,1,0,−1,0,−1,0,−1,0,1,0,1,0,1,0,−1,0,−1,0,1,0,−1,0,−1,0,1,0,1,0,−1,0,1,0,1,0,1,0,1,0,−1,0,1,0,1,0,1,0,1,0,1,0,1,0,1,0,1,0,−1,0,−1,0,1,0,−1,0,−1,0,−1,0,1,0,−1,0,1,0,1,0,−1,0,1,0,−1,0,−1,0,1,0,1,0,−1,0,−1,0,1,0,−1,0,−1,0,−1,0,−1,0,1,0,−1,0,1,0,−1,0,1,0,1,0,−1,0,1,0,1,0,−1,0,−1,0,1,0,−1,0,−1,0,−1,0,−1,0,1,0,−1,0,−1,0,−1,0,1,0,−1,0,−1,0,1,0,1,0,1,0,1,0,−1,0,1,0,−1,0,−1,0,−1,0,1,0,1,0,1,0,1,0,−1,0,−1,0,−1,0,−1,0,−1,0,−1,0,1,0,−1,0,1,0,1,0,−1,0,−1,0,−1,0,1,0,1,0,−1,0,−1,0,1,0,0,0,0,0,0,0,1,0,1,0,−1,0,−1,0,−1,0,−1,0,1,0,−1,0,1,0,1,0,−1,0,−1,0,−1,0,1,0,1,0,1,0,1,0,−1,0,1,0,−1,0,1,0,1,0,1,0,−1,0,−1,0,1,0,1,0,1,0,−1,0,−1,0,1,0,1,0,1,0,1,0,1,0,1,0,−1,0,−1,0,1,0,1,0,−1,0,1,0,−1,0,1,0,1,0,−1,0,−1,0,−1,0,1,0,−1,0,1,0,1,0,1,0,−1,0,−1,0,−1,0,1,0,1,0,1,0,1,0,1,0,−1,0,−1,0,−1,0,−1,0,1,0,−1,0,1,0,1,0,1,0,−1,0,1,0,−1,0,1,0,1,0,1,0,−1,0,−1,0,−1,0,1,0,1,0,−1,0,−1,0,−1,0,−1,0,−1,0,−1,0,1,0,1,0,1,0,−1,0,1,0,−1,0,1,0,1,0,1,0,1,0,1,0,−1,0,−1,0,−1,0,−1,0,1,0,−1,0,1,0,1,0,1,0,−1,0,−1,0,−1,0,1,0,1,0,−1,0,−1,0,1,0,1,0,−1,0,−1,0,1,0,−1,0,−1,0,1,0,−1,0,1,0,1,0,1,0,1,0,1,0,−1,0,−1,0,−1,0,−1,0,−1,0,−1,0,1,0,−1,0,−1,0,1,0,−1,0,−1,0,−1,0,1,0,1,0,1,0,−1,0,−1,0,−1,0,1,0,−1,0,1,0,1,0,−1,0,−1,0,−1,0,−1,0,1,0,1,0,−1,0,−1,0,−1,0,1,0,1,0,−1,0,−1,0,−1,0,1,0,−1,0,−1,0,1,0,1,0,1,0,−1,0,−1,0,1,0,−1,0,−1,0,−1,0,−1,0,−1,0,−1,0,1,0,−1,0,−1,0,−1,0,−1,0,−1,0,1,0,1,0,1,0,−1,0,−1,0,1,0,1,0,1,0,1,0,−1,0,−1,0,−1,0,−1,0,1,0,1,0,−1,0,−1,0,−1,0,1,0,1,0,−1,0,−1,0,−1,0,1,0,1,0,−1,0,−1,0,−1,0,−1,0,1,0,−1,0,−1,0,1,0,1,0,−1,0,1,0,1,0,1,0,1,0,−1,0,1,0,−1,0,−1,0,−1,0,1,0,1,0,−1,0,1,0,1,0,1,0,−1,0,−1,0,−1,0,−1,0,1,0,1,0,1,0,−1,0,−1,0,−1,0,−1,0,−1,0,1,0,0,0,0,0,0,0,0,0,0,0}
For 160 MHz transmission, the N-TF sequence with the format of an HELTF2X160, optimized for estimation order P=4, is given by:
N-TF(HELTF2X160,P=4)=sqrt(2048/996)·{0,0,0,0,0,0,0,0,0,0,0,0,1,0,1,0,1,0,1,0,1,0,1,0,1,0,1,0,−1,0,−1,0,1,0,1,0,1,0,−1,0,−1,0,−1,0,1,0,−1,0,1,0,−1,0,−1,0,1,0,1,0,1,0,1,0,−1,0,−1,0,−1,0,1,0,−1,0,−1,0,−1,0,1,0,1,0,−1,0,1,0,1,0,−1,0,−1,0,−1,0,1,0,1,0,−1,0,1,0,−1,0,−1,0,−1,0,−1,0,−1,0,1,0,−1,0,−1,0,−1,0,−1,0,−1,0,1,0,−1,0,−1,0,1,0,−1,0,−1,0,−1,0,−1,0,1,0,1,0,−1,0,−1,0,−1,0,1,0,1,0,1,0,1,0,−1,0,−1,0,1,0,1,0,1,0,−1,0,−1,0,−1,0,−1,0,1,0,−1,0,−1,0,1,0,−1,0,1,0,−1,0,1,0,−1,0,1,0,1,0,1,0,1,0,−1,0,−1,0,−1,0,1,0,−1,0,1,0,1,0,−1,0,−1,0,−1,0,−1,0,1,0,−1,0,1,0,1,0,−1,0,1,0,−1,0,1,0,−1,0,1,0,−1,0,1,0,1,0,1,0,1,0,1,0,−1,0,−1,0,1,0,−1,0,−1,0,−1,0,−1,0,−1,0,1,0,1,0,1,0,−1,0,−1,0,−1,0,−1,0,1,0,−1,0,−1,0,−1,0,1,0,−1,0,1,0,1,0,1,0,−1,0,−1,0,1,0,1,0,−1,0,1,0,−1,0,−1,0,1,0,1,0,1,0,1,0,−1,0,1,0,1,0,1,0,1,0,−1,0,−1,0,−1,0,−1,0,1,0,−1,0,−1,0,1,0,−1,0,1,0,1,0,−1,0,−1,0,−1,0,1,0,1,0,−1,0,−1,0,−1,0,1,0,−1,0,1,0,1,0,1,0,−1,0,1,0,1,0,−1,0,1,0,1,0,−1,0,−1,0,1,0,1,0,1,0,−1,0,1,0,1,0,1,0,−1,0,−1,0,1,0,−1,0,−1,0,1,0,1,0,−1,0,1,0,−1,0,1,0,1,0,1,0,1,0,1,0,−1,0,−1,0,−1,0,−1,0,1,0,−1,0,−1,0,1,0,−1,0,−1,0,−1,0,−1,0,−1,0,−1,0,1,0,1,0,−1,0,1,0,1,0,1,0,1,0,1,0,−1,0,−1,0,−1,0,−1,0,−1,0,−1,0,1,0,1,0,1,0,1,0,1,0,0,0,0,0,0,0,1,0,−1,0,1,0,1,0,−1,0,1,0,−1,0,−1,0,−1,0,−1,0,−1,0,−1,0,−1,0,1,0,1,0,1,0,1,0,−1,0,−1,0,1,0,1,0,1,0,1,0,−1,0,1,0,−1,0,1,0,1,0,−1,0,1,0,1,0,1,0,1,0,−1,0,−1,0,−1,0,1,0,−1,0,1,0,1,0,−1,0,−1,0,−1,0,1,0,1,0,−1,0,1,0,1,0,1,0,−1,0,1,0,−1,0,−1,0,1,0,−1,0,−1,0,−1,0,−1,0,−1,0,−1,0,−1,0,−1,0,1,0,−1,0,1,0,−1,0,1,0,1,0,1,0,1,0,1,0,−1,0,−1,0,−1,0,−1,0,1,0,1,0,−1,0,−1,0,−1,0,1,0,1,0,−1,0,−1,0,−1,0,−1,0,1,0,1,0,−1,0,1,0,−1,0,1,0,1,0,1,0,−1,0,1,0,−1,0,1,0,1,0,−1,0,−1,0,1,0,−1,0,−1,0,1,0,−1,0,1,0,1,0,−1,0,1,0,1,0,−1,0,1,0,−1,0,−1,0,−1,0,−1,0,1,0,1,0,1,0,1,0,1,0,1,0,1,0,−1,0,−1,0,1,0,−1,0,−1,0,−1,0,−1,0,1,0,−1,0,−1,0,1,0,−1,0,−1,0,−1,0,−1,0,1,0,−1,0,1,0,1,0,1,0,−1,0,1,0,1,0,1,0,−1,0,1,0,1,0,1,0,1,0,−1,0,1,0,1,0,−1,0,−1,0,1,0,−1,0,−1,0,−1,0,−1,0,1,0,−1,0,1,0,1,0,−1,0,1,0,−1,0,1,0,1,0,1,0,−1,0,−1,0,−1,0,1,0,1,0,−1,0,1,0,1,0,1,0,1,0,−1,0,−1,0,−1,0,1,0,1,0, 1,0,−1,0,1,0,1,0,1,0,1,0,1,0,1,0,−1,0,1,0,−1,0,−1,0,1,0,1,0,1,0,−1,0,−1,0,1,0,−1,0,−1,0,−1,0,−1,0,−1,0,1,0,−1,0,−1,0,1,0,−1,0,1,0,−1,0,1,0,1,0,−1,0,−1,0,1,0,1,0,−1,0,1,0,1,0,1,0,1,0,−1,0,1,0,−1,0,−1,0,−1,0,1,0,−1,0,1,0,−1,0,1,0,1,0,−1,0,1,0,1,0,1,0,−1,0,1,0,1,0,1,0,1,0,0,0,0,0,0,0,0,0,0,0,0,0,0,0,0,0,0,0,0,0,0,0,−1,0,−1,0,−1,0,1,0,1,0,1,0,−1,0,1,0,−1,0,−1,0,1,0,−1,0,1,0,−1,0,−1,0,1,0,1,0,1,0,1,0,−1,0,−1,0,−1,0,−1,0,1,0,−1,0,−1,0,1,0,−1,0,−1,0,1,0,1,0,−1,0,−1,0,−1,0,1,0,1,0,1,0,1,0,1,0,1,0,1,0,1,0,1,0,−1,0,1,0,1,0,−1,0,−1,0,−1,0,−1,0,−1,0,−1,0,−1,0,1,0,−1,0,1,0,−1,0,1,0,−1,0,1,0,1,0,−1,0,1,0,1,0,−1,0,1,0,−1,0,−1,0,1,0,1,0,−1,0,1,0,−1,0,−1,0,1,0,−1,0,−1,0,−1,0,−1,0,−1,0,1,0,−1,0,−1,0,1,0,−1,0,−1,0,1,0,−1,0,1,0,1,0,1,0,−1,0,−1,0,1,0,1,0,1,0,−1,0,−1,0,−1,0,1,0,1,0,1,0,−1,0,−1,0,1,0,−1,0,1,0,1,0,1,0,1,0,1,0,−1,0,−1,0,−1,0,1,0,−1,0,−1,0,1,0,−1,0,1,0,−1,0,−1,0,−1,0,1,0,1,0,1,0,−1,0,1,0,−1,0,−1,0,1,0,1,0,−1,0,1,0,−1,0,−1,0,−1,0,−1,0,1,0,1,0,−1,0,1,0,−1,0,−1,0,1,0,1,0,−1,0,−1,0,1,0,1,0,−1,0,−1,0,−1,0,−1,0,1,0,1,0,1,0,1,0,1,0,−1,0,−1,0,−1,0,−1,0,−1,0,1,0,1,0,1,0,−1,0,−1,0,−1,0,1,0,1,0,1,0,1,0,−1,0,1,0,1,0,1,0,1,0,1,0,1,0,1,0,1,0,−1,0,−1,0,−1,0,1,0,−1,0,1,0,1,0,1,0,−1,0,−1,0,−1,0,1,0,1,0,−1,0,−1,0,−1,0,−1,0,1,0,−1,0,1,0,−1,0,−1,0,−1,0,−1,0,1,0,−1,0,1,0,−1,0,−1,0,1,0,1,0,1,0,1,0,1,0,1,0,1,0,1,0,−1,0,−1,0,−1,0,−1,0,−1,0,1,0,−1,0,−1,0,−1,0,1,0,−1,0,1,0,1,0,1,0,1,0,−1,0,−1,0,1,0,−1,0,1,0,1,0,1,0,1,0,1,0,1,0,−1,0,−1,0,−1,0,1,0,0,0,0,0,0,0,1,0,1,0,−1,0,−1,0,1,0,1,0,−1,0,1,0,1,0,−1,0,1,0,1,0,1,0,1,0,−1,0,1,0,−1,0,−1,0,−1,0,−1,0,1,0,−1,0,1,0,−1,0,−1,0,1,0,−1,0,−1,0,−1,0,−1,0,1,0,1,0,−1,0,1,0,1,0,1,0,−1,0,1,0,1,0,−1,0,−1,0,1,0,−1,0,−1,0,1,0,−1,0,−1,0,1,0,−1,0,−1,0,1,0,1,0,1,0,−1,0,−1,0,1,0,1,0,1,0,1,0,−1,0,1,0,1,0,1,0,1,0,−1,0,1,0,−1,0,−1,0,1,0,1,0,1,0,1,0,−1,0,−1,0,−1,0,1,0,1,0,−1,0,−1,0,1,0,−1,0,1,0,−1,0,−1,0,1,0,1,0,1,0,1,0,−1,0,−1,0,1,0,1,0,1,0,1,0,1,0,1,0,−1,0,−1,0,−1,0,1,0,1,0,1,0,−1,0,1,0,1,0,1,0,1,0,−1,0,−1,0,1,0,−1,0,1,0,1,0,−1,0,−1,0,1,0,1,0,−1,0,1,0,−1,0,1,0,1,0,−1,0,1,0,−1,0,−1,0,1,0,1,0,−1,0,1,0,1,0,−1,0,−1,0,−1,0,1,0,−1,0,−1,0,1,0,1,0,1,0,−1,0,1,0,−1,0,−1,0,1,0,1,0,1,0,1,0,−1,0,1,0,−1,0,−1,0,1,0,−1,0,−1,0,1,0,−1,0,−1,0,−1,0,1,0,1,0,−1,0,−1,0,1,0,1,0,−1,0,−1,0,−1,0,−1,0,1,0,1,0,1,0,−1,0,1,0,1,0,−1,0,1,0,−1,0,−1,0,−1,0,1,0,−1,0,−1,0,−1,0,1,0,1,0,1,0,−1,0,−1,0,−1,0,−1,0,−1,0,−1,0,1,0,−1,0,1,0,1,0,−1,0,−1,0,1,0,−1,0,1,0,1,0,−1,0,−1,0,−1,0,−1,0,1,0,1,0,−1,0,1,0,1,0,1,0,1,0,−1,0,−1,0,1,0,1,0,−1,0,−1,0,1,0,−1,0,1,0,1,0,−1,0,−1,0,−1,0,−1,0,1,0,1,0,1,0,1,0,−1,0,−1,0,1,0,−1,0,1,0,−1,0,1,0,1,0,−1,0,1,0,1,0,1,0,−1,0,−1,0,−1,0,1,0,−1,0,0,0,0,0,0,0,0,0,0,0}
For 160 MHz transmission, the N-TF sequence with the format of an HELTF2X160, optimized for estimation order P=5, is given by:
N-TF(HELTF2X160,P=5)=sqrt(2048/996)·{0,0,0,0,0,0,0,0,0,0,0,0,−1,0,−1,0,1,0,1,0,1,0,−1,0,−1,0,1,0,1,0,1,0,1,0,−1,0,−1,0,1,0,−1,0,−1,0,1,0,1,0,1,0,1,0,1,0,1,0,1,0,−1,0,−1,0,−1,0,−1,0,1,0,−1,0,1,0,−1,0,−1,0,1,0,−1,0,1,0,1,0,1,0,−1,0,1,0,1,0,1,0,−1,0,1,0,−1,0,1,0,−1,0,1,0,1,0,−1,0,1,0,1,0,1,0,−1,0,−1,0,−1,0,1,0,−1,0,1,0,−1,0,−1,0,−1,0,−1,0,−1,0,−1,0,−1,0,1,0,1,0,−1,0,1,0,1,0,1,0,−1,0,−1,0,1,0,1,0,1,0,−1,0,1,0,−1,0,1,0,−1,0,−1,0,1,0,−1,0,−1,0,1,0,1,0,1,0,−1,0,1,0,−1,0,1,0,1,0,1,0,−1,0,−1,0,1,0,1,0,−1,0,−1,0,−1,0,−1,0,−1,0,1,0,1,0,1,0,1,0,−1,0,1,0,−1,0,−1,0,−1,0,−1,0,1,0,1,0,−1,0,1,0,−1,0,−1,0,1,0,1,0,−1,0,1,0,1,0,1,0,−1,0,1,0,1,0,−1,0,−1,0,1,0,1,0,1,0,1,0,−1,0,1,0,−1,0,1,0,−1,0,−1,0,1,0,−1,0,1,0,1,0,1,0,1,0,−1,0,1,0,1,0,1,0,1,0,1,0,1,0,1,0,1,0,−1,0,−1,0,1,0,−1,0,−1,0,−1,0,−1,0,−1,0,1,0,−1,0,−1,0,−1,0,−1,0,1,0,−1,0,1,0,1,0,−1,0,−1,0,−1,0,−1,0,1,0,−1,0,−1,0,1,0,1,0,1,0,1,0,−1,0,−1,0,−1,0,−1,0,1,0,1,0,1,0,−1,0,1,0,−1,0,1,0,−1,0,−1,0,−1,0,−1,0,1,0,1,0,1,0,−1,0,1,0,−1,0,1,0,−1,0,−1,0,1,0,−1,0,−1,0,−1,0,1,0,1,0,−1,0,−1,0,1,0,1,0,1,0,1,0,1,0,−1,0,−1,0,−1,0,−1,0,−1,0,1,0,1,0,−1,0,1,0,−1,0,1,0,−1,0,−1,0,−1,0,−1,0,1,0,−1,0,1,0,−1,0,1,0,−1,0,−1,0,1,0,1,0,−1,0,1,0,1,0,−1,0,1,0,0,0,0,0,0,0,−1,0,−1,0,1,0,−1,0,−1,0,1,0,1,0,1,0,1,0,−1,0,1,0,1,0,1,0,1,0,1,0,1,0,−1,0,1,0,1,0,1,0,1,0,−1,0,1,0,−1,0,1,0,−1,0,−1,0,−1,0,−1,0,−1,0,−1,0,−1,0,1,0,−1,0,1,0,−1,0,1,0,−1,0,1,0,1,0,−1,0,1,0,1,0,1,0,−1,0,1,0,1,0,−1,0,1,0,−1,0,−1,0,1,0,1,0,−1,0,−1,0,−1,0,1,0,1,0,−1,0,−1,0,1,0,−1,0,−1,0,1,0,−1,0,1,0,−1,0,−1,0,1,0,1,0,−1,0,1,0,1,0,−1,0,−1,0,−1,0,−1,0,1,0,−1,0,−1,0,1,0,−1,0,−1,0,−1,0,−1,0,1,0,1,0,−1,0,−1,0,−1,0,−1,0,1,0,−1,0,1,0,−1,0,−1,0,−1,0,−1,0,−1,0,−1,0,1,0,−1,0,−1,0,−1,0,−1,0,1,0,−1,0,−1,0,−1,0,−1,0,1,0,−1,0,−1,0,−1,0,−1,0,1,0,−1,0,1,0,1,0,1,0,1,0,−1,0,−1,0,1,0,−1,0,−1,0,1,0,−1,0,−1,0,1,0,−1,0,−1,0,1,0,−1,0,−1,0,1,0,−1,0,1,0,−1,0,−1,0,1,0,−1,0,−1,0,−1,0,−1,0,1,0,1,0,1,0,−1,0,−1,0,−1,0,1,0,1,0,−1,0,1,0,−1,0,−1,0,1,0,1,0,1,0,1,0,1,0,−1,0,1,0,1,0,1,0,−1,0,−1,0,1,0,1,0,1,0,−1,0,−1,0,1,0,−1,0,1,0,−1,0,1,0,1,0,1,0,1,0,1,0,1,0,−1,0,1,0,−1,0,−1,0,1,0,1,0,1,0,−1,0,−1,0,1,0,1,0,−1,0,1,0,−1,0,1,0,−1,0,−1,0,−1,0,1,0,1,0,−1,0,1,0,−1,0,1,0,1,0,−1,0,−1,0,−1,0,−1,0,1,0,−1,0,1,0,−1,0,−1,0,1,0,1,0,−1,0,−1,0,1,0,1,0,1,0,1,0,−1,0,1,0,1,0,−1,0,1,0,−1,0,1,0,1,0,−1,0,1,0,−1,0,1,0,1,0,1,0,1,0,−1,0,1,0,1,0,1,0,−1,0,−1,0,1,0,1,0,−1,0,0,0,0,0,0,0,0,0,0,0,0,0,0,0,0,0,0,0,0,0,0,0,1,0,1,0,−1,0,−1,0,−1,0,−1,0,1,0,−1,0,−1,0,1,0,−1,0,1,0,−1,0,1,0,−1,0,−1,0,−1,0,−1,0,−1,0,1,0,−1,0,−1,0,−1,0,−1,0,1,0,−1,0,1,0,−1,0,−1,0,1,0,−1,0,1,0,−1,0,−1,0,−1,0,1,0,−1,0,1,0,−1,0,−1,0,−1,0,1,0,1,0,−1,0,1,0,−1,0,−1,0,1,0,1,0,−1,0,−1,0,−1,0,−1,0,−1,0,1,0,1,0,1,0,−1,0,−1,0,1,0,1,0,−1,0,1,0,1,0,−1,0,1,0,−1,0,−1,0,−1,0,1,0,−1,0,1,0,1,0,−1,0,1,0,−1,0,−1,0,1,0,1,0,−1,0,1,0,−1,0,1,0,−1,0,−1,0,1,0,−1,0,−1,0,1,0,1,0,−1,0,−1,0,1,0,1,0,−1,0,−1,0,1,0,−1,0,−1,0,−1,0,−1,0,−1,0,−1,0,−1,0,−1,0,1,0,−1,0,1,0,1,0,−1,0,−1,0,1,0,1,0,1,0,1,0,1,0,−1,0,−1,0,−1,0,1,0,−1,0,1,0,1,0,−1,0,1,0,1,0,1,0,−1,0,−1,0,1,0,1,0,−1,0,1,0,−1,0,−1,0,1,0,−1,0,−1,0,−1,0,−1,0,1,0,−1,0,1,0,1,0,−1,0,−1,0,1,0,−1,0,−1,0,1,0,1,0,1,0,1,0,1,0,1,0,1,0,−1,0,−1,0,1,0,1,0,1,0,−1,0,1,0,1,0,−1,0,−1,0,−1,0,1,0,−1,0,1,0,1,0,−1,0,−1,0,−1,0,−1,0,−1,0,−1,0,1,0,1,0,1,0,1,0,−1,0,1,0,−1,0,1,0,−1,0,−1,0,1,0,1,0,−1,0,1,0,−1,0,−1,0,−1,0,−1,0,−1,0,1,0,−1,0,−1,0,−1,0,−1,0,1,0,−1,0,−1,0,1,0,−1,0,1,0,−1,0,−1,0,1,0,−1,0,−1,0,1,0,−1,0,−1,0,1,0,−1,0,−1,0,1,0,−1,0,−1,0,1,0,−1,0,1,0,1,0,−1,0,1,0,1,0,1,0,1,0,−1,0,−1,0,−1,0,−1,0,1,0,1,0,−1,0,1,0,−1,0,1,0,−1,0,−1,0,−1,0,−1,0,−1,0,−1,0,1,0,−1,0,1,0,0,0,0,0,0,0,−1,0,1,0,1,0,−1,0,1,0,−1,0,1,0,−1,0,−1,0,1,0,1,0,−1,0,1,0,1,0,1,0,1,0,−1,0,−1,0,−1,0,−1,0,−1,0,−1,0,1,0,1,0,1,0,−1,0,−1,0,1,0,−1,0,1,0,1,0,−1,0,−1,0,−1,0,1,0,1,0,−1,0,−1,0,1,0,1,0,1,0,1,0,−1,0,−1,0,−1,0,−1,0,−1,0,1,0,1,0,1,0,1,0,1,0,1,0,1,0,−1,0,−1,0,−1,0,−1,0,1,0,−1,0,−1,0,−1,0,−1,0,−1,0,−1,0,−1,0,−1,0,−1,0,1,0,1,0,1,0,1,0,1,0,−1,0,−1,0,1,0,−1,0,1,0,1,0,1,0,−1,0,1,0,1,0,1,0,−1,0,1,0,−1,0,1,0,1,0,1,0,1,0,−1,0,−1,0,1,0,−1,0,−1,0,1,0,1,0,−1,0,1,0,1,0,1,0,1,0,−1,0,−1,0,−1,0,−1,0,1,0,−1,0,1,0,1,0,1,0,−1,0,−1,0,−1,0,−1,0,1,0,−1,0,1,0,−1,0,−1,0,1,0,−1,0,−1,0,1,0,1,0,−1,0,1,0,1,0,−1,0,1,0,1,0,1,0,−1,0,−1,0,1,0,1,0,−1,0,−1,0,−1,0,−1,0,−1,0,1,0,−1,0,−1,0,−1,0,1,0,1,0,1,0,1,0,−1,0,−1,0,−1,0,−1,0,1,0,1,0,−1,0,−1,0,−1,0,−1,0,−1,0,−1,0,1,0,1,0,−1,0,1,0,−1,0,−1,0,1,0,−1,0,−1,0,−1,0,−1,0,−1,0,1,0,−1,0,1,0,−1,0,−1,0,−1,0,1,0,1,0,1,0,1,0,−1,0,1,0,−1,0,1,0,−1,0,−1,0,1,0,1,0,1,0,1,0,1,0,1,0,1,0,−1,0,1,0,1,0,1,0,−1,0,1,0,−1,0,−1,0,−1,0,−1,0,1,0,−1,0,−1,0,1,0,−1,0,−1,0,1,0,−1,0,1,0,1,0,1,0,−1,0,1,0,1,0,1,0,1,0,−1,0,−1,0,1,0,1,0,−1,0,1,0,1,0,−1,0,1,0,−1,0,−1,0,1,0,1,0,−1,0,−1,0,−1,0,1,0,1,0,−1,0,1,0,−1,0,−1,0,1,0,−1,0,−1,0,−1,0,0,0,0,0,0,0,0,0,0,0}
For 160 MHz transmission, the N-TF sequence with the format of an HELTF2X160, optimized for estimation order P=6, is given by:
N-TF(HELTF2X160,P=6)=sqrt(2048/996)·{0,0,0,0,0,0,0,0,0,0,0,0,−1,0,−1,0,−1,0,−1,0,−1,0,−1,0,1,0,−1,0,1,0,1,0,−1,0,1,0,1,0,−1,0,−1,0,−1,0,1,0,1,0,1,0,1,0,−1,0,1,0,−1,0,1,0,−1,0,−1,0,1,0,−1,0,−1,0,−1,0,1,0,−1,0,1,0,1,0,1,0,−1,0,−1,0,1,0,−1,0,1,0,1,0,1,0,−1,0,1,0,−1,0,1,0,−1,0,1,0,−1,0,−1,0,−1,0,1,0,−1,0,−1,0,−1,0,−1,0,−1,0,−1,0,1,0,−1,0,1,0,1,0,−1,0,1,0,−1,0,−1,0,−1,0,1,0,−1,0,−1,0,−1,0,1,0,−1,0,−1,0,−1,0,−1,0,1,0,−1,0,−1,0,1,0,−1,0,−1,0,1,0,1,0,1,0,−1,0,−1,0,1,0,−1,0,1,0,−1,0,1,0,−1,0,1,0,1,0,−1,0,1,0,−1,0,−1,0,1,0,−1,0,1,0,1,0,1,0,−1,0,−1,0,1,0,1,0,1,0,−1,0,1,0,1,0,−1,0,1,0,−1,0,−1,0,1,0,−1,0,−1,0,1,0,1,0,1,0,1,0,−1,0,−1,0,1,0,1,0,−1,0,−1,0,1,0,1,0,−1,0,−1,0,−1,0,−1,0,−1,0,1,0,−1,0,1,0,1,0,−1,0,−1,0,1,0,−1,0,1,0,−1,0,1,0,1,0,−1,0,1,0,1,0,1,0,1,0,−1,0,−1,0,−1,0,1,0,1,0,1,0,1,0,1,0,−1,0,−1,0,−1,0,1,0,1,0,1,0,1,0,−1,0,1,0,1,0,1,0,1,0,−1,0,1,0,1,0,1,0,−1,0,−1,0,−1,0,−1,0,1,0,1,0,1,0,1,0,1,0,1,0,1,0,−1,0,−1,0,−1,0,−1,0,1,0,1,0,−1,0,1,0,1,0,1,0,−1,0,1,0,−1,0,1,0,1,0,−1,0,1,0,1,0,−1,0,1,0,−1,0,1,0,1,0,−1,0,−1,0,−1,0,1,0,1,0,1,0,−1,0,1,0,1,0,1,0,−1,0,1,0,1,0,−1,0,1,0,−1,0,1,0,−1,0,−1,0,1,0,1,0,−1,0,1,0,1,0,1,0,1,0,1,0,−1,0,1,0,1,0,−1,0,1,0,−1,0,−1,0,1,0,−1,0,1,0,−1,0,0,0,0,0,0,0,1,0,−1,0,−1,0,1,0,−1,0,−1,0,1,0,−1,0,1,0,−1,0,1,0,−1,0,−1,0,1,0,−1,0,−1,0,1,0,−1,0,1,0,−1,0,−1,0,−1,0,1,0,1,0,−1,0,−1,0,1,0,−1,0,−1,0,1,0,1,0,−1,0,−1,0,−1,0,1,0,1,0,−1,0,−1,0,1,0,−1,0,−1,0,−1,0,−1,0,1,0,−1,0,1,0,−1,0,1,0,−1,0,−1,0,−1,0,−1,0,1,0,−1,0,−1,0,1,0,−1,0,−1,0,−1,0,−1,0,1,0,−1,0,−1,0,−1,0,1,0,1,0,−1,0,−1,0,−1,0,−1,0,−1,0,−1,0,1,0,−1,0,1,0,1,0,1,0,1,0,1,0,1,0,−1,0,−1,0,−1,0,1,0,−1,0,−1,0,−1,0,1,0,−1,0,1,0,−1,0,1,0,−1,0,1,0,−1,0,−1,0,1,0,−1,0,−1,0,−1,0,1,0,1,0,−1,0,−1,0,−1,0,−1,0,1,0,−1,0,1,0,−1,0,1,0,1,0,−1,0,1,0,1,0,−1,0,−1,0,−1,0,1,0,−1,0,1,0,−1,0,−1,0,1,0,−1,0,1,0,1,0,1,0,1,0,−1,0,−1,0,1,0,−1,0,−1,0,−1,0,1,0,−1,0,1,0,1,0,1,0,1,0,−1,0,−1,0,−1,0,1,0,1,0,1,0,1,0,−1,0,1,0,−1,0,1,0,1,0,−1,0,1,0,1,0,−1,0,−1,0,−1,0,1,0,−1,0,1,0,1,0,1,0,−1,0,1,0,−1,0,−1,0,1,0,1,0,−1,0,−1,0,1,0,−1,0,1,0,−1,0,1,0,1,0,−1,0,−1,0,−1,0,1,0,1,0,−1,0,1,0,1,0,1,0,1,0,−1,0,1,0,1,0,−1,0,−1,0,1,0,1,0,−1,0,1,0,1,0,−1,0,1,0,1,0,1,0,1,0,1,0,−1,0,1,0,−1,0,1,0,−1,0,1,0,−1,0,−1,0,1,0,−1,0,1,0,−1,0,1,0,−1,0,−1,0,−1,0,−1,0,1,0,1,0,−1,0,1,0,−1,0,1,0,1,0,−1,0,1,0,−1,0,1,0,−1,0,−1,0,1,0,1,0,1,0,−1,0,−1,0,1,0,−1,0,−1,0,−1,0,1,0,−1,0,−1,0,1,0,1,0,1,0,0,0,0,0,0,0,0,0,0,0,0,0,0,0,0,0,0,0,0,0,0,0,−1,0,−1,0,−1,0,−1,0,−1,0,1,0,1,0,−1,0,−1,0,1,0,1,0,−1,0,−1,0,−1,0,−1,0,1,0,−1,0,1,0,1,0,1,0,1,0,−1,0,−1,0,−1,0,1,0,1,0,−1,0,1,0,−1,0,−1,0,1,0,−1,0,1,0,−1,0,1,0,−1,0,−1,0,−1,0,1,0,1,0,−1,0,−1,0,1,0,1,0,−1,0,−1,0,−1,0,1,0,−1,0,−1,0,1,0,1,0,1,0,−1,0,−1,0,1,0,−1,0,−1,0,−1,0,−1,0,1,0,−1,0,−1,0,−1,0,1,0,1,0,−1,0,−1,0,−1,0,1,0,1,0,−1,0,1,0,−1,0,−1,0,−1,0,1,0,1,0,−1,0,−1,0,1,0,−1,0,1,0,−1,0,−1,0,1,0,−1,0,−1,0,−1,0,−1,0,−1,0,1,0,−1,0,−1,0,1,0,−1,0,1,0,−1,0,1,0,1,0,1,0,−1,0,−1,0,−1,0,−1,0,−1,0,−1,0,−1,0,1,0,1,0,−1,0,−1,0,−1,0,1,0,1,0,1,0,1,0,−1,0,1,0,1,0,1,0,−1,0,−1,0,1,0,1,0,−1,0,−1,0,1,0,1,0,−1,0,−1,0,−1,0,−1,0,1,0,1,0,1,0,−1,0,−1,0,1,0,−1,0,−1,0,1,0,−1,0,1,0,1,0,1,0,−1,0,−1,0,1,0,1,0,1,0,−1,0,−1,0,−1,0,1,0,1,0,−1,0,1,0,1,0,1,0,−1,0,1,0,1,0,1,0,−1,0,−1,0,1,0,−1,0,−1,0,1,0,1,0,1,0,1,0,1,0,−1,0,1,0,1,0,−1,0,1,0,1,0,1,0,1,0,1,0,1,0,1,0,1,0,1,0,−1,0,−1,0,1,0,1,0,−1,0,1,0,1,0,1,0,−1,0,−1,0,1,0,1,0,1,0,−1,0,−1,0,1,0,1,0,1,0,1,0,1,0,1,0,1,0,−1,0,1,0,1,0,−1,0,−1,0,1,0,−1,0,1,0,−1,0,−1,0,−1,0,1,0,1,0,1,0,1,0,1,0,−1,0,1,0,−1,0,−1,0,−1,0,−1,0,−1,0,−1,0,1,0,−1,0,−1,0,−1,0,−1,0,1,0,1,0,−1,0,−1,0,−1,0,1,0,1,0,−1,0,1,0,−1,0,1,0,0,0,0,0,0,0,−1,0,1,0,1,0,−1,0,1,0,−1,0,1,0,1,0,−1,0,−1,0,−1,0,−1,0,−1,0,−1,0,−1,0,1,0,−1,0,1,0,1,0,1,0,−1,0,1,0,−1,0,1,0,1,0,−1,0,−1,0,−1,0,−1,0,1,0,−1,0,1,0,1,0,−1,0,1,0,−1,0,−1,0,1,0,−1,0,1,0,−1,0,1,0,−1,0,−1,0,1,0,1,0,−1,0,−1,0,−1,0,−1,0,1,0,1,0,1,0,1,0,−1,0,1,0,−1,0,1,0,−1,0,−1,0,1,0,−1,0,1,0,−1,0,−1,0,1,0,−1,0,1,0,−1,0,1,0,−1,0,1,0,1,0,−1,0,1,0,−1,0,1,0,−1,0,−1,0,1,0,1,0,1,0,−1,0,−1,0,−1,0,−1,0,−1,0,1,0,−1,0,1,0,−1,0,−1,0,−1,0,−1,0,−1,0,1,0,−1,0,−1,0,1,0,1,0,1,0,−1,0,1,0,1,0,−1,0,−1,0,−1,0,−1,0,1,0,−1,0,1,0,1,0,1,0,1,0,1,0,1,0,−1,0,−1,0,1,0,−1,0,−1,0,1,0,−1,0,−1,0,1,0,1,0,1,0,1,0,−1,0,1,0,−1,0,1,0,1,0,−1,0,−1,0,−1,0,−1,0,1,0,1,0,−1,0,−1,0,−1,0,1,0,1,0,−1,0,1,0,−1,0,−1,0,−1,0,1,0,1,0,1,0,1,0,1,0,1,0,−1,0,1,0,1,0,−1,0,1,0,1,0,1,0,1,0,1,0,−1,0,1,0,1,0,−1,0,1,0,−1,0,1,0,−1,0,1,0,1,0,1,0,1,0,1,0,−1,0,−1,0,−1,0,1,0,−1,0,−1,0,1,0,1,0,1,0,−1,0,−1,0,−1,0,1,0,−1,0,−1,0,1,0,1,0,−1,0,−1,0,−1,0,−1,0,1,0,1,0,−1,0,1,0,1,0,1,0,−1,0,1,0,−1,0,−1,0,1,0,−1,0,1,0,1,0,1,0,1,0,1,0,1,0,−1,0,−1,0,1,0,−1,0,1,0,−1,0,1,0,−1,0,1,0,1,0,−1,0,1,0,1,0,−1,0,−1,0,−1,0,−1,0,1,0,1,0,1,0,−1,0,−1,0,1,0,−1,0,−1,0,−1,0,1,0,1,0,−1,0,1,0,−1,0,1,0,−1,0,0,0,0,0,0,0,0,0,0,0}
For 160 MHz transmission, the N-TF sequence with the format of an HELTF2X160, optimized for estimation order P=7, is given by:
N-TF(HELTF2X160,P=7)=sqrt(2048/996)·{0,0,0,0,0,0,0,0,0,0,0,0,1,0,−1,0,−1,0,1,0,1,0,1,0,−1,0,−1,0,−1,0,1,0,−1,0,−1,0,1,0,−1,0,−1,0,−1,0,1,0,1,0,−1,0,1,0,1,0,−1,0,1,0,1,0,1,0,−1,0,1,0,1,0,1,0,−1,0,−1,0,1,0,1,0,1,0,1,0,−1,0,−1,0,−1,0,1,0,−1,0,−1,0,−1,0,1,0,1,0,1,0,1,0,1,0,−1,0,1,0,1,0,1,0,−1,0,−1,0,−1,0,−1,0,1,0,1,0,1,0,1,0,−1,0,−1,0,1,0,−1,0,1,0,1,0,1,0,−1,0,−1,0,1,0,−1,0,−1,0,−1,0,−1,0,−1,0,−1,0,1,0,1,0,−1,0,−1,0,1,0,1,0,−1,0,1,0,−1,0,−1,0,−1,0,1,0,−1,0,1,0,−1,0,−1,0,−1,0,1,0,−1,0,−1,0,−1,0,1,0,1,0,1,0,−1,0,−1,0,1,0,1,0,−1,0,−1,0,−1,0,1,0,1,0,1,0,1,0,−1,0,−1,0,−1,0,1,0,−1,0,1,0,1,0,1,0,1,0,−1,0,1,0,−1,0,−1,0,1,0,−1,0,−1,0,1,0,−1,0,1,0,−1,0,−1,0,1,0,1,0,−1,0,−1,0,−1,0,−1,0,1,0,−1,0,1,0,−1,0,−1,0,1,0,1,0,−1,0,−1,0,1,0,−1,0,−1,0,−1,0,1,0,−1,0,−1,0,1,0,−1,0,1,0,1,0,1,0,1,0,1,0,−1,0,−1,0,−1,0,−1,0,−1,0,−1,0,−1,0,−1,0,1,0,1,0,1,0,−1,0,1,0,−1,0,1,0,−1,0,1,0,−1,0,−1,0,−1,0,−1,0,−1,0,1,0,1,0,1,0,1,0,1,0,1,0,1,0,−1,0,1,0,−1,0,1,0,−1,0,−1,0,1,0,1,0,−1,0,−1,0,1,0,1,0,1,0,1,0,1,0,−1,0,1,0,−1,0,−1,0,−1,0,−1,0,−1,0,1,0,−1,0,−1,0,−1,0,1,0,1,0,1,0,1,0,−1,0,1,0,−1,0,1,0,−1,0,−1,0,1,0,−1,0,1,0,1,0,1,0,1,0,−1,0,1,0,1,0,1,0,1,0,1,0,−1,0,1,0,−1,0,−1,0,−1,0,−1,0,1,0,1,0,−1,0,−1,0,−1,0,−1,0,0,0,0,0,0,0,−1,0,−1,0,−1,0,1,0,1,0,1,0,−1,0,1,0,−1,0,−1,0,1,0,−1,0,1,0,−1,0,1,0,−1,0,1,0,1,0,−1,0,−1,0,1,0,1,0,1,0,1,0,−1,0,−1,0,1,0,−1,0,1,0,−1,0,−1,0,1,0,1,0,−1,0,−1,0,−1,0,1,0,−1,0,1,0,−1,0,1,0,−1,0,−1,0,−1,0,1,0,1,0,−1,0,−1,0,−1,0,1,0,−1,0,−1,0,−1,0,1,0,−1,0,1,0,1,0,1,0,1,0,1,0,−1,0,1,0,1,0,1,0,−1,0,−1,0,1,0,1,0,1,0,1,0,1,0,−1,0,−1,0,1,0,1,0,−1,0,1,0,1,0,1,0,−1,0,1,0,−1,0,1,0,−1,0,1,0,1,0,1,0,−1,0,−1,0,−1,0,1,0,1,0,−1,0,−1,0,−1,0,−1,0,−1,0,1,0,1,0,−1,0,−1,0,−1,0,1,0,1,0,1,0,−1,0,−1,0,−1,0,1,0,−1,0,−1,0,−1,0,−1,0,−1,0,1,0,1,0,1,0,−1,0,−1,0,−1,0,1,0,−1,0,1,0,1,0,1,0,−1,0,1,0,−1,0,1,0,−1,0,−1,0,1,0,−1,0,1,0,1,0,−1,0,1,0,1,0,1,0,−1,0,−1,0,1,0,−1,0,−1,0,1,0,1,0,1,0,−1,0,−1,0,−1,0,−1,0,−1,0,−1,0,1,0,1,0,1,0,1,0,1,0,1,0,1,0,1,0,−1,0,1,0,1,0,−1,0,−1,0,−1,0,−1,0,−1,0,−1,0,1,0,−1,0,1,0,−1,0,1,0,−1,0,1,0,−1,0,−1,0,−1,0,1,0,−1,0,1,0,−1,0,−1,0,−1,0,1,0,1,0,−1,0,−1,0,1,0,1,0,−1,0,−1,0,−1,0,1,0,1,0,1,0,1,0,−1,0,−1,0,−1,0,−1,0,−1,0,−1,0,1,0,1,0,−1,0,−1,0,−1,0,−1,0,1,0,−1,0,1,0,1,0,−1,0,1,0,−1,0,−1,0,−1,0,1,0,−1,0,1,0,1,0,−1,0,−1,0,−1,0,−1,0,1,0,1,0,−1,0,−1,0,1,0,1,0,−1,0,1,0,1,0,1,0,−1,0,1,0,−1,0,1,0,−1,0,−1,0,1,0,−1,0,−1,0,−1,0,−1,0,0,0,0,0,0,0,0,0,0,0,0,0,0,0,0,0,0,0,0,0,0,0,1,0,−1,0,−1,0,−1,0,−1,0,−1,0,−1,0,−1,0,−1,0,−1,0,1,0,1,0,−1,0,1,0,1,0,1,0,−1,0,−1,0,1,0,1,0,−1,0,1,0,−1,0,−1,0,−1,0,−1,0,−1,0,1,0,1,0,−1,0,1,0,1,0,−1,0,1,0,−1,0,1,0,−1,0,1,0,1,0,1,0,1,0,−1,0,−1,0,1,0,1,0,−1,0,−1,0,1,0,−1,0,1,0,1,0,1,0,−1,0,−1,0,1,0,1,0,1,0,−1,0,1,0,1,0,1,0,1,0,−1,0,−1,0,−1,0,−1,0,1,0,1,0,1,0,−1,0,1,0,1,0,1,0,1,0,1,0,−1,0,1,0,1,0,1,0,−1,0,−1,0,−1,0,−1,0,1,0,1,0,−1,0,−1,0,1,0,1,0,1,0,−1,0,−1,0,1,0,−1,0,−1,0,1,0,1,0,−1,0,1,0,1,0,1,0,1,0,1,0,−1,0,1,0,−1,0,1,0,1,0,1,0,−1,0,1,0,−1,0,1,0,1,0,1,0,−1,0,−1,0,−1,0,1,0,1,0,1,0,−1,0,−1,0,−1,0,−1,0,−1,0,−1,0,−1,0,1,0,1,0,1,0,1,0,1,0,−1,0,1,0,−1,0,1,0,−1,0,1,0,−1,0,1,0,1,0,−1,0,−1,0,−1,0,1,0,−1,0,1,0,1,0,−1,0,−1,0,1,0,1,0,−1,0,1,0,−1,0,−1,0,−1,0,−1,0,1,0,1,0,−1,0,−1,0,−1,0,1,0,−1,0,−1,0,−1,0,−1,0,−1,0,−1,0,−1,0,−1,0,−1,0,−1,0,−1,0,1,0,1,0,1,0,−1,0,−1,0,1,0,1,0,1,0,1,0,1,0,−1,0,−1,0,1,0,1,0,−1,0,−1,0,−1,0,1,0,1,0,1,0,−1,0,−1,0,−1,0,−1,0,1,0,−1,0,−1,0,−1,0,−1,0,1,0,1,0,−1,0,1,0,−1,0,1,0,1,0,1,0,−1,0,−1,0,−1,0,−1,0,−1,0,−1,0,−1,0,−1,0,−1,0,−1,0,1,0,−1,0,1,0,−1,0,1,0,1,0,1,0,−1,0,−1,0,−1,0,−1,0,1,0,−1,0,1,0,1,0,−1,0,1,0,−1,0,1,0,1,0,−1,0,−1,0,1,0,1,0,−1,0,1,0,0,0,0,0,0,0,1,0,1,0,−1,0,−1,0,−1,0,1,0,−1,0,−1,0,−1,0,−1,0,−1,0,−1,0,1,0,1,0,−1,0,−1,0,1,0,1,0,1,0,−1,0,1,0,−1,0,−1,0,−1,0,1,0,−1,0,−1,0,1,0,1,0,1,0,−1,0,1,0,1,0,1,0,−1,0,1,0,−1,0,1,0,−1,0,−1,0,1,0,−1,0,1,0,−1,0,1,0,−1,0,1,0,1,0,1,0,−1,0,1,0,1,0,1,0,1,0,1,0,−1,0,−1,0,−1,0,1,0,1,0,1,0,1,0,1,0,1,0,1,0,−1,0,1,0,−1,0,−1,0,1,0,1,0,−1,0,1,0,−1,0,−1,0,1,0,1,0,1,0,1,0,1,0,1,0,−1,0,−1,0,−1,0,−1,0,−1,0,−1,0,−1,0,−1,0,−1,0,1,0,−1,0,1,0,−1,0,1,0,1,0,1,0,−1,0,1,0,−1,0,−1,0,−1,0,1,0,−1,0,−1,0,−1,0,−1,0,−1,0,−1,0,1,0,1,0,−1,0,−1,0,−1,0,1,0,−1,0,1,0,1,0,1,0,−1,0,−1,0,1,0,−1,0,−1,0,1,0,−1,0,1,0,−1,0,−1,0,−1,0,−1,0,−1,0,1,0,1,0,1,0,−1,0,1,0,−1,0,1,0,−1,0,1,0,1,0,1,0,1,0,−1,0,1,0,1,0,−1,0,1,0,−1,0,−1,0,−1,0,−1,0,−1,0,1,0,1,0,−1,0,−1,0,1,0,1,0,1,0,−1,0,−1,0,1,0,1,0,1,0,1,0,−1,0,−1,0,−1,0,1,0,1,0,1,0,−1,0,1,0,−1,0,1,0,1,0,1,0,−1,0,−1,0,−1,0,1,0,1,0,−1,0,1,0,1,0,1,0,1,0,−1,0,1,0,−1,0,−1,0,1,0,1,0,1,0,1,0,1,0,1,0,−1,0,1,0,−1,0,1,0,−1,0,−1,0,−1,0,1,0,−1,0,1,0,1,0,1,0,1,0,−1,0,−1,0,−1,0,−1,0,1,0,1,0,1,0,−1,0,−1,0,1,0,1,0,−1,0,−1,0,1,0,−1,0,−1,0,1,0,1,0,1,0,−1,0,−1,0,−1,0,1,0,1,0,1,0,−1,0,−1,0,1,0,1,0,1,0,−1,0,1,0,−1,0,−1,0,1,0,−1,0,−1,0,0,0,0,0,0,0,0,0,0,0}
For 160 MHz transmission, the N-TF sequence with the format of an HELTF2X160, optimized for estimation order P=8, is given by:
N-TF(HELTF2X160,P=8)=sqrt(2048/996)·{0,0,0,0,0,0,0,0,0,0,0,0,1,0,−1,0,1,0,−1,0,−1,0,−1,0,−1,0,1,0,1,0,−1,0,−1,0,1,0,1,0,1,0,−1,0,−1,0,1,0,1,0,1,0,−1,0,−1,0,1,0,−1,0,−1,0,1,0,1,0,1,0,−1,0,1,0,−1,0,−1,0,−1,0,−1,0,−1,0,1,0,1,0,−1,0,1,0,1,0,1,0,1,0,−1,0,−1,0,−1,0,−1,0,1,0,1,0,1,0,1,0,−1,0,1,0,1,0,−1,0,1,0,1,0,1,0,1,0,1,0,−1,0,1,0,1,0,−1,0,1,0,1,0,1,0,1,0,1,0,−1,0,−1,0,1,0,1,0,1,0,1,0,−1,0,−1,0,1,0,−1,0,1,0,−1,0,−1,0,−1,0,−1,0,−1,0,−1,0,1,0,1,0,−1,0,1,0,−1,0,−1,0,−1,0,−1,0,−1,0,1,0,1,0,1,0,1,0,−1,0,1,0,1,0,1,0,1,0,1,0,−1,0,−1,0,−1,0,1,0,−1,0,1,0,1,0,1,0,1,0,−1,0,−1,0,1,0,1,0,−1,0,1,0,−1,0,1,0,1,0,−1,0,−1,0,1,0,1,0,−1,0,1,0,1,0,1,0,1,0,1,0,1,0,1,0,−1,0,−1,0,1,0,−1,0,−1,0,−1,0,1,0,1,0,1,0,−1,0,1,0,1,0,1,0,1,0,−1,0,1,0,−1,0,1,0,1,0,−1,0,1,0,1,0,−1,0,1,0,1,0,1,0,1,0,−1,0,−1,0,1,0,−1,0,1,0,1,0,−1,0,−1,0,1,0,1,0,−1,0,−1,0,1,0,−1,0,1,0,1,0,−1,0,1,0,−1,0,−1,0,−1,0,−1,0,1,0,−1,0,−1,0,−1,0,1,0,1,0,1,0,1,0,−1,0,−1,0,−1,0,1,0,−1,0,1,0,−1,0,−1,0,1,0,1,0,1,0,1,0,1,0,1,0,1,0,−1,0,1,0,1,0,−1,0,1,0,−1,0,−1,0,1,0,−1,0,1,0,−1,0,1,0,−1,0,−1,0,1,0,−1,0,−1,0,1,0,1,0,1,0,1,0,1,0,−1,0,1,0,−1,0,1,0,−1,0,−1,0,1,0,1,0,1,0,1,0,1,0,1,0,1,0,1,0,−1,0,−1,0,−1,0,−1,0,−1,0,1,0,1,0,−1,0,0,0,0,0,0,0,1,0,1,0,1,0,1,0,−1,0,1,0,−1,0,−1,0,1,0,1,0,−1,0,−1,0,1,0,−1,0,−1,0,1,0,−1,0,1,0,−1,0,−1,0,1,0,−1,0,1,0,−1,0,−1,0,1,0,1,0,−1,0,−1,0,1,0,1,0,1,0,1,0,−1,0,1,0,1,0,−1,0,1,0,1,0,−1,0,−1,0,1,0,−1,0,−1,0,1,0,1,0,1,0,1,0,−1,0,1,0,1,0,−1,0,1,0,−1,0,−1,0,−1,0,1,0,−1,0,1,0,1,0,1,0,1,0,1,0,−1,0,−1,0,1,0,−1,0,−1,0,1,0,−1,0,1,0,−1,0,−1,0,1,0,1,0,−1,0,1,0,−1,0,−1,0,1,0,1,0,−1,0,1,0,−1,0,1,0,1,0,1,0,1,0,1,0,1,0,−1,0,1,0,−1,0,−1,0,−1,0,1,0,1,0,−1,0,1,0,−1,0,1,0,1,0,−1,0,1,0,−1,0,1,0,−1,0,−1,0,1,0,1,0,1,0,−1,0,1,0,−1,0,−1,0,−1,0,1,0,−1,0,1,0,1,0,−1,0,1,0,1,0,−1,0,1,0,−1,0,1,0,1,0,1,0,1,0,1,0,1,0,−1,0,1,0,1,0,−1,0,1,0,1,0,1,0,1,0,1,0,−1,0,1,0,1,0,−1,0,1,0,−1,0,1,0,1,0,−1,0,1,0,−1,0,1,0,1,0,1,0,1,0,−1,0,−1,0,1,0,1,0,−1,0,1,0,1,0,−1,0,1,0,1,0,1,0,−1,0,−1,0,1,0,−1,0,1,0,−1,0,−1,0,1,0,1,0,1,0,−1,0,−1,0,−1,0,−1,0,−1,0,1,0,1,0,1,0,1,0,−1,0,1,0,1,0,1,0,−1,0,1,0,1,0,−1,0,1,0,1,0,−1,0,1,0,−1,0,1,0,1,0,1,0,−1,0,−1,0,−1,0,−1,0,1,0,−1,0,−1,0,−1,0,−1,0,1,0,1,0,1,0,1,0,1,0,1,0,1,0,1,0,1,0,−1,0,1,0,1,0,1,0,1,0,−1,0,1,0,1,0,1,0,1,0,1,0, 1,0, 1,0,−1, 0,−1,0,−1,0,−1,0,1,0,−1,0,−1,0,1,0,1,0,−1,0,1,0,1,0,1,0,1,0,1,0,1,0,0,0,0,0,0,0,0,0,0,0,0,0,0,0,0,0,0,0,0,0,0,0,1,0,1,0,1,0,−1,0,−1,0,1,0,−1,0,−1,0,−1,0,−1,0,−1,0,−1,0,1,0,1,0,1,0,1,0,1,0,−1,0,−1,0,1,0,−1,0,−1,0,−1,0,−1,0,1,0,1,0,1,0,−1,0,−1,0,−1,0,1,0,1,0,1,0,−1,0,1,0,−1,0,1,0,−1,0,−1,0,−1,0,−1,0,1,0,−1,0,1,0,1,0,−1,0,1,0,−1,0,−1,0,1,0,1,0,1,0,1,0,1,0,1,0,−1,0,1,0,1,0,1,0,1,0,−1,0,1,0,1,0,1,0,−1,0,1,0,−1,0,1,0,−1,0,−1,0,−1,0,1,0,−1,0,1,0,1,0,1,0,−1,0,−1,0,1,0,1,0,−1,0,−1,0,−1,0,1,0,−1,0,−1,0,−1,0,−1,0,−1,0,1,0,1,0,1,0,−1,0,−1,0,−1,0,−1,0,−1,0,−1,0,1,0,−1,0,1,0,1,0,1,0,1,0,1,0,1,0,−1,0,1,0,−1,0,1,0,1,0,−1,0,1,0,1,0,1,0,1,0,−1,0,−1,0,−1,0,1,0,−1,0,1,0,1,0,1,0,1,0,1,0,−1,0,−1,0,1,0,−1,0,1,0,−1,0,−1,0,−1,0,1,0,−1,0,1,0,1,0,−1,0,1,0,1,0,−1,0,−1,0,−1,0,1,0,1,0,−1,0,1,0,−1,0,1,0,1,0,1,0,1,0,−1,0,−1,0,1,0,1,0,1,0,1,0,−1,0,−1,0,−1,0,−1,0,−1,0,−1,0,1,0,1,0,−1,0,1,0,−1,0,1,0,1,0,−1,0,−1,0,1,0,1,0,1,0,−1,0,1,0,1,0,1,0,1,0,1,0,−1,0,−1,0,−1,0,−1,0,1,0,−1,0,1,0,−1,0,−1,0,1,0,−1,0,1,0,1,0,−1,0,−1,0,1,0,1,0,1,0,1,0,1,0,1,0,−1,0,−1,0,1,0,1,0,−1,0,1,0,1,0,−1,0,1,0,1,0,−1,0,−1,0,1,0,1,0,−1,0,−1,0,−1,0,−1,0,1,0,1,0,1,0,−1,0,1,0,−1,0,−1,0,−1,0,1,0,1,0,1,0,1,0,1,0,−1,0,1,0,1,0,−1,0,1,0,1,0,1,0,1,0,1,0,−1,0,1,0,1,0,1,0,−1,0,0,0,0,0,0,0,1,0,1,0,1,0,1,0,−1,0,−1,0,1,0,1,0,−1,0,1,0,−1,0,1,0,1,0,−1,0,1,0,1,0,−1,0,−1,0,−1,0,−1,0,1,0,1,0,1,0,−1,0,1,0,−1,0,−1,0,1,0,1,0,−1,0,1,0,−1,0,1,0,1,0,−1,0,1,0,1,0,1,0,−1,0,1,0,1,0,−1,0,1,0,−1,0,1,0,−1,0,−1,0,−1,0,−1,0,1,0,1,0,1,0,1,0,−1,0,1,0,−1,0,1,0,1,0,1,0,1,0,1,0,1,0,−1,0,−1,0,1,0,−1,0,1,0,1,0,−1,0,1,0,−1,0,−1,0,−1,0,1,0,−1,0,1,0,1,0,−1,0,1,0,−1,0,1,0,1,0,1,0,−1,0,1,0,−1,0,−1,0,1,0,−1,0,1,0,1,0,−1,0,1,0,1,0,1,0,−1,0,−1,0,−1,0,1,0,1,0,−1,0,−1,0,1,0,1,0,1,0,−1,0,1,0,−1,0,1,0,1,0,−1,0,−1,0,1,0,1,0,1,0,1,0,−1,0,1,0,−1,0,−1,0,−1,0,−1,0,−1,0,−1,0,1,0,−1,0,−1,0,1,0,−1,0,1,0,−1,0,−1,0,−1,0,1,0,1,0,1,0,1,0,1,0,1,0,1,0,−1,0,−1,0,−1,0,1,0,1,0,1,0,1,0,−1,0,1,0,1,0,−1,0,−1,0,−1,0,−1,0,−1,0,−1,0,1,0,1,0,1,0,1,0,1,0,1,0,1,0,1,0,−1,0,−1,0,1,0,−1,0,−1,0,1,0,1,0,1,0,1,0,1,0,−1,0,1,0,−1,0,−1,0,1,0,−1,0,1,0,−1,0,1,0,−1,0,1,0,−1,0,−1,0,1,0,−1,0,1,0,1,0,−1,0,1,0,−1,0,1,0,−1,0,1,0,−1,0,−1,0,1,0,−1,0,1,0,1,0,−1,0,1,0,1,0,−1,0,1,0,1,0,−1,0,1,0,1,0,1,0,−1,0,1,0,−1,0,−1,0,1,0,1,0,−1,0,1,0,1,0,1,0,1,0,1,0,−1,0,−1,0,1,0,−1,0,−1,0,−1,0,1,0,1,0,1,0,1,0,1,0,1,0,−1,0,−1,0,1,0,−1,0,1,0,1,0,−1,0,1,0,−1,0,1,0,1,0,1,0,0,0,0,0,0,0,0,0,0,0}
For 160 MHz transmission, the N-TF sequence with the format of an HELTF2X160, optimized for estimation order P=9, is given by:
N-TF(HELTF2X160,P=9)=sqrt(2048/996)·{0,0,0,0,0,0,0,0,0,0,0,0,1,0,1,0,1,0,−1,0,1,0,−1,0,1,0,1,0,1,0,1,0,1,0,1,0,1,0,1,0,1,0,−1,0,1,0,1,0,1,0,−1,0,−1,0,1,0,−1,0,1,0,1,0,1,0,1,0,1,0,−1,0,−1,0,−1,0,−1,0,−1,0,−1,0,−1,0,−1,0,−1,0,1,0,1,0,−1,0,−1,0,1,0,−1,0,−1,0,−1,0,1,0,1,0,1,0,1,0,−1,0,1,0,1,0,1,0,1,0,1,0,−1,0,1,0,−1,0,1,0,1,0,1,0,1,0,1,0,1,0,−1,0,1,0,1,0,1,0,−1,0,1,0,1,0,1,0,1,0,−1,0,1,0,1,0,−1,0,1,0,−1,0,−1,0,1,0,1,0,−1,0,1,0,1,0,−1,0,−1,0,1,0,−1,0,−1,0,−1,0,1,0,−1,0,1,0,−1,0,1,0,1,0,−1,0,1,0,1,0,1,0,−1,0,1,0,−1,0,1,0,−1,0,−1,0,−1,0,1,0,1,0,1,0,1,0,1,0,−1,0,1,0,1,0,−1,0,1,0,−1,0,1,0,1,0,1,0,−1,0,1,0,1,0,−1,0,1,0,−1,0,1,0,1,0,−1,0,−1,0,1,0,−1,0,−1,0,1,0,−1,0,−1,0,−1,0,1,0,1,0,1,0,−1,0,1,0,1,0,1,0,−1,0,−1,0,1,0,1,0,1,0,1,0,−1,0,1,0,1,0,−1,0,1,0,1,0,−1,0,1,0,−1,0,−1,0,1,0,−1,0,1,0,1,0,−1,0,−1,0,−1,0,1,0,−1,0,−1,0,−1,0,−1,0,1,0,1,0,−1,0,1,0,1,0,−1,0,1,0,−1,0,1,0,−1,0,−1,0,−1,0,1,0,1,0,1,0,−1,0,−1,0,−1,0,−1,0,1,0,−1,0,1,0,−1,0,−1,0,1,0,1,0,−1,0,1,0,−1,0,1,0,1,0,−1,0,1,0,−1,0,−1,0,−1,0,−1,0,−1,0,1,0,−1,0,1,0,−1,0,−1,0,−1,0,−1,0,1,0,−1,0,−1,0,1,0,1,0,1,0,1,0,1,0,−1,0,1,0,1,0,1,0,−1,0,1,0,−1,0,1,0,1,0,1,0,1,0,1,0,1,0,−1,0,−1,0,−1,0,−1,0,−1,0,−1,0,1,0,1,0,−1,0,0,0,0,0,0,0,1,0,1,0,1,0,−1,0,−1,0,1,0,1,0,−1,0,1,0,−1,0,−1,0,−1,0,1,0,−1,0,−1,0,1,0,−1,0,1,0,−1,0,−1,0,1,0,−1,0,1,0,−1,0,−1,0,1,0,1,0,−1,0,−1,0,−1,0,−1,0,1,0,1,0,−1,0,1,0,−1,0,−1,0,1,0,1,0,−1,0,1,0,−1,0,−1,0,−1,0,1,0,1,0,−1,0,1,0,−1,0,1,0,1,0,1,0,−1,0,−1,0,−1,0,−1,0,1,0,−1,0,1,0,1,0,−1,0,1,0,1,0,1,0,−1,0,1,0,−1,0,−1,0,1,0,−1,0,−1,0,1,0,−1,0,1,0,1,0,−1,0,1,0,−1,0,−1,0,1,0,1,0,−1,0,1,0,−1,0,−1,0,1,0,1,0,1,0,1,0,−1,0,−1,0,1,0,1,0,−1,0,1,0,1,0,1,0,−1,0,1,0,−1,0,1,0,−1,0,−1,0,1,0,−1,0,1,0,−1,0,−1,0,1,0,1,0,1,0,1,0,−1,0,1,0,−1,0,1,0,1,0,1,0,1,0,−1,0,−1,0,1,0,1,0,1,0,1,0,1,0,1,0,1,0,1,0,1,0,−1,0,−1,0,−1,0,1,0,1,0,−1,0,−1,0,1,0,1,0,1,0,1,0,−1,0,1,0,1,0,−1,0,1,0,−1,0,−1,0,1,0,−1,0,1,0,−1,0,−1,0,1,0,1,0,−1,0,−1,0,1,0,−1,0,1,0,−1,0,1,0,1,0,1,0,1,0,1,0,−1,0,1,0,−1,0,1,0,−1,0,1,0,1,0,1,0,1,0,1,0,1,0,−1,0,−1,0,1,0,−1,0,−1,0,1,0,1,0,1,0,1,0,1,0,1,0,−1,0,1,0,1,0,−1,0,−1,0,−1,0,1,0,1,0,−1,0,1,0,1,0,1,0,1,0,−1,0,−1,0,−1,0,1,0,−1,0,1,0,−1,0,−1,0,1,0,−1,0,1,0,1,0,−1,0,1,0,1,0,1,0,1,0,1,0,1,0,−1,0,−1,0,1,0,−1,0,1,0,1,0,−1,0,1,0,1,0,1,0,1,0,1,0,1,0,−1,0,−1,0,−1,0,1,0,1,0,−1,0,−1,0,−1,0,1,0,1,0,1,0,−1,0,1,0,1,0,−1,0,1,0,0,0,0,0,0,0,0,0,0,0,0,0,0,0,0,0,0,0,0,0,0,0,1,0,1,0,1,0,−1,0,1,0,1,0,−1,0,1,0,−1,0,−1,0,−1,0,−1,0,1,0,−1,0,1,0,−1,0,1,0,1,0,−1,0,1,0,−1,0,−1,0,−1,0,−1,0,1,0,1,0,1,0,−1,0,−1,0,−1,0,1,0,1,0,1,0,1,0,−1,0,−1,0,1,0,1,0,1,0,−1,0,−1,0,−1,0,−1,0,1,0,1,0,−1,0,1,0,1,0,1,0,1,0,1,0,1,0,1,0,1,0,1,0,1,0,1,0,1,0,1,0,1,0,−1,0,1,0,1,0,1,0,−1,0,1,0,−1,0,1,0,1,0,−1,0,1,0,1,0,−1,0,1,0,−1,0,−1,0,−1,0,−1,0,1,0,−1,0,−1,0,−1,0,1,0,1,0,1,0,−1,0,−1,0,−1,0,1,0,1,0,1,0,1,0,−1,0,1,0,−1,0,1,0,1,0,1,0,1,0,−1,0,1,0,1,0,1,0,1,0,1,0,1,0,−1,0,1,0,−1,0,1,0,1,0,−1,0,1,0,1,0,1,0,1,0,−1,0,1,0,1,0,1,0,−1,0,1,0,1,0,1,0,1,0,1,0,−1,0,−1,0,1,0,−1,0,1,0,−1,0,−1,0,−1,0,1,0,1,0,1,0,1,0,−1,0,−1,0,1,0,−1,0,−1,0,−1,0,1,0,1,0,−1,0,1,0,−1,0,1,0,1,0,1,0,1,0,−1,0,1,0,1,0,1,0,−1,0,−1,0,−1,0,−1,0,1,0,−1,0,−1,0,−1,0,1,0,−1,0,1,0,1,0,−1,0,1,0,−1,0,−1,0,−1,0,−1,0,1,0,1,0,1,0,1,0,1,0,1,0,1,0,−1,0,−1,0,−1,0,−1,0,1,0,1,0,−1,0,1,0,−1,0,−1,0,−1,0,1,0,1,0,−1,0,−1,0,1,0,−1,0,1,0,1,0,1,0,1,0,1,0,−1,0,−1,0,1,0,1,0,1,0,1,0,1,0,1,0,1,0,1,0,−1,0,−1,0,1,0,−1,0,−1,0,−1,0,1,0,−1,0,−1,0,1,0,1,0,1,0,1,0,−1,0,−1,0,−1,0,1,0,1,0,−1,0,1,0,1,0,−1,0,1,0,1,0,−1,0,1,0,1,0,1,0,1,0,1,0,−1,0,1,0,1,0,1,0,−1,0,0,0,0,0,0,0,1,0,1,0,1,0,1,0,−1,0,−1,0,1,0,1,0,−1,0,1,0,−1,0,1,0,1,0,−1,0,1,0,1,0,−1,0,−1,0,−1,0,1,0,1,0,1,0,−1,0,−1,0,1,0,−1,0,1,0,1,0,−1,0,1,0,1,0,1,0,1,0,1,0,−1,0,1,0,1,0,1,0,−1,0,−1,0,−1,0,1,0,1,0,−1,0,1,0,−1,0,−1,0,1,0,−1,0,1,0,1,0,−1,0,−1,0,−1,0,1,0,−1,0,1,0,1,0,1,0,1,0,1,0,1,0,1,0,1,0,1,0,−1,0,1,0,1,0,−1,0,1,0,−1,0,−1,0,1,0,1,0,−1,0,1,0,−1,0,−1,0,1,0,1,0,1,0,−1,0,1,0,−1,0,1,0,−1,0,−1,0,1,0,−1,0,−1,0,−1,0,1,0,1,0,1,0,−1,0,−1,0,1,0,−1,0,−1,0,1,0,−1,0,−1,0,1,0,1,0,1,0,1,0,1,0,−1,0,1,0,1,0,−1,0,−1,0,1,0,1,0,1,0,1,0,−1,0,1,0,1,0,−1,0,−1,0,−1,0,1,0,1,0,1,0,−1,0,1,0,1,0,1,0,1,0,1,0,−1,0,−1,0,1,0,−1,0,1,0,1,0,−1,0,1,0,1,0,−1,0,−1,0,−1,0,−1,0,−1,0,1,0,−1,0,−1,0,1,0,1,0,−1,0,−1,0,−1,0,−1,0,−1,0,−1,0,1,0,1,0,1,0,1,0,1,0,−1,0,1,0,1,0,−1,0,1,0,−1,0,−1,0,1,0,1,0,1,0,1,0,1,0,−1,0,−1,0,−1,0,1,0,−1,0,1,0,−1,0,1,0,1,0,1,0,1,0,−1,0,−1,0,1,0,1,0,1,0,1,0,−1,0,−1,0,−1,0,−1,0,1,0,1,0,−1,0,−1,0,−1,0,1,0,1,0,1,0,1,0,−1,0,−1,0,−1,0,−1,0,1,0,−1,0,−1,0,1,0,1,0,1,0,−1,0,1,0,−1,0,−1,0,−1,0,−1,0,1,0,1,0,−1,0,1,0,1,0,1,0,−1,0,−1,0,1,0,−1,0,−1,0,1,0,1,0,1,0,1,0,1,0,1,0,1,0,1,0,−1,0,1,0,−1,0,1,0,−1,0,−1,0,−1,0,−1,0,1,0,1,0,−1,0,0,0,0,0,0,0,0,0,0,0}
For 160 MHz transmission, the N-TF sequence with the format of an HELTF2X160, optimized for estimation order P=10, is given by:
N-TF(HELTF2X160,P=10)=sqrt(2048/996)·{0,0,0,0,0,0,0,0,0,0,0,0,1,0,−1,0,1,0,1,0,−1,0,−1,0,−1,0,1,0,1,0,1,0,1,0,−1,0,1,0,1,0,−1,0,−1,0,−1,0,1,0,−1,0,1,0,1,0,−1,0,−1,0,−1,0,−1,0,1,0,1,0,−1,0,1,0,−1,0,1,0,−1,0,1,0,−1,0,1,0,1,0,−1,0,1,0,−1,0,1,0,−1,0,−1,0,1,0,1,0,1,0,−1,0,1,0,−1,0,−1,0,1,0,1,0,−1,0,1,0,1,0,1,0,−1,0,−1,0,−1,0,1,0,1,0,−1,0,−1,0,1,0,−1,0,−1,0,1,0,−1,0,−1,0,−1,0,1,0,−1,0,1,0,1,0,−1,0,−1,0,1,0,1,0,1,0,−1,0,−1,0,−1,0,−1,0,−1,0,−1,0,−1,0,−1,0,−1,0,−1,0,1,0,1,0,−1,0,1,0,1,0,1,0,1,0,−1,0,−1,0,−1,0,−1,0,−1,0,−1,0,−1,0,−1,0,−1,0,1,0,−1,0,−1,0,−1,0,−1,0,1,0,1,0,−1,0,−1,0,−1,0,−1,0,1,0,1,0,−1,0,−1,0,1,0,−1,0,1,0,−1,0,1,0,−1,0,−1,0,1,0,1,0,−1,0,1,0,−1,0,1,0,−1,0,−1,0,1,0,−1,0,1,0,−1,0,1,0,−1,0,−1,0,−1,0,−1,0,1,0,−1,0,1,0,1,0,−1,0,−1,0,1,0,1,0,−1,0,−1,0,−1,0,1,0,1,0,−1,0,−1,0,−1,0,1,0,1,0,1,0,−1,0,1,0,1,0,−1,0,−1,0,−1,0,1,0,1,0,−1,0,−1,0,1,0,1,0,−1,0,1,0,1,0,−1,0,1,0,1,0,−1,0,1,0,−1,0,−1,0,1,0,1,0,−1,0,−1,0,−1,0,−1,0,1,0,1,0,−1,0,1,0,−1,0,1,0,1,0,1,0,−1,0,1,0,−1,0,−1,0,1,0,−1,0,−1,0,1,0,1,0,−1,0,1,0,1,0,−1,0,−1,0,1,0,1,0,1,0,−1,0,−1,0,−1,0,1,0,−1,0,−1,0,1,0,1,0,1,0,1,0,−1,0,−1,0,1,0,1,0,1,0,−1,0,1,0,1,0,−1,0,−1,0,1,0,−1,0,−1,0,1,0,−1,0,1,0,1,0,1,0,−1,0,1,0,1,0,−1,0,1,0,−1,0,0,0,0,0,0,0,−1,0,1,0,1,0,−1,0,−1,0,1,0,−1,0,−1,0,1,0,−1,0,−1,0,−1,0,−1,0,1,0,−1,0,−1,0,−1,0,−1,0,−1,0,1,0,−1,0,1,0,−1,0,1,0,−1,0,1,0,−1,0,−1,0,1,0,1,0,−1,0,1,0,−1,0,−1,0,1,0,1,0,−1,0,−1,0,1,0,−1,0,−1,0,−1,0,−1,0,−1,0,1,0,1,0,−1,0,1,0,−1,0,−1,0,1,0,1,0,−1,0,−1,0,1,0,1,0,−1,0,1,0,1,0,−1,0,1,0,−1,0,−1,0,−1,0,1,0,−1,0,−1,0,1,0,−1,0,−1,0,1,0,−1,0,−1,0,−1,0,1,0,1,0,−1,0,−1,0,−1,0,−1,0,1,0,−1,0,−1,0,−1,0,1,0,−1,0,1,0,−1,0,−1,0,−1,0,−1,0,−1,0,−1,0,−1,0,1,0,−1,0,−1,0,1,0,−1,0,−1,0,1,0,−1,0,−1,0,−1,0,1,0,1,0,1,0,−1,0,−1,0,1,0,−1,0,−1,0,1,0,−1,0,1,0,1,0,−1,0,1,0,1,0,1,0,−1,0,−1,0,−1,0,−1,0,1,0,−1,0,−1,0,1,0,−1,0,1,0,1,0,−1,0,1,0,1,0,1,0,−1,0,−1,0,1,0,−1,0,1,0,−1,0,1,0,1,0,1,0,−1,0,1,0,1,0,1,0,−1,0,−1,0,1,0,1,0,−1,0,−1,0,−1,0,1,0,−1,0,−1,0,−1,0,1,0,−1,0,1,0,−1,0,−1,0,−1,0,−1,0,1,0,−1,0,1,0,−1,0,−1,0,1,0,−1,0,1,0,−1,0,−1,0,−1,0,−1,0,1,0,−1,0,−1,0,−1,0,−1,0,−1,0,1,0,−1,0,1,0,−1,0,−1,0,1,0,−1,0,−1,0,1,0,1,0,−1,0,−1,0,1,0,−1,0,−1,0,−1,0,−1,0,1,0,−1,0,−1,0,−1,0,1,0,−1,0,−1,0,1,0,−1,0,−1,0,1,0,−1,0,−1,0,−1,0,1,0,−1,0,1,0,−1,0,−1,0,−1,0,−1,0,1,0,1,0,−1,0,−1,0,−1,0,1,0,1,0,−1,0,−1,0,1,0,−1,0,−1,0,−1,0,−1,0,−1,0,1,0,1,0,−1,0,1,0,−1,0,−1,0,1,0,−1,0,−1,0,−1,0,1,0,−1,0,0,0,0,0,0,0,0,0,0,0,0,0,0,0,0,0,0,0,0,0,0,0,−1,0,1,0,−1,0,1,0,−1,0,−1,0,1,0,−1,0,1,0,−1,0,−1,0,−1,0,−1,0,1,0,1,0,−1,0,1,0,−1,0,−1,0,1,0,−1,0,1,0,1,0,1,0,−1,0,−1,0,−1,0,−1,0,−1,0,1,0,−1,0,−1,0,1,0,1,0,−1,0,1,0,−1,0,−1,0,−1,0,−1,0,−1,0,1,0,1,0,1,0,1,0,1,0,−1,0,1,0,1,0,1,0,1,0,−1,0,−1,0,−1,0,−1,0,−1,0,−1,0,−1,0,−1,0,1,0,1,0,−1,0,1,0,−1,0,−1,0,−1,0,−1,0,−1,0,1,0,−1,0,1,0,1,0,1,0,−1,0,−1,0,1,0,1,0,1,0,−1,0,1,0,−1,0,1,0,1,0,1,0,1,0,1,0,1,0,−1,0,1,0,1,0,−1,0,1,0,1,0,1,0,1,0,1,0,−1,0,1,0,1,0,−1,0,−1,0,1,0,1,0,−1,0,1,0,1,0,−1,0,1,0,−1,0,−1,0,1,0,−1,0,−1,0,1,0,1,0,−1,0,−1,0,1,0,−1,0,−1,0,1,0,1,0,−1,0,1,0,−1,0,1,0,−1,0,−1,0,−1,0,1,0,−1,0,−1,0,1,0,−1,0,1,0,1,0,1,0,1,0,1,0,1,0,−1,0,−1,0,−1,0,−1,0,1,0,−1,0,1,0,−1,0,1,0,−1,0,−1,0,−1,0,−1,0,−1,0,−1,0,−1,0,−1,0,−1,0,−1,0,1,0,1,0,−1,0,−1,0,1,0,−1,0,−1,0,1,0,1,0,−1,0,1,0,−1,0,1,0,−1,0,−1,0,−1,0,−1,0,1,0,−1,0,−1,0,1,0,1,0,−1,0,−1,0,−1,0,−1,0,1,0,1,0,−1,0,1,0,1,0,−1,0,−1,0,1,0,−1,0,−1,0,1,0,−1,0,1,0,1,0,−1,0,−1,0,−1,0,1,0,−1,0,−1,0,1,0,1,0,−1,0,1,0,−1,0,−1,0,−1,0,−1,0,1,0,−1,0,1,0,−1,0,−1,0,−1,0,−1,0,−1,0,1,0,−1,0,−1,0,1,0,−1,0,−1,0,−1,0,−1,0,−1,0,−1,0,−1,0,−1,0,−1,0,−1,0,1,0,−1,0,−1,0,−1,0,−1,0,1,0,1,0,1,0,−1,0,−1,0,1,0,−1,0,1,0,1,0,0,0,0,0,0,0,−1,0,−1,0,1,0,−1,0,1,0,1,0,−1,0,−1,0,1,0,−1,0,1,0,1,0,−1,0,−1,0,1,0,−1,0,−1,0,1,0,−1,0,1,0,−1,0,−1,0,−1,0,1,0,−1,0,1,0,1,0,1,0,1,0,−1,0,1,0,1,0,−1,0,−1,0,1,0,−1,0,−1,0,1,0,−1,0,1,0,−1,0,1,0,−1,0,−1,0,1,0,1,0,−1,0,−1,0,−1,0,1,0,1,0,−1,0,1,0,−1,0,−1,0,−1,0,−1,0,1,0,−1,0,−1,0,−1,0,1,0,−1,0,−1,0,1,0,−1,0,−1,0,1,0,1,0,−1,0,1,0,−1,0,−1,0,−1,0,−1,0,−1,0,1,0,−1,0,1,0,−1,0,1,0,−1,0,−1,0,−1,0,1,0,1,0,−1,0,−1,0,1,0,1,0,1,0,−1,0,−1,0,−1,0,1,0,−1,0,−1,0,−1,0,1,0,1,0,−1,0,1,0,−1,0,1,0,−1,0,−1,0,1,0,1,0,1,0,1,0,1,0,−1,0,−1,0,−1,0,−1,0,1,0,−1,0,−1,0,−1,0,1,0,−1,0,−1,0,1,0,−1,0,1,0,−1,0,−1,0,−1,0,−1,0,−1,0,−1,0,1,0,−1,0,−1,0,−1,0,−1,0,1,0,1,0,−1,0,1,0,−1,0,1,0,1,0,−1,0,−1,0,1,0,1,0,−1,0,1,0,1,0,−1,0,1,0,1,0,−1,0,−1,0,−1,0,−1,0,1,0,−1,0,−1,0,1,0,1,0,−1,0,−1,0,−1,0,−1,0,−1,0,1,0,1,0,−1,0,−1,0,−1,0,−1,0,−1,0,−1,0,1,0,−1,0,−1,0,1,0,−1,0,−1,0,1,0,−1,0,−1,0,1,0,−1,0,1,0,1,0,1,0,−1,0,−1,0,1,0,−1,0,1,0,1,0,−1,0,−1,0,−1,0,1,0,1,0,1,0,1,0,1,0,1,0,−1,0,1,0,−1,0,1,0,−1,0,−1,0,1,0,1,0,−1,0,−1,0,1,0,1,0,1,0,1,0,1,0,−1,0,−1,0,1,0,−1,0,1,0,−1,0,−1,0,1,0,1,0,−1,0,−1,0,−1,0,−1,0,1,0,1,0,−1,0,1,0,1,0,1,0,1,0,−1,0,1,0,1,0,−1,0,1,0,1,0,1,0,−1,0,−1,0,1,0,0,0,0,0,0,0,0,0,0,0}
List24
For 160 MHz transmission, the N-TF sequence with the format of an HELTF160, optimized for estimation order P=3, is given by:
N-TF(HELTF160,P=3)=sqrt(2048/1992)·{0,0,0,0,0,0,0,0,0,0,0,0,1,−1,1,1,−1,1,−1,1,−1,−1,−1,1,−1,−1,−1,−1,−1,1,1,1,−1,−1,1,−1,1,1,−1,1,−1,1,1,−1,1,1,1,−1,−1,1,−1,1,−1,−1,1,−1,1,−1,−1,1,−1,1,1,−1,−1,−1,−1,1,−1,−1,1,1,−1,1,1,1,1,1,1,−1,−1,−1,1,−1,−1,1,1,1,−1,1,−1,1,1,1,−1,1,−1,1,−1,1,1,−1,−1,−1,−1,−1,1,1,1,1,1,−1,1,1,1,1,−1,1,−1,1,−1,−1,−1,1,−1,−1,1,1,−1,1,−1,−1,−1,−1,−1,−1,−1,−1,−1,−1,−1,−1,1,1,−1,−1,1,1,−1,−1,1,−1,1,1,1,1,−1,1,−1,1,1,−1,−1,−1,−1,1,1,−1,−1,−1,1,1,−1,−1,−1,−1,1,−1,−1,1,1,−1,1,1,−1,−1,−1,1,−1,−1,−1,−1,−1,−1,1,−1,−1,1,−1,−1,1,−1,1,−1,1,−1,−1,−1,1,1,1,−1,1,−1,1,−1,1,−1,−1,1,−1,1,1,1,1,1,−1,1,1,−1,1,−1,−1,−1,1,1,1,−1,−1,−1,−1,−1,−1,−1,1,−1,1,1,1,−1,1,1,1,1,−1,−1,1,−1,−1,1,1,−1,−1,−1,−1,−1,−1,1,−1,−1,1,1,−1,−1,−1,−1,−1,−1,−1,−1,1,1,1,1,−1,−1,−1,−1,−1,−1,−1,1,1,1,−1,−1,1,−1,−1,−1,−1,1,1,−1,1,−1,1,1,−1,−1,−1,1,1,1,1,−1,1,1,1,−1,−1,1,−1,1,1,−1,1,−1,−1,1,−1,1,1,−1,1,1,1,−1,−1,−1,−1,−1,1,−1,−1,1,1,−1,−1,−1,1,1,1,1,1,1,1,−1,−1,−1,1,1,−1,−1,1,−1,1,1,1,1,1,1,1,−1,−1,−1,1,1,−1,1,−1,−1,1,1,1,1,1,1,1,1,1,−1,1,−1,1,−1,1,−1,−1,1,−1,−1,1,1,−1,1,−1,1,1,1,1,1,1,−1,−1,1,−1,1,−1,1,−1,−1,1,−1,1,1,−1,−1,1,1,−1,−1,1,1,−1,1,1,−1,1,−1,1,−1,−1,−1,1,−1,−1,1,1,−1,1,1,−1,−1,−1,1,−1,1,1,1,1,1,1,1,1,1,1,1,−1,−1,−1,−1,1,1,1,−1,1,1,1,−1,1,−1,1,−1,1,−1,−1,1,1,1,−1,1,−1,1,1,1,1,1,1,1,1,−1,1,1,1,−1,1,−1,−1,1,−1,−1,1,−1,0,0,0,0,0,1,1,−1,−1,−1,1,−1,1,−1,1,1,−1,−1,1,1,1,−1,−1,1,−1,1,1,−1,1,−1,−1,1,−1,−1,1,1,1,−1,−1,1,−1,−1,−1,1,−1,−1,1,1,1,−1,1,1,1,−1,1,−1,1,1,1,1,1,1,1,−1,−1,−1,−1,−1,−1,−1,1,−1,−1,1,−1,−1,1,−1,1,1,1,1,1,−1,−1,1,1,1,−1,−1,1,−1,1,1,−1,−1,−1,−1,−1,−1,1,1,−1,1,1,1,1,−1,−1,1,−1,−1,−1,−1,−1,−1,1,1,1,−1,1,−1,−1,−1,−1,−1,1,1,−1,1,1,−1,−1,1,−1,1,1,−1,−1,−1,1,1,1,1,−1,−1,1,1,−1,−1,−1,1,1,1,1,1,−1,1,1,−1,1,1,1,−1,−1,−1,−1,1,−1,−1,−1,−1,−1,1,−1,−1,1,−1,−1,−1,−1,−1,1,1,1,1,1,−1,−1,−1,−1,1,−1,1,−1,1,−1,1,1,1,1,1,1,−1,−1,1,1,1,−1,−1,−1,−1,−1,−1,−1,−1,−1,1,1,1,1,1,−1,−1,1,−1,−1,1,1,−1,1,1,−1,−1,1,−1,−1,−1,−1,1,1,1,−1,−1,1,−1,−1,1,−1,−1,−1,1,1,−1,−1,1,−1,−1,−1,−1,1,1,−1,1,1,1,1,−1,−1,−1,−1,1,1,−1,−1,−1,1,−1,−1,1,−1,−1,1,−1,1,−1,−1,−1,1,−1,−1,−1,1,−1,1,1,1,1,1,1,−1,1,1,−1,1,−1,1,1,1,1,1,−1,−1,−1,1,1,1,−1,−1,1,1,−1,−1,−1,1,−1,−1,−1,−1,−1,1,1,−1,1,−1,−1,1,1,1,1,−1,−1,1,1,−1,−1,−1,1,−1,1,−1,−1,1,−1,−1,1,−1,−1,1,−1,1,−1,1,−1,−1,−1,−1,−1,1,−1,−1,1,−1,−1,1,1,1,1,1,−1,1,−1,1,−1,−1,−1,−1,−1,−1,−1,1,1,1,−1,−1,−1,−1,1,1,−1,1,−1,1,1,1,1,−1,1,1,1,1,−1,−1,1,1,−1,1,−1,1,−1,1,−1,1,1,−1,1,−1,1,1,1,1,1,1,1,−1,1,1,−1,1,1,1,1,1,1,1,1,1,1,−1,−1,−1,1,1,1,1,−1,−1,−1,1,1,−1,−1,1,1,1,−1,1,−1,1,1,−1,1,−1,1,1,1,1,1,−1,−1,1,−1,1,−1,1,1,1,−1,1,−1,−1,1,1,−1,−1,−1,−1,1,1,1,−1,1,1,0,0,0,0,0,0,0,0,0,0,0,0,0,0,0,0,0,0,0,0,0,0,0,−1,−1,−1,1,1,−1,1,1,1,−1,−1,1,−1,1,−1,1,1,1,1,−1,−1,1,−1,−1,−1,−1,1,1,1,1,1,1,1,1,1,−1,−1,−1,−1,−1,1,−1,−1,−1,−1,1,1,1,−1,1,−1,1,−1,−1,1,−1,1,−1,−1,1,−1,1,1,1,1,1,−1,1,−1,1,−1,1,−1,1,1,−1,1,−1,−1,−1,−1,1,−1,1,1,−1,−1,1,−1,−1,1,−1,1,−1,1,−1,−1,1,−1,1,−1,1,1,−1,1,−1,−1,−1,1,1,1,−1,1,1,−1,−1,−1,1,1,1,−1,−1,−1,1,−1,−1,−1,−1,−1,1,−1,−1,1,1,1,−1,−1,1,1,1,−1,1,1,1,1,1,1,1,1,−1,−1,1,−1,−1,−1,−1,−1,−1,1,1,−1,−1,1,−1,−1,−1,−1,1,−1,−1,−1,1,−1,−1,−1,−1,1,−1,1,1,1,−1,−1,1,1,−1,1,1,−1,1,−1,−1,−1,−1,−1,1,1,1,−1,−1,1,−1,−1,−1,−1,−1,1,1,−1,1,−1,1,−1,1,−1,1,1,−1,1,−1,1,1,−1,−1,1,−1,−1,−1,−1,1,−1,1,−1,1,−1,1,−1,−1,1,1,−1,1,1,−1,1,1,1,−1,−1,1,−1,1,1,1,1,1,1,−1,1,−1,1,1,−1,1,1,−1,1,1,−1,−1,1,1,1,1,−1,−1,−1,1,1,−1,−1,−1,−1,1,1,1,1,−1,1,1,−1,1,1,1,1,1,1,1,1,−1,−1,−1,−1,−1,1,−1,1,−1,1,1,1,1,1,1,−1,−1,1,1,1,1,1,1,1,1,−1,1,1,1,1,−1,1,1,1,1,−1,−1,1,1,−1,−1,−1,1,−1,1,1,−1,1,1,1,−1,1,−1,1,1,1,−1,−1,−1,1,−1,−1,−1,1,1,1,1,1,1,1,1,−1,1,−1,1,−1,1,−1,−1,1,−1,−1,−1,1,1,1,1,1,1,−1,1,−1,1,−1,−1,1,1,−1,1,1,−1,1,1,1,−1,−1,−1,1,1,1,−1,1,1,1,1,−1,1,−1,−1,−1,1,1,1,−1,1,−1,−1,−1,1,1,−1,1,1,1,1,1,−1,1,−1,−1,1,1,−1,1,1,1,−1,−1,−1,1,−1,−1,−1,1,−1,1,1,1,−1,−1,−1,−1,1,−1,−1,1,1,−1,1,−1,1,1,1,1,1,−1,1,1,−1,1,−1,−1,1,−1,−1,1,1,−1,1,1,−1,−1,1,1,1,−1,−1,0,0,0,0,0,1,1,1,−1,−1,−1,1,−1,1,−1,1,−1,1,1,−1,1,−1,−1,1,1,−1,1,1,1,1,1,−1,1,−1,−1,1,1,1,−1,−1,1,1,1,−1,−1,−1,−1,1,1,1,−1,1,1,1,−1,−1,1,−1,−1,−1,−1,1,1,1,−1,1,1,−1,−1,−1,−1,−1,1,1,1,−1,1,1,1,−1,−1,1,−1,1,1,1,1,1,−1,−1,1,1,1,−1,1,1,−1,−1,−1,−1,−1,1,−1,−1,1,1,1,−1,1,1,1,1,1,−1,−1,1,1,−1,1,1,−1,1,−1,1,−1,−1,1,−1,−1,1,1,−1,1,−1,−1,1,1,1,−1,1,1,1,−1,1,−1,−1,1,1,1,−1,1,1,−1,−1,−1,−1,−1,1,1,1,−1,−1,1,1,−1,−1,1,−1,−1,1,−1,1,1,1,−1,−1,−1,−1,−1,−1,1,−1,−1,1,−1,1,1,−1,1,−1,−1,1,1,1,1,−1,1,−1,−1,−1,−1,−1,1,−1,1,−1,−1,−1,−1,1,−1,−1,−1,1,−1,1,1,1,−1,−1,−1,1,1,−1,−1,−1,1,1,1,−1,1,1,−1,1,−1,1,−1,1,1,−1,1,1,1,1,−1,1,1,−1,1,1,−1,1,−1,−1,−1,−1,−1,−1,−1,−1,1,1,−1,−1,−1,1,−1,1,−1,1,1,1,1,1,−1,−1,−1,−1,−1,−1,−1,1,−1,1,−1,−1,−1,−1,1,−1,−1,1,−1,1,−1,1,−1,−1,1,−1,−1,−1,−1,−1,1,−1,1,1,1,1,1,1,−1,1,−1,−1,−1,−1,1,1,−1,−1,1,1,−1,−1,1,1,1,−1,1,−1,1,−1,1,−1,1,−1,−1,−1,1,1,−1,1,1,−1,−1,−1,1,−1,1,−1,−1,1,−1,1,−1,−1,−1,−1,−1,1,−1,1,1,1,−1,1,1,−1,−1,1,1,−1,1,−1,1,−1,1,−1,−1,−1,−1,1,1,−1,−1,1,1,−1,1,−1,1,1,−1,−1,1,−1,−1,−1,1,1,1,1,−1,−1,1,−1,−1,1,1,−1,1,−1,1,−1,−1,−1,1,1,1,1,−1,−1,1,−1,1,−1,−1,1,1,1,−1,−1,1,1,1,−1,1,−1,−1,1,1,−1,1,1,1,1,1,−1,1,1,1,1,1,1,1,1,−1,1,−1,1,1,1,1,−1,−1,−1,−1,−1,−1,−1,−1,1,−1,−1,1,−1,1,−1,1,−1,−1,1,1,−1,−1,1,−1,−1,1,−1,1,1,1,−1,1,1,1,−1,1,1,1,0,0,0,0,0,0,0,0,0,0,0}
For 160 MHz transmission, the N-TF sequence with the format of an HELTF160, optimized for estimation order P=4, is given by:
N-TF(HELTF160,P=4)=sqrt(2048/1992)·{0,0,0,0,0,0,0,0,0,0,0,0,−1,−1,1,−1,1,−1,1,−1,−1,−1,−1,1,−1,−1,1,1,−1,−1,−1,−1,−1,−1,−1,1,−1,1,1,−1,−1,1,−1,−1,−1,1,−1,−1,−1,1,−1,−1,1,1,−1,1,1,1,−1,−1,−1,1,1,−1,−1,1,−1,1,1,−1,1,−1,1,−1,1,1,1,−1,1,−1,−1,1,−1,−1,−1,−1,1,−1,−1,1,−1,−1,−1,−1,−1,1,−1,1,1,−1,1,1,1,−1,1,1,1,−1,1,−1,−1,−1,1,−1,1,1,1,−1,1,−1,1,1,1,−1,1,−1,−1,1,1,−1,1,−1,1,−1,−1,−1,1,−1,−1,−1,1,−1,−1,1,1,−1,−1,−1,1,1,−1,−1,−1,−1,−1,1,−1,−1,−1,−1,−1,−1,−1,−1,−1,1,1,−1,−1,1,−1,1,−1,−1,−1,1,−1,−1,−1,1,−1,1,−1,1,−1,−1,1,−1,1,−1,−1,1,−1,−1,−1,−1,−1,1,−1,1,1,−1,−1,1,1,1,−1,1,−1,−1,−1,1,1,1,1,1,−1,−1,−1,−1,−1,−1,−1,−1,1,1,−1,1,−1,−1,−1,−1,1,−1,1,−1,1,1,−1,−1,−1,−1,1,−1,−1,−1,1,−1,−1,−1,1,−1,1,1,−1,1,−1,−1,−1,−1,−1,−1,1,−1,−1,1,1,−1,−1,−1,1,−1,1,−1,−1,1,−1,1,−1,1,1,−1,−1,1,1,−1,1,−1,−1,1,1,−1,1,−1,−1,1,1,−1,−1,1,−1,−1,−1,−1,1,1,1,1,−1,−1,1,−1,−1,−1,1,1,1,−1,−1,1,1,−1,−1,−1,−1,−1,1,−1,1,−1,−1,1,−1,−1,−1,−1,1,1,1,−1,−1,−1,−1,−1,1,−1,1,1,1,−1,−1,1,−1,−1,−1,1,−1,−1,1,1,−1,1,1,1,−1,1,1,−1,−1,1,1,−1,1,−1,−1,1,1,1,1,−1,−1,1,−1,1,1,1,−1,−1,−1,1,−1,1,−1,1,1,1,−1,−1,1,−1,1,−1,−1,1,−1,1,−1,−1,−1,1,−1,1,1,1,1,−1,−1,−1,1,1,−1,1,−1,−1,−1,1,−1,1,−1,1,1,−1,−1,−1,1,−1,−1,−1,1,−1,−1,−1,−1,1,1,−1,−1,−1,1,−1,−1,−1,−1,−1,1,−1,1,−1,−1,−1,1,−1,1,1,1,−1,1,−1,1,1,−1,−1,1,−1,1,−1,1,−1,−1,1,1,1,1,1,−1,−1,−1,−1,−1,−1,−1,1,−1,1,−1,1,1,1,−1,−1,1,−1,−1,1,−1,−1,1,1,0,0,0,0,0,1,1,1,−1,1,1,1,−1,−1,−1,1,−1,1,−1,−1,−1,−1,1,1,−1,1,−1,−1,−1,1,−1,1,−1,−1,−1,1,−1,−1,1,−1,−1,−1,1,1,−1,1,1,1,−1,−1,−1,1,−1,−1,−1,1,−1,−1,−1,1,−1,1,1,−1,1,1,1,−1,1,−1,1,−1,1,−1,1,1,1,1,−1,−1,−1,−1,1,−1,−1,1,1,1,−1,−1,−1,−1,−1,1,−1,1,1,−1,−1,1,1,1,−1,1,1,−1,−1,−1,−1,−1,−1,−1,1,−1,−1,1,1,−1,−1,−1,−1,−1,−1,1,1,−1,1,1,−1,−1,−1,1,1,−1,1,1,−1,−1,1,1,−1,1,1,1,−1,−1,−1,1,−1,−1,−1,−1,1,1,−1,−1,−1,−1,−1,−1,−1,1,1,1,1,−1,1,1,−1,1,1,−1,1,1,−1,1,1,−1,1,−1,−1,−1,−1,−1,−1,−1,1,1,−1,−1,−1,−1,−1,−1,−1,−1,1,1,1,1,1,−1,−1,−1,1,1,1,1,1,−1,1,−1,−1,1,−1,1,1,−1,1,−1,−1,−1,−1,1,1,−1,1,1,1,−1,−1,−1,−1,1,−1,1,−1,1,1,1,1,1,−1,1,1,1,−1,1,−1,−1,1,−1,−1,1,1,1,−1,1,−1,1,−1,−1,1,1,1,1,1,−1,−1,−1,−1,−1,1,−1,−1,1,−1,1,−1,−1,−1,1,1,1,−1,−1,1,1,−1,−1,1,−1,1,−1,1,1,−1,1,−1,−1,−1,1,1,−1,1,−1,1,1,−1,−1,−1,1,−1,1,−1,1,−1,−1,−1,−1,1,−1,−1,−1,−1,1,1,−1,−1,1,1,−1,1,−1,1,1,−1,1,1,−1,−1,1,−1,−1,1,1,1,1,−1,1,−1,−1,1,1,1,−1,−1,−1,1,1,−1,1,1,−1,1,1,1,1,−1,−1,−1,−1,1,1,−1,1,1,−1,1,−1,−1,−1,1,−1,1,1,−1,1,−1,1,−1,−1,1,−1,1,1,−1,1,1,1,−1,1,−1,1,1,1,1,−1,1,−1,1,−1,−1,1,1,1,1,−1,−1,1,−1,−1,−1,−1,1,1,1,−1,−1,1,−1,1,−1,1,1,1,−1,−1,−1,1,−1,1,−1,1,−1,1,−1,−1,1,−1,−1,−1,1,1,−1,−1,1,−1,−1,1,1,1,1,1,−1,−1,1,1,−1,1,1,−1,1,1,−1,−1,−1,−1,−1,−1,−1,1,1,1,−1,1,−1,−1,−1,1,−1,1,1,−1,1,1,1,1,1,1,−1,1,1,0,0,0,0,0,0,0,0,0,0,0,0,0,0,0,0,0,0,0,0,0,0,0,1,1,−1,−1,1,1,1,−1,1,−1,1,−1,1,−1,−1,−1,1,−1,−1,−1,−1,−1,−1,−1,−1,−1,−1,1,1,1,−1,1,1,1,−1,1,1,−1,1,−1,1,−1,−1,−1,−1,−1,−1,−1,−1,−1,1,−1,−1,−1,−1,−1,1,1,−1,1,1,1,−1,−1,−1,−1,1,1,−1,1,1,1,−1,−1,1,−1,−1,−1,−1,1,−1,1,−1,1,1,1,−1,−1,−1,1,−1,1,−1,−1,1,1,1,−1,1,1,−1,−1,1,1,−1,−1,1,−1,1,1,−1,−1,1,−1,1,−1,−1,1,1,1,−1,−1,1,1,−1,−1,−1,1,1,1,1,1,1,−1,1,−1,−1,−1,−1,−1,1,1,1,1,−1,−1,−1,−1,1,1,−1,−1,−1,1,1,−1,−1,1,1,−1,1,−1,−1,−1,1,−1,1,−1,−1,−1,−1,1,−1,−1,−1,−1,−1,1,1,−1,−1,−1,1,1,1,1,−1,−1,1,−1,1,−1,−1,1,−1,−1,1,−1,1,−1,−1,−1,1,−1,−1,1,−1,1,−1,−1,−1,−1,1,1,−1,−1,1,1, 1,−1,1,−1,1,−1,−1,−1,−1,−1,1,−1,−1,1,1,1,−1,−1,1,1,−1,−1,−1,−1,1,−1,−1,1,1,1,1,1,−1,−1,1,1,−1,−1,−1,1,1,1,−1,1,−1,−1,−1,1,1,1,−1,1,−1,−1,−1,−1,−1,1,1,1,1,1,1,−1,−1,−1,−1,−1,−1,1,−1,1,−1,−1,−1,−1,1,−1,−1,1,−1,1,−1,1,1,1,−1,1,1,1,−1,−1,−1,−1,−1,1,−1,1,−1,1,1,−1,−1,1,−1,−1,−1,−1,−1,−1,−1,−1,−1,−1,−1,1,1,−1,−1,1,−1,1,−1,−1,1,1,1,−1,1,−1,1,1,−1,−1,−1,−1,−1,1,1,−1,−1,−1,1,1,−1,1,−1,−1,−1,−1,1,−1,−1,1,1,−1,1,1,−1,1,−1,−1,1,1,1,−1,1,−1,1,−1,1,1,−1,1,1,1,−1,−1,1,−1,1,1,1,−1,1,−1,−1,−1,1,−1,1,1,1,−1,−1,1,1,−1,1,1,1,1,−1,−1,−1,−1,−1,−1,1,−1,1,1,1,−1,−1,1,−1,−1,−1,1,−1,1,−1,−1,1,1,1,1,1,1,−1,−1,−1,1,−1,1,1,1,1,1,1,1,−1,1,1,−1,−1,1,−1,1,−1,1,−1,1,1,−1,−1,1,1,1,−1,−1,1,1,1,−1,1,−1,−1,1,−1,1,−1,1,−1,−1,−1,−1,1,1,0,0,0,0,0,−1,−1,1,−1,−1,−1,1,−1,1,−1,−1,1,1,−1,−1,−1,−1,1,−1,1,1,1,1,−1,1,1,−1,1,−1,−1,1,−1,−1,−1,−1,1,1,1,−1,−1,1,−1,−1,1,−1,−1,−1,−1,1,−1,1,−1,−1,1,−1,−1,−1,1,1,1,−1,−1,−1,−1,−1,1,1,−1,−1,−1,−1,−1,−1,−1,1,1,−1,1,−1,1,−1,−1,−1,−1,1,−1,1,1,1,−1,1,−1,1,1,1,−1,−1,−1,1,−1,−1,1,1,1,−1,1,1,−1,−1,1,−1,1,1,1,−1,−1,1,−1,1,−1,−1,−1,−1,1,1,−1,−1,1,1,1,1,−1,1,−1,1,−1,−1,1,−1,1,1,1,−1,−1,−1,1,−1,1,−1,1,−1,−1,1,1,1,1,−1,1,1,1,−1,−1,1,−1,−1,1,−1,1,−1,−1,1,−1,−1,1,−1,−1,−1,1,−1,−1,1,1,−1,−1,−1,−1,−1,1,1,−1,1,−1,−1,−1,1,−1,−1,−1,1,1,1,−1,1,−1,1, 1, 1,−1,1,1,1,−1,1,−1,−1,1,−1,1,1,1,−1,1,−1,−1,−1,1,1,−1,1,1,1,−1,−1,−1,−1,−1,1,−1,1,−1,−1,−1,1,1,−1,1,−1,−1,1,1,1,1,−1,1,−1,−1,−1,−1,−1,−1,1,−1,−1,−1,−1,−1,−1,−1,1,−1,−1,−1,−1,1,1,1,1,−1,−1,1,1,1,−1,1,1,−1,−1,−1,1,1,1,−1,−1,−1,−1,−1,1,1,−1,−1,−1,−1,−1,1,−1,−1,−1,−1,1,−1,−1,−1,−1,1,1,1,1,1,1,1,−1,−1,1,−1,−1,−1,−1,1,−1,−1,−1,−1,−1,−1,−1,1,1,−1,−1,1,1,1,1,1,1,−1,−1,1,−1,−1,1,1,−1,−1,1,−1,1,1,1,−1,−1,−1,1,−1,−1,1,−1,1,−1,1,−1,1,−1,1,1,−1,1,−1,1,1,1,1,−1,1,−1,1,−1,−1,−1,1,1,−1,−1,−1,1,1,−1,1,−1,−1,−1,−1,1,−1,1,−1,1,−1,1,1,1,−1,−1,−1,1,−1,−1,1,−1,−1,−1,−1,−1,1,1,−1,−1,1,−1,−1,−1,1,1,−1,1,−1,1,1,−1,−1,−1,1,−1,−1,−1,1,−1,−1,1,−1,−1,−1,1,1,−1,−1,−1,1,1,−1,−1,1,−1,−1,1,1,1,1,1,1,1,−1,1,−1,1,−1,−1,−1,1,1,−1,−1,−1,−1,−1,1,1,1,−1,−1,1,−1,1,−1,1,−1,1,1,1,0,0,0,0,0,0,0,0,0,0,0}
For 160 MHz transmission, the N-TF sequence with the format of an HELTF160, optimized for estimation order P=5, is given by:
N-TF(HELTF160,P=5)=sqrt(2048/1992)·{0,0,0,0,0,0,0,0,0,0,0,0,1,−1,1,1,−1,1,1,1,−1,1,−1,−1,−1,−1,1,−1,1,1,1,−1,−1,1,1,1,1,−1,1,−1,−1,1, 1, 1, 1,−1,1,1,−1,1,1,1,−1,1,1,1,−1,−1,1,−1,1,−1,1,−1,1,1,−1,1,−1,1,−1,−1,−1,1,1,−1,1,−1,1,−1,1,−1,−1,1,1,1,1,−1,−1,1,−1,−1,1,−1,−1,−1,1,1,−1,1,1,−1,−1,1,−1,−1,−1,1,1,1,−1,1,−1,1,1,−1,−1,−1,1,−1,1,1,−1,1,−1,1,1,1,1,−1,−1,−1,−1,1,1,1,−1,1,−1,−1,−1,−1,−1,−1,1,−1,1,−1,1,1,−1,1,−1,−1,−1,−1,−1,1,−1,1,−1,−1,−1,−1,1,1,−1,1,1,1,1,1,1,1,−1,−1,1,1,−1,1,1,1,−1,1,−1,−1,−1,1,−1,1,−1,1,1,−1,1,1,−1,−1,1,1,−1,−1,−1,1,−1,−1,1,−1,−1,1,−1,1,−1,−1,1,−1,1,1,1,1,−1,1,1,−1,−1,1,−1,−1,−1,1,1,1,1,−1,−1,1,−1,−1,1,1,−1,1,−1,1,−1,1,−1,1,−1,1,−1,1,−1,1,−1,−1,−1,1,−1,−1,1,−1,−1,−1,1,−1,1,1,−1,−1,1,1,−1,1,1,1,−1,1,−1,−1,1,−1,−1,−1,1,1,−1,1,1,1,−1,1,−1,−1,1,1,−1,−1,1,1,−1,1,1,−1,1,−1,1,−1,1,−1,−1,−1,−1,1,−1,−1,1,−1,1,1,1,−1,−1,−1,1,−1,1,1,−1,−1,1,1,1,−1,−1,1,1,−1,1,−1,1,−1,1,−1,1,−1,−1,1,1,1,1,1,1,−1,1,1,1,1,−1,1,1,1,1,−1,1,1,1,1,−1,−1,−1,−1,1,1,−1,−1,1,1,1,1,−1,1,1,1,−1,1,1,−1,1,1,1,1,1,1,1,1,−1,−1,−1,1,1,1,−1,−1,1,1,−1,1,−1,1,−1,1,−1,−1,−1,−1,−1,1,−1,1,−1,−1,1,−1,−1,−1,−1,1,−1,1,−1,1,1,1,−1,−1,1,−1,−1,−1,−1,1,−1,−1,−1,−1,1,−1,−1,1,1,1,1,1,−1,−1,−1,1,1,−1,−1,−1,1,1,−1,1,1,1,−1,−1,−1,1,−1,1,1,1,−1,−1,−1,1,−1,−1,1,1,−1,1,1,1,1,1,1,−1,1,−1,−1,1,−1,1,−1,1,−1,−1,1,1,1,1,1,1,1,−1,0,0,0,0,0,−1,1,1,1,1,−1,1,−1,−1,−1,−1,−1,1,−1,1,1,1,1,−1,1,1,1,1,1,1,−1,1,1,−1,1,1,−1,−1,1,−1,−1,1,1,1,−1,1,1,1,−1,1,1,1,1,1,1,−1,1,1,1,−1,−1,1,−1,1,−1,1,1,−1,1,1,1,−1,−1,1,−1,−1,−1,1,−1,1,−1,1,−1,1,−1,−1,−1,1,1,−1,−1,−1,−1,−1,−1,−1,1,−1,1,1,1,−1,−1,−1,−1,−1,−1,−1,−1,1,1,−1,−1,1,1,−1,−1,−1,1,1,−1,1,1,−1,1,1,1,1,1,1,−1,1,−1,1,1,1,−1,1,1,−1,1,1,1,1,−1,−1,−1,1,−1,−1,−1,−1,−1,−1,1,1,−1,−1,−1,1,−1,−1,−1,1,−1,−1,−1,1,1,1,−1,1,−1,−1,1,−1,−1,−1,1,−1,−1,1,−1,−1,1,1,−1,1,1,−1,−1,−1,−1,1,−1,1,1,1,1,1,1,1,1,−1,−1,−1,−1,1,−1,−1,1,1,−1,1,1,1,−1,1,1,−1,−1,1,−1,1,1,−1,1,−1,−1,−1,1,−1,−1,1,1,1,−1,−1,1,1,1,1,1,−1,−1,−1,1,−1,−1,1,−1,−1,1,−1,−1,−1,1,1,−1,−1,−1,−1,1,1,1,1,−1,1,−1,−1,−1,1,1,−1,1,−1,1,−1,1,−1,−1,−1,−1,−1,1,−1,1,−1,1,−1,−1,−1,−1,−1,1,1,1,1,−1,1,−1,−1,−1,−1,1,−1,−1,−1,1,1,1,−1,1,−1,−1,1,1,−1,1,−1,−1,1,1,−1,1,1,−1,1,−1,1,1,−1,1,1,1,1,−1,1,−1,−1,−1,−1,−1,1,−1,−1,−1,1,1,1,−1,1,−1,1,−1,−1,1,1,−1,−1,−1,1,−1,−1,1,1,−1,1,−1,−1,1,1,1,−1,−1,1,1,1,1,1,−1,1,−1,1,−1,1,1,1,1,1,1,−1,1,−1,1,1,−1,1,−1,1,−1,−1,−1,1,1,1,−1,1,1,1,−1,−1,1,−1,−1,−1,1,−1,1,1,1,−1,−1,−1,−1,−1,1,−1,−1,−1,1,1,−1,−1,−1,1,−1,1,1,1,1,−1,−1,−1,−1,−1,−1,1,1,1,−1,−1,−1,1,1,−1,−1,1,−1,−1,−1,1,−1,−1,−1,1,1,1,−1,−1,−1,1,1,−1,1,1,−1,1,1,1,1,−1,−1,1,1,−1,1,1,1,1,−1,1,−1,−1,1,1,−1,−1,1,1,1,0,0,0,0,0,0,0,0,0,0,0,0,0,0,0,0,0,0,0,0,0,0,0,1,1,−1,−1,−1,−1,−1,−1,−1,−1,1,−1,1,1,1,1,1,1,1,1,−1,1,−1,−1,−1,1,−1,1,1,1,−1,1,1,1,1,−1,−1,−1,−1,1,−1,1,−1,1,−1,−1,−1,−1,−1,−1,1,1,1,1,−1,1,1,−1,−1,−1,1,1,−1,1,−1,1,1,−1,−1,1,−1,1,−1,1,1,1,−1,1,−1,1,−1,1,−1,1,−1,1,1,−1,−1,−1,1,1,−1,1,−1,−1,−1,1,−1,1,1,−1,−1,−1,−1,1,−1,1,−1,−1,−1,1,−1,−1,1,1,−1,−1,1,1,−1,1,1,1,−1,1,1,1,−1,−1,−1,1,1,−1,1,−1,−1,−1,−1,1,1,−1,1,1,1,1,1,−1,1,−1,1,−1,−1,1,1,1,1,−1,1,1,−1,−1,1,−1,1,−1,1,−1,1,−1,1,1,1,−1,1,−1,−1,−1,−1,1,−1,−1,1,−1,1,1,1,−1,1,−1,−1,1,−1,1,1,1,1,1,−1,1,1,1,−1,1,−1,−1,−1,1,−1,−1,−1,1,1,1,−1,1,−1,1,1,1,−1,−1,−1,−1,−1,1,1,1,−1,1,1,−1,1,1,−1,−1,−1,1,−1,−1,1,−1,1,1,1,1,1,1,−1,−1,1,1,1,1,1,1,−1,1,1,1,−1,1,−1,−1,1,−1,−1,−1,1,1,−1,1,1,1,−1,−1,1,1,1,1,−1,−1,1,−1,−1,−1,1,1,−1,1,−1,−1,−1,−1,−1,1,−1,1,−1,1,1,−1,−1,−1,−1,−1,1,1,1,−1,−1,1,−1,1,−1,1,1,1,−1,−1,1,1,−1,1,1,−1,−1,1,1,1,1,−1,−1,−1,1,1,−1,1,−1,−1,−1,1,−1,−1,−1,−1,1,1,1,−1,1,−1,1,−1,1,−1,1,1,−1,−1,−1,1,1,1,−1,1,−1,1,1,1,1,−1,−1,1,−1,1,1,1,1,1,−1,−1,1,1,1,1,−1,1,1,1,−1,−1,1,−1,1,−1,1,1,−1,1,1,−1,−1,1,−1,1,1,1,1,−1,1,1,1,1,−1,−1,−1,−1,−1,1,−1,1,1,1,1,−1,1,−1,1,1,−1,−1,−1,1,1,−1,−1,−1,1,−1,1,1,1,1,−1,−1,−1,1,1,−1,1,−1,1,−1,−1,−1,−1,−1,−1,−1,1,−1,1,1,1,−1,1,1,1,1,1,1,−1,−1,−1,−1,−1,−1,−1,1,1,−1,1,1,−1,−1,1,−1,−1,−1,−1,−1,−1,1,1,1,0,0,0,0,0,−1,−1,−1,−1,1,−1,−1,−1,−1,−1,1,−1,1,−1,1,−1,1,1,1,1,−1,1,1,1,−1,−1,−1,1,1,−1,1,1,−1,−1,−1,−1,1,−1,1,1,1,−1,−1,1,−1,−1,−1,−1,1,−1,1,−1,1,−1,1,−1,−1,−1,−1,−1,1,−1,1,−1,1,1,1,−1,1,1,−1,−1,1,1,1,1,1,−1,1,−1,1,−1,−1,−1,1,1,1,1,−1,−1,1,1,−1,−1,−1,−1,−1,1,1,1,1,1,1,1,−1,−1,−1,1,1,1,−1,1,−1,1,1,1,−1,−1,−1,1,1,1,1,1,−1,1,−1,−1,−1,−1,−1,1,1,1,1,1,−1,1,1,1,−1,−1,1,1,−1,1,1,−1,1,1,−1,−1,1,−1,−1,−1,−1,−1,−1,1,1,1,1,−1,1,1,1,1,−1,−1,1,1,−1,−1,1,1,−1,1,1,−1,1,1,1,1,1,−1,1,−1,−1,−1,−1,−1,1,1,1,−1,1,1,−1,−1,1,−1,1,−1,1,−1,1,1,1,1,1,−1,1,−1,1,−1,−1,−1,1,−1,1,−1,−1,−1,−1,−1,1,−1,1,−1,1,−1,−1,−1,−1,−1,1,1,1,−1,−1,−1,1,−1,1,1,−1,−1,1,−1,1,−1,−1,1,−1,1,1,−1,−1,−1,−1,−1,−1,1,−1,−1,1,−1,1,−1,1,−1,1,−1,1,−1,−1,−1,1,−1,1,−1,1,1,1,1,1,1,−1,−1,−1,−1,−1,−1,1,1,1,−1,1,1,1,−1,1,1,1,1,1,1,−1,−1,1,−1,1,1,−1,1,1,1,1,1,−1,−1,−1,−1,−1,−1,1,1,1,−1,−1,1,1,−1,−1,−1,1,−1,1,1,1,1,−1,−1,1,−1,−1,−1,−1,−1,−1,−1,1,−1,1,1,1,−1,1,1,−1,1,−1,1,1,1,1,−1,−1,1,−1,1,−1,−1,1,−1,−1,1,1,1,1,−1,1,−1,−1,1,−1,−1,1,1,1,−1,−1,−1,1,−1,−1,1,1,−1,−1,1,1,−1,1,−1,−1,1,−1,1,−1,1,1,−1,−1,−1,−1,1,1,1,−1,−1,1,1,1,1,−1,−1,−1,1,1,−1,1,1,1,−1,−1,−1,−1,−1,1,−1,−1,−1,1,−1,1,−1,1,−1,1,1,−1,1,−1,−1,1,−1,1,1,1,1,−1,−1,−1,−1,1,−1,−1,1,1,1,1,−1,−1,−1,1,−1,1,1,1,−1,1,1,1,1,−1,−1,1,−1,1,1,1,−1,−1,1,1,−1,0,0,0,0,0,0,0,0,0,0,0}
For 160 MHz transmission, the N-TF sequence with the format of an HELTF160, optimized for estimation order P=6, is given by:
N-TF(HELTF160,P=6)=sqrt(2048/1992)·{0,0,0,0,0,0,0,0,0,0,0,0,1,−1,1,1,−1,1,−1,1,−1,−1,1,1,1,−1,1,−1,1,1,−1,−1,−1,1,1,−1,−1,1,−1,1,1,−1,−1,1,1,−1,−1,1,−1,−1,1,−1,−1,1,−1,1,−1,1,−1,−1,−1,−1,−1,−1,1,−1,1,1,−1,−1,1,1,−1,1,−1,−1,1,−1,1,−1,−1,−1,1,1,−1,1,1,1,−1,−1,1,1,1,−1,1,−1,−1,1,1,1,1,1,−1,−1,−1,−1,−1,1,1,−1,−1,1,−1,1,−1,−1,1,1,1,1,1,1,−1,1,1,−1,1,1,1,1,1,−1,−1,−1,1,1,−1,1,1,−1,1,−1,−1,−1,1,1,−1,−1,−1,1,−1,1,1,−1,−1,−1,1,−1,1,1,1,−1,1,1,1,1,1,−1,1,−1,1,−1,1,−1,1,1,1,−1,1,1,1,1,−1,−1,1,−1,1,−1,−1,1,1,−1,−1,1,−1,−1,1,−1,−1,−1,−1,−1,1,1,1,1,−1,1,1,1,1,1,1,1,1,−1,−1,1,1,−1,−1,−1,1,1,−1,1,1,−1,−1,1,−1,−1,1,1,1,−1,−1,1,1,−1,−1,1,1,−1,−1,1,−1,1,1,1,−1,1,1,−1,1,1,1,−1,−1,−1,−1,1,1,−1,−1,1,1,−1,1,1,−1,1,1,−1,1,1,1,−1,−1,1,1,1,−1,−1,1,1,−1,1,−1,−1,1,1,−1,1,−1,1,−1,−1,−1,1,−1,−1,1,1,−1,−1,1,−1,−1,1,1,−1,−1,−1,1,1,−1,1,−1,−1,−1,1,−1,−1,1,−1,1,1,1,−1,−1,−1,−1,−1,−1,1,1,1,1,−1,−1,−1,1,1,−1,1,1,−1,1,−1,−1,1,−1,1,−1,1,1,1,1,1,−1,−1,1,−1,−1,1,1,−1,1,1,−1,−1,−1,−1,−1,1,−1,−1,1,1,−1,−1,−1,−1,−1,1,1,1,1,−1,−1,1,1,−1,1,1,1,1,−1,−1,1,1,1,1,−1,−1,−1,1,−1,−1,1,1,−1,1,−1,−1,1,−1,−1,−1,1,1,−1,−1,1,1,−1,1,−1,1,1,−1,1,1,−1,−1,−1,−1,−1,1,1,−1,1,−1,−1,−1,−1,1,−1,−1,1,1,1,1,−1,1,1,1,1,1,−1,−1,−1,1,1,1,1,−1,−1,1,−1,−1,−1,−1,−1,1,−1,1,−1,−1,1,1,−1,1,1,−1,1,−1,1,1,1,1,1,−1,1,−1,1,−1,−1,−1,−1,1,−1,1,−1,−1,−1,1,1,−1,1,0,0,0,0,0,−1,1,1,1,−1,1,1,−1,1,1,1,−1,1,−1,−1,1,1,−1,−1,−1,−1,1,−1,1,1,−1,−1,1,1,1,1,−1,−1,−1,1,1,1,−1,1,−1,−1,−1,−1,1,1,−1,−1,−1,1,−1,−1,−1,−1,1,−1,−1,−1,−1,1,−1,1,1,1,1,1,1,−1,1,1,−1,−1,−1,1,−1,−1,−1,−1,1,1,1,1,−1,1,−1,1,1,−1,1,−1,−1,1,1,1,−1,−1,−1,−1,1,−1,−1,1,1,−1,−1,1,1,−1,1,1,1,−1,1,1,−1,1,1,1,1,−1,−1,−1,1,1,−1,1,−1,1,1,−1,−1,−1,1,−1,−1,−1,−1,1,−1,1,−1,−1,1,1,−1,1,1,1,−1,1,−1,−1,−1,1,1,−1,−1,1,1,1,−1,1,−1,−1,−1,−1,1,−1,1,1,1,1,1,−1,1,1,1,−1,−1,1,−1,−1,−1,−1,1,−1,1,−1,−1,1,−1,1,−1,−1,−1,−1,1,1,1,1,1,1,1,−1,−1,1,−1,1,−1,−1,1,−1,−1,1,−1,1,1,1,1,1,−1,−1,1,1,−1,−1,−1,−1,−1,1,1,−1,−1,1,1,−1,−1,−1,1,−1,−1,−1,1,1,1,−1,1,1,−1,1,−1,1,1,1,−1,−1,−1,−1,−1,1,1,1,−1,1,1,−1,−1,−1,1,−1,1,1,1,−1,−1,1,−1,−1,−1,1,1,1,−1,−1,1,−1,1,1,−1,1,−1,−1,1,−1,1,1,1,1,−1,1,1,−1,1,1,1,1,−1,−1,1,−1,1,1,1,1,−1,−1,1,−1,1,1,1,−1,1,−1,1,−1,−1,−1,−1,−1,1,−1,−1,−1,1,−1,1,1,1,1,−1,1,1,−1,1,1,1,−1,1,1,−1,−1,1,1,1,−1,−1,−1,−1,−1,−1,−1,−1,−1,1,−1,−1,1,1,−1,−1,−1,−1,−1,1,−1,−1,1,−1,1,−1,−1,1,−1,1,1,1,−1,1,−1,−1,−1,1,1,−1,−1,1,−1,1,1,1,−1,−1,−1,−1,−1,1,−1,−1,−1,−1,1,−1,1,−1,−1,−1,−1,−1,−1,1,−1,1,−1,−1,1,1,1,1,−1,−1,1,−1,1,1,−1,1,1,−1,1,−1,1,−1,1,−1,−1,−1,−1,−1,1,1,−1,1,−1,−1,−1,−1,−1,1,1,−1,−1,1,1,−1,−1,−1,−1,1,−1,1,−1,1,−1,−1,−1,1,1,1,1,1,1,−1,−1,1,−1,−1,−1,−1,−1,−1,−1,1,−1,−1,1,1,−1,−1,0,0,0,0,0,0,0,0,0,0,0,0,0,0,0,0,0,0,0,0,0,0,0,1,−1,1,−1,1,−1,−1,−1,−1,−1,1,−1,1,1,−1,−1,1,−1,−1,1,1,1,−1,1,1,−1,1,1,1,−1,1,1,−1,−1,1,−1,1,1,1,−1,−1,1,−1,−1,−1,−1,1,1,−1,−1,−1,−1,−1,−1,1,1,−1,−1,1,1,1,1,−1,−1,1,1,1,−1,1,1,−1,1,1,−1,1,1,−1,1,−1,1,1,−1,1,1,−1,−1,1,1,1,1,−1,1,1,1,−1,−1,−1,−1,−1,1,−1,−1,1,1,1,−1,1,−1,1,1,1,1,1,−1,1,−1,1,1,−1,−1,1,−1,1,−1,1,−1,−1,−1,1,−1,1,−1,1,1,−1,1,−1,−1,1,−1,−1,1,1,−1,−1,−1,1,−1,−1,1,−1,1,1,−1,−1,−1,1,−1,−1,1,1,1,1,−1,−1,1,1,−1,−1,−1,−1,1,1,−1,−1,1,1,1,−1,−1,1,−1,−1,1,1,−1,1,1,1,−1,1,1,−1,−1,1,−1,1,−1,−1,−1,1,−1,1,−1,1,−1,−1,−1,1,−1,1,−1,1,1,−1,1,1,−1,−1,1,−1,−1,−1,1,1,−1,−1,1,1,1,1,−1,1,−1,1,1,−1,1,−1,−1,−1,1,1,−1,1,−1,1,−1,1,1,1,1,1,1,−1,1,1,1,1,−1,−1,−1,−1,−1,1,−1,1,1,−1,1,1,1,1,−1,1,1,−1,−1,−1,1,1,−1,−1,−1,−1,1,1,−1,−1,−1,1,−1,1,−1,−1,−1,1,1,1,−1,1,−1,1,−1,1,1,−1,−1,−1,−1,−1,1,−1,1,1,−1,1,1,1,1,1,−1,−1,−1,1,−1,−1,−1,1,1,−1,−1,−1,−1,1,−1,−1,−1,−1,−1,−1,1,−1,−1,−1,−1,−1,1,−1,−1,1,1,1,1,−1,−1,1,−1,−1,1,−1,1,−1,1,1,−1,1,1,1,−1,−1,−1,−1,−1,−1,1,−1,−1,1,1,1,−1,1,−1,−1,−1,1,1,1,−1,1,1,1,−1,1,1,1,−1,1,1,−1,−1,1,1,1,−1,−1,1,−1,−1,−1,1,−1,−1,1,−1,1,−1,−1,−1,−1,−1,−1,−1,1,1,−1,1,−1,−1,1,1,1,1,1,1,1,−1,1,1,1,1,1,−1,1,−1,1,1,−1,−1,−1,1,1,−1,1,−1,1,1,1,1,1,−1,−1,1,1,−1,1,−1,1,1,1,−1,−1,−1,−1,1,1,1,1,1,1,1,−1,−1,−1,1,1,−1,−1,−1,−1,−1,−1,0,0,0,0,0,−1,−1,−1,1,1,1,−1,−1,1,−1,1,−1,−1,1,−1,−1,−1,−1,−1,1,−1,−1,−1,1,−1,−1,1,−1,−1,1,1,−1,−1,1,1,−1,−1,1,−1,−1,1,1,−1,−1,1,1,1,−1,−1,−1,1,−1,1,−1,−1,1,−1,1,−1,−1,1,−1,1,1,−1,1,−1,−1,1,−1,−1,−1,1,1,−1,1,−1,1,−1,−1,−1,−1,1,−1,−1,−1,−1,−1,−1,1,−1,1,1,1,1,1,−1,1,−1,1,−1,−1,1,1,1,−1,1,−1,−1,1,−1,−1,−1,1,−1,1,−1,1,−1,1,−1,1,−1,−1,−1,−1,1,1,1,1,−1,1,1,1,−1,1,−1,−1,−1,−1,−1,1,1,1,1,−1,−1,1,1,1,1,−1,−1,1,−1,−1,1,1,−1,−1,1,−1,−1,1,1,1,−1,−1,−1,−1,1,1,−1,−1,−1,−1,1,1,−1,1,1,−1,−1,1,−1,−1,1,−1,1,−1,1,1,1,1,−1,1,1,1,−1,−1,−1,1,1,−1,1,−1,−1,−1,1,1,1,1,1,−1,1,1,−1,1,1,1,1,−1,1,−1,−1,−1,1,1,−1,−1,1,−1,−1,1,−1,−1,−1,1,1,1,1,1,−1,−1,1,1,−1,−1,−1,1,1,−1,1,1,1,1,1,−1,1,1,1,−1,1,1,1,−1,1,1,−1,1,1,1,−1,−1,1,1,−1,−1,1,−1,−1,1,1,1,−1,1,1,1,−1,1,1,1,1,−1,1,1,1,1,−1,1,1,−1,1,1,−1,1,1,1,1,−1,−1,1,1,−1,−1,−1,1,1,−1,−1,−1,1,1,1,−1,1,−1,−1,1,−1,−1,−1,1,1,1,1,1,1,1,1,−1,−1,−1,1,1,1,−1,1,1,−1,−1,1,−1,1,−1,−1,1,−1,1,−1,1,−1,−1,−1,−1,1,−1,−1,1,1,1,1,−1,1,1,1,1,1,−1,−1,1,1,−1,1,1,−1,1,1,1,−1,−1,1,1,−1,−1,1,1,−1,1,−1,−1,1,1,−1,−1,−1,1,1,1,−1,−1,−1,1,−1,1,−1,−1,1,1,−1,1,−1,−1,−1,−1,−1,1,−1,1,1,1,−1,−1,1,−1,−1,1,1,1,1,1,−1,−1,−1,1,1,−1,1,1,−1,−1,−1,1,−1,−1,1,1,−1,1,1,1,−1,1,−1,1,−1,−1,−1,−1,1,−1,−1,−1,1,−1,1,1,1,1,1,−1,−1,1,−1,1,1,−1,1,1,1,1,1,1,1,−1,1,1,−1,0,0,0,0,0,0,0,0,0,0,0}
For 160 MHz transmission, the N-TF sequence with the format of an HELTF160, optimized for estimation order P=7, is given by:
N-TF(HELTF160,P=7)=sqrt(2048/1992)·{0,0,0,0,0,0,0,0,0,0,0,0,−1,−1,−1,−1,−1,1,1,−1,1,1,−1,1,1,−1,−1,1,−1,−1,−1,1,−1,−1,−1,1,−1,−1,1,−1,1,1,1,−1,1,−1,1,1,−1,−1,1,1,−1,−1,−1,−1,1,1,−1,−1,−1,−1,1,−1,1,−1,1,1,1,1,1,−1,−1,1,1,−1,1,1,−1,−1,1,−1,−1,1,1,−1,−1,−1,1,1,−1,1,−1,−1,1,−1,1,1,−1,1,1,−1,−1,1,−1,−1,−1,1,1,−1,1,−1,−1,−1,−1,1,1,−1,−1,−1,1,−1,−1,−1,−1,1,1,−1,1,−1,1,−1,−1,1,1,1,1,1,1,−1,1,1,−1,−1,1,1,−1,−1,1,−1,1,1,1,1,−1,1,−1,1,−1,−1,−1,1,1,1,1,1,−1,−1,−1,−1,−1,1,1,−1,1,1,−1,−1,1,1,−1,−1,−1,1,1,1,−1,1,−1,−1,−1,−1,1,−1,1,1,−1,−1,1,−1,−1,1,1,−1,1,−1,1,−1,1,−1,−1,−1,−1,−1,−1,1,1,−1,1,−1,1,−1,1,−1,1,1,1,−1,1,1,1,−1,−1,−1,1,−1,−1,1,−1,1,−1,1,−1,−1,1,1,1,1,−1,1,−1,−1,−1,−1,−1,1,−1,−1,−1,−1,−1,1,1,−1,−1,−1,−1,1,−1,1,−1,−1,1,1,1,−1,1,1,1,−1,−1,1,1,−1,−1,−1,1,1,−1,−1,1,1,−1,−1,1,−1,−1,−1,1,−1,1,1,−1,−1,1,1,1,−1,1,−1,−1,−1,−1,−1,−1,−1,−1,−1,−1,1,−1,−1,−1,1,−1,−1,1,1,−1,1,1,−1,−1,1,1,−1,−1,1,−1,1,1,−1,1,−1,1,−1,−1,−1,−1,−1,1,−1,1,1,1,−1,−1,1,1,1,1,1,1,−1,−1,−1,1,−1,−1,1,−1,−1,1,−1,1,1,1,−1,−1,−1,1,1,1,1,1,−1,1,1,−1,−1,−1,1,1,1,−1,−1,1,1,−1,−1,−1,1,1,−1,1,1,−1,−1,1,−1,−1,−1,1,−1,1,−1,−1,−1,1,1,1,−1,−1,−1,−1,1,−1,1,1,−1,−1,−1,1,−1,1,−1,1,−1,1,1,1,−1,−1,1,1,−1,−1,−1,−1,1,−1,1,−1,1,−1,1,−1,−1,1,1,1,1,−1,−1,1,−1,−1,1,1,−1,1,−1,1,−1,1,−1,1,−1,−1,−1,1,1,1,−1,−1,−1,1,1,1,−1,−1,1,1,−1,−1,−1,1,1,−1,−1,−1,−1,1,−1,1,1,−1,−1,1,0,0,0,0,0,−1,1,1,−1,−1,1,1,−1,1,1,1,−1,−1,−1,−1,1,−1,−1,1,−1,−1,1,−1,1,1,1,1,1,−1,−1,−1,1,1,1,−1,1,−1,1,−1,1,1,−1,−1,1,−1,1,−1,−1,1,1,−1,1,−1,−1,1,1,−1,1,−1,1,−1,−1,−1,−1,−1,1,1,−1,1,−1,1,1,1,−1,−1,−1,1,−1,1,−1,1,1,−1,1,1,−1,−1,1,−1,−1,−1,−1,1,1,1,1,1,−1,1,1,−1,−1,1,1,1,−1,−1,−1,1,1,−1,−1,1,1,−1,1,1,−1,1,1,1,1,1,1,−1,1,−1,−1,−1,−1,1,−1,1,1,−1,−1,1,1,1,−1,−1,1,−1,1,1,1,−1,−1,1,−1,−1,1,1,−1,−1,1,1,−1,−1,−1,1,1,1,1,1,1,−1,−1,1,1,−1,1,−1,−1,−1,−1,−1,−1,−1,−1,1,1,−1,−1,−1,−1,1,−1,1,1,−1,1,−1,−1,1,−1,1,1,−1,−1,−1,−1,−1,1,−1,−1,−1,−1,−1,−1,−1,1,1,−1,1,−1,−1,−1,−1,−1,−1,1,−1,−1,−1,1,−1,−1,−1,−1,−1,−1,−1,1,1,1,1,−1,−1,−1,−1,−1,−1,1,1,−1,−1,1,−1,1,−1,−1,−1,−1,1,−1,−1,1,−1,1,−1,1,−1,1,1,−1,−1,−1,−1,−1,1,−1,−1,1,1,−1,1,−1,1,1,1,−1,1,−1,1,1,1,−1,−1,1,1,−1,−1,−1,−1,1,1,1,−1,−1,−1,1,−1,−1,1,−1,1,1,1,1,−1,−1,1,1,1,−1,1,−1,1,1,1,1,−1,−1,−1,1,−1,1,−1,−1,−1,−1,1,−1,1,1,−1,1,1,−1,−1,1,1,−1,1,−1,−1,1,−1,1,1,−1,−1,−1,−1,−1,1,−1,1,1,−1,−1,−1,−1,1,−1,1,1,1,−1,−1,1,1,−1,−1,−1,1,−1,1,−1,−1,−1,1,−1,−1,−1,1,−1,−1,1,1,−1,1,−1,−1,−1,−1,−1,−1,1,−1,−1,1,1,−1,−1,−1,1,−1,1,1,−1,−1,−1,−1,1,−1,−1,−1,−1,−1,−1,−1,−1,−1,−1,−1,−1,−1,−1,1,−1,1,1,1,−1,−1,1,−1,−1,−1,−1,1,1,1,−1,1,1,−1,−1,−1,1,1,1,1,1,−1,−1,1,−1,−1,1,1,−1,−1,−1,−1,1,1,1,−1,1,−1,−1,−1,1,−1,−1,1,−1,1,−1,−1,1,1,−1,1,1,1,−1,−1,−1,1,−1,−1,−1,1,1,0,0,0,0,0,0,0,0,0,0,0,0,0,0,0,0,0,0,0,0,0,0,0,1,1,1,−1,−1,−1,−1,1,1,1,1,−1,1,−1,−1,−1,1,−1,1,−1,−1,−1,1,−1,1,−1,1,1,−1,1,−1,−1,1,1,−1,1,1,−1,−1,−1,1,1,−1,1,1,1,1,1,−1,−1,1,1,−1,−1,1,−1,−1,−1,1,1,−1,−1,−1,1,−1,−1,−1,−1,1,−1,1,1,1,1,1,1,1,−1,−1,1,−1,−1,1,1,−1,1,1,1,−1,−1,1,−1,1,−1,1,1,−1,1,−1,−1,−1,−1,1,1,1,−1,1,1,1,−1,−1,1,1,−1,1,−1,−1,1,−1,−1,1,1,1,1,−1,1,1,−1,1,1,−1,−1,−1,1,−1,1,−1,1,1,−1,1,−1,−1,1,1,−1,−1,1,1,−1,−1,−1,−1,−1,−1,1,−1,−1,1,1,−1,−1,1,1,1,1,1,−1,−1,−1,1,1,1,1,−1,−1,−1,−1,−1,1,1,−1,1,−1,1,−1,−1,1,−1,−1,−1,−1,−1,1,−1,−1,1,−1,1,−1,1,−1,1,−1,1,1,−1,1,1,−1,−1,−1,1,1,1,−1,1,1,1,−1,−1,−1,−1,1,1,−1,−1,−1,−1,1,1,1,1,−1,−1,1,1,−1,−1,−1,1,1,1,1,1,1,−1,1,−1,1,1,−1,1,1,−1,1,1,1,−1,1,1,−1,−1,−1,1,1,1,−1,−1,1,−1,−1,1,1,−1,1,1,1,−1,1,1,−1,1,1,1,−1,−1,1,1,−1,1,−1,−1,1,1,−1,−1,1,1,−1,−1,−1,1,1,1,−1,−1,1,−1,−1,1,−1,1,−1,−1,1,−1,−1,1,−1,−1,1,−1,−1,−1,1,1,−1,−1,−1,1,−1,1,1,−1,−1,1,−1,−1,−1,1,1,−1,1,−1,1,−1,−1,−1,−1,−1,1,−1,−1,−1,1,−1,−1,−1,1,−1,1,1,−1,−1,1,1,−1,1,1,−1,−1,−1,−1,−1,1,1,−1,1,−1,−1,1,1,1,−1,−1,−1,−1,−1,−1,−1,−1,1,1,1,−1,1,−1,1,−1,1,−1,−1,−1,1,1,1,1,1,−1,−1,1,1,−1,−1,1,−1,−1,−1,−1,−1,1,1,1,−1,−1,1,1,1,1,−1,1,−1,1,−1,1,1,1,−1,1,1,1,1,1,−1,1,1,−1,1,−1,−1,1,1,−1,1,−1,1,−1,−1,1,1,−1,1,1,−1,−1,−1,1,1,−1,1,1,1,1,1,−1,1,1,−1,−1,1,−1,1,−1,−1,−1,−1,−1,1,−1,−1,1,1,1,−1,−1,1,−1,0,0,0,0,0,−1,−1,1,−1,−1,−1,−1,1,−1,−1,−1,−1,1,1,−1,−1,1,−1,1,1,−1,1,1,1,−1,−1,1,1,−1,−1,−1,1,−1,−1,1,1,−1,−1,−1,−1,−1,1,1,−1,−1,−1,1,−1,−1,1,−1,−1,1,1,1,−1,−1,−1,1,−1,1,−1,1,1,1,−1,−1,−1,−1,−1,1,−1,1,1,1,−1,−1,1,−1,1,1,1,−1,−1,−1,−1,1,1,−1,1,−1,1,−1,1,1,1,−1,1,−1,1,−1,1,−1,−1,−1,1,−1,−1,1,1,−1,1,−1,−1,−1,1,−1,1,−1,1,−1,1,1,−1,−1,−1,1,−1,−1,1,1,1,1,−1,1,1,1,−1,1,−1,1,−1,1,−1,1,−1,1,1,1,1,1,1,−1,−1,−1,1,1,1,1,−1,−1,1,−1,1,−1,1,1,−1,1,−1,−1,−1,−1,1,1,1,1,1,−1,1,−1,−1,1,1,−1,−1,−1,1,−1,1,−1,1,−1,−1,1,1,−1,−1,−1,1,−1,1,−1,−1,1,−1,−1,1,−1,1,1,1,1,−1,−1,−1,1,−1,1,1,1,−1,1,−1,1,−1,1,−1,−1,−1,1,−1,−1,1,1,−1,−1,1,1,1,1,−1,−1,1,1,−1,−1,1,−1,−1,1,1,−1,1,−1,−1,1,−1,−1,1,1,1,1,1,−1,−1,1,1,1,1,−1,1,−1,1,−1,1,1,1,−1,−1,−1,−1,−1,−1,−1,1,1,1,−1,−1,1,1,1,−1,1,−1,1,−1,−1,1,1,−1,1,−1,−1,1,−1,1,−1,1,−1,−1,1,−1,1,−1,−1,−1,1,−1,1,1,−1,1,−1,−1,−1,−1,1,−1,1,−1,1,−1,−1,−1,1,−1,−1,1,−1,−1,−1,−1,1,−1,1,−1,−1,−1,−1,−1,1,−1,−1,1,−1,−1,−1,−1,−1,1,1,1,1,−1,1,1,−1,1,−1,−1,1,−1,1,1,−1,1,−1,−1,1,−1,−1,1,−1,1,−1,1,1,1,1,1,−1,−1,−1,−1,−1,1,1,−1,−1,−1,−1,−1,1,−1,1,1,1,−1,−1,−1,−1,−1,−1,1,1,1,−1,−1,1,1,1,−1,1,1,−1,1,−1,1,1,−1,−1,−1,1,−1,−1,−1,1,−1,−1,1,1,1,−1,−1,1,1,−1,1,1,−1,−1,−1,1,1,1,−1,1,−1,1,1,−1,−1,−1,1,−1,−1,1,1,−1,−1,1,−1,1,1,−1,1,−1,1,1,1,1,1,−1,1,−1,−1,1,1,1,−1,1,1,−1,−1,1,1,0,0,0,0,0,0,0,0,0,0,0}
For 160 MHz transmission, the N-TF sequence with the format of an HELTF160, optimized for estimation order P=8, is given by:
N-TF(HELTF160,P=8)=sqrt(2048/1992)·{0,0,0,0,0,0,0,0,0,0,0,0,1,−1,1,−1,−1,1,1,−1,−1,−1,1,1,1,−1,−1,−1,−1,−1,1,1,−1,1,1,1,−1,−1,1,1,1,−1,1,−1,−1,−1,1,1,−1,1,−1,−1,1,−1,1,−1,−1,1,1,1,−1,−1,1,1,1,−1,−1,−1,−1,1,1,−1,1,−1,1,−1,−1,1,1,−1,−1,−1,−1,1,1,1,1,1,−1,−1,−1,1,−1,1,1,−1,1,−1,1,−1,−1,−1,−1,−1,−1,1,−1,1,−1,−1,−1,−1,1,−1,1,1,−1,−1,1,1,−1,1,−1,1,1,−1,1,−1,1,1,1,1,−1,−1,1,−1,−1,−1,−1,1,−1,−1,1,−1,−1,1,1,−1,1,−1,1,1,−1,−1,1,1,−1,−1,1,−1,1,−1,1,−1,1,−1,1,1,−1,1,1,−1,1,−1,1,1,−1,−1,−1,1,−1,1,1,1,1,1,1,−1,1,1,−1,1,1,−1,−1,1,1,1,1,−1,−1,−1,1,1,1,−1,1,−1,1,−1,1,−1,1,−1,−1,1,−1,1,1,1,1,−1,1,1,1,−1,1,−1,−1,1,1,1,1,1,−1,1,1,−1,1,1,1,−1,1,1,−1,−1,1,1,1,−1,−1,1,1,1,−1,1,1,1,−1,1,1,−1,1,1,−1,1,1,1,−1,1,−1,−1,−1,−1,1,1,−1,−1,1,1,1,−1,−1,1,1,1,−1,1,1,1,−1,1,1,−1,1,1,−1,1,1,−1,1,−1,−1,1,1,−1,1,−1,1,−1,1,−1,−1,−1,−1,1,1,−1,−1,1,1,−1,1,1,1,1,1,1,1,−1,−1,−1,1,1,1,1,−1,−1,−1,−1,1,−1,−1,1,1,−1,−1,−1,1,−1,−1,1,1,1,1,−1,−1,−1,1,−1,−1,1,−1,−1,1,−1,1,1,1,−1,−1,−1,1,1,−1,−1,−1,−1,−1,1,1,1,1,1,−1,−1,1,1,−1,1,−1,1,1,−1,−1,1,−1,1,1,1,1,−1,1,−1,1,1,−1,−1,1,1,−1,1,1,−1,−1,1,1,1,1,−1,1,1,−1,−1,1,1,−1,−1,1,−1,1,−1,1,1,−1,1,1,1,−1,−1,1,1,1,−1,1,1,−1,1,−1,1,1,1,1,1,−1,−1,−1,−1,1,1,−1,1,−1,−1,1,1,1,−1,1,1,−1,−1,−1,−1,1,1,−1,1,1,−1,−1,−1,1,1,1,−1,1,−1,1,−1,−1,−1,−1,1,−1,1,−1,−1,1,−1,−1,−1,1,1,−1,−1,1,−1,1,0,0,0,0,0,−1,1,−1,−1,1,−1,−1,1,1,1,1,−1,−1,1,−1,1,1,1,1,1,−1,1,−1,−1,−1,−1,1,1,−1,−1,1,−1,1,−1,−1,−1,−1,−1,−1,1,1,−1,−1,1,−1,1,−1,−1,1,−1,−1,−1,−1,1,−1,1,−1,1,−1,1,1,−1,1,1,1,1,−1,1,−1,−1,−1,1,−1,1,−1,−1,1,−1,1,1,−1,1,1,1,1,−1,1,−1,1,1,−1,1,−1,−1,1,1,1,−1,1,1,1,1,−1,1,−1,−1,−1,1,−1,1,1,−1,−1,−1,1,−1,1,1,−1,1,1,1,−1,1,−1,−1,−1,1,−1,−1,1,−1,−1,1,−1,1,−1,1,−1,1,−1,−1,1,−1,1,1,−1,1,−1,−1,1,−1,−1,−1,1,1,−1,1,−1,1,−1,−1,1,1,1,−1,1,−1,−1,1,−1,−1,−1,1,−1,−1,1,−1,1,1,1,−1,−1,1,1,−1,−1,−1,−1,−1,1,−1,−1,−1,1,−1,−1,1,1,1,−1,1,1,−1,−1,−1,−1,−1,−1,1,1,1,−1,1,−1,1,1,1,1,1,−1,1,−1,−1,−1,1,−1,1,1,1,1,1,1,1,1,1,−1,−1,1,1,−1,−1,−1,−1,1,1,−1,1,1,1,−1,1,−1,1,1,1,−1,1,−1,1,−1,−1,1,1,1,1,1,−1,1,1,1,1,−1,1,−1,−1,1,−1,1,1,1,−1,−1,−1,1,1,−1,−1,1,1,1,1,1,−1,1,1,1,1,1,−1,−1,1,1,1,1,1,−1,−1,−1,−1,−1,1,−1,−1,−1,1,1,−1,−1,−1,−1,1,−1,1,1,−1,1,−1,−1,−1,1,−1,−1,1,−1,−1,−1,−1,1,1,1,−1,−1,1,1,−1,−1,−1,−1,−1,1,1,−1,1,1,1,−1,−1,−1,−1,1,1,1,1,1,1,−1,1,−1,−1,−1,−1,−1,−1,1,1,1,1,1,1,1,−1,1,−1,−1,−1,1,−1,−1,1,−1,1,−1,1,1,−1,−1,1,−1,1,1,−1,1,1,1,1,−1,−1,1,1,−1,1,1,−1,1,1,−1,1,−1,1,−1,1,−1,1,−1,1,−1,1,1,1,−1,−1,1,1,1,−1,−1,1,1,1,−1,1,−1,−1,1,−1,1,−1,−1,1,1,1,1,−1,−1,1,−1,1,1,1,1,1,−1,−1,1,1,−1,1,−1,−1,−1,−1,1,1,1,−1,1,1,−1,−1,1,1,1,−1,−1,−1,−1,1,1,1,1,−1,1,1,1,−1,1,−1,0,0,0,0,0,0,0,0,0,0,0,0,0,0,0,0,0,0,0,0,0,0,0,−1,−1,1,1,1,−1,−1,1,−1,1,−1,−1,−1,−1,1,−1,−1,−1,1,1,−1,1,−1,−1,−1,1,1,1,−1,−1,−1,−1,−1,1,−1,−1,1,1,1,1,1,−1,1,1,−1,1,−1,−1,1,1,−1,−1,−1,1,1,−1,−1,−1,1,1,−1,−1,−1,1,−1,1,−1,−1,1,−1,−1,−1,1,−1,1,1,−1,−1,−1,1,1,−1,1,−1,−1,1,−1,−1,−1,1,−1,1,−1,1,−1,−1,−1,1,−1,1,1,1,1,1,−1,−1,1,−1,−1,1,−1,1,−1,−1,−1,−1,1,1,1,−1,−1,1,−1,1,−1,−1,1,1,−1,1,−1,1,1,1,1,1,−1,1,1,−1,−1,1,−1,−1,−1,−1,−1,1,−1,1,1,1,1,1,1,−1,−1,−1,−1,1,−1,−1,−1,1,1,1,1,−1,−1,−1,−1,1,−1,1,1,1,−1,1,1,1,−1,−1,1,−1,1,1,1,1,−1,−1,−1,1,−1,−1,−1,1,−1,1,1,1,1,1,1,−1,−1,1,1,−1,1,−1,1,−1,−1,1,−1,−1,−1,−1,1,1,1,1,1,−1,1,1,−1,−1,−1,1,−1,1,1,−1,1,−1,−1,−1,1,1,1,−1,1,1,−1,−1,−1,1,1,1,1,1,−1,−1,1,1,−1,−1,−1,1,−1,−1,−1,−1,1,1,−1,−1,1,1,1,1,−1,−1,1,−1,−1,1,−1,−1,−1,1,−1,−1,1,−1,1,1,−1,1,−1,1,1,−1,−1,1,−1,−1,−1,1,−1,−1,1,1,−1,−1,−1,−1,1,1,−1,1,1,1,−1,−1,1,−1,1,−1,−1,1,−1,1,1,1,−1,−1,1,1,−1,−1,−1,1,1,1,−1,1,−1,1,−1,−1,1,−1,1,1,−1,1,1,−1,1,1,−1,−1,1,1,−1,1,−1,1,1,−1,−1,1,−1,−1,−1,−1,−1,−1,1,−1,1,−1,−1,1,1,1,−1,−1,1,−1,−1,1,−1,1,1,1,−1,−1,−1,−1,−1,−1,−1,−1,−1,1,−1,1,−1,−1,1,−1,1,1,−1,−1,−1,−1,−1,1,1,−1,−1,1,−1,−1,−1,1,−1,−1,−1,1,1,1,−1,−1,−1,1,−1,−1,1,1,1,−1,−1,−1,1,1,1,−1,−1,1,−1,1,−1,1,1,1,1,−1,1,−1,1,1,1,−1,−1,1,1,1,−1,−1,1,1,1,1,1,−1,1,−1,1,−1,−1,1,−1,1,1,−1,1,1,1,−1,1,−1,−1,−1,−1,1,−1,−1,1,1,1,0,0,0,0,0,1,1,−1,1,−1,1,−1,−1,−1,−1,−1,−1,−1,−1,−1,−1,1,1,−1,1,−1,1,−1,1,1,1,−1,−1,1,1,1,1,−1,1,−1,1,−1,1,1,−1,1,1,−1,−1,−1,1,1,1,−1,1,−1,1,−1,−1,−1,−1,−1,1,−1,−1,1,1,−1,−1,1,1,1,−1,−1,1,1,1,1,1,−1,−1,1,−1,1,1,−1,1,1,−1,1,1,1,1,−1,1,−1,1,1,1,−1,−1,1,1,−1,1,1,−1,−1,1,1,1,1,1,−1,1,−1,−1,−1,−1,−1,−1,1,1,1,−1,1,−1,1,1,1,1,−1,1,−1,−1,−1,−1,1,1,1,−1,1,−1,−1,1,−1,1,−1,1,1,−1,1,1,1,1,1,−1,−1,1,−1,1,−1,−1,1,−1,1,1,1,−1,1,−1,1,1,−1,1,−1,1,1,1,1,−1,1,1,−1,−1,−1,1,1,−1,1,−1,−1,1,1,−1,−1,−1,−1,1,−1,−1,1,−1,1,1,1,−1,−1,−1,−1,1,−1,1,1,1,1,1,−1,−1,1,−1,−1,1,1,1,1,1,1,1,−1,−1,1,1,−1,1,−1,1,−1,1,1,1,−1,1,−1,1,1,−1,1,1,−1,1,1,1,−1,1,−1,−1,1,1,1,1,−1,−1,−1,−1,−1,−1,1,−1,1,1,1,−1,1,−1,−1,−1,−1,−1,−1,−1,−1,−1,−1,1,−1,1,−1,1,1,1,−1,−1,−1,1,1,−1,−1,1,1,1,−1,−1,−1,1,1,−1,1,1,−1,−1,1,−1,−1,1,−1,1,−1,1,−1,−1,−1,1,1,−1,−1,−1,1,1,−1,1,−1,1,1,−1,−1,1,1,1,−1,−1,1,−1,1,−1,−1,−1,−1,1,1,1,1,1,−1,−1,1,−1,−1,−1,1,1,1,−1,1,−1,−1,−1,1,1,−1,1,1,1,1,1,−1,1,−1,−1,1,−1,−1,−1,1,1,−1,−1,−1,−1,1,−1,1,−1,1,−1,−1,−1,1,1,1,1,1,−1,−1,−1,1,−1,1,1,1,−1,−1,−1,−1,−1,1,1,1,−1,−1,−1,−1,−1,−1,1,−1,−1,1,−1,1,−1,−1,1,1,−1,1,1,1,1,−1,1,1,1,1,−1,−1,−1,1,−1,1,−1,−1,−1,−1,1,1,1,1,−1,−1,1,1,1,1,1,−1,−1,1,−1,−1,−1,−1,−1,−1,−1,1,1,1,1,1,−1,−1,−1,1,1,1,−1,−1,−1,−1,−1,1,−1,−1,−1,1,1,−1,−1,−1,1,−1,−1,−1,0,0,0,0,0,0,0,0,0,0,0}
For 160 MHz transmission, the N-TF sequence with the format of an HELTF160, optimized for estimation order P=9, is given by:
N-TF(HELTF160,P=9)=sqrt(2048/1992)·{0,0,0,0,0,0,0,0,0,0,0,0,1,−1,1,1,−1,1,1,−1,1,−1,1,−1,1,−1,1,1,1,1,−1,−1,−1,1,1,−1,1,1,−1,−1,1,−1,1,−1,−1,−1,1,1,1,1,−1,−1,1,−1,−1,−1,−1,1,−1,1,−1,−1,1,−1,1,1,−1,1,1,1,−1,1,−1,−1,1,−1,−1,−1,1,−1,−1,1,1,1,1,−1,−1,−1,−1,1,−1,−1,−1,−1,−1,−1,1,−1,1,−1,−1,−1,1,1,−1,1,−1,1,−1,−1,−1,1,−1,1,1,1,1,−1,−1,−1,−1,−1,1,1,−1,−1,−1,1,−1,−1,−1,1,−1,1,1,−1,1,1,−1,−1,−1,−1,−1,1,−1,−1,−1,1,1,1,1,−1,−1,1,−1,−1,−1,1,−1,−1,−1,−1,1,−1,−1,1,1,1,1,−1,−1,−1,−1,−1,1,1,1,−1,1,1,−1,−1,1,1,1,−1,1,1,1,−1,−1,1,−1,−1,−1,−1,−1,1,−1,−1,1,−1,1,1,1,−1,−1,−1,1,−1,−1,1,−1,−1,1,−1,−1,−1,1,1,−1,−1,−1,−1,−1,−1,−1,−1,−1,1,−1,1,1,1,−1,1,1,−1,−1,−1,−1,−1,−1,−1,1,1,−1,−1,1,−1,−1,1,−1,1,−1,1,−1,−1,1,−1,1,−1,1,−1,−1,1,1,1,1,−1,−1,−1,−1,−1,1,1,1,1,1,−1,1,−1,−1,1,−1,1,−1,−1,1,1,−1,−1,1,1,1,−1,−1,−1,1,−1,−1,−1,1,1,1,−1,−1,−1,−1,−1,−1,1,−1,−1,−1,−1,1,1,1,−1,−1,−1,−1,−1,−1,−1,−1,1,1,−1,1,1,−1,−1,1,1,1,−1,1,−1,−1,−1,1,1,−1,−1,−1,1,1,−1,1,1,1,−1,−1,1,−1,1,1,−1,−1,−1,1,−1,−1,1,1,−1,1,1,−1,−1,1,1,1,1,−1,1,−1,−1,−1,1,1,1,1,−1,1,1,−1,−1,−1,1,−1,1,−1,1,−1,1,1,−1,1,−1,1,−1,−1,−1,−1,1,1,1,−1,−1,−1,1,−1,1,1,1,1,1,1,−1,−1,−1,−1,−1,−1,−1,1,−1,1,−1,−1,1,−1,−1,1,−1,−1,1,−1,−1,1,−1,1,−1,−1,−1,−1,1,−1,−1,−1,−1,1,−1,−1,−1,−1,−1,1,−1,−1,1,−1,−1,1,−1,1,−1,−1,1,−1,1,1,−1,−1,1,1,1,−1,−1,−1,1,−1,1,−1,−1,1,1,−1,1,−1,1,−1,1,1,−1,1,−1,−1,−1,−1,1,−1,−1,1,−1,1,0,0,0,0,0,1,1,1,1,−1,−1,−1,−1,−1,1,−1,−1,1,−1,−1,1,−1,−1,1,1,1,−1,1,−1,−1,1,−1,1,−1,1,−1,−1,1,−1,−1,−1,1,1,1,−1,−1,−1,1,1,1,−1,1,−1,1,−1,1,−1,−1,−1,−1,−1,1,1,1,−1,1,−1,−1,−1,−1,−1,1,−1,−1,−1,−1,1,−1,−1,−1,1,−1,−1,1,−1,1,−1,−1,−1,1,−1,1,−1,−1,1,1,1,−1,1,1,−1,−1,−1,1,1,−1,1,1,1,−1,−1,1,1,−1,1,−1,1,1,−1,−1,−1,1,−1,1,1,−1,−1,−1,1,−1,1,−1,1,−1,−1,−1,−1,−1,−1,−1,1,−1,1,−1,1,−1,−1,1,1,−1,1,−1,1,1,1,−1,1,1,−1,−1,−1,−1,−1,−1,−1,−1,−1,1,1,−1,−1,1,−1,1,−1,−1,−1,1,−1,−1,1,−1,1,−1,−1,1,−1,1,−1,−1,−1,1,1,−1,−1,1,−1,−1,−1,−1,1,1,1,−1,1,−1,−1,−1,−1,−1,−1,1,−1,1,1,1,−1,1,−1,1,1,1,1,−1,−1,1,−1,1,−1,−1,−1,−1,−1,−1,1,−1,−1,1,−1,−1,1,−1,−1,−1,−1,−1,−1,−1,−1,1,1,−1,−1,−1,−1,1,−1,1,−1,−1,−1,−1,1,−1,−1,−1,1,−1,−1,1,−1,1,1,−1,−1 . . . 1,1,−1,−1,1,−1,−1,1,1,1,1,−1,1,1,1,−1,1,1,−1,1,−1,−1,1, 1,−1,−1,−1,−1,1,−1,−1,1,1,−1,1,−1,1,−1,−1,−1,−1,−1,1,−1,1,−1,1,1,1,−1,1,−1,1,1,1,1,1,1,1,−1,−1,−1,1,1,−1,−1,−1,1,1,−1,−1,−1,1,1,−1,−1,1,−1,−1,1,−1,1,1,1,1,−1,−1,−1,1,−1,1,−1,−1,1,−1,−1,1,1,−1,−1,−1,−1,1,1,1,−1,−1,−1,1,1,1,−1,−1,1,1,−1,−1,1,1,1,−1,1,−1,−1,−1,−1,−1,−1,−1,1,1,−1,−1,−1,−1,1,1,1,1,−1,1,−1,−1,1,−1,−1,1,−1,−1,−1,1,1,−1,−1,1,−1,−1,−1,1,−1,1,1,1,1,−1,−1,−1,−1,−1,1,−1,−1,1,1,1,1,−1,−1,1,1,−1,−1,−1,1,1,−1,1,−1,1,1,−1,−1,1,−1,1,1,−1,1,−1,−1,−1,−1,−1,1,−1,1,−1,1,−1,1,−1,−1,−1,−1,−1,−1,1,−1,−1,1,−1,1,−1,0,0,0,0,0,0,0,0,0,0,0,0,0,0,0,0,0,0,0,0,0,0,0,1,−1,−1,1,1,1,−1,−1,1,−1,1,−1,1,1,1,−1,−1,−1,−1,−1,−1,−1,−1,1,1,−1,1,−1,1,−1,1,−1,1,−1,1,1,−1,−1,−1,−1,−1,−1,−1,1,1,1,−1,−1,1,1,−1,−1,−1,−1,1,−1,−1,1,1,1,−1,1,−1,−1,−1,−1,−1,1,−1,1,1,1,−1,1,−1,−1,−1,−1,1,−1,1,1,−1,1,−1,−1,−1,1,1,1,1,−1,−1,−1,1,−1,−1,−1,−1,−1,−1,1,−1,−1,1,1,1,−1,−1,−1,−1,1,−1,−1,1,−1,1,−1,−1,−1,1,−1,−1,−1,−1,1,−1,1,−1,−1,−1,1,−1,−1,1,−1,1,−1,−1,−1,−1,−1,−1,1,−1,−1,−1,1,−1,−1,1,−1,−1,1,−1,1,1,−1,1,1,−1,1,−1,−1,−1,1,−1,1,−1,1,1,−1,−1,−1,1,1,−1,−1,1,1,−1,−1,−1,−1,1,1,−1,1,−1,−1,1,1,−1,1,−1,−1,−1,1,−1,−1,1,−1,1,−1,−1,−1,−1,1,1,−1,1,−1,1,1,−1,−1,−1,1,−1,1,−1,1,1,1,1,−1,1,1,−1,1,1,−1,−1,1,−1,1,−1,1,−1,−1,1,−1,−1,−1,−1,1,−1,−1,−1,1,1,1,−1,−1,1,1,−1,1,−1,1,−1,−1,1,1,1,1,−1,−1,−1,−1,−1,−1,−1,−1,1,1,1,−1,−1,1,−1,−1,1,−1,−1,−1,−1,1,−1,1,1,−1,1,1,−1,1,1,−1,−1,1,1,−1,1,−1,1,−1,−1,−1,1,1,−1,1,−1,1,1,−1,−1,−1,−1,1,1,1,1,1,1,1,1,1,−1,1,1,−1,1,−1,1,−1,−1,−1,1,1,1,−1,1,1,1,−1,1,1,−1,1,1,1,1,1,−1,−1,−1,1,1,1,1,−1,1,1,−1,−1,−1,−1,1,1,−1,−1,1,1,−1,−1,1,−1,1,−1,1,−1,1,−1,1,1,−1,−1,−1,−1,−1,1,−1,1,1,−1,1,−1,1,−1,−1,−1,−1,−1,−1,1,1,−1,−1,1,−1,−1,−1,1,1,1,1,1,−1,1,−1,1,−1,−1,−1,−1,1,−1,1,1,−1,1,1,−1,1,1,1,−1,−1,1,1,−1,1,1,−1,1,−1,−1,1,−1,1,1,−1,−1,1,1,1,−1,−1,1,1,1,1,1,1,−1,1,−1,−1,−1,1,1,1,1,−1,−1,−1,−1,1,−1,1,1,−1,−1,−1,1,−1,−1,−1,1,1,−1,1,−1,−1,1,1,1,0,0,0,0,0,−1,1,−1,1,1,−1,1,−1,1,1,1,−1,−1,−1,1,−1,1,1,−1,1,−1,1,1,−1,1,1,1,1,−1,1,−1,1,1,−1,1,−1,1,1,−1,−1,−1,−1,−1,1,1,1,1,−1,−1,1,−1,−1,−1,1,1,−1,−1,1,−1,−1,−1,−1,1,1,−1,−1,−1,−1,1,−1,1,−1,−1,1,−1,1,−1,1,1,1,−1,−1,−1,−1,1,−1,1,−1,1,−1,1,1,1,−1,1,−1,−1,1,−1,−1,−1,−1,1,−1,−1,−1,−1,1,1,1,1,−1,1,1,1,−1,−1,−1,−1,−1,−1,−1,1,−1,1,1,−1,−1,1,−1,−1,−1,−1,−1,−1,1,−1,1,−1,−1,1,−1,−1,−1,−1,1,−1,1,1,−1,−1,−1,−1,−1,−1,−1,−1,1,−1,1,−1,−1,−1,1,−1,1,−1,1,−1,1,−1,−1,−1,1,1,1,−1,1,1,1,1,−1,−1,1,1,−1,1,1,−1,1,−1,1,1,−1,1,−1,−1,1,−1,1,1,1,1,1,1,1,1,1,1,−1,1,1,1,1,1,1,1,1,1,−1,−1,1,−1,−1,1,1,−1,−1,−1,1,1,−1,1,−1,1,−1,−1,−1,1,1,−1,1,−1,1,−1,−1,−1,−1,1,1,−1,1,1,−1,−1,−1,1,1,−1,1,−1,−1,1,−1,−1,1,1,1,−1,1,1,−1,−1,−1,1,1,1,1,1,1,−1,−1,1,1,−1,−1,−1,−1,1,1,−1,−1,1,1,−1,1,−1,−1,1,−1,1,−1,−1,−1,−1,1,1,1,−1,1,1,−1,1,−1,−1,−1,1,−1,−1,1,−1,−1,−1,1,−1,−1,1,1,1,1,1,1,−1,−1,−1,1,−1,1,−1,1,1,−1,1,−1,−1,1,1,−1,1,−1,−1,1,−1,1,1,−1,1,1,1,−1,−1,−1,−1,1,1,−1,−1,−1,1,1,1,1,−1,−1,−1,−1,1,1,−1,1,1,1,1,−1,−1,−1,1,−1,1,−1,1,−1,1,−1,1,−1,1,−1,1,−1,1,−1,1,1,1,−1,1,−1,1,1,−1,−1,1,1,−1,1,−1,1,1,1,−1,−1,1,1,1,−1,1,−1,1,−1,−1,−1,−1,1,1,1,1,1,1,−1,1,−1,−1,1,1,1,−1,1,1,1,−1,−1,1,1,1,1,1,−1,−1,1,−1,−1,−1,1,−1,−1,1,1,1,1,−1,−1,−1,1,−1,1,−1,−1,1,1,−1,−1,−1,1,−1,−1,−1,−1,1,−1,1,1,1,−1,−1,0,0,0,0,0,0,0,0,0,0,0}
For 160 MHz transmission, the N-TF sequence with the format of an HELTF160, optimized for estimation order P=10, is given by:
N-TF(HELTF160,P=10)=sqrt(2048/1992)·{0,0,0,0,0,0,0,0,0,0,0,0,1,1,−1,−1,1,−1,1,−1,−1,−1,−1,−1,1,1,−1,−1,1,−1,1,−1,−1,1,−1,1,−1,1,−1,−1,−1,1,1,1,−1,1,−1,1,−1,−1,−1,−1,−1,1,−1,1,1,−1,−1,1,−1,1,−1,−1,−1,−1,1,−1,1,−1,1,1,1,−1,−1,1,1,1,1,−1,−1,−1,1,−1,1,1,−1,1,−1,−1,1,−1,−1,1,−1,−1,1,−1,1,−1,1,−1,1,−1,−1,−1,−1,−1,1,1,1,1,1,1,−1,1,−1,−1,−1,−1,−1,1,−1,1,−1,1,−1,−1,−1,1,1,−1,−1,−1,1,−1,1,1,1,−1,1,−1,1,1,−1,1,1,−1,1,−1,1,−1,−1,−1,1,1,−1,1,1,1,−1,1,−1,1,−1,−1,1,1,−1,1,1,1,1,1,1,−1,−1,−1,−1,−1,−1,1,1,1,1,1,1,−1,1,1,1,−1,−1,−1,−1,−1,−1,−1,1,1,−1,1,−1,1,1,−1,−1,−1,1,−1,1,−1,−1,1,1,1,−1,1,−1,1,1,−1,−1,1,−1,−1,1,1,1,−1,1,−1,−1,1,−1,1,−1,1,−1,1,−1,1,1,−1,1,−1,−1,−1,−1,−1,1,−1,1,1,−1,1,1,−1,1,1,1,−1,1,1,1,−1,−1,−1,−1,−1,1,−1,−1,−1,−1,1,−1,−1,1,1,−1,1,1,−1,1,−1,1,−1,1,−1,−1,−1,−1,−1,−1,1,1,1,1,1,1,−1,−1,−1,1,1,−1,−1,−1,1,1,1,−1,1,−1,1,1,−1,−1,1,−1,1,1,−1,1,1,−1,1,−1,1,1,1,−1,−1,1,−1,1,−1,1,−1,−1,1,−1,−1,1,−1,1,1,−1,−1,1,−1,1,1,1,−1,1,−1,1,1,−1,1,−1,1,−1,1,1,1,1,−1,−1,−1,1,−1,1,1,−1,−1,1,1,1,1,1,1,−1,1,1,−1,−1,−1,1,1,1,−1,−1,−1,1,−1,−1,1,−1,1,−1,−1,−1,1,1,1,−1,−1,1,1,1,−1,−1,1,−1,1,1,−1,−1,−1,−1,1,−1,−1,1,−1,1,−1,−1,−1,1,−1,−1,−1,1,1,−1,−1,−1,−1,−1,1,1,1,−1,−1,1,1,1,1,1,−1,−1,1,−1,1,−1,1,−1,1,−1,−1,1,−1,1,−1,1,−1,1,−1,1,1,1,1,1,1,1,−1,1,−1,−1,1,−1,−1,1,−1,−1,−1,−1,−1,1,1,−1,1,−1,1,1,−1,−1,−1,1,1,−1,−1,1,1,1,−1,0,0,0,0,0,1,1,1,1,1,1,−1,−1,−1,1,1,−1,1,1,−1,1,−1,1,−1,−1,−1,−1,1,1,−1,−1,−1,1,−1,−1,1,−1,1,1,−1,1,−1,1,−1,1,−1,−1,1,−1,−1,−1,1,1,1,1,−1,−1,1,−1,−1,1,−1,1,−1,1,−1,−1,−1,1,1,−1,1,−1,1,−1,−1,−1,1,1,1,−1,1,−1,−1,1,1,1,−1,−1,−1,−1,−1,1,−1,1,1,−1,1,1,−1,1,−1,1,−1,1,1,1,−1,−1,1,1,−1,1,1,1,1,1,1,1,−1,−1,1,−1,−1,1,1,1,1,−1,−1,1,−1,−1,−1,−1,−1,1,1,1,−1,1,−1,−1,−1,1,−1,1,−1,1,1,1,1,−1,1,−1,1,−1,−1,−1,−1,1,−1,−1,−1,1,1,1,1,−1,−1,−1,1,−1,−1,−1,1,1,1,1,1,1,−1,−1,1,1,−1,1,1,1,1,−1,−1,−1,−1,−1,1,−1,−1,1,1,−1,1,−1,−1,−1,−1,−1,−1,−1,−1,1,1,1,1,−1,−1,1,−1,1,1,1,−1,−1,−1,1,−1,1,−1,−1,−1,−1,1,1,1,−1,−1,−1,1,1,−1,−1,1,1,−1,1,1,1,1,1,−1,−1,−1,1,1,1,1,−1,1,−1,1,1,1,−1,−1,1,1,−1,1,1,−1,1,1,−1,1,−1,1,1,−1,1,1,1,−1,1,−1,1,−1,1,−1,1,1,1,−1,−1,−1,1,−1,−1,1,−1,−1,−1,−1,1,−1,−1,1,1,1,1,1,−1,1,1,1,−1,−1,−1,1,−1,1,−1,1,−1,−1,1,−1,1,−1,1,−1,1,1,−1,1,1,1,−1,−1,1,−1,−1,1,1,1,1,1,−1,−1,−1,−1,1,1,−1,1,−1,−1,−1,1,1,1,−1,1,1,−1,1,−1,1,−1,1,−1,−1,−1,−1,1,1,1,1,−1,−1,−1,−1,−1,−1,−1,−1,1,1,1,−1,−1,1,1,1,1,−1,1,−1,1,−1,−1,1,−1,1,−1,−1,1,1,−1,1,1,−1,1,1,1,−1,1,−1,1,−1,1,1,1,1,1,−1,−1,1,−1,1,−1,−1,1,−1,1,1,−1,−1,1,1,−1,−1,−1,−1,1,−1,1,1,−1,−1,1,1,1,−1,−1,−1,1,−1,1,1,−1,−1,1,−1,−1,1,1,−1,−1,1,−1,−1,1,1,−1,1,−1,1,1,1,−1,1,−1,−1,−1,−1,1,1,−1,−1,1,1,1,−1,−1,−1,−1,−1,1,1,1,−1,1,1,0,0,0,0,0,0,0,0,0,0,0,0,0,0,0,0,0,0,0,0,0,0,0,1,1,−1,−1,1,−1,−1,−1,1,−1,−1,−1,−1,1,−1,1,1,−1,1,1,−1,1,1,−1,1,−1,−1,−1,1,−1,1,1,−1,1,−1,−1,1,−1,−1,1,1,1,1,−1,1,1,−1,1,−1,1,1,1,−1,1,−1,1,1,−1,1,1,−1,−1,1,−1,−1,1,1,−1,−1,1,1,−1,−1,1,−1,−1,1,1,−1,−1,1,1,−1,−1,1,−1,−1,1,1,1,1,1,1,−1,−1,−1,−1,−1,−1,−1,−1,1,1,−1,1,−1,−1,−1,1,1,−1,1,1,1,1,1,1,1,−1,1,1,−1,−1,−1,1,1,−1,1,1,−1,1,−1,−1,1,1,1,−1,−1,−1,1,−1,1,1,1,1,1,1,−1,1,−1,−1,−1,−1,1,−1,1,−1,1,1,1,−1,1,−1,−1,−1,−1,−1,1,1,−1,−1,−1,−1,−1,1,1,−1,−1,−1,1,1,1,1,−1,−1,−1,−1,1,−1,1,−1,1,−1,−1,1,1,−1,−1,−1,1,−1,1,1,1,−1,−1,−1,1,1,1,1,1,1,1,−1,1,−1,−1,−1,−1,1,−1,−1,−1,−1,−1,1,−1,1,1,1,1,1,1,−1,1,−1,−1,1,1,−1,1,−1,−1,1,−1,1,−1,1,−1,−1,−1,−1,−1,1,1,1,1,−1,1,−1,1,−1,1,1,1,1,−1,1,1,1,1,−1,1,1,1,1,−1,−1,1,−1,1,1,−1,1,1,1,−1,1,−1,1,−1,−1,1,−1,−1,1,1,−1,−1,−1,1,−1,−1,1,1,1,−1,−1,−1,−1,−1,1,−1,−1,1,−1,−1,1,1,−1,−1,1,−1,1,−1,1,−1,1,−1,1,−1,1,−1,−1,1,−1,−1,−1,−1,−1,1,1,−1,1,−1,−1,1,−1,1,1,−1,−1,1,−1,1,1,1,−1,1,1,1,1,−1,−1,−1,1,1,−1,−1,−1,1,1,−1,1,−1,1,1,1,−1,−1,1,1,1,−1,−1,−1,1,−1,−1,1,1,1,−1,−1,−1,−1,−1,1,−1,1,−1,1,−1,−1,1,−1,1,−1,1,1,1,−1,1,1,−1,1,1,−1,1,−1,1,1,1,1,1,1,−1,1,−1,−1,1,−1,−1,1,1,1,1,−1,1,−1,−1,−1,−1,−1,−1,−1,−1,−1,−1,1,1,−1,1,1,−1,1,−1,−1,1,−1,1,−1,−1,1,−1,1,−1,1,−1,−1,−1,1,1,1,−1,1,1,1,1,−1,1,1,1,1,−1,1,1,1,−1,1,−1,−1,1,1,−1,−1,1,0,0,0,0,0,−1,−1,1,1,−1,1,1,1,1,−1,−1,−1,−1,−1,1,1,1,1,1,1,1,−1,−1,1,−1,1,1,−1,−1,−1,−1,−1,1,−1,1,1,1,1,1,−1,−1,−1,−1,1,−1,1,1,1,1,1,1,1,−1,−1,1,−1,−1,1,1,−1,1,1,1,1,−1,1,−1,−1,1,1,1,−1,−1,−1,−1,1,1,1,−1,1,1,−1,1,−1,−1,−1,−1,−1,−1,1,−1,1,1,−1,1,−1,−1,−1,−1,−1,1,−1,1,1,1,1,1,−1,1,−1,1,−1,−1,1,−1,1,1,1,−1,1,−1,1,−1,−1,1,1,1,−1,1,−1,−1,−1,−1,−1,1,−1,1,−1,−1,−1,−1,−1,−1,1,−1,−1,1,−1,1,−1,−1,−1,−1,−1,−1,−1,1,1,−1,1,1,−1,1,1,1,−1,−1,1,1,1,1,−1,1,1,−1,1,−1,1,−1,1,−1,1,−1,−1,1,−1,1,−1,1,1,1,−1,−1,1,1,1,−1,−1,1,−1,−1,1,1,−1,1,1,−1,−1,1,−1,−1,−1,−1,1,1,1,−1,1,1,−1,1,−1,1,−1,1,1,1,1,−1,1,−1,1,−1,−1,1,−1,−1,−1,1,1,1,1,1,−1,1,−1,−1,1,−1,−1,−1,1,−1,1,1,−1,−1,1,−1,−1,−1,−1,1,1,1,−1,−1,−1,1,1,1,−1,1,−1,−1,−1,−1,−1,1,1,1,1,−1,1,1,1,−1,1,−1,1,1,−1,1,1,1,−1,−1,1,1,−1,1,−1,1,−1,1,−1,1,−1,1,−1,1,−1,1,−1,1,−1,−1,1,−1,1,−1,−1,1,−1,−1,1,−1,1,−1,1,1,1,1,−1,1,−1,−1,−1,−1,−1,−1,−1,1,−1,1,1,1,−1,1,−1,1,1,1,1,1,1,−1,1,−1,1,1,1,−1,1,−1,1,−1,−1,1,1,1,−1,−1,−1,1,1,−1,−1,−1,−1,−1,1,−1,1,1,1,1,−1,−1,−1,1,−1,−1,−1,−1,−1,1,1,−1,1,1,1,−1,−1,−1,−1,−1,−1,−1,1,−1,1,1,1,1,1,−1,1,−1,−1,−1,1,1,1,−1,−1,1,1,1,1,−1,1,−1,−1,1,−1,1,1,1,1,1,1,1,1,−1,−1,1,−1,−1,1,−1,1,1,−1,1,1,1,1,−1,−1,1,−1,1,1,−1,1,1,−1,1,1,−1,1,1,−1,1,−1,−1,1,−1,−1,1,−1,−1,1,1,−1,1,1,−1,1,−1,1,−1,−1,−1,1,1,0,0,0,0,0,0,0,0,0,0,0}.

5. First communication device according to claim 4,
wherein the circuitry is configured to perform one or more of the following operations to the selected nonlinearity estimation sequence before transmitting it in the second training field:
shifting the phase of the selected nonlinearity estimation sequence by an angle;
flipping left and right in frequency domain to mirror the frequency axis;
transforming the selected nonlinearity estimation sequence into the time domain;
transforming the selected nonlinearity estimation sequence into the time domain and flipping left and right in the time domain to mirror the time axis;
transforming the selected nonlinearity estimation sequence into the time domain and rearranging or permuting samples of the selected nonlinearity estimation sequence in time domain;
transforming the selected nonlinearity estimation sequence into the time domain and concatenating a copy or a part of the selected nonlinearity estimation sequence or a cyclic prefix to the selected nonlinearity estimation sequence; and
transforming the selected nonlinearity estimation sequence into the time domain and concatenating another selected nonlinearity estimation sequence after transforming it into the time domain.

6. First communication device according to claim 1,
wherein the circuitry is configured to transmit a third training field, in particular as part of a first data unit including the first training field and the second training field, the third training field being identical to the second training field or comprising a nonlinearity estimation sequence optimized for a different estimation order than the nonlinearity estimation sequence comprised in the second training field.

7. First communication device according to claim 1,
wherein the circuitry is configured to transmit, in particular as part of a first data unit including the first training field and the second training field, one or more of:
a feedback estimation order indicator indicating the desired estimation order of the nonlinearity feedback;
a transmission estimation order indicator indicating the estimation order of the nonlinearity estimation sequence comprised in the second training field; and
another transmission estimation order indicator indicating the estimation order of a nonlinearity estimation sequence comprised in a third training field if a third training field is transmitted.

8. First communication device according to claim 1,
wherein the circuitry is configured to use the received nonlinearity feedback to configure the subsequent transmission by one or more of:
applying predistortion to one or more subsequent data units to be transmitted based on the received nonlinearity feedback before transmission of said one or more subsequent data units;
transmitting a further second training field, in particular in another data unit comprising the first training field and the further second training field, the further second training field comprising a further nonlinearity estimation sequence, in particular having a different estimation order than the nonlinearity estimation sequence comprising in the second training field.

9. First communication device according to claim 1,
wherein the circuitry is configured to transmit, before transmitting the second training field, a nonlinearity estimation announcement,
wherein the nonlinearity estimation announcement and the second training field are transmitted on a first frequency band, and
wherein the nonlinearity estimation announcement instructs the second communication device to tune to a second frequency band different from the first frequency band, in particular a second frequency band that is adjacent to the first frequency band, during transmission of the second training field by the first communication device and optionally to tune to the first frequency band for transmission of the nonlinearity feedback to the first communication device.

10. Second communication device configured to communicate with a first communication device, the second communication device comprising circuitry configured to:
receive a first training field comprising a channel estimation sequence and a second training field comprising a nonlinearity estimation sequence, the second training field having a higher peak-to-average-power ratio and/or a different average power than the first training field;
estimate nonlinearities between the first and second communication devices based on the received second training field; and
transmit nonlinearity feedback with respect to the estimated nonlinearities to the first communication device.

11. Second communication device according to claim 10,
wherein the circuitry is configured to estimate, before estimating the nonlinearities, the channel between the first communication device and the second communication device based on the received first training field, and perform channel equalization applying the channel estimate on the second training field.

12. Second communication device according to claim 10,
wherein the circuitry is configured to include in the nonlinearity feedback one or more of:
coefficients of a polynomial representing the nonlinearity;
an optimal estimation order;
a feedback estimation order; and
an accuracy indicator indicating the accuracy of the estimated nonlinearities.

13. Second communication device according to claim 12,
wherein the circuitry is configured to determine the coefficients of a polynomial representing the nonlinearity based on an estimation matrix.

14. Second communication device according to claim 12,
wherein the circuitry is configured to determine the optimal estimation order based on a signal-to-noise ratio of the received second training field.

15. Second communication device according to claim 12,
wherein the circuitry is configured to determine the accuracy of the nonlinearities using one or more of:
a correctly received data field within a first data unit comprising the first training field and the second training field;
a received third training field of the first PPDU, the third training field being identical to the second training field or comprising a nonlinearity estimation sequence optimized for a different estimation order than the nonlinearity estimation sequence comprised in the second training field; and
a received further second training field.

16. Second communication device according to claim 10,
wherein the circuitry is configured to
receive a third training field, in particular as part of a first data unit including the first training field and the second training field, the third training field being identical to the second training field or comprising a nonlinearity estimation sequence optimized for a different estimation order than the nonlinearity estimation sequence comprised in the second training field;
estimate nonlinearities between the first and second communication devices by use of the received third training field and/or determine the accuracy of the nonlinearities estimated by use of the received second training field; and
transmit the nonlinearity feedback including information with respect to the nonlinearities estimated by use of the received second training field and/or information with respect to the nonlinearities estimated by use of the third training field.

17. Second communication device according to claim 10,
wherein the circuitry is configured to
receive, before receiving the second training field, a nonlinearity estimation announcement on a first frequency band;
tune to a second frequency band different from the first frequency band, in particular a second frequency band that is adjacent to the first frequency band, during transmission of the second training field by the first communication device and receive out-of-band emissions caused by the transmission of the second training field by the first communication device; and
tune to the first frequency band and transmit the nonlinearity feedback to the first communication device.

18. First communication method of a first communication device configured to communicate with a second communication device, the first communication method comprising:
transmitting a first training field comprising a channel estimation sequence for use by the second communication device to estimate the channel between the first communication device and the second communication device;
transmitting a second training field comprising a nonlinearity estimation sequence for use by the second communication device to estimate nonlinearities between the first and second communication devices, the second training field having a higher peak-to-average-power ratio and/or a different average power than the first training field;
receiving nonlinearity feedback from the second communication device with respect to the estimated nonlinearities; and
using the received nonlinearity feedback to configure a subsequent transmission.

19. Second communication method of a second communication device configured to communicate with a first communication device, the second communication method comprising:
receiving a first training field comprising a channel estimation sequence and a second training field comprising a nonlinearity estimation sequence, the second training field having a higher peak-to-average-power ratio and/or a different average power than the first training field;
estimating nonlinearities between the first and second communication devices based on the received second training field; and
transmitting nonlinearity feedback with respect to the estimated nonlinearities to the first communication device.

20. A non-transitory computer-readable recording medium that stores therein a computer program product, which, when executed by a processor, causes the method according to claim 18 to be performed.
